(19) United States
(12) Patent Application Publication
(10) Pub. No.: US 2024/0041038 A1
(43) Pub. Date: Feb. 8, 2024

(54) INSECTICIDAL COMBINATIONS

(71) Applicant: Vestaron Corporation, Kalamazoo, MI (US)

(72) Inventors: Kyle SCHNEIDER, Kalamazoo, MI (US); Breck DAVIS, Kalamazoo, MI (US); Daniel HULBERT, Kalamazoo, MI (US); Joseph TOURTOIS, Kalamazoo, MI (US)

(73) Assignee: Vestaron Corporation, Kalamazoo, MI (US)

(21) Appl. No.: 17/922,469

(22) PCT Filed: Apr. 30, 2021
(86) PCT No.: PCT/US2021/030277

§ 371 Date: Oct. 31, 2022

Related U.S. Application Data
(60) Provisional application No. 63/019,219, filed on May 1, 2020.

(51) Int. Cl. A01N 37/46; A01N 59/14; A01N 63/23; A01N 63/40; A01P 7/04; A01N 65/26; A01N 63/30; A01N 63/12

(52) U.S. Cl. CPC A01N 37/46; A01N 59/14; A01N 63/23; A01N 63/40; A01P 7/04; A01N 65/26; A01N 63/30; A01N 63/12

(57) ABSTRACT

New insecticidal combinations, compositions, and methods of using the same are provided. The present invention is directed to combinations of Cysteine Rich Insecticidal Peptides (CRIPS), and Insecticidal Agents (IAs). The present invention also describes the use of said combinations and compositions for the control of insects. Here, we describe the following: genes encoding CRIPs; compositions and combinations comprising CRIPs and IAs; and methods using the same that are useful for the control of pests.

### CROSS REFERENCE TO RELATED APPLICATIONS

This application claims the benefit of, and priority to, U.S. Provisional Application Ser. No. 63/019,219 filed on May 1, 2020, the disclosure of which is incorporated by reference herein in its entirety.

### SEQUENCE LISTING

This application incorporates by reference in its entirety the Sequence Listing entitled “225312-491452 ST25.txt” (1.41 MB), which was created on Apr. 28, 2021 at 10:07 PM, and filed electronically herewith.

### TECHNICAL FIELD

New insecticidal combinations of Cysteine Rich Insecticidal Proteins (CRIPs), and Insecticidal Agents (IAs), e.g., chemical substances, molecules, nucleotides, polynucleotides, peptides, polypeptides, proteins, toxins, toxicants, poisons, insecticides, pesticides, organic compounds, inorganic compounds, prokaryote organisms, or eukaryote organisms (and the agents produced from said prokaryote or eukaryote organisms), for the control and/or eradication of pests are described and claimed.

### BACKGROUND

Numerous insects are vectors for disease. Mosquitoes in the genus Anopheles are the principle vectors of Zika virus, Chikungunya virus, and malaria, a disease caused by protozoa in the genus Trypanosoma. Aedes aegypti is the main vector of the viruses that cause Yellow fever and Dengue. Other viruses, the causal agents of various types of encephalitis, are also carried by Aedes spp. mosquitoes. Wuchereria bancrofti and Brugia malayi, parasitic roundworms that cause filariasis, are usually spread by mosquitoes in the genera Culex, Mansonia, and Anopheles.

Horse flies and deer flies may transmit the bacterial pathogens of tularemia (Pasteurella tularensis) and anthrax (Bacillus anthracis), as well as a parasitic roundworm (Loa loa) that causes loiasis in tropical Africa.

Eye gnats in the genus Hippelates can carry the spirochaete pathogen that causes yaws (Treponema pertenue), and may also spread conjunctivitis (pinkeye). Tsetse flies in the genus Glossina transmit the protozoan pathogens that cause African sleeping sickness (Trypanosoma gambiense and T. rhodesiense). Sand flies in the genus Phlebotomus are vectors of a bacterium (Bartonella bacilliformis) that causes Carrion's disease (Oroyo fever) in South America. In parts of Asia and North Africa, they spread a viral agent that causes sand fly fever (Pappataci fever) as well as protozoan pathogens (Leishmania spp.) that cause Leishmaniasis.

Accordingly, in order to preserve the crops we depend on for food, and safeguard human and animal health, effective insecticidal treatments are needed.

Here we describe combinations of Insecticidal Agents (IAs) and Cysteine-Rich Insecticidal Peptides (CRIPs). IAs are one or more chemical substances, molecules, nucleotides, polynucleotides, peptides, polypeptides, proteins, toxins, toxicants, poisons, insecticides, pesticides, organic compounds, inorganic compounds, prokaryote organisms and/or the products therefrom (such as bacterial toxins), or eukaryote organisms and/or the products therefrom (such as fungal toxins). IAs can be combined to provide insecticidal effects that are greater than the additive effect of any IA used in isolation.

CRIPs are peptides, polypeptides, and/or proteins that possess cysteine residues that, in some embodiments, are capable of forming disulfide bonds; these disulfide bonds create a scaffolding motif that is observed in a wide variety of unrelated protein families. An example of peptides that fall within the CRIP family are inhibitor cystine knot (ICK) peptides. ICK peptides include many molecules that have insecticidal activity. Such ICK peptides are often toxic to naturally occurring biological target species, usually insects or arachnids of some type. Often ICK peptides can have arthropod origins such as the venoms of scorpions or spiders.

Here, we describe novel insecticidal combinations of IAs and CRIPs. For example, we describe, inter alia, an insecticidally effective combinations comprising (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), and methods of using the same to preserve the crops we depend on for food, and safeguard human and animal health.

### SUMMARY

This invention describes how to combine CRIPs and IAs so they provide insecticidal effects that are greater than the additive insecticidal effect of any IA or CRIP used in isolation. The present disclosure describes how to make and use combinations of CRIPS and IAs to kill and control insects, even insecticide-resistant insects, and even at low doses. Without being bound by theory, our understanding of CRIPs and IAs allows us to teach one ordinarily skilled in the art, to create novel methods, compositions, compounds (proteins and peptides) and procedures to protect plants and control insects.

The present disclosure describes a combination comprising a Cysteine Rich Insecticidal Peptide (CRIP) and an Insecticidal Agent (IA).

In addition, the present disclosure describes a combination comprising a Cysteine Rich Insecticidal Peptide (CRIP) and an Insecticidal Agent (IA), wherein the IA is a bacterial toxin; a fungal toxin; a lectin; an Azadirachta indica compound; a boron compound; a virus; or a combination thereof; and wherein the CRIP is a U1-agatoxin-Ta1b peptide; a U1-agatoxin-Ta1b Variant Polypeptide (TVP); a sea anemone toxin; an Av3 Variant Polypeptide (AVP); a Phoneutria toxin; or an Atracotoxin (ACTX).

In addition, the present disclosure describes a composition comprising the combination a combination comprising a Cysteine Rich Insecticidal Peptide (CRIP) and an Insecticidal Agent (IA), and further comprising an excipient.

In addition, the present disclosure describes a combination comprising one or more fermentation solids, spores, or toxins isolated from a Bacillus thuringiensis ssp. kurstaki strain EVB-113-19, and a U1-agatoxin-Ta1b peptide having an amino acid sequence according to the amino acid sequence set forth in SEQ ID NO: 1.

In addition, the present disclosure describes a combination comprising one or more fermentation solids, spores, or toxins isolated from a Bacillus thuringiensis ssp. kurstaki strain EVB-113-19, and a U1-agatoxin-Ta1b Variant Polypeptide (TVP) having an amino acid sequence according to the amino acid sequence set forth in SEQ ID NO: 2.

In addition, the present disclosure describes a combination comprising one or more fermentation solids, spores, or toxins isolated from a Bacillus thuringiensis ssp. kurstaki strain EVB-113-19, and an Av3-Variant Polypeptide (AVP) having an amino acid sequence according to the amino acid sequence set forth in SEQ ID NO: 67.

In addition, the present disclosure describes a combination comprising one or more fermentation solids, spores, or toxins isolated from a Bacillus thuringiensis ssp. kurstaki strain EVB-113-19, and a Γ-CNTX-Pn1a toxin having an amino acid sequence according to the amino acid sequence set forth in SEQ ID NO: 65.

In addition, the present disclosure describes a combination comprising a Beauveria bassiana strain ANT-03 spore, and a U+2-ACTX-Hv1a toxin having an amino acid sequence according to the amino acid sequence set forth in SEQ ID NO: 61.

In addition, the present disclosure describes a combination comprising one or more fermentation solids, spores, or toxins isolated from a Bacillus thuringiensis ssp. tenebrionis strain NB-176, and a U+2-ACTX-Hv1a toxin having an amino acid sequence according to the amino acid sequence set forth in SEQ ID NO: 61.

In addition, the present disclosure describes a combination comprising one or more fermentation solids, spores, or toxins isolated from a Bacillus thuringiensis ssp. kurstaki strain EVB-113-19, and a U+2-ACTX-Hv1a toxin having an amino acid sequence according to the amino acid sequence set forth in SEQ ID NO: 61.

In addition, the present disclosure describes a combination comprising one or more fermentation solids, spores, or toxins isolated from a Bacillus thuringiensis ssp. israelensis Strain BMP 144, and a U+2-ACTX-Hv1a toxin having an amino acid sequence according to the amino acid sequence set forth in SEQ ID NO: 61.

In addition, the present disclosure describes a combination comprising a Photorhabdus luminescens toxin, and an ACTX; wherein the Photorhabdus luminescens toxin is a Photorhabdus luminescens toxin complex (Tca) comprising a TcaA (SEQ ID NO: 616), a TcaB (SEQ ID NO: 617), a TcaC (SEQ ID NO: 618), and a TcaZ (SEQ ID NO: 619); and wherein the ACTX peptide is a U+2-ACTX-Hv1a toxin (SEQ ID NO: 61).

In addition, the present disclosure describes a combination comprising a Galanthus nivalis agglutinin (GNA), and an ACTX; wherein the GNA has an amino acid sequence as set forth in SEQ ID NO: 35; and wherein the ACTX peptide is a U+2-ACTX-Hv1a toxin having an amino acid sequence according to the amino acid sequence set forth in SEQ ID NO: 61.

In addition, the present disclosure describes a combination comprising an Azadirachtin, and an ACTX; wherein the Azadirachtin is an Azadirachtin having a chemical formula: C₃₅H₄₄O₁₆; and wherein the ACTX is a U+2-ACTX-Hv1a toxin having an amino acid sequence according to the amino acid sequence set forth in SEQ ID NO: 61.

In addition, the present disclosure describes a combination comprising a boric acid compound, and an ACTX; wherein the boric acid compound has a chemical formula of H₃BO₃; and wherein the ACTX peptide is a U+2-ACTX-Hv1a toxin having an amino acid sequence according to the amino acid sequence set forth in SEQ ID NO: 61.

In addition, the present disclosure describes a combination comprising a Cydia pomonella granulovirus (CpGV), and an ACTX; wherein the CpGV is a Cydia pomonella granulovirus isolate V22 virus; and wherein the ACTX peptide is a U+2-ACTX-Hv1a toxin having an amino acid sequence according to the amino acid sequence set forth in SEQ ID NO: 61.

In addition, the present disclosure describes a method of using a combination comprising a Cysteine Rich Insecticidal Peptide (CRIP) and an Insecticidal Agent (IA) to control insects, said method comprising, providing a combination of at least one CRIP and at least one IA, applying a combination comprising a Cysteine Rich Insecticidal Peptide (CRIP) and an Insecticidal Agent (IA) to the locus of an insect.

In addition, the present disclosure describes a method of using a combination comprising a Cysteine Rich Insecticidal Peptide (CRIP) and an Insecticidal Agent (IA) to control Bacillus thuringiensis-toxin-resistant insects comprising, providing a combination of at least one CRIP and at least on IA; and then applying said combination to the locus of an insect.

In addition, the present disclosure describes a method of combating, controlling, or inhibiting a pest comprising, applying a pesticidally effective amount of a combination comprising a Cysteine Rich Insecticidal Peptide (CRIP) and an Insecticidal Agent (IA) to the locus of the pest, or to a plant or animal susceptible to an attack by the pest.

### BRIEF DESCRIPTION OF THE DRAWINGS

FIG. 1 shows a graph depicting the 24-hour mortality of Aedes aegypti (mosquito) larvae after a diet incorporation assay using (1) U+2-ACTX-Hv1a with Bti; (2) Bti toxin alone; (3) U+2-ACTX-Hv1a alone; and (4) control (water).

FIG. 2 depicts a graph showing the 3-day mortality of the Lepidopteran species, the beet armyworm (Spodoptera exigua) after a foliar spray assay with Bacillus thuringiensis var. kurstaki toxins (Btk) combined with Γ-CNTX-Pn1a. Here, the treatments were (1) Γ-CNTX-Pn1a alone; (2) Btk toxin alone; (3) a combination of Γ-CNTX-Pn1a and Btk toxin; or (4) a control (0.125% Vintre, a surfactant).

FIG. 3 depicts a graph showing the 3-day mortality of the Lepidopteran species, the beet armyworm (Spodoptera exigua), after a foliar spray assay with Btk combined with Av3-Variant Polypeptides (AVPs). Here, (1) AVP alone; (2) Btk toxin alone; (3) a combination of both AVP and Btk toxin; or (4) a control (0.125% Vintre, a surfactant) were tested. The AVP tested here was AVPb.

FIG. 4 shows a chromatogram evaluating WT-Ta1b degradation in Helicoverpa zea gut extract (HGE), a simulated lepidopteran gut environment, after 0, 20, 40, 60, 180, and 1260 minutes. The box indicates the major and minor peaks, thus indicating the degradation of WT-Ta1b. Nested insets show zoomed in and zoomed out views of the chromatogram. The box highlights the peaks demonstrating the proteolysis event, which is evidenced by the presence of two shoulders: the smaller “shoulder” on the right side of the main peak indicates the partial proteolyzation event.

FIG. 5 shows a chromatogram evaluating TVP-R9Q degradation in Helicoverpa zea gut extract (HGE), a simulated lepidopteran gut environment, after 0, 20, 40, 60, 180, and 1260 minutes. The box indicates the presence of single peak, thus indicating the stability of TVP-R9Q. Nested insets show zoomed in and zoomed out views of the chromatogram. Here, the presence of a single main peak (shown in the box) indicates the stability of the TVP-R9Q peptide.

FIG. 6 depicts a graph showing the results of a defoliation assay when testing WT-Ta1b, Btk toxins, and combinations thereof against the Lepidopteran species, Helicoverpa zea (corn earworm). Treatments were as follows: (1) WT-Ta1b alone; (2) Btk toxin alone; (3) a combination of both WT-Ta1b and Btk toxin; or (4) a control (0.125% Vintre, a surfactant). Here, Btk toxins are shown as “Btk”

FIG. 7 depicts a graph showing the results of a defoliation assay when testing TVP-R9Q, Btk toxins, and combinations thereof against the Lepidopteran species, Helicoverpa zea (corn earworm). Treatments were as follows: (1) TVP-R9Q alone; (2) Btk toxin alone; (3) a combination of both TVP-R9Q and Btk toxin; or (4) a control (0.125% Vintre, a surfactant). Here, Btk toxins are shown as “Btk”

FIG. 8 depicts a graph showing the results of a mortality assay when testing WT-Ta1b, Btk toxins, and combinations thereof against the Lepidopteran species, Helicoverpa zea (corn earworm). Treatments were as follows: (1) WT-Ta1b alone; (2) Btk toxin alone; (3) a combination of both WT-Ta1b and Btk toxin; or (4) a control (0.125% Vintre, a surfactant). Here, Btk toxins are shown as “Btk”

FIG. 9 depicts a graph showing the results of a mortality assay when testing TVP-R9Q, Btk toxins, and combinations thereof against the Lepidopteran species, Helicoverpa zea (corn earworm). Treatments were as follows: (1) TVP-R9Q alone; (2) Btk toxin alone; (3) a combination of both TVP-R9Q and Btk toxin; or (4) a control (0.125% Vintre, a surfactant). Here, Btk toxins are shown as “Btk”

FIG. 10 depicts a graph showing the 4-day mortality of the Coleopteran species, the Darkling Beetle (Alphilobius diaperinus) after a diet incorporation assay with (1) U+2-ACTX-Hv1a alone; (2) Btt toxin alone; (3) a combination of both U+2-ACTX-Hv1a and Btt toxin; or (4) an untreated control (water).

FIG. 11 depicts a graph showing the 4-day mortality of the Colorado potato beetle (Leptinotarsa decemlineata) when sprayed with (1) U+2-ACTX-Hv1a alone; (2) Btt toxin alone; (3) a combination of both U+2-ACTX-Hv1a and Btt toxin; or (4) an untreated control (water).

FIG. 12 depicts a graph showing mortality at day 4 in corn earworm larvae treated with: (a) Water; (b) Photorhabdus luminescens toxin complex extract alone (4.75% v/v); (c) 10 mg/mL U+2-ACTX-Hv1a (1% w/v); and (d) Photorhabdus luminescens toxin complex extract (4.75% w/v) with 10 mg/mL U+2-ACTX-Hv1a (1% w/v). Here, % w/v is percent w/v of the total volume of the composition, with the remainder being water.

FIG. 13 depicts a graph showing the mortality rate in corn earworm neonates on day three after being treated with (a) 0 mg/mL GNA (0% w/v); with 0 mg/mL U+2-ACTX-Hv1a (0% w/v) (control); (b) 2.5 mg/mL GNA (0.25% w/v); 0 mg/mL U+2-ACTX-Hv1a (0% w/v); (c) 0 mg/mL GNA (0% w/v); 5 mg/mL U+2-ACTX-Hv1a (0.5% w/v); and (d) 2.5 mg/mL GNA (0.25% w/v); 5 mg/mL U+2-ACTX-Hv1a (0.5% w/v). Here, % w/v is percent w/v of the total volume of the composition, with the remainder being water. Proportional mortality refers to the proportion of individual insects killed over the course of an experiment, i.e., the number of dead individuals over the total number of individuals.

FIG. 14 depicts a graph showing the mortality rate in Fall armyworm (Spodoptera frugiperda) larvae on day three after being treated with (a) Chitinase 0 μL/L (0% w/v); U+2-ACTX-Hv1a 0 mg/mL (0% w/v); Sucrose (10% w/v); (b) Chitinase 100 μL/L (0.01% w/v); U+2-ACTX-Hv1a 0 mg/mL (0% w/v); Sucrose (10% w/v); (c) Chitinase μL/L (0% w/v); U+2-ACTX-Hv1a 5 mg/mL (0.5% w/v); Sucrose (10% w/v); and (d) Chitinase 100 μL/L (0.01% w/v); U+2-ACTX-Hv1a 5 mg/mL (0.5% w/v); Sucrose (10% w/v). Here, % w/v is percent w/v of the total volume of the composition, with the remainder being water.

FIG. 15 depicts the chemical structure of the insect growth regulator, Azadirachtin.

FIG. 16 depicts a graph showing the mortality rate in Corn earworm (Helicoverpa zea) neonates on day three after being treated with (a) 0 Azadirachtin (0% v/v); 0 mg/mL U+2-ACTX-Hv1a (0% w/v) (control); (b) 80 μL/L Azadirachtin (0.008% v/v); 0 mg/mL U+2-ACTX-Hv1a (0% w/v); (c) 0 μL/L Azadirachtin (0% v/v); 10 mg/mL U+2-ACTX-Hv1a (1% w/v); and (d) 80 μL/L Azadirachtin (0.008% v/v); 10 mg/mL of U+2-ACTX-Hv1a (1% w/v). Here, % w/v is percent w/v of the total volume of the composition, with the remainder being water.

FIG. 17 depicts a graph showing the mortality rate in Lesser mealworm (Alphitobius diaperinus) neonates on day three after being treated with the following: (a) 0 mg/mL U+2-ACTX-Hv1a (0% w/v); 0 mg/mL boric acid (0% w/v) (control); (b) 0 mg/mL U+2-ACTX-Hv1a (0% w/v); 2.5 mg/mL boric acid (0.25% w/v); (c) 1 mg/mL U+2-ACTX-Hv1a (0.1% w/v); 0 mg/mL boric acid (0% w/v); and (d) 1 mg/mL U+2-ACTX-Hv1a (0.1% w/v); 2.5 mg/mL boric acid (0.25% w/v). Here, % w/v is percent w/v of the total volume of the composition, with the remainder being water.

FIG. 18 depicts a graph showing the mortality rate in Codling Moths (Cydia pomonella) neonates on day seven after being treated with the following: (a) 0 mg/mL Beauveria bassiana toxins (0% w/v); 0 mg/mL of U+2-ACTX-Hv1a (0% w/v) (control); (b) 1.2 mg/mL Beauveria bassiana toxins (0.12% w/v); 0 mg/mL of U+2-ACTX-Hv1a (0% w/v); (c) 0 mg/mL Beauveria bassiana toxins; 2 mg/mL of U+2-ACTX-Hv1a (0.2% w/v); and (d) 1.2 mg/mL Beauveria bassiana toxins (0.12% w/v); 2 mg/mL of U+2-ACTX-Hv1a (0.2% w/v). Here, % w/v is percent w/v of the total volume of the composition, with the remainder being water.

FIG. 19 depicts a graph showing the mortality rate in Codling Moths (Cydia pomonella) neonates on day two after being treated with (a) 0 μL/L of CpGV (0% w/v); 0 mg/mL of U+2-ACTX-Hv1a (0% w/v) (control); (b) 58.5 μL/L of CpGV (0.00585% w/v); 0 mg/mL of U+2-ACTX-Hv1a (0% w/v); (c) 0 μL/L of CpGV (0% w/v); 2 mg/mL of U+2-ACTX-Hv1a (0.2% w/v); and (d) 58.5 μL/L of CpGV (0.00585% w/v); 2 mg/mL of U+2-ACTX-Hv1a (0.2% w/v Here, % w/v is percent w/v of the total volume of the composition, with the remainder being water.

FIG. 20 depicts a graphs showing the results of a diet incorporation assay of Novaluron with U+2-ACTX-Hv1a, and evaluating mortality in corn earworm (Helicoverpa zea) after 3-days. As shown here, there was no evidence of a greater than additive effect when combining Novaluron with U+2-ACTX-Hv1a in a corn earworm (Helicoverpa zea) diet incorporation assay. Here, “U+2” refers to U+2-ACTX-Hv1a. Concentrations of Novaluron were as follows: (a) 80 μL/L, of Novaluron (0.008% w/v); (b) 8 μL/L of Novaluron (0.0008% w/v); (c) 0.8 μL/L, of Novaluron (0.00008% w/v); and (d) 0 μL/L, of Novaluron (0% w/v). 10 ppt of Spear corresponds to 1 mg/mL (1% w/v) of U+2-ACTX-Hv1a.

FIG. 21 depicts a graphs showing the results of a diet incorporation assay of nanoparticles and U+2-ACTX-Hv1a, and evaluating mortality in corn earworm (Helicoverpa zea) after 3-days. As shown here, there was no evidence of a greater than additive effect when combining nanoparticles with U+2-ACTX-Hv1a in a corn earworm (Helicoverpa zea) diet incorporation assay. Here, “Spear” refers to U+2-ACTX-Hv1a. Concentrations of nanoparticles were as follows: (a) 50 nm silica aminated (2700 ppm); (b) 50 silica (2575 ppm); (c) 20 nm silica (1177 ppm); and (d) 10 nm silica (12500 ppm). Here, “U+2” corresponds to 5 ppt of, U+2-ACTX-Hv1a, i.e., 0.5 mg/mL (0.5% w/v of the total volume of the composition) of U+2-ACTX-Hula. Proportional mortality=the number of dead insects divided by the total number of insects. “UTC” means untreated control (water).

FIG. 22 depicts a graph showing the mortality dose response of a diet incorporation assay of cryolite and U+2-ACTX-Hv1a against corn earworm (Helicoverpa zea) after 3 days. As shown here, there was no evidence of a greater than additive effect when combining cryolite with U+2-ACTX-Hv1a in a corn earworm (Helicoverpa zea) diet incorporation assay. Here, “U+2” refers to U+2-ACTX-Hv1a. Concentrations of nanoparticles were as follows: (a) 10000 ppm; (b) 2000 ppm; (c) 400 ppm; and (d) 0 ppm. Here, 10 ppt of “U+2” (i.e., U+2-ACTX-Hv1a) corresponds to 1 mg/mL (1% w/v of the total volume of the composition) of U+2-ACTX-Hv1a. Proportional mortality=the number of dead insects divided by the total number of insects.

### DETAILED DESCRIPTION

### Definitions

“5′-end” and “3′-end” refers to the directionality, i.e., the end-to-end orientation of a nucleotide polymer (e.g., DNA). The 5′-end of a polynucleotide is the end of the polynucleotide that has the fifth carbon.

“5′- and 3′-homology arms” or “5′ and 3′ arms” or “left and right arms” refers to the polynucleotide sequences in a vector and/or targeting vector that homologously recombine with the target genome sequence and/or endogenous gene of interest in the host organism in order to achieve successful genetic modification of the host organism's chromosomal locus.

“Γ-CNTX-Pn1a” or “γ-CNTX-Pn1a” or “gamma-CNTX-Pn1a” or “gamma” refers to an insecticidal neurotoxin derived from the Brazilian armed spider, Phoneutria nigriventer. Γ-CNTX-Pn1a targets the N-methyl-D-aspartate (NMDA)-subtype of ionotropic glutamate receptor (GRIN), and sodium channels.

“ω/κ-HXTX-Hv1a” or “omega/kappa-HXTX-Hv1a,” refers to the insecticidal toxin derived from the Australian Blue Mountain Funnel-web Spider, Hadronyche versuta. ω/κ-HXTX-Hv1a is a type of ACTX peptide, i.e., a family of insecticidal ICK peptides that have been isolated from spiders belonging to the Atracinae family. ω/κ-HXTX-Hv1a is a positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties.

“ACTX” or “ACTX peptide” or “atracotoxin” refers to a family of insecticidal ICK peptides that have been isolated from spiders belonging to the Atracinae family. One such spider is known as the Australian Blue Mountains Funnel-web Spider, which has the scientific name Hadronyche versuta. Two examples of ACTX peptides from this species are the Omega and U peptides.

“ADN1 promoter” refers to the DNA segment comprised of the promoter sequence derived from the Schizosaccharomyces pombe adhesion defective protein 1 gene.

“Alpha-MF signal” or “αMF secretion signal” refers to a protein that directs nascent recombinant polypeptides to the secretory pathway.

“Agriculturally-acceptable carrier” covers all adjuvants, inert components, dispersants, surfactants, tackifiers, binders, etc. that are ordinarily used in pesticide formulation technology; these are well known to those skilled in pesticide formulation.

“Agriculturally acceptable salt” is used herein synonymously with the term “pharmaceutically acceptable salt.”

“Agroinfection” means a plant transformation method where DNA is introduced into a plant cell by using Agrobacteria tumefaciens or Agrobacteria rhizogenes.

“Alignment” refers to a method of comparing two or more sequences (e.g., nucleotide, polynucleotide, amino acid, peptide, polypeptide, or protein sequences) for the purpose of determining their relationship to each other. Alignments are typically performed by computer programs that apply various algorithms, however, it is also possible to perform an alignment by hand. Alignment programs typically iterate through potential alignments of sequences and score the alignments using substitution tables, employing a variety of strategies to reach a potential optimal alignment score. Commonly-used alignment algorithms include, but are not limited to, CLUSTALW (see Thompson J. D., Higgins D. G., Gibson T. J., CLUSTAL W: improving the sensitivity of progressive multiple sequence alignment through sequence weighting, position-specific gap penalties and weight matrix choice, Nucleic Acids Research 22: 4673-4680, 1994); CLUSTALV (see Larkin M. A., et al., CLUSTALW2, ClustalW and ClustalX version 2, Bioinformatics 23(21): 2947-2948, 2007); Mafft; Kalign; ProbCons; and T-Coffee (see Notredame et al., T-Coffee: A novel method for multiple sequence alignments, Journal of Molecular Biology 302: 205-217, 2000). Exemplary programs that implement one or more of the foregoing algorithms include, but are not limited to, MegAlign from DNAStar (DNAStar, Inc. 3801 Regent St. Madison, Wis. 53705), MUSCLE, T-Coffee, CLUSTALX, CLUSTALV, JalView, Phylip, and Discovery Studio from Accelrys (Accelrys, Inc., 10188 Telesis Ct, Suite 100, San Diego, Calif. 92121). In some embodiments, an alignment will introduce “phase shifts” and/or “gaps” into one or both of the sequences being compared in order to maximize the similarity between the two sequences, and scoring refers to the process of quantitatively expressing the relatedness of the aligned sequences.

“Alpha-MF signal” or “αMF secretion signal” refers to a protein that directs nascent recombinant polypeptides to the secretory pathway.

“Arachnid” refers to a class of arthropods. For example in some embodiments, arachnid can mean spiders, scorpions, ticks, mites, harvestmen, or solifuges.

“Av2” or “ATX-II” or “neurotoxin 2” or “Anemonia viridis toxin 2” or δ-AITX-Avd1c” refers to a toxin isolated from the venom of Anemonia sulcata. One example of an Av2 polypeptide is a polypeptide having the amino acid sequence of SEQ ID NO: 588.

“Av3” refers to a polypeptide isolated from the sea anemone, Anemonia viridis, which can target receptor site 3 on α-subunit III of voltage-gated sodium channels. One example of an Av3 polypeptide is an Av3 polypeptide having the amino acid sequence of SEQ ID NO: 44 (NCBI Accession No. P01535.1).

“AVP” or “Av3 variant polypeptides” refers to an Av3 polypeptide sequence and/or a polypeptide encoded by a variant Av3 polynucleotide sequence that has been altered to produce a non-naturally occurring polypeptide and/or polynucleotide sequence.

“BAAS” means barley alpha-amylase signal peptide, and is an example of an ERSP. One example of a BAAS is a BAAS having the amino acid sequence of SEQ ID NO:37 (NCBI Accession No. AAA32925.1).

“Biomass” refers to any measured plant product.

“Binary vector” or “binary expression vector” means an expression vector which can replicate itself in both E. coli strains and Agrobacterium strains. Also, the vector contains a region of DNA (often referred to as t-DNA) bracketed by left and right border sequences that is recognized by virulence genes to be copied and delivered into a plant cell by Agrobacterium.

“bp” or “base pair” refers to a molecule comprising two chemical bases bonded to one another. For example, a DNA molecule consists of two winding strands, wherein each strand has a backbone made of an alternating deoxyribose and phosphate groups. Attached to each deoxyribose is one of four bases, i.e., adenine (A), cytosine (C), guanine (G), or thymine (T), wherein adenine forms a base pair with thymine, and cytosine forms a base pair with guanine.

“Bt toxins” refers to fermentation solids, spores, and toxins produced by Bacillus thuringiensis (Bt)—a Gram positive, spore-forming bacterium, such as Bacillus thuringiensis var. kurstaki (Btk), Bacillus thuringiensis var. tenebrionis (Btt), and Bacillus thuringiensis var. israelensis (Bti). During sporulation, Bacillus thuringiensis produces crystal proteins (i.e., proteinaceous inclusions), called δ-endotoxins, that have insecticidal action. In some embodiments, a Bt toxin can be crystal (Cry) proteins, cytolytic (Cyt) proteins, vegetative insecticidal proteins (Vips), or other toxin produced by a Bacillus thuringiensis.

“Bt-resistant” or “Bt-resistance” or “Bt-resistant insect” or “Bacillus thuringiensis-toxin-resistant insects” refers to a heritable change in the sensitivity of a pest population that is reflected in the repeated failure of a product (e.g., Bt) to achieve the expected level of control when used against that pest species.

“C-terminal” refers to the free carboxyl group (i.e., —COOH) that is positioned on the terminal end of a polypeptide.

“cDNA” or “copy DNA” or “complementary DNA” refers to a molecule that is complementary to a molecule of RNA. In some embodiments, cDNA may be either single-stranded or double-stranded. In some embodiments, cDNA can be a double-stranded DNA synthesized from a single stranded RNA template in a reaction catalyzed by a reverse transcriptase. In yet other embodiments, “cDNA” refers to all nucleic acids that share the arrangement of sequence elements found in native mature mRNA species, where sequence elements are exons and 3′ and 5′ non-coding regions. Normally mRNA species have contiguous exons, with the intervening introns removed by nuclear RNA splicing, to create a continuous open reading frame encoding the protein. In some embodiments, “cDNA” refers to a DNA that is complementary to and derived from an mRNA template.

“CEW” refers to Corn earworm.

“Cleavable Linker” see Linker.

“Cloning” refers to the process and/or methods concerning the insertion of a DNA segment (e.g., usually a gene of interest, for example tvp) from one source and recombining it with a DNA segment from another source (e.g., usually a vector, for example, a plasmid) and directing the recombined DNA, or “recombinant DNA” to replicate, usually by transforming the recombined DNA into a bacteria or yeast host.

“Chimeric gene” means a DNA sequence that encodes a gene derived from portions of one or more coding sequences to produce a new gene.

“Coding sequence” or “CDS” refers to a polynucleotide or nucleic acid sequence that can be transcribed (e.g., in the case of DNA) or translated (e.g., in the case of mRNA) into a peptide, polypeptide, or protein, when placed under the control of appropriate regulatory sequences and in the presence of the necessary transcriptional and/or translational molecular factors. The boundaries of the coding sequence are determined by a translation start codon at the 5′ (amino) terminus and a translation stop codon at the 3′ (carboxy) terminus. A transcription termination sequence will usually be located 3′ to the coding sequence. In some embodiments, a coding sequence may be flanked on the 5′ and/or 3′ ends by untranslated regions. In some embodiments, a coding sequence can be used to produce a peptide, a polypeptide, or a protein product. In some embodiments, the coding sequence may or may not be fused to another coding sequence or localization signal, such as a nuclear localization signal. In some embodiments, the coding sequence may be cloned into a vector or expression construct, may be integrated into a genome, or may be present as a DNA fragment.

“Codon optimization” refers to the production of a gene in which one or more endogenous, native, and/or wild-type codons are replaced with codons that ultimately still code for the same amino acid, but that are of preference in the corresponding host.

“Combination” refers to any association between two or among more items. The association can be spatial, temporal, and/or refer to the use of the two or more items for a common purpose. For example, a combination can be any spatiotemporal association, mixture, or permutation of: (1) one or more CRIPs, or pharmaceutically acceptable salt thereof; CRIP-insecticidal proteins, or pharmaceutically acceptable salt thereof; or combination thereof; and (2) one or more Insecticidal Agents (IA), as described herein, wherein (1) and (2) are used for the common purpose controlling or combating insect pests, such that the insect pest either dies, stops, or slows its movement; stops or slows its feeding; stops or slows its growth; becomes confused (e.g., with regard to navigation, locating food, sleeping behaviors, and/or mating); fails to pupate; interferes with reproduction; and/or precludes the insect from producing offspring and/or precludes the insect from producing fertile offspring.

Unless the context makes clear otherwise, the term “combination” may include simultaneous, separate, or sequentially administration of: (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA), in any order of sequence.

It will be appreciated that in some embodiments, (1) one or more CRIPs, or pharmaceutically acceptable salt thereof; CRIP-insecticidal proteins, or pharmaceutically acceptable salt thereof; or combination thereof; and (2) one or more Insecticidal Agents (IA), are considered to be administered as a “combination or “in combination” whenever a pest or the locus of a pest is exposed to, or a locus to be protected from a pest (e.g., a plant) is treated with, a simultaneous exposure to both (1) and (2). In some embodiments, each of the (1) one or more CRIPs, or pharmaceutically acceptable salt thereof; CRIP-insecticidal proteins, or pharmaceutically acceptable salt thereof; or combination thereof; and (2) one or more Insecticidal Agents (IA), may be administered sequentially or according to a different schedule—indeed, it is not required that individual doses of different agents be administered at the same time, or in the same composition. Rather, so long as both the (1) one or more CRIPs, or pharmaceutically acceptable salt thereof; CRIP-insecticidal proteins, or pharmaceutically acceptable salt thereof; or combination thereof; and (2) one or more Insecticidal Agents (IA), remain pesticidally-effective (i.e., having insecticidal activity), they are considered to be administered “in combination.”

In some embodiments, “combination” refers to simultaneous administration of: (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA).

In some embodiments, “combination” refers to separate administration of: (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA).

In yet other embodiments, “combination” refers to sequential administration of (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA), in any order.

In some embodiments of the present invention, i.e., wherein the administration of the combination is sequential or separate, the delay in administering the second component should not be such as to lose the beneficial effect of the combination in its entirety, i.e., the combination of (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA). Where a combination of two or more components is administered separately or sequential, it will be understood that the dosage regime for each component may be different to and independent of the other components.

In some embodiments, the one or more CRIPs, or pharmaceutically acceptable salts thereof; one or more CRIP-insecticidal proteins, or pharmaceutically acceptable salts thereof; or a combination thereof, can be administered on the same day as the one or more Insecticidal Agents (IA). In other embodiments, the one or more CRIPs, or pharmaceutically acceptable salts thereof; one or more CRIP-insecticidal proteins, or pharmaceutically acceptable salts thereof; or a combination thereof, may be administered in the same week, or the same month as the one or more Insecticidal Agents (IA).

In some embodiments, a combination can be a “mixture.” As used herein, “mixture” refers to a combination of two or more agents, e.g., (1) one or more CRIPs, or pharmaceutically acceptable salts thereof; one or more CRIP-insecticidal proteins, or pharmaceutically acceptable salts thereof; or a combination thereof; with (2) one or more Insecticidal Agents (IA), that are in physical and/or chemical contact with one another.

“Complementary” refers to the topological compatibility or matching together of interacting surfaces of two polynucleotides as understood by those of skill in the art. Thus, two sequences are “complementary” to one another if they are capable of hybridizing to one another to form a stable anti-parallel, double-stranded nucleic acid structure. A first polynucleotide is complementary to a second polynucleotide if the nucleotide sequence of the first polynucleotide is substantially identical to the nucleotide sequence of the polynucleotide binding partner of the second polynucleotide, or if the first polynucleotide can hybridize to the second polynucleotide under stringent hybridization conditions. Thus, the polynucleotide whose sequence 5′-TATAC-3′ is complementary to a polynucleotide whose sequence is 5′-GTATA-3′.

“Conditioned medium” means the cell culture medium which has been used by cells and is enriched with cell derived materials but does not contain cells.

“Cone shell” or “cone snails” or “cones” refers to organisms belonging to the Conus genus of predatory marine gastropods. For example, in some embodiments, a cone shell can be one of the following species: Conus amadis; Conus catus; Conus ermineus; Conus geographus; Conus gloriamaris; Conus kinoshitai; Conus magus; Conus marmoreus; Conus purpurascens; Conus stercusmuscarum; Conus striatus; Conus textile; or Conus tulipa.

“Conotoxin” refers to the toxins isolated from cone shells that act by interfering with neuronal communication. For example, in some embodiments, a conotoxin can be an α-, ω-, δ-, or κ-conotoxins. Briefly, the α-conotoxins (and αA-&φ-conotoxins) target nicotinic ligand gated channels; ω-conotoxins target voltage-gated calcium channels; μ-conotoxins target the voltage-gated sodium channels; δ-conotoxins target the voltage-gated sodium channel; and κ-conotoxins target the voltage-gated potassium channel.

“Copy number” refers to the number of identical copies of a vector, an expression cassette, an amplification unit, a gene or indeed any defined nucleotide sequence, that are present in a host cell at any time. For example, in some embodiments, a gene or another defined chromosomal nucleotide sequence may be present in one, two, or more copies on the chromosome. An autonomously replicating vector may be present in one, or several hundred copies per host cell.

“CRIP” refers to Cysteine Rich Insecticidal Peptide. CRIPs are peptides rich in cysteine residues that, in some embodiments, are operable to form disulfide bonds between such cysteine residues. In some embodiments, CRIPS contain at least four (4), sometimes six (6), and sometimes eight (8) cysteine amino acids among proteins or peptides having at least 10 amino acids where the cysteines form two (2), three (3) or four (4) disulfide bonds. In some embodiments, the disulfide bonds contribute to the folding, three-dimensional structure, and activity of the insecticidal peptide. The cysteine-cysteine disulfide bonds, and the three dimensional structure they form, play a significant role in the insecticidal nature of these insecticidal peptides. In some embodiments, a CRIP may or may not comprise an inhibitor cystine knot (ICK) motif. For example, in some embodiments, a CRIP with an ICK motif can be an ACTX peptide from a spider; in other embodiments, a CRIP without an ICK motif, i.e., a non-ICK CRIP, can be a peptide like Av2 and Av3, peptides isolated from sea anemones. Non-ICK CRIPS can have 4-8 cysteines which form 2-4 disulfide bonds. These cysteine-cysteine disulfide bonds stabilized toxic peptides (CRIPS) can have remarkable stability when exposed to the environment. Many CRIPS are isolated from venomous animals such as spiders, scorpions, snakes and sea snails and sea anemones and they are toxic to insects.

“CRIP construct” refers to the three-dimensional arrangement/orientation of peptides, polypeptides, and/or motifs of operably linked polypeptide segments (e.g., a CRIP-insecticidal protein). For example, a CRIP expression ORF can include one or more of the following components or motifs: a CRIP; an endoplasmic reticulum signal peptide (ERSP); a linker peptide (L); a translational stabilizing protein (STA); or any combination thereof. And, as used herein, the term “CRIP construct” is used to describe the designation and/or orientation of the structural motif. In other words, the CRIP construct describes the arrangement and orientation of the components or motifs contained within a given CRIP expression ORF. For example, in some embodiments, a CRIP construct describes, without limitation, the orientation of one of the following CRIP-insecticidal proteins: ERSP-CRIP; ERSP-(CRIP)_{N}; ERSP-CRIP-L; ERSP-(CRIP)_{N}-L; ERSP-(CRIP-L)_{N}; ERSP-L-CRIP; ERSP-L-(CRIP)_{N}; ERSP-(L-CRIP)_{N}; ERSP-STA-CRIP; ERSP-STA-(CRIP)_{N}; ERSP-CRIP-STA; ERSP-(CRIP)_{N}-STA; ERSP-(STA-CRIP)_{N}; ERSP-(CRIP-STA)_{N}; ERSP-L-CRIP-STA; ERSP-L-STA-CRIP; ERSP-L-(CRIP-STA)_{N}; ERSP-L-(STA-CRIP)_{N}; ERSP-L-(CRIP)_{N}-STA; ERSP-(L-CRIP)_{N}-STA; ERSP-(L-STA-CRIP)_{N}; ERSP-(L-CRIP-STA)_{N}; ERSP-(L-STA)_{N}-CRIP; ERSP-(L-CRIP)_{N}-STA; ERSP-STA-L-CRIP; ERSP-STA-CRIP-L; ERSP-STA-L-(CRIP)_{N}; ERSP-(STA-L)_{N}-CRIP; ERSP-STA-(L-CRIP)_{N}; ERSP-(STA-L-CRIP)_{N}; ERSP-STA-(CRIP)_{N}-L; ERSP-STA-(CRIP-L)_{N}; ERSP-(STA-CRIP)_{N}-L; ERSP-(STA-CRIP-L)_{N}; ERSP-CRIP-L-STA; ERSP-CRIP-STA-L; ERSP-(CRIP)_{N}-STA-L ERSP-(CRIP-L)_{N}-STA; ERSP-(CRIP-STA)_{N}-L; ERSP-(CRIP-L-STA)_{N}; or ERSP-(CRIP-STA-L)_{N}; wherein N is an integer ranging from 1 to 200. See also “Structural motif.”

“CRIP ORF diagram” refers to the composition of one or more CRIP ORFs, as written out in diagram or equation form. For example, a “CRIP ORF diagram” can be written out as using acronyms or short-hand references to the DNA segments contained within the ORF. Accordingly, in one example, a “CRIP ORF diagram” may describe the polynucleotide segments encoding the ERSP, L, STA, and CRIP, by diagramming in equation form the DNA segments as “ersp” (i.e., the polynucleotide sequence that encodes the ERSP polypeptide); “linker” or “L” (i.e., the polynucleotide sequence that encodes the LINKER polypeptide); “sta” (i.e., the polynucleotide sequence that encodes the STA polypeptide), and “crip” (i.e., the polynucleotide sequence encoding a CRIP), respectively. An example of a CRIP ORF diagram is “ersp-sta-(linkerᵢ−cripⱼ)_{N},” or “ersp-(cripⱼ-linkerᵢ)_{N}-sta” and/or any combination of the DNA segments thereof.

“CRIP polynucleotide” refers to a polynucleotide or group of polynucleotides operable to express and/or encode an insecticidal protein comprising one or more CRIPs in addition to one or more non-CRIP polypeptides or proteins.

“CRIP-insecticidal protein” refers to any protein, peptide, polypeptide, amino acid sequence, configuration, or arrangement, consisting of: (1) at least one CRIP, or two or more CRIPs; and (2) additional peptides, polypeptides, or proteins, wherein said additional peptides, polypeptides, or proteins have the ability to do one or more of the following: (a) increase the mortality and/or inhibit the growth of insects when the insects are exposed to a CRIP-insecticidal protein, relative to a CRIP alone; (b) increase the expression of said CRIP-insecticidal protein, e.g., in a host cell or an expression system; and/or (c) affect the post-translational processing of the CRIP-insecticidal protein.

In some embodiments, an insecticidal protein can comprise a one or more CRIPs as disclosed herein. In some embodiments, a CRIP-insecticidal protein can be a polymer comprising two or more CRIPs. In some embodiments, the insecticidal protein can comprise a CRIP homopolymer, e.g., two or more CRIP monomers that are the same CRIP. In some embodiments, the insecticidal protein can comprise a CRIP heteropolymer, e.g., two or more CRIP monomers, wherein the CRIP monomers are different.

In some embodiments, a CRIP-insecticidal protein can be a polymer of amino acids that when properly folded or in its most natural thermodynamic state exerts an insecticidal activity against one or more insects.

In some embodiments, a CRIP-insecticidal protein can be a polymer comprising two or more CRIPs, wherein the CRIPs are operably linked via a linker peptide, e.g., a cleavable and/or non-cleavable linker. In some embodiments, a CRIP-insecticidal protein can refer to a one or more CRIPs operably linked with one or more proteins such as a stabilizing domain (STA); an endoplasmic reticulum signaling protein (ERSP); an insect cleavable or insect non-cleavable linker (L); and/or any other combination thereof. In some embodiments, a CRIP-insecticidal protein can be a non-naturally occurring protein comprising (1) a wild-type CRIP protein; and (2) additional peptides, polypeptides, or proteins, e.g., an ERSP; a linker; a STA; a UBI; or a histidine tag or similar marker.

“Culture” or “cell culture” refers to the maintenance of cells in an artificial, in vitro environment.

“Culturing” refers to the propagation of organisms on or in various kinds of media. For example, the term “culturing” can mean growing a population of cells under suitable conditions in a liquid or solid medium. In some embodiments, culturing refers to fermentative recombinant production of a heterologous polypeptide of interest and/or other desired end products (typically in a vessel or reactor).

“Cystine” refers to an oxidized cysteine-dimer. Cystines are sulfur-containing amino acids obtained via the oxidation of two cysteine molecules, and are linked with a disulfide bond.

“Defined medium” means a medium that is composed of known chemical components but does not contain crude proteinaceous extracts or by-products such as yeast extract or peptone.

“Degeneracy” or “codon degeneracy” refers to the phenomenon that one amino acid can be encoded by different nucleotide codons. Thus, the nucleic acid sequence of a nucleic acid molecule that encodes a protein or polypeptide can vary due to degeneracies. As a result of the degeneracy of the genetic code, many nucleic acid sequences can encode a given polypeptide with a particular activity; such functionally equivalent variants are contemplated herein.

“Desmethyllimocin B” refers to [(5R,7R,8R,9R,10R,13S,17S)-17-[(3R)-5-Hydroxyoxolan-3-yl]-4,4,8,10,13-pentamethyl-3,16-dioxo-6,7,9,11,12,17-hexahydro-5H-cyclopenta[a]phenanthren-7-yl] acetate.

“Disulfide bond” means a covalent bond between two cysteine amino acids derived by the coupling of two thiol groups on their side chains.

“DNA” refers to deoxyribonucleic acid, comprising a polymer of one or more deoxyribonucleotides or nucleotides (i.e., adenine [A], guanine [G], thymine [T], or cytosine [C]), which can be arranged in single-stranded or double-stranded form. For example, one or more nucleotides creates a polynucleotide.

“dNTPs” refers to the nucleoside triphosphates that compose DNA and RNA.

“Double expression cassette” refers to two heterologous polypeptide expression cassettes contained on the same vector.

“Double transgene peptide expression vector” or “double transgene expression vector” means a yeast expression vector that contains two copies of the heterologous polypeptide expression cassette.

“Endogenous” refers to a polynucleotide, peptide, polypeptide, protein, or process that naturally occurs and/or exists in an organism, e.g., a molecule or activity that is already present in the host cell before a particular genetic manipulation.

“Enhancer element” refers to a DNA sequence operably linked to a promoter, which can exert increased transcription activity on the promoter relative to the transcription activity that results from the promoter in the absence of the enhancer element.

“ER” or “Endoplasmic reticulum” is a subcellular organelle common to all eukaryotes where some post translation modification processes occur.

“ERSP” or “endoplasmic reticulum signal peptide” is an N-terminus sequence of amino acids that—during protein translation of the mRNA molecule encoding a CRIP—is recognized and bound by a host cell signal-recognition particle, which moves the protein translation ribosome/mRNA complex to the ER in the cytoplasm. The result is the protein translation is paused until it docks with the ER where it continues and the resulting protein is injected into the ER.

“ersp” refers to a polynucleotide encoding the peptide, ERSP.

“ER trafficking” means transportation of a cell expressed protein into ER for post-translational modification, sorting and transportation.

“Excipient” refers to any pharmacologically inactive, natural, or synthetic, component or substance that is formulated alongside (e.g., concomitantly), or subsequent to, the active ingredient of the present invention (i.e., a CRIP or CRIP-insecticidal protein). In some embodiments, an excipient can be any additive, adjuvant, binder, bulking agent, carrier, coating, diluent, disintegrant, filler, glidant, lubricant, preservative, vehicle, or combination thereof, with which a CRIP or CRIP-insecticidal protein of the present invention can be administered, and or which is useful in preparing a composition of the present invention. Excipients, include any such materials known in the art that are nontoxic and do not interact with other components of a composition. In some embodiments, excipients can be formulated alongside a CRIP or CRIP-insecticidal protein when preparing a composition for the purpose of bulking up compositions (thus often referred to as bulking agents, fillers or diluents). In other embodiments, an excipient can be used to confer an enhancement on the active ingredient in the final dosage form, such as facilitating absorption and/or solubility. In yet other embodiments, an excipient can be used to provide stability, or prevent contamination (e.g., microbial contamination). In other embodiments, an excipient can be used to confer a physical property to a composition (e.g., a composition that is a dry granular, or dry flowable powder physical form). Reference to an excipient includes both one and more than one such excipients. Suitable pharmaceutical excipients are described in Remington's Pharmaceutical Sciences, by E. W. Martin, the disclosure of which is incorporated herein by reference in its entirety.

“Expression cassette” refers to (1) a DNA sequence of interest, e.g., a polynucleotide operable to encode a CRIP; and one or more of the following: (2) promoters, terminators, and/or enhancer elements; (3) an appropriate mRNA stabilizing polyadenylation signal; (4) an internal ribosome entry site (IRES); (5) introns; and/or (6) post-transcriptional regulatory elements. The combination (1) with at least one of (2)-(6) is called an “expression cassette.” In some embodiments, there can be numerous expression cassettes cloned into a vector. For example, in some embodiments, there can be a first expression cassette comprising a polynucleotide operable to encode a CRIP. In alternative embodiments, there are two expression cassettes, each comprising a polynucleotide operable to encode a CRIP (i.e., a double expression cassette). In other embodiments, there are three expression cassettes operable to encode a CRIP (i.e., a triple expression cassette). In some embodiments, a double expression cassette can be generated by subcloning a second expression cassette into a vector containing a first expression cassette. In some embodiments, a triple expression cassette can be generated by subcloning a third expression cassette into a vector containing a first and a second expression cassette. Methods concerning expression cassettes and cloning techniques are well-known in the art and described herein. See also CRIP expression cassette.

“Expression ORF” means a nucleotide encoding a protein complex and is defined as the nucleotides in the ORF.

“FECT” means a transient plant expression system using Foxtail mosaic virus with elimination of coating protein gene and triple gene block.

“Fermentation beer” refers to spent fermentation medium, i.e., fermentation medium supernatant after removal of organisms, that has been inoculated with and consumed by a transformed host cell (e.g., a yeast cell operable to express a CRIP of the present invention). In some embodiments, fermentation beer refers to the solution that is recovered following the fermentation of the transformed host cell. The term “fermentation” refers broadly to the enzymatic and anaerobic or aerobic breakdown of organic substances (e.g., a carbon substrate) nutrient substances by microorganisms under controlled conditions (e.g., temperature, oxygen, pH, nutrients, and the like) to produce fermentation products (e.g., one or more peptides of the present invention). While fermentation typically describes processes that occur under anaerobic conditions, as used herein it is not intended that the term be solely limited to strict anaerobic conditions, as the term “fermentation” used herein may also occur processes that occur in the presence of oxygen.

“Fermentation solid(s)” refers to solids (including dissolved) that remain from fermentation beer during the yeast-based fermentation process, and consists essentially of salts, complex protein source, vitamins, and additional yeast byproducts having a molecular weight cutoff of from about 200 kDa to about 1 kDa.

“GFP” means a green fluorescent protein from the jellyfish, Aequorea victoria.

“HIS” or “His” refers to histidine. For example, in some embodiments, “HIS” or His” may refer to a histidine tag, e.g., a histidine tag having an amino acid sequence as set forth in SEQ ID NO: 591.

“Homologous” refers to the sequence similarity or sequence identity between two polypeptides or between two nucleic acid molecules. When a position in both of the two compared sequences is occupied by the same base or amino acid monomer subunit, e.g., if a position in each of two DNA molecules is occupied by adenine, then the molecules are homologous at that position. The percent of homology between two sequences is a function of the number of matching or homologous positions shared by the two sequences divided by the number of positions compared×100. Thus, in some embodiments, the term “homologous” refers to the sequence similarity between two polypeptide molecules, or between two nucleic acid molecules. When a position in both of the two compared sequences is occupied by the same base or amino acid monomeric subunit, e.g., if a position in each of two DNA molecules is occupied by adenine, then the molecules are homologous at that position. The homology between two sequences is a function of the number of matching or homologous positions shared by the two sequences. For example, if 6 of 10 of the positions in two sequences are matched or homologous then the two sequences are 60% homologous. By way of example, the DNA sequences ATTGCC and TATGGC share 50% homology.

The term “homology,” when used in relation to nucleic acids, refers to a degree of complementarity. There may be partial homology, or complete homology and thus identical. “Sequence identity” refers to a measure of relatedness between two or more nucleic acids, and is given as a percentage with reference to the total comparison length. The identity calculation takes into account those nucleotide residues that are identical and in the same relative positions in their respective larger sequences.

“Homologous recombination” refers to the event of substitution of a segment of DNA by another one that possesses identical regions (homologous) or nearly so. For example, in some embodiments, “homologous recombination” refers to a type of genetic recombination in which nucleotide sequences are exchanged between two similar or identical molecules of DNA. Briefly, homologous recombination is most widely used by cells to accurately repair harmful breaks that occur on both strands of DNA, known as double-strand breaks. Although homologous recombination varies widely among different organisms and cell types, most forms involve the same basic steps: after a double-strand break occurs, sections of DNA around the 5′ ends of the break are cut away in a process called resection. In the strand invasion step that follows, an overhanging 3′ end of the broken DNA molecule then “invades” a similar or identical DNA molecule that is not broken. After strand invasion, the further sequence of events may follow either of two main pathways, i.e., the double-strand break repair pathway, or the synthesis-dependent strand annealing pathway. Homologous recombination is conserved across all three domains of life as well as viruses, suggesting that it is a nearly universal biological mechanism. For example, in some embodiments, homologous recombination can occur using a site-specific integration (SSI) sequence, whereby there is a strand exchange crossover event between nucleic acid sequences substantially similar in nucleotide composition. These crossover events can take place between sequences contained in the targeting construct of the invention (i.e., the SSI sequence) and endogenous genomic nucleic acid sequences (e.g., the polynucleotide encoding the peptide subunit). In addition, in some embodiments, it is possible that more than one site-specific homologous recombination event can occur, which would result in a replacement event in which nucleic acid sequences contained within the targeting construct have replaced specific sequences present within the endogenous genomic sequences.

“ICK motif” or “ICK motif protein” or “inhibitor cystine knot motif” or “ICK peptides” or “cystine knot motif” or “cystine knot peptides” refers to a 16 to 60 amino acid peptide with at least 6 half-cystine core amino acids having three disulfide bridges, wherein the 3 disulfide bridges are covalent bonds and of the six half-cystine residues the covalent disulfide bonds are between the first and fourth, the second and fifth, and the third and sixth half-cystines, of the six core half-cystine amino acids starting from the N-terminal amino acid. In general this type of peptide comprises a beta-hairpin secondary structure, normally composed of residues situated between the fourth and sixth core half-cystines of the motif, the hairpin being stabilized by the structural crosslinking provided by the motif's three disulfide bonds. Note that additional cysteine/cystine or half-cystine amino acids may be present within the inhibitor cystine knot motif.

“ick” means a nucleotide encoding an ICK motif protein.

“ICK motif protein expression ORF” or “expression ORF” means a nucleotide encoding an ICK motif protein complex and is defined as the nucleotides in the ORF.

“ICK motif protein expression vector” or “ICK expression vector” or “ICK motif expression vector” means a binary vector which contains an expression ORF. The binary vector also contains the necessary transcription promoter and terminator sequence surrounding the expression ORF to promote expression of the ORF and the protein it encodes.

“Identity” refers to a relationship between two or more polypeptide sequences or two or more polynucleotide sequences, as determined by comparing said sequences. The term “identity” also means the degree of sequence relatedness between polypeptide or polynucleotide sequences, as the case may be, as determined by the match between strings of such sequences. “Identity” and “similarity” can be readily calculated by any one of the myriad methods known to those having ordinary skill in the art, including but not limited to those described in: Computational Molecular Biology, Lesk, A. M., ed., Oxford University Press, New York, 1988; Biocomputing: Informatics and Genome Projects, Smith, D. W., ed., Academic Press, New York, 1993; Computer Analysis of Sequence Data, Part 1, Griffin, A. M., and Griffin, H. G., eds., Humana Press, New Jersey, 1994, Sequence Analysis in Molecular Biology, von Heinje, G., Academic Press, 1987; and Sequence Analysis Primer, Gribskov, M. and Devereux, J., eds., M Stockton Press, New York, 1991; and Carillo, H., and Lipman, D., SIAM J. Applied Math., 48: 1073 (1988), the disclosures of which are incorporated herein by reference in their entireties. Furthermore, methods to determine identity and similarity are codified in publicly available computer programs. For example in some embodiments, methods to determine identity and similarity between two sequences include, but are not limited to, the GCG program package (Devereux, J., et al., Nucleic Acids Research 12(1): 387 (1984)), BLASTP, BLASTN, and FASTA (Altschul, S. F. et al., J. Molec. Biol. 215: 403-410 (1990). The BLAST X program is publicly available from NCBI and other sources (BLAST Manual, Altschul, S., et al., NCBI NLM NIH Bethesda, Md. 20894; Altschul, S., et al., J. Mol. Biol. 215: 403-410 (1990), the disclosures of which are incorporated herein by reference in their entireties.

“IGER” means a name for a short peptide, based on its actual sequence of one letter codes. It is an example of an intervening linker.

“in vivo” refers to the natural environment (e.g., an animal or a cell) and to processes or reactions that occur within a natural environment.

“Inactive” refers to a condition wherein something is not in a state of use, e.g., lying dormant and/or not working. For example, when used in the context of a gene or when referring to a gene, the term inactive means said gene is no longer actively synthesizing a gene product, having said gene product translated into a protein, or otherwise having the gene perform its normal function. For example, in some embodiments, the term inactive can refer the failure of a gene to transcribe RNA, a failure of RNA processing (e.g., pre-mRNA processing; RNA splicing; or other post-transcriptional modifications); interference with non-coding RNA maturation; interference with RNA export (e.g., from the nucleus to the cytoplasm); interference with translation; protein folding; translocation; protein transport; and/or inhibition and/or interference with any of the molecules polynucleotides, peptides, polypeptides, proteins, transcription factors, regulators, inhibitors, or other factors that take part in any of the aforementioned processes.

“Inoperable” refers to the condition of a thing not functioning, malfunctioning, or no longer able to function. For example, when used in the context of a gene or when referring to a gene, the term inoperable means said gene is no longer able to operate as it normally would, either permanently or transiently. For example, “inoperable,” in some embodiments, means that a gene is no longer able to synthesize a gene product, having said gene product translated into a protein, or is otherwise unable to gene perform its normal function. For example, in some embodiments, the term inoperable can refer the failure of a gene to transcribe RNA, a failure of RNA processing (e.g., pre-mRNA processing; RNA splicing; or other post-transcriptional modifications); interference with non-coding RNA maturation; interference with RNA export (e.g., from the nucleus to the cytoplasm); interference with translation; protein folding; translocation; protein transport; and/or inhibition and/or interference with any of the molecules polynucleotides, peptides, polypeptides, proteins, transcription factors, regulators, inhibitors, or other factors that take part in any of the aforementioned processes.

“Insect” includes all organisms in the class “Insecta.” The term “pre-adult” insects refers to any form of an organism prior to the adult stage, including, for example, eggs, larvae, and nymphs. As used herein, the term “insect refers to any arthropod and nematode, including acarids, and insects known to infest all crops, vegetables, and trees and includes insects that are considered pests in the fields of forestry, horticulture and agriculture. Examples of specific crops that might be protected with the methods disclosed herein are soybean, corn, cotton, alfalfa and the vegetable crops. A list of specific crops and insects is enclosed herein.

“Insect gut environment” or “gut environment” means the specific pH and proteinase conditions found within the fore, mid or hind gut of an insect or insect larva.

“Insect hemolymph environment” means the specific pH and proteinase conditions of found within an insect or insect larva.

“Insecticidal activity” means that upon or after exposing the insect to compounds, agents, or peptides, the insect either dies stops or slows its movement; stops or slows its feeding; stops or slows its growth; becomes confused (e.g., with regard to navigation, locating food, sleeping behaviors, and/or mating); fails to pupate; interferes with reproduction; and/or precludes the insect from producing offspring and/or precludes the insect from producing fertile offspring.

“Insecticidal Agent” or “IA” or “Agent” refers to one or more chemical substances, molecules, nucleotides, polynucleotides, RNA, DNA, peptides, polypeptides, proteins, lipids, glycolipids, enzymes, toxins, toxicants, poisons, insecticides, pesticides, organic compounds, inorganic compounds, viruses, prokaryote organisms, or eukaryote organisms (and the agents produced from said prokaryote or eukaryote organisms). In some embodiments, an IA includes, but is not limited to, members selected from the categories of RNAi; Stomach poisons; Inhibitors of chitin biosynthesis type 0; Inhibitors of chitin biosynthesis, type 1; Insect viruses; Compounds isolated from Azadirachta indica; Compounds with unknown MOAs; Bacteria (and products therefrom); Fungi (and products therefrom); Nematodes (and products therefrom); Botanical essences; Mechanical disruptors; Fluorescent brighteners; Silica nanospheres; Chitinases; Lectins; Membrane Attack Complex/Perforin (MACPF) proteins; Plant virus coat protein-toxin fusions; Glycan binding domain/toxin fusion proteins; Acetylcholinesterase (AchE) inhibitors; GABA-gated chloride channel blockers; Sodium channel modulators; Nicotinic acetylcholine receptor (nAchR) Competitive Modulators; Nicotinic acetylcholine receptor (nAchR) allosteric modulators—site I; Glutamate-gated chloride channel (GluCl) allosteric modulators; Juvenile hormone mimics; Miscellaneous non-specific (multi-site) inhibitors; Chordotonal organ TRPV channel modulators; Mite growth inhibitors; Inhibitors of mitochondrial ATP synthase; Uncouplers of oxidative phosphorylation via disruption of the proton gradient; Nicotinic acetylcholine receptor (nAchR) channel blockers; Moulting disruptors (dipteran); Ecdysone receptor agonists; Octopamine receptor agonists; Mitochondrial complex III electron transport inhibitors; Mitochondrial complex I electron transport inhibitors; Voltage-dependent sodium channel blockers; Inhibitors of acetyl co-enzyme A carboxylase; Mitochondrial complex IV electron transport inhibitors; Mitochondrial complex II electron transport inhibitors; Ryanodine receptor modulators; Chordotonal organ modulators—undefined target site; or GABA-gated chloride channel allosteric modulators. In some embodiments, an Insecticidal Agent can be a polymer of amino acids, a peptide, a polypeptide, or a protein; such peptide-IAs can be made and/or used in accordance with any of the methods pertaining to peptides and/or proteins as described herein.

“Integrative expression vector” or “integrative vector” means a yeast expression vector which can insert itself into a specific locus of the yeast cell genome and stably becomes a part of the yeast genome.

“Insecticide-resistant” or “Insecticide-resistance” or “Insecticide-resistant insect” or refers to a heritable change in the sensitivity of a pest population to an insecticide that is reflected in the repeated failure of said insecticide to achieve the expected level of control when used against that pest species.

“Intervening linker” refers to a short peptide sequence in the protein separating different parts of the protein, or a short DNA sequence that is placed in the reading frame in the ORF to separate the upstream and downstream DNA sequences. For example, in some embodiments, an intervening linker may be used allowing proteins to achieve their independent secondary and tertiary structure formation during translation. In some embodiments, the intervening linker can be either resistant or susceptible to cleavage in plant cellular environments, in the insect and/or lepidopteran gut environment, and in the insect hemolymph and lepidopteran hemolymph environment.

“Isolated” refers to separating a thing and/or a component from its natural environment, e.g., a toxin isolated from a given genus or species means that toxin is separated from its natural environment, e.g., taken out of a WT organism.

“Kappa-ACTX peptide” refers to an excitatory toxin that inhibits insect calcium-activated potassium (KCa) channels (Slo-type). As used herein, “Kappa-ACTX peptide” can refer to peptides isolated from the Australian Blue Mountains Funnel-web Spider, Hadronyche versuta, or variants thereof.

“kb” refers to kilobase, i.e., 1000 bases. As used herein, the term “kb” means a length of nucleic acid molecules. For example, 1 kb refers to a nucleic acid molecule that is 1000 nucleotides long. A length of double-stranded DNA that is 1 kb long, contains two thousand nucleotides (i.e., one thousand on each strand). Alternatively, a length of single-stranded RNA that is 1 kb long, contains one thousand nucleotides.

“kDa” refers to kilodalton, a unit equaling 1,000 daltons; a “dalton” or “Da” is a unit of molecular weight (MW).

“Knock in” or “knock-in” or “knocks-in” or “knocking-in” refers to the replacement of an endogenous gene with an exogenous or heterologous gene, or part thereof. For example, in some embodiments, the term “knock-in” refers to the introduction of a nucleic acid sequence encoding a desired protein to a target gene locus by homologous recombination, thereby causing the expression of the desired protein. In some embodiments, a “knock-in” mutation can modify a gene sequence to create a loss-of-function or gain-of-function mutation. The term “knock-in” can refer to the procedure by which a exogenous or heterologous polynucleotide sequence or fragment thereof is introduced into the genome (e.g., “they performed a knock-in” or “they knocked-in the heterologous gene”), or the resulting cell and/or organism (e.g., “the cell is a “knock-in” or “the animal is a “knock-in”).

“Knock out” or “knockout” or “knock-out” or “knocks-out” or “knocking-out” refers to a partial or complete suppression of the expression gene product (e.g., mRNA) of a protein encoded by an endogenous DNA sequence in a cell. In some embodiments, the “knock-out” can be effectuated by targeted deletion of a whole gene, or part of a gene encoding a peptide, polypeptide, or protein. As a result, the deletion may render a gene inactive, partially inactive, inoperable, partly inoperable, or otherwise reduce the expression of the gene or its products in any cell in the whole organism and/or cell in which it is normally expressed. The term “knock-out” can refer to the procedure by which an endogenous gene is made completely or partially inactive or inoperable (e.g., “they performed a knock-out” or “they knocked-out the endogenous gene”), or the resulting cell and/or organism (e.g., “the cell is a “knock-out” or “the animal is a “knock-out”).

“Knockdown dose 50” or “KD₅₀” refers to the median dose required to cause paralysis or cessation of movement in 50% of a population, for example a population of Musca domestica (common housefly) and/or Aedes aegypti (mosquito).

“1” or “linker” refers to a nucleotide encoding linker peptide.

“L” in the proper context refers to a linker peptide, which links a translational stabilizing protein (STA) with an additional polypeptide, e.g., a heterologous peptide, and/or multiple heterologous peptides. When referring to amino acids, “L” can also mean leucine.

“LAC4 promoter” or “Lac4 promoter” refers to a DNA segment comprised of the promoter sequence derived from the K. lactis β-galactosidase gene. The LAC4 promoters is strong and inducible reporter that is used to drive expression of exogenous genes transformed into yeast.

“LAC4 terminator” or “Lac4 terminator” refers to a DNA segment comprised of the transcriptional terminator sequence derived from the K. lactis β-galactosidase gene.

“LD₂₀” refers to a dose required to kill 20% of a population.

“LD₅₀” refers to lethal dose 50 which means the dose required to kill 50% of a population.

“Lepidopteran gut environment” means the specific pH and proteinase conditions found within the fore, mid or hind gut of a lepidopteran insect or larva.

“Lepidopteran hemolymph environment” means the specific pH and proteinase conditions of found within lepidopteran insect or larva.

“Linker” or “LINKER” or “peptide linker” or “L” or “intervening linker” refers to a short peptide sequence operable to link two peptides together. Linker can also refer to a short DNA sequence that is placed in the reading frame of an ORF to separate an upstream and downstream DNA sequences. In some embodiments, a linker can be cleavable by an insect protease. In some embodiments, a linker may allow proteins to achieve their independent secondary and tertiary structure formation during translation. In some embodiments, the linker can be either resistant or susceptible to cleavage in plant cellular environments, in the insect and/or lepidopteran gut environment, and/or in the insect hemolymph and lepidopteran hemolymph environment. In some embodiments, a linker can be cleaved by a protease, e.g., in some embodiments, a linker can be cleaved by a plant protease (e.g., papain, bromelain, ficin, actinidin, zingibain, and/or cardosins), an insect protease, a fungal protease, a vertebrate protease, an invertebrate protease, a bacteria protease, a mammal protease, a reptile protease, or an avian protease. In some embodiments, a linker can be cleavable or non-cleavable. In some embodiments, a linker comprises a binary or tertiary region, wherein each region is cleavable by at least two types of proteases: one of which is an insect and/or nematode protease and the other one of which is a human protease. In some embodiments, a linker can have one of (at least) three roles: to cleave in the insect gut environment, to cleave in the plant cell, or to be designed not to intentionally cleave.

“Medium” (plural “media”) refers to a nutritive solution for culturing cells in cell culture.

“MOA” refers to mechanism of action.

“Molecular weight (MW)” refers to the mass or weight of a molecule, and is typically measured in “daltons (Da)” or kilodaltons (kDa). In some embodiments, MW can be calculated using sodium dodecyl sulfate polyacrylamide gel electrophoresis (SDS-PAGE), analytical ultracentrifugation, or light scattering. In some embodiments, the SDS-PAGE method is as follows: the sample of interest is separated on a gel with a set of molecular weight standards. The sample is run, and the gel is then processed with a desired stain, followed by destaining for about 2 to 14 hours. The next step is to determine the relative migration distance (Rf) of the standards and protein of interest. The migration distance can be determined using the following equation:

$$Rf = \frac{Migration distance of the protein}{Migration distance of the dye front} \qquad Formula ( III )$$

Next, the logarithm of the MW can be determined based on the values obtained for the bands in the standard; e.g., in some embodiments, the logarithm of the molecular weight of an SDS-denatured polypeptide and its relative migration distance (Rf) is plotted into a graph. After plotting the graph, interpolating the value derived will provide the molecular weight of the unknown protein band.

“Motif” refers to a polynucleotide or polypeptide sequence that is implicated in having some biological significance and/or exerts some effect or is involved in some biological process.

“Multiple cloning site” or “MCS” refers to a segment of DNA found on a vector that contains numerous restriction sites in which a DNA sequence of interest can be inserted.

“Mutant” refers to an organism, DNA sequence, amino acid sequence, peptide, polypeptide, or protein, that has an alteration or variation (for example, in the nucleotide sequence or the amino acid sequence), which causes said organism and/or sequence to be different from the naturally occurring or wild-type organism, wild-type sequence, and/or reference sequence with which the mutant is being compared. In some embodiments, this alteration or variation can be one or more nucleotide and/or amino acid substitutions or modifications (e.g., deletion or addition). In some embodiments, the one or more amino acid substitutions or modifications can be conservative; here, such a conservative amino acid substitution and/or modification in a “mutant” does not substantially diminish the activity of the mutant in relation to its non-mutant form. For example, in some embodiments, a “mutant” possesses one or more conservative amino acid substitutions when compared to a peptide with a disclosed and/or claimed sequence, as indicated by a SEQ ID NO.

“N-terminal” refers to the free amine group (i.e., —NH₂) that is positioned on beginning or start of a polypeptide.

“NCBI” refers to the National Center for Biotechnology Information.

“nm” refers to nanometers.

“Non-ICK CRIPS” refers to peptides having 4-8 cysteines which form 2-4 disulfide bonds. Non-ICK peptides include cystine knot peptides that are not ICK peptides. Non-ICK peptides may have different disulfide bond connectivity patterns than ICKs. Examples of a Non-ICK CRIP are peptides like Av2 and Av3, isolated from sea anemones; these anemone peptides are examples of a class of compounds that modulate sodium channels in the insect peripheral nervous system (PNS).

“Non-Polar amino acid” is an amino acid that is weakly hydrophobic and includes glycine, alanine, proline, valine, leucine, isoleucine, phenylalanine and methionine. Glycine or gly is the most preferred non-polar amino acid for the dipeptides of this invention.

“Normalized peptide yield” means the peptide yield in the conditioned medium divided by the corresponding cell density at the point the peptide yield is measured. The peptide yield can be represented by the mass of the produced peptide in a unit of volume, for example, mg per liter or mg/L, or by the UV absorbance peak area of the produced peptide in the HPLC chromatograph, for example, mAu·sec. The cell density can be represented by visible light absorbance of the culture at wavelength of 600 nm (OD600).

“OD” refers to optical density. Typically, OD is measured using a spectrophotometer. When measuring growth over time of a cell population, OD600 is preferable to UV spectroscopy; this is because at a 600 nm wavelength, the cells will not be harmed as they would under too much UV light.

“OD660 nm” or “OD_{660 nm}” refers to optical densities at 660 nanometers (nm).

“Omega peptide” or “omega toxin,” or “omega-ACTX-Hv1a,” or “native omegaACTX-Hv1a” all refer to an ACTX peptide which was first isolated from a spider known as the Australian Blue Mountains Funnel-web Spider, Hadronyche versuta. Omega peptide is a positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties.

“One letter code” means the peptide sequence which is listed in its one letter code to distinguish the various amino acids in the primary structure of a protein: alanine=A, arginine=R, asparagine=N, aspartic acid=D, asparagine or aspartic acid=B, cysteine=C, glutamic acid=E, glutamine=Q, glutamine or glutamic acid=Z, glycine=G, histidine=H, isoleucine=I, leucine=L, lysine=K, methionine=M, phenylalanine=F, proline=P, serine=S, threonine=T, tryptophan=W, tyrosine=Y, and valine=V.

“Operable” refers to the ability to be used, the ability to do something, and/or the ability to accomplish some function or result. For example, in some embodiments, “operable” refers to the ability of a polynucleotide, DNA sequence, RNA sequence, or other nucleotide sequence or gene to encode a peptide, polypeptide, and/or protein. For example, in some embodiments, a polynucleotide may be operable to encode a protein, which means that the polynucleotide contains information that imbues it with the ability to create a protein (e.g., by transcribing mRNA, which is in turn translated to protein).

“Operably linked” refers to a juxtaposition wherein the components so described are in a relationship permitting them to function in their intended manner. For example, in some embodiments, operably linked can refer to two or more DNA, peptide, or polypeptide sequences. In other embodiments, operably linked can mean that the two adjacent DNA sequences are placed together such that the transcriptional activation of one DNA sequence can act on the other DNA sequence. In yet other embodiments, the term “operably linked” can refer to two or more peptides and/or polypeptides, wherein said two or more peptides and/or polypeptides are connected in such a way as to yield a single polypeptide chain; alternatively, the term operably linked can refer to two or more peptides that are connected in such a way that one peptide exerts some effect on the other. In yet other embodiments, operably linked can refer to two adjacent DNA sequences are placed together such that the transcriptional activation of one can act on the other.

“ORF” or “open reading frame” refers to a length of RNA or DNA sequence, between a translation start signal (e.g., AUG or ATG, respectively) and any one or more of the known termination codons, which encodes one or more polypeptide sequences. Put another way, the ORF describes the frame of reference as seen from the point of view of a ribosome translating the RNA code, insofar that the ribosome is able to keep reading (i.e., adding amino acids to the nascent protein) because it has not encountered a stop codon. Thus, “open reading frame” or “ORF” refers to the amino acid sequence encoded between translation initiation and termination codons of a coding sequence. Here, the terms “initiation codon” and “termination codon” refer to a unit of three adjacent nucleotides (i.e., a codon) in a coding sequence that specifies initiation and chain termination, respectively, of protein synthesis (mRNA translation).

In some embodiments, an ORF is a continuous stretch of codons that begins with a start codon (usually ATG for DNA, and AUG for RNA) and ends at a stop codon (usually UAA, UAG or UGA). In other embodiments, an ORF can be length of RNA or DNA sequence, between a translation start signal (e.g., AUG or ATG) and any one or more of the known termination codons, wherein said length of RNA or DNA sequence encodes one or more polypeptide sequences. In some other embodiments, an ORF can be a DNA sequence encoding a protein which begins with an ATG start codon and ends with a TGA, TAA or TAG stop codon. ORF can also mean the translated protein that the DNA encodes. Generally, those having ordinary skill in the art distinguish the terms “open reading frame” and “ORF,” from the term “coding sequence,” based upon the fact that the broadest definition of “open reading frame” simply contemplates a series of codons that does not contain a stop codon. Accordingly, while an ORF may contain introns, the coding sequence is distinguished by referring to those nucleotides (e.g., concatenated exons) that can be divided into codons that are actually translated into amino acids by the ribosomal translation machinery (i.e., a coding sequence does not contain introns); however, as used herein, the terms “coding sequence”; “CDS”; “open reading frame”; and “ORF,” are used interchangeably.

“Out-recombined” or “out-recombination” refers to the removal of a gene and/or polynucleotide sequence (e.g., an endogenous gene) that is flanked by two site-specific recombination sites (e.g., the 5′- and 3′-nucleotide sequence of a target gene that is homologous to the homology arms of a target vector) during in vivo homologous recombination. See “knockout.”

“Parasporal crystal toxin” refers to any of the peptides, polypeptides, and/or proteins that are part of the parasporal body or parasporal crystal, which is a bipyramidal crystal containing one or more peptides, polypeptides, and/or proteins. When the parasporal body or parasporal crystal is ingested by an insect, this toxin-containing parasporal crystal dissolves in the alkaline gut juices, followed by cleavage via midgut proteases of the protoxin, which yields an active peptide toxin, e.g., a δ-endotoxin.

“Peptide expression cassette” or “expression cassette” means a DNA sequence which is composed of all the DNA elements necessary to complete transcription of an insecticidal protein in a biological expression system. In the described methods herein, it includes a transcription promoter, a DNA sequence to encode an α-mating factor signal sequence, a cleavage site, an insecticidal protein transgene, a stop codon and a transcription terminator.

“Peptide expression vector” means a host organism expression vector which contains a heterologous peptide transgene.

“Peptide expression yeast strain”, “peptide expression strain” or “peptide production strain” means a yeast strain which can produce a heterologous peptide.

“Peptide-IA” refers to Insecticidal Agents that are amino acids, peptides, polypeptides, and/or proteins.

“Peptide transgene” or “insecticidal peptide transgene” or “insecticidal protein transgene” refers to a DNA sequence that encodes a peptide of interest and can be translated in a biological expression system.

“Peptide yield” means the insecticidal peptide concentration in the conditioned medium which is produced from the cells of a peptide expression yeast strain. It can be represented by the mass of the produced peptide in a unit of volume, for example, mg per liter or mg/L, or by the UV absorbance peak area of the produced peptide in the HPLC chromatograph, for example, mAu·sec.

“Peritrophic membrane” means a lining inside the insect gut that traps large food particles can aid in their movement through the gut while allowing digestion, but also protecting the gut wall.

“Pest” includes, but is not limited to: insects, fungi, bacteria, nematodes, mites, ticks, and the like.

“Pesticidally-effective amount” refers to an amount of the pesticide that is able to bring about death to at least one pest, or to noticeably reduce pest growth, feeding, or normal physiological development. This amount will vary depending on such factors as, for example, the specific target pests to be controlled, the specific environment, location, plant, crop, or agricultural site to be treated, the environmental conditions, and the method, rate, concentration, stability, and quantity of application of the pesticidally-effective polypeptide composition. The formulations may also vary with respect to climatic conditions, environmental considerations, and/or frequency of application and/or severity of pest infestation.

“Pharmaceutically acceptable salt” is synonymous with agriculturally acceptable salt, and as used herein refers to a compound that is modified by making acid or base salts thereof.

“Plant” shall mean whole plants, plant tissues, plant organs (e.g., leaves, stems, roots, etc.), seeds, plant cells, propagules, embryos and progeny of the same. Plant cells can be differentiated or undifferentiated (e.g. callus, suspension culture cells, protoplasts, leaf cells, root cells, phloem cells, and pollen).

“Plant transgenic protein” means a protein from a heterologous species that is expressed in a plant after the DNA or RNA encoding it was delivered into one or more of the plant cells.

“Plant cleavable linker” means a cleavable linker peptide, or a nucleotide encoding a cleavable linker peptide, which contains a plant protease recognition site and can be cleaved during the protein expression process in the plant cell.

“Plant-incorporated protectant” or “PIP” means an insecticidal protein produced by transgenic plants, and the genetic material necessary for the plant to produce the protein.

“Plasmid” refers to a DNA segment that acts as a carrier for a gene of interest and, when transformed or transfected into an organism, can replicate and express the DNA sequence contained within the plasmid independently of the host organism. Plasmids are a type of vector, and can be “cloning vectors” (i.e., simple plasmids used to clone a DNA fragment and/or select a host population carrying the plasmid via some selection indicator) or “expression plasmids” (i.e., plasmids used to produce large amounts of polynucleotides and/or polypeptides).

“Polar amino acid” is an amino acid that is polar and includes serine, threonine, cysteine, asparagine, glutamine, histidine, tryptophan and tyrosine; preferred polar amino acids are serine, threonine, cysteine, asparagine and glutamine; with serine being most highly preferred.

“Polynucleotide” refers to a polymeric-form of nucleotides (e.g., ribonucleotides, deoxyribonucleotides, or analogs thereof) of any length; e.g., a sequence of two or more ribonucleotides or deoxyribonucleotides. As used herein, the term “polynucleotide” includes double- and single-stranded DNA, as well as double- and single-stranded RNA; it also includes modified and unmodified forms of a polynucleotide (modifications to and of a polynucleotide, for example, can include methylation, phosphorylation, and/or capping). In some embodiments, a polynucleotide can be one of the following: a gene or gene fragment (for example, a probe, primer, EST, or SAGE tag); genomic DNA; genomic DNA fragment; exon; intron; messenger RNA (mRNA); transfer RNA; ribosomal RNA; ribozyme; cDNA; recombinant polynucleotide; branched polynucleotide; plasmid; vector; isolated DNA of any sequence; isolated RNA of any sequence; nucleic acid probe; primer or amplified copy of any of the foregoing.

In yet other embodiments, a polynucleotide can refer to a polymeric-form of nucleotides operable to encode the open reading frame of a gene.

In some embodiments, a polynucleotide can refer to cDNA.

In some embodiments, polynucleotides can have any three-dimensional structure and may perform any function, known or unknown. The structure of a polynucleotide can also be referenced to by its 5′- or 3′-end or terminus, which indicates the directionality of the polynucleotide. Adjacent nucleotides in a single-strand of polynucleotides are typically joined by a phosphodiester bond between their 3′ and 5′ carbons. However, different internucleotide linkages could also be used, such as linkages that include a methylene, phosphoramidate linkages, etc. This means that the respective 5′ and 3′ carbons can be exposed at either end of the polynucleotide, which may be called the 5′ and 3′ ends or termini. The 5′ and 3′ ends can also be called the phosphoryl (PO₄) and hydroxyl (OH) ends, respectively, because of the chemical groups attached to those ends. The term polynucleotide also refers to both double- and single-stranded molecules. Unless otherwise specified or required, any embodiment that makes or uses a polynucleotide encompasses both the double-stranded form and each of two complementary single-stranded forms known or predicted to make up the double-stranded form.

In some embodiments, a polynucleotide can include modified nucleotides, such as methylated nucleotides and nucleotide analogs (including nucleotides with non-natural bases, nucleotides with modified natural bases such as aza- or deaza-purines, etc.). If present, modifications to the nucleotide structure can be imparted before or after assembly of the polynucleotide.

In some embodiments, a polynucleotide can also be further modified after polymerization, such as by conjugation with a labeling component. Additionally, the sequence of nucleotides in a polynucleotide can be interrupted by non-nucleotide components. One or more ends of the polynucleotide can be protected or otherwise modified to prevent that end from interacting in a particular way (e.g. forming a covalent bond) with other polynucleotides.

In some embodiments, a polynucleotide can be composed of a specific sequence of four nucleotide bases: adenine (A); cytosine (C); guanine (G); and thymine (T). Uracil (U) can also be present, for example, as a natural replacement for thymine when the polynucleotide is RNA. Uracil can also be used in DNA. Thus, the term “sequence” refers to the alphabetical representation of a polynucleotide or any nucleic acid molecule, including natural and non-natural bases.

The term “RNA molecule” or ribonucleic acid molecule refers to a polynucleotide having a ribose sugar rather than deoxyribose sugar and typically uracil rather than thymine as one of the pyrimidine bases. An RNA molecule of the invention is generally single-stranded, but can also be double-stranded. In the context of an RNA molecule from an RNA sample, the RNA molecule can include the single-stranded molecules transcribed from DNA in the cell nucleus, mitochondrion or chloroplast, which have a linear sequence of nucleotide bases that is complementary to the DNA strand from which it is transcribed.

In some embodiments, a polynucleotide can further comprise one or more heterologous regulatory elements. For example, in some embodiments, the regulatory element is one or more promoters; enhancers; silencers; operators; splicing signals; polyadenylation signals; termination signals; RNA export elements, internal ribosomal entry sites (IRES); poly-U sequences; or combinations thereof.

“Post-transcriptional gene silencing”, or “PTGS”, means a cellular process within living cells that suppress the expression of a gene.

“Post-transcriptional regulatory elements” are DNA segments and/or mechanisms that affect mRNA after it has been transcribed. Post-transcriptional mechanisms include splicing events, capping, addition of a Poly (A) tail, and other mechanisms known to those having ordinary skill in the art.

“Promoter” refers to a region of DNA to which RNA polymerase binds and initiates the transcription of a gene.

“Protein” has the same meaning as “peptide” and/or “polypeptide” in this document.

“Ratio” refers to the quantitative relation between two amounts showing the number of times one value contains or is contained within the other.

“Reading frame” refers to one of the six possible reading frames, three in each direction, of the double stranded DNA molecule. The reading frame that is used determines which codons are used to encode amino acids within the coding sequence of a DNA molecule. In some embodiments, a reading frame is a way of dividing the sequence of nucleotides in a polynucleotide and/or nucleic acid (e.g., DNA or RNA) into a set of consecutive, non-overlapping triplets.

“Recombinant DNA” or “rDNA” refers to DNA that is comprised of two or more different DNA segments.

“Recombinant vector” means a DNA plasmid vector into which foreign DNA has been inserted.

“Regulatory elements” refers to a genetic element that controls some aspect of the expression and/or processing of nucleic acid sequences. For example, in some embodiments, a regulatory element can be found at the transcriptional and post-transcriptional level. Regulatory elements can be cis-regulatory elements (CREs), or trans-regulatory elements (TREs). In some embodiments, a regulatory element can be one or more promoters; enhancers; silencers; operators; splicing signals; polyadenylation signals; termination signals; RNA export elements, internal ribosomal entry sites (IRES); poly-U sequences; and/or other elements that influence gene expression, for example, in a tissue-specific manner; temporal-dependent manner; to increase or decrease expression; and/or to cause constitutive expression.

“Restriction enzyme” or “restriction endonuclease” refers to an enzyme that cleaves DNA at a specified restriction site. For example, a restriction enzyme can cleave a plasmid at an EcoRI, SacII or BstXI restriction site allowing the plasmid to be linearized, and the DNA of interest to be ligated.

“Restriction site” refers to a location on DNA comprising a sequence of 4 to 8 nucleotides, and whose sequence is recognized by a particular restriction enzyme.

“Salannin” refers to a chemical compound isolated from Azadirachta indica that has insecticidal activity. In some embodiments, Salannin has a molecular formula of C₃₄H₄₄O₉, and a molecular weight of 596.7 g/mol.

“Sea anemone” refers to a group of marine animals of the order Actiniaria. Sea anemones are named after the anemone, which is a terrestrial flowering plant, due to colorful appearance many sea anemones possess. For example, in some embodiments, a sea anemone is one of the following species: Actinia equine; Anemonia erythraea; Anemonia sukata; Anemonia viridis; Anthopleura elegantissima; Anthopleura fuscoviridis; Anthopleura xanthogrammica; Bunodosoma caissarum; Bunodosoma cangicum; Bunodosoma granulifera; Heteractis crispa; Parasicyonis actinostoloides; Radianthus paumotensis; or Stoichactis helianthus.

“Selection gene” means a gene which confers an advantage for a genetically modified organism to grow under the selective pressure.

“Serovar” or “serotype” refers to a group of closely related microorganisms distinguished by a characteristic set of antigens. In some embodiments, a serovar is an antigenically and serologically distinct variety of microorganism

“sp.” refers to species.

“ssp.” or “subsp.” refers to subspecies.

“Sub cloning” or “subcloned” refers to the process of transferring DNA from one vector to another, usually advantageous vector. For example, polynucleotide encoding a mutant or a peptide can be subcloned into a pKlac1 plasmid subsequent to selection of yeast colonies transformed with pKLAC1 plasmids.

“SSI” is an acronym that is context dependent. In some contexts, it can refer to “site-specific integration,” which is used to refer to a sequence that will permit in vivo homologous recombination to occur at a specific site within a host organism's genome. Thus, in some embodiments, the term “site-specific integration” refers to the process directing a transgene to a target site in a host-organism's genome, allowing the integration of genes of interest into pre-selected genome locations of a host-organism. However, in other contexts, SSI can refer to “surface spraying indoors,” which is a technique of applying a variable volume sprayable volume of an insecticide onto surfaces where vectors rest, such as on walls, windows, floors and ceilings.

“STA” or “Translational stabilizing protein” or “stabilizing domain” or “stabilizing protein” (used interchangeably herein) means a peptide or protein with sufficient tertiary structure that it can accumulate in a cell without being targeted by the cellular process of protein degradation. The protein can be between 5 and 50 amino acids long. The translational stabilizing protein is coded by a DNA sequence for a protein that is operably linked with a sequence encoding an insecticidal protein or a CRIP in the ORF. The operably-linked STA can either be upstream or downstream of the CRIP and can have any intervening sequence between the two sequences (STA and CRIP) as long as the intervening sequence does not result in a frame shift of either DNA sequence. The translational stabilizing protein can also have an activity which increases delivery of the CRIP across the gut wall and into the hemolymph of the insect.

“sta” means a nucleotide encoding a translational stabilizing protein.

“Structural motif” refers to the three-dimensional arrangement of peptides and/or polypeptides, and/or the arrangement of operably linked polypeptide segments. For example, a polypeptide having an ERSP motif, an STA motif, a LINKER motif, and a CRIP polypeptide motif, has an overall “structural motif” of ERSP-STA-L-CRIP. See also “CRIP construct.”

“Ta1b” or “U1-agatoxin-Ta1b” or “Ta1bWT” or “wild-type U1-agatoxin-Ta1b” refers to a polypeptide isolated from the Hobo spider, Eratigena agrestis. One example of a U1-agatoxin-Ta1b is a polypeptide having the amino acid sequence of SEQ ID NO:1 (NCBI Accession No. 046167.1).

“Ta1b variant polynucleotide” or “U1-agatoxin-Ta1b variant polynucleotide” refers to a polynucleotide or group of polynucleotides operable to express and/or encode an insecticidal protein comprising one or more TVPs. The term “U1-agatoxin-Ta1b variant polynucleotide” when used to describe the U1-agatoxin-Ta1b variant polynucleotide sequence contained in a TVP expression ORF, its inclusion in a vector, and/or when describing the polynucleotides encoding an insecticidal protein, is described as “tvp” and/or “Tvp.”

“Toxin” refers to a venom and/or a poison, especially a protein or conjugated protein produced by certain animals, higher plants, and pathogenic bacteria. Generally, the term “toxin” is reserved natural products, e.g., molecules and peptides found in scorpions, spiders, snakes, poisonous mushrooms, etc., whereas the term “toxicant” is reserved for man-made products and/or artificial products e.g., man-made chemical pesticides. However, as used herein, the terms “toxin” and “toxicant” are used synonymously

“Transfection” and “transformation” both refer to the process of introducing exogenous and/or heterologous DNA or RNA (e.g., a vector containing a polynucleotide that encodes a CRIP) into a host organism (e.g., a prokaryote or a eukaryote). Generally, those having ordinary skill in the art sometimes reserve the term “transformation” to describe processes where exogenous and/or heterologous DNA or RNA are introduced into a bacterial cell; and reserve the term “transfection” for processes that describe the introduction of exogenous and/or heterologous DNA or RNA into eukaryotic cells. However, as used herein, the term “transformation” and “transfection” are used synonymously, regardless of whether a process describes the introduction exogenous and/or heterologous DNA or RNA into a prokaryote (e.g., bacteria) or a eukaryote (e.g., yeast, plants, or animals).

“Transgene” means a heterologous DNA sequence encoding a protein which is transformed into a plant.

“Transgenic host cell” means a cell which is transformed with a gene and has been selected for its transgenic status via an additional selection gene.

“Transgenic plant” means a plant that has been derived from a single cell that was transformed with foreign DNA such that every cell in the plant contains that transgene.

“Transient expression system” means an Agrobacterium tumefaciens-based system which delivers DNA encoding a disarmed plant virus into a plant cell where it is expressed. The plant virus has been engineered to express a protein of interest at high concentrations, up to 40% of the TSP.

“Triple expression cassette refers to three CRIP expression cassettes contained on the same vector.

“TRBO” means a transient plant expression system using Tobacco mosaic virus with removal of the viral coating protein gene.

“TSP” or “total soluble protein” means the total amount of protein that can be extracted from a plant tissue sample and solubilized into the extraction buffer.

“TVP” or “U1-agatoxin-Ta1b Variant Polypeptides (TVPs)” or “Ta1b Variant Polypeptides (TVPs)” refers to mutants or variants of the wild-type U1-agatoxin-Ta1b polypeptide sequence and/or a polynucleotide sequence encoding a wild-type U1-agatoxin-Ta1b polypeptide, that have been altered to produce a non-naturally occurring polypeptide and/or polynucleotide sequence. An exemplary wild-type U1-agatoxin-Ta1b polypeptide sequence is provided herein, having the amino acid sequence of SEQ ID NO: 1. An exemplary wild-type U1-agatoxin-Ta1b precursor polypeptide sequence is provided herein, having the amino acid sequence of SEQ ID NO: 48 (NCBI Accession No. 046167.1), which includes the signal sequence “MKLQLMICLVLLPCFFC” (SEQ ID NO: 59). In some embodiments, a TVP can have an amino acid sequence according to any of the amino acid sequences listed in Table 1. Accordingly, the term “TVP” refers to peptides having one or more mutations relative to the amino acid sequence set forth in SEQ ID NO: 1. In some embodiments, a TVP can have an amino acid sequence according to Formula (I):

E-P-D-E-I-C-R-X₁-X₂-M-X₃-N-K-E-F-T-Y-X₄-S-N-V-C-N-N-C-G-D-Q-V-A-A-C-E-A-E-C—F-X₅-N-D-V-Y-Z₁-A-C-H-E-A-Q-X₆-X₇ Formula (I)

wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent.

In some embodiments, a TVP can have an amino acid sequence according to Formula (II):

E-P-D-E-I-C-R-A-X₁-M-T-N-K-E-F-T-Y-K-S-N-V-C-N-N-C-G-D-Q-V-A-A-C-E-A-E-C—F-R-N-D-V-Y-Z₁-A-C-H-E-A-Q-K-G Formula (II)

wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof.

“U-ACTX-Hv1a” or “hybrid peptide” or “hybrid toxin” or “hybrid-ACTX-Hv1a” or “native hybridACTX-Hv1a” or “U peptide” or “U toxin” or “native U” or “native U-ACTX-Hv1a,” all refer to an ACTX peptide, which was discovered from a spider known as the Australian Blue Mountains Funnel-web Spider, Hadronyche versuta. U-ACTX-Hv1a is a positive allosteric modulators of the nicotinic acetylcholine receptor, and may also be a dual antagonist to insect voltage-gated Ca²⁺ channels and voltage-gated K⁺ channels. See Chambers et al., Insecticidal spider toxins are high affinity positive allosteric modulators of the nicotinic acetylcholine receptor. FEBS Lett. 2019 June; 593(12):1336-1350; and Windley et al., Lethal effects of an insecticidal spider venom peptide involve positive allosteric modulation of insect nicotinic acetylcholine receptors. Neuropharmacology. 2017 December; 127:224-242, the disclosures of which are incorporated herein by reference in their entireties. An exemplary U-ACTX-Hv1a peptide is provided in SEQ ID NO: 60.

“U+2 peptide” or “U+2 protein” or “U+2 toxin” or “U+2” or “U+2-ACTX-Hv1a” or “Spear” all refer to a U-ACTX-Hv1a having an additional dipeptide operably linked to the native peptide. The additional dipeptide that is operably linked to the U peptide is indicated by the “+2” or “plus 2” can be selected from among several peptides, any of which may result in a “U+2 peptide” with unique properties as discussed herein. In some preferred embodiments, the dipeptide is “GS”; an exemplary U+2-ACTX-Hv1a peptide is set forth in SEQ ID NO: 61.

“UBI” refers to ubiquitin. For example, in some embodiments, UBI can refer to a ubiquitin monomer isolated from Zea mays.

“var.” refers to varietas or variety. The term “var.” is used to indicate a taxonomic category that ranks below the species level and/or subspecies (where present). In some embodiments, the term “var.” represents members differing from others of the same subspecies or species in minor but permanent or heritable characteristics.

“Variant” or “variant sequence” or “variant peptide” refers to an amino acid sequence that possesses one or more conservative amino acid substitutions or conservative modifications. The conservative amino acid substitutions in a “variant” does not substantially diminish the activity of the variant in relation to its non-varied form. For example, in some embodiments, a “variant” possesses one or more conservative amino acid substitutions when compared to a peptide with a disclosed and/or claimed sequence, as indicated by a SEQ ID NO.

“Vector” refers to the DNA segment that accepts a foreign gene of interest (e.g., crip). The gene of interest is known as an “insert” or “transgene.”

“Vip” or “VIP” or “Vegetative Insecticidal Proteins” refer to proteins discovered from screening the supernatant of vegetatively grown strains of Bt for possible insecticidal activity. Vips have little or no similarity to Cry proteins. Of particular use and preference for use with this document are what have been called VIP3 or Vip3 proteins, which have Lepidopteran activity. Vips are thought to have a similar mode of action as Bt cry peptides.

“Vitrification” refers to a process of converting a material into a glass-like amorphous material. The glass-like amorphous solid may be free of any crystalline structure. Solidification of a vitreous solid occurs at the glass transition temperature (Tg).

“Wild type” or “WT” refers to the phenotype and/or genotype (i.e., the appearance or sequence) of an organism, polynucleotide sequence, and/or polypeptide sequence, as it is found and/or observed in its naturally occurring state or condition.

“Yeast expression vector” or “expression vector” or “vector” means a plasmid which can introduce a heterologous gene and/or expression cassette into yeast cells to be transcribed and translated.

“Yield” refers to the production of a peptide, and increased yields can mean increased amounts of production, increased rates of production, and an increased average or median yield and increased frequency at higher yields. The term “yield” when used in reference to plant crop growth and/or production, as in “yield of the plant” refers to the quality and/or quantity of biomass produced by the plant.

Throughout this specification, unless specifically stated otherwise or the context requires otherwise, reference to a single step, composition of matter, group of steps or group of compositions of matter shall be taken to encompass one and a plurality (i.e., one or more) of those steps, compositions of matter, groups of steps or group of compositions of matter.

The present disclosure is performed without undue experimentation using, unless otherwise indicated, conventional techniques of molecular biology, microbiology, virology, recombinant DNA technology, solid phase and liquid nucleic acid synthesis, peptide synthesis in solution, solid phase peptide synthesis, immunology, cell culture, and formulation. Such procedures are described, for example, in Sambrook, Fritsch & Maniatis, Molecular Cloning: A Laboratory Manual, Cold Spring Harbor Laboratories, New York, Second Edition (1989), whole of Vols I, II, and III; DNA Cloning: A Practical Approach, Vols. I and II (D. N. Glover, ed., 1985), IRL Press, Oxford, whole of text; Oligonucleotide Synthesis: A Practical Approach (M. J. Gait, ed, 1984) IRL Press, Oxford, whole of text, and particularly the papers therein by Gait, pp 1-22; Atkinson et al, pp 35-81; Sproat et al, pp 83-115; and Wu et al, pp 135-151; 4. Nucleic Acid Hybridization: A Practical Approach (B. D. Hames & S. J. Higgins, eds., 1985) IRL Press, Oxford, whole of text; Immobilized Cells and Enzymes: A Practical Approach (1986) IRL Press, Oxford, whole of text; Perbal, B., A Practical Guide to Molecular Cloning (1984); Methods In Enzymology (S. Colowick and N. Kaplan, eds., Academic Press, Inc.), whole of series; J. F. Ramalho Ortigao, “The Chemistry of Peptide Synthesis” In: Knowledge database of Access to Virtual Laboratory website (Interactiva, Germany); Sakakibara, D., Teichman, J., Lien, E. Land Fenichel, R. L. (1976). Biochem. Biophys. Res. Commun. 73 336-342; Merrifield, R. B. (1963). J. Am. Chem. Soc. 85, 2149-2154; Barany, G. and Merrifield, R. B. (1979) in “The Peptides” (Gross, E. and Meienhofer, 3. eds.), vol. 2, pp. 1-284, Academic Press, New York. 12. Wiinsch, E., ed. (1974) Synthese von Peptiden in Houben-Weyls Metoden der Organischen Chemie (Muler, E., ed.), vol. 15, 4th ed., Parts 1 and 2, Thieme, Stuttgart; Bodanszky, M. (1984) Principles of Peptide Synthesis, Springer-Verlag, Heidelberg; Bodanszky, M. & Bodanszky, A. (1984) The Practice of Peptide Synthesis, Springer-Verlag, Heidelberg; Bodanszky, M. (1985) Int. J. Peptide Protein Res. 25, 449-474; Handbook of Experimental Immunology, Vols. I-IV (D. M. Weir and C. C. Blackwell, eds., 1986, Blackwell Scientific Publications); and Animal Cell Culture: Practical Approach, Third Edition (John R. W. Masters, ed., 2000); each of these references are incorporated herein by reference in their entireties.

Throughout this specification, unless the context requires otherwise, the word “comprise,” or variations such as “comprises” or “comprising,” will be understood to imply the inclusion of a stated step or element or integer or group of steps or elements or integers but not the exclusion of any other step or element or integer or group of elements or integers.

All patent applications, patents, and printed publications referred to herein are incorporated by reference in their entirety to the same extent as if each individual publication, patent, or patent application was specifically and individually indicated to be incorporated by reference in its entirety. And, all patent applications, patents, and printed publications cited herein are incorporated herein by reference in the entireties, except for any definitions, subject matter disclaimers, or disavowals, and except to the extent that the incorporated material is inconsistent with the express disclosure herein, in which case the language in this disclosure controls.

Cysteine Rich Insecticidal Proteins (Crips)

The present invention provides combinations comprising (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA). Several types of CRIPs are contemplated and taught herein. The CRIPs of the present invention, which can be used in combination with the Insecticidal Agents (IAs) of the present invention, are described in detail below. All CRIPs suitable for the combinations of the present invention and contemplated below include CRIP-insecticidal proteins.

Spider Peptides and Toxins

In some embodiments, a CRIP can be a spider toxin peptide or protein isolated from one of the following: Phoneutria nigriventer; Allagelena opulenta; Cupiennius salei; Plectreurys tristis; Coremiocnemis vanda; Haplopelma huwenum; Agelena orientalis; Allagelena opulenta; Segestria florentina; Apomastus schlingeri; Phoneutria keyserlingi; Macrothele gigas; Macrothele raveni; Missulena bradleyi; Pireneitega luctuosa; Phoneutria reidyi; Illawara wisharti; Eucratoscelus constrictus; Agelenopsis aperta; Hololena curta; Oxyopes lineatus; Brachypelma albiceps; or Brachypelma smithi.

In some embodiments, a CRIP can be isolated from Hadronyche versuta, or the Blue Mountain funnel web spider, Hadronyche venenata, Atrax robustus, Atrax formidabilis, or Atrax infensus.

In some embodiments, a CRIP can be any of the following spider peptides, polypeptides, and/or toxins: U+2-ACTX-Hv1a; Γ-CNTX-Pn1a; U13-ctenitoxin-Pn1a, U13-ctenitoxin-Pn1b,U13-ctenitoxin-Pn1c, U1-agatoxin-Aop1a, U1-ctenitoxin-Cs1a, U1-nemetoxin-Csp1a, U1-nemetoxin-Csp1b, U1-nemetoxin-Csp1c, U1-plectoxin-Pt1a, U1-plectoxin-Pt1b, U1-plectoxin-Pt1c, U1-plectoxin-Pt1d, U1-plectoxin-Pt1f, U1-theraphotoxin-Cv1a, U1-theraphotoxin-Hh1a_1, U1-theraphotoxin-Hh1a_2, U1-theraphotoxin-Hh1a_3, U1-theraphotoxin-Hh1b, U1-theraphotoxin-Hh1c_1, U1-theraphotoxin-Hh1c_2, U1-theraphotoxin-Hh1d, U1-theraphotoxin-Hh1e, U1-theraphotoxin-Hh1f_1, U1-theraphotoxin-Hh1f_2, U1-theraphotoxin-Hh1f_3, U1-theraphotoxin-Hh1f_4, U1-theraphotoxin-Hh1g, U2-agatoxin-Ao1a, U2-agatoxin-Aop1a, U2-ctenitoxin-Cs1a, U2-ctenitoxin-Pn1a, U2-cyrtautoxin-As1a, U2-segestritoxin-Sf1a, U2-segestritoxin-Sf1b, U2-segestritoxin-Sf1c, U2-segestritoxin-Sf1d, U2-segestritoxin-Sf1e, U2-segestritoxin-Sf1f, U2-segestritoxin-Sf1g, U2-segestritoxin-Sf1h, U2-theraphotoxin-Hh1a, U3-cyrtautoxin-Asia, U3-plectoxin-Pt1a, U5-ctenitoxin-Pn1a, U7-ctenitoxin-Pk1a, β-hexatoxin-Mg1a, β-hexatoxin-Mr1a, Γ-ctenitoxin-Pn1a, 6-actinopoditoxin-Mb1a, δ-Amaurobitoxin-Pl1a, δ-Amaurobitoxin-Pl1b, 6-Amaurobitoxin-Pl1c, δ-Amaurobitoxin-Pl1d, δ-ctenitoxin-Asp2e, δ-ctenitoxin-Pn1a 1, 6-ctenitoxin-Pn1a 2, δ-ctenitoxin-Pn1b, δ-ctenitoxin-Pn2a, δ-ctenitoxin-Pn2b, δ-ctenitoxin-Pn2cδ-ctenitoxin-Pr2d, δ-hexatoxin-Aria, δ-hexatoxin-Hv1a, δ-hexatoxin-Hv1b, 6-hexatoxin-Iw1a, δ-hexatoxin-Mg1a, δ-hexatoxin-Mg1b, κ-hexatoxin-Hf1a, κ-hexatoxin-Hv1a, κ-hexatoxin-Hv1b, κ-hexatoxin-Hv1c_1, κ-hexatoxin-Hv1c_2, κ-hexatoxin-Hv1c_3, κ-hexatoxin-Hv1c_4, κ-hexatoxin-Hv1d, κ-hexatoxin-Hv1e, κ-theraphotoxin-Ec2a, κ-theraphotoxin-Ec2b, μ-agatoxin-Aa1a, μ-agatoxin-Aa1b, μ-agatoxin-Aa1c, μ-agatoxin-Aa1d, μ-agatoxin-Aa1e, μ-agatoxin-Aa1f, μ-agatoxin-Hc1a, μ-agatoxin-Hc1b, μ-agatoxin-Hc1c, μ-hexatoxin-Mg1a, μ-hexatoxin-Mg1b, μ-hexatoxin-Mg1c, μ-hexatoxin-Mg2a, μ-theraphotoxin-Hh1a, ω-actinopoditoxin-Mb1a, ω-agatoxin-Aa4a, ω-agatoxin-Aa4b, ω-agatoxin-Aa4c, ω-hexatoxin-Ar1a_1, ω-hexatoxin-Ar1a_3, ω-hexatoxin-Ar1b_1, ω-hexatoxin-Ar1d_1, ω-hexatoxin-Ar1d_4, ω-hexatoxin-Ar1e_1 ω-hexatoxin-Ar1f, ω-hexatoxin-Ar1g_1, ω-hexatoxin-Ar1h, ω-hexatoxin-Ar2a, ω-hexatoxin-Ar2b, ω-hexatoxin-Ar2c, ω-hexatoxin-Ar2d, ω-hexatoxin-Ar2e_1, ω-hexatoxin-Ar2e_2, ω-atracotoxin-Asp2a, ω-hexatoxin-Asp2b, ω-hexatoxin-Hf1a, ω-hexatoxin-Hi1a_1, ω-hexatoxin-Hi1a_2, ω-hexatoxin-Hi1a_3, ω-hexatoxin-Hi1b_1, ω-hexatoxin-Hi1b_10, ω-hexatoxin-Hi1b_2, ω-hexatoxin-Hi1b_5, ω-hexatoxin-Hi1b_8, ω-hexatoxin-Hi1c_1, ω-hexatoxin-Hi1c_2, ω-hexatoxin-Hv1a, ω-hexatoxin-Hv1b, ω-hexatoxin-Hv1c, ω-hexatoxin-Hv1d, ω-hexatoxin-Hv1e, ω-hexatoxin-Hv1f, ω-hexatoxin-Hv1g_1, ω-hexatoxin-Hv1g_5ω-hexatoxin-Hv1g_6ω-hexatoxin-Hv2a, ω-hexatoxin-Hv2b_1, ω-hexatoxin-Hv2b_2, ω-hexatoxin-Hv2b_3, ω-hexatoxin-Hv2b_4, ω-hexatoxin-Hv2b_5, ω-hexatoxin-Hv2b_6, ω-hexatoxin-Hv2b_7, ω-hexatoxin-Hv2c, ω-hexatoxin-Hv2d_1, ω-hexatoxin-Hv2d_2, ω-hexatoxin-Hv2d_3, ω-hexatoxin-Hv2e, ω-hexatoxin-Hv2f, ω-hexatoxin-Hv2g, ω-hexatoxin-Hv2h_1, ω-hexatoxin-Hv2h_2, ω-hexatoxin-Hv2i, ω-hexatoxin-Hv2j_1, ω-hexatoxin-Hv2j_2, ω-hexatoxin-Hv2k, ω-hexatoxin-Hv2l, ω-hexatoxin-Hv2m_1, ω-hexatoxin-Hv2m_2, ω-hexatoxin-Hv2m_3, ω-hexatoxin-Hv2n, ω-hexatoxin-Hv2o, ω-hexatoxin-Hvn1a, ω-hexatoxin-Hvn1b_1, ω-hexatoxin-Hvn1b_2, ω-hexatoxin-Hvn1b_3, ω-hexatoxin-Hvn1b_4, ω-hexatoxin-Hvn1b_6, ω-hexatoxin-Iw2a, ω-oxotoxin-Ol1b, ω-plectoxin-Pt1a, ω-theraphotoxin-Asp1a, ω-theraphotoxin-Asp1f, ω-theraphotoxin-Asp1g, ω-theraphotoxin-Ba1a, ω-theraphotoxin-Ba1b, ω-theraphotoxin-Bs1a, ω-theraphotoxin-Bs2a, or ω-theraphotoxin-Hh2a.

In some embodiments, a CRIP can be a spider toxin peptide or protein having an amino acid sequence as set forth in any one of SEQ ID NOs: 192-278 and 281-370.

In some embodiments, a polynucleotide encoding a CRIP can encode a CRIP having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 192-278 and 281-370.

ACTX Peptides

In some embodiments, a CRIP can be an ACTX peptide.

In some embodiments, a CRIP can be one or more of the following ACTX peptides: U-ACTX-Hv1a, U+2-ACTX-Hv1a, rU-ACTX-Hv1a, rU-ACTX-Hv1b, rκ-ACTX-Hv1c, ω-ACTX-Hv1a, and/or ω-ACTX-Hv1a+2.

Exemplary ACTX peptides include: U-ACTX-Hv1a, having the amino acid sequence “QYCVPVDQPCSLNTQPCCDDATCTQERNENGHTVYYCRA” (SEQ ID NO: 60); U+2-ACTX-Hv1a, having the amino acid sequence “GSQYCVPVDQPCSLNTQPCCDDATCTQERNENGHTVYYCRA” (SEQ ID NO: 61); Omega-ACTX-Hv1a, having the amino acid sequence “SPTCIPSGQPCPYNENCCSQSCTFKENENGNTVKRCD” (SEQ ID NO: 62); “ω+2-ACTX-Hv1a+2” (or Omega+2-ACTX-Hv1a) having the amino acid sequence “GSSPTCIPSGQPCPYNENCCSQSCTFKENENGNTVKRCD” (SEQ ID NO: 63); and Kappa+2-ACTX-Hv1a (or κ+2-ACTX-Hv1a), having the amino acid sequence “GSAICTGADRPCAACCPCCPGTSCKAESNGVSYCRKDEP” (SEQ ID NO: 64).

In some embodiments, a CRIP can be “Kappa-ACTX-Hv1a” (or κ+2-ACTX-Hv1a) having the amino acid sequence “AICTGADRPCAACCPCCPGTSCKAESNGVSYCRKDEP” (SEQ ID NO: 594).

In some embodiments, an ACTX peptide may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to SEQ ID NOs: 60-64, 192-370 and 594.

In some embodiments, a polynucleotide encoding an ACTX peptide can encode an ACTX peptide having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 60-64, and 594.

Γ-CNTX-Pn1a Peptides

In some preferred embodiments, a CRIP can be a Γ-CNTX-Pn1a or γ-CNTX-Pn1a toxin. The Γ-CNTX-Pn1a peptide is an insecticidal neurotoxin derived from the Brazilian armed spider, Phoneutria nigriventer. Γ-CNTX-Pn1a targets the N-methyl-D-aspartate (NMDA)-subtype of ionotropic glutamate receptor (GRIN), and sodium channels. An exemplary wild-type full length Γ-CNTX-Pn1a peptide has an amino acid sequence of: MKVAIVFLSLLVLAFASESIEENREEFPVEESARCADINGACKSDCDCCGDSVTCDCY WSDSCKCRESNFKIGMAIRKKFC (SEQ ID NO: 689) (NCBI Accession No. P59367). A recombinant mature Γ-CNTX-Pn1a peptide is provided, having an amino acid sequence of “GSCADINGACKSDCDCCGDSVTCDCYWSDSCKCRESNFKIGMAIRKKFC” (SEQ ID NO: 65).

In some embodiments, an Γ-CNTX-Pn1a peptide may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to SEQ ID NO: 65.

In some embodiments, a polynucleotide encoding a Γ-CNTX-Pn1a peptide can encode a Γ-CNTX-Pn1a peptide having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 65.

Wild-Type U1-Agatoxins and TVPs

“Hobo spiders” (Eratigena agrestis, formerly Tegenaria agrestis) are venomous spiders that are members of the Agelenidae family of spiders, or funnel web weavers. See Ingale A, Antigenic epitopes prediction and MEC binder of a paralytic insecticidal toxin (ITX-1) of Tegenaria agrestis (hobo spider). 4 Aug. 2010 Volume 2010:2 pp 97-103. The venom of Hobo spiders has been implicated as possessing insecticidal activity. See Johnson et al., Novel insecticidal peptides from Tegenaria agrestis spider venom may have a direct effect on the insect central nervous system. Arch Insect Biochem Physiol. 1998; 38(1):19-31; Klint et al., Production of Recombinant Disulfide-Rich Venom Peptides for Structural and Functional Analysis via Expression in the Periplasm of E. coli. PLoS One. 2013; 8(5): e63865.

The Hobo spider—along with several other spiders in the Agelenidae family, produce venom containing agatoxins—which exhibit insecticidal activity. Agatoxins are a chemically diverse group of toxins that can induce various insecticidal effects depending on the target species; e.g., agatoxins cause slow-onset spastic paralysis in coleopterans, lepidopterans, and dipterans; increase the rate of neuron firing in the central nervous system (CNS) of houseflies (Musca domestica); and are lethal to other insects (e.g., the blowfly, Lucilia cuprina). Accordingly, agatoxins are implicated in targeting the CNS. See Undheim et al., Weaponization of a hormone: convergent recruitment of hyperglycemic hormone into the venom of arthropod predators. Structure 23: 1283-1292, and Johnson et al., Novel insecticidal peptides from Tegenaria agrestis spider venom may have a direct effect on the insect central nervous system. Arch. Insect Biochem. Physiol. 38:19-31(1998).

Two types of agatoxins include U1-agatoxin-Ta1a and U1-agatoxin-Ta1b, which are both members of the helical arthropod-neuropeptide-derived (HAND) toxins family. In addition to spiders, these toxins can also be found in the venom of centipedes. The agatoxins are evolutionary offshoots of an ancient ecdysozoan hormone family, i.e., the ion transport peptide/crustacean hyperglycemic hormone (ITP/CHH) family. See Undheim et al., Weaponization of a hormone: convergent recruitment of hyperglycemic hormone into the venom of arthropod predators. Structure 23: 1283-1292, and Johnson et al., Novel insecticidal peptides from Tegenaria agrestis spider venom may have a direct effect on the insect central nervous system. Arch. Insect Biochem. Physiol. 38:19-31(1998).

The Hobo-spider-derived U1-agatoxin-Ta1b toxin has a full amino acid sequence of

“MKLQLMICLVLLPCFFCEPDEICRARMTNKEFTYKSNVCNNCGDQVAACEAECFRN DVYTACHEAQKG (SEQ ID NO:48)” which includes a signal peptide from amino acid positions 1-17, and the mature toxin from positions 18-68. Id. The protein comprises four tightly packed α-helices, with no β-strands present, and the molecular mass of the mature toxin is 5700.39 Daltons (Da). Id.

An exemplary mature wild-type U1-agatoxin-Ta1b polypeptide from Eratigena agrestis is provided having the amino acid sequence:

(SEQ ID NO: 1)
“EPDEICRARMTNKEFTYKSNVCNNCGDQVAACEAECFRNDVYTACHEA
QKG”.

During protein processing, the mature wild-type U1-agatoxin-Ta1b toxin undergoes an excision event of the C-terminal glycine, yielding the following amino acid sequence:

EPDEICRARMTNKEFTYKSNVCNNCGDQVAACEAECFRNDVYTACHEAQK (SEQ ID NO: 60). A subsequent post-translational event result in the mature wild-type U1-agatoxin-Ta1b toxin having a C-terminal amidation.

U1-agatoxin-Ta1b Variant Polypeptides (TVPs) are mutants or variants that differ from the wild-type U1-agatoxin-Ta1b (SEQ ID NO:1) in some way, e.g., in some embodiments, this variance can be an amino acid substitution, deletion, or addition; or a change to the polynucleotide encoding the wild-type U1-agatoxin-Ta1b resulting in an amino acid substitution, deletion, or addition. The result of this variation is a non-naturally occurring polypeptide and/or polynucleotide sequence encoding the same that possesses enhanced insecticidal activity against one or more insect species relative to the wild-type U1-agatoxin-Ta1b.

In some embodiments, a TVP can have an amino acid sequence according to SEQ ID NOs: 2-15, 49-53, 621-622, 624-628, 631-640, 642-651, or 653-654, as shown in Table 1.

TABLE 1
TVPs of the present invention.

| Amino | | | |
|---|---|---|---|
| Acid | | | |
| SEQ ID | | Amino Acid | |
| NO | Name | Sequence | Nucleotide Sequence |
| 1 | WT-Ta1b | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 2 | TVP-R9Q | EPDEICRAQMTNKEF | GAACCAGACGAGATATGCAGAGCAcaaATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 3 | TVP-R9QΔG | EPDEICRAQMTNKEF | GAACCAGACGAGATATGCAGAGCAcaaATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 4 | TVP-K18A | EPDEICRARMTNKEF | GAACCAGACGAGATATGCAGAGCAAGGATGACC |
| | | TYASNVCNNCGDQVA | AACAAAGAATTTACCTATgctTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 5 | TVP- | EPDEICRARMTNKEF | GAACCAGACGAGATATGCAGAGCAAGGATGACC |
| | K18AΔG | TYASNVCNNCGDQVA | AACAAAGAATTTACCTATgctTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 6 | TVP-R38A | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFANDVYTAC | AATAATTGTGGCGACCAGGTGGCAGCCTGCGAG |
| | | HEAQKG | GCAGAGTGCTTTgctAATGACGTTTACACAGCT |
| | | | TGTCACGAGGCTCAGAAAGGT |
| 7 | TVP- | EPDEICRARMTNKEF | GAACCAGACGAGATATGCAGAGCAAGGATGACC |
| | R38AΔG | TYKSNVCNNCGDQVA | AACAAAGAATTTACCTATAAGTCCAACGTATGC |
| | | ACEAECFANDVYTAC | AATAATTGTGGCGACCAGGTGGCAGCCTGCGAG |
| | | HEAQK | GCAGAGTGCTTTgctAATGACGTTTACACAGCT |
| | | | TGTCACGAGGCTCAGAAA |
| 8 | TVP-A8N | EPDEICRNRMTNKEF | GAACCAGACGAGATATGCAGAaacAGGATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 9 | TVP-A8NΔG | EPDEICRNRMTNKEF | GAACCAGACGAGATATGCAGAaacAGGATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 10 | TVP-A8S | EPDEICRSRMTNKEF | GAACCAGACGAGATATGCAGAtcaAGGATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 11 | TVP-A8SΔG | EPDEICRSRMTNKEF | GAACCAGACGAGATATGCAGAtcaAGGATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 12 | TVP-R9N | EPDEICRANMTNKEF | GAACCAGACGAGATATGCAGAGCAaacATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 13 | TVP-R9NΔG | EPDEICRANMTNKEF | GAACCAGACGAGATATGCAGAGCAaacATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 14 | TVP-T11P | EPDEICRARMPNKEF | GAACCAGACGAGATATGCAGAGCAAGGATGcct |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 15 | TVP- | EPDEICRARMPNKEF | GAACCAGACGAGATATGCAGAGCAAGGATGcct |
| | T11PΔG | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQK | GCAGAGTGCTTTCGTAATGACGTTTACACAGCT |
| | | | TGTCACGAGGCTCAGAAA |
| 49 | TVP-T43A | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYAAC | AATAATTGTGGCGACCAGGTGGCAGCCTGCGAG |
| | | HEAQKG | GCAGAGTGCTTTCGTAATGACGTTTACgctGCT |
| | | | TGTCACGAGGCTCAGAAAGGT |
| 50 | TVP- | EPDEICRARMTNKEF | GAACCAGACGAGATATGCAGAGCAAGGATGACC |
| | T43AΔG | TYKSNVCNNCGDQVA | AACAAAGAATTTACCTATAAGTCCAACGTATGC |
| | | ACEAECERNDVYAAC | AATAATTGTGGCGACCAGGTGGCAGCCTGCGAG |
| | | HEAQK | GCAGAGTGCTTTCGTAATGACGTTTACgctGCT |
| | | | TGTCACGAGGCTCAGAAA |
| 51 | TVP- | EPDEICRAQMTNKEF | GAACCAGACGAGATATGCAGAGCAcaaATGACC |
| | R9Q/T43A | TYKSNVCNNCGDQVA | AACAAAGAATTTACCTATAAGTCCAACGTATGC |
| | | ACEAECFRNDVYAAC | AATAATTGTGGCGACCAGGTGGCAGCCTGCGAG |
| | | HEAQKG | GCAGAGTGCTTTCGTAATGACGTTTACgctGCT |
| | | | TGTCACGAGGCTCAGAAAGGT |
| 52 | TVP- | EPDEICRAQMTNKEF | GAACCAGACGAGATATGCAGAGCAcaaATGACC |
| | R9Q/T43A/ | TYKSNVCNNCGDQVA | AACAAAGAATTTACCTATAAGTCCAACGTATGC |
| | ΔG | ACEAECFRNDVYAAC | AATAATTGTGGCGACCAGGTGGCAGCCTGCGAG |
| | | HEAQK | GCAGAGTGCTTTCGTAATGACGTTTACgctGCT |
| | | | TGTCACGAGGCTCAGAAA |
| 53 | TVP- | EPDEICRAQMTNKEF | GAACCAGACGAGATATGCAGAGCAcaaATGACC |
| | R9Q/T43A/ | TYKSNVCNNCGDQVA | AACAAAGAATTTACCTATAAGTCCAACGTATGC |
| | ΔK-G | ACEAECERNDVYAAC | AATAATTGTGGCGACCAGGTGGCAGCCTGCGAG |
| | | HEAQ | GCAGAGTGCTTTCGTAATGACGTTTACgctGCT |
| | | | TGTCACGAGGCTCAG |
| 621 | TVP-R9A | EPDEICRAAMTNKEF | GAACCAGACGAGATATGCAGAGCAgcaATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 622 | TVP-R9G | EPDEICRAGMTNKEF | GAACCAGACGAGATATGCAGAGCAggaATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 623 | TVP-R9N | EPDEICRANMTNKEF | GAACCAGACGAGATATGCAGAGCAaatATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 624 | TVP-R9L | EPDEICRALMTNKEF | GAACCAGACGAGATATGCAGAGCActaATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 625 | TVP-R9D | EPDEICRADMTNKEF | GAACCAGACGAGATATGCAGAGCAgatATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 626 | TVP-R9V | EPDEICRAVMTNKEF | GAACCAGACGAGATATGCAGAGCAgtcATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 627 | TVP-R9M | EPDEICRAMMTNKEF | GAACCAGACGAGATATGCAGAGCAatgATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 628 | TVP-R9I | EPDEICRAIMTNKEF | GAACCAGACGAGATATGCAGAGCAattATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 629 | TVP-R9Q/ | EPDEICRAQMTNKEF | GAACCAGACGAGATATGCAGAGCAcaaATGACC |
| | T43A | TYKSNVCNNCGDQVA | AACAAAGAATTTACCTATAAGTCCAACGTATGC |
| | | ACEAECFRNDVYAAC | AATAATTGTGGCGACCAGGTGGCAGCCTGCGAG |
| | | HEAQKG | GCAGAGTGCTTTCGTAATGACGTTTACgcaGCT |
| | | | TGTCACGAGGCTCAGAAAGGT |
| 630 | TVP-R9Q | EPDEICRAQMTNKEF | GAACCAGACGAGATATGCAGAGCAcaaATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 631 | TVP-R9C | EPDEICRACMTNKEF | GAACCAGACGAGATATGCAGAGCAtctATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 632 | TVP-R9E | EPDEICRAEMTNKEF | GAACCAGACGAGATATGCAGAGCAgaaATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 633 | TVP-R9T | EPDEICRATMTNKEF | GAACCAGACGAGATATGCAGAGCAactATGACC |
| | | TYKSNVCNNCGDQVA | AACAAAGAATTTACCTATAAGTCCAACGTATGC |
| | | ACEAECFRNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 634 | TVP-R9S | EPDEICRASMINKEF | GAACCAGACGAGATATGCAGAGCAtctATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 635 | TVP-T43F | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYFAC | AATAATTGTGGCGACCAGGTGGCAGCCTGCGAG |
| | | HEAQKG | GCAGAGTGCTTTCGTAATGACGTTTACtttGCT |
| | | | TGTCACGAGGCTCAGAAAGGT |
| 636 | TVP-T43P | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYPAC | AATAATTGTGGCGACCAGGTGGCAGCCTGCGAG |
| | | HEAQKG | GCAGAGTGCTTTCGTAATGACGTTTACcctGCT |
| | | | TGTCACGAGGCTCAGAAAGGT |
| 637 | TVP-T43Y | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYYAC | AATAATTGTGGCGACCAGGTGGCAGCCTGCGAG |
| | | HEAQKG | GCAGAGTGCTTTCGTAATGACGTTTACtatGCT |
| | | | TGTCACGAGGCTCAGAAAGGT |
| 638 | TVP-T43K | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYKAC | AATAATTGTGGCGACCAGGTGGCAGCCTGCGAG |
| | | HEAQKG | GCAGAGTGCTTTCGTAATGACGTTTACaaaGCT |
| | | | TGTCACGAGGCTCAGAAAGGT |
| 639 | TVP-T43W | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYWAC | AATAATTGTGGCGACCAGGTGGCAGCCTGCGAG |
| | | HEAQKG | GCAGAGTGCTTTCGTAATGACGTTTACtggGCT |
| | | | TGTCACGAGGCTCAGAAAGGT |
| 640 | TVP-T43H | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYHAC | AATAATTGTGGCGACCAGGTGGCAGCCTGCGAG |
| | | HEAQKG | GCAGAGTGCTTTCGTAATGACGTTTACcatGCT |
| | | | TGTCACGAGGCTCAGAAAGGT |
| 641 | TVP-T43A | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYAAC | AATAATTGTGGCGACCAGGTGGCAGCCTGCGAG |
| | | HEAQKG | GCAGAGTGCTTTCGTAATGACGTTTACgctGCT |
| | | | TGTCACGAGGCTCAGAAAGGT |
| 642 | TVP-T43G | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYGAC | AATAATTGTGGCGACCAGGTGGCAGCCTGCGAG |
| | | HEAQKG | GCAGAGTGCTTTCGTAATGACGTTTACggtGCT |
| | | | TGTCACGAGGCTCAGAAAGGT |
| 643 | TVP-T43N | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYNAC | AATAATTGTGGCGACCAGGTGGCAGCCTGCGAG |
| | | HEAQKG | GCAGAGTGCTTTCGTAATGACGTTTACaatGCT |
| | | | TGTCACGAGGCTCAGAAAGGT |
| 644 | TVP-T43L | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYLAC | AATAATTGTGGCGACCAGGTGGCAGCCTGCGAG |
| | | HEAQKG | GCAGAGTGCTTTCGTAATGACGTTTACttaGCT |
| | | | TGTCACGAGGCTCAGAAAGGT |
| 645 | TVP-T43D | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYDAC | AATAATTGTGGCGACCAGGTGGCAGCCTGCGAG |
| | | HEAQKG | GCAGAGTGCTTTCGTAATGACGTTTACgatGCT |
| | | | TGTCACGAGGCTCAGAAAGGT |
| 646 | TVP-T43V | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYVAC | AATAATTGTGGCGACCAGGTGGCAGCCTGCGAG |
| | | HEAQKG | GCAGAGTGCTTTCGTAATGACGTTTACgtcGCT |
| | | | TGTCACGAGGCTCAGAAAGGT |
| 647 | TVP-T43M | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYMAC | AATAATTGTGGCGACCAGGTGGCAGCCTGCGAG |
| | | HEAQKG | GCAGAGTGCTTTCGTAATGACGTTTACatgGCT |
| | | | TGTCACGAGGCTCAGAAAGGT |
| 648 | TVP-T43I | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYIAC | AATAATTGTGGCGACCAGGTGGCAGCCTGCGAG |
| | | HEAQKG | GCAGAGTGCTTTCGTAATGACGTTTACattGCT |
| | | | TGTCACGAGGCTCAGAAAGGT |
| 649 | TVP-T43Q | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYQAC | AATAATTGTGGCGACCAGGTGGCAGCCTGCGAG |
| | | HEAQKG | GCAGAGTGCTTTCGTAATGACGTTTACcaaGCT |
| | | | TGTCACGAGGCTCAGAAAGGT |
| 650 | TVP-T43C | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYCAC | AATAATTGTGGCGACCAGGTGGCAGCCTGCGAG |
| | | HEAQKG | GCAGAGTGCTTTCGTAATGACGTTTACtctGCT |
| | | | TGTCACGAGGCTCAGAAAGGT |
| 651 | TVP-T43E | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECFRNDVYEAC | AATAATTGTGGCGACCAGGTGGCAGCCTGCGAG |
| | | HEAQKG | GCAGAGTGCTTTCGTAATGACGTTTACgaaGCT |
| | | | TGTCACGAGGCTCAGAAAGGT |
| 652 | TVP-T43T | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYTAC | AATAATTGTGGCGACCAGGTGGCAGCCTGCGAG |
| | | HEAQKG | GCAGAGTGCTTTCGTAATGACGTTTACACAGCT |
| | | | TGTCACGAGGCTCAGAAAGGT |
| 653 | TVP-T43S | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYSAC | AATAATTGTGGCGACCAGGTGGCAGCCTGCGAG |
| | | HEAQKG | GCAGAGTGCTTTCGTAATGACGTTTACtcaGCT |
| | | | TGTCACGAGGCTCAGAAAGGT |
| 654 | TVP-T43R | EPDEICRARMTNKEF | GAACCAGACGAGATATGCAGAGCAAGGATGACC |
| | | TYKSNVCNNCGDQVA | AACAAAGAATTTACCTATAAGTCCAACGTATGC |
| | | ACEAECERNDVYRAC | AATAATTGTGGCGACCAGGTGGCAGCCTGCGAG |
| | | HEAQKG | GCAGAGTGCTTTCGTAATGACGTTTACagaGCT |
| | | | TGTCACGAGGCTCAGAAAGGT |

In some embodiments, a polynucleotide sequence having a sequence according to SEQ ID NOs: 2-15, 49-53, 621-622, 624-628, 631-640, 642-651, or 653-654, is operable to encode a TVP. For example, in some embodiments, a polynucleotide as shown in Table 2 is operable to encode a TVP.

TABLE 2
Polynucleotides of the present invention.

| Polynucleotide | | |
|---|---|---|
| SEQ ID NO | Name | Sequence |
| 16 | WT-Ta1b | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 17 | TVP-R9Q | GAACCAGACGAGATATGCAGAGCAcaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 18 | TVP-R9QΔG | GAACCAGACGAGATATGCAGAGCAcaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 19 | TVP-K18A | GAACCAGACGAGATATGCAGAGCAAGGATGACCAACAAAGA |
| | | ATTTACCTATgctTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 20 | TVP-K18AΔG | GAACCAGACGAGATATGCAGAGCAAGGATGACCAACAAAGA |
| | | ATTTACCTATgctTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 21 | TVP-R38A | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTgctAATGACGTT |
| | | TACACAGCTTGTCACGAGGCTCAGAAAGGT |
| 22 | TVP-R38AΔG | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTgctAATGACGTT |
| | | TACACAGCTTGTCACGAGGCTCAGAAA |
| 23 | TVP-A8N | GAACCAGACGAGATATGCAGAaacAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 24 | TVP-A8NΔG | GAACCAGACGAGATATGCAGAaacAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 25 | TVP-A8S | GAACCAGACGAGATATGCAGAtcaAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 26 | TVP-A8SΔG | GAACCAGACGAGATATGCAGAtcaAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 27 | TVP-R9N | GAACCAGACGAGATATGCAGAGCAaacATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 28 | TVP-R9NΔG | GAACCAGACGAGATATGCAGAGCAaacATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 29 | TVP-T11P | GAACCAGACGAGATATGCAGAGCAAGGATGcctAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 30 | TVP-T11PΔG | GAACCAGACGAGATATGCAGAGCAAGGATGcctAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAA |
| 54 | TVP-T43A | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAGAAAGGT |
| 55 | TVP-T43AΔG | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAGAAA |
| 56 | TVP-R9Q/T43A | GAACCAGACGAGATATGCAGAGCAcaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAGAAAGGT |
| 57 | TVP-R9Q/T43A/ | GAACCAGACGAGATATGCAGAGCAcaaATGACCAACAAAGA |
| | ΔG | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAGAAA |
| 58 | TVP- | GAACCAGACGAGATATGCAGAGCAcaaATGACCAACAAAGA |
| | R9Q/T43A/ΔK-G | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAG |
| 655 | TVP-R9A | GAACCAGACGAGATATGCAGAGCAgcaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 656 | TVP-R9G | GAACCAGACGAGATATGCAGAGCAggaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 657 | TVP-R9N | GAACCAGACGAGATATGCAGAGCAaatATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 658 | TVP-R9L | GAACCAGACGAGATATGCAGAGCActaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 659 | TVP-R9D | GAACCAGACGAGATATGCAGAGCAgatATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 660 | TVP-R9V | GAACCAGACGAGATATGCAGAGCAgtcATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 661 | TVP-R9M | GAACCAGACGAGATATGCAGAGCAatgATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 662 | TVP-R9I | GAACCAGACGAGATATGCAGAGCAattATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 663 | TVP-R9Q/T43A | GAACCAGACGAGATATGCAGAGCAcaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgcaGCTTGTCACGAGGCTCAGAAAGGT |
| 664 | TVP-R9Q | GAACCAGACGAGATATGCAGAGCAcaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 665 | TVP-R9C | GAACCAGACGAGATATGCAGAGCAtctATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 666 | TVP-R9E | GAACCAGACGAGATATGCAGAGCAgaaATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 667 | TVP-R9T | GAACCAGACGAGATATGCAGAGCAactATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 668 | TVP-R9S | GAACCAGACGAGATATGCAGAGCAtctATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 669 | TVP-T43F | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACtttGCTTGTCACGAGGCTCAGAAAGGT |
| 670 | TVP-T43P | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACcctGCTTGTCACGAGGCTCAGAAAGGT |
| 671 | TVP-T43Y | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACtatGCTTGTCACGAGGCTCAGAAAGGT |
| 672 | TVP-T43K | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACaaaGCTTGTCACGAGGCTCAGAAAGGT |
| 673 | TVP-T43W | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACtggGCTTGTCACGAGGCTCAGAAAGGT |
| 674 | TVP-T43H | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACcatGCTTGTCACGAGGCTCAGAAAGGT |
| 675 | TVP-T43A | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgctGCTTGTCACGAGGCTCAGAAAGGT |
| 676 | TVP-T43G | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACggtGCTTGTCACGAGGCTCAGAAAGGT |
| 677 | TVP-T43N | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACaatGCTTGTCACGAGGCTCAGAAAGGT |
| 678 | TVP-T43L | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACttaGCTTGTCACGAGGCTCAGAAAGGT |
| 679 | TVP-T43D | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgatGCTTGTCACGAGGCTCAGAAAGGT |
| 680 | TVP-T43V | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgtcGCTTGTCACGAGGCTCAGAAAGGT |
| 681 | TVP-T43M | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACatgGCTTGTCACGAGGCTCAGAAAGGT |
| 682 | TVP-T43I | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACattGCTTGTCACGAGGCTCAGAAAGGT |
| 683 | TVP-T43Q | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACcaaGCTTGTCACGAGGCTCAGAAAGGT |
| 684 | TVP-T43C | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACtctGCTTGTCACGAGGCTCAGAAAGGT |
| 685 | TVP-T43E | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACgaaGCTTGTCACGAGGCTCAGAAAGGT |
| 686 | TVP-T43T | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACACAGCTTGTCACGAGGCTCAGAAAGGT |
| 687 | TVP-T43S | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACtcaGCTTGTCACGAGGCTCAGAAAGGT |
| 688 | TVP-T43R | GAACCAGACGAGATATGCAGAGCAAGGATGACCAACAAAGA |
| | | ATTTACCTATAAGTCCAACGTATGCAATAATTGTGGCGACC |
| | | AGGTGGCAGCCTGCGAGGCAGAGTGCTTTCGTAATGACGTT |
| | | TACagaGCTTGTCACGAGGCTCAGAAAGGT |

Exemplary TVPs

An exemplary description of TVPs, and polynucleotides operable to encode TVP, is provided in International Application No. PCT/US21/28254, the disclosure of which is incorporated herein by reference in its entirety.

In some embodiments, a TVP comprises one or more mutations relative to the wild-type sequence of U1-agatoxin-Ta1b as set forth in SEQ ID NO:1. For example, in some embodiments, a TVP can have a first, second, or third mutation relative to the wild-type sequence of U1-agatoxin-Ta1b as set forth in SEQ ID NO:1.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP has one amino acid substitution at X₁, X₂, X₃, X₄, or X₅, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP has one amino acid substitution at X₁, X₂, X₃, X₄, or X₅; and wherein X₇ is Glycine, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP has one amino acid substitution at X₁, X₂, X₃, X₄, or X₅; and wherein X₇ is absent, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP has one amino acid substitution at X₁, X₂, X₃, X₄, or X₅; and wherein X₆ and X₇ are absent, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP comprises an amino sequence as set forth in any one of SEQ ID NOs: 2-15, 49-53, 621-622, 624-628, 631-640, 642-651, or 653-654, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP is encoded by a polynucleotide sequence as set forth in any one of SEQ ID NOs: 17-30, 54-58, or 655-688, or a complementary nucleotide sequence thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP further comprises a homopolymer or heteropolymer of two or more TVPs, wherein the amino acid sequence of each TVP is the same or different.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A;

X₅ is R or A; Z₁ is T, S, A, F, P, Y, K, W, H, A, G, N, L, V, M, I, Q, C, E, or R; X₆ is K or absent; and X₇ is G or absent; and wherein the TVP is a fused protein comprising two or more TVPs separated by a cleavable or non-cleavable linker, and wherein the amino acid sequence of each TVP may be the same or different.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein the TVP is a fused protein comprising two or more TVPs separated by a cleavable or non-cleavable linker, and wherein the amino acid sequence of each TVP may be the same or different, and wherein the linker is cleavable inside the gut or hemolymph of an insect.

In some embodiments, the linker has an amino acid sequence as set forth in any one of SEQ ID NOs: 61-70.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; and wherein if Z₁ is T or S, then the TVP is glycosylated, or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence

(SEQ ID NO: 51)
“EPDEICRAQMTNKEFTYKSNVCNNCGDQVAACEAECFRNDVYAACHEA
QKG”.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof; wherein if Z₁ is T then the TVP is glycosylated.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof, wherein X₁ is Q; and Z₁ is A.

In some embodiments, an insecticidal U₁-agatoxin-Ta1b variant polypeptide (TVP), can be a TVP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence to the amino acid sequence as set forth in any one of SEQ ID NOs: 2, 49, or 51, or a pharmaceutically acceptable salt thereof.

In some embodiments, the TVP may comprise an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence:

(SEQ ID NO: 51)
“EPDEICRAQMTNKEFTYKSNVCNNCGDQVAACEAECFRNDVYAACHEA
QKG”.

In some preferred embodiments, a TVP can be a TVP-R9Q/T43A (SEQ ID NO: 51).

In various embodiments, polynucleotides encoding TVPs can be used to transform plant cells, yeast cells, or bacteria cells. In some embodiments, the insecticidal TVP transgenic proteins may be formulated into compositions that can be sprayed or otherwise applied in any manner known to those skilled in the art to the surface of plants or parts thereof. Accordingly, DNA constructs are provided herein, operable to encode one or more TVPs under the appropriate conditions in a host cell, for example, a plant cell. Methods for controlling a pest infection by a parasitic insect of a plant cell comprises administering or introducing a polynucleotide encoding a TVP as described herein to a plant, plant tissue, or a plant cell by recombinant techniques and growing said recombinantly altered plant, plant tissue or plant cell in a field exposed to the pest. Alternatively, TVPs can be formulated into a sprayable composition consisting of a TVP and an excipient, and applied directly to susceptible plants by direct application, such that upon ingestion of the TVP by the infectious insect results in a deleterious effect.

Scorpion Peptides and Toxins

In some embodiments, a CRIP can be any of the following scorpion peptides, polypeptides, and/or toxins: Imperatoxin-A (IpTxa), Potassium channel toxin alpha-KTx 10.2 (Cobatoxin-2), Potassium channel toxin alpha-KTx 11.1 (Parabutoxin-1), Potassium channel toxin alpha-KTx 11.2 (Parabutoxin-2), Potassium channel toxin alpha-KTx 11.3 (Parabutoxin-10), Potassium channel toxin alpha-KTx 12.1 (Butantoxin), Potassium channel toxin alpha-KTx 12.2 (Butantoxin), Potassium channel toxin alpha-KTx 12.3 (Butantoxin-like peptide), Potassium channel toxin alpha-KTx 15.1 (Peptide Aa1), Potassium channel toxin alpha-KTx 15.3 (Toxin AmmTX3), Potassium channel toxin alpha-KTx 15.6 (Discrepin), Potassium channel toxin alpha-KTx 16.1 (Tamulotoxin), Potassium channel toxin alpha-KTx 19.1 (Neurotoxin BmBKTx1), Potassium channel toxin alpha-KTx 1.3 (Iberiotoxin), Potassium channel toxin alpha-KTx 1.4 (Limbatotoxin), Potassium channel toxin alpha-KTx 1.7 (Lqh 15-1), Potassium channel toxin alpha-KTx 1.9 (Hongotoxin-2), Potassium channel toxin alpha-KTx 1.10 (Parabutoxin-3), Potassium channel toxin alpha-KTx 1.11 (Slotoxin), Potassium channel toxin alpha-KTx 1.13 (Charybdotoxin c), Potassium channel toxin alpha-KTx 2.1 (Noxiustoxin), Potassium channel toxin alpha-KTx 2.2 (Margatoxin), Potassium channel toxin alpha-KTx 2.3 (CllTx1), Potassium channel toxin alpha-KTx 2.4 (Noxiustoxin-2), Potassium channel toxin alpha-KTx 2.5 (Hongotoxin-1), Potassium channel toxin alpha-KTx 2.6 (Hongotoxin-3), Potassium channel toxin alpha-KTx 2.7 (CllTx2), Potassium channel toxin alpha-KTx 2.8 (Toxin Ce1), Potassium channel toxin alpha-KTx 2.9 (Toxin Ce2), Potassium channel toxin alpha-KTx 2.10 (Toxin Ce3), Potassium channel toxin alpha-KTx 2.11 (Toxin Ce4), Potassium channel toxin alpha-KTx 2.12 (Toxin Ce5), Potassium channel toxin alpha-KTx 3.1 (Kaliotoxin-1), Potassium channel toxin alpha-KTx 3.2 (Agitoxin-2), Potassium channel toxin alpha-KTx 3.3 (Agitoxin-3), Potassium channel toxin alpha-KTx 3.4 (Agitoxin-1), Potassium channel toxin alpha-KTx 3.7 (OsK-1), Potassium channel toxin alpha-KTx 3.8 (Charybdotoxin-like peptide Bs 6), Potassium channel toxin alpha-KTx 3.9 (Kaliotoxin-3), Potassium channel toxin alpha-KTx 4.1 (Tityustoxin K-alpha), Potassium channel toxin alpha-KTx 4.3 (Toxin TdK1), Potassium channel toxin alpha-KTx 4.4 (Toxin Tc30), Potassium channel toxin alpha-KTx 5.1 (Leiurotoxin-1), Potassium channel toxin alpha-KTx 5.2 (Leiurotoxin I-like toxin P05), Potassium channel toxin alpha-KTx 5.4 (Tamapin), Potassium channel toxin alpha-KTx 5.5 (Tamapin-2), Potassium channel toxin alpha-KTx 6.1 (Potassium channel-blocking toxin 1), Potassium channel toxin alpha-KTx 6.2 (Maurotoxin), Potassium channel toxin alpha-KTx 6.3 (Neurotoxin HsTX1), Potassium channel toxin alpha-KTx 6.12 (Anuroctoxin), Potassium channel toxin alpha-KTx 6.13 (Spinoxin), Potassium channel toxin alpha-KTx 6.14 (HgeTx1), Potassium channel toxin alpha-KTx 7.2 (Toxin PiTX-K-beta), Potassium channel toxin gamma-KTx 1.2 (Ergtoxin-like protein 1), Potassium channel toxin gamma-KTx 1.3 (Ergtoxin-like protein 1), Potassium channel toxin gamma-KTx 1.4 (Ergtoxin-like protein 1), Potassium channel toxin gamma-KTx 1.5 (Ergtoxin-like protein 1), Potassium channel toxin gamma-KTx 1.6 (Ergtoxin-like protein 1), Potassium channel toxin gamma-KTx 4.2 (Ergtoxin-like protein 5), Insectotoxin-I1. Small toxin (Peptide I), Insectotoxin-I3 (BeI3), Insectotoxin-I4 (BeI4), Insectotoxin-I5A, Neurotoxin 8 (Neurotoxin VIII), Probable toxin Lqh 8/6, Neurotoxin 9 (Neurotoxin IX), Maurocalcin (MCa), Chlorotoxin-like peptide Bs 14 (Bs14), Chlorotoxin (CTX), Neurotoxin P2, Insectotoxin-I5 (BeI5), Potassium channel toxin alpha-KTx 6.15 (Hemitoxin), Toxin GaTx1, AahIT1, Phaiodotoxin, BaIT2, BotIT1, BotIT2, BmK M1, BmK-M2, BmK-M4, BmK-M7, BmK IT-AP, Bom3, Bom4, BjaIT, Bj-xtrIT, BjIT2, LqhaIT, Lqhb1, LqhIT2, LqhdprIT3a, Lgh-xtrIT, Lqh3, Lqh6, Lqh7, LqqIT1, LqqIT2, Lqq3, OD1, Ts1, or Tz1.

In some embodiments, a CRIP can be a scorpion peptide having an amino acid sequence as set forth in any one of SEQ ID NOs: 88-191.

In some embodiments, a CRIP can be an imperatoxin. Imperatoxins are peptide toxins derived from the venom of the African scorpion (Pandinus imperator).

In some embodiments, a CRIP can be an imperatoxin, wherein the imperatoxin is Imperatoxin A (IpTx-a), or a variant thereof. In some embodiments, the IpTx-a has an amino acid sequence of GDCLPHLKRCKADNDCCGKKCKRRGTNAEKRCR (SEQ ID NO: 66).

In some embodiments, a CRIP can be an AaIT1 toxin. The protein toxin, AalT1, is a sodium channel site 4 toxin from North African desert scorpion (Androctonus australis). An exemplary AaIT1 toxin is a peptide having the amino acid sequence according to SEQ ID NO: 88 (NCBI accession No. P01497.2). AaIT1 is a site 4 toxin, which forces the insect sodium channel to open by lowering the activation reaction energy barrier.

In some embodiments, an scorpion peptide may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to SEQ ID NOs: 66, 88-191.

In some embodiments, a polynucleotide encoding a scorpion peptide or toxin can encode a scorpion peptide or toxin having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 66, 88-191.

Sea Anemone Peptides and Toxins

In some embodiments, a CRIP can be isolated from a sea anemone. For example, in some embodiments, the sea anemone can be Actinia equina; Anemonia erythraea; Anemonia sulcata; Anemonia viridis; Anthopleura elegantissima; Anthopleura fuscoviridis; Anthopleura xanthogrammica; Bunodosoma caissarum; Bunodosoma cangicum; Bunodosoma granulifera; Heteractis crispa; Parasicyonis actinostoloides; Radianthus paumotensis; or Stoichactis helianthus. In yet other embodiments, the sea anemone toxin can be Av2; an Av3; or a variant thereof.

In some embodiments, a CRIP can be one of the following sea anemone toxins: Toxin AETX-1 (AETX I), Toxin APETx1, Toxin APETx2, Antihypertensive protein BDS-1 (Blood depressing substance I), Antihypertensive protein BDS-2 (Blood depressing substance II), Neurotoxin Bg-2 (Bg II), Neurotoxin Bg-3 (Bg III), Toxin APE 1-1, Toxin APE 1-2, Neurotoxin-1 (Toxin ATX-I), Neurotoxin-1 (Neurotoxin I), Neurotoxin 1 (Toxin RTX-I), Neurotoxin 1 (Toxin SHP-I), Toxin APE 2-1, Toxin APE 2-2, Neurotoxin-2 (Toxin ATX-II), (aka AV2)Neurotoxin-2 (Toxin AFT-II), Neurotoxin 2 (Toxin RTX-II), Neurotoxin 2 (Neurotoxin II), Neurotoxin 3 homolog (Neurotoxin III homolog), Neurotoxin 3 (Toxin RTX-III), Neurotoxin 3 (Neurotoxin-III), Neurotoxin 4 (Toxin RTX-IV), Neurotoxin-5 (Toxin ATX-V), Neurotoxin 5 (Toxin RTX-V), Anthopleurin-A (Toxin AP-A), Anthopleurin-B (Toxin AP-B), Anthopleurin-C (Toxin AP-C), Potassium channel toxin Aek, Potassium channel toxin Bgk, Major neurotoxin BcIII, Neurotoxin BcIV, Cangitoxin (CGTX), Potassium channel toxin ShK, Toxin PCR1 (PCR1-2), Toxin PCR2 (PCR2-5), Toxin PCR3 (PCR2-1), Toxin PCR4 (PCR2-10), Toxin PCR6 (PCR3-7), Cangitoxin-2 (Cangitoxin II), or Cangitoxin-3 (Cangitoxin III).

In some embodiments, a CRIP can be a sea anemone peptide having an amino acid sequence as set forth in SEQ ID NOs: 371-411.

In some embodiments, a CRIP of the present invention can be one or more polypeptides derived from the sea anemone, Anemonia viridis, which possesses a variety of toxins that it uses to defend itself. One of the toxins derived from Anemonia viridis is the neurotoxin “Av3.” Av3 is a type III sea anemone toxin that inhibits the inactivation of voltage-gated sodium (Na t) channels at receptor site 3, resulting in contractile paralysis. The binding of an Av3 toxin to site 3 results in the inactivated state of the sodium channel to become destabilized, which in turn causes the channel to remain in the open position (see Blumenthal et al., Voltage-gated sodium channel toxins: poisons, probes, and future promise. Cell Biochem Biophys. 2003; 38(2):215-38). Av3 shows high selectivity for crustacean and insect sodium channels, and low selectivity for mammalian sodium channels (see Moran et al., Sea anemone toxins affecting voltage-gated sodium channels—molecular and evolutionary features, Toxicon. 2009 Dec. 15; 54(8): 1089-1101). An exemplary Av3 polypeptide from Anemonia viridis is provided having the amino acid sequence of SEQ ID NO:44.

In some embodiments, a CRIP of the present invention can be an Av3 variant polypeptide (AVP). In some embodiments, AVPs can have the following amino acid variations from SEQ ID NO:44: an N-terminal amino acid substitution of R1K relative to SEQ ID NO:44, changing the polypeptide sequence from the wild-type “RSCCPCYWGGCPWGQNCYPEGCSGPKV” to “KSCCPCYWGGCPWGQNCYPEGCSGPKV” (SEQ ID NO:45); C-terminal amino acid can be deleted relative to SEQ ID NO:44, changing the polypeptide sequence from the wild-type “RSCCPCYWGGCPWGQNCYPEGCSGPKV” to “RSCCPCYWGGCPWGQNCYPEGCSGPK” (SEQ ID NO:46); and/or an N-terminal mutation and a C-terminal mutation, wherein the N-terminal amino acid can have a substitution of R1K relative to SEQ ID NO:44, and the C-terminal amino acid can be deleted relative to SEQ ID NO:44, changing the polypeptide sequence from the wild-type

(SEQ ID NO: 47)
“RSCCPCYWGGCPWGQNCYPEGCSGPKV” to
“KSCCPCYWGGCPWGQNCYPEGCSGPK”.

In some embodiments, an illustrative Av3 peptide or variant thereof is described in the Applicant's PCT application (Application No. PCT/US19/51093) filed Sep. 13, 2019, entitled “Av3 Mutant Insecticidal Polypeptides and Methods for Producing and Using Same,” the disclosure of which, and the disclosure of Av3 peptides or variants thereof, are described and are incorporated by reference herein in its entirety.

In some embodiments, a sea anemone peptide may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to SEQ ID NOs: 44-47, and 371-411.

In some embodiments, a polynucleotide encoding a sea anemone peptide can encode a sea anemone peptide having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 44-47, and 371-411.

Cone Shell Peptides and Conotoxins

Conotoxins are toxins isolated from cone shells; these toxins act by interfering with neuronal communication. Examples of conotoxins include the α-, ω-, μ-, δ-, and κ-conotoxins. Briefly, the α-conotoxins (and αA- & φconotoxins) target nicotinic ligand gated channels; ω-conotoxins target voltage-gated calcium channels; μ-conotoxins target the voltage-gated sodium channels; δ-conotoxins target the voltage-gated sodium channel; and κ-conotoxins target the voltage-gated potassium channel.

In some embodiments, a CRIP can be isolated from organisms belonging to the Conus genus, wherein the peptide isolated is a conotoxin.

In some embodiments, a CRIP can be isolated from Conus amadis; Conus catus; Conus ermineus; Conus geographus; Conus gloriamaris; Conus kinoshitai; Conus magus; Conus marmoreus; Conus purpurascens; Conus stercusmuscarum; Conus striatus; Conus textile; or Conus tulipa.

Other CRIPs

In some embodiments, a CRIP can be a toxin, peptide, or protein (otherwise known as a venom- or poison-peptide or protein) that is produced and/or isolated from an arthropod, a spider, a scorpion, an insect, a bee, a wasp, a centipede, a crustacean, a reptile, a snake, a lizard, an amphibian, a frog, a salamander, a mollusk, a cone shell, a cnidarian, a sea anemone, a jellyfish, a hydrozoan, a cephalopod, an octopus, a squid, a cuttlefish, a fish, or a mammal.

In some embodiments, a CRIP can be a snake venom, or toxin therefrom.

CRIP-Insecticidal Proteins

CRIP-insecticidal proteins are any protein, peptide, polypeptide, amino acid sequence, configuration, or arrangement, consisting of: (1) at least one CRIP, or two or more CRIPs; and (2) additional non-CRIP peptides, polypeptides, or proteins that, e.g., in some embodiments, have the ability to do the following: increase the mortality and/or inhibit the growth of insects when the insects are exposed to a CRIP-insecticidal protein, relative to a CRIP alone; increase the expression of said CRIP-insecticidal protein, e.g., in a host cell or an expression system; and/or affect the post-translational processing of the CRIP-insecticidal protein.

In some embodiments, a CRIP-insecticidal protein can be a polymer comprising two or more CRIPs. In some embodiments, a CRIP-insecticidal protein can be a polymer comprising two or more CRIPs, wherein the CRIPs are operably linked via a linker peptide, e.g., a cleavable and/or non-cleavable linker.

In some embodiments, a CRIP-insecticidal protein can refer to a one or more CRIPs operably linked with one or more proteins such as a stabilizing domain (STA); an endoplasmic reticulum signaling protein (ERSP); an insect cleavable or insect non-cleavable linker (L); and/or any other combination thereof.

In some embodiments, a CRIP-insecticidal protein can be a non-naturally occurring protein comprising (1) a wild-type CRIP; and (2) additional peptides, polypeptides, or proteins, e.g., an ERSP; a linker; a STA; a UBI; or a histidine tag or similar marker.

In some embodiments, a CRIP-insecticidal protein can be a non-naturally occurring protein comprising (1) a wild-type CRIP; and (2) a non-naturally occurring CRIP.

In some embodiments, a CRIP-insecticidal protein can be a non-naturally occurring protein comprising (1) a wild-type CRIP; and (2) a non-naturally occurring CRIP; and (3) additional peptides, polypeptides, or proteins, e.g., an ERSP; a linker; a STA; a UBI; or a histidine tag or similar marker.

In some embodiments, a CRIP-insecticidal protein can comprise any of the CRIPs described herein.

In some embodiments, an insecticidal protein can comprise a one or more CRIPs as disclosed herein. In some embodiments, the insecticidal protein can comprise a CRIP homopolymer, e.g., two or more CRIP monomers that are the same CRIP. In some embodiments, the insecticidal protein can comprise a CRIP heteropolymer, e.g., two or more CRIP monomers, wherein the CRIP monomers are different.

In some embodiments, an insecticidal protein can comprise a fused protein comprising two or more CRIPs separated by a cleavable or non-cleavable linker, wherein the amino acid sequence of each CRIP may be the same or different.

In some embodiments, an insecticidal protein can comprise a fused protein comprising two or more CRIPs separated by a cleavable or non-cleavable linker, wherein the amino acid sequence of each CRIP may be the same or different, wherein the linker is cleavable inside the gut or hemolymph of an insect.

In some embodiments, an insecticidal protein can comprise a fused protein comprising two or more CRIPs separated by a cleavable or non-cleavable linker, wherein the amino acid sequence of each CRIP may be the same or different, wherein the linker is cleavable inside the gut of a mammal.

Exemplary methods for the generation of cleavable and non-cleavable linkers can be found in U.S. patent application Ser. No. 15/727,277; and PCT Application No. PCT/US2013/030042, the disclosure of which are incorporated by reference herein in their entirety.

Methods for Producing a Crip or Peptide-IA

Methods of producing proteins are well known in the art, and there are a variety of techniques available. For example, in some embodiments, proteins can be produced using recombinant methods, or chemically synthesized. The present disclosure provides methods for producing CRIPs, CRIP-insecticidal proteins, and other peptide insecticidal agents (Peptide-IAs). These methods are described in detail below.

In some embodiments, a CRIP of the present invention can be created using any known method for producing a protein. For example, in some embodiments, and without limitation, a CRIP can be created using a recombinant expression system, such as yeast expression system or a bacterial expression system. However, those having ordinary skill in the art will recognize that other methods of protein production are available.

In some embodiments, the present invention provides a method of producing a CRIP using a recombinant expression system.

In some embodiments, the present invention comprises, consists essentially of, or consists of, a method of producing a CRIP, said method comprising: (a) preparing a vector comprising a first expression cassette comprising, consisting essentially of, or consisting of, a polynucleotide operable to encode a CRIP, or a complementary nucleotide sequence thereof, (b) introducing the vector into a host cell, for example a bacteria or a yeast, or an insect, or a plant cell, or an animal cell; and (c) growing the yeast strain in a growth medium under conditions operable to enable expression of the CRIP and secretion into the growth medium. In some related embodiments, the host cell, is a yeast cell.

The invention is practicable in a wide variety of host cells (see host cell section below). Indeed, an end-user of the invention can practice the teachings thereof in any host cell of his or her choosing. Thus, in some embodiments, the host cell can be any host cell that satisfies the requirements of the end-user; i.e., in some embodiments, the expression of a CRIP may be accomplished using a variety of host cells, and pursuant to the teachings herein. For example, in some embodiments, a user may desire to use one specific type of host cell (e.g., a yeast cell or a bacteria cell) as opposed to another; the preference of a given host cell can range from availability to cost.

For example, in some embodiments, in some embodiments, the present invention comprises, consists essentially of, or consists of, a method of producing a CRIP, said method comprising: (a) preparing a vector comprising a first expression cassette comprising, consisting essentially of, or consisting of, a polynucleotide operable to encode a CRIP, or a complementary nucleotide sequence thereof; (b) introducing the vector into a host cell, for example a bacteria or a yeast, or an insect, or a plant cell, or an animal cell; and (c) growing the yeast strain in a growth medium under conditions operable to enable expression of the CRIP and secretion into the growth medium. In some related embodiments, the host cell, is a yeast cell.

Isolating and Mutating Wild-Type CRIPs

A CRIP or peptide-Insecticidal Agent (peptide-IA) can be obtained directly from the source (e.g., isolating said CRIP or peptide-IA from an animal). Mutant CRIPs or peptide-IAs can be generated by creating a mutation in the wild-type CRIP or peptide-IA polynucleotide sequence; inserting that CRIP or peptide-IA polynucleotide sequence into the appropriate vector; transforming a host organism in such a way that the polynucleotide encoding a CRIP or peptide-IA is expressed; culturing the host organism to generate the desired amount of CRIP or peptide-IA; and then purifying the CRIP or peptide-IA from in and/or around host organism.

Producing a mutation in wild-type CRIP or peptide-IA polynucleotide sequence can be achieved by various means that are well known to those having ordinary skill in the art. Methods of mutagenesis include Kunkel's method; cassette mutagenesis; PCR site-directed mutagenesis; the “perfect murder” technique (delitto perfetto); direct gene deletion and site-specific mutagenesis with PCR and one recyclable marker; direct gene deletion and site-specific mutagenesis with PCR and one recyclable marker using long homologous regions; transplacement “pop-in pop-out” method; and CRISPR-Cas 9. Exemplary methods of site-directed mutagenesis can be found in Ruvkun & Ausubel, A general method for site-directed mutagenesis in prokaryotes. Nature. 1981 Jan. 1; 289(5793):85-8; Wallace et al., Oligonucleotide directed mutagenesis of the human beta-globin gene: a general method for producing specific point mutations in cloned DNA. Nucleic Acids Res. 1981 Aug. 11; 9(15):3647-56; Dalbadie-McFarland et al., Oligonucleotide-directed mutagenesis as a general and powerful method for studies of protein function. Proc Natl Acad Sci USA. 1982 November; 79(21):6409-13; Bachman. Site-directed mutagenesis. Methods Enzymol. 2013; 529:241-8; Carey et al., PCR-mediated site-directed mutagenesis. Cold Spring Harb Protoc. 2013 Aug. 1; 2013(8):738-42; and Cong et al., Multiplex genome engineering using CRISPR/Cas systems. Science. 2013 Feb. 15; 339(6121):819-23, the disclosures of all of the aforementioned references are incorporated herein by reference in their entireties.

Wild-type CRIPs, e.g., spider, scorpion, and/or other toxins can be isolated from the venom. For example, spider venom can be isolated from the venom glands of spiders (e.g., spiders such as Eratigena agrestis), using any of the techniques known to those having ordinary skill in the art. For example, in some embodiments, venom can be isolated from spiders according to the methods described in U.S. Pat. No. 5,688,764, the disclosure of which is incorporated herein by reference in its entirety.

A wild-type CRIP or peptide-IA polynucleotide sequence can be obtained by screening a genomic library using primer probes directed to the CRIP or peptide-IA polynucleotide sequence. Alternatively, wild-type CRIP or peptide-IA polynucleotide sequence and/or mutant CRIP or peptide-IA polynucleotide sequences can be chemically synthesized. For example, a CRIP or peptide-IA polynucleotide sequence and/or mutant CRIP or peptide-IA polynucleotide sequence can be generated using the oligonucleotide synthesis methods such as the phosphoramidite; triester, phosphite, or H-Phosphonate methods. See Engels, J. W. and Uhlmann, E. (1989), Gene Synthesis (New Synthetic Methods (77)). Angew. Chem. Int. Ed. Engl., 28: 716-734, the disclosure of which is incorporated herein by reference in its entirety.

Chemically Synthesizing CRIP or Peptide-IA Polynucleotides

In some embodiments, the polynucleotide sequence encoding the CRIP or peptide-IA can be chemically synthesized using commercially available polynucleotide synthesis services such as those offered by GENEWIZ® (e.g., TurboGENE™; PriorityGENE; and FragmentGENE), or SIGMA-ALDRICH® (e.g., Custom DNA and RNA Oligos Design and Order Custom DNA Oligos). Exemplary method for generating DNA and or custom chemically synthesized polynucleotides are well known in the art, and are illustratively provided in U.S. Pat. No. 5,736,135, Ser. No. 08/389,615, filed on Feb. 13, 1995, the disclosure of which is incorporated herein by reference in its entirety. See also Agarwal, et al., Chemical synthesis of polynucleotides. Angew Chem Int Ed Engl. 1972 June; 11(6):451-9; Ohtsuka et al., Recent developments in the chemical synthesis of polynucleotides. Nucleic Acids Res. 1982 Nov. 11; 10(21): 6553-6570; Sondek & Shortie. A general strategy for random insertion and substitution mutagenesis: sub stoichiometric coupling of trinucleotide phosphoramidites. Proc Natl Acad Sci USA. 1992 Apr. 15; 89(8): 3581-3585; Beaucage S. L., et al., Advances in the Synthesis of Oligonucleotides by the Phosphoramidite Approach. Tetrahedron, Elsevier Science Publishers, Amsterdam, NL, vol. 48, No. 12, 1992, pp. 2223-2311; Agrawal (1993) Protocols for Oligonucleotides and Analogs: Synthesis and Properties; Methods in Molecular Biology Vol. 20, the disclosures of which are incorporated herein by reference in their entirety.

Chemically synthesizing polynucleotides allows for a DNA sequence to be generated that is tailored to produce a desired polypeptide based on the arrangement of nucleotides within said sequence (i.e., the arrangement of cytosine [C], guanine [G], adenine [A] or thymine [T] molecules); the mRNA sequence that is transcribed from the chemically synthesized DNA polynucleotide can be translated to a sequence of amino acids, each amino acid corresponding to a codon in the mRNA sequence. Accordingly, the amino acid composition of a polypeptide chain that is translated from an mRNA sequence can be altered by changing the underlying codon that determines which of the 20 amino acids will be added to the growing polypeptide; thus, mutations in the DNA such as insertions, substitutions, deletions, and frameshifts may cause amino acid insertions, substitutions, or deletions, depending on the underlying codon.

Obtaining a CRIP or peptide-IA from a chemically synthesized DNA polynucleotide sequence and/or a wild-type DNA polynucleotide sequence that has been altered via mutagenesis can be achieved by cloning the DNA sequence into an appropriate vector. There are a variety of expression vectors available, host organisms, and cloning strategies known to those having ordinary skill in the art. For example, the vector can be a plasmid, which can introduce a heterologous gene and/or expression cassette into yeast cells to be transcribed and translated. The term “vector” is used to refer to a carrier nucleic acid molecule into which a nucleic acid sequence can be inserted for introduction into a cell where it can be replicated. A vector may contain “vector elements” such as an origin of replication (ORI); a gene that confers antibiotic resistance to allow for selection; multiple cloning sites; a promoter region; a selection marker for non-bacterial transfection; and a primer binding site. A nucleic acid sequence can be “exogenous,” which means that it is foreign to the cell into which the vector is being introduced or that the sequence is homologous to a sequence in the cell but in a position within the host cell nucleic acid in which the sequence is ordinarily not found. Vectors include plasmids, cosmids, viruses (bacteriophage, animal viruses, and plant viruses), and artificial chromosomes (e.g., YACs). One of skill in the art would be well equipped to construct a vector through standard recombinant techniques, which are described in Sambrook et al., 1989 and Ausubel et al., 1996, both incorporated herein by reference. In addition to encoding a CRIP or peptide-IA polynucleotide, a vector may encode a targeting molecule. A targeting molecule is one that directs the desired nucleic acid to a particular tissue, cell, or other location.

Vectors and Transformation

In some embodiments, a CRIP or peptide-IA polynucleotide can be cloned into a vector using a variety of cloning strategies, and commercial cloning kits and materials readily available to those having ordinary skill in the art. For example, the CRIP or peptide-IA polynucleotide can be cloned into a vector using such strategies as the SnapFast; Gateway; TOPO; Gibson; LIC; InFusionHD; or Electra strategies. There are numerous commercially available vectors that can be used to produce CRIP or peptide-IA. For example, a CRIP or peptide-IA polynucleotide can be generated using polymerase chain reaction (PCR), and combined with a pCR™II-TOPO vector, or a PCR™2.1-TOPO® vector (commercially available as the TOPO® TA Cloning® Kit from Invitrogen) for 5 minutes at room temperature; the TOPO® reaction can then be transformed into competent cells, which can subsequently be selected based on color change (see Janke et al., A versatile toolbox for PCR-based tagging of yeast genes: new fluorescent proteins, more markers and promoter substitution cassettes. Yeast. 2004 August; 21(11):947-62; see also, Adams et al. Methods in Yeast Genetics. Cold Spring Harbor, N Y, 1997, the disclosure of which is incorporated herein by reference in its entirety).

In some embodiments, a polynucleotide encoding a CRIP or peptide-IA can be cloned into a vector such as a plasmid, cosmid, virus (bacteriophage, animal viruses, and plant viruses), and/or artificial chromosome (e.g., YACs).

In some embodiments, a polynucleotide encoding a CRIP or peptide-IA can be inserted into a vector, for example, a plasmid vector using E. coli as a host, by performing the following: digesting about 2 to 5 μg of vector DNA using the restriction enzymes necessary to allow the DNA segment of interest to be inserted, followed by overnight incubation to accomplish complete digestion (alkaline phosphatase may be used to dephosphorylate the 5′-end in order to avoid self-ligation/recircularization); gel purify the digested vector. Next, amplify the DNA segment of interest, for example, a polynucleotide encoding an CRIP or peptide-IA, via PCR, and remove any excess enzymes, primers, unincorporated dNTPs, short-failed PCR products, and/or salts from the PCR reaction using techniques known to those having ordinary skill in the art (e.g., by using a PCR clean-up kit). Ligate the DNA segment of interest to the vector by creating a mixture comprising: about 20 ng of vector; about 100 to 1,000 ng or DNA segment of interest; 2 μL 10× buffer (i.e., 30 mM Tris-HCl 4 mM MgCl₂, 26 μM NAD, 1 mM DTT, 50 μg/ml BSA, pH 8, stored at 25° C.); 1 μL T4 DNA ligase; all brought to a total volume of 20 μL by adding H₂O. The ligation reaction mixture can then be incubated at room temperature for 2 hours, or at 16° C. for an overnight incubation. The ligation reaction (i.e., about 1 μL) can then be transformed to competent cell, for example, by using electroporation or chemical methods, and a colony PCR can then be performed to identify vectors containing the DNA segment of interest.

In some embodiments a polynucleotide encoding a CRIP or peptide-IA, along with other DNA segments together composing a CRIP or peptide-IA expression ORF can be designed for secretion from host yeast cells. An illustrative method of designing a CRIP or peptide-IA expression ORF is as follows: the ORF can begin with a signal peptide sequence, followed by a DNA sequence encoding a Kex2 cleavage site (Lysine-Arginine), and subsequently followed by the CRIP or peptide-IA polynucleotide transgene, with the addition of glycine-serine codons at the 5′-end, and finally a stop codon at the 3′-end. All these elements will then be expressed to a fusion peptide in yeast cells as a single open reading frame (ORF). An α-mating factor (αMF) signal sequence is most frequently used to facilitate metabolic processing of the recombinant insecticidal peptides through the endogenous secretion pathway of the recombinant yeast, i.e. the expressed fusion peptide will typically enter the Endoplasmic Reticulum, wherein the α-mating factor signal sequence is removed by signal peptidase activity, and then the resulting pro-insecticidal peptide will be trafficked to the Golgi Apparatus, in which the Lysine-Arginine dipeptide mentioned above is completely removed by Kex2 endoprotease, after which the mature, polypeptide (i.e., CRIP or peptide-IA), is secreted out of the cells.

In some embodiments, polypeptide expression levels in recombinant yeast cells can be enhanced by optimizing the codons based on the specific host yeast species. Naturally occurring frequencies of codons observed in endogenous open reading frames of a given host organism need not necessarily be optimized for high efficiency expression. Furthermore, different yeast species (for example, Kluyveromyces lactis, Pichia pastoris, Saccharomyces cerevisiae, etc.) have different optimal codons for high efficiency expression. Hence, codon optimization should be considered for the CRIP or peptide-IA expression ORF, including the sequence elements encoding the signal sequence, the Kex2 cleavage site and the CRIP or peptide-IA, because they are initially translated as one fusion peptide in the recombinant yeast cells.

In some embodiments, a codon-optimized CRIP or peptide-IA expression ORF can be ligated into a yeast-specific expression vectors for yeast expression. There are many expression vectors available for yeast expression, including episomal vectors and integrative vectors, and they are usually designed for specific yeast strains. One should carefully choose the appropriate expression vector in view of the specific yeast expression system which will be used for the peptide production. In some embodiments, integrative vectors can be used, which integrate into chromosomes of the transformed yeast cells and remain stable through cycles of cell division and proliferation. The integrative DNA sequences are homologous to targeted genomic DNA loci in the transformed yeast species, and such integrative sequences include pLAC4, 25S rDNA, pAOX1, and TRP2, etc. The locations of insecticidal peptide transgenes can be adjacent to the integrative DNA sequence (Insertion vectors) or within the integrative DNA sequence (replacement vectors).

In some embodiments, the expression vectors can contain E. coli elements for DNA preparation in E. coli, for example, E. coli replication origin, antibiotic selection marker, etc. In some embodiments, vectors can contain an array of the sequence elements needed for expression of the transgene of interest, for example, transcriptional promoters, terminators, yeast selection markers, integrative DNA sequences homologous to host yeast DNA, etc. There are many suitable yeast promoters available, including natural and engineered promoters, for example, yeast promoters such as pLAC4, pAOX1, pUPP, pADH1, pTEF, pGal1, etc., and others, can be used in some embodiments.

In some embodiments, selection methods such as acetamide prototrophy selection; zeocin-resistance selection; geneticin-resistance selection; nourseothricin-resistance selection; uracil deficiency selection; and/or other selection methods may be used. For example, in some embodiments, the Aspergillus nidulans amdS gene can be used as selectable marker. Exemplary methods for the use of selectable markers can be found in U.S. Pat. No. 6,548,285 (filed Apr. 3, 1997); U.S. Pat. No. 6,165,715 (filed Jun. 22, 1998); and 6,110,707 (filed Jan. 17, 1997), the disclosures of which are incorporated herein by reference in its entirety.

In some embodiments, a polynucleotide encoding a CRIP or peptide-IA can be inserted into a pKLAC1 plasmid. The pKLAC1 is commercially available from New England Biolabs® Inc., (item no. (NEB #E1000). The pKLAC1 is designed to accomplish high-level expression of recombinant protein (e.g., CRIP or peptide-IA) in the yeast Kluyveromyces lactis. The pKLAC1 plasmid can be ordered alone, or as part of a K. lactis Protein Expression Kit. The pKLAC1 plasmid can be linearized using the SacII or BstXI restriction enzymes, and possesses a MCS downstream of an αMF secretion signal. The αMF secretion signal directs recombinant proteins to the secretory pathway, which is then subsequently cleaved via Kex2 resulting in, for example, a CRIP or peptide-IA. Kex2 is a calcium-dependent serine protease, which is involved in activating proproteins of the secretory pathway, and is commercially available (PeproTech®; item no. 450-45).

In some embodiments, a polynucleotide encoding a CRIP or peptide-IA can be inserted into a pKlac1 plasmid, or subcloned into a pKlac1 plasmid subsequent to selection of yeast colonies transformed with pKLAC1 plasmids ligated with polynucleotide encoding a CRIP or peptide-IA. Yeast, for example K. lactis, transformed with a pKLAC1 plasmids ligated with polynucleotide encoding a CRIP or peptide-IA can be selected based on acetamidase (amdS), which allows transformed yeast cells to grow in YCB medium containing acetamide as its only nitrogen source. Once positive yeast colonies transformed with a pKLAC1 plasmids ligated with polynucleotide encoding a CRIP or peptide-IA are identified.

In some embodiments, a polynucleotide encoding a CRIP or peptide-IA can be inserted into other commercially available plasmids and/or vectors that are readily available to those having skill in the art, e.g., plasmids are available from Addgene (a non-profit plasmid repository); GenScript®; Takara®; Qiagen®; and Promega™.

In some embodiments, a polynucleotide encoding a TVP can be inserted into other commercially available plasmids and/or vectors that are readily available to those having skill in the art, e.g., plasmids are available from Addgene (a non-profit plasmid repository); GenScript®; Takara®; Qiagen®; and Promega™.

In some embodiments, a yeast cell transformed with one or more CRIP expression cassettes can produce a CRIP in a yeast culture with a yield of: at least 70 mg/L, at least 80 mg/L, at least 90 mg/L, at least 100 mg/L, at least 110 mg/L, at least 120 mg/L, at least 130 mg/L, at least 140 mg/L, at least 150 mg/L, at least 160 mg/L, at least 170 mg/L, at least 180 mg/L, at least 190 mg/L 200 mg/L, at least 500 mg/L, at least 750 mg/L, at least 1,000 mg/L, at least 1,250 mg/L, at least 1,500 mg/L, at least 1,750 mg/L, at least 2,000 mg/L, at least 2,500 mg/L, at least 3,000 mg/L, at least 3,500 mg/L, at least 4,000 mg/L, at least 4,500 mg/L, at least 5,000 mg/L, at least 5,500 mg/L, at least at least 6,000 mg/L, at least 6,500 mg/L, at least 7,000 mg/L, at least 7,500 mg/L, at least 8,000 mg/L, at least 8,500 mg/L, at least 9,000 mg/L, at least 9,500 mg/L, at least 10,000 mg/L, at least 11,000 mg/L, at least 12,000 mg/L, at least 12,500 mg/L, at least 13,000 mg/L, at least 14,000 mg/L, at least 15,000 mg/L, at least 16,000 mg/L, at least 17,000 mg/L, at least 17,500 mg/L, at least 18,000 mg/L, at least 19,000 mg/L, at least 20,000 mg/L, at least 25,000 mg/L, at least 30,000 mg/L, at least 40,000 mg/L, at least 50,000 mg/L, at least 60,000 mg/L, at least 70,000 mg/L, at least 80,000 mg/L, at least 90,000 mg/L, or at least 100,000 mg/L of CRIP per liter of medium.

In some embodiments, one or more expression cassettes comprising a polynucleotide operable to express a CRIP can be inserted into a vector, resulting in a yield ranging from about 100 mg/L of CRIP to about 100,000 mg/L; from about 110 mg/L to about 100,000 mg/L; from about 120 mg/L to about 100,000 mg/L; from about 130 mg/L to about 100,000 mg/L; from about 140 mg/L to about 100,000 mg/L; from about 150 mg/L to about 100,000 mg/L; from about 160 mg/L to about 100,000 mg/L; from about 170 mg/L to about 100,000 mg/L; from about 180 mg/L to about 100,000 mg/L; from about 190 mg/L to about 100,000 mg/L; from about 200 mg/L to about 100,000 mg/L; from about 250 mg/L to about 100,000 mg/L; from about 500 mg/L to about 100,000 mg/L; from about 750 mg/L to about 100,000 mg/L; from about 1000 mg/L to about 100,000 mg/L; from about 1000 mg/L to about 100,000 mg/L; from about 1500 mg/L to about 100,000 mg/L; from about 2000 mg/L to about 100,000 mg/L; from about 2500 mg/L to about 100,000 mg/L; from about 3000 mg/L to about 100,000 mg/L; from about 3500 mg/L to about 100,000 mg/L; from about 4000 mg/L to about 100,000 mg/L; from about 4500 mg/L to about 100,000 mg/L; from about 5000 mg/L to about 100,000 mg/L; from about 5500 mg/L to about 100,000 mg/L; from about 6000 mg/L to about 100,000 mg/L; from about 6500 mg/L to about 100,000 mg/L; from about 7000 mg/L to about 100,000 mg/L; from about 7500 mg/L to about 100,000 mg/L; from about 8000 mg/L to about 100,000 mg/L; from about 8500 mg/L to about 100,000 mg/L; from about 9000 mg/L to about 100,000 mg/L; from about 9500 mg/L to about 100,000 mg/L; from about 10000 mg/L to about 100,000 mg/L; from about 10500 mg/L to about 100,000 mg/L; from about 11000 mg/L to about 100,000 mg/L; from about 11500 mg/L to about 100,000 mg/L; from about 12000 mg/L to about 100,000 mg/L; from about 12500 mg/L to about 100,000 mg/L; from about 13000 mg/L to about 100,000 mg/L; from about 13500 mg/L to about 100,000 mg/L; from about 14000 mg/L to about 100,000 mg/L; from about 14500 mg/L to about 100,000 mg/L; from about 15000 mg/L to about 100,000 mg/L; from about 15500 mg/L to about 100,000 mg/L; from about 16000 mg/L to about 100,000 mg/L; from about 16500 mg/L to about 100,000 mg/L; from about 17000 mg/L to about 100,000 mg/L; from about 17500 mg/L to about 100,000 mg/L; from about 18000 mg/L to about 100,000 mg/L; from about 18500 mg/L to about 100,000 mg/L; from about 19000 mg/L to about 100,000 mg/L; from about 19500 mg/L to about 100,000 mg/L; from about 20000 mg/L to about 100,000 mg/L; from about 20500 mg/L to about 100,000 mg/L; from about 21000 mg/L to about 100,000 mg/L; from about 21500 mg/L to about 100,000 mg/L; from about 22000 mg/L to about 100,000 mg/L; from about 22500 mg/L to about 100,000 mg/L; from about 23000 mg/L to about 100,000 mg/L; from about 23500 mg/L to about 100,000 mg/L; from about 24000 mg/L to about 100,000 mg/L; from about 24500 mg/L to about 100,000 mg/L; from about 25000 mg/L to about 100,000 mg/L; from about 25500 mg/L to about 100,000 mg/L; from about 26000 mg/L to about 100,000 mg/L; from about 26500 mg/L to about 100,000 mg/L; from about 27000 mg/L to about 100,000 mg/L; from about 27500 mg/L to about 100,000 mg/L; from about 28000 mg/L to about 100,000 mg/L; from about 28500 mg/L to about 100,000 mg/L; from about 29000 mg/L to about 100,000 mg/L; from about 29500 mg/L to about 100,000 mg/L; from about 30000 mg/L to about 100,000 mg/L; from about 30500 mg/L to about 100,000 mg/L; from about 31000 mg/L to about 100,000 mg/L; from about 31500 mg/L to about 100,000 mg/L; from about 32000 mg/L to about 100,000 mg/L; from about 32500 mg/L to about 100,000 mg/L; from about 33000 mg/L to about 100,000 mg/L; from about 33500 mg/L to about 100,000 mg/L; from about 34000 mg/L to about 100,000 mg/L; from about 34500 mg/L to about 100,000 mg/L; from about 35000 mg/L to about 100,000 mg/L; from about 35500 mg/L to about 100,000 mg/L; from about 36000 mg/L to about 100,000 mg/L; from about 36500 mg/L to about 100,000 mg/L; from about 37000 mg/L to about 100,000 mg/L; from about 37500 mg/L to about 100,000 mg/L; from about 38000 mg/L to about 100,000 mg/L; from about 38500 mg/L to about 100,000 mg/L; from about 39000 mg/L to about 100,000 mg/L; from about 39500 mg/L to about 100,000 mg/L; from about 40000 mg/L to about 100,000 mg/L; from about 40500 mg/L to about 100,000 mg/L; from about 41000 mg/L to about 100,000 mg/L; from about 41500 mg/L to about 100,000 mg/L; from about 42000 mg/L to about 100,000 mg/L; from about 42500 mg/L to about 100,000 mg/L; from about 43000 mg/L to about 100,000 mg/L; from about 43500 mg/L to about 100,000 mg/L; from about 44000 mg/L to about 100,000 mg/L; from about 44500 mg/L to about 100,000 mg/L; from about 45000 mg/L to about 100,000 mg/L; from about 45500 mg/L to about 100,000 mg/L; from about 46000 mg/L to about 100,000 mg/L; from about 46500 mg/L to about 100,000 mg/L; from about 47000 mg/L to about 100,000 mg/L; from about 47500 mg/L to about 100,000 mg/L; from about 48000 mg/L to about 100,000 mg/L; from about 48500 mg/L to about 100,000 mg/L; from about 49000 mg/L to about 100,000 mg/L; from about 49500 mg/L to about 100,000 mg/L; from about 50000 mg/L to about 100,000 mg/L; from about 50500 mg/L to about 100,000 mg/L; from about 51000 mg/L to about 100,000 mg/L; from about 51500 mg/L to about 100,000 mg/L; from about 52000 mg/L to about 100,000 mg/L; from about 52500 mg/L to about 100,000 mg/L; from about 53000 mg/L to about 100,000 mg/L; from about 53500 mg/L to about 100,000 mg/L; from about 54000 mg/L to about 100,000 mg/L; from about 54500 mg/L to about 100,000 mg/L; from about 55000 mg/L to about 100,000 mg/L; from about 55500 mg/L to about 100,000 mg/L; from about 56000 mg/L to about 100,000 mg/L; from about 56500 mg/L to about 100,000 mg/L; from about 57000 mg/L to about 100,000 mg/L; from about 57500 mg/L to about 100,000 mg/L; from about 58000 mg/L to about 100,000 mg/L; from about 58500 mg/L to about 100,000 mg/L; from about 59000 mg/L to about 100,000 mg/L; from about 59500 mg/L to about 100,000 mg/L; from about 60000 mg/L to about 100,000 mg/L; from about 60500 mg/L to about 100,000 mg/L; from about 61000 mg/L to about 100,000 mg/L; from about 61500 mg/L to about 100,000 mg/L; from about 62000 mg/L to about 100,000 mg/L; from about 62500 mg/L to about 100,000 mg/L; from about 63000 mg/L to about 100,000 mg/L; from about 63500 mg/L to about 100,000 mg/L; from about 64000 mg/L to about 100,000 mg/L; from about 64500 mg/L to about 100,000 mg/L; from about 65000 mg/L to about 100,000 mg/L; from about 65500 mg/L to about 100,000 mg/L; from about 66000 mg/L to about 100,000 mg/L; from about 66500 mg/L to about 100,000 mg/L; from about 67000 mg/L to about 100,000 mg/L; from about 67500 mg/L to about 100,000 mg/L; from about 68000 mg/L to about 100,000 mg/L; from about 68500 mg/L to about 100,000 mg/L; from about 69000 mg/L to about 100,000 mg/L; from about 69500 mg/L to about 100,000 mg/L; from about 70000 mg/L to about 100,000 mg/L; from about 70500 mg/L to about 100,000 mg/L; from about 71000 mg/L to about 100,000 mg/L; from about 71500 mg/L to about 100,000 mg/L; from about 72000 mg/L to about 100,000 mg/L; from about 72500 mg/L to about 100,000 mg/L; from about 73000 mg/L to about 100,000 mg/L; from about 73500 mg/L to about 100,000 mg/L; from about 74000 mg/L to about 100,000 mg/L; from about 74500 mg/L to about 100,000 mg/L; from about 75000 mg/L to about 100,000 mg/L; from about 75500 mg/L to about 100,000 mg/L; from about 76000 mg/L to about 100,000 mg/L; from about 76500 mg/L to about 100,000 mg/L; from about 77000 mg/L to about 100,000 mg/L; from about 77500 mg/L to about 100,000 mg/L; from about 78000 mg/L to about 100,000 mg/L; from about 78500 mg/L to about 100,000 mg/L; from about 79000 mg/L to about 100,000 mg/L; from about 79500 mg/L to about 100,000 mg/L; from about 80000 mg/L to about 100,000 mg/L; from about 80500 mg/L to about 100,000 mg/L; from about 81000 mg/L to about 100,000 mg/L; from about 81500 mg/L to about 100,000 mg/L; from about 82000 mg/L to about 100,000 mg/L; from about 82500 mg/L to about 100,000 mg/L; from about 83000 mg/L to about 100,000 mg/L; from about 83500 mg/L to about 100,000 mg/L; from about 84000 mg/L to about 100,000 mg/L; from about 84500 mg/L to about 100,000 mg/L; from about 85000 mg/L to about 100,000 mg/L; from about 85500 mg/L to about 100,000 mg/L; from about 86000 mg/L to about 100,000 mg/L; from about 86500 mg/L to about 100,000 mg/L; from about 87000 mg/L to about 100,000 mg/L; from about 87500 mg/L to about 100,000 mg/L; from about 88000 mg/L to about 100,000 mg/L; from about 88500 mg/L to about 100,000 mg/L; from about 89000 mg/L to about 100,000 mg/L; from about 89500 mg/L to about 100,000 mg/L; from about 90000 mg/L to about 100,000 mg/L; from about 90500 mg/L to about 100,000 mg/L; from about 91000 mg/L to about 100,000 mg/L; from about 91500 mg/L to about 100,000 mg/L; from about 92000 mg/L to about 100,000 mg/L; from about 92500 mg/L to about 100,000 mg/L; from about 93000 mg/L to about 100,000 mg/L; from about 93500 mg/L to about 100,000 mg/L; from about 94000 mg/L to about 100,000 mg/L; from about 94500 mg/L to about 100,000 mg/L; from about 95000 mg/L to about 100,000 mg/L; from about 95500 mg/L to about 100,000 mg/L; from about 96000 mg/L to about 100,000 mg/L; from about 96500 mg/L to about 100,000 mg/L; from about 97000 mg/L to about 100,000 mg/L; from about 97500 mg/L to about 100,000 mg/L; from about 98000 mg/L to about 100,000 mg/L; from about 98500 mg/L to about 100,000 mg/L; from about 99000 mg/L to about 100,000 mg/L; or from about 99500 mg/L to about 100,000 mg/L of CRIP per liter of medium (supernatant of yeast fermentation broth).

In some In some embodiments, one or more expression cassettes comprising a polynucleotide operable to express a CRIP can be inserted into a vector, resulting in a yield ranging from about 100 mg/L of CRIP to about 100,000 mg/L; from about 100 mg/L to about 99500 mg/L; from about 100 mg/L to about 99000 mg/L; from about 100 mg/L to about 98500 mg/L; from about 100 mg/L to about 98000 mg/L; from about 100 mg/L to about 97500 mg/L; from about 100 mg/L to about 97000 mg/L; from about 100 mg/L to about 96500 mg/L; from about 100 mg/L to about 96000 mg/L; from about 100 mg/L to about 95500 mg/L; from about 100 mg/L to about 95000 mg/L; from about 100 mg/L to about 94500 mg/L; from about 100 mg/L to about 94000 mg/L; from about 100 mg/L to about 93500 mg/L; from about 100 mg/L to about 93000 mg/L; from about 100 mg/L to about 92500 mg/L; from about 100 mg/L to about 92000 mg/L; from about 100 mg/L to about 91500 mg/L; from about 100 mg/L to about 91000 mg/L; from about 100 mg/L to about 90500 mg/L; from about 100 mg/L to about 90000 mg/L; from about 100 mg/L to about 89500 mg/L; from about 100 mg/L to about 89000 mg/L; from about 100 mg/L to about 88500 mg/L; from about 100 mg/L to about 88000 mg/L; from about 100 mg/L to about 87500 mg/L; from about 100 mg/L to about 87000 mg/L; from about 100 mg/L to about 86500 mg/L; from about 100 mg/L to about 86000 mg/L; from about 100 mg/L to about 85500 mg/L; from about 100 mg/L to about 85000 mg/L; from about 100 mg/L to about 84500 mg/L; from about 100 mg/L to about 84000 mg/L; from about 100 mg/L to about 83500 mg/L; from about 100 mg/L to about 83000 mg/L; from about 100 mg/L to about 82500 mg/L; from about 100 mg/L to about 82000 mg/L; from about 100 mg/L to about 81500 mg/L; from about 100 mg/L to about 81000 mg/L; from about 100 mg/L to about 80500 mg/L; from about 100 mg/L to about 80000 mg/L; from about 100 mg/L to about 79500 mg/L; from about 100 mg/L to about 79000 mg/L; from about 100 mg/L to about 78500 mg/L; from about 100 mg/L to about 78000 mg/L; from about 100 mg/L to about 77500 mg/L; from about 100 mg/L to about 77000 mg/L; from about 100 mg/L to about 76500 mg/L; from about 100 mg/L to about 76000 mg/L; from about 100 mg/L to about 75500 mg/L; from about 100 mg/L to about 75000 mg/L; from about 100 mg/L to about 74500 mg/L; from about 100 mg/L to about 74000 mg/L; from about 100 mg/L to about 73500 mg/L; from about 100 mg/L to about 73000 mg/L; from about 100 mg/L to about 72500 mg/L; from about 100 mg/L to about 72000 mg/L; from about 100 mg/L to about 71500 mg/L; from about 100 mg/L to about 71000 mg/L; from about 100 mg/L to about 70500 mg/L; from about 100 mg/L to about 70000 mg/L; from about 100 mg/L to about 69500 mg/L; from about 100 mg/L to about 69000 mg/L; from about 100 mg/L to about 68500 mg/L; from about 100 mg/L to about 68000 mg/L; from about 100 mg/L to about 67500 mg/L; from about 100 mg/L to about 67000 mg/L; from about 100 mg/L to about 66500 mg/L; from about 100 mg/L to about 66000 mg/L; from about 100 mg/L to about 65500 mg/L; from about 100 mg/L to about 65000 mg/L; from about 100 mg/L to about 64500 mg/L; from about 100 mg/L to about 64000 mg/L; from about 100 mg/L to about 63500 mg/L; from about 100 mg/L to about 63000 mg/L; from about 100 mg/L to about 62500 mg/L; from about 100 mg/L to about 62000 mg/L; from about 100 mg/L to about 61500 mg/L; from about 100 mg/L to about 61000 mg/L; from about 100 mg/L to about 60500 mg/L; from about 100 mg/L to about 60000 mg/L; from about 100 mg/L to about 59500 mg/L; from about 100 mg/L to about 59000 mg/L; from about 100 mg/L to about 58500 mg/L; from about 100 mg/L to about 58000 mg/L; from about 100 mg/L to about 57500 mg/L; from about 100 mg/L to about 57000 mg/L; from about 100 mg/L to about 56500 mg/L; from about 100 mg/L to about 56000 mg/L; from about 100 mg/L to about 55500 mg/L; from about 100 mg/L to about 55000 mg/L; from about 100 mg/L to about 54500 mg/L; from about 100 mg/L to about 54000 mg/L; from about 100 mg/L to about 53500 mg/L; from about 100 mg/L to about 53000 mg/L; from about 100 mg/L to about 52500 mg/L; from about 100 mg/L to about 52000 mg/L; from about 100 mg/L to about 51500 mg/L; from about 100 mg/L to about 51000 mg/L; from about 100 mg/L to about 50500 mg/L; from about 100 mg/L to about 50000 mg/L; from about 100 mg/L to about 49500 mg/L; from about 100 mg/L to about 49000 mg/L; from about 100 mg/L to about 48500 mg/L; from about 100 mg/L to about 48000 mg/L; from about 100 mg/L to about 47500 mg/L; from about 100 mg/L to about 47000 mg/L; from about 100 mg/L to about 46500 mg/L; from about 100 mg/L to about 46000 mg/L; from about 100 mg/L to about 45500 mg/L; from about 100 mg/L to about 45000 mg/L; from about 100 mg/L to about 44500 mg/L; from about 100 mg/L to about 44000 mg/L; from about 100 mg/L to about 43500 mg/L; from about 100 mg/L to about 43000 mg/L; from about 100 mg/L to about 42500 mg/L; from about 100 mg/L to about 42000 mg/L; from about 100 mg/L to about 41500 mg/L; from about 100 mg/L to about 41000 mg/L; from about 100 mg/L to about 40500 mg/L; from about 100 mg/L to about 40000 mg/L; from about 100 mg/L to about 39500 mg/L; from about 100 mg/L to about 39000 mg/L; from about 100 mg/L to about 38500 mg/L; from about 100 mg/L to about 38000 mg/L; from about 100 mg/L to about 37500 mg/L; from about 100 mg/L to about 37000 mg/L; from about 100 mg/L to about 36500 mg/L; from about 100 mg/L to about 36000 mg/L; from about 100 mg/L to about 35500 mg/L; from about 100 mg/L to about 35000 mg/L; from about 100 mg/L to about 34500 mg/L; from about 100 mg/L to about 34000 mg/L; from about 100 mg/L to about 33500 mg/L; from about 100 mg/L to about 33000 mg/L; from about 100 mg/L to about 32500 mg/L; from about 100 mg/L to about 32000 mg/L; from about 100 mg/L to about 31500 mg/L; from about 100 mg/L to about 31000 mg/L; from about 100 mg/L to about 30500 mg/L; from about 100 mg/L to about 30000 mg/L; from about 100 mg/L to about 29500 mg/L; from about 100 mg/L to about 29000 mg/L; from about 100 mg/L to about 28500 mg/L; from about 100 mg/L to about 28000 mg/L; from about 100 mg/L to about 27500 mg/L; from about 100 mg/L to about 27000 mg/L; from about 100 mg/L to about 26500 mg/L; from about 100 mg/L to about 26000 mg/L; from about 100 mg/L to about 25500 mg/L; from about 100 mg/L to about 25000 mg/L; from about 100 mg/L to about 24500 mg/L; from about 100 mg/L to about 24000 mg/L; from about 100 mg/L to about 23500 mg/L; from about 100 mg/L to about 23000 mg/L; from about 100 mg/L to about 22500 mg/L; from about 100 mg/L to about 22000 mg/L; from about 100 mg/L to about 21500 mg/L; from about 100 mg/L to about 21000 mg/L; from about 100 mg/L to about 20500 mg/L; from about 100 mg/L to about 20000 mg/L; from about 100 mg/L to about 19500 mg/L; from about 100 mg/L to about 19000 mg/L; from about 100 mg/L to about 18500 mg/L; from about 100 mg/L to about 18000 mg/L; from about 100 mg/L to about 17500 mg/L; from about 100 mg/L to about 17000 mg/L; from about 100 mg/L to about 16500 mg/L; from about 100 mg/L to about 16000 mg/L; from about 100 mg/L to about 15500 mg/L; from about 100 mg/L to about 15000 mg/L; from about 100 mg/L to about 14500 mg/L; from about 100 mg/L to about 14000 mg/L; from about 100 mg/L to about 13500 mg/L; from about 100 mg/L to about 13000 mg/L; from about 100 mg/L to about 12500 mg/L; from about 100 mg/L to about 12000 mg/L; from about 100 mg/L to about 11500 mg/L; from about 100 mg/L to about 11000 mg/L; from about 100 mg/L to about 10500 mg/L; from about 100 mg/L to about 10000 mg/L; from about 100 mg/L to about 9500 mg/L; from about 100 mg/L to about 9000 mg/L; from about 100 mg/L to about 8500 mg/L; from about 100 mg/L to about 8000 mg/L; from about 100 mg/L to about 7500 mg/L; from about 100 mg/L to about 7000 mg/L; from about 100 mg/L to about 6500 mg/L; from about 100 mg/L to about 6000 mg/L; from about 100 mg/L to about 5500 mg/L; from about 100 mg/L to about 5000 mg/L; from about 100 mg/L to about 4500 mg/L; from about 100 mg/L to about 4000 mg/L; from about 100 mg/L to about 3500 mg/L; from about 100 mg/L to about 3000 mg/L; from about 100 mg/L to about 2500 mg/L; from about 100 mg/L to about 2000 mg/L; from about 100 mg/L to about 1500 mg/L; from about 100 mg/L to about 1000 mg/L; from about 100 mg/L to about 1000 mg/L; from about 100 mg/L to about 750 mg/L; from about 100 mg/L to about 500 mg/L; from about 100 mg/L to about 250 mg/L; from about 100 mg/L to about 100 mg/L; or from about 100 mg/L to about 110 mg/L of CRIP per liter of medium (supernatant of yeast fermentation broth).

In addition to the DNA polynucleotide sequence that encodes a CRIP or peptide-IA, additional DNA segments known as regulatory elements can be cloned into a vector that allow for enhanced expression of the foreign DNA or transgene; examples of such additional DNA segments include (1) promoters, terminators, and/or enhancer elements; (2) an appropriate mRNA stabilizing polyadenylation signal; (3) an internal ribosome entry site (IRES); (4) introns; and (5) post-transcriptional regulatory elements. The combination of a DNA segment of interest with any one of the foregoing cis-acting elements is called an “expression cassette.”

A single expression cassette can contain one or more of the aforementioned regulatory elements, and a polynucleotide operable to express a CRIP or peptide-IA. For example, in some embodiments, a CRIP or peptide-IA expression cassette can comprise polynucleotide operable to express a CRIP or peptide-IA, and an α-MF signal; Kex2 site; LAC4 terminator; ADN1 promoter; and an acetamidase (amdS) selection marker—flanked by LAC4 promoters on the 5′-end and 3′-end.

In some embodiments, there can be numerous expression cassettes cloned into a vector. For example, in some embodiments, there can be a first expression cassette comprising a polynucleotide operable to express a CRIP or peptide-IA. In alternative embodiments, there are two expression cassettes operable to encode a CRIP or peptide-IA (i.e., a double expression cassette). In other embodiments, there are three expression cassettes operable to encode a CRIP or peptide-IA (i.e., a triple expression cassette).

In some embodiments, a double expression cassette can be generated by subcloning a second CRIP or peptide-IA expression cassette into a vector containing a first CRIP or peptide-IA expression cassette.

In some embodiments, a triple expression cassette can be generated by subcloning a third CRIP or peptide-IA expression cassette into a vector containing a first and a second CRIP or peptide-IA expression cassette.

In some embodiments, a yeast cell transformed with one or more CRIP or peptide-IA expression cassettes can produce CRIP or peptide-IA in a yeast culture with a yield of: at least 70 mg/L, at least 80 mg/L, at least 90 mg/L, at least 100 mg/L, at least 110 mg/L, at least 120 mg/L, at least 130 mg/L, at least 140 mg/L, at least 150 mg/L, at least 160 mg/L, at least 170 mg/L, at least 180 mg/L, at least 190 mg/L 200 mg/L, at least 500 mg/L, at least 750 mg/L, at least 1,000 mg/L, at least 1,250 mg/L, at least 1,500 mg/L, at least 1,750 mg/L, at least 2,000 mg/L, at least 2,500 mg/L, at least 3,000 mg/L, at least 3,500 mg/L, at least 4,000 mg/L, at least 4,500 mg/L, at least 5,000 mg/L, at least 5,500 mg/L, at least at least 6,000 mg/L, at least 6,500 mg/L, at least 7,000 mg/L, at least 7,500 mg/L, at least 8,000 mg/L, at least 8,500 mg/L, at least 9,000 mg/L, at least 9,500 mg/L, at least 10,000 mg/L, at least 11,000 mg/L, at least 12,000 mg/L, at least 12,500 mg/L, at least 13,000 mg/L, at least 14,000 mg/L, at least 15,000 mg/L, at least 16,000 mg/L, at least 17,000 mg/L, at least 17,500 mg/L, at least 18,000 mg/L, at least 19,000 mg/L, at least 20,000 mg/L, at least 25,000 mg/L, at least 30,000 mg/L, at least 40,000 mg/L, at least 50,000 mg/L, at least 60,000 mg/L, at least 70,000 mg/L, at least 80,000 mg/L, at least 90,000 mg/L, or at least 100,000 mg/L of CRIP or peptide-IA per liter of yeast culture medium.

In some embodiments, one or more expression cassettes comprising a polynucleotide operable to express a CRIP or peptide-IA can be inserted into a vector, for example a pKlac1 plasmid, resulting in a yield of about 100 mg/L of CRIP or peptide-IA (supernatant of yeast fermentation broth). For example, in some embodiments, two expression cassettes comprising a polynucleotide operable to express a CRIP or peptide-IA can be inserted into a vector, for example a pKS482 plasmid, resulting in a yield of about 2 g/L of CRIP or peptide-IA (supernatant of yeast fermentation broth). Alternatively, in some embodiments, three expression cassettes comprising a polynucleotide operable to express a CRIP or peptide-IA can be inserted into a vector, for example a pKlac1T plasmid.

In some embodiments, multiple CRIP or peptide-IA expression cassettes can be transfected into yeast in order to enable integration of one or more copies of the optimized CRIP or peptide-IA transgene into the K. lactis genome. An exemplary method of introducing multiple CRIP or peptide-IA expression cassettes into a K. lactis genome is as follows: a CRIP or peptide-IA expression cassette DNA sequence is synthesized, comprising an intact LAC4 promoter element, a codon-optimized CRIP or peptide-IA expression ORF element and a pLAC4 terminator element; the intact expression cassette is ligated into the pKlac1 vector between Sal I and Kpn I restriction sites, downstream of the pLAC4 terminator of pKS477, resulting in the double transgene CRIP or peptide-IA expression vector, pKS482; the double transgene vectors, pKS482, are then linearized using Sac II restriction endonuclease and transformed into YCT306 strain of K. lactis by electroporation. The resulting yeast colonies are then grown on YCB agar plate supplemented with 5 mM acetamide, which only the acetamidase-expressing cells could use efficiently as a metabolic source of nitrogen. To evaluate the yeast colonies, about 100 to 400 colonies can be picked from the pKS482 yeast plates. Inoculates from the colonies are each cultured in 2.2 mL of the defined K. lactis media with 2% sugar alcohol added as a carbon source. Cultures are incubated at 23.5° C., with shaking at 280 rpm, for six days, at which point cell densities in the cultures will reach their maximum levels as indicated by light absorbance at 600 nm (OD600). Cells are then removed from the cultures by centrifugation at 4,000 rpm for 10 minutes, and the resulting supernatants (conditioned media) are filtered through 0.2 μM membranes for HPLC yield analysis.

Chemically Synthesizing Peptides

Peptide synthesis or the chemical synthesis or peptides and/or polypeptides can be used to generate CRIPs or peptide-IAs: these methods can be performed by those having ordinary skill in the art, and/or through the use of commercial vendors (e.g., GenScript®; Piscataway, New Jersey). For example, in some embodiments, chemical peptide synthesis can be achieved using Liquid phase peptide synthesis (LPPS), or solid phase peptide synthesis (SPPS).

In some embodiments, peptide synthesis can generally be achieved by using a strategy wherein the coupling the carboxyl group of a subsequent amino acid to the N-terminus of a preceding amino acid generates the nascent polypeptide chain—a process that is opposite to the type of polypeptide synthesis that occurs in nature.

Peptide deprotection is an important first step in the chemical synthesis of polypeptides. Peptide deprotection is the process in which the reactive groups of amino acids are blocked through the use of chemicals in order to prevent said amino acid's functional group from taking part in an unwanted or non-specific reaction or side reaction; in other words, the amino acids are “protected” from taking part in these undesirable reactions.

Prior to synthesizing the peptide chain, the amino acids must be “deprotected” to allow the chain to form (i.e., amino acids to bind). Chemicals used to protect the N-termini include 9-fluorenylmethoxycarbonyl (Fmoc), and tert-butoxycarbonyl (Boc), each of which can be removed via the use of a mild base (e.g., piperidine) and a moderately strong acid (e.g., trifluoracetic acid (TFA)), respectively.

The C-terminus protectant required is dependent on the type of chemical peptide synthesis strategy used: e.g., LPPS requires protection of the C-terminal amino acid, whereas SPPS does not owing to the solid support which acts as the protecting group. Side chain amino acids require the use of several different protecting groups that vary based on the individual peptide sequence and N-terminal protection strategy; typically, however, the protecting group used for side chain amino acids are based on the tert-butyl (tBu) or benzyl (Bzl) protecting groups.

Amino acid coupling is the next step in a peptide synthesis procedure. To effectuate amino acid coupling, the incoming amino acid's C-terminal carboxylic acid must be activated: this can be accomplished using carbodiimides such as diisopropylcarbodiimide (DIC), or dicyclohexylcarbodiimide (DCC), which react with the incoming amino acid's carboxyl group to form an O-acylisourea intermediate. The O-acylisourea intermediate is subsequently displaced via nucleophilic attack via the primary amino group on the N-terminus of the growing peptide chain. The reactive intermediate generated by carbodiimides can result in the racemization of amino acids. To avoid racemization of the amino acids, reagents such as 1-hydroxybenzotriazole (HOBt) are added in order to react with the O-acylisourea intermediate. Other couple agents that may be used include 2-(1H-benzotriazol-1-yl)-1,1,3,3-tetramethyluronium hexafluorophosphate (HBTU), and benzotriazol-1-yl-oxy-tris(dimethylamino)phosphonium hexafluorophosphate (BOP), with the additional activating bases. Finally, following amino acid deprotection and coupling,

At the end of the synthesis process, removal of the protecting groups from the polypeptide must occur—a process that usually occurs through acidolysis. Determining which reagent is required for peptide cleavage is a function of the protection scheme used and overall synthesis method. For example, in some embodiments, hydrogen bromide (HBr); hydrogen fluoride (HF); or trifluoromethane sulfonic acid (TFMSA) can be used to cleave Bzl and Boc groups. Alternatively, in other embodiments, a less strong acid such as TFA can effectuate acidolysis of tBut and Fmoc groups. Finally, peptides can be purified based on the peptide's physiochemical characteristics (e.g., charge, size, hydrophobicity, etc.). Techniques that can be used to purify peptides include Purification techniques include Reverse-phase chromatography (RPC); Size-exclusion chromatography; Partition chromatography; High-performance liquid chromatography (HPLC); and Ion exchange chromatography (IEC).

Exemplary methods of peptide synthesis can be found in Anderson G. W. and McGregor A. C. (1957) T-butyloxycarbonylamino acids and their use in peptide synthesis. Journal of the American Chemical Society. 79, 6180-3; Carpino L. A. (1957) Oxidative reactions of hydrazines. Iv. Elimination of nitrogen from 1, 1-disubstituted-2-arenesulfonhydrazidesl-4. Journal of the American Chemical Society. 79, 4427-31; McKay F. C. and Albertson N. F. (1957) New amine-masking groups for peptide synthesis. Journal of the American Chemical Society. 79, 4686-90; Merrifield R. B. (1963) Solid phase peptide synthesis. I. The synthesis of a tetrapeptide. Journal of the American Chemical Society. 85, 2149-54; Carpino L. A. and Han G. Y. (1972) 9-fluorenylmethoxycarbonyl amino-protecting group. The Journal of Organic Chemistry. 37, 3404-9; and A Lloyd-Williams P. et al. (1997) Chemical approaches to the synthesis of peptides and proteins. Boca Raton: CRC Press. 278; U.S. Pat. No. 3,714,140 (filed Mar. 16, 1971); U.S. Pat. No. 4,411,994 (filed Jun. 8, 1978); U.S. Pat. No. 7,785,832 (filed Jan. 20, 2006); U.S. Pat. No. 8,314,208 (filed Feb. 10, 2006); and 10,442,834 (filed Oct. 2, 2015); and United States Patent Application 2005/0165215 (filed Dec. 23, 2004), the disclosures of which are incorporated herein by reference in their entireties.

Additional exemplary methods of generating polynucleotides, peptides, and CRIPs, can be found in U.S. Patent Application Publication No. 20150148288 A1, the disclosure of which is incorporated herein by reference in its entirety.

Any of the methods described herein can be used to generate any of the CRIPs, CRIP-insecticidal proteins, or peptide-IAs described herein.

Cell Culture and Transformation Techniques

The terms “transformation” and “transfection” both describe the process of introducing exogenous and/or heterologous DNA or RNA to a host organism. Generally, those having ordinary skill in the art sometimes reserve the term “transformation” to describe processes where exogenous and/or heterologous DNA or RNA are introduced into a bacterial cell; and reserve the term “transfection” for processes that describe the introduction of exogenous and/or heterologous DNA or RNA into eukaryotic cells. However, as used herein, the term “transformation” and “transfection” are used synonymously, regardless of whether a process describes the introduction exogenous and/or heterologous DNA or RNA into a prokaryote (e.g., bacteria) or a eukaryote (e.g., yeast, plants, or animals).

In some embodiments, a host cell can be transformed using the following methods: electroporation; cell squeezing; microinjection; impalefection; the use of hydrostatic pressure; sonoporation; optical transfection; continuous infusion; lipofection; through the use of viruses such as adenovirus, adeno-associated virus, lentivirus, herpes simplex virus, and retrovirus; the chemical phosphate method; endocytosis via DEAE-dextran or polyethylenimine (PEI); protoplast fusion; hydrodynamic deliver; magnetofection; nucleoinfection; and/or others. Exemplary methods regarding transfection and/or transformation techniques can be found in Makrides (2003), Gene Transfer and Expression in Mammalian Cells, Elvesier; Wong, TK & Neumann, E. Electric field mediated gene transfer. Biochem. Biophys. Res. Commun. 107, 584-587 (1982); Potter & Heller, Transfection by Electroporation. Curr Protoc Mol Biol. 2003 May; CHAPTER: Unit-9.3; Kim & Eberwine, Mammalian cell transfection: the present and the future. Anal Bioanal Chem. 2010 August; 397(8): 3173-3178, each of these references are incorporated herein by reference in their entireties.

Electroporation is a technique in which electricity is applied to cells causing the cell membrane to become permeable; this in turn allows exogenous DNA to be introduced into the cells. Electroporation is readily known to those having ordinary skill in the art, and the tools and devices required to achieve electroporation are commercially available (e.g., Gene Pulser Xcell™ Electroporation Systems, Bio-Rad®; Neon® Transfection System for Electroporation, Thermo-Fisher Scientific; and other tools and/or devices). Exemplary methods of electroporation are illustrated in Potter & Heller, Transfection by Electroporation. Curr Protoc Mol Biol. 2003 May; CHAPTER: Unit-9.3; Saito (2015) Electroporation Methods in Neuroscience. Springer press; Pakhomov et al., (2017) Advanced Electroporation Techniques in Biology and Medicine. Taylor & Francis; the disclosure of which is incorporated herein by reference in its entirety.

In some embodiments, electroporation can be used to introduce a vector containing a polynucleotide encoding a CRIP or peptide-IA into yeast, for example, a CRIP or peptide-IA cloned into a pKlac1 plasmid, and transformed into K. lactis cells via electroporation, can be accomplished by inoculating about 10-200 mL of yeast extract peptone dextrose (YEPD) with a suitable yeast species, for example, Kluyveromyces lactis, Kluyveromyces marxianus, Saccharomyces cerevisiae, Pichia pastoris, etc., and incubate on a shaker at 30° C. until the early exponential phase of yeast culture (e.g. about 0.6 to 2×10 8 cells/mL); harvesting the yeast in sterile centrifuge tube and centrifuging at 3000 rpm for 5 minutes at 4° C. (note: keep cells chilled during the procedure) washing cells with 40 mL of ice cold, sterile deionized water, and pelleting the cells a 23,000 rpm for 5 minutes; repeating the wash step, and the resuspending the cells in 20 mL of 1M fermentable sugar, e.g. galactose, maltose, latotriose, sucrose, fructose or glucose and/or sugar alcohol, for example, erythritol, hydrogenated starch hydrolysates, isomalt, lactitol, maltitol, mannitol, and xylitol, followed by spinning down at 3,000 rpm for 5 minutes; resuspending the cells with proper volume of ice cold 1M fermentable sugar, e.g. galactose, maltose, latotriose, sucrose, fructose or glucose and/or a sugar alcohol, for example, erythritol, hydrogenated starch hydrolysates, isomalt, lactitol, maltitol, mannitol, and xylitol to final cell density of 3×10⁹ cell/mL; mixing 40 μl of the yeast suspension with about 1-4 μl of the vector containing a linear polynucleotide encoding a CRIP or peptide-IA (˜1 μg) in a pre-chilled 0.2 cm electroporation cuvette (note: ensure the sample is in contact with both sides of the aluminum cuvette); providing a single pulse at 2000 V, for optimal time constant of 5 ms of the RC circuit, the cells was then let recovered in 0.5 ml YED and 0.5 mL 1M fermentable sugar, e.g. galactose, maltose, latotriose, sucrose, fructose or glucose and/or a sugar alcohol, for example, erythritol, hydrogenated starch hydrolysates, isomalt, lactitol, maltitol, mannitol, and xylitol mixture, and then spreading onto selective plates.

In some embodiments, electroporation can be used to introduce a vector containing a polynucleotide encoding a CRIP or peptide-IA into plant protoplasts by incubating sterile plant material in a protoplast solution (e.g., around 8 mL of 10 mM 2-[N-morpholino]ethanesulfonic acid (MES), pH 5.5; 0.01% (w/v) pectylase; 1% (w/v) macerozyme; 40 mM CaCl₂; and 0.4 M mannitol) and adding the mixture to a rotary shaker for about 3 to 6 hours at 30° C. to produce protoplasts; removing debris via 80-μm-mesh nylon screen filtration; rinsing the screen with about 4 ml plant electroporation buffer (e.g., 5 mM CaCl₂; 0.4 M mannitol; and PBS); combining the protoplasts in a sterile 15 mL conical centrifuge tube, and then centrifuging at about 300×g for about 5 minutes; subsequent to centrifugation, discarding the supernatant and washing with 5 mL of plant electroporation buffer; resuspending the protoplasts in plant electroporation buffer at about 1.5×10⁶ to 2×10⁶ protoplasts per mL of liquid; transferring about 0.5-mL of the protoplast suspension into one or more electroporation cuvettes, set on ice, and adding the vector (note: for stable transformation, the vector should be linearized using anyone of the restriction methods described above, and about 1 to 10 μg of vector may be used; for transient expression, the vector may be retained in its supercoiled state, and about 10 to 40 μg of vector may be used); mixing the vector and protoplast suspension; placing the cuvette into the electroporation apparatus, and shocking for one or more times at about 1 to 2 kV (a 3- to 25-μF capacitance may be used initially while optimizing the reaction); returning the cuvette to ice; diluting the transformed cells 20-fold in complete medium; and harvesting the protoplasts after about 48 hours.

Host Cells

The methods, compositions, CRIPs and peptide-IAs of the present invention may be implemented in any cell type, e.g., a eukaryotic or prokaryotic cell.

In some embodiments, the host cell used to produce a CRIP, a CRIP-insecticidal protein, or a peptide-IA, is a prokaryote. For example, in some embodiments, the host cell may be an Archaebacteria or Eubacteria, such as Gram-negative or Gram-positive organisms. Examples of useful bacteria include Escherichia (e.g., E. coli), Bacilli (e.g., B. subtilis), Enterobacteria, Pseudomonas species (e.g., P. aeruginosa), Salmonella typhimurium, Serratia marcescans, Klebsiella, Proteus, Shigella, Rhizobia, Vitreoscilla, or Paracoccus.

In some embodiments, the host cell used to produce a CRIP, a CRIP-insecticidal protein, or a peptide-IA, may be a unicellular cell. For example, in some embodiments, the host cell may be bacterial cells such as gram positive bacteria.

In some embodiments, the host cell may be a bacteria selected from the following genera consisting of: Candidatus Chloracidobacterium, Arthrobacter, Corynebacterium, Frankia, Micrococcus, Mycobacterium, Propionibacterium, Streptomyces, Aquifex Bacteroides, Porphyromonas, Bacteroides, Porphyromonas, Flavobacterium, Chlamydia, Prosthecobacter, Verrucomicrobium, Chloroflexus, Chroococcus, Merismopedia, Synechococcus, Anabaena, Nostoc, Spirulina, Trichodesmium, Pleurocapsa, Prochlorococcus, Prochloron, Bacillus, Listeria, Staphylococcus, Clostridium, Dehalobacter, Epulopiscium, Ruminococcus, Enterococcus, Lactobacillus, Streptococcus, Erysipelothrix, Mycoplasma, Leptospirillum, Nitrospira, Thermodesulfobacterium, Gemmata, Pirellula, Planctomyces, Caulobacter, Agrobacterium, Bradyrhizobium, Brucella, Methylobacterium, Prosthecomicrobium, Rhizobium, Rhodopseudomonas, Sinorhizobium, Rhodobacter, Roseobacter, Acetobacter, Rhodospirillum, Rickettsia, Rickettsia conorii, Mitochondria, Wolbachia, Erythrobacter, Erythromicrobium, Sphingomonas, Alcaligenes, Burkholderia, Leptothrix, Sphaerotilus, Thiobacillus, Neisseria, Nitrosomonas, Gallionella, Spirillum, Azoarcus, Aeromonas, Succinomonas, Succinivibrio, Ruminobacter, Nitrosococcus, Thiocapsa, Enterobacter, Escherichia, Klebsiella, Salmonella, Shigella, Wigglesworthia, Yersinia, Coxiella, Legionella, Halomonas, Pasteurella, Acinetobacter, Azotobacter, Pseudomonas, Psychrobacter, Beggiatoa, Thiomargarita, Vibrio, Xanthomonas, Bdellovibrio, Campylobacter, Helicobacter, Myxococcus, Desulfosarcina, Geobacter, Desulfuromonas, Borrelia, Leptospira, Treponema, Petrotoga, Thermotoga, Deinococcus, or Thermus.

In some embodiments, the host cell used to produce a CRIP, a CRIP-insecticidal protein, or a peptide-IA, may be selected from one of the following bacteria species: Bacillus alkalophilus, Bacillus amyloliquefaciens, Bacillus brevis, Bacillus circulans, Bacillus coagulans, Bacillus lautus, Bacillus lentus, Bacillus licheniformis, Bacillus megaterium, Bacillus stearothermophilus, Bacillus subtilis, Bacillus thuringiensis, Streptomyces lividans, Streptomyces murinus, Streptomyces coelicolor, Streptomyces albicans, Streptomyces griseus, Streptomyces plicatosporus, Escherichia albertii, Escherichia blattae, Escherichia coli, Escherichia fergusonii, Escherichia hermannii, Escherichia senegalensis, Escherichia vulneris, Pseudomonas abietaniphila, Pseudomonas agarici, Pseudomonas agarolyticus, Pseudomonas alcaliphila, Pseudomonas alginovora, Pseudomonas andersonii, Pseudomonas antarctica, Pseudomonas asplenii, Pseudomonas azelaica, Pseudomonas batumici, Pseudomonas borealis, Pseudomonas brassicacearum, Pseudomonas chloritidismutans, Pseudomonas cremoricolorata, Pseudomonas diterpeniphila, Pseudomonas filiscindens, Pseudomonas frederiksbergensis, Pseudomonas gingeri, Pseudomonas graminis, Pseudomonas grimontii, Pseudomonas halodenitrificans, Pseudomonas halophila, Pseudomonas hibiscicola, Pseudomonas hydrogenovora, Pseudomonas indica, Pseudomonas japonica, Pseudomonas jessenii, Pseudomonas kilonensis, Pseudomonas koreensis, Pseudomonas lini, Pseudomonas lurida, Pseudomonas lutea, Pseudomonas marginata, Pseudomonas meridiana, Pseudomonas mesoacidophila, Pseudomonas pachastrellae, Pseudomonas palleroniana, Pseudomonas parafulva, Pseudomonas pavonanceae, Pseudomonas proteolyica, Pseudomonas psychrophila, Pseudomonas psychrotolerans, Pseudomonas pudica, Pseudomonas rathonis, Pseudomonas reactans, Pseudomonas rhizosphaerae, Pseudomonas salmononii, Pseudomonas thermaerum, Pseudomonas thermocarboxydovorans, Pseudomonas thermotolerans, Pseudomonas thivervalensis, Pseudomonas umsongensis, Pseudomonas vancouverensis, Pseudomonas wisconsinensis, Pseudomonas xanthomarina Pseudomonas xiamenensis, Pseudomonas aeruginosa, Pseudomonas alcaligenes, Pseudomonas anguilliseptica, Pseudomonas citronellolis, Pseudomonas flavescens, Pseudomonas jinjuensis, Pseudomonas mendocina, Pseudomonas nitroreducens, Pseudomonas oleovorans, Pseudomonas pseudoalcaligenes, Pseudomonas resinovorans, Pseudomonas straminae, Pseudomonas aurantiaca, Pseudomonas chlororaphis, Pseudomonas fragi, Pseudomonas lundensis, Pseudomonas taetrolens Pseudomonas azotoformans, Pseudomonas brenneri, Pseudomonas cedrina, Pseudomonas congelans, Pseudomonas corrugata, Pseudomonas costantinii, Pseudomonas extremorientalis, Pseudomonas fluorescens, Pseudomonas fulgida, Pseudomonas gessardii, Pseudomonas libanensis, Pseudomonas mandelii, Pseudomonas marginalis, Pseudomonas mediterranea, Pseudomonas migulae, Pseudomonas mucidolens, Pseudomonas orientalis, Pseudomonas poae, Pseudomonas rhodesiae, Pseudomonas synxantha, Pseudomonas tolaasii, Pseudomonas trivialis, Pseudomonas veronii Pseudomonas denitrificans, Pseudomonas pertucinogena, Pseudomonas fulva, Pseudomonas monteilii, Pseudomonas mosselii, Pseudomonas oryzihabitans, Pseudomonas plecoglossicida, Pseudomonas putida, Pseudomonas balearica, Pseudomonas luteola, or Pseudomonas stutzeri. Pseudomonas avellanae, Pseudomonas cannabina, Pseudomonas caricapapyae, Pseudomonas cichorii, Pseudomonas coronafaciens, Pseudomonas fuscovaginae, Pseudomonas tremae, or Pseudomonas viridiflava

In some embodiments, the host cell used to produce a CRIP, a CRIP-insecticidal protein, or a peptide-IA can be eukaryote.

In some embodiments, the host cell used to produce a CRIP, a CRIP-insecticidal protein, or a peptide-IA, may be a cell belonging to the clades: Opisthokonta; Viridiplantae (e.g., algae and plant); Amebozoa; Cercozoa; Alveolata; Marine flagellates; Heterokonta; Discicristata; or Excavata.

In some embodiments, the procedures and methods described here can be accomplished using a host cell that is, e.g., a Metazoan, a Choanoflagellata, or a fungi.

In some embodiments, the procedures and methods described here can be accomplished using a host cell that is a fungi. For example, in some embodiments, the host cell may be a cell belonging to the eukaryote phyla: Ascomycota, Basidiomycota, Chytridiomycota, Microsporidia, or Zygomycota

In some embodiments, the procedures and methods described here can be accomplished using a host cell that is a fungi belonging to one of the following genera: Aspergillus, Cladosporium, Magnaporthe, Morchella, Neurospora, Penicillium, Saccharomyces, Cryptococcus, or Ustilago.

In some embodiments, the procedures and methods described here can be accomplished using a host cell that is a fungi belonging to one of the following species: Saccharomyces cerevisiae, Saccharomyces boulardi, Saccharomyces uvarum; Aspergillus flavus, A. terreus, A. awamori; Cladosporium elatum, Cl. Herbarum, Cl. Sphaerospermum, and Cl. Cladosporioides; Magnaporthe grise, Magnaporthe oryzae, Magnaporthe rhizophila; Morchella deliciosa, Morchella esculenta, Morchella conica; Neurospora crassa, Neurospora intermedia, Neurospora tetrasperma; Penicillium notatum, Penicillium chrysogenum, Penicillium roquefortii, or Penicillium simplicissimum.

In some embodiments, the procedures and methods described here can be accomplished using a host cell that is a Kluyveromyces lactis, Kluyveromyces marxianus, Saccharomyces cerevisiae, or Pichia pastoris.

In some embodiments, the host cell used to produce a CRIP, a CRIP-insecticidal protein, or a peptide-IA, may be a fungi belonging to one of the following genera: Aspergillus, Cladosporium, Magnaporthe, Morchella, Neurospora, Penicillium, Saccharomyces, Cryptococcus, or Ustilago.

In some embodiments, the host cell used to produce a CRIP, a CRIP-insecticidal protein, or a peptide-IA may be a member of the Saccharomycetaceae family. For example, in some embodiments, the host cell may be one of the following genera within the Saccharomycetaceae family: Brettanomyces, Candida, Citeromyces, Cyniclomyces, Debaryomyces, Issatchenkia, Kazachstania, Kluyveromyces, Komagataella, Kuraishia, Lachancea, Lodderomyces, Nakaseomyces, Pachysolen, Pichia, Saccharomyces, Spathaspora, Tetrapisispora, Vanderwaltozyma, Torulaspora, Williopsis, Zygosaccharomyces, or Zygotorulaspora.

In some embodiments, the host cell used to produce a CRIP, a CRIP-insecticidal protein, or a peptide-IA, may be one of the following: Aspergillus flavus, Aspergillus terreus, Aspergillus awamori, Cladosporium elatum, Cladosporium Herbarum, Cladosporium Sphaerospermum, Cladosporium cladosporioides, Magnaporthe grisea, Magnaporthe oryzae, Magnaporthe rhizophila, Morchella deliciosa, Morchella esculenta, Morchella conica, Neurospora crassa, Neurospora intermedia, Neurospora tetrasperma, Penicillium notatum, Penicillium chrysogenum, Penicillium roquefortii, or Penicillium simplicissimum.

In some embodiments, the host cell used to produce a CRIP, a CRIP-insecticidal protein, or a peptide-IA, may be a species within the Candida genus. For example, the host cell may be one of the following: Candida albicans, Candida ascalaphidarum, Candida amphixiae, Candida antarctica, Candida argentea, Candida atlantica, Candida atmosphaerica, Candida auris, Candida blankii, Candida blattae, Candida bracarensis, Candida bromeliacearum, Candida carpophila, Candida carvajalis, Candida cerambycidarum, Candida chauliodes, Candida corydalis, Candida dosseyi, Candida dubliniensis, Candida ergatensis, Candida fructus, Candida glabrata, Candida fermentati, Candida guilliermondii, Candida haemulonii, Candida humilis, Candida insectamens, Candida insectorum, Candida intermedia, Candida jeffresii, or Candida kefyr.

In some embodiments, the host cell used to produce a CRIP, a CRIP-insecticidal protein, or a peptide-IA, may be a species within the Kluyveromyces genus. For example, the host cell may be one of the following: Kluyveromyces aestuarii, Kluyveromyces dobzhanskii, Kluyveromyces lactis, Kluyveromyces marxianus, Kluyveromyces nonfermentans, or Kluyveromyces wickerhamii.

In some embodiments, the host cell used to produce a CRIP, a CRIP-insecticidal protein, or a peptide-IA, may be a species within the Pichia genus. For example, the host cell may be one of the following: Pichia farinose, Pichia anomala, Pichia heedii, Pichia guilhermondii, Pichia kluyveri, Pichia membranifaciens, Pichia norvegensis, Pichia ohmeri, Pichia pastoris, Pichia methanolica, or Pichia subpelliculosa.

In some embodiments, the host cell used to produce a CRIP, a CRIP-insecticidal protein, or a peptide-IA, may be a species within the Saccharomyces genus. For example, the host cell may be one of the following: Saccharomyces arboricolus, Saccharomyces bayanus, Saccharomyces bulderi, Saccharomyces cariocanus, Saccharomyces cariocus, Saccharomyces cerevisiae, Saccharomyces cerevisiae var boulardii, Saccharomyces chevalieri, Saccharomyces dairenensis, Saccharomyces elhpsoideus, Saccharomyces eubayanus, Saccharomyces exiguous, Saccharomyces florentinus, Saccharomyces fragilis, Saccharomyces kudriavzevii, Saccharomyces martiniae, Saccharomyces mikatae, Saccharomyces monacensis, Saccharomyces norbensis, Saccharomyces paradoxus, Saccharomyces pastorianus, Saccharomyces spencerorum, Saccharomyces turicensis, Saccharomyces unisporus, Saccharomyces uvarum, or Saccharomyces zonatus.

In some embodiments, the host cell used to produce a CRIP, a CRIP-insecticidal protein, or a peptide-IA, may be one of the following: Saccharomyces cerevisiae, Pichia pastoris, Pichia methanolica, Schizosaccharomyces pombe, or Hansenula anomala.

The use of yeast cells as a host organism to generate recombinant CRIPs or peptide-IAs is an exceptional method, well known to those having ordinary skill in the art. In some embodiments, the methods and compositions described herein can be performed with any species of yeast, including but not limited to any species of the genus Saccharomyces, Pichia, Kluyveromyces, Hansenula, Yarrowia or Schizosaccharomyces and the species Saccharomyces includes any species of Saccharomyces, for example Saccharomyces cerevisiae species selected from following strains: INVSc1, YNN27, S150-2B, W303-1B, CG25, W3124, JRY188, BJ5464, AH22, GRF18, W303-1A and BJ3505. In some embodiments, members of the Pichia species including any species of Pichia, for example the Pichia species, Pichia pastoris, for example, the Pichia pastoris is selected from following strains: Bg08, Y-11430, X-33, GS115, GS190, JC220, JC254, GS200, JC227, JC300, JC301, JC302, JC303, JC304, JC305, JC306, JC307, JC308, YJN165, KM71, MC100-3, SMD1163, SMD1165, SMD1168, GS241, MS105, any pep4 knock-out strain and any prb1 knock-out strain, as well as Pichia pastoris selected from following strains: Bg08, X-33, SMD1168 and KM71. In some embodiments, any Kluyveromyces species can be used to accomplish the methods described here, including any species of Kluyveromyces, for example, Kluyveromyces lactis, and we teach that the stain of Kluyveromyces lactis can be but is not required to be selected from following strains: GG799, YCT306, YCT284, YCT389, YCT390, YCT569, YCT598, NRRL Y-1140, MW98-8C, MS1, CBS293.91, Y721, MD2/1, PM6-7A, WM37, K6, K7, 22AR1, 22A295-1, SD11, MG1/2, MSK110, JA6, CMKS, HP101, HP108 and PM6-3C, in addition to Kluyveromyces lactis species is selected from GG799, YCT306 and NRRL Y-1140.

In some embodiments, the host cell used to produce a CRIP, a CRIP-insecticidal protein, or a peptide-IA, can be an Aspergillus oryzae.

In some embodiments, the host cell used to produce a CRIP, a CRIP-insecticidal protein, or a peptide-IA, can be an Aspergillus japonicas.

In some embodiments, the host cell used to produce a CRIP, a CRIP-insecticidal protein, or a peptide-IA, can be an Aspergillus niger.

In some embodiments, the host cell used to produce a CRIP, a CRIP-insecticidal protein, or a peptide-IA, can be a Bacillus licheniformis.

In some embodiments, the host cell used to produce a CRIP, a CRIP-insecticidal protein, or a peptide-IA, can be a Bacillus subtilis.

In some embodiments, the host cell used to produce a CRIP, a CRIP-insecticidal protein, or a peptide-IA, can be a Trichoderma reesei.

In some embodiments, the procedures and methods described here can be accomplished using a host cell that is a yeast, including but not limited to any species of Hansenula species including any species of Hansenula and preferably Hansenula polymorpha. In some embodiments, the procedures and methods described here can be accomplished with any species of yeast, including but not limited to any species of Yarrowia species for example, Yarrowia lipolytica. In some embodiments, the procedures and methods described here can be accomplished with any species of yeast, including but not limited to any species of Schizosaccharomyces species including any species of Schizosaccharomyces and preferably Schizosaccharomyces pombe.

Yeast Cell Culture

In some embodiments, yeast species such as Kluyveromyces lactis, Saccharomyces cerevisiae, Pichia pastoris, and others, can be used as a host organism. Yeast cell culture techniques are well known to those having ordinary skill in the art. Exemplary methods of yeast cell culture can be found in Evans, Yeast Protocols. Springer (1996); Bill, Recombinant Protein Production in Yeast. Springer (2012); Hagan et al., Fission Yeast: A Laboratory Manual, CSH Press (2016); Konishi et al., Improvement of the transformation efficiency of Saccharomyces cerevisiae by altering carbon sources in pre-culture. Biosci Biotechnol Biochem. 2014; 78(6):1090-3; Dymond, Saccharomyces cerevisiae growth media. Methods Enzymol. 2013; 533:191-204; Looke et al., Extraction of genomic DNA from yeasts for PCR-based applications. Biotechniques. 2011 May; 50(5):325-8; and Romanos et al., Culture of yeast for the production of heterologous proteins. Curr Protoc Cell Biol. 2014 Sep. 2; 64:20.9.1-16, the disclosure of which is incorporated herein by reference in its entirety.

Recipes for yeast cell fermentation media and stocks are described as follows: (1) MSM media recipe: 2 g/L sodium citrate dihydrate; 1 g/L calcium sulfate dihydrate (0.79 g/L anhydrous calcium sulfate); 42.9 g/L potassium phosphate monobasic; 5.17 g/L ammonium sulfate; 14.33 g/L potassium sulfate; 11.7 g/L magnesium sulfate heptahydrate; 2 mL/L PTM1 trace salt solution; 0.4 ppm biotin (from 500×, 200 ppm stock); 1-2% pure glycerol or other carbon source. (2) PTM1 trace salts solution: Cupric sulfate-5H₂O 6.0 g; Sodium iodide 0.08 g; Manganese sulfate-H₂O 3.0 g; Sodium molybdate-2H₂O 0.2 g; Boric Acid 0.02 g; Cobalt chloride 0.5 g; Zinc chloride 20.0 g; Ferrous sulfate-7H₂O 65.0 g; Biotin 0.2 g; Sulfuric Acid 5.0 ml; add Water to a final volume of 1 liter. An illustrative composition for K. lactis defined medium (DMSor) is as follows: 11.83 g/L KH₂PO₄, 2.299 g/L K2HPO₄, 20 g/L of a fermentable sugar, e.g., galactose, maltose, latotriose, sucrose, fructose or glucose and/or a sugar alcohol, for example, erythritol, hydrogenated starch hydrolysates, isomalt, lactitol, maltitol, mannitol, and xylitol, 1 g/L MgSO₄·7H₂O, 10 g/L (NH₄)₅O₄, 0.33 g/L CaCl₂·2H₂O, 1 g/L NaCl, 1 g/L KCl, 5 mg/L CuSO₄·5H₂O, 30 mg/L MnSO₄·H₂O, 10 mg/L, ZnCl₂, 1 mg/L KI, 2 mg/L CoCl₂·6H₂O, 8 mg/L Na₂MoO₄·2H₂O, 0.4 mg/L H₃BO₃, 15 mg/L FeCl₃·6H₂O, 0.8 mg/L biotin, 20 mg/L Ca-pantothenate, 15 mg/L thiamine, 16 mg/L myo-inositol, 10 mg/L nicotinic acid, and 4 mg/L pyridoxine.

Yeast cells can be cultured in 48-well Deep-well plates, sealed after inoculation with sterile, air-permeable cover. Colonies of yeast, for example, K. lactis cultured on plates can be picked and inoculated the deep-well plates with 2.2 mL media per well, composed of DMSor. Inoculated deep-well plates can be grown for 6 days at 23.5° C. with 280 rpm shaking in a refrigerated incubator-shaker. On day 6 post-inoculation, conditioned media should be harvested by centrifugation at 4000 rpm for 10 minutes, followed by filtration using filter plate with 0.22 μM membrane, with filtered media are subject to HPLC analyses.

Yeast Transformation, Peptide Purification, and Analysis

An exemplary method of yeast transformation is as follows: the expression vectors carrying a CRIP ORF, a CRIP-insecticidal protein ORF, or a peptide-IA ORF, are transformed into yeast cells. First, the expression vectors are usually linearized by specific restriction enzyme cleavage to facilitate chromosomal integration via homologous recombination. The linear expression vector is then transformed into yeast cells by a chemical or electroporation method of transformation and integrated into the targeted locus of the yeast genome by homologous recombination. The integration can happen at the same chromosomal locus multiple times; therefore, the genome of a transformed yeast cell can contain multiple copies of CRIP or peptide-IA expression cassettes. The successfully transformed yeast cells can be identified using growth conditions that favor a selective marker engineered into the expression vector and co-integrated into yeast chromosomes with the CRIP, CRIP-insecticidal protein, or peptide-IA ORF; examples of such markers include, but are not limited to, acetamide prototrophy, zeocin resistance, geneticin resistance, nourseothricin resistance, and uracil prototrophy.

Due to the influence of unpredictable and variable factors—such as epigenetic modification of genes and networks of genes, and variation in the number of integration events that occur in individual cells in a population undergoing a transformation procedure—individual yeast colonies of a given transformation process will differ in their capacities to produce a CRIP ORF, a CRIP-insecticidal protein ORF, or a peptide-IA ORF. Therefore, transgenic yeast colonies carrying the CRIP or peptide-IA transgenes should be screened for high yield strains. Two effective methods for such screening—each dependent on growth of small-scale cultures of the transgenic yeast to provide conditioned media samples for subsequent analysis—use reverse-phase HPLC or housefly injection procedures to analyze conditioned media samples from the positive transgenic yeast colonies.

The transgenic yeast cultures can be performed using 14 mL round bottom polypropylene culture tubes with 5 to 10 mL defined medium added to each tube, or in 48-well deep well culture plates with 2.2 mL defined medium added to each well. The defined medium, not containing crude proteinaceous extracts or by-products such as yeast extract or peptone, is used for the cultures to reduce the protein background in the conditioned media harvested for the later screening steps. The cultures are performed at the optimal temperature, for example, 23.5° C. for K. lactis, for about 5-6 days, until the maximum cell density is reached. CRIPs or peptide-IAs will now be produced by the transformed yeast cells and secreted out of cells to the growth medium. To prepare samples for the screening, cells are removed from the cultures by centrifugation and the supernatants are collected as the conditioned media, which are then cleaned by filtration through 0.22 μm filter membrane and then made ready for strain screening.

In some embodiments, positive yeast colonies transformed with CRIP or peptide-IA can be screened via reverse-phase HPLC (rpHPLC) screening of putative yeast colonies. In this screening method, an HPLC analytic column with bonded phase of C18 can be used. Acetonitrile and water are used as mobile phase solvents, and a UV absorbance detector set at 220 nm is used for the peptide detection. Appropriate amounts of the conditioned medium samples are loaded into the rpHPLC system and eluted with a linear gradient of mobile phase solvents. The corresponding peak area of the insecticidal peptide in the HPLC chromatograph is used to quantify the CRIP or peptide-IA concentrations in the conditioned media. Known amounts of pure CRIP or peptide-IA are run through the same rpHPLC column with the same HPLC protocol to confirm the retention time of the peptide and to produce a standard peptide HPLC curve for the quantification.

An exemplary reverse-phase HPLC screening process of positive K. lactis cells is as follows: a CRIP ORF, a CRIP-insecticidal protein ORF, or a peptide-IA ORF, can be inserted into the expression vector, pKLAC1, and transformed into the K. lactis strain, YCT306, from New England Biolabs, Ipswich, MA, USA. pKLAC1 vector is an integrative expression vector. Once the CRIP or peptide-IA transgenes were cloned into pKLAC1 and transformed into YCT306, their expression was controlled by the LAC4 promoter. The resulting transformed colonies produced pre-propeptides comprising an α-mating factor signal peptide, a Kex2 cleavage site and mature CRIPs or peptide-IAs. The α-Mating factor signal peptide guides the pre-propeptides to enter the endogenous secretion pathway, and mature CRIP or peptide-IAs are released into the growth media.

In some embodiments, codon optimization for CRIP or peptide-IA expression can be performed in two rounds, for example, in the first round, based on some common features of high expression DNA sequences, multiple variants of the CRIP or peptide-IA expression ORF, expressing an α-Mating factor signal peptide, a Kex2 cleavage site and the CRIP or peptide-IA, are designed and their expression levels are evaluated in the YCT306 strain of K. lactis, resulting in an initial K. lactis expression algorithm; in a second round of optimization, additional variant CRIP or peptide-IA expression ORFs can be designed based on the initial K. lactis expression algorithm to further fine-tuned the K. lactis expression algorithm, and identify the best ORF for CRIP or peptide-IA expression in K. lactis. In some embodiments, the resulting DNA sequence from the foregoing optimization can have an open reading frame encoding an α-MF signal peptide, a Kex2 cleavage site and a CRIP, a CRIP-insecticidal protein, or a peptide-IA, which can be cloned into the pKLAC1 vector using Hind III and Not I restriction sites, resulting in CRIP or peptide-IA expression vectors.

In some embodiments, the yeast, Pichia pastoris, can be transformed with a CRIP, a CRIP-insecticidal protein, or a peptide-IA, expression cassette. An exemplary method for transforming P. pastoris is as follows: the vectors, pJUGαKR and pJUZαKR, can be used to transform the CRIP or peptide-IA into P. pastoris. The pJUGαKR and pJUZαKR vectors are available from Biogrammatics, Carlsbad, California, USA. Both vectors are integrative vectors and use the uracil phosphoribosyltransferase promoter (pUPP) to enhance the heterologous transgene expression. The only difference between the vectors is that pJUGαKR provides G418 resistance to the host yeast, while pJUZαKR provides Zeocin resistance. Pairs of complementary oligonucleotides, encoding the CRIP or peptide-IA are designed and synthesized for subcloning into the two yeast expression vectors. Hybridization reactions are performed by mixing the corresponding complementary oligonucleotides to a final concentration of 20 μM in 30 mM NaCl, 10 mM Tris-Cl (all final concentrations), pH 8, and then incubating at 95° C. for 20 min, followed by a 9-hour incubation starting at 92° C. and ending at 17° C., with 3° C. drops in temperature every 20 min. The hybridization reactions will result in DNA fragments encoding CRIP or peptide-IA. The two P. pastoris vectors are digested with BsaI-HF restriction enzymes, and the double stranded DNA products of the reactions are then subcloned into the linearized P. pastoris vectors using standard procedures. Following verification of the sequences of the subclones, plasmid aliquots are transfected by electroporation into the P. pastoris strain, Bg08. The resulting transformed yeast, selected based on resistance to Zeocin or G418 conferred by elements engineered into vectors pJUZαKR and pJUGαKR, respectively, can be cultured and screened as described herein.

A detailed description of ORFs and the components thereof is provided below.

Yeast Peptide Yield Screening and Evaluation

Peptide yield can be determined by any of the methods known to those of skill in the art (e.g., capillary gel electrophoresis (CGE), Western blot analysis, and the like). Activity assays, as described herein and known in the art, can also provide information regarding peptide yield. In some embodiments, these or any other methods known in the art can be used to evaluate peptide yield.

Quantification Assays

In some embodiments, and without limitation, CRIP peptide yield can be measured using: HPLC; Mass spectrometry (MS) and related techniques; LC/MS/MS; reverse phase protein arrays (RPPA); immunohistochemistry; ELISA; suspension bead array, mass spectrometry; dot blot; SDS-PAGE; capillary gel electrophoresis (CGE); Western blot analysis; Bradford assay; measuring UV absorption at 260 nm; Lowry assay; Smith copper/bicinchoninic assay; a secretion assay; Pierce protein assay; Biuret reaction; and the like. Exemplary methods of protein quantification are provided in Stoscheck, C. 1990 “Quantification of Protein” Methods in Enzymology, 182:50-68; Lowry, O. Rosebrough, A., Farr, A. and Randall, R. 1951 J. Biol. Chem. 193:265; Smith, P. et al., (1985) Anal. Biochem. 150:76-85; Bradford, M. 1976 “A Rapid and Sensitive Method for the Quantitation of Microgram Quantities of Protein Utilizing the Principle of Protein-Dye Binding” Anal. Biochem. 72:248-254; Cabib, E. and Polacheck, I. 1984 “Protein assay for dilute solutions.” Methods in Enzymology, 104:318-328; Turcanu, Victor; Williams, Neil A. (2001). “Cell identification and isolation on the basis of cytokine secretion: A novel tool for investigating immune responses.” Nature Medicine. 7 (3): 373-376; U.S. Pat. No. 6,391,649; the disclosures of which are incorporated herein by reference in their entireties.

In other embodiments, CRIP peptide yield can be quantified and/or assessed using methods that include, without limitation: recombinant protein mass per volume of culture (e.g., gram or milligrams protein per liter culture); percent or fraction of recombinant protein insoluble precipitate obtained after cell lysis determined in (e.g., recombinant protein extracted supernatant in an amount/amount of protein in the insoluble components); percentage or fraction of active protein (e.g., an amount/analysis of the active protein for use in protein amount); total cell protein (tcp) percentage or fraction; and/or the amount of protein/cell and the dry biomass of a percentage or ratio.

In some embodiments, wherein yield is expressed in terms of culture volume, the culture cell density may be taken into account, particularly when yields between different cultures are being compared.

In some embodiments, the present invention provides a method of producing a heterologous polypeptide that is at least about 5%, at least about 10%, about 15%, about 20%, about 25%, about 30%, about 40%, about 45%, about 50%, about 55%, about 60%, about 65%, about 70%, about 75%, or greater of total cell protein (tcp). “Percent total cell protein” is the amount of heterologous polypeptide in the host cell as a percentage of aggregate cellular protein. The determination of the percent total cell protein is well known in the art.

“Total cell protein (tcp)” or “Percent total cell protein (% tcp)” is the amount of protein or polypeptide in the host cell as a percentage of aggregate cellular protein. Methods for the determination of the percent total cell protein are well known in the art.

In some embodiments, HPLC can be used to quantify peptide yield. For example, in some embodiments, CRIP or peptide-IA yield can be evaluated using an Agilent 1100 HPLC system equipped with an Onyx monolithic 4.5×100 mm, C18 reverse-phase analytical HPLC column and an auto-injector. An illustrative use of the Agilent 1100 HPLC system equipped with an Onyx monolithic 4.5×100 mm, C18 reverse-phase analytical HPLC column and an auto-injector is as follows: filtered conditioned media samples from transformed K. lactis cells are analyzed using Agilent 1100 HPLC system equipped with an Onyx monolithic 4.5×100 mm, C18 reverse-phase analytical HPLC column and an auto-injector by analyzing HPLC grade water and acetonitrile containing 0.1% trifluoroacetic acid, constituting the two mobile phase solvents used for the HPLC analyses; the peak areas of both the CRIP or peptide-IA are analyzed using HPLC chromatographs, and then used to calculate the peptide concentration in the conditioned media, which can be further normalized to the corresponding final cell densities (as determined by OD600 measurements) as normalized peptide yield.

Activity Assays

In some embodiments, positive yeast colonies transformed with a CRIP or a peptide-IA can be screened using a housefly injection assay. The CRIP or peptide-IA can paralyze/kill houseflies when injected in measured doses through the body wall of the dorsal thorax. The efficacy of the CRIP or peptide-IA can be defined by the median paralysis/lethal dose of the peptide (PD₅₀/LD₅₀), which causes 50% knock-down ratio or mortality of the injected houseflies respectively. The pure CRIP or peptide-IA is normally used in the housefly injection assay to generate a standard dose-response curve, from which a PD₅₀/LD₅₀ value can be determined. Using a PD₅₀/LD₅₀ value from the analysis of a standard dose-response curve of the pure CRIP or peptide-IA, quantification of the CRIP or peptide-IA produced by the transformed yeast can be achieved using a housefly injection assay performed with serial dilutions of the corresponding conditioned media.

An exemplary housefly injection bioassay is as follows: conditioned media is serially diluted to generate full dose-response curves from the housefly injection bioassay. Before injection, adult houseflies (Musca domestica) are immobilized with CO₂, and 12-18 mg houseflies are selected for injection. A microapplicator, loaded with a 1 cc syringe and 30-gauge needle, is used to inject 0.5 μL per fly, doses of serially diluted conditioned media samples into houseflies through the body wall of the dorsal thorax. The injected houseflies are placed into closed containers with moist filter paper and breathing holes on the lids, and they are examined by knock-down ratio or by mortality scoring at 24 hours post-injection. Normalized yields are calculated. Peptide yield means the peptide concentration in the conditioned media in units of mg/L. However, peptide yields are not always sufficient to accurately compare the strain production rate. Individual strains may have different growth rates, hence when a culture is harvested, different cultures may vary in cell density. A culture with a high cell density may produce a higher concentration of the peptide in the media, even though the peptide production rate of the strain is lower than another strain which has a higher production rate. Accordingly, the term “normalized yield” is created by dividing the peptide yield with the cell density in the corresponding culture and this allows a better comparison of the peptide production rate between strains. The cell density is represented by the light absorbance at 600 nm with a unit of “A” (Absorbance unit).

Screening yeast colonies that have undergone a transformation with CRIP or peptide-IA can identify the high yield yeast strains from hundreds of potential colonies. These strains can be fermented in bioreactor to achieve at least up to 4 g/L or at least up to 3 g/L or at least up to 2 g/L yield of the CRIP or peptide-IA when using optimized fermentation media and fermentation conditions described herein. The higher rates of production (expressed in mg/L) can be anywhere from about 100 mg/L to about 100,000 mg/L; or from about 100 mg/L to about 90,000 mg/L; or from about 100 mg/L to about 80,000 mg/L; or from about 100 mg/L to about 70,000 mg/L; or from about 100 mg/L to about 60,000 mg/L; or from about 100 mg/L to about 50,000 mg/L; or from about 100 mg/L to about 40,000 mg/L; or from about 100 mg/L to about 30,000 mg/L; or from about 100 mg/L to about 20,000 mg/L; or from about 100 mg/L to about 17,500 mg/L; or from about 100 mg/L to about 15,000 mg/L; or from about 100 mg/L to about 12,500 mg/L; or from about 100 mg/L to about 10,000 mg/L; or from about 100 mg/L to about 9,000 mg/L; or from about 100 mg/L to about 8,000 mg/L; or from about 100 mg/L to about 7,000 mg/L; or from about 100 mg/L to about 6,000 mg/L; or from about 100 mg/L to about 5,000 mg/L; or from about 100 mg/L to about 3,000 mg/L; or from about 100 mg/L to 2,000 mg/L; or from about 100 mg/L to 1,500 mg/L; or from about 100 mg/L to 1,000 mg/L; or from about 100 mg/L to 750 mg/L; or from about 100 mg/L to 500 mg/L; or from about 150 mg/L to 100,000 mg/L; or from about 200 mg/L to 100,000 mg/L; or from about 300 mg/L to 100,000 mg/L; or from about 400 mg/L to 100,000 mg/L; or from about 500 mg/L to 100,000 mg/L; or from about 750 mg/L to 100,000 mg/L; or from about 1,000 mg/L to 100,000 mg/L; or from about 1,250 mg/L to 100,000 mg/L; or from about 1,500 mg/L to 100,000 mg/L; or from about 2,000 mg/L to 100,000 mg/L; or from about 2,500 mg/L to 100,000 mg/L; or from about 3,000 mg/L to 100,000 mg/L; or from about 3,500 mg/L to 100,000 mg/L; or from about 4,000 mg/L to 100,000 mg/L; or from about 4,500 mg/L to 100,000 mg/L; or from about 5,000 mg/L to 100,000 mg/L; or from about 6,000 mg/L to 100,000 mg/L; or from about 7,000 mg/L to 100,000 mg/L; or from about 8,000 mg/L to 100,000 mg/L; or from about 9,000 mg/L to 100,000 mg/L; or from about 10,000 mg/L to 100,000 mg/L; or from about 12,500 mg/L to 100,000 mg/L; or from about 15,000 mg/L to 100,000 mg/L; or from about 17,500 mg/L to 100,000 mg/L; or from about 20,000 mg/L to 100,000 mg/L; or from about 30,000 mg/L to 100,000 mg/L; or from about 40,000 mg/L to 100,000 mg/L; or from about 50,000 mg/L to 100,000 mg/L; or from about 60,000 mg/L to 100,000 mg/L; or from about 70,000 mg/L to 100,000 mg/L; or from about 80,000 mg/L to 100,000 mg/L; or from about 90,000 mg/L to 100,000 mg/L; or any range of any value provided or even greater yields than can be achieved with a peptide before conversion, using the same or similar production methods that were used to produce the peptide before conversion.

Any of the foregoing methods can be used and/or tailored to produce a CRIP and/or peptide-IA (e.g., an Insecticidal Agent that lends itself to such methods, e.g., a polymer of amino acids, a peptide and/or a protein). For example, any of the foregoing methods can be used to produce, generate, make, express, transcribe, translate, synthesize or otherwise create, any of the CRIPs or peptide-IAs described herein, including, without limitation, ACTX peptides (e.g., U-ACTX-Hv1a, U+2-ACTX-Hv1a, rU-ACTX-Hv1a, rU-ACTX-Hv1b, rκ-ACTX-Hv1c, ω-ACTX-Hv1a, and/or ω-ACTX-Hv1a+2); Γ-CNTX-Pn1a; U1-agatoxin-Ta1b; TVPs; Av2; Av3; AVPs; and/or Bt toxins (e.g., Cry toxins, Cyt toxins, or Vips).

Culture and Fermentation Conditions

Cell culture techniques are well-known in the art. In some embodiments, the culture method and/or materials will necessarily require adaption based on the host cell selected; and, such adaptions (e.g., modifying pH, temperature, medium contents, and the like) are well known to those having ordinary skill in the art. In some embodiments, any known culture technique may be employed to produce a CRIP, a CRIP-insecticidal protein, or a peptide-IA of the present invention.

Exemplary culture methods are provided in U.S. Pat. Nos. 3,933,590; 3,946,780; 4,988,623; 5,153,131; 5,153,133; 5,155,034; 5,316,905; 5,330,908; 6,159,724; 7,419,801; 9,320,816; 9,714,408; and 10,563,169; the disclosures of which are incorporated herein by reference in their entireties.

Yeast Culture

Yeast cell culture techniques are well known to those having ordinary skill in the art. Exemplary methods of yeast cell culture can be found in Evans, Yeast Protocols. Springer (1996); Bill, Recombinant Protein Production in Yeast. Springer (2012); Hagan et al., Fission Yeast: A Laboratory Manual, CSH Press (2016); Konishi et al., Improvement of the transformation efficiency of Saccharomyces cerevisiae by altering carbon sources in pre-culture. Biosci Biotechnol Biochem. 2014; 78(6):1090-3; Dymond, Saccharomyces cerevisiae growth media. Methods Enzymol. 2013; 533:191-204; Looke et al., Extraction of genomic DNA from yeasts for PCR-based applications. Biotechniques. 2011 May; 50(5):325-8; and Romanos et al., Culture of yeast for the production of heterologous proteins. Cliff Protoc Cell Biol. 2014 Sep. 2; 64:20.9.1-16, the disclosure of which is incorporated herein by reference in its entirety.

Yeast can be cultured in a variety of media, e.g., in some embodiments, yeast can be cultured in minimal medium; YPD medium; yeast synthetic drop-out medium; Yeast Nitrogen Base (YNB with or without amino acids); YEPD medium; ADE D medium; ADE DS″ medium; LEU D medium; HIS D medium; or Mineral salts medium.

In some embodiments, yeast can be cultured in minimal medium. In some embodiments, minimal medium ingredients can comprise: 2% Sugar; Phosphate Buffer, pH 6.0; Magnesium Sulfate; Calcium Chloride; Ammonium Sulfate; Sodium Chloride; Potassium Chloride; Copper Sulfate; Manganese Sulfate; Zinc Chloride; Potassium Iodide; Cobalt Chloride; Sodium Molybdate; Boric Acid; Iron Chloride; Biotin; Calcium pantothenate; Thiamine; Myo-inositol; Nicotinic Acid; and Pyridoxine.

In some embodiments, yeast can be cultured in YPD medium. YPD medium comprises a bacteriological peptone, yeast extract, and glucose.

In some embodiments, yeast can be cultured in yeast synthetic drop-out medium, which can be used to differentiate auxotrophic mutant strains that cannot grow without a specific medium component transformed with a plasmid that allows said transformant to grow on a medium lacking the required component.

In some embodiments, yeast can be cultured using Yeast Nitrogen Base (YNB with or without amino acids), which comprises nitrogen, vitamins, trace elements, and salts.

In some embodiments, the medium can be YEPD medium, e.g., a medium comprising 2% D-glucose, 2% BACTO Peptone (Difco Laboratories, Detroit, MI), 1% BACTO yeast extract (Difco), 0.004% adenine, and 0.006% L-leucine; or, a variation thereof, wherein the carbon source is a sugar alcohol, e.g., glycerol or sorbitol

In some embodiments, the medium can be ADE D medium, e.g., a medium comprising 0.056%-Ade-Trp-Thr powder, 0.67% yeast nitrogen base without amino acids, 2% D-glucose, and 0.5% 200× tryptophan, threonine solution; or, a variation thereof, wherein the carbon source is a sugar alcohol, e.g., glycerol or sorbitol

In some embodiments, the medium can be ADE DS″ medium, e.g., a medium comprising 0.056%-Ade-Trp-Thr powder, 0.67% yeast nitrogen base without amino acids, 2% D-glucose, 0.5% 200× tryptophan, threonine solution, and 18.22% D-sorbitol; or, a variation thereof, wherein the carbon source is entirely a sugar alcohol, e.g., glycerol or sorbitol

In some embodiments, the medium can be LEU D medium e.g., a medium comprising 0.052%-Leu-Trp-Thr powder, 0.67% yeast nitrogen base without amino acids, 2% D-glucose, and 0.5% 200× tryptophan, threonine solution; or, a variation thereof, wherein the carbon source is a sugar alcohol, e.g., glycerol or sorbitol.

In some embodiments, the medium can be HIS D medium, e.g., a medium comprising 0.052%-His-Trp-Thr powder, 0.67% yeast nitrogen base without amino acids, 2% D-glucose, and 0.5% 200× tryptophan, threonine solution; or, a variation thereof, wherein the carbon source is a sugar alcohol, e.g., glycerol or sorbitol.

In some embodiments, a mineral salts medium can be used. Mineral salts media consists of mineral salts and a carbon source such as, e.g., glucose, sucrose, or glycerol. Examples of mineral salts media include, e.g., M9 medium, Pseudomonas medium (ATCC 179), and Davis and Mingioli medium. See, Davis & Mingioli (1950) J. Bact. 60:17-28. The mineral salts used to make mineral salts media include those selected from among, e.g., potassium phosphates, ammonium sulfate or chloride, magnesium sulfate or chloride, and trace minerals such as calcium chloride, borate, and sulfates of iron, copper, manganese, and zinc. Typically, no organic nitrogen source, such as peptone, tryptone, amino acids, or a yeast extract, is included in a mineral salts medium. Instead, an inorganic nitrogen source is used and this may be selected from among, e.g., ammonium salts, aqueous ammonia, and gaseous ammonia. A mineral salts medium will typically contain glucose or glycerol as the carbon source.

In comparison to mineral salts media, minimal media can also contain mineral salts and a carbon source, but can be supplemented with, e.g., low levels of amino acids, vitamins, peptones, or other ingredients, though these are added at very minimal levels. Media can be prepared using the methods described in the art, e.g., in U.S. Pat. App. Pub. No. 2006/0040352, the disclosure of which is incorporated herein by reference in its entirety. Details of cultivation procedures and mineral salts media useful in the methods of the present invention are described by Riesenberg, D et al., 1991, “High cell density cultivation of Escherichia coli at controlled specific growth rate,” J. Biotechnol. 20 (1):17-27.

In some embodiments, Kluyveromyces lactis are grown in minimal media supplemented with 2% glucose, galactose, sorbitol, or glycerol as the sole carbon source. Cultures are incubated at 30° C. until mid-log phase (24-48 hours) for β-galactosidase measurements, or for 6 days at 23.5° C. for heterologous protein expression.

In some embodiments, yeast cells can be cultured in 48-well Deep-well plates, sealed after inoculation with sterile, air-permeable cover. Colonies of yeast, for example, K. lactis cultured on plates can be picked and inoculated the deep-well plates with 2.2 mL media per well, composed of DMSor. Inoculated deep-well plates can be grown for 6 days at 23.5° C. with 280 rpm shaking in a refrigerated incubator-shaker. On day 6 post-inoculation, conditioned media should be harvested by centrifugation at 4000 rpm for 10 minutes, followed by filtration using filter plate with 0.22 μM membrane, with filtered media are subject to HPLC analyses.

In some embodiments, yeast species such as Kluyveromyces lactis, Saccharomyces cerevisiae, Pichia pastoris, and others, can be used as a host organism, and/or the yeast to be modified using the methods described herein.

Temperature and pH conditions will vary depending on the stage of culture and the host cell species selected. Variables such as temperature and pH in cell culture are readily known to those having ordinary skill in the art.

The pH level is important in the culturing of yeast. One of skill in the art will appreciate that the culturing process includes not only the start of the yeast culture but the maintenance of the culture as well. The yeast culture may be started at any pH level, however, since the media of a yeast culture tends to become more acidic (i.e., lowering the pH) over time, care must be taken to monitor the pH level during the culturing process.

In some embodiments of the invention, the yeast is grown in a medium at a pH level that is dictated based on the species of yeast used, the stage of culture, and/or the temperature. Thus, in some embodiments, the pH level can fall within a range from about 2 to about 10. Those having ordinary skill in the art will recognize that the optimum pH for most microorganisms is near the neutral point (pH 7.0). However, in some embodiments, some fungal species prefer an acidic environment: accordingly, in some embodiments, the pH can range from 2 to 6.5. In some embodiments, the pH can range from about 4 to about 4.5. Some fungal species (e.g., molds) can grow can grow in a pH of from about 2 to about 8.5, but favor an acid pH. See Mountney & Gould, Practical food microbiology and technology. 1988. Ed. 3; and Pena et al., Effects of high medium pH on growth, metabolism and transport in Saccharomyces cerevisiae. FEMS Yeast Res. 2015 March; 15(2):fou005.

In other embodiments, the pH is about 5.7 to 5.9, 5.8 to 6.0, 5.9 to 6.1, 6.0 to 6.2, 6.1 to 6.3, 6.2 to 6.5, 6.4 to 6.7, 6.5 to 6.8, 6.6 to 6.9, 6.7 to 7.0, 6.8 to 7.1, 6.9 to 7.2, 7.0 to 7.3, 7.1 to 7.4, 7.2 to 7.5, 7.3 to 7.6, 7.4 to 7.7, 7.5 to 7.8, 7.6 to 7.9, 7.7 to 8.0, 7.8 to 8.1, 7.9 to 8.2, 8.0 to 8.3, 8.1 to 8.4, 8.2 to 8.5, 8.3 to 8.6, 8.4 to 8.7, or 8.5 to 8.8.

In some embodiments, the pH of the medium can be at least 5.5. In other aspects, the medium can have a pH level of about 5.5. In other aspects, the medium can have a pH level of between 4 and 8. In some cases, the culture is maintained at a pH level of between 5.5 and 8. In other aspects, the medium has a pH level of between 6 and 8. In some cases, medium has a pH level that is maintained at a pH level of between 6 and 8. In some embodiments, the yeast is grown and/or maintained at a pH level of between 6.1 and 8.1. In some embodiments, the yeast is grown and/or maintained at a pH level of between 6.2 and 8.2. In some embodiments, the yeast is grown and/or maintained at a pH level of between 6.3 and 8.3. In some embodiments, the yeast is grown and/or maintained at a pH level of between 6.4 and 8.4. In some embodiments, the yeast is grown and/or maintained at a pH level of between 5.5 and 8.5. In some embodiments, the yeast is grown and/or maintained at a pH level of between 6.5 and 8.5. In some embodiments, the yeast is grown at a pH level of about 5.6, 5.7, 5.8 or 5.9. In some embodiments, the yeast is grown at a pH level of about 6. In some embodiments, the yeast is grown at a pH level of about 6.5. In some embodiments, the yeast is grown at a pH level of about 6, 6.1, 6.2, 6.3, 6.4, 6.5, 6.6, 6.7, 6.8, 6.9 or 7.0. In some embodiments, the yeast is grown at a pH level of about 7, 7.1, 7.2, 7.3, 7.4, 7.5, 7.6, 7.7, 7.8, 7.9, or 8.0. In some embodiments, the yeast is grown at a level of above 8.

In some embodiments, the pH of the medium can range from a pH of 2 to 8.5. In certain embodiments, the pH is about 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, or 8.8.

Exemplary methods of yeast culture can be found in U.S. Pat. No. 5,436,136, entitled “Repressible yeast promoters” (filed Dec. 20, 1991; assignee Ciba-Geigy Corporation); U.S. Pat. No. 6,645,739, entitled “Yeast expression systems, methods of producing polypeptides in yeast, and compositions relating to same” (filed Jul. 26, 2001; assignee Phoenix Pharmacologies, Inc., Lexington, KY); and U.S. Pat. No. 10,023,836, entitled “Medium for yeasts” (filed Aug. 23, 2013; assignee Yamaguchi University); the disclosures of which are incorporated herein by reference in their entirety.

Fermentation

The present invention contemplates the culture of host organisms in any fermentation format. For example, batch, fed-batch, semi-continuous, and continuous fermentation modes may be employed herein.

Fermentation may be performed at any scale. The methods and techniques contemplated according to the present invention are useful for recombinant protein expression at any scale. Thus, in some embodiments, e.g., microliter-scale, milliliter scale, centiliter scale, and deciliter scale fermentation volumes may be used, and 1 Liter scale and larger fermentation volumes can be used.

In some embodiments, the fermentation volume is at or above about 1 Liter. For example, in some embodiments, the fermentation volume is about 1 liter to about 100 liters. In some embodiments, the fermentation volume is about 1 liter, about 2 liters, about 3 liters, about 4 liters, about 5 liters, about 6 liters, about 7 liters, about 8 liters, about 9 liters, or about 10 liters. In some embodiments, the fermentation volume is about 1 liter to about 5 liters, about 1 liter to about 10 liters, about 1 liter to about 25 liters, about 1 liter to about 50 liters, about 1 liter to about 75 liters, about 10 liters to about 25 liters, about 25 liters to about 50 liters, or about 50 liters to about 100 liters In other embodiments, the fermentation volume is at or above 5 Liters, 10 Liters, 15 Liters, 20 Liters, 25 Liters, 50 Liters, 75 Liters, 100 Liters, 200 Liters, 500 Liters, 1,000 Liters, 2,000 Liters, 5,000 Liters, 10,000 Liters, or 50,000 Liters.

In some embodiments, the fermentation medium can be a nutrient solution used for growing and or maintaining cells. Without limitation, this solution ordinarily provides at least one component from one or more of the following categories: (1) an energy source, usually in the form of a carbon source, e.g., glucose; (2) all essential amino acids, and usually the basic set of twenty amino acids; (3) vitamins and/or other organic compounds required at low concentrations; (4) free fatty acids or lipids, for example linoleic acid; and (5) trace elements, where trace elements are defined as inorganic compounds or naturally occurring elements that are typically required at very low concentrations, usually in the micromolar range.

In some embodiments, the fermentation medium can be the same as the cell culture medium or any other media described herein. In some embodiments, the fermentation medium can be different from the cell culture medium. In some embodiments, the fermentation medium can be modified in order to accommodate the large-scale production of proteins.

In some embodiments, the fermentation medium can be supplemented electively with one or more components from any of the following categories: (1) hormones and other growth factors such as, serum, insulin, transferrin, and the like; (2) salts, for example, magnesium, calcium, and phosphate; (3) buffers, such as HEPES; (4) nucleosides and bases such as, adenosine, thymidine, etc.; (5) protein and tissue hydrolysates, for example peptone or peptone mixtures which can be obtained from purified gelatin, plant material, or animal byproducts; (6) antibiotics, such as gentamycin; and (7) cell protective agents, for example pluronic polyol.

In some embodiments, the pH of the fermentation medium can be maintained using pH buffers and methods known to those of skill in the art. Control of pH during fermentation can also can be achieved using aqueous ammonia. In some embodiments, the pH of the fermentation medium will be selected based on the preferred pH of the organism used. Thus, in some embodiments, and depending on the host cell and temperature, the pH can range from about to 1 to about 10.

In some embodiments, the pH of the fermentation medium can range from a pH of 2 to 8.5. In certain embodiments, the pH is about 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, or 8.8.

In other embodiments, the pH is about 5.7 to 5.9, 5.8 to 6.0, 5.9 to 6.1, 6.0 to 6.2, 6.1 to 6.3, 6.2 to 6.5, 6.4 to 6.7, 6.5 to 6.8, 6.6 to 6.9, 6.7 to 7.0, 6.8 to 7.1, 6.9 to 7.2, 7.0 to 7.3, 7.1 to 7.4, 7.2 to 7.5, 7.3 to 7.6, 7.4 to 7.7, 7.5 to 7.8, 7.6 to 7.9, 7.7 to 8.0, 7.8 to 8.1, 7.9 to 8.2, 8.0 to 8.3, 8.1 to 8.4, 8.2 to 8.5, 8.3 to 8.6, 8.4 to 8.7, or 8.5 to 8.8

In some embodiments, e.g., where Escherichia coli (E. coli) is used, the optimal pH range is between 6.5 and 7.5, depending on the temperature.

In other embodiments, e.g., where a yeast strain is used, the pH can range from about 4.0 to 8.0.

In some embodiments, neutral pH, i.e., a pH of about 7.0 can be used.

Those having ordinary skill in the art will recognize that during fermentation, the pH levels may drift as result of conversion and production of substrates and metabolic compounds.

In some embodiments, the fermentation medium can be supplemented with a buffer or other chemical in order to avoid changes to the pH. For example, in some embodiments, the addition of Ca(OH)₂, CaCO₃, NaOH, or NH₄OH can be added to the fermentation medium to neutralize the production of acidic compounds that occur, e.g., in some yeast species during industrial processes.

Temperature is another important consideration in the fermentation process; and, like pH considerations, temperature will depend on the type of host cell selected.

In some embodiments, the fermentation temperature is maintained at about 4° C. to about 42° C. In certain embodiments, the fermentation temperature is about 4° C., about 5° C., about 6° C., about 7° C., about 8° C., about 9° C., about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., or about 42° C.

In other embodiments, the fermentation temperature is maintained at about 25° C. to about 27° C., about 25° C. to about 28° C., about 25° C. to about 29° C., about 25° C. to about 30° C., about 25° C. to about 31° C., about 25° C. to about 32° C., about 25° C. to about 33° C., about 26° C. to about 28° C., about 26° C. to about 29° C., about 26° C. to about 30° C., about 26° C. to about 31° C., about 26° C. to about 32° C., about 27° C. to about 29° C., about 27° C. to about 30° C., about 27° C. to about 31° C., about 27° C. to about 32° C., about 26° C. to about 33° C., about 28° C. to about 30° C., about 28° C. to about 31° C., about 28° C. to about 32° C., about 29° C. to about 31° C., about 29° C. to about 32° C., about 29° C. to about 33° C., about 30° C. to about 32° C., about 30° C. to about 33° C., about 31° C. to about 33° C., about 31° C. to about 32° C., about 30° C. to about 33° C., or about 32° C. to about 33° C.

In other embodiments, the temperature is changed during fermentation, e.g., depending on the stage of fermentation.

Fermentation can be achieved with a variety of microorganisms known to those having ordinary skill in the art. Suitable microorganisms for up-scaled production of a CRIP, a CRIP-insecticidal protein, or a peptide-IA include any microorganism listed herein. In some embodiments, non-limiting examples of microorganisms include strains of the genus Saccharomyces spp. (including, but not limited to, S. cerevisiae (baker's yeast), S. distaticus, S. uvarum), the genus Kluyveromyces, (including, but not limited to, K. marxianus, K fragilis), the genus Candida (including, but not limited to, C. pseudotropicalis, and C. brassicae), Pichia stipitis (a relative of Candida shehatae), the genus Clavispora (including, but not limited to, C. lusitaniae and C. opuntiae), the genus Pachysolen (including, but not limited to, P. tannophilus), the genus Bretannomyces (including, but not limited to, e.g., B. clausenii. Other suitable microorganisms include, for example, Zymomonas mobilis, Clostridium spp. (including, but not limited to, C. thermocellum; C. saccharobutylacetonicum, C. saccharobutylicum, C. puniceum, C. beijernckii, and C. acetobutylicum), Moniliella pollinis, Moniliella megachiliensis, Lactobacillus spp. Yarrowia lipolytica, Aureobasidium sp., Trichosporonoides sp., Trigonopsis variabilis, Trichosporon sp., Moniliellaacetoabutans sp., Typhula variabilis, Candida magnolias, Ustilaginomycetes sp., Pseudozyma tsukubaensis, yeast species of genera Zygosaccharomyces, Debaryomyces, Hansenula and Pichia, and fungi of the dematioid genus Torula. See, e.g., Philippidis, G. P., 1996, Cellulose bioconversion technology, in Handbook on Bioethanol: Production and Utilization, Wyman, C. E., ed., Taylor & Francis, Washington, D.C., 179-212.

Fermentation medium may be selected depending on the host cell and/or needs of the end-user. Any necessary supplements besides, e.g., carbon, may also be included at appropriate concentrations introduced alone or as a mixture with another supplement or medium such as a complex nitrogen source.

Yeast Fermentation

Fermentation methods using yeast are well known to those having ordinary skill in the art. In some embodiments, batch fermentation can be used according to the methods provided herein; in other embodiments, continuous fermentation procedures can be used.

In some embodiments, the batch method of fermentation can be used to produce CRIPs, CRIP-insecticidal proteins, or peptide-IAs of the present invention. Briefly, the batch method of fermentation refers to a type of fermentation that is performed with a closed system, wherein the composition of the medium is determined at the beginning of the fermentation and is not subject to artificial alterations during the fermentation (i.e., the medium is inoculated with one or more yeast cells at the start of fermentation, and fermentation is allowed to proceed, uninterrupted by the user). Typically, in batch fermentation systems, the metabolite and biomass compositions of the system change constantly up to the time the fermentation is stopped. Within batch cultures, yeast cells pass through a static lag phase to a high growth log phase, and, finally, to a stationary phase, in which the growth rate is diminished or stopped. If untreated, yeast cells in the stationary phase will eventually die. In a batch method, yeast cells in log phase generally are responsible for the bulk of synthesis of end product.

In some embodiments, fed-batch fermentation can be used to produce CRIPs, CRIP-insecticidal proteins, or peptide-IAs of the present invention. Briefly, fed-batch fermentation is similar to typical batch method (described above), however, the substrate in the fed-batch method is added in increments as the fermentation progresses. Fed-batch fermentation is useful when catabolite repression may inhibit yeast cell metabolism, and when it is desirable to have limited amounts of substrate in the medium. Generally, the measurement of the substrate concentration in a fed-batch system is estimated on the basis of the changes of measurable factors reflecting metabolism, such as pH, dissolved oxygen, the partial pressure of waste gases (e.g., CO₂), and the like.

In some embodiments, the fed-batch fermentation procedure can be used to produce CRIPs, CRIP-insecticidal proteins, or peptide-IAs as follows: culturing a production organism (e.g., a modified yeast cell) in a 10 L bioreactor sparged with an N₂/CO₂ mixture, using 5 L broth containing 5 g/L potassium phosphate, 2.5 g/L ammonium chloride, 0.5 g/L magnesium sulfate, and 30 g/L corn steep liquor, and an initial first and second carbon source concentration of 20 g/L. As the modified yeast cells grow and utilize the carbon sources, additional 70% carbon source mixture is then fed into the bioreactor at a rate approximately balancing carbon source consumption. The temperature of the bioreactor is generally maintained at 30° C. Growth continues for approximately 24 hours or more, and the heterologous peptides reach a desired concentration, e.g., with the cell density being between about 5 and 10 g/L. Upon completion of the cultivation period, the fermenter contents can be passed through a cell separation unit such as a centrifuge to remove cells and cell debris, and the fermentation broth can be transferred to a product separations unit. Isolation of the heterologous peptides can take place by standard separations procedures well known in the art.

In some embodiments, continuous fermentation can be used to produce CRIPs, CRIP-insecticidal proteins, or peptide-IAs of the present invention. Briefly, continuous fermentation refers to fermentation with an open system, wherein a fermentation medium is added continuously to a bioreactor, and an approximately equal amount of conditioned medium is removed simultaneously for processing. Continuous fermentation generally maintains the cultures at a high density, in which yeast cells are primarily in log phase growth. Typically, continuous fermentation methods are performed to maintain steady state growth conditions, and yeast cell loss, due to medium withdrawal, should be balanced against the cell growth rate in the fermentation.

In some embodiments, the continuous fermentation method can be used to produce CRIPs, CRIP-insecticidal proteins, or peptide-IAs as follows: a modified yeast strain can be cultured using a bioreactor apparatus and a medium composition, albeit where the initial first and second carbon source is about, e.g., 30-50 g/L. When the carbon source is exhausted, feed medium of the same composition is supplied continuously at a rate of between about 0.5 L/hr and 1 L/hr, and liquid is withdrawn at the same rate. The heterologous peptide concentration in the bioreactor generally remains constant along with the cell density. Temperature is generally maintained at 30° C., and the pH is generally maintained at about 4.5 using concentrated NaOH and HCl, as required.

In some embodiments, when producing CRIPs, CRIP-insecticidal proteins, or peptide-IAs, the bioreactor can be operated continuously, for example, for about one month, with samples taken every day or as needed to assure consistency of the target chemical compound concentration. In continuous mode, fermenter contents are constantly removed as new feed medium is supplied. The exit stream, containing cells, medium, and heterologous peptides, can then be subjected to a continuous product separations procedure, with or without removing cells and cell debris, and can be performed by continuous separations methods well known in the art to separate organic products from peptides of interest.

In some embodiments, a yeast cell operable to express a CRIP, a CRIP-insecticidal protein, or a peptide-IA can be grown, e.g., using a fed batch process in aerobic bioreactor. Briefly, reactors are filled to about 20% to about 70% capacity with medium comprising a carbon source and other reagents. Temperature and pH is maintained using one or more chemicals as described herein. Oxygen level is maintained by sparging air intermittently in concert with agitation.

For example, in some embodiments, the present invention provides a method of using a fed batch process in aerobic bioreactor, wherein the reactor is filled to about 20%; 21%; 22%; 23%; 24%; 25%; 26%; 27%; 28%; 29%; 30%; 31%; 32%; 33%; 34%; 35%; 36%; 37%; 38%; 39%; 40%; 41%; 42%; 43%; 44%; 45%; 46%; 47%; 48%; 49%; 50%; 51%; 52%; 53%; 54%; 55%; 56%; 57%; 58%; 59%; 60%; 61%; 62%; 63%; 64%; 65%; 66%; 67%; 68%; 69%; or 70% capacity.

In some embodiments, the present invention provides a fed batch fermentation method using an aerobic bioreactor to produce CRIPs, CRIP-insecticidal proteins, or peptide-IAs, wherein the medium is a rich culture medium. For example, in some embodiments, the carbon source can be glucose, sorbitol, or lactose.

In some embodiments, the amount of glucose can be about 2 g/L; 3 g/L; 4 g/L; 5 g/L; 6 g/L; 7 g/L; 8 g/L; 9 g/L; 10 g/L; 11 g/L; 12 g/L; 13 g/L; 14 g/L; 15 g/L; 16 g/L; 17 g/L; 18 g/L; 19 g/L; 20 g/L; 21 g/L; 22 g/L; 23 g/L; 24 g/L; 25 g/L; 26 g/L; 27 g/L; 28 g/L; 29 g/L; or 30 g/L of the medium.

In some embodiments, the amount of sorbitol can be about 2 g/L; 3 g/L; 4 g/L; 5 g/L; 6 g/L; 7 g/L; 8 g/L; 9 g/L; 10 g/L; 11 g/L; 12 g/L; 13 g/L; 14 g/L; 15 g/L; 16 g/L; 17 g/L; 18 g/L; 19 g/L; 20 g/L; 21 g/L; 22 g/L; 23 g/L; 24 g/L; 25 g/L; 26 g/L; 27 g/L; 28 g/L; 29 g/L; or 30 g/L of the medium.

In some embodiments, the amount of lactose can be about 2 g/L; 3 g/L; 4 g/L; 5 g/L; 6 g/L; 7 g/L; 8 g/L; 9 g/L; 10 g/L; 11 g/L; 12 g/L; 13 g/L; 14 g/L; 15 g/L; 16 g/L; 17 g/L; 18 g/L; 19 g/L; 20 g/L; 21 g/L; 22 g/L; 23 g/L; 24 g/L; 25 g/L; 26 g/L; 27 g/L; 28 g/L; 29 g/L; or 30 g/L of the medium.

In some embodiments, the present invention provides a fed batch fermentation method using an aerobic bioreactor, wherein the medium is supplemented with one or more of phosphoric acid, calcium sulfate, potassium sulfate, magnesium sulfate heptahydrate, potassium hydroxide, and/or corn steep liquor.

In some embodiments, the medium can be supplemented with phosphoric acid in an amount of about 2 g/L; 3 g/L; 4 g/L; 5 g/L; 6 g/L; 7 g/L; 8 g/L; 9 g/L; 10 g/L; 11 g/L; 12 g/L; 13 g/L; 14 g/L; 15 g/L; 16 g/L; 17 g/L; 18 g/L; 19 g/L; 20 g/L; 21 g/L; 22 g/L; 23 g/L; 24 g/L; 25 g/L; 26 g/L; 27 g/L; 28 g/L; 29 g/L; or 30 g/L to the medium.

In some embodiments, the medium can be supplemented with calcium sulfate in an amount of about 0.05 g/L; 0.15 g/L; 0.25 g/L; 0.35 g/L; 0.45 g/L; 0.55 g/L; 0.65 g/L; 0.75 g/L; 0.85 g/L; 0.95 g/L; 1.05 g/L; 1.15 g/L; 1.25 g/L; 1.35 g/L; 1.45 g/L; 1.55 g/L; 1.65 g/L; 1.75 g/L; 1.85 g/L; 1.95 g/L; 2.05 g/L; 2.15 g/L; 2.25 g/L; 2.35 g/L; 2.45 g/L; 2.55 g/L; 2.65 g/L; 2.75 g/L; 2.85 g/L; or 2.95 g/L to the medium.

In some embodiments, the medium can be supplemented with potassium sulfate in an amount of about 2 g/L; 2.5 g/L; 3 g/L; 3.5 g/L; 4 g/L; 4.5 g/L; 5 g/L; 5.5 g/L; 6 g/L; 6.5 g/L; 7 g/L; 7.5 g/L; 8 g/L; 8.5 g/L; 9 g/L; 9.5 g/L; 10 g/L; 10.5 g/L; 11 g/L; 11.5 g/L; 12 g/L; 12.5 g/L; 13 g/L; 13.5 g/L; 14 g/L; 14.5 g/L; 15 g/L; 15.5 g/L; 16 g/L; 16.5 g/L; 17 g/L; 17.5 g/L; 18 g/L; 18.5 g/L; 19 g/L; 19.5 g/L; or 20 g/L to the medium.

In some embodiments, the medium can be supplemented with magnesium sulfate heptahydrate in an amount of about 0.25 g/L; 0.5 g/L; 0.75 g/L; 1 g/L; 1.25 g/L; 1.5 g/L; 1.75 g/L; 2 g/L; 2.25 g/L; 2.5 g/L; 2.75 g/L; 3 g/L; 3.25 g/L; 3.5 g/L; 3.75 g/L; 4 g/L; 4.25 g/L; 4.5 g/L; 4.75 g/L; 5 g/L; 5.25 g/L; 5.5 g/L; 5.75 g/L; 6 g/L; 6.25 g/L; 6.5 g/L; 6.75 g/L; 7 g/L; 7.25 g/L; 7.5 g/L; 7.75 g/L; 8 g/L; 8.25 g/L; 8.5 g/L; 8.75 g/L; 9 g/L; 9.25 g/L; 9.5 g/L; 9.75 g/L; 10 g/L; 10.25 g/L; 10.5 g/L; 10.75 g/L; 11 g/L; 11.25 g/L; 11.5 g/L; 11.75 g/L; 12 g/L; 12.25 g/L; 12.5 g/L; 12.75 g/L; 13 g/L; 13.25 g/L; 13.5 g/L; 13.75 g/L; 14 g/L; 14.25 g/L; 14.5 g/L; 14.75 g/L; or 15 g/L to the medium.

In some embodiments, the medium can be supplemented with potassium hydroxide in an amount of about 0.25 g/L; 0.5 g/L; 0.75 g/L; 1 g/L; 1.25 g/L; 1.5 g/L; 1.75 g/L; 2 g/L; 2.25 g/L; 2.5 g/L; 2.75 g/L; 3 g/L; 3.25 g/L; 3.5 g/L; 3.75 g/L; 4 g/L; 4.25 g/L; 4.5 g/L; 4.75 g/L; 5 g/L; 5.25 g/L; 5.5 g/L; 5.75 g/L; 6 g/L; 6.25 g/L; 6.5 g/L; 6.75 g/L; or 7 g/L to the medium.

In some embodiments, the medium can be supplemented with corn steep liquor in an amount of about 5 g/L; 6 g/L; 7 g/L; 8 g/L; 9 g/L; 10 g/L; 11 g/L; 12 g/L; 13 g/L; 14 g/L; 15 g/L; 16 g/L; 17 g/L; 18 g/L; 19 g/L; 20 g/L; 21 g/L; 22 g/L; 23 g/L; 24 g/L; 25 g/L; 26 g/L; 27 g/L; 28 g/L; 29 g/L; 30 g/L; 31 g/L; 32 g/L; 33 g/L; 34 g/L; 35 g/L; 36 g/L; 37 g/L; 38 g/L; 39 g/L; 40 g/L; 41 g/L; 42 g/L; 43 g/L; 44 g/L; 45 g/L; 46 g/L; 47 g/L; 48 g/L; 49 g/L; 50 g/L; 51 g/L; 52 g/L; 53 g/L; 54 g/L; 55 g/L; 56 g/L; 57 g/L; 58 g/L; 59 g/L; 60 g/L; 61 g/L; 62 g/L; 63 g/L; 64 g/L; 65 g/L; 66 g/L; 67 g/L; 68 g/L; 69 g/L; or 70 g/L to the medium.

In some embodiments, the temperature of the reactor can be maintained between about 15° C. and about 45° C. In some embodiments, the reactor can have a temperature of about 20° C., 21° C., 22° C., 23° C., 24° C., 25° C., 26° C., 27° C., 28° C., 29° C., 30° C., 31° C., 32° C., 33° C., 34° C., 35° C., 36° C., 37° C., 38° C., 39° C., or 40° C.

In some embodiments, the pH can have a level of about 3 to about 6. In some embodiments, the pH can be 3.0, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, 5, 5.1, 5.2, 5.3, 5.4, 5.5, 5.6, 5.7, 5.8, 5.9, or 6.0.

In some embodiments, the pH can be maintained at a constant level via the addition of one or more chemicals. For example, in some embodiments, ammonium hydroxide can be added to maintain pH. In some embodiments, ammonium hydroxide can be added to a level of ammonium hydroxide in the medium that is about 5%, 6%, 7%, 8%, 9%, 10%, 11%, 12%, 13%, 14%, 15%, 16%, 17%, 18%, 19%, or 20%, of ammonium hydroxide

In some embodiments, oxygen levels can be maintained by sparging. For example, in some embodiments, dissolved oxygen can be maintained at a constant level by sparging air between 0.5-1.5 volume/volume/min and by increasing agitation to maintain a set point of 10-30%.

In some embodiments, inoculation of the reactor can be accomplished based on an overnight seed culture comprising from about 2.5 g/L to about 50 g/L of a carbon source, e.g., glucose, sorbitol, or lactose. In some embodiments, the overnight seed culture can comprise corn steep liquor, e.g., from about 2.5 g/L to about 50 g/L of corn steep liquor.

In some embodiments, the inoculation percentage can range from about 5-20% of initial fill volume. Following inoculation, the reactor can be fed with from about a 50% to about an 80% solution of the selected carbon source up until the reactor is filled and/or the desired supernatant peptide concentration is achieved. In some embodiments, the time required to fill the reactor can range from about 86 hours to about 160 hours. In some embodiments, the quantity required to reach the desired peptide concentration can range from about 0.8 g/L to about 1.2 g/L. Upon completion of the fermentation, the contents can be passed through a cell separation unit and optionally concentrated, depending on intended use of the material.

Additional recipes for yeast fermentation media are provided herein.

Recipes for yeast cell fermentation media and stocks are described as follows: (1) MSM media recipe: 2 g/L sodium citrate dihydrate; 1 g/L calcium sulfate dihydrate (0.79 g/L anhydrous calcium sulfate); 42.9 g/L potassium phosphate monobasic; 5.17 g/L ammonium sulfate; 14.33 g/L potassium sulfate; 11.7 g/L magnesium sulfate heptahydrate; 2 mL/L PTM1 trace salt solution; 0.4 ppm biotin (from 500×, 200 ppm stock); 1-2% pure glycerol or other carbon source. (2) PTM1 trace salts solution: Cupric sulfate-5H₂O 6.0 g; Sodium iodide 0.08 g; Manganese sulfate-H₂O 3.0 g; Sodium molybdate-2H₂O 0.2 g; Boric Acid 0.02 g; Cobalt chloride 0.5 g; Zinc chloride 20.0 g; Ferrous sulfate-7H₂O 65.0 g; Biotin 0.2 g; Sulfuric Acid 5.0 ml; add Water to a final volume of 1 liter. An illustrative composition for K. lactis defined medium (DMSor) is as follows: 11.83 g/L KH₂PO₄, 2.299 g/L K₂HPO₄, 20 g/L of a fermentable sugar, e.g., galactose, maltose, latotriose, sucrose, fructose or glucose and/or a sugar alcohol, for example, erythritol, hydrogenated starch hydrolysates, isomalt, lactitol, maltitol, mannitol, and xylitol, 1 g/L MgSO₄·7H₂O, 10 g/L (NH₄)₅O₄, 0.33 g/L CaCl₂·2H₂O, 1 g/L NaCl, 1 g/L KCl, 5 mg/L CuSO₄·5H₂O, 30 mg/L MnSO₄·H₂O, 10 mg/L, ZnCl₂, 1 mg/L KI, 2 mg/L CoCl₂·6H₂O, 8 mg/L Na₂MoO₄·2H₂O, 0.4 mg/L H₃BO₃·15 mg/L FeCl₃·6H₂O, 0.8 mg/L biotin, 20 mg/L Ca-pantothenate, 15 mg/L thiamine, 16 mg/L myo-inositol, 10 mg/L nicotinic acid, and 4 mg/L pyridoxine.

Peptide Degradation

Proteins, polypeptides, and peptides degrade in both biological samples and in solution (e.g., cell culture and/or during fermentation). Methods of detecting peptide degradation (e.g., degradation of a CRIP, a CRIP-insecticidal protein, or a peptide-IA) are well known in the art. Any of the well-known methods of detecting peptide degradation (e.g., during fermentation) may be employed here.

In some embodiments, peptide degradation can be detected using isotope labeling techniques; liquid chromatography/mass spectrometry (LC/MS); HPLC; radioactive amino acid incorporation and subsequent detection, e.g., via scintillation counting; the use of a reporter protein, e.g., a protein that can be detected (e.g., by fluorescence, spectroscopy, luminometry, etc.); fluorescent intensity of one or more bioluminescent proteins and/or fluorescent proteins and/or fusions thereof; pulse-chase analysis (e.g., pulse-labeling a cell with radioactive amino acids and following the decay of the labeled protein while chasing with unlabeled precursor, and arresting protein synthesis and measuring the decay of total protein levels with time); cycloheximide-chase assays;

In some embodiments, an assay can be used to detect peptide degradation, wherein a sample is contacted with a non-fluorescent compound that is operable to react with free primary amine in said sample produced via the degradation of a peptide, and which then produces a fluorescent signal that can be quantified and compared to a standard. Examples of non-fluorescent compounds that can be utilized as fluorescent tags for free amines according to the present disclosure are 3-(4-carboxybenzoyl) quinoline-2-carboxaldehyde (CBQCA), fluorescamine, and o-phthaldialdehyde.

In some embodiments, the method to determine the readout signal from the reporter protein depends from the nature of the reporter protein. For example, for fluorescent reporter proteins, the readout signal corresponds to the intensity of the fluorescent signal. The readout signal may be measured using spectroscopy-, fluorometry-, photometry-, and/or luminometry-based methods and detection systems, for example. Such methods and detection systems are well known in the art.

In some embodiments, standard immunological procedures known to those having ordinary skill in the art can be used to detect peptide degradation. For example, in some embodiments, peptide degradation can be detected in a sample using immunoassays that employ a detectable antibody. Such immunoassays include, for example, agglutination assays, ELISA, Pandex microfluorimetric assay, flow cytometry, serum diagnostic assays, and immunohistochemical staining procedures, all of which are well-known in the art. In some embodiments, the levels (e.g., of fluorescence) in one sample can be compared to a standard. An antibody can be made detectable by various means well known in the art. For example, a detectable marker can be directly or indirectly attached to the antibody. Useful markers include, for example, radionucleotides, enzymes, fluorogens, chromogens and chemiluminescent labels.

Exemplary methods of detecting peptide degradation is provided in U.S. Pat. Nos. 5,766,927; 7,504,253; 9,201,073; 9,429,566; United States Patent Application 20120028286; Eldeeb et al., A molecular toolbox for studying protein degradation in mammalian cells. J Neurochem. 2019 November; 151(4):520-533; and Buchanan et al., Cycloheximide Chase Analysis of Protein Degradation in Saccharomyces cerevisiae. J Vis Exp. 2016; (110): 53975, the disclosures of which are incorporated herein by reference in their entireties.
A
A
A
a

CRIP Incorporation into Plants or Parts Thereof

The CRIPs, CRIP-insecticidal proteins, and peptide-IAs described herein, and/or an insecticidal protein comprising at least one CRIP or peptide-IA as described herein, can be incorporated into plants, plant tissues, plant cells, plant seeds, and/or plant parts thereof, for either the stable, or transient expression of a CRIP, a CRIP-insecticidal protein, or a peptide-IA, and/or a polynucleotide sequence encoding the same.

In some embodiments, the CRIP or peptide-IA can be incorporated into a plant using recombinant techniques known in the art. In some embodiments, the CRIP or peptide-IA or insecticidal protein comprising at least one CRIP or peptide-IA may be in the form of an insecticidal protein which may comprise one or more CRIP or peptide-IA monomers. In other embodiments, the insecticidal protein comprising at least one CRIP or peptide-IA may also comprise one or more non-CRIP or non-IA polypeptides or proteins, e.g. an endoplasmic reticulum signal peptide operably linked to one or more CRIPs or peptide-IAs.

As used in this section, with respect to transgenic plants, plant tissues, plant cells, and plant seeds, the term “CRIP” or “peptide-IA” also encompasses an insecticidal protein comprising one or more CRIPs or peptide-IAs in addition to one or more non-CRIP or non-IA peptides, polypeptides or proteins, and a “CRIP polynucleotide” or “IA polynucleotide” is similarly also used to encompass a polynucleotide or group of polynucleotides operable to express and/or encode an insecticidal protein comprising one or more CRIPs or peptide-IAs in addition to one or more non-CRIP or non-IA polypeptides or proteins.

The goal of incorporating a CRIP, a CRIP-insecticidal protein, or a peptide-IA, into plants (i.e., to make transgenic plants that express CRIPs or peptide-IAs) is to deliver insecticidal proteins to the pest via the insect's consumption of the transgenic CRIP, CRIP-insecticidal protein, or peptide-IA expressed in a plant tissue consumed by the insect. Upon the consumption of the CRIP, CRIP-insecticidal protein, or peptide-IA by the insect from its food (e.g., an insect feeding upon a transgenic plant), the consumed CRIP, CRIP-insecticidal protein, or peptide-IA may have the ability to inhibit the growth, impair the movement, or even kill an insect. Accordingly, transgenic plants expressing a CRIP, a CRIP-insecticidal protein, or a peptide-IA polynucleotide and/or a CRIP, a CRIP-insecticidal protein, or a peptide-IA polypeptide may express said CRIP, CRIP-insecticidal protein, or peptide-IA polynucleotide/polypeptide in a variety of plant tissues, including but not limited to, the epidermis (e.g., mesophyll); periderm; phloem; xylem; parenchyma; collenchyma; sclerenchyma; and primary and secondary meristematic tissues. For example, in some embodiments, a polynucleotide sequence encoding a CRIP, a CRIP-insecticidal protein, or a peptide-IA can be operably linked to a regulatory region containing a phosphoenolpyruvate carboxylase promoter, resulting in the expression of a CRIP, a CRIP-insecticidal protein, or a peptide-IA in a plant's mesophyll tissue.

Transgenic plants expressing a CRIP, a CRIP-insecticidal protein, or a peptide-IA and/or a polynucleotide operable to express CRIP/peptide-IA can be generated by any one of the various methods and protocols well known to those having ordinary skill in the art; such methods of the invention do not require that a particular method for introducing a nucleotide construct to a plant be used, only that the nucleotide construct gains access to the interior of at least one cell of the plant. Methods for introducing nucleotide constructs into plants are known in the art including, but not limited to, stable transformation methods, transient transformation methods, and virus-mediated methods. “Transgenic plants” or “transformed plants” or “stably transformed” plants or cells or tissues refers to plants that have incorporated or integrated exogenous nucleic acid sequences or DNA fragments into the plant cell. These nucleic acid sequences include those that are exogenous, or not present in the untransformed plant cell, as well as those that may be endogenous, or present in the untransformed plant cell. “Heterologous” generally refers to the nucleic acid sequences that are not endogenous to the cell or part of the native genome in which they are present, and have been added to the cell by infection, transfection, microinjection, electroporation, microprojection, or the like.

Transformation of plant cells can be accomplished by one of several techniques known in the art. Typically, a construct that expresses an exogenous or heterologous peptide or polypeptide of interest (e.g., a CRIP, a CRIP-insecticidal protein, or a peptide-IA), would contain a promoter to drive transcription of the gene, as well as a 3′ untranslated region to allow transcription termination and polyadenylation. The design and organization of such constructs is well known in the art. In some embodiments, a gene can be engineered such that the resulting peptide is secreted, or otherwise targeted within the plant cell to a specific region and/or organelle. For example, the gene can be engineered to contain a signal peptide to facilitate transfer of the peptide to the endoplasmic reticulum. It may also be preferable to engineer the plant expression cassette to contain an intron, such that mRNA processing of the intron is required for expression.

Typically, a plant expression cassette can be inserted into a plant transformation vector. This plant transformation vector may be comprised of one or more DNA vectors needed for achieving plant transformation. For example, it is a common practice in the art to utilize plant transformation vectors that are comprised of more than one contiguous DNA segment. These vectors are often referred to in the art as “binary vectors.” Binary vectors as well as vectors with helper plasmids are most often used for Agrobacterium-mediated transformation, where the size and complexity of DNA segments needed to achieve efficient transformation is quite large, and it is advantageous to separate functions onto separate DNA molecules. Binary vectors typically contain a plasmid vector that contains the cis-acting sequences required for T-DNA transfer (such as left border and right border), a selectable marker that is engineered to be capable of expression in a plant cell, and a “gene of interest” (a gene engineered to be capable of expression in a plant cell for which generation of transgenic plants is desired). Also present on this plasmid vector are sequences required for bacterial replication. The cis-acting sequences are arranged in a fashion to allow efficient transfer into plant cells and expression therein. For example, the selectable marker gene and the CRIP/peptide-IA are located between the left and right borders. Often a second plasmid vector contains the trans-acting factors that mediate T-DNA transfer from Agrobacterium to plant cells. This plasmid often contains the virulence functions (Vir genes) that allow infection of plant cells by Agrobacterium, and transfer of DNA by cleavage at border sequences and vir-mediated DNA transfer, as is understood in the art (Hellens and Mullineaux (2000) Trends in Plant Science 5:446-451). Several types of Agrobacterium strains (e.g. LBA4404, GV3101, EHA101, EHA105, etc.) can be used for plant transformation. The second plasmid vector is not necessary for transforming the plants by other methods such as microprojection, microinjection, electroporation, polyethylene glycol, etc.

In general, plant transformation methods involve transferring heterologous DNA into target plant cells (e.g. immature or mature embryos, suspension cultures, undifferentiated callus, protoplasts, etc.), followed by applying a maximum threshold level of appropriate selection (depending on the selectable marker gene) to recover the transformed plant cells from a group of untransformed cell mass. Explants are typically transferred to a fresh supply of the same medium and cultured routinely. Subsequently, the transformed cells are differentiated into shoots after placing on regeneration medium supplemented with a maximum threshold level of selecting agent. The shoots are then transferred to a selective rooting medium for recovering rooted shoot or plantlet. The transgenic plantlet then grows into a mature plant and produces fertile seeds (e.g. Hiei et al. (1994) The Plant Journal 6:271-282; Ishida et al. (1996) Nature Biotechnology 14:745-750). Explants are typically transferred to a fresh supply of the same medium and cultured routinely. A general description of the techniques and methods for generating transgenic plants are found in Ayres and Park (1994) Critical Reviews in Plant Science 13:219-239 and Bommineni and Jauhar (1997) Maydica 42:107-120. Because the transformed material contains many cells, both transformed and non-transformed cells are present in any piece of subjected target callus or tissue or group of cells. The ability to kill non-transformed cells and allow transformed cells to proliferate results in transformed plant cultures. Often, the ability to remove non-transformed cells is a limitation to rapid recovery of transformed plant cells and successful generation of transgenic plants.

Transformation protocols as well as protocols for introducing nucleotide sequences into plants may vary depending on the type of plant or plant cell, i.e., monocot or dicot, targeted for transformation. Generation of transgenic plants may be performed by one of several methods, including, but not limited to, microinjection, electroporation, direct gene transfer, introduction of heterologous DNA by Agrobacterium into plant cells (Agrobacterium-mediated transformation), bombardment of plant cells with heterologous foreign DNA adhered to particles, ballistic particle acceleration, aerosol beam transformation, Lec1 transformation, and various other non-particle direct-mediated methods to transfer DNA. Exemplary transformation protocols are disclosed in U.S. Published Application No. 20010026941; U.S. Pat. No. 4,945,050; International Publication No. WO 91/00915; and

U.S. Published Application No. 2002015066, the disclosures of which are incorporated herein by reference in their entireties.

Chloroplasts can also be readily transformed, and methods concerning the transformation of chloroplasts are known in the art. See, for example, Svab et al. (1990) Proc. Natl. Acad. Sci. USA 87:8526-8530; Svab and Maliga (1993) Proc. Natl. Acad. Sci. USA 90:913-917; Svab and Maliga (1993) EMBO J. 12:601-606, the disclosure of which is incorporated herein by reference in its entirety. The method of chloroplast transformation relies on particle gun delivery of DNA containing a selectable marker and targeting of the DNA to the plastid genome through homologous recombination. Additionally, plastid transformation can be accomplished by transactivation of a silent plastid-borne transgene by tissue-preferred expression of a nuclear-encoded and plastid-directed RNA polymerase. Such a system has been reported in McBride et al. (1994) Proc. Natl. Acad. Sci. USA 91:7301-7305.

Following integration of heterologous foreign DNA into plant cells, one having ordinary skill may then apply a maximum threshold level of appropriate selection chemical/reagent (e.g., an antibiotic) in the medium to kill the untransformed cells, and separate and grow the putatively transformed cells that survive from this selection treatment by transferring said surviving cells regularly to a fresh medium. By continuous passage and challenge with appropriate selection, an artisan identifies and proliferates the cells that are transformed with the plasmid vector. Molecular and biochemical methods can then be used to confirm the presence of the integrated heterologous gene of interest into the genome of the transgenic plant.

The cells that have been transformed may be grown into plants in accordance with conventional methods known to those having ordinary skill in the art. See, for example, McCormick et al. (1986) Plant Cell Reports 5:81-84, the disclosure of which is incorporated herein by reference in its entirety. These plants may then be grown, and either pollinated with the same transformed strain or different strains, and the resulting hybrid having constitutive expression of the desired phenotypic characteristic identified. Two or more generations may be grown to ensure that expression of the desired phenotypic characteristic is stably maintained and inherited and then seeds harvested to ensure expression of the desired phenotypic characteristic has been achieved. In this manner, the present disclosure provides transformed seed (also referred to as “transgenic seed”) having a nucleotide construct of the invention, for example, an expression cassette of the invention, stably incorporated into their genome.

In various embodiments, the present disclosure provides an insecticidal protein comprising at least one CRIP/peptide-IA, that act as substrates for insect proteinases, proteases and peptidases (collectively referred to herein as “proteases”) as described above.

In some embodiments, transgenic plants or parts thereof, that may be receptive to the expression of CRIPs or peptide-IAs and/or compositions comprising a CRIP, a CRIP-insecticidal protein, or a peptide-IA, as described herein, can include: alfalfa, banana, barley, bean, broccoli, cabbage, canola, carrot, cassava, castor, cauliflower, celery, chickpea, Chinese cabbage, citrus, coconut, coffee, corn, clover, cotton, a cucurbit, cucumber, Douglas fir, eggplant, eucalyptus, flax, garlic, grape, hops, leek, lettuce, Loblolly pine, millets, melons, nut, oat, olive, onion, ornamental, palm, pasture grass, pea, peanut, pepper, pigeonpea, pine, potato, poplar, pumpkin, Radiata pine, radish, rapeseed, rice, rootstocks, rye, safflower, shrub, sorghum, Southern pine, soybean, spinach, squash, strawberry, sugar beet, sugarcane, sunflower, sweet corn, sweet gum, sweet potato, switchgrass, tea, tobacco, tomato, triticale, turf grass, watermelon, and a wheat plant. In some embodiments the transgenic plant may be grown from cells that were initially transformed with the DNA constructs described herein. In other embodiments, the transgenic plant may express the encoded CRIP/peptide-IA compositions in a specific tissue, or plant part, for example, a leaf, a stem a flower, a sepal, a fruit, a root, or a seed or combinations thereof.

Any of the foregoing plant incorporation methods/techniques can be used to produce a CRIP and/or peptide-IA (e.g., an Insecticidal Agent that lends itself to such methods, e.g., a polymer of amino acids, a peptide or a protein). For example, any of the foregoing methods can be used to produce, generate, make, express, transcribe, translate, synthesize or otherwise create, any of the CRIPs or peptide-IAs described herein, including, without limitation, ACTX peptides (e.g., U-ACTX-Hv1a, U+2-ACTX-Hv1a, rU-ACTX-Hv1a, rU-ACTX-Hv1b, rκ-ACTX-Hv1c, ω-ACTX-Hv1a, and/or ω-ACTX-Hv1a+2); F-CNTX-Pn1a; U1-agatoxin-Ta1b; TVPs; Av2; Av3; AVPs; and/or Bt toxins (e.g., Cry toxins, Cyt toxins, or Vips).

Proteins with Cleavable Linkers and Non-Cleavable Linkers

In some embodiments, the insecticidal protein comprising at least one CRIP (or peptide-IA) can be operably linked to a cleavable peptide. In other embodiments, the insecticidal protein comprising at least one CRIP (or peptide-IA) can be operably linked to a non-cleavable peptide.

In some embodiments, the insecticidal protein comprising at least one CRIP/peptide-IA can have two or more cleavable peptides, wherein the insecticidal protein comprises an insect cleavable linker (L), the insect cleavable linker being fused in frame with a construct comprising (CRIP-L)ₙ, wherein “n” is an integer ranging from 1 to 200, or from 1 to 100, or from 1 to 10. In another embodiment, the insecticidal protein comprising at least one CRIP, and described herein, comprises an endoplasmic reticulum signal peptide (ERSP) operably linked with a CRIP, which is operably linked with an insect cleavable linker (L) and/or a repeat construct (L-CRIP)ₙ or (CRIP-L)ₙ, wherein n is an integer ranging from 1 to 200, or from 1 to 100, or from 1 to 10.

In various embodiments, an exemplary insecticidal protein can include a protein construct comprising: (ERSP)-(CRIP-L)ₙ; (ERSP)-(L)-(CRIP-L)ₙ; (ERSP)-(L-CRIP)ₙ; (ERSP)-(L-CRIP)ₙ-(L); wherein n is an integer ranging from 1 to 200 or from 1 to 100, or from 1 to 10. In various related embodiments described above, a CRIP is the aforementioned U1-agatoxin-Ta1b Variant Polypeptides, L is a non-cleavable or cleavable peptide, and n is an integer ranging from 1 to 200, preferably an integer ranging from 1 to 100, and more preferably an integer ranging from 1 to 10. In some embodiments, the insecticidal protein may contain CRIP peptides that are the same or different, and insect cleavable peptides that are the same or different. In some embodiments, the C-terminal CRIP is operably linked at its C-terminus with a cleavable peptide that is operable to be cleaved in an insect gut environment. In some embodiments, the N-terminal CRIP is operably linked at its N-terminus with a cleavable peptide that is operable to be cleaved in an insect gut environment.

Some of the available proteases and peptidases found in the insect gut environment are dependent on the life-stage of the insect, as these enzymes are often spatially and temporally expressed. The digestive system of the insect is composed of the alimentary canal and associated glands. Food enters the mouth and is mixed with secretions that may or may not contain digestive proteases and peptidases. The foregut and the hind gut are ectodermal in origin. The foregut serves generally as a storage depot for raw food. From the foregut, discrete boluses of food pass into the midgut (mesenteron or ventriculus). The midgut is the site of digestion and absorption of food nutrients. Generally, the presence of certain proteases and peptidases in the midgut follow the pH of the gut. Certain proteases and peptidases in the human gastrointestinal system may include: pepsin, trypsin, chymotrypsin, elastase, carboxypeptidase, aminopeptidase, and dipeptidase.

The insect gut environment includes the regions of the digestive system in the herbivore species where peptides and proteins are degraded during digestion. Some of the available proteases and peptidases found in insect gut environments may include: (1) serine proteases; (2) cysteine proteases; (3) aspartic proteases, and (4) metalloproteases.

The two predominant protease classes in the digestive systems of phytophagous insects are the serine and cysteine proteases. Murdock et al. (1987) carried out an elaborate study of the midgut enzymes of various pests belonging to Coleoptera, while Srinivasan et al. (2008) have reported on the midgut enzymes of various pests belonging to Lepidoptera. Serine proteases are known to dominate the larval gut environment and contribute to about 95% of the total digestive activity in Lepidoptera, whereas the Coleopteran species have a wider range of dominant gut proteases, including cysteine proteases.

The papain family contains peptidases with a wide variety of activities, including endopeptidases with broad specificity (such as papain), endopeptidases with very narrow specificity (such as glycyl endopeptidases), aminopeptidases, dipeptidyl-peptidase, and peptidases with both endopeptidase and exopeptidase activities (such as cathepsins B and H). Other exemplary proteinases found in the midgut of various insects include trypsin-like enzymes, e.g. trypsin and chymotrypsin, pepsin, carboxypeptidase-B and aminotripeptidases.

Serine proteases are widely distributed in nearly all animals and microorganisms (Joanitti et al., 2006). In higher organisms, nearly 2% of genes code for these enzymes (Barrette-Ng et al., 2003). Being essentially indispensable to the maintenance and survival of their host organism, serine proteases play key roles in many biological processes. Serine proteases are classically categorized by their substrate specificity, notably by whether the residue at P1: trypsin-like (Lys/Arg preferred at P1), chymotrypsin-like (large hydrophobic residues such as Phe/Tyr/Leu at P1), or elastase-like (small hydrophobic residues such as Ala/Val at P1) (revised by Tyndall et. al., 2005). Serine proteases are a class of proteolytic enzymes whose central catalytic machinery is composed of three invariant residues, an aspartic acid, a histidine and a uniquely reactive serine, the latter giving rise to their name, the “catalytic triad”. The Asp-His-Ser triad can be found in at least four different structural contexts (Hedstrom, 2002). These four clans of serine proteases are typified by chymotrypsin, subtilisin, carboxypeptidase Y, and Clp protease. The three serine proteases of the chymotrypsin-like clan that have been studied in greatest detail are chymotrypsin, trypsin, and elastase. More recently, serine proteases with novel catalytic triads and dyads have been discovered for their roles in digestion, including Ser-His-Glu, Ser-Lys/His, His-Ser-His, and N-terminal Ser.

One class of well-studied digestive enzymes found in the gut environment of insects is the class of cysteine proteases. The term “cysteine protease” is intended to describe a protease that possesses a highly reactive thiol group of a cysteine residue at the catalytic site of the enzyme. There is evidence that many phytophagous insects and plant parasitic nematodes rely, at least in part, on midgut cysteine proteases for protein digestion. These include but are not limited to Hemiptera, especially squash bugs (Anasa tristis); green stink bug (Acrosternum hilare); Riptortus clavatus; and almost all Coleoptera examined to date, especially, Colorado potato beetle (Leptinotarsa deaemlineata); three-lined potato beetle (Lema trilineata); asparagus beetle (Crioceris asparagi); Mexican bean beetle (Epilachna varivestis); red flour beetle (Triolium castaneum); confused flour beetle (Tribolium confusum); the flea beetles (Chaetocnema spp., Haltica spp., and Epitrix spp.); corn rootworm (Diabrotica Spp.); cowpea weevil (Callosobruchus aculatue); boll weevil (Antonomus grandis); rice weevil (Sitophilus oryza); maize weevil (Sitophilus zeamais); granary weevil (Sitophilus granarius); Egyptian alfalfa weevil (Hypera postica); bean weevil (Acanthoseelides obtectus); lesser grain borer (Rhyzopertha dominica); yellow meal worm (Tenebrio molitor); Thysanoptera, especially, western flower thrips (Franklini ella occidentalis); Diptera, especially, leafminer spp. (Liriomyza trifolii); plant parasitic nematodes especially the potato cyst nematodes (Globodera spp.), the beet cyst nematode (Heterodera schachtii) and root knot nematodes (Meloidogyne spp.).

Another class of digestive enzymes is the aspartic proteases. The term “aspartic protease” is intended to describe a protease that possesses two highly reactive aspartic acid residues at the catalytic site of the enzyme and which is most often characterized by its specific inhibition with pepstatin, a low molecular weight inhibitor of nearly all known aspartic proteases. There is evidence that many phytophagous insects rely, in part, on midgut aspartic proteases for protein digestion most often in conjunction with cysteine proteases. These include but are not limited to Hemiptera especially (Rhodnius prolixus) and bedbug (Cimex spp.) and members of the families Phymatidae, Pentatomidae, Lygaeidae and Belostomatidae; Coleoptera, in the families of the Meloidae, Chrysomelidae, Coccinelidae and Bruchidae all belonging to the series Cucujiformia, especially, Colorado potato beetle (Leptinotarsa decemlineata) three-lined potato beetle (Lematri lineata); southern and western corn rootworm (Diabrotica undecimpunctata and D. virgifera), boll weevil (Anthonomus grandis), squash bug (Anasatristis); flea beetle (Phyllotreta crucifera), bruchid beetle (Callosobruchus maculatus), Mexican bean beetle (Epilachna varivestis), soybean leafminer (Odontota horni), margined blister beetle (Epicauta pestifera) and the red flour beetle (Triolium castaneum); Diptera, especially housefly (Musca domestica) (Terra and Ferreira (1994) Comn. Biochem. Physiol. 109B: 1-62; Wolfson and Murdock (1990) J. Chem. Ecol. 16: 1089-1102).

Polynucleotide Incorporation into Plants

A challenge regarding the expression of heterogeneous polypeptides in transgenic plants is maintaining the desired effect (e.g., insecticidal activity) of the introduced polypeptide upon expression in the host organism; one way to maintain such an effect is to increase the chance of proper protein folding through the use of an operably linked Endoplasmic Reticulum Signal Peptide (ERSP). Another method to maintain the effect of a transgenic protein is to incorporate a Translational Stabilizing Protein (STA).

Endoplasmic Reticulum Signal Peptide (ERSP)

The subcellular targeting of a recombinant protein to the ER can be achieved through the use of an ERSP operably linked to said recombinant protein; this allows for the correct assembly and/or folding of such proteins, and the high level accumulation of these recombinant proteins in plants. Exemplary methods concerning the compartmentalization of host proteins into intracellular storage are disclosed in McCormick et al., Proc. Natl. Acad. Sci. USA 96(2):703-708, 1999; Staub et al., Nature Biotechnology 18:333-338, 2000; Conrad et al., Plant Mol. Biol. 38:101-109, 1998; and Stoger et al., Plant Mol. Biol. 42:583-590, 2000, the disclosures of which are incorporated herein by reference in their entireties. Accordingly, one way to achieve the correct assembly and/or folding of recombinant proteins, is to operably link an endoplasmic reticulum signal peptide (ERSP) to the recombinant protein of interest.

In some embodiments, a peptide comprising an Endoplasmic Reticulum Signal Peptide (ERSP) can be operably linked to a CRIP (designated as ERSP-CRIP), wherein said ERSP is the N-terminal of said peptide, and where the ERSP peptide is between 3 to 60 amino acids in length, between 5 to 50 amino acids in length, between 20 to 30 amino acids in length and or where the peptide is BAAS, or tobacco extensin signal peptide, or a modified tobacco extensin signal peptide, or Jun a 3 signal peptide of Juniperus ashei. For example, in some embodiments, a plant can be transformed with a nucleotide that codes for any of the peptides that are described herein as Endoplasmic Reticulum Signal Peptides (ERSP) and/or a CRIP.

In some embodiments, a protein comprised of an Endoplasmic Reticulum Signal Peptide (ERSP) can be operably linked to a CRIP, operably linked to an intervening linker peptide (L or Linker), designated as ERSP-L-CRIP, or ERSP-CRIP-L, wherein said ERSP is the N-terminal of said protein, and said L or Linker may be either on the N-terminal side (upstream) of the CRIP or the C-terminal side (downstream) of the CRIP. A protein designated as ERSP-L-CRIP, or ERSP-CRIP-L, comprising any of the ERSPs or CRIPs described herein and wherein said L can be an uncleavable linker peptide, or a cleavable linker peptide, which may be cleavable in a plant cells during protein expression process or may be cleavable in an insect gut environments and hemolymph environments, and comprised of any of the intervening linker peptide (LINKER) described, or taught by this document including the following sequences: IGER (SEQ ID NO:31), EEKKN, (SEQ ID NO:32), and ETMFKHGL (SEQ ID NO:33).

In some embodiments, a protein comprising an Endoplasmic Reticulum Signal Peptide (ERSP) can be operably linked to a CRIP, which is in turn operably linked to a Translational Stabilizing Protein (STA). Here, this configuration is designated as ERSP-STA-CRIP or ERSP-CRIP-STA, wherein said ERSP is the N-terminal of said protein and said STA may be either on the N-terminal side (upstream) of the CRIP, or of the C-terminal side (downstream) of the CRIP. In some embodiments, a protein designated as ERSP-STA-CRIP or ERSP-CRIP-STA, comprising any of the ERSPs or CRIPs described herein, can be operably linked to a STA, for example, any of the translational stabilizing proteins described, or taught by this document including GFP (Green Fluorescent Protein; SEQ ID NO:34; NCBI Accession No. P42212), or Jun a 3, (Juniperus ashei; SEQ ID NO:36; NCBI Accession No. P81295.1).

Plants can be transiently or stably transfected with the DNA sequence that encodes a CRIP or an insecticidal protein comprising one or more CRIPs and one or more non-CRIP peptides, polypeptides or proteins, for example, using anyone of the transfection methods described above; alternatively, plants can be transfected with a polynucleotide that encodes a CRIP operably linked to an ERSP, LINKER, and/or a STA protein encoding polynucleotide. For example, in some embodiments, a transgenic plant or plant genome can be transfected to incorporate the polynucleotide sequence that encodes the Endoplasmic Reticulum Signal Peptide (ERSP); CRIP; and/or intervening linker peptide (LINKER, L), thus causing mRNA transcribed from the heterogeneous DNA to be expressed in the transformed plant.

The present disclosure may be used for transformation of any plant species, including, but not limited to, monocots and dicots. Crops for which a transgenic approach or PEP would be an especially useful approach include, but are not limited to: alfalfa, cotton, tomato, maize, wheat, corn, sweet corn, lucerne, soybean, sorghum, field pea, linseed, safflower, rapeseed, oil seed rape, rice, soybean, barley, sunflower, trees (including coniferous and deciduous), flowers (including those grown commercially and in greenhouses), field lupins, switchgrass, sugarcane, potatoes, tomatoes, tobacco, crucifers, peppers, sugarbeet, barley, and oilseed rape, Brassica sp., rye, millet, peanuts, sweet potato, cassaya, coffee, coconut, pineapple, citrus trees, cocoa, tea, banana, avocado, fig, guava, mango, olive, papaya, cashew, macadamia, almond, oats, vegetables, ornamentals, and conifers.

In some embodiments, the CRIP expression open reading frame (ORF) described herein is a polynucleotide sequence that will enable the plant to express mRNA, which in turn will be translated into peptides be expressed, folded properly, and/or accumulated to such an extent that said proteins provide a dose sufficient to inhibit and/or kill one or more pests. In one embodiment, an example of a protein CRIP expression ORF can be a cysteine rich insecticidal protein (crip), an “ersp” (i.e., the polynucleotide sequence that encodes the ERSP polypeptide) a “linker” (i.e., the polynucleotide sequence that encodes the LINKER polypeptide), a “sta” (i.e., the polynucleotide sequence that encodes the STA polypeptide), or any combination thereof, and can be described in the following equation format:

ersp-sta-(linkerᵢ−cripⱼ)ₙ, or ersp-(cripⱼ-linkerᵢ)ₙ-sta

The foregoing illustrative embodiment of a polynucleotide equation would result in the following protein complex being expressed: ERSP-STA-(LINKER_{I}-CRIP_{J})_{N}, containing four possible peptide components with dash signs to separate each component. The nucleotide component of ersp is a polynucleotide segment encoding a plant endoplasmic reticulum trafficking signal peptide (ERSP). The component of sta is a polynucleotide segment encoding a translation stabilizing protein (STA), which helps the accumulation of the CRIP expressed in plants, however, in some embodiments, the inclusion of sta may not be necessary in the CRIP expression ORF. The component of linkerᵢ is a polynucleotide segment encoding an intervening linker peptide (L OR LINKER) to separate the CRIP from other components contained in ORF, and from the translation stabilizing protein. The subscript letter “i” indicates that in some embodiments, different types of linker peptides can be used in the CRIP expression ORF. The component “crip” indicates the polynucleotide segment encoding the CRIP. The subscript “j” indicates different CRIP polynucleotides may be included in the CRIP expression ORF. For example, in some embodiments, the CRIP polynucleotide sequence can encode a CRIP with an amino acid substitution, or an amino acid deletion. The subscript “n” as shown in “(linkerᵢ−cripⱼ)ₙ” indicates that the structure of the nucleotide encoding an intervening linker peptide and a CRIP can be repeated “n” times in the same open reading frame in the same CRIP expression ORF, where “n” can be any integrate number from 1 to 10; “n” can be from 1 to 10, specifically “n” can be 1, 2, 3, 4, or 5, and in some embodiments “n” is 6, 7, 8, 9 or 10. The repeats may contain polynucleotide segments encoding different intervening linkers (LINKER) and different CRIPs. The different polynucleotide segments including the repeats within the same CRIP expression ORF are all within the same translation frame. In some embodiments, the inclusion of a sta polynucleotide in the CRIP expression ORF may not be required. For example, an ersp polynucleotide sequence can be directly be linked to the polynucleotide encoding a CRIP variant polynucleotide without a linker.

In the foregoing exemplary equation, the polynucleotide “crip” encoding the polypeptide “CRIP” can be the polynucleotide sequence that encodes any CRIP as described herein. For example, in some embodiments, the “crip” polynucleotide can encode a CRIP including, but not limited to, ACTX peptides (e.g., U-ACTX-Hv1a, U+2-ACTX-Hv1a, rU-ACTX-Hv1a, rU-ACTX-Hv1b, rκ-ACTX-Hv1c, ω-ACTX-Hv1a, and/or ω-ACTX-Hv1a+2); Γ-CNTX-Pn1a; U1-agatoxin-Ta1b; TVPs; Av2; Av3; or AVPs. In addition, the foregoing equation can also be used to encode a peptide-IA (e.g., an Insecticidal Agent that lends itself to such methods, e.g., a polymer of amino acids, a peptide or a protein) such as Bt toxins (e.g., Cry toxins, Cyt toxins, or Vips).

In the foregoing exemplary equation, the polynucleotide “crip” encoding the polypeptide “CRIP” can be the polynucleotide sequence that encodes any CRIP as described herein, e.g., a CRIP comprising an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to: a spider peptide having an amino acid sequence as set forth in any one of SEQ ID NOs: 192-370; an ACTX peptide (e.g., U-ACTX-Hv1a, U+2-ACTX-Hv1a, rU-ACTX-Hv1a, rU-ACTX-Hv1b, K-ACTX-Hv1a, κ+2-ACTX-Hv1a, ω-ACTX-Hv1a, and/or ω+2-ACTX-Hv1a) having an amino acid sequence as set forth in any one of SEQ ID NOs: 60-64, 192-370 and 594; an Γ-CNTX-Pn1a having an amino acid sequence as set forth in any one of SEQ ID NO: 65; a U1-agatoxin-Ta1b peptide having an amino acid sequence as set forth in SEQ ID NO: 1; a U1-agatoxin-Ta1b Variant Polypeptide (TVP) having an amino acid sequence as set forth in any one of SEQ ID NOs: 2-15, 49-53, 2-15, 49-53, 621-622, 624-628, 631-640, 642-651, or 653-654; a scorpion peptide having an amino acid sequence as set forth in any one of SEQ ID NOs: 66, 88-191; a sea anemone peptide having an amino acid sequence as set forth in any one of SEQ ID NOs: 371-411; an Av3 polypeptide from Anemonia viridis having an amino acid sequence as set forth in SEQ ID NO:44; an Av3 variant polypeptide (AVP) having an amino acid sequence as set forth in any one of SEQ ID NOs: 45-47; or a conotoxin.

In some embodiments, a CRIP ORF starts with an ersp at its 5′-end. For the CRIP to be properly folded and functional when it is expressed from a transgenic plant, it must have an ersp nucleotide fused in frame with the polynucleotide encoding a CRIP. During the cellular translation process, translated ERSP can direct the CRIP being translated to insert into the Endoplasmic Reticulum (ER) of the plant cell by binding with a cellular component called a signal-recognition particle. Within the ER the ERSP peptide is cleaved by signal peptidase and the CRIP is released into the ER, where the CRIP is properly folded during the post-translation modification process, for example, the formation of disulfide bonds. Without any additional retention protein signals, the protein is transported through the ER to the Golgi apparatus, where it is finally secreted outside the plasma membrane and into the apoplastic space. CRIP can accumulate at apoplastic space efficiently to reach the insecticidal dose in plants.

The ERSP peptide is at the N-terminal region of the plant-translated CRIP complex and the ERSP portion is composed of about 3 to 60 amino acids. In some embodiments it is 5 to 50 amino acids. In some embodiments it is 10 to 40 amino acids but most often is composed of 15 to 20; 20 to 25; or 25 to 30 amino acids. The ERSP is a signal peptide so called because it directs the transportation of a protein. Signal peptides may also be called targeting signals, signal sequences, transit peptides, or localization signals. The signal peptides for ER trafficking are often 15 to 30 amino acid residues in length and have a tripartite organization, comprised of a core of hydrophobic residues flanked by a positively charged amino terminal and a polar, but uncharged carboxyterminal region. (Zimmermann, et al, “Protein translocation across the ER membrane,” Biochimica et Biohysica Acta, 2011, 1808: 912-924).

Many ERSPs are known. It is NOT required that the ERSP be derived from a plant ERSP, non-plant ERSPs will work with the procedures described herein. Many plant ERSPs are however well known and we describe some plant derived ERSPs here. BAAS, for example, is derived from the plant, Hordeum vulgare, and has the amino acid sequence as follows: MANKHLSLSLFLVLLGLSASLASG (SEQ ID NO:37)

Plant ERSPs, which are selected from the genomic sequence for proteins that are known to be expressed and released into the apoplastic space of plants, include examples such as BAAS, carrot extensin, and tobacco PR1. The following references provide further descriptions, and are incorporated by reference herein in their entirety. De Loose, M. et al. “The extensin signal peptide allows secretion of a heterologous protein from protoplasts” Gene, 99 (1991) 95-100; De Loose, M. et al. described the structural analysis of an extension—encoding gene from Nicotiana plumbaginifolia, the sequence of which contains a typical signal peptide for translocation of the protein to the endoplasmic reticulum; Chen, M. H. et al. “Signal peptide-dependent targeting of a rice alpha-amylase and cargo proteins to plastids and extracellular compartments of plant cells” Plant Physiology, 2004 July; 135(3): 1367-77. Epub 2004 Jul. 2. Chen, M. H. et al. studied the subcellular localization of α-amylases in plant cells by analyzing the expression of α-amylase, with and without its signal peptide, in transgenic tobacco. These references and others teach and disclose the signal peptide that can be used in the methods, procedures and peptide, protein and nucleotide complexes and constructs described herein.

The tobacco extensin signal peptide motif is an ERSP (Memelink et al, the Plant Journal, 1993, V4: 1011-1022; see also Pogue G P et al, Plant Biotechnology Journal, 2010, V8: 638-654). In some embodiments, a CRIP ORF can have a tobacco extensin signal peptide motif. In one embodiment, the CRIP ORF can have an extensin motif according to SEQ ID NO:38. In another embodiment, the CRIP ORF can have an extensin motif according to SEQ ID NO:39.

An illustrative example of how to generate an embodiment with an extensin signal motif is as follows: A DNA sequence encoding an extensin motif is designed (for example, the DNA sequence shown in SEQ ID NO:40 or SEQ ID NO:41) using oligo extension PCR with four synthetic DNA primers; ends sites such as a restriction site, for example, a Pac I restriction site at the 5′-end, and a 5′-end of a GFP sequence at the 3′-end, can be added using PCR with the extensin DNA sequence serving as a template, and resulting in a fragment; the fragment is used as the forward PCR primer to amplify the DNA sequence encoding a CRIP ORF, for example “gfp-l-CRIP” contained in a pFECT vector, thus producing a CRIP ORF encoding (from N′ to C′ terminal) “ERSP-GFP-L-CRIP” wherein the ERSP is extensin. The resulting DNA sequence can then be cloned into Pac I and Avr II restriction sites of a FECT vector to generate the pFECT-CRIP vector for transient plant expression of GFP fused CRIP.

In some embodiments, an illustrative expression system can include the FECT expression vectors containing CRIP ORF is transformed into Agrobacterium, GV3101, and the transformed GV3101 is injected into tobacco leaves for transient expression of CRIP ORF.

Translational Stabilizing Protein (STA)

A Translational stabilizing protein (STA) can increase the amount of CRIP in plant tissues. One of the CRIP ORFs, ERSP-CRIP, is sufficient to express a properly folded CRIP in the transfected plant, but in some embodiments, effective protection of a plant from pest damage may require that the plant expressed CRIP accumulate. With transfection of a properly constructed CRIP ORF, a transgenic plant can express and accumulate greater amounts of the correctly folded CRIP. When a plant accumulates greater amounts of properly folded CRIP, it can more easily resist, inhibit, and/or kill the pests that attack and eat the plants. One method of increasing the accumulation of a polypeptide in transgenic tissues is through the use of a translational stabilizing protein (STA). The translational stabilizing protein can be used to significantly increase the accumulation of CRIP in plant tissue, and thus increase the efficacy of a plant transfected with CRIP with regard to pest resistance. The translational stabilizing protein is a protein with sufficient tertiary structure that it can accumulate in a cell without being targeted by the cellular process of protein degradation. The following equation describes one of the examples of an CRIP ORF that encodes a stabilizing protein fused with U1-agatoxin-Ta1b Variant polynucleotide sequence:

ersp-sta-l-crip or ersp-crip-l-sta

In some embodiments, the translational stabilizing protein can be a domain of another protein, or it can comprise an entire protein sequence. In some embodiments, the translational stabilizing protein can be between 5 and 50 amino acids, 50 to 250 amino acids (e.g., GNA), 250 to 750 amino acids (e.g., chitinase) and 750 to 1500 amino acids (e.g., enhancin).

The protein, or protein domain can contain proteins that have no useful characteristics other than translation stabilization, or they can have other useful traits in addition to translational stabilization. One embodiment of the translational stabilizing protein can be a polymer of fusion proteins involving CRIP. A specific example of a translational stabilizing protein is provided here to illustrate the use of a translational stabilizing protein. The example is not intended to limit the disclosure or claims in any way. Useful translational stabilizing proteins are well known in the art, and any proteins of this type could be used as disclosed herein. Procedures for evaluating and testing production of peptides are both known in the art and described herein. One example of one translational stabilizing protein is Green-Fluorescent Protein (GFP) (SEQ ID NO:34; NCBI Accession No. P42212.1).

Additional examples of translational stabilizing proteins can be found in the following references, the disclosures of which are incorporated by reference in their entirety: Kramer, K. J. et al. “Sequence of a cDNA and expression of the gene encoding epidermal and gut chitinases of Manduca sexta” Insect Biochemistry and Molecular Biology, Vol. 23, Issue 6, September 1993, pp. 691-701. Kramer, K. J. et al. isolated and sequenced a chitinase-encoding cDNA from the tobacco hornworm, Manduca sexta. Hashimoto, Y. et al. “Location and nucleotide sequence of the gene encoding the viral enhancing factor of the Trichoplusia ni granulosis virus” Journal of General Virology, (1991), 72, 2645-2651. Hashimoto, Y. et al. cloned the gene encoding the viral enhancing factor of a Trichoplusia ni granulosis virus and determined the complete nucleotide sequence. These references and others teach and disclose translational stabilizing proteins that can be used in the methods, procedures and peptide, protein and nucleotide complexes and constructs described herein.

In some embodiments, a CRIP ORF can be transformed into a plant, for example, in the tobacco plant, Nicotiana benthamiana, using a CRIP ORF that contains a STA, for example Jun a 3. The mature Jun a 3 is a ˜30 kDa plant defending protein that is also an allergen for some people. Jun a 3 is produced by Juniperus ashei trees and can be used in some embodiments as a translational stabilizing protein (STA). In some embodiments, the Jun a 3 amino acid sequence can be the sequence shown in SEQ ID NO:36. In other embodiments, the Jun a 3 amino acid sequence can be the sequence shown in SEQ ID NO:42.

Linkers

Linker proteins assist in the proper folding of the different motifs composing a CRIP ORF. The CRIP ORF described in this invention also incorporates polynucleotide sequences encoding intervening linker peptides between the polynucleotide sequences encoding the CRIP (crip) and the translational stabilizing protein (sta), or between polynucleotide sequence encoding multiple polynucleotide sequences encoding CRIP, i.e., (l-crip)_{N} or (crip-l)_{N}, if the expression ORF involves multiple CRIP domain expression. The intervening linker peptides (LINKERS or L) separate the different parts of the expressed CRIP complex and help proper folding of the different parts of the complex during the expression process. In the expressed CRIP complex, different intervening linker peptides can be involved to separate different functional domains. In some embodiments, the LINKER is attached to a CRIP and this bivalent group can be repeated up to 10 (N=1-10) and possibly even more than 10 times in order to facilitate the accumulation of properly folded CRIP in the plant that is to be protected.

In some embodiments the intervening linker peptide can be between 1 and 30 amino acids in length. However, it is not necessarily an essential component in the expressed CRIP in plants. A cleavable linker peptide can be designed to the CRIP ORF to release the properly CRIP from the expressed CRIP complex in the transformed plant to improve the protection the CRIP affords the plant with regard to pest damage. One type of the intervening linker peptide is the plant cleavable linker peptide. This type of linker peptides can be completely removed from the expressed CRIP ORF complex during plant post-translational modification. Therefore, in some embodiments, the properly folded CRIP linked by this type of intervening linker peptides can be released in the plant cells from the expressed CRIP ORF complex during post-translational modification in the plant.

Another type of the cleavable intervening linker peptide is not cleavable during the expression process in plants. However, it has a protease cleavage site specific to serine, threonine, cysteine, aspartate proteases or metalloproteases. The type of cleavable linker peptide can be digested by proteases found in the insect and lepidopteran gut environment and/or the insect hemolymph and lepidopteran hemolymph environment to release the CRIP in the insect gut or hemolymph. Using the information taught by this disclosure it should be a matter of routine for one skilled in the art to make or find other examples of LINKERS that will be useful in this invention.

In some embodiments, the CRIP ORF can contain a cleavable type of intervening linker, for example, the type listed in SEQ ID NO:31, having the amino acid code of “IGER” (SEQ ID NO:31). The molecular weight of this intervening linker or LINKER is 473.53 Daltons. In other embodiments, the intervening linker peptide (LINKER) can also be one without any type of protease cleavage site, i.e. an uncleavable intervening linker peptide, for example, the linker “ETMFKHGL” (SEQ ID NO:33).

In some embodiments, the CRIP-insecticidal protein can have two or more cleavable peptides, wherein the insecticidal protein comprises an insect cleavable linker (L), the insect cleavable linker being fused in frame with a construct comprising (CRIP-L)ₙ, wherein “n” is an integer ranging from 1 to 200, or from 1 to 100, or from 1 to 10. In another embodiment, the CRIP-insecticidal protein, and described herein, comprises an endoplasmic reticulum signal peptide (ERSP) operably linked with a CRIP, which is operably linked with an insect cleavable linker (L) and/or a repeat construct (L-CRIP)ₙ or (CRIP-L)ₙ, wherein n is an integer ranging from 1 to 200, or from 1 to 100, or from 1 to 10.

In some embodiments, a protein comprising an Endoplasmic Reticulum Signal Peptide (ERSP) can be operably linked to a CRIP and an intervening linker peptide (L or Linker); such a construct is designated as ERSP-L-CRIP, or ERSP-CRIP-L, wherein said ERSP is the N-terminal of said protein, and said L or Linker may be either on the N-terminal side (upstream) of the CRIP, or the C-terminal side (downstream) of the CRIP. A protein designated as ERSP-L-CRIP, or ERSP-CRIP-L, comprising any of the ERSPs or CRIPs described herein, can have a Linker “L” that can be an uncleavable linker peptide, or a cleavable linker peptide, and which may be cleavable in a plant cells during protein expression process, or may be cleavable in an insect gut environment and/or hemolymph environment.

An exemplary description of the foregoing linkers, and methods of making and using the same, are provided in U.S. Patent Application Publication No. US20180362598A1, the disclosure of which is incorporated herein by reference in its entirety.

Other examples of intervening linker peptides can be found in the following references, which are incorporated by reference herein in their entirety: A plant expressed serine proteinase inhibitor precursor was found to contain five homogeneous protein inhibitors separated by six same linker peptides in Heath et al. “Characterization of the protease processing sites in a multidomain proteinase inhibitor precursor from Nicotiana alata” European Journal of Biochemistry, 1995; 230: 250-257. A comparison of the folding behavior of green fluorescent proteins through six different linkers is explored in Chang, H. C. et al. “De novo folding of GFP fusion proteins: high efficiency in eukaryotes but not in bacteria” Journal of Molecular Biology, 2005 Oct. 21; 353(2): 397-409. An isoform of the human GalNAc-Ts family, GalNAc-T2, was shown to retain its localization and functionality upon expression in N. benthamiana plants by Daskalova, S. M. et al. “Engineering of N. benthamiana L. plants for production of N-acetylgalactosamine-glycosylated proteins” BMC Biotechnology, 2010 Aug. 24; 10: 62. The ability of endogenous plastid proteins to travel through stromules was shown in Kwok, E. Y. et al. “GFP-labelled Rubisco and aspartate aminotransferase are present in plastid stromules and traffic between plastids” Journal of Experimental Botany, 2004 March; 55(397): 595-604. Epub 2004 Jan. 30. A report on the engineering of the surface of the tobacco mosaic virus (TMV), virion, with a mosquito decapeptide hormone, trypsin-modulating oostatic factor (TMOF) was made by Borovsky, D. et al. “Expression of Aedes trypsin-modulating oostatic factor on the virion of TMV: A potential larvicide” Proc Natl Acad Sci, 2006 Dec. 12; 103(50): 18963-18968. These references and others teach and disclose the intervening linkers that can be used in the methods, procedures and peptide, protein and nucleotide complexes and constructs described herein.

The CRIP ORF and CRIP constructs

“CRIP ORF” refers to a nucleotide encoding a CRIP, and/or one or more stabilizing proteins, secretory signals, or target directing signals, for example, ERSP or STA, and is defined as the nucleotides in the ORF that has the ability to be translated. Thus, a “CRIP ORF diagram” refers to the composition of one or more CRIP ORFs, as written out in diagram or equation form. For example, a “CRIP ORF diagram” can be written out as using acronyms or short-hand references to the DNA segments contained within the expression ORF. Accordingly, in one example, a “CRIP ORF diagram” may describe the polynucleotide segments encoding the ERSP, LINKER, STA, and CRIP, by diagramming in equation form the DNA segments as “ersp” (i.e., the polynucleotide sequence that encodes the ERSP polypeptide); “linker” or “L” (i.e., the polynucleotide sequence that encodes the LINKER polypeptide); “sta” (i.e., the polynucleotide sequence that encodes the STA polypeptide), and “crip” (i.e., the polynucleotide sequence encoding a CRIP), respectively. An example of a CRIP ORF diagram is “ersp-sta-(linkerᵢ−cripⱼ)_{N},” or “ersp-(cripⱼ-linkerᵢ)_{N}-sta” and/or any combination of the DNA segments thereof.

The following equations describe two examples of a CRIP ORF that encodes an ERSP, a STA, a linker, and a CRIP:

ersp-sta-l-crip or ersp-crip-l-sta

In some embodiments, the CRIP open reading frame (ORF) described herein is a polynucleotide sequence that will enable the plant to express mRNA, which in turn will be translated into peptides that will folded properly, and/or accumulated to such an extent that said proteins provide a dose sufficient to inhibit and/or kill one or more pests. In one embodiment, an example of a protein CRIP ORF can be a polynucleotide encoding a CRIP (crip), an “ersp” (i.e., the polynucleotide sequence that encodes the ERSP polypeptide) a “linker” (i.e., the polynucleotide sequence that encodes the LINKER polypeptide), a “sta” (i.e., the polynucleotide sequence that encodes the STA polypeptide), or any combination thereof, and can be described in the following equation format:

ersp-sta-(linkerᵢ−cripⱼ)ₙ, or ersp-(cripⱼ-linkerᵢ)ₙ-sta

The foregoing illustrative embodiment of a polynucleotide equation would result in the following protein complex being expressed: ERSP-STA-(LINKER_{I}-CRIP_{J})_{N}, containing four possible peptide components with dash signs to separate each component. The nucleotide component of ersp is a polynucleotide segment encoding a plant endoplasmic reticulum trafficking signal peptide (ERSP). The component of sta is a polynucleotide segment encoding a translation stabilizing protein (STA), which helps the accumulation of the CRIP expressed in plants, however, in some embodiments, the inclusion of sta may not be necessary in the CRIP ORF. The component of linkerᵢ is a polynucleotide segment encoding an intervening linker peptide (L OR LINKER) to separate the CRIP from other components contained in ORF, and from the translation stabilizing protein. The subscript letter “i” indicates that in some embodiments, different types of linker peptides can be used in the CRIP ORF. The component “crip” indicates the polynucleotide segment encoding the CRIP. The subscript “j” indicates different polynucleotides may be included in the CRIP ORF. For example, in some embodiments, the polynucleotide sequence can encode a CRIP with a different amino acid substitution. The subscript “n” as shown in “(linkerᵢ-cripⱼ)ₙ” indicates that the structure of the nucleotide encoding an intervening linker peptide and a CRIP can be repeated “n” times in the same open reading frame in the same CRIP ORF, where “n” can be any integrate number from 1 to 10; “n” can be from 1 to 10, specifically “n” can be 1, 2, 3, 4, or 5, and in some embodiments “n” is 6, 7, 8, 9 or 10. The repeats may contain polynucleotide segments encoding different intervening linkers (LINKER) and different CRIPs. The different polynucleotide segments including the repeats within the same CRIP ORF are all within the same translation frame. In some embodiments, the inclusion of a sta polynucleotide in the CRIP ORF may not be required. For example, an ersp polynucleotide sequence can be directly be linked to the polynucleotide encoding a CRIP variant polynucleotide without a linker.

In the foregoing exemplary equation, the polynucleotide “crip” encoding the polypeptide “CRIP” can be the polynucleotide sequence that encodes any CRIP as described herein, e.g., a CRIP comprising an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to a spider peptide having an amino acid sequence as set forth in any one of SEQ ID NOs: 192-370; an ACTX peptide (e.g., U-ACTX-Hv1a, U+2-ACTX-Hv1a, rU-ACTX-Hv1a, rU-ACTX-Hv1b, κ-ACTX-Hv1a, κ+2-ACTX-Hv1a, ω-ACTX-Hv1a, and/or ω+2-ACTX-Hv1a) having an amino acid sequence as set forth in any one of SEQ ID NOs: 60-64, 192-370 and 594; an Γ-CNTX-Pn1a having an amino acid sequence as set forth in any one of SEQ ID NO: 65; a U1-agatoxin-Ta1b peptide having an amino acid sequence as set forth in SEQ ID NO: 1; a U1-agatoxin-Ta1b Variant Polypeptide (TVP) having an amino acid sequence as set forth in any one of SEQ ID NOs: 2-15, 49-53, 2-15, 49-53, 621-622, 624-628, 631-640, 642-651, or 653-654; a scorpion peptide having an amino acid sequence as set forth in any one of SEQ ID NOs: 66, 88-191; a sea anemone peptide having an amino acid sequence as set forth in any one of SEQ ID NOs: 371-411; an Av3 polypeptide from Anemonia viridis having an amino acid sequence as set forth in SEQ ID NO:44; an Av3 variant polypeptide (AVP) having an amino acid sequence as set forth in any one of SEQ ID NOs: 45-47; or a conotoxin.

In some embodiments, a polynucleotide is operable to encode a CRIP-insecticidal protein having the following CRIP construct orientation and/or arrangement: ERSP-CRIP; ERSP-(CRIP)_{N}; ERSP-CRIP-L; ERSP-(CRIP)_{N}-L; ERSP-(CRIP-L)_{N}; ERSP-L-CRIP; ERSP-L-(CRIP)_{N}; ERSP-(L-CRIP)_{N}; ERSP-STA-CRIP; ERSP-STA-(CRIP)_{N}; ERSP-CRIP-STA; ERSP-(CRIP)_{N}-STA; ERSP-(STA-CRIP)_{N}; ERSP-(CRIP-STA)_{N}; ERSP-L-CRIP-STA; ERSP-L-STA-CRIP; ERSP-L-(CRIP-STA)_{N}; ERSP-L-(STA-CRIP)_{N}; ERSP-L-(CRIP)_{N}-STA; ERSP-(L-CRIP)_{N}-STA; ERSP-(L-STA-CRIP)_{N}; ERSP-(L-CRIP-STA)_{N}; ERSP-(L-STA)_{N}-CRIP; ERSP-(L-CRIP)_{N}-STA; ERSP-STA-L-CRIP; ERSP-STA-CRIP-L; ERSP-STA-L-(CRIP)_{N}; ERSP-(STA-L)_{N}-CRIP; ERSP-STA-(L-CRIP)_{N}; ERSP-(STA-L-CRIP)_{N}; ERSP-STA-(CRIP)_{N}-L; ERSP-STA-(CRIP-L)_{N}; ERSP-(STA-CRIP)_{N}-L; ERSP-(STA-CRIP-L)_{N}; ERSP-CRIP-L-STA; ERSP-CRIP-STA-L; ERSP-(CRIP)_{N}-STA-L ERSP-(CRIP-L)_{N}-STA; ERSP-(CRIP-STA)_{N}-L; ERSP-(CRIP-L-STA)_{N}; or ERSP-(CRIP-STA-L)_{N}; wherein N is an integer ranging from 1 to 200.

In some embodiments, any of the CRIP ORFs and/or CRIP constructs described herein can be produced recombinantly, e.g., in some embodiments, any of the CRIP ORFs and/or CRIP constructs described herein can be produced in cell culture, e.g., by a yeast cell.

Any of the aforementioned methods, and/or any of the methods described herein, can be used to incorporate into a plant or a plant part thereof, one or more polynucleotides operable to express any one or more of the CRIPs or CRIP-insecticidal proteins as described herein; e.g., one or more CRIPs or CRIP-insecticidal protein having the amino acid sequence of SEQ ID NOs: 2-15, 49-53, or 77-110, which are likewise described herein.

The present disclosure may be used for transformation of any plant species, including, but not limited to, monocots and dicots. Crops for which a transgenic approach or PEP would be an especially useful approach include, but are not limited to: alfalfa, cotton, tomato, maize, wheat, corn, sweet corn, lucerne, soybean, sorghum, field pea, linseed, safflower, rapeseed, oil seed rape, rice, soybean, barley, sunflower, trees (including coniferous and deciduous), flowers (including those grown commercially and in greenhouses), field lupins, switchgrass, sugarcane, potatoes, tomatoes, tobacco, crucifers, peppers, sugarbeet, barley, and oilseed rape, Brassica sp., rye, millet, peanuts, sweet potato, cassaya, coffee, coconut, pineapple, citrus trees, cocoa, tea, banana, avocado, fig, guava, mango, olive, papaya, cashew, macadamia, almond, oats, vegetables, ornamentals, and conifers.

Transforming Plants with Polynucleotides

In some embodiments, the CRIP ORFs and CRIP constructs described above and herein can be cloned into any plant expression vector for the CRIP to be expression in plants, either transiently or stably.

Transient plant expression systems can be used to promptly optimize the structure of the CRIP ORF for some specific CRIP expression in plants, including the necessity of some components, codon optimization of some components, optimization of the order of each component, etc. A transient plant expression vector is often derived from a plant virus genome. Plant virus vectors provide advantages in quick and high level of foreign gene expression in plant due to the infection nature of plant viruses. The full length of the plant viral genome can be used as a vector, but often a viral component is deleted, for example the coat protein, and transgenic ORFs are subcloned in that place. The CRIP ORF can be subcloned into such a site to create a viral vector. These viral vectors can be introduced into plant mechanically since they are infectious themselves, for example through plant wound, spray-on etc. They can also be transfected into plants via agroinfection, by cloning the virus vector into the T-DNA of the crown gall bacterium, Agrobacterium tumefaciens, or the hairy root bacterium, Agrobacterium rhizogenes. The expression of the CRIP in this vector is controlled by the replication of the RNA virus, and the virus translation to mRNA for replication is controlled by a strong viral promoter, for example, 35S promoter from Cauliflower mosaic virus. Viral vectors with CRIP ORF are usually cloned into T-DNA region in a binary vector that can replicate itself in both E. coli strains and Agrobacterium strains. The transient transfection of a plant can be done by infiltration of the plant leaves with the Agrobacterium cells which contain the viral vector for CRIP expression. In the transient transformed plant, it is common for the foreign protein expression to be ceased in a short period of time due to the post-transcriptional gene silencing (PTGS). Sometimes a PTGS suppressing protein gene is necessary to be co-transformed into the plant transiently with the same type of viral vector that drives the expression of with the CRIP ORF. This improves and extends the expression of the CRIP in the plant. The most commonly used PTGS suppressing protein is P19 protein discovered from tomato bushy stunt virus (TBSV).

In some embodiments, transient transfection of plants can be achieved by recombining a polynucleotide encoding a CRIP with any one of the readily available vectors (see above), and confirmed, using a marker or signal (e.g., GFP emission). In some embodiments, a transiently transfected plant can be created by recombining a polynucleotide encoding a CRIP with a DNA encoding a GFP-Hybrid fusion protein in a vector, and transfection said vector into a plant (e.g., tobacco) using different FECT vectors designed for targeted expression. In some embodiments, a polynucleotide encoding a CRIP can be recombined with a pFECT vector for APO (apoplast localization) accumulation; a pFECT vector for CYTO (cytoplasm localization) accumulation; or pFECT with ersp vector for ER (endoplasm reticulum localization) accumulation.

An exemplary transient plant transformation strategy is agroinfection using a plant viral vector due to its high efficiency, ease, and low cost. In some embodiments, a tobacco mosaic virus overexpression system (see TRBO, Lindbo J A, Plant Physiology, 2007, V145: 1232-1240) can be used to transiently transform plants with CRIP. The TRBO DNA vector has a T-DNA region for agroinfection, which contains a CaMV 35S promoter that drives expression of the tobacco mosaic virus RNA without the gene encoding the viral coating protein. Moreover, this system uses the “disarmed” virus genome, therefore viral plant to plant transmission can be effectively prevented.

In another embodiment, the FECT viral transient plant expression system can be used to transiently transform plants with CRIP (see Liu Z & Kearney C M, BMC Biotechnology, 2010, 10:88). The FECT vector contains a T-DNA region for agroinfection, which contains a CaMV 35S promoter that drives the expression of the foxtail mosaic virus RNA without the genes encoding the viral coating protein and the triple gene block. Moreover, this system uses the “disarmed” virus genome, therefore viral plant to plant transmission can be effectively prevented. To efficiently express the introduced heterologous gene, the FECT expression system additionally needs to co-express P19, a RNA silencing suppressor protein from tomato bushy stunt virus, to prevent the post-transcriptional gene silencing (PTGS) of the introduced T-DNA. (The TRBO expression system does not need co-expression of P19).

In some embodiments, the CRIP ORF can be designed to encode a series of translationally fused structural motifs that can be described as follows: N′-ERSP-STA-L-CRIP-C′ wherein the “N′” and “C′” indicating the N-terminal and C-terminal amino acids, respectively, and the ERSP motif can be the Barley Alpha-Amylase Signal peptide (BAAS) (SEQ ID NO:37); the stabilizing protein (STA) can be GFP (SEQ ID NO:34); the linker peptide “L” can be IGER (SEQ ID NO:31) In some embodiments, the ersp-sta-l-CRIP ORF can chemically synthesized to include restrictions sites, for example a Pac I restriction site at its 5′-end, and an Avr II restriction site at its 3′-end. In some embodiments, the CRIP ORF can be cloned into the Pac I and Avr II restriction sites of a FECT expression vector (pFECT) to create an U1-agatoxin-Ta1b variant expression vector for the FECT transient plant expression system (pFECT-CRIP). To maximize expression in the FECT expression system, some embodiments may have a FECT vector expressing the RNA silencing suppressor protein P19 (pFECT-P19) generated for co-transformation.

In some embodiments, a U1-agatoxin-Ta1b variant expression vector can be recombined for use in a TRBO transient plant expression system, for example, by performing a routine PCR procedure and adding a Not I restriction site to the 3′-end of the CRIP ORF described above, and then cloning the CRIP ORF into Pac I and Not I restriction sites of the TRBO expression vector (pTRBO-CRIP).

In some embodiments, an Agrobacterium tumefaciens strain, for example, commercially available GV3101 cells, can be used for the transient expression of a CRIP ORF in a plant tissue (e.g., tobacco leaves) using one or more transient expression systems, for example, the FECT and TRBO expression systems. An exemplary illustration of such a transient transfection protocol includes the following: an overnight culture of GV3101 can be used to inoculate 200 mL Luria-Bertani (LB) medium; the cells can be allowed to grow to log phase with OD600 between 0.5 and 0.8; the cells can then be pelleted by centrifugation at 5000 rpm for 10 minutes at 4° C.; cells can then be washed once with 10 mL pre-chilled TE buffer (Tris-HCl 10 mM, EDTA 1 mM, pH8.0), and then resuspended into 20 mL LB medium; GV3101 cell resuspension can then be aliquoted in 250 μL fractions into 1.5 mL microtubes; aliquots can then be snap-frozen in liquid nitrogen and stored at −80° C. freezer for future transformation. The pFECT-CRIP and pTRBO-CRIP vectors can then transformed into the competent GV3101 cells using a freeze-thaw method as follows: the stored competent GV3101 cells are thawed on ice and mixed with 1 to 5 μg pure DNA (pFECT-CRIP or pTRBO-CRIP vector). The cell-DNA mixture is kept on ice for 5 minutes, transferred to −80° C. for 5 minutes, and incubated in a 37° C. water bath for 5 minutes. The freeze-thaw treated cells are then diluted into 1 mL LB medium and shaken on a rocking table for 2 to 4 hours at room temperature. A 200 μL aliquot of the cell-DNA mixture is then spread onto LB agar plates with the appropriate antibiotics (10 μg/mL rifampicin, 25 μg/mL gentamycin, and 50 μg/mL kanamycin can be used for both pFECT-CRIP transformation and pTRBO-CRIP transformation) and incubated at 28° C. for two days. Resulting transformed colonies are then picked and cultured in 6 mL aliquots of LB medium with the appropriate antibiotics for transformed DNA analysis and making glycerol stocks of the transformed GV3101 cells.

In some embodiments, the transient transformation of plant tissues, for example, tobacco leaves, can be performed using leaf injection with a 3-mL syringe without needle. In one illustrative example, the transformed GV3101 cells are streaked onto an LB plate with the appropriate antibiotics (as described above) and incubated at 28° C. for two days. A colony of transformed GV3101 cells are inoculated to 5 ml of LB-MESA medium (LB media supplemented with 10 mM IVIES, and 20 μM acetosyringone) and the same antibiotics described above, and grown overnight at 28° C. The cells of the overnight culture are collected by centrifugation at 5000 rpm for 10 minutes and resuspended in the induction medium (10 mM MES, 10 mM MgCl₂, 100 μM acetosyringone) at a final OD600 of 1.0. The cells are then incubated in the induction medium for 2 hours to overnight at room temperature and are then ready for transient transformation of tobacco leaves. The treated cells can be infiltrated into the underside of attached leaves of Nicotiana benthamiana plants by injection, using a 3-mL syringe without a needle attached.

In some embodiments, the transient transformation can be accomplished by transfecting one population of GV3101 cells with pFECT-CRIP or pTRBO-CRIP and another population with pFECT-P19, mixing the two cell populations together in equal amounts for infiltration of tobacco leaves by injection with a 3-mL syringe.

Stable integration of polynucleotide operable to encode CRIP is also possible with the present disclosure, for example, the CRIP ORF can also be integrated into plant genome using stable plant transformation technology, and therefore CRIPs can be stably expressed in plants and protect the transformed plants from generation to generation. For the stable transformation of plants, the CRIP expression vector can be circular or linear. The CRIP ORF, the CRIP expression cassette, and/or the vector with polynucleotide encoding an CRIP for stable plant transformation should be carefully designed for optimal expression in plants based on what is known to those having ordinary skill in the art, and/or by using predictive vector design tools such as Gene Designer 2.0 (Atum Bio); VectorBuilder (Cyagen); SnapGene® viewer; GeneArt™ Plasmid Construction Service (Thermo-Fisher Scientific); and/or other commercially available plasmid design services. See Tolmachov, Designing plasmid vectors. Methods Mol Biol. 2009; 542:117-29. The expression of CRIP is usually controlled by a promoter that promotes transcription in some, or all the cells of the transgenic plant. The promoter can be a strong plant viral promoter, for example, the constitutive 35S promoter from Cauliflower Mosaic Virus (CaMV); it also can be a strong plant promoter, for example, the hydroperoxide lyase promoter (pHPL) from Arabidopsis thaliana; the Glycine max polyubiquitin (Gmubi) promoter from soybean; the ubiquitin promoters from different plant species (rice, corn, potato, etc.), etc. A plant transcriptional terminator often occurs after the stop codon of the ORF to halt the RNA polymerase and transcription of the mRNA. To evaluate the CRIPs expression, a reporter gene can be included in the CRIP expression vector, for example, beta-glucuronidase gene (GUS) for GUS straining assay, green fluorescent protein (GFP) gene for green fluorescence detection under UV light, etc. For selection of transformed plants, a selection marker gene is usually included in the CRIP expression vector. In some embodiments, the marker gene expression product can provide the transformed plant with resistance to specific antibiotics, for example, kanamycin, hygromycin, etc., or specific herbicide, for example, glyphosate etc. If agroinfection technology is adopted for plant transformation, T-DNA left border and right border sequences are also included in the CRIP expression vector to transport the T-DNA portion into the plant.

The constructed CRIP expression vector can be transfected into plant cells or tissues using many transfection technologies. Agroinfection is a very popular way to transform a plant using an Agrobacterium tumefaciens strain or an Agrobacterium rhizogenes strain. Particle bombardment (also called Gene Gun, or Biolistics) technology is also very common method of plant transfection. Other less common transfection methods include tissue electroporation, silicon carbide whiskers, direct injection of DNA, etc. After transfection, the transfected plant cells or tissues placed on plant regeneration media to regenerate successfully transfected plant cells or tissues into transgenic plants.

Evaluation of a transformed plant can be accomplished at the DNA level, RNA level and protein level. A stably transformed plant can be evaluated at all of these levels and a transiently transformed plant is usually only evaluated at protein level. To ensure that the CRIP ORF integrates into the genome of a stably transformed plant, the genomic DNA can be extracted from the stably transformed plant tissues for and analyzed using PCR or Southern blot. The expression of the CRIP in the stably transformed plant can be evaluated at the RNA level, for example, by analyzing total mRNA extracted from the transformed plant tissues using northern blot or RT-PCR. The expression of the CRIP in the transformed plant can also be evaluated in protein level directly. There are many ways to evaluate expression of CRIP in a transformed plant. If a reporter gene included in the CRIP ORF, a reporter gene assay can be performed, for example, in some embodiments a GUS straining assay for GUS reporter gene expression, a green fluorescence detection assay for GFP reporter gene expression, a luciferase assay for luciferase reporter gene expression, and/or other reporter techniques may be employed.

In some embodiments total protein can be extracted from the transformed plant tissues for the direct evaluation of the expression of the CRIP using a Bradford assay to evaluate the total protein level in the sample.

In some embodiments, analytical HPLC chromatography technology, Western blot technique, or iELISA assay can be adopted to qualitatively or quantitatively evaluate the CRIP in the extracted total protein sample from the transformed plant tissues. CRIP expression can also be evaluated by using the extracted total protein sample from the transformed plant tissues in an insect bioassay, for example, in some embodiments, the transformed plant tissue or the whole transformed plant itself can be used in insect bioassays to evaluate CRIP expression and its ability to provide protection for the plant.

In some embodiments, a plant, plant tissue, plant cell, plant seed, or part thereof of the present invention, can comprise one or more CRIPs, or a polynucleotide encoding the same.

In some embodiments, a plant, plant tissue, plant cell, plant seed, or part thereof of the present invention, can comprise one or more CRIPs, or a polynucleotide encoding the same, wherein said CRIP is any CRIP as described herein. For example, in some embodiments, a plant, plant tissue, plant cell, plant seed, or part thereof, can comprise a CRIP including, but not limited to, one or more of the following: ACTX peptides (e.g., U-ACTX-Hv1a, U+2-ACTX-Hv1a, rU-ACTX-Hv1a, rU-ACTX-Hv1b, rκ-ACTX-Hv1c, co-ACTX-Hv1a, and/or ω-ACTX-Hv1a+2); Γ-CNTX-Pn1a; U1-agatoxin-Ta1b; TVPs; Av2; Av3; or AVPs. In addition, the methods and techniques can be used to create a plant, plant tissue, plant cell, plant seed, or part thereof, comprising a peptide-IA (e.g., an Insecticidal Agent that lends itself to such methods, e.g., a polymer, a peptide or a protein) such as Bt toxins (e.g., Cry toxins, Cyt toxins, or Vips).

In some embodiments, a plant, plant tissue, plant cell, plant seed, or part thereof of the present invention, can comprise one or more CRIPs, or a polynucleotide encoding the same, wherein said CRIP may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to: a spider peptide having an amino acid sequence as set forth in any one of SEQ ID NOs: 192-370; an ACTX peptide (e.g., U-ACTX-Hv1a, U+2-ACTX-Hv1a, rU-ACTX-Hv1a, rU-ACTX-Hv1b, κ-ACTX-Hv1a, κ+2-ACTX-Hv1a, ω-ACTX-Hv1a, and/or ω+2-ACTX-Hv1a) having an amino acid sequence as set forth in any one of SEQ ID NOs: 60-64, 192-370 and 594; an F-CNTX-Pn1a having an amino acid sequence as set forth in any one of SEQ ID NO: 65; a U1-agatoxin-Ta1b peptide having an amino acid sequence as set forth in SEQ ID NO: 1; a U1-agatoxin-Ta1b Variant Polypeptide (TVP) having an amino acid sequence as set forth in any one of SEQ ID NOs: 2-15, 49-53, 2-15, 49-53, 621-622, 624-628, 631-640, 642-651, or 653-654; a scorpion peptide having an amino acid sequence as set forth in any one of SEQ ID NOs: 66, 88-191; a sea anemone peptide having an amino acid sequence as set forth in any one of SEQ ID NOs: 371-411; an Av3 polypeptide from Anemonia viridis having an amino acid sequence as set forth in SEQ ID NO:44; an Av3 variant polypeptide (AVP) having an amino acid sequence as set forth in any one of SEQ ID NOs: 45-47; or a conotoxin.

Confirming Successful Transformation with CRIPs

Following introduction of heterologous foreign DNA into plant cells, the transformation or integration of heterologous gene in the plant genome is confirmed by various methods such as analysis of nucleic acids, proteins and metabolites associated with the integrated gene.

PCR analysis is a rapid method to screen transformed cells, tissue or shoots for the presence of incorporated gene at the earlier stage before transplanting into the soil (Sambrook and Russell (2001) Molecular Cloning: A Laboratory Manual. Cold Spring Harbor Laboratory Press, Cold Spring Harbor, N.Y.). PCR is carried out using oligonucleotide primers specific to the gene of interest or Agrobacterium vector background, etc.

Plant transformation may be confirmed by Southern blot analysis of genomic DNA (Sambrook and Russell, 2001, supra). In general, total DNA is extracted from the transformed plant, digested with appropriate restriction enzymes, fractionated in an agarose gel and transferred to a nitrocellulose or nylon membrane. The membrane or “blot” is then probed with, for example, radiolabeled ³²P target DNA fragment to confirm the integration of introduced gene into the plant genome according to standard techniques (Sambrook and Russell, 2001, supra).

In Northern blot analysis, RNA is isolated from specific tissues of transformed plant, fractionated in a formaldehyde agarose gel, and blotted onto a nylon filter according to standard procedures that are routinely used in the art (Sambrook and Russell, 2001, supra). Expression of RNA encoded by the polynucleotide encoding a CRIP is then tested by hybridizing the filter to a radioactive probe derived from a CRIP, by methods known in the art (Sambrook and Russell, 2001, supra).

Western blot, biochemical assays and the like may be carried out on the transgenic plants to confirm the presence of protein encoded by the CRIP gene by standard procedures (Sambrook and Russell, 2001, supra) using antibodies that bind to one or more epitopes present on the CRIP.

A number of markers have been developed to determine the success of plant transformation, for example, resistance to chloramphenicol, the aminoglycoside G418, hygromycin, or the like. Other genes that encode a product involved in chloroplast metabolism may also be used as selectable markers. For example, genes that provide resistance to plant herbicides such as glyphosate, bromoxynil, or imidazolinone may find particular use. Such genes have been reported (Stalker et al. (1985) J. Biol. Chem. 263:6310-6314 (bromoxynil resistance nitrilase gene); and Sathasivan et al. (1990) Nucl. Acids Res. 18:2188 (AHAS imidazolinone resistance gene). Additionally, the genes disclosed herein are useful as markers to assess transformation of bacterial, yeast, or plant cells. Methods for detecting the presence of a transgene in a plant, plant organ (e.g., leaves, stems, roots, etc.), seed, plant cell, propagule, embryo or progeny of the same are well known in the art. In one embodiment, the presence of the transgene is detected by testing for pesticidal activity.

Fertile plants expressing a CRIP and/or U1-agatoxin-Ta1b variant polynucleotide may be tested for pesticidal activity, and the plants showing optimal activity selected for further breeding. Methods are available in the art to assay for pest activity. Generally, the protein is mixed and used in feeding assays. See, for example Marrone et al. (1985) J. of Economic Entomology 78:290-293.

In some embodiments, evaluating the success of a transient transfection procedure can be determined based on the expression of a reporter gene, for example, GFP. In some embodiments, GFP can be detected under U.V. light in tobacco leaves transformed with the FECT and/or TRBO vectors.

In some embodiments, CRIP expression can be quantitatively evaluated in a plant (e.g., tobacco). An exemplary procedure that illustrates CRIP quantification in a tobacco plant is as follows: 100 mg disks of transformed leaf tissue is collected by punching leaves with the large opening of a 1000 μL pipette tip. The collected leaf tissue is place into a 2 mL microtube with 5/32″ diameter stainless steel grinding balls, and frozen in −80° C. for 1 hour, and then homogenized using a Troemner-Ta1boys High Throughput Homogenizer. Next, 750 μL ice-cold TSP-SE1 extraction solutions (sodium phosphate solution 50 mM, 1:100 diluted protease inhibitor cocktail, EDTA 1 mM, DIECA 10 mM, PVPP 8%, pH 7.0) is added into the tube and vortexed. The microtube is then left still at room temperature for 15 minutes and then centrifuged at 16,000 g for 15 minutes at 4° C.; 100 μL of the resulting supernatant is taken and loaded into pre-Sephadex G-50-packed column in 0.45 μm Millipore Multi Screen filter microtiter plate with empty receiving Costar microtiter plate on bottom. The microtiter plates are then centrifuged at 800 g for 2 minutes at 4° C. The resulting filtrate solution, herein called total soluble protein extract (TSP extract) of the tobacco leaves, is then ready for the quantitative analysis.

In some embodiments, the total soluble protein concentration of the TSP extract can be estimated using Pierce Coomassie Plus protein assay. BSA protein standards with known concentrations can be used to generate a protein quantification standard curve. For example, 2 μL of each TSP extract can be mixed into 200 μL of the chromogenic reagent (CPPA reagent) of the Coomassie Plus protein assay kits and incubated for 10 minutes. The chromogenic reaction can then be evaluated by reading OD595 using a SpectroMax-M2 plate reader using SoftMax Pro as control software. The concentrations of total soluble proteins can be about 0.788±0.20 μg/μL or about 0.533±0.03 μg/μL in the TSP extract from plants transformed via FECT and TRBO, respectively, and the results can be used to calculate the percentage of the expressed U1-agatoxin-Ta1b Variant peptide in the TSP (% TSP) for the iELISA assay

In some embodiments, an indirect ELISA (iELISA) assay can be used to quantitatively evaluate the CRIP content in the tobacco leaves transiently transformed with the FECT and/or TRBO expression systems. An illustrative example of using iELISA to quantify CRIP is as follows: 5 μL of the leaf TSP extract is diluted with 95 μL of CB2 solution (Immunochemistry Technologies) in the well of an Immulon 2HD 96-well plate, with serial dilutions performed as necessary; leaf proteins obtained from extract samples are then allowed to coat the well walls for 3 hours in the dark, at room temperature, and the CB2 solution is then subsequently removed; each well is washed twice with 200 μL PBS (Gibco); 150 μL blocking solution (Block BSA in PBS with 5% non-fat dry milk) is added into each well and incubated for 1 hour, in the dark, at room temperature; after the removal of the blocking solution, a PBS wash of the wells, 100 μL of primary antibodies directed against CRIP (custom antibodies are commercially available from ProMab Biotechnologies, Inc.; GenScript®; or raised using the knowledge readily available to those having ordinary skill in the art); the antibodies diluted at 1: 250 dilution in blocking solution are added to each well and incubated for 1 hour in the dark at room temperature; the primary antibody is removed and each well is washed with PBS 4 times; 100 μL of HRP-conjugated secondary antibody (i.e., antibody directed against host species used to generate primary antibody, used at 1: 1000 dilution in the blocking solution) is added into each well and incubated for 1 hour in the dark at room temperature; the secondary antibody is removed and the wells are washed with PBS, 100 μL; substrate solution (a 1: 1 mixture of ABTS peroxidase substrate solution A and solution B, KPL) is added to each well, and the chromogenic reaction proceeds until sufficient color development is apparent; 100 μL of peroxidase stop solution is added to each well to stop the reaction; light absorbance of each reaction mixture in the plate is read at 405 nm using a SpectroMax-M2 plate reader, with SoftMax Pro used as control software; serially diluted known concentrations of pure CRIPs samples can be treated in the same manner as described above in the iELISA assay to generate a mass-absorbance standard curve for quantities analysis. The expressed CRIP can be detected by iELISA at about 3.09±1.83 ng/μL in the leaf TSP extracts from the FECT transformed tobacco; and about 3.56±0.74 ng/μL in the leaf TSP extract from the TRBO transformed tobacco. Alternatively, the expressed CRIP can be about 0.40% total soluble protein (% TSP) for FECT transformed plants and about 0.67% TSP in TRBO transformed plants.

Insecticidal Agents (IAs)

Insecticidal Agents (IAs) are chemical substances, molecules, nucleotides, polynucleotides, peptides, polypeptides, proteins, toxins, toxicants, poisons, insecticides, pesticides, organic compounds, inorganic compounds, prokaryote organisms, or eukaryote organisms (and the agents produced from said prokaryote or eukaryote organisms), that possess at least some insecticidal activity.

In some embodiments, an IA can be any one or more chemical substances, molecules, nucleotides, polynucleotides, peptides, polypeptides, proteins, poisons, insecticides, pesticides, organic compounds, inorganic compounds, or combinations thereof, that exhibit insecticidal activity.

In some embodiments, an IA can be a prokaryote organism, eukaryote organism, or the agents produced therefrom, that exhibit insecticidal activity.

In some embodiments, an IA includes, but is not limited to, members selected from the categories of: RNAi; Stomach poisons; Inhibitors of chitin biosynthesis type 0; Inhibitors of chitin biosynthesis, type 1; Insect viruses; Compounds isolated from Azadirachta indica; Compounds with unknown MOAs; Bacteria (and products therefrom); Fungi (and products therefrom); Nematodes (and products therefrom); Botanical essences; Mechanical disruptors; Fluorescent brighteners; Silica nanospheres; Chitinases; Lectins; Membrane Attack Complex/Perforin (MACPF) proteins; Plant virus coat protein-toxin fusions; Glycan binding domain/toxin fusion proteins; Acetylcholinesterase (AchE) inhibitors; GABA-gated chloride channel blockers; Sodium channel modulators; Nicotinic acetylcholine receptor (nAchR) Competitive Modulators; Nicotinic acetylcholine receptor (nAchR) allosteric modulators—site I; Glutamate-gated chloride channel (GluCl) allosteric modulators; Juvenile hormone mimics; Miscellaneous non-specific (multi-site) inhibitors; Chordotonal organ TRPV channel modulators; Mite growth inhibitors; Inhibitors of mitochondrial ATP synthase; Uncouplers of oxidative phosphorylation via disruption of the proton gradient; Nicotinic acetylcholine receptor (nAchR) channel blockers; Moulting disruptors (dipteran); Ecdysone receptor agonists; Octopamine receptor agonists; Mitochondrial complex III electron transport inhibitors; Mitochondrial complex I electron transport inhibitors; Voltage-dependent sodium channel blockers; Inhibitors of acetyl co-enzyme A carboxylase; Mitochondrial complex IV electron transport inhibitors; Mitochondrial complex II electron transport inhibitors; Ryanodine receptor modulators; Chordotonal organ modulators—undefined target site; or GABA-gated chloride channel allosteric modulators.

In some preferred embodiments, an Insecticidal Agent (IA) can be selected from the following: RNAi: such as dsRNA (e.g., WupA dsRNA); Stomach poisons: e.g., arsenicals such as “Paris green” or copper acetoarsenite, lead arsenate, calcium arsenate; fluorine compounds (e.g., sodium fluoride); borates (e.g., borax, boric acid, disodium octaborate, sodium borate, sodium metaborate, sodium tetraborate decahydrate, boron oxide, boron carbide, boron nitride, boron tribromide, boron trichloride, or boron trifluoride);

Inhibitors of chitin biosynthesis type 0: e.g., benzoylureas (e.g., bistrifluron, chlorfluazuron, diflubenzuron, flucycloxuron, flufenoxuron, hexaflumuron, lufenuron, novaluron, noviflumuron, teflubenzuron, or triflumuron); Inhibitors of chitin biosynthesis, type 1: e.g., buprofezin; Insect viruses: e.g., Baculoviridae viruses (e.g., Betabaculoviruses such as granuloviruses (GVs) and nucleopolyhedroviruses (NPVS), e.g., Cydia pomonella GV, Thaumatotibia leucotreta GV, Anticarsia gemmatalis MNPV, or Helicoverpa armigera NPV); and Parvoviridae viruses (e.g., Junonia coenia densovirus (JcDNV)); Compounds isolated from Azadirachta indica: e.g., Azadirachtin; Azadiradione; Azadiradionolide; Deacetylgedunin; Deacetylazadirachtinol; Desfuranoazadiradione; Epoxyazadiradione; Gedunin; Mahmoodin; Neemfruitin A; Neemfruitin B; Nimbolide; Nimbin; Nimolicinol; Ohchinin Acetate; Salannin; Salannol; alpha-Nimolactone; beta-Nimolactone; 2′,3′-Dihydrosalannin; 3-Deacetylsalannin; 6-Deacetylnimbin; 7-Acetyl-16,17-dehydro-16-hydroxyneotrichilenone; 7-Benzoylnimbocinol; 7-Deacetyl-7-benzoylepoxyazadiradione; 7-Deacetyl-7-benzoylgedunin; 7-Deacetyl-17-epinimolicinol; 15-Hydroxyazadiradione; 17-Epi-17-Hydroxyazadiradione; 17-Epiazadiradione; 20,21,22,23-Tetrahydro-23-oxoazadirone; 22,23-Dihydronimocinol; or 28-Deoxonimbolide; Compounds with unknown MOAs: e.g., benzoximate, bromopropylate, chinomethionat, dicofol, lime sulfur, pyridalyl, or sulfur; Bacteria: including the fermentation solids, spores, toxins, and/or products therefrom, e.g., Brevibacillus brevis; Brevibacillus brevis toxins (e.g., TIC4670 Beta pore forming protein); Alcaligenes faecalis; Alcaligenes faecalis toxins (e.g., AfIP-1A/1B); Pseudomonas chlororaphis; Pseudomonas chlororaphis toxins (e.g., PIP-72Aa); Yersinia entomophaga (e.g., Yersinia entomophaga MH96); Yersinia nurmii; Photorhabdus luminescens; Photorhabdus luminescens toxin complexes (Tca); Burkholderia spp, or Wolbachie pipientis; Bacillus thuringiensis (e.g., Bacillus thuringiensis var. israelensis, Bacillus thuringiensis var. aizawai, Bacillus thuringiensis var. kurstaki, Bacillus thuringiensis var. tenebrionensis; or Bacillus sphaericus); Bacillus thuringiensis toxins, e.g., parasporal crystal toxins (e.g., δ-endotoxins such as Cry toxins, Cyt toxins); or secreted protein (e.g., vegetative insecticidal proteins (Vips), secreted insecticidal proteins (Sips), Bin-like family proteins, or ETX_MTX2-family proteins); Fungi: including parts and/or products thereof, e.g., Ascomycete fungi, such as a fungi in the Cordycipitaceae family (e.g., a Beauveria bassiana or Cordyceps bassiana, and/or the toxins therefrom); Metarhizium anisopliae (e.g., strain F52) and the products therefrom; or Paecilomyces fumosoroseus (e.g., Apopka strain 97) and the products therefrom, or nematode Steinernema glaseri and the products thereof; Nematodes: e.g., Steinernema glaseri or Heterorhabditis bacteriophora; Botanical essences: including synthetics and/or extracts or unrefined oils, such as Dysphania ambrosioides or near ambrosioides extract, fatty acid monoesters with glycerol or propanediol Neem oil; Mechanical disruptors: such as Diatomaceous earth, minerals, and/or synthetic/natural fibers; Fluorescent brighteners: e.g., Calcofluor White M2R; Silica nanospheres: e.g., NanoXact Silica Nanospheres; Chitinases: e.g., chitinase from Streptomyces griseus; Lectins: e.g., Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); or Datura stramonium Lectin (DSL); Membrane Attack Complex/Perforin (MACPF) proteins: e.g., MACPF isolated from fern; or GNIP1Aa isolated form chromobacteria; Plant virus coat protein-toxin fusions: e.g., Pea enation mosaic virus (PEMV) fusions; or POC anti-aphids; Glycan binding domain/toxin fusion proteins: e.g., chitinase glycan binding domain from Yersinia entomophaga MH96, glycan binding domain from snowdrop lectin, glycan binding domain from plant Luteovirus, and/or glycan binding domain from insect Parvoviridae or Baculoviridae viruses.

In yet other embodiments, an Insecticidal Agent (IA) can be selected from the following group: Acetylcholinesterase (AchE) inhibitors: e.g., carbamates (e.g., alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, and xylylcarb); and organophosphates (e.g., acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, and isopropyl o-(methoxyaminothio-phosphoryl) salicylate); GABA-gated chloride channel blockers: e.g., cyclodiene organochlorines (e.g., chlordane and endosulfan); and phenylpyrazoles (fiproles) (e.g., ethiprole and fipronil); Sodium channel modulators: e.g., pyrethroids and pyrethrins (e.g., acrinathrin, allethrin, d-cis-trans allethrin, d-trans allethrin, bifenthrin, bioallethrin, bioallethrin s-cyclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1r)-trans-isomers], deltamethrin, empenthrin [(ez)-(1r)-isomers], esfenvalerate, etofenprox, fenpropathrin, fenvalerate, flucythrinate, flumethrin, tau-fluvalinate, kadathrin, pyrethrins (pyrethrum), halfenprox, phenothrin [(1r)-trans-isomer], prallethrin, resmethrin, silafluofen, tefluthrin, tetramethrin, tetramethrin [(1r)-isomers], tralomethrin, transfluthrin, and permethrin); DDT; or methoxychlor; Nicotinic acetylcholine receptor (nAchR) Competitive Modulators: e.g., neonicotinoids (e.g., acetamiprid, clothianidin, dinotefuran, imidacloprid, nitenpyram, thiacloprid, thiamethoxam); nicotine; sulfoximines (e.g., sulfoxaflor); butenolides (e.g., flupyradifurone); and mesoionics (e.g., triflumezopyrim); Nicotinic acetylcholine receptor (nAchR) allosteric modulators—site I: e.g., spinosyns (e.g., spinetoram and spinosad); Glutamate-gated chloride channel (GluCl) allosteric modulators: e.g., avermectins and milbemycins (e.g., abamectin, emamectin benzoate, lepimectin, and milbemectin); Juvenile hormone mimics: e.g., juvenile hormone analogues (e.g., hydroprene, kinoprene, and methoprene); fenoxycarb; and pyriproxyfen; Miscellaneous non-specific (multi-site) inhibitors: e.g., alkyl halides (e.g., methyl bromide and other alkyl halides); chloropicrin; tartar emetic; and methyl isothiocyanate generators (e.g., dazomet and metam); Chordotonal organ TRPV channel modulators: e.g., pyridine azomethine derivatives (e.g., pymetrozine and pyrifluquinazon); and pyropenes (e.g., afidopyropen); Mite growth inhibitors: e.g., clofentezine; diflovidazin; hexythiazox; and etoxazole; Inhibitors of mitochondrial ATP synthase: e.g., diafenthiuron; organotin miticides (e.g., azocyclotin, cyhexatin, and fenbutatin oxide); propargite; and tetradifon; Uncouplers of oxidative phosphorylation via disruption of the proton gradient: e.g., pyrroles, dinitrophenols, and sulfluramid (e.g., chlorfenapyr, DNOC, and sulfluramid); Nicotinic acetylcholine receptor (nAchR) channel blockers: e.g., nereistoxin analogues such as bensultap, cartap hydrochloride, thiocyclam, thiosultap-sodium; Moulting disruptors (dipteran): e.g., cyromazine; Ecdysone receptor agonists: e.g., diacylhydrazines such as chromafenozide, halofenozide, methoxyfenozide, and tebufenozide; Octopamine receptor agonists: e.g., amitraz; Mitochondrial complex III electron transport inhibitors: e.g., hydramethylnon; acequinocyl; fluacrypyrim; and bifenazate; Mitochondrial complex I electron transport inhibitors: e.g., meti acaricides and insecticides (e.g., fenazaquin, fenpyroximate, pyrimidifen, pyridaben, tebufenpyrad, and tolfenpyrad); and rotenone; Voltage-dependent sodium channel blockers: e.g., oxadiazines (e.g., indoxacarb); and semicarbazones (e.g., metaflumizone); Inhibitors of acetyl co-enzyme A carboxylase: e.g., tetronic and tetramic acid derivatives (e.g., spirodiclofen, spiromesifen, spiropidion, and spirotetramat); Mitochondrial complex IV electron transport inhibitors: e.g., phosphides (e.g., aluminum phosphide, calcium phosphide, phosphine, and zinc phosphide); and cyanides (e.g., calcium cyanide, potassium cyanide, and sodium cyanide); Mitochondrial complex II electron transport inhibitors: e.g., beta-ketonitrile derivatives (e.g., cyenopyrafen and cyflumetofen); and carboxanilides (e.g., pyflubumide); Ryanodine receptor modulators: e.g., diamides such as chlorantraniliprole, cyantraniliprole, cyclaniliprole, flubendiamide, and tetraniliprole; Chordotonal organ modulators—undefined target site: e.g., flonicamid; or GABA-gated chloride channel allosteric modulators: e.g., meta-diamides and isoxazolines, such as broflanilide, fluxametamide.

In some embodiments, an IA can be a nucleotide, polynucleotide, gene, peptide, polypeptide, protein, or enzyme.

In some embodiments, an IA can be expressed in plants. For example, in some embodiments, an IA operable to be expressed in a plant, plant tissue, plant cell, plant seed, or plant part thereof, can include one or more of the following: nucleotides, peptides, polypeptides, and/or proteins isolated from the organisms known as Bacillus thuringiensis var. israelensis, Bacillus thuringiensis var. aizawai, Bacillus thuringiensis var. kurstaki, Bacillus thuringiensis var. tenebrionensis, and/or Bacillus sphaericus; chitinases; Galanthus nivalis agglutinin; WupA dsRNA; TIC4670 Beta pore forming protein; AfIP-1A/1B, PIP-72Aa, luteovirus CP-toxin fusion; chitinase glycan binding domain from Yersinia entomophaga MH96; glycan binding domain from snowdrop lectin fused to a toxin; glycan binding domain from plant Luteovirus fused to toxin; and glycan binding domain from insect Parvoviridae or Baculoviridae coat protein viruses fused to toxin.

IAs: Fungi and Fungal Toxins

Entomopathogenic fungi are fungi that can an act as a parasite and/or disease of insect and/or invertebrates. As their name implies, entomopathogenic fungi are eukaryote organisms, having a nucleus clearly defined by a membrane. Entomopathogenic fungi can be a single-cell organism (i.e., unicellular), such as in yeasts; alternatively, they can be formed multicellularly via filamentous units known as hyphae, forming mycelium. Hyphae are formed by single-nucleate or multi-nucleate segments, separated by transverse walls.

Fungi reproduction units are known as spores or conidia. As it pertains to entomopathogenic fungi, target insects are usually infected by these reproductive units. Generally, the infection of insects by entomopathogenic fungi is usually divided into three steps: (1) adhesion and spore germination in the insect's cuticle; (2) penetration within the insect's hemocele; and (3) fungi development, generally ending with the insect's death. See Tanada, Y., & Kaya, H. K. (1993), Insect Pathology. San Diego. Academic Press.

Briefly, a general route of pathogenesis is described as follows: once the entomopathogenic fungus has penetrated the cuticle, it goes on to the hemocele, wherein the hyphae convert into hyphael bodies or blastospores and/or protoplasts. These then disseminate to all parts of the insect body, and ultimately destroy the internal organs. The insect's death occurs due to nutritional deficiencies, invasion and destruction of insect tissue and metabolic imbalances due to toxic substances which are produced by the fungus. See Gillespie, A. T. and Claydon, N. The use of entomogenous fungi for pest control and the role of toxins in pathogenesis. (1989), Pestic. Sci., 27: 203-215.

Within the insect's cavity, infection success will depend on the genetic potential the fungus has to grow rapidly, penetrate barriers found inside the insect and resist toxic substances the insect might produce, as well as its defense mechanisms. The insect's primary defense mechanism is the encapsulation and melanization of foreign bodies.

Once the insect's immune barriers are overcome, fungi grows saprophytically, forms a mycelium mass and produces reproductive structures within the hemocele. The spores and sterile hyphae emerge from the insect under adequate humidity and temperature conditions. The spore production, unloading, dispersion, survival and germination processes will depend on environmental conditions. The vast number of spores produced by the insect cadavers partially compensates the high odds of the great majority of them not surviving at all. See A. E. Hajek & R. J St. Leger, Interactions Between Fungal Pathogens and Insect Hosts, Annual Review of Entomology 1994 39:1, 293-322

In some embodiments, an IA can be an entomopathogenic fungi, or product derived therefrom, for example, hyphae, spores or reproductive structures.

In some embodiments, an IA can be a peptide, protein, or toxin produced from an entomopathogenic fungi.

In some embodiments, an IA can be an Ascomycete fungal toxin.

In some embodiments, an IA can be a Cordycipitaceae family fungal toxin.

In some embodiments, an IA can be is a Akanthomyces toxin; a Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, an IA can be an organism or toxin therefrom, selected from the following genera: Beauveria; Metarhizium; Paecilomyces; Lecanicillium; Nomuraea; Isaria; Hirsutella; Sorosporella; Aspergillus; Cordiceps; Entomophthora; Zoophthora; Pandora; Entomophaga; Conidiobolus and Basidiobolus.

In some embodiments, an IA can be a Beauveria toxin.

In some embodiments, an IA can be: a Beauveria alba toxin; a Beauveria amorpha toxin; a Beauveria arenaria toxin; a Beauveria asiatica toxin; a Beauveria australis toxin; a Beauveria bassiana toxin; a Cordyceps bassiana toxin; a Beauveria brongniartii toxin; a Beauveria brumptii toxin; a Beauveria caledonica toxin; a Beauveria chiromensis toxin; a Beauveria coccorum toxin; a Beauveria cretacea toxin; a Beauveria cylindrospora toxin; a Beauveria delacroixii toxin; a Beauveria densa toxin; a Beauveria dependens toxin; a Beauveria doryphorae toxin; a Beauveria effusa toxin; a Beauveria epigaea toxin; a Beauveria felina toxin; a Beauveria geodes toxin; a Beauveria globulifera toxin; a Beauveria heimii toxin; a Beauveria hoplocheli toxin; a Beauveria kipukae toxin; a Beauveria laxa toxin; a Beauveria malawiensis toxin; a Beauveria medogensis toxin; a Beauveria melolonthae toxin; a Beauveria nubicola toxin; a Beauveria oryzae toxin; a Beauveria paradoxa toxin; a Beauveria paranensis toxin; a Beauveria parasitica toxin; a Beauveria petelotii toxin; a Beauveria pseudobassiana toxin; a Beauveria rileyi toxin; a Beauveria rubra toxin; a Beauveria shiotae toxin; a Beauveria sobolifera toxin; a Beauveria spicata toxin; a Beauveria stephanoderis toxin; a Beauveria sulfurescens toxin; a Beauveria sungii toxin; a Beauveria tenella toxin; a Beauveria tundrensis toxin; a Beauveria velata toxin; a Beauveria varroae toxin; a Beauveria vermiconia toxin; a Beauveria vexans toxin; a Beauveria viannai toxin; or a Beauveria virella toxin.

In some embodiments, an IA can be a Beauveria bassiana toxin

In some embodiments, an IA can be beauvericin.

Beauvericin is a fungal toxin produced by various Fusarium species, as well as the fungus Beauveria bassiana. Beauvericin is a cyclic peptide, with toxic effects on insects as well as both human and murine cell lines. The activity of beauvericin is due to the ionophoric properties of the compound. Beauvericin is capable of forming complexes with alkali metal cations and affects ion transport across cell membranes. In addition, beauvericin has been reported to be one of the most powerful inhibitors of cholesterol acetyltransferase. Beauvericin has also been shown to induce a type of cell death very similar to apoptosis. Circumstantial evidence further indicates that beauvericin acts in concert with other Fusarium toxins to cause additional toxic effects.

In some embodiments, an IA can be a beauvericin having the chemical formula C₄₅H₅₇N₃O₉.

In some embodiments, an IA can be a “Beauvericin A” toxin having the chemical formula C₄₆H₅₉N₃O₉.

In some embodiments, an IA can be a “Beauvericin B” toxin having the chemical formula C₄₇H₆₁N₃O₉.

In some embodiments, an IA can be a Beauveria bassiana strain ANT-03 spore.

Exemplary methods of producing, making, and using fungi and fungal toxins for the control and/or inhibition of insects are disclosed in: U.S. Pat. No. 9,217,140, entitled “Fungal strain Beauveria sp. MTCC 5184 and a process for the preparation of enzymes therefrom”; U.S. Pat. No. 6,261,553, entitled “Mycoinsecticides against an insect of the grasshopper family”; U.S. Pat. No. 8,709,399, entitled “Bio-pesticide and method for pest control”; U.S. Pat. No. 7,241,612, entitled “Methods and materials for control of insects such as pecan weevils”; and U.S. Pat. No. 8,226,938, entitled “Biocontrol of Varroa mites with Beauveria bassiana,” the disclosures of which are incorporated here by reference in their entireties.

IAs: Lectins

Lectins are polypeptides that are able to recognize and reversibly bind in a specific way to free carbohydrates and/or the glycoconjugates of cell membranes. Lectins are one of the two groups of glycan-binding proteins (GBPs), the other being sulfated glycosaminoglycan (GAG)-binding proteins. Found in the animalia, plantae, fungi, protista, archaea, bacteria and virus kingdoms, lectins have highly variable biological functions depending on the organism of origin. For example, in mammals, endogenous lectins are involved in cell-extracellular matrix (ECM); gamete fertilization; cell-cell self-recognition; embryonic development; cell growth, differentiation, signaling, adhesion, and migration; apoptosis; host-pathogen interactions; immunomodulation and inflammation; glycoprotein folding and routing; mitogenic induction; and homeostasis.

Typically, lectins possess at least one non-catalytic domain with the ability to bind—in a reversible way with high specificity—to carbohydrates that are bound to cell membranes or free carbohydrates (e.g., polysaccharides, glycoproteins, or glycolipids). This domain is known as the carbohydrate-recognition domain (CRD). In some embodiments, examples of lectins can include: Concanavalin A (ConA), which is isolated from jack beans. ConA binds to glucose, mannose, and glycosides of mannose and/or glucose. Wheat germ agglutinin (WGA) is another lectin that binds to N-acetylglucosamine and its glycosides. Red kidney bean lectin binds to N-acetylglucosamine, and Peanut agglutinin binds to galactose and galactosides. An exemplary review of lectin structure and biology can be found in Essentials of Glycobiology, 3rd edition. Varki A, Cummings R D, Esko J D, et al., editors. Cold Spring Harbor (NY): Cold Spring Harbor Laboratory Press; 2015-2017.

Due to their diverse roles and structures, lectins can be categorized according to several criteria, e.g., lectins can be categorized based on cell localization (e.g., extracellular lectins, intracellular endoplasmic reticulum (ER) lectins, Golgi lectins, cytoplasmic lectins, membrane-bound lectins). See Lakhtin et al., Lectins of living organisms. The overview. Anaerobe. 2011 December; 17(6):452-5, the disclosure of which is incorporated herein by reference in its entirety.

Similarities in structure or sequence can also be used to categorize lectins (e.g., beta prism lectins (B-type), calcium dependent lectins (C-type), lectins with Ficolins-Fibrinogen/collagen domain (F-type), garlic and snow drop lectins (G-type), hyaluronan bonding proteins or hyal-adherins (H-type), immunoglobulin superfamily lectins (I-type), jocob and related lectins (J-type), legume seed lectins (L-type), alpha mannosidase related lectins (M-type), nucleotide phosphohydrolases lectins (N-type), ricin lectins (R-type), Tachypleus tridentatus (T-type), wheat germ agglutinin (W type), Xenopus egg lectins (X type)). See Kumar et al., Biological role of lectins: A review. J. Orofac. Sci. 2012; 4:20-25, the disclosure of which is incorporated herein by reference in its entirety.

Alternatively, carbohydrate specificities can also be used to categorize lectins. For example, based on animals and plants (e.g., d-mannose (d-glucose)-binding lectins, 2-acetamido-2-deoxy-glucose-binding lectins, 2-acetamido-2-deoxy-galactose-binding lectins, d-galactose-binding lectins, l-fucose-binding lectins, other lectins); or based on all organisms (e.g., Glucose/mannose-binding lectins, galactose and N-acetyl-d-galactosamine-binding lectins, l-fucose-binding lectins, sialic acids-binding lectins). See Goldstein I. J., & Hayes C. E. The Lectins: Carbohydrate-binding proteins of plants and animals. Adv. Carbohydr. Chem. Biochem. 1978; 35:127-340; and Kumar et al., Biological role of lectins: A review. J. Orofac. Sci. 2012; 4:20-25, the disclosures of which are incorporated herein by reference in their entirety.

Characterizing a lectin's binding domain can be accomplished via X-ray co-crystallography, NMR, and MS mapping of relevant contacts and protein dynamics; equilibrium dialysis against labeled hapten; equilibrium binding with filtration (e.g., membranes); equilibrium binding, stopped by PEG with centrifugation (solubilized receptor); the use of multivalent ligands; the use of multivalent receptor probes; Biacore realtime kinetics; and/or evaluating the rates of cell adhesion, e.g., flow under shear to immobilized glycan or receptor.

Lectin sequences, 3D X-ray structures, and references concerning lectins, can be obtained from the website: https://www.unilectin.eu/unilectin3D/; See Bonnardel et al., UniLectin3D, a database of carbohydrate binding proteins with curated information on 3D structures and interacting ligands. Nucleic Acids Res. 2019 Jan. 8; 47(D1):D1236-D1244, the disclosure of which is incorporated herein by reference in its entirety.

In some embodiments, an IA can be a lectin.

In some embodiments, an IA can be a lectin, wherein said lectin is not fused nor operably linked to the CRIP.

In some embodiments, an IA can be one of the following: Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia simplicifolia-II (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); and/or Datura stramonium Lectin (DSL).

In some embodiments, an IA can be one or more of the lectins listed in Table 3. For example, in some embodiments, the lectins can have an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 35, 595-615, or a variant thereof.

TABLE 3
This table provides non-limiting examples of well characterized
lectins, and their accession numbers on NCBI, sequences, and SEQ ID NO as listed in
the sequence listing.

| | Accession | | SEQ ID |
|---|---|---|---|
| Name | No. | Sequence | NO. |
| Galanthus nivalis | AAL07474 | MAKASLLILATIFLGVITPSCLSENILYSGETLPT | 35 |
| agglutinin (GNA) | | GGFLSSGSFVFIMQEDCNLVLYNVDKPIWATNTGG | |
| | | LSSDCSLSMQNDGNLVVFTPSNKPIWASNTDGQNG | |
| | | NYVCILQKDRNVVIYGTNRWATGTYTGAVGIPESP | |
| | | PSEKYPSAGKIKLVTAK | |
| Galanthus nivalis | P30617 | MAKASLLILAAIFLGVITPSCLSDNILYSGETLST | 595 |
| agglutinin (GNA) | | GEFLNYGSFVFIMQEDCNLVLYDVDKPIWATNTGG | |
| | | LSRSCFLSMQTDGNLVVYNPSNKPIWASNTGGQNG | |
| | | NYVCILQKDRNVVIYGTDRWATGTHTGLVGIPASP | |
| | | PSEKYPTAGKIKLVTAK | |
| Sambucus nigra | AAL04120 | MRVIAAAMLYLYIVVLAICSVGIEGIEYPSVSENL | 596 |
| (European elder) | | AGAKSATWDFLRMPTSRNGYDDGEPITGNIVGRDG | |
| lectin (SNA) | | LCVDVRNGYDTDGTPIQLWPCGTQRNQQWTFHTDD | |
| | | TIRSMGKCMTANGLNNGGNIMIFNCSTAVENAIKW | |
| | | EVTIDGSIINPSSGLVITAPSAASRTILLLQNNIY | |
| | | AASQGWTVSNNVQPIVASIVGFREMCLQANGENNG | |
| | | VWMEDCEATSLQQQWALFGDRTIRVNSNRGLCVTT | |
| | | NGYNSRDLIIILKCQGLPSQRWFFNSDGAIVNPKS | |
| | | KLVMDVKSSNVSLREIIIYPATGRPNQQWVTQVLP | |
| | | S | |
| Leukoagglutinating | P0DKL3 | MATSNSKPTQVLLATELTFFELLLNNVNSSDELSF | 597 |
| lectin from the seeds | | TINNFVPNEADLLFQGEASVSSTGVLQLTRVENGQ | |
| of Maackia | | PQKYSVGRALYAAPVRIWDNTTGSVASESTSFTFV | |
| amurensis (MAL) | | VKAPNPDITSDGLAFYLAPPDSQIPSGSVSKYLGL | |
| | | FNNSNSDSSNQIVAVELDTYFAHSYDPWDPNYRHI | |
| | | GIDVNGIESIKTVQWDWINGGVAFATITYLAPNKT | |
| | | LIASLVYPSNQTTESVAASVDLKEILPEWVRVGES | |
| | | AATGYPTEVETHDVLSWSFTSTLEANCDAATENNV | |
| | | HIARYTA | |
| Erythrina cristagalli | P83410 | VETISFSFSEFEPGNDNLTLQGAALITQSGVLQLT | 598 |
| lectin (ECL) | | KINQNGMPAWDSTGRTLYTKPVHMWDSTTGTVASF | |
| | | ETRESESIEQPYTRPLPADGLVFFMGPTKSKPAQG | |
| | | YGYLGVENNSKQDNSYQTLAVEFDTFSNPWDPPQV | |
| | | PHIGIDVNSIRSIKTQPFQLDNGQVANVVIKYDAP | |
| | | SKILHVVLVYPSSGAIYTIAEIVDVKQVLPDWVDV | |
| | | GLSGATGAQRDAAETHDVYSWSFQASLPE | |
| Ricinus communis | AAB22584 | IFPKQYPIINFTTADATVESYTNFIRAVRSHLTTG | 599 |
| agglutinin-I (RCA) | | ADVRHEIPVLPNRVGLPISQRFILVELSNHAELSV | |
| | | TLALDVTNAYVVGCRAGNSAYFFHPDNQEDAEAIT | |
| | | HLFTDVQNSFTFAFGGNYDRLEQLGGLRENIELGT | |
| | | GPLEDAISALYYYSTCGTQIPTLARSEMVCIQMIS | |
| | | EAARFQYIEGEMRTRIRYNRRSAPDPSVITLENSW | |
| | | GRLSTAIQESNQGAFASPIQLQRRNGSKENVYDVS | |
| | | ILIPIIALMVYRCAPPPSSQFSLLIRPVVPNENAD | |
| | | VCMDPEPIVRIVGRNGLCVDVTGEEFFDGNPIQLW | |
| | | PCKSNTDWNQLWTLRKDSTIRSNGKCLTISKSSPR | |
| | | QQVVIYNCSTATVGATRWQIWDNRTIINPRSGLVL | |
| | | AATSGNSGTKLTVQTNIYAVSQGWLPTNNTQPFVT | |
| | | TIVGLYGMCLQANSGKVWLEDCTSEKAEQQWALYA | |
| | | DGSIRPQQNRDNCLTTDANIKGTVVKILSCGPASS | |
| | | GQRWMFKNDGTILNLYNGLVLDVRRSDPSLKQIIV | |
| | | HPFHGNLNQIWLPLF | |
| Peanut agglutinin | P02872 | MKPFCVFLTFFLLLAASSKKVDSAETVSENENSES | 600 |
| (PNA) | | EGNPAINFQGDVTVLSNGNIQLTNLNKVNSVGRVL | |
| | | YAMPVRIWSSATGNVASFLTSFSFEMKDIKDYDPA | |
| | | DGIIFFIAPEDTQIPAGSIGGGTLGVSDTKGAGHE | |
| | | VGVEFDTYSNSEYNDPPTDHVGIDVNSVDSVKTVP | |
| | | WNSVSGAVVKVTVIYDSSTKTLSVAVINDNGDITT | |
| | | IAQVVDLKAKLPERVKFGFSASGSLGGRQIHLIRS | |
| | | WSFTSTLITTTRRSIDNNEKKIMNMASA | |
| Agglutinin isolectin | P10968 | MKMMSTRALALGAAAVLAFAAATAQAQRCGEQGSN | 601 |
| 1 (WGA1) | | MECPNNLCCSQYGYCGMGGDYCGKGCQNGACWTSK | |
| | | RCGSQAGGATCTNNQCCSQYGYCGFGAEYCGAGCQ | |
| | | GGPCRADIKCGSQAGGKLCPNNLCCSQWGFCGLGS | |
| | | EFCGGGCQSGACSTDKPCGKDAGGRVCTNNYCCSK | |
| | | WGSCGIGPGYCGAGCQSGGCDGVFAEAITANSTLL | |
| | | QE | |
| Concanavalin-A | P02866 | MAISKKSSLFLPIFTFITMFLMVVNKVSSSTHETN | 602 |
| (CNA) precursor | | ALHEMENQFSKDQKDLILQGDATTGTDGNLELTRV | |
| | | SSNGSPQGSSVGRALFYAPVHIWESSAVVASFEAT | |
| | | FTFLIKSPDSHPADGIAFFISNIDSSIPSGSTGRL | |
| | | LGLFPDANVIRNSTTIDENAAYNADTIVAVELDTY | |
| | | PNTDIGDPSYPHIGIDIKSVRSKKTAKWNMQNGKV | |
| | | GTAHIIYNSVDKRLSAVVSYPNADSATVSYDVDLD | |
| | | NVLPEWVRVGLSASTGLYKETNTILSWSFTSKLKS | |
| | | NEIPDIATVV | |
| Jacalin-like lectin | 6FLY_A | SGLVKLGLWGGNEGTLQDIDGHPTRLTKIVIRSAH | 603 |
| (Chain A) | | AIDALQFDYVEDGKTFAAGQWGGNGGKSDTIEFQP | |
| | | GEYLIAIKGTTGALGAVTNLVRSLTFISNMRTYGP | |
| | | FGLEHGTPFSVPVASGRIVAFYGRFGSLVDAFGIY | |
| | | LMPY | |
| Lectin alpha-1 chain | P07443 | VTSYTLNEVVPLKDVVPEWVRIGFSATTGAEFAAH | 604 |
| | | EVLSWSFHSELGGTSASKQ | |
| Lectin CaBo | P58906 | MAISKKSSLYLPIFTFITMLLMVVNKVSSSTADAN | 605 |
| | | ALHFTFNQFSKDQKDLILQGDATTGTDGNLELTRV | |
| | | SSNGSPQGNSVGRALFYAPVHIWESSAVVASEDAT | |
| | | FKFLIKSPDSEPADGITFFIANIDSSIPSGSGGRL | |
| | | LGLFPDANIIKNSTTIDENAAYNADTIVAVELDTY | |
| | | PNTDIGDPNYPHIGIDIKSIRSKKTTRWNIQNGKV | |
| | | GTAHINYNSVGKRLSAIVSYPNSDSATVSYDVDLD | |
| | | NVLPEWVRVGLSATTGLYKETNTILSWSFTSKLKS | |
| | | N | |
| Lectin ConGF | A0A067XG71 | ADTIVAVELDTYPNTDIGDPNYPHIGIDIKSIRSK | 606 |
| | | KIAKWNMQDGKVATAHIIYNSVGKRLSAVVSYPNA | |
| | | DSATVSYDVDLDNVLPEWVRVGLSATTGLYKETNT | |
| | | ILSWSFTSKLKSNSTAETNALHETENQFTKDQKDL | |
| | | ILQGDATTDSDGNLQLTRVSSDGTPQGNSVGRALF | |
| | | YAPVHIWESSAVVASEDATFTFLIKSPDSDPADGI | |
| | | TFFISNMDSTIPSGSGGRLLGLFPDAN | |
| Mannose-specific | P86184 | ADTIVAVELDSYPNTDIGDPSYPHIGIDIKSIRSK | 607 |
| lectin alpha chain | | STARWNMQTGKVGTAHISYNSVAKRLTAVVSYSGS | |
| | | SSTTVSYDVDLNNVLPEWVRVGLSATTGLYKETNT | |
| | | ILSWSFTSKLKTNSIADANALHESFHQFTQNPKDL | |
| | | ILQGDATTDSDGNLELTKVSSSGSPQGSSVGRALF | |
| | | YAPVHIWESSAVVASFDATFTFLIKSPDSEPADGI | |
| | | TFFIANTDTSIPSGSSGRLLGLFPDAN | |
| Beta-galactoside- | P81446 | MNGHLASRRAWVWYFLMLGQVFGATVKAETKFSYE | 608 |
| specific lectin 1 | | RLRLRVTHQTTGEEYFRFITLLRDYVSSGSESNEI | |
| | | PLLRQSTIPVSDAQRFVLVELTNEGGDSITAAIDV | |
| | | TNLYVVAYQAGDQSYFLRDAPRGAETHLFTGTTRS | |
| | | SLPENGSYPDLERYAGHRDQIPLGIDQLIQSVTAL | |
| | | RFPGGSTRTQARSILILIQMISEAARENPILWRAR | |
| | | QYINSGASFLPDVYMLELETSWGQQSTQVQQSTDG | |
| | | VENNPIRLAIPPGNFVTLTNVRDVIASLAIMLFVC | |
| | | GERPSSSDVRYWPLVIRPVIADDVTCSASEPTVRI | |
| | | VGRNGMCVDVRDDDFHDGNQIQLWPSKSNNDPNQL | |
| | | WTIKRDGTIRSNGSCLTTYGYTAGVYVMIEDCNTA | |
| | | VREATLWEIWGNGTIINPRSNLVLAASSGIKGTTL | |
| | | TVQTLDYTLGQGWLAGNDTAPREVTIYGERDLCME | |
| | | SNGGSVWVETCVISQQNQRWALYGDGSIRPKQNQD | |
| | | QCLTCGRDSVSTVINIVSCSAGSSGQRWVETNEGA | |
| | | ILNLKNGLAMDVAQANPKLRRIIIYPATGKPNQMW | |
| | | LPVP | |
| Galectin-3 | P17931 | MADNESLHDALSGSGNPNPQGWPGAWGNQPAGAGG | 609 |
| | | YPGASYPGAYPGQAPPGAYPGQAPPGAYPGAPGAY | |
| | | PGAPAPGVYPGPPSGPGAYPSSGQPSATGAYPATG | |
| | | PYGAPAGPLIVPYNLPLPGGVVPRMLITILGTVKP | |
| | | NANRIALDFQRGNDVAFHENPRENENNRRVIVCNT | |
| | | KLDNNWGREERQSVFPFESGKPFKIQVLVEPDHEK | |
| | | VAVNDAHLLQYNHRVKKLNEISKLGISGDIDLTSA | |
| | | SYTMI | |
| Mannose/glucose- | P83721 | ADTIVAVELDTYPNTDIGDPSYQHIGINIKSIRSK | 610 |
| specific lectin | | ATTRWDVQNGKVGTAHISYNSVAKRLSAVVSYPGG | |
| Cramoll | | SSATVSYDVDLNNILPEWVRVGLSASTGLYKETNT | |
| | | ILSWSFTSKSNSTADAQSLHFTFNQFSQSPKDLIL | |
| | | QGDASTDSDGNLQLTRVSNGSPQSDSVGRALYYAP | |
| | | VHIWDKSAVVASFDATFTFLIKSPDREIADGIAFF | |
| | | IANTDSSIPHGSGGRLLGLFPDAN | |
| Beta-galactoside- | P82683 | MNAVMDSRGAWVSCFLILGLVFGATVKAETKESYE | 611 |
| specific lectin 3 | | RLRLRVTHQTTGDEYFRFITLLRDYVSSGSESNEI | |
| | | PLLRQSTIPVSDAQRFVLVELTNQGGDSITAAIDV | |
| | | TNLYVVAYQAGDQSYFLRDAPDGAERHLFTGTTRS | |
| | | SLPFTGSYTDLERYAGHRDQIPLGIEELIQSVSAL | |
| | | RYPGGSTRAQARSIIILIQMISEAARENPIFWRVR | |
| | | QDINSGESFLPDMYMLELETSWGQQSTQVQQSTDG | |
| | | VENNPERLAISTGNFVTLSNVRDVIASLAIMLFVC | |
| | | RDRPSSSEVRYWPLVIRPVLENSGAVDDVTCTASE | |
| | | PTVRIVGRDGLCVDVRDGKFHNGNPIQLSPCKSNT | |
| | | DPNQLWTIRRDGTIRSNGRCLTTYGYTAGVYVMIE | |
| | | DCNTAVREATLWQIWGNGTIINPRSNLVLGAASGS | |
| | | SGTTLTVQTQVYSLGQGWLAGNDTAPREVTIYGER | |
| | | DLCMEANGASVWVETCGSSTENQNWALYGDGSIRP | |
| | | KQNQDQCLTCQGDSVATVINIVSCSAGSSGQRWVF | |
| | | TNEGTILNLNNGLVMDVAQSNPSLRRIIIYPATGN | |
| | | PNQMWLPVP | |
| Lactose-binding | P86795 | SGAVHFSFTKFSTSSSDLTLQGSALVSSKGSLKKN | 612 |
| lectin-2 | | PSKKGKPVDHSVGRALYRSPIHIWDETTGKVASFD | |
| | | ATFSFVSEAPAIPMLFPSSKGELNDEDDTRIGGQL | |
| | | GVVNDSYNVIRVTVAVENDGYRNRVDPSARPHISL | |
| | | PIKSVRSKKTAKWNMQTGKVGTAHISYNSVAKRLS | |
| | | AVVSYTGNSSSTTVSYDVLLNLAVLPSKVLVGKTA | |
| | | TGLYKDHVETNTILSWSFTSKLKTNSIAD | |
| Galectin-1 | P09382 | MACGLVASNLNLKPGECLRVRGEVAPDAKSFVLNL | 613 |
| | | GKDSNNLCLHENPRENAHGDANTIVCNSKDGGAWG | |
| | | TEQREAVFPFQPGSVAEVCITEDQANLTVKLPDGY | |
| | | EFKFPNRLNLEAINYMAADGDFKIKCVAFD | |
| Alpha-N- | Q8WPD0 | MAFFRALCFVLLVGFAAACQPDCSWKCPPKCPPMW | 614 |
| acetylgalactosamine- | | TFYNGNCYRYFGTGKTYDEAESHCQEFTEVGLGHL | |
| specific lectin | | ASIASAEENNLLLTMWKSVRTTTTGGLWIGLNDQA | |
| | | EEGNFIWTDGSAVTFTDWATTQPDNYQNEDCAHMR | |
| | | HELDGDDRWNDIACSRAFAYVCKMSTTN | |
| Favin | P02871 | TDEITSESIPKFRPDQPNLIFQGGGYTTKEKLTLT | 615 |
| | | KAVKNTVGRALYSLPIHIWDSETGNVADFTTTFIF | |
| | | VIDAPNGYNVADGFTFFIAPVDTKPQTGGGYLGVE | |
| | | NGKDYDKTAQTVAVEFDTFYNAAWDPSNGKRHIGI | |
| | | DVNTIKSISTKSWNLQNGEEAHVAISFNATTNVLS | |
| | | VTLLYPNLTGYTLSEVVPLKDVVPEWVRIGESATT | |
| | | GAEYATHEVLSWTFLSELTGPSN | |

In some embodiments, an IA may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to an amino acid sequence as set forth in any one of SEQ ID NOs: 35, 595-615.

IAs: Chitinases

In some embodiments, an IA may be a chitinase.

In some embodiments, an IA may be a chitinase from Trichoderma viride.

In some embodiments, an IA may be a chitinase having an amino acid sequence as set forth in SEQ ID NO: 620.

In some embodiments, an IA may be a chitinase comprising an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to an amino acid sequence as set forth in any one of SEQ ID NO: 620.

IAs: Azadirachta indica Compounds

Azadirachta indica (also known as neem, nimtree or Indian lilac) is a tree in the mahogany family, Mehaceae. Native to the Indian subcontinent, Azadirachta indica typically grows in tropical and semi-tropical regions.

Azadirachta indica has been used for centuries as a source of pesticides. Various neem seed extracts, particularly the ones containing the hydrophilic, tetranortriterpenoid azadirachtin, are known to influence the feeding behavior, metamorphosis (insect growth regulating [IGR] effect), fecundity, and fitness of numerous insect species belonging to various orders.

Azadirachtin is a tetranortriterpenoid botanical insecticide of the liminoid class extracted from the neem tree (Azadirachta indica). It is a highly oxidized tetranortriterpenoid which boasts of a plethora of oxygen functionality and comprising an enol ether, acetal, hemiacetal, and tetra-substituted oxirane as well as a variety of carboxylic esters.

Azadirachtin is structurally similar to insect hormone “ecdysones”. These hormones typically control the process of metamorphosis when the insects pass from larva to pupa to adult. Azadirachtin mainly acts as an “ecdysone blocker”. It blocks the insect's production and release of vital hormones. As a result, insects cannot molt. Azadirachtin is also known to disturb mating and sexual communication of insects, repel larvae and adults, deter females from laying eggs, sterilize adults and deter feeding.

In some embodiments, an IA can be an Azadirachta indica compound.

In some embodiments, an IA can be an Azadirachtin; an Azadiradione; an Azadiradionolide; a Deacetylgedunin; a Deacetylazadirachtinol; a Desfuranoazadiradione; a Epoxyazadiradione; a Gedunin; a Mahmoodin; a Neemfruitin A; a Neemfruitin B; a Nimbolide; a Nimbin; a Nimolicinol; an Ohchinin Acetate; a Salannin; a Salannol; an alpha-Nimolactone; a beta-Nimolactone; a 2′,3′-Dihydrosalannin; a 3-Deacetylsalannin; a 6-Deacetylnimbin; a 7-Acetyl-16,17-dehydro-16-hydroxyneotrichilenone; a 7-Benzoylnimbocinol; a 7-Deacetyl-7-benzoylepoxyazadiradione; a 7-Deacetyl-7-benzoylgedunin; a 7-Deacetyl-17-epinimolicinol; a 15-Hydroxyazadiradione; a 17-Epi-17-Hydroxyazadiradione; a 17-Epiazadiradione; a 20,21,22,23-Tetrahydro-23-oxoazadirone; a 22,23-Dihydronimocinol; or a 28-Deoxonimbolide.

In some embodiments, an IA can be Azadirachtin.

In some embodiments, an IA can be an Azadirachtin having a chemical formula: C₃₅H₄₄O₁₆.

Exemplary methods of extracting Azadirachtin are disclosed in U.S. Pat. No. 6,312,738, entitled “Azadirachtin extraction process,” the disclosure of which is incorporated herein by reference in its entirety.

Exemplary methods of producing azadirachtin concentrates from neem seed materials are disclosed in PCT Application No. WO1995002962A1, entitled “Method for producing azadirachtin concentrates from neem seed materials,” the disclosure of which is incorporated herein by reference in its entirety.

Exemplary methods of purifying azadirachtin are disclosed in U.S. Pat. No. 5,736,145, entitled “Process for preparing purified Azadirachtin in powder form from neem seeds and storage stable aqueous composition containing Azadirachtin,” the disclosure of which is incorporated herein by reference in its entirety.

Exemplary methods of creating and storing compositions comprising azadirachtin are disclosed in U.S. Pat. No. 6,811,790, entitled “Storage stable pesticide formulations containing azadirachtin,” the disclosure of which is incorporated herein by reference in its entirety.

Exemplary methods of making and using Azadirachtin are disclosed in U.S. Pat. No. 9,635,858, entitled “Pesticide and a method of controlling a wide variety of pests,” the disclosure of which is incorporated herein by reference in its entirety.

Exemplary Azadirachtin extracts and compositions are disclosed in U.S. Pat. No. 4,943,434, entitled “Insecticidal hydrogenated neem extracts”; U.S. Pat. No. 5,411,736, entitled “Hydrophic extracted neem oil—a novel insecticide”; and U.S. Pat. No. 5,372,817, entitled “Insecticidal compositions derived from neem oil and neem wax fractions”; the disclosures of which are incorporated herein by reference in their entireties.

IAs: Boron Compounds

In some embodiments, an IA can be a boron compound.

In some embodiments, an IA may be boric acid, diboron tetrahydroxide, a borate, a boron oxide, a borane, or any combination of any of the foregoing.

In some embodiments, the IA may be a boranes and/or a borate ester that produces oxides of boron in aqueous media.

In some embodiments, the boron compound is boric acid, a borate (e.g., basic sodium borate (borax)), or a mixture of boric acid and a borate.

In some embodiments, an IA may be a borate. Suitable borates include, but are not limited to, perborates, metaborates, tetraborates, octaborates, borate esters, and any combination of any of the foregoing. Preferred borates include, but are not limited to, metallic borates (e.g., sodium borate, zinc borate and potassium borate), such as disodium tetraborate decahydrate, disodium octaborate tetrahydrate, sodium metaborate, sodium perborate monohydrate, disodium octaborate, sodium tetraborate pentahydrate, sodium tetraborate, copper metaborate, zinc borate, barium metaborate, and any combination thereof.

In some embodiments, an IA can be borax (e.g., sodium borate decahydrate-10 mol Na₂B₄O₇·10H₂O or sodium borate pentahydrate-5 mol Na₂B₄O₇·5H₂O),

In other embodiments, an IA can be a boron compound that may be utilized in effective amounts as substitutes for borax (or may be utilized in effective amounts in combination with borax or one another). For example, in some embodiments, an IA may be anhydrous borax (Na₂B₄O₇); ammonium tetraborate ((NH₄)₂B₄O₇·4H₂O); ammonium pentaborate ((NH₄)₂B₁₀O₁₆·8H₂O); potassium pentaborate (K2B₁₀O₁₆·8H₂O); potassium tetraborate (K2B₄O₇·4H₂O); sodium metaborate ((8 mol) Na₂B₂O₄·8H₂O); sodium metaborate ((4 mol) Na₂B₂O₄·4H₂O); disodium tetraborate decahydrate (Na₂B₄O₇·10H₂O); disodium tetraborate pentahydrate (Na₂B₄O₇·5H₂O); disodium octaborate tetrahydrate (Na₂B₈O₁₃·4H₂O); or combinations thereof.

In some embodiments, an IA can be a boron compound that is selected from the group consisting of: borax, boric acid, disodium octaborate, sodium borate, sodium metaborate, sodium tetraborate decahydrate, boron oxide, boron carbide, boron nitride, boron tribromide, boron trichloride, and boron trifluoride.

In some embodiments, an IA can be boric acid.

In some embodiments, an IA can be boric acid having a chemical formula of H₃BO₃.

Exemplary methods describing the production and use of boron compounds and/or boron-containing compounds are disclosed in U.S. Pat. No. 490,688, entitled “Insecticide”; U.S. Pat. No. 1,029,203, entitled “Insectifuge”; U.S. Pat. No. 1,636,688, entitled “Composition and method of preparing roach tablets”; U.S. Pat. No. 4,363,798, entitled “Termite bait composition”; U.S. Pat. No. 4,959,221, entitled “Pest exterminating composition”; U.S. Pat. No. 5,871,780, entitled “Pest-controlling composition”; and U.S. Pat. No. 8,778,372, entitled “Dual-action pest control formulation and method”; the disclosures of which are incorporated herein by reference in their entireties.

IAs: Viruses

In some embodiments, an IA can be a virus that possesses an insecticidal activity when in contact with an insect species.

In some embodiments, an IA can be a DNA virus or an RNA virus.

In some embodiments, an IA can be an ascovirus; baculovirus; densovirus; entomopoxvirus; hytrosavirus; iridovirus; nudivirus; polydnavirus; dicistrovirus; iflavirus; nodavirus; tetravirus; or cypovirus.

Ascoviridae Family Viruses

In some embodiments, an IA can be a virus from the Ascoviridae family. For example, in some embodiments, an IA can be an ascovirus such as Heliothis virescens ascovirus 3a; Heliothis virescens ascovirus 3; Heliothis virescens ascovirus 3b; Heliothis virescens ascovirus 3c; Heliothis virescens ascovirus 3d; Heliothis virescens ascovirus 3e; Heliothis virescens ascovirus 3f; Heliothis virescens ascovirus 3g; Heliothis virescens ascovirus 3h; Heliothis virescens ascovirus 3j; Spodoptera frugiperda ascovirus 1a; Trichoplusia ni ascovirus 2a; Heliothis virescens ascovirus 3i; Spodoptera ascovirus; Spodoptera exigua ascovirus 5a; Spodoptera frugiperda ascovirus 1c; Spodoptera frugiperda ascovirus 1d; Trichoplusia ni ascovirus 2b; Trichoplusia ni ascovirus 2c; Trichoplusia ni ascovirus 2d; or Trichoplusia ni ascovirus 6b.

In some embodiments, an IA can be a virus from the Ascoviridae family. For example, in some embodiments, an IA can be a toursvirus such as Diadromus pulchellus toursvirus; Diadromus pulchellus ascovirus 4a; or Dasineura jujubifolia toursvirus 2a.

Densovirinae Family Viruses

In some embodiments, an IA can be a virus from the Densovirinae family. For example, in some embodiments, an IA can be an Ambidensovirus.

In some embodiments, an IA can be an Ambidensovirus selected from the following group: Asteroid ambidensovirus 1; Sea star-associated densovirus; Blattodean ambidensovirus 1; Periplaneta fuliginosa densovirus; Periplaneta fuliginosa densovirus Guo/2000; Blattodean ambidensovirus 2; Blattella germanica densovirus 1; Decapod ambidensovirus 1; Cherax quadricarinatus densovirus; Dipteran ambidensovirus 1; Culex pipiens densovirus; Hemipteran ambidensovirus 1; Planococcus citri densovirus; Hemipteran ambidensovirus 2; Dysaphis plantaginea densovirus; Hemipteran ambidensovirus 3; Myzus persicae densovirus; Myzus persicae nicotianae densovirus; Hymenopteran ambidensovirus 1; Solenopsis invicta densovirus; Lepidopteran ambidensovirus 1; Galleria mellonella densovirus; Junonia coenia densovirus; Junonia coenia densovirus pBRJ/1990; Mythimna loreyi densovirus; Pseudoplusia includens densovirus; Orthopteran ambidensovirus 1; Acheta domestica densovirus; unclassified Ambidensovirus; Tetranychus urticae-associated ambidensovirus; unclassified Densovirus; Ambidensovirus CaaDV1; Ambidensovirus CaaDV2; Atrato Denso-like virus; Atrato Denso-like virus 1; Densovirus SC1065; Densovirus SC1118; Densovirus SC116; Densovirus SC2121; Densovirus SC2209; Densovirus SC2228; Densovirus SC2886; Densovirus SC3749; Densovirus SC3908; Densovirus SC4092; Densovirus SC444; Densovirus SC525; Diaphorina citri densovirus; Diatraea saccharalis densovirus; Lupine feces-associated densovirus; Lupine feces-associated densovirus 2; or Ambidensovirus sp.

Entomopoxvirinae Family Viruses

In some embodiments, an IA can be a virus from the Entomopoxvirinae family. For example, in some embodiments, an IA can be an Alphaentomopoxvirus; Betaentomopoxvirus; Diachasmimorpha entomopoxvirus; Melanoplus sanguinipes entomopoxvirus; or some heretofore unclassified Entomopoxvirinae.

In some embodiments, an IA can be an Entomopoxvirinae family virus selected from the following group: Anomala cuprea entomopoxvirus; Adoxophyes honmai entomopoxvirus; Adoxophyes honmai entomopoxvirus ‘L’; Amsacta moorei entomopoxvirus; Choristoneura biennis entomopoxvirus; Choristoneura fumiferana entomopoxvirus; Choristoneura rosaceana entomopoxvirus; Choristoneura rosaceana entomopoxvirus ‘L’; Heliothis armigera entomopoxvirus; Mythimna separata entomopoxvirus; Mythimna separata entomopoxvirus ‘L’; unclassified Betaentomopoxvirus; Diachasmimorpha longicaudata entomopoxvirus; Melanoplus sanguinipes entomopoxvirus ‘O’; Anacridium aegyptium entomopoxvirus; Calliptamus italicus entomopoxvirus; Chironomus decorus entomopoxvirus; Gomphocerus sibiricus entomopoxvirus; Homona coffearia entomopoxvirus; Linepithema humile entomopoxvirus 1; Oedaleus asiaticus entomopoxvirus; or Pseudaletia separata entomopoxvirus.

Iridoviridae Family Viruses

In some embodiments, an IA can be an Iridoviridae family virus, e.g., an Iridovirus.

In some embodiments, an IA can be an Iridoviridae family virus selected from the following group: Tipula iridescent virus; Invertebrate iridescent virus 31; Armadillidium vulgare iridescent virus; Popillia japonica iridescent virus; Porcellio scaber iridescent virus; Invertebrate iridescent virus 6; Gryllus bimaculatus iridovirus; unclassified Iridovirus; Acetes erythraeus iridovirus; Anticarsia gemmatalis iridescent virus; Armadillidium decorum iridescent virus; Barramundi perch iridovirus; Bluegill sunfish iridovirus; Common ponyfish iridovirus; Crimson snapper iridovirus; Decapterus macrosoma iridovirus; Gazza minuta iridovirus; Invertebrate iridescent virus 16; Costelytra zealandica iridescent virus; Invertebrate iridescent virus 2; Sericesthis iridescent virus; Invertebrate iridescent virus 23; Heteronychus arator iridescent virus; Invertebrate iridescent virus 24; Apis cerana iridescent virus; Invertebrate iridescent virus 29; Tenebrio molitor iridescent virus; Iridovirus barramundi/Quang Ninh/VNM/2008; Iridovirus IV31; Japanese sea bass iridovirus; Lagocephalus sceleratus iridovirus; Lates calcarifer iridovirus; Leiognathus splendens iridovirus; Marble goby iridovirus; Orbiculate batfish iridovirus; Parapristipoma trilineatum iridovirus; Perch iridovirus 603-2/China; Polydactylus sextarius iridovirus; Porcellio siculoccidentalis iridescent virus; Pyrrhalta luteola iridescent virus; Rana temporaria United Kingdom iridovirus 1; Rana temporaria United Kingdom iridovirus 2; Silver sea bream iridovirus; Snakehead iridovirus; Stone flounder iridovirus 603-3/China; Stone flounder iridovirus 724/China; Sturgeon iridovirus; Synodus indicus iridovirus; or Trichoniscus panormidensis iridescent virus.

Nudiviridae Family Viruses

In some embodiments, an IA can be an Nudiviridae family virus, e.g., an Alphanudivirus, a Betanudivirus, or some heretofore unclassified Nudiviridae family virus

In some embodiments, an IA can be an Nudiviridae family virus selected from the following group: Gryllus bimaculatus nudivirus; Oryctes rhinoceros nudivirus; Heliothis zea nudivirus; Helicoverpa zea nudivirus 2; Allomyrina virus; Drosophila innubila nudivirus; Drosophila nudivirus RLU-2011; Esparto virus; Homarus gammarus nudivirus; Kallithea virus; Macrobrachium nudivirus CN-SL2011; Mauternbach virus; Nilaparvata lugens endogenous nudivirus; Penaeus monodon nudivirus; Tipula oleracea nudivirus; or Tomelloso virus.

Iflaviridae Family Viruses

In some embodiments, an IA can be an Iflaviridae family virus selected from the following group: Antheraea pernyi iflavirus; Brevicoryne brassicae virus; Brevicoryne brassicae virus—UK; Deformed wing virus; Kakugo virus; VDV-1/DWV recombinant; Dinocampus coccinellae paralysis virus; Ectropis obliqua virus; Ectropis obliqua picorna-like virus; Infectious flacherie virus; Infectious flacherie virus isolate silkworm; Ixodes holocyclus iflavirus; Lygus lineolaris virus 1; Lymantria dispar iflavirus 1; Nilaparvata lugens honeydew virus 1; Perina nuda virus; Sacbrood virus; Sacbrood virus CSBV-LN/China/2009; Slow bee paralysis virus; Spodoptera exigua iflavirus 1; Spodoptera exigua iflavirus 2; Varroa destructor virus 1; unclassified Iflavirus; ACT flea iflavirus; Aedes vexans iflavirus; Armigeres iflavirus; Bat iflavirus; Bee iflavirus 1; Blackberry iflavirus A; Blackberry iflavirus B; Bombyx mori iflavirus; Breves iflavirus; Diamondback moth iflavirus; Formica exsecta virus 2; Haemaphysalis flava iflavirus; Heliconius erato iflavirus; Helicoverpa armigera iflavirus; Midge iflavirus 9000; Miniopterus fuliginosus iflavirus; Moku virus; Nasonia vitripennis virus; Pirizal iflavirus; Psammotettix alienus iflavirus 1; Rondonia iflavirus 1; Rondonia iflavirus 2; Scaphoideus titanus iflavirus 1; Scaphoideus titanus iflavirus 2; VDV-1/DWV recombinant 4; Vespa velutina Moku virus; or Xysticus cristatus iflavirus.

Baculoviridae Family Viruses

In some embodiments, an IA can be a virus from the Baculoviridae family. For example, in some embodiments, an IA can be an Alphabaculovirus, Betabaculovirus, Deltabaculovirus, Gammabaculovirus, or heretofore unclassified Baculoviridae virus.

In some embodiments, an IA can be an Alphabaculovirus virus selected from the following group: Adoxophyes honmai nucleopolyhedrovirus; Agrotis ipsilon multiple nucleopolyhedrovirus; Agrotis segetum nucleopolyhedrovirus A; Agrotis segetum nucleopolyhedrovirus B; Antheraea pernyi nucleopolyhedrovirus; Antheraea proylei nucleopolyhedrovirus; Philosamia cynthia ricini nucleopolyhedrovirus virus; Anticarsia gemmatalis multiple nucleopolyhedrovirus; Autographa californica multiple nucleopolyhedrovirus; Anagrapha falcifera MNPV; Autographa californica nucleopolyhedrovirus; Galleria mellonella MNPV; Plutella xylostella multiple nucleopolyhedrovirus; Rachiplusia nu MNPV; Rachiplusia ou MNPV; Bombyx mori nucleopolyhedrovirus; Bombyx mandarina nucleopolyhedrovirus; Bombyx mandarina nucleopolyhedrovirus S2; Bombyx mori nuclear polyhedrosis virus K1; Buzura suppressaria nucleopolyhedrovirus; Catopsilia pomona nucleopolyhedrovirus; Choristoneura fumiferana DEF multiple nucleopolyhedrovirus; Choristoneura fumiferana multiple nucleopolyhedrovirus; Choristoneura occidentalis alphabaculovirus; Choristoneura murinana nucleopolyhedrovirus; Choristoneura rosaceana nucleopolyhedrovirus; Chrysodeixis chalcites nucleopolyhedrovirus; Chrysodeixis chalcites SNPV TF1-A; Chrysodeixis includens nucleopolyhedrovirus; Pseudoplusia includens SNPV IE; Clanis bilineata nucleopolyhedrovirus; Dasychira pudibunda nucleopolyhedrovirus; Ectropis obliqua nucleopolyhedrovirus; Epiphyas postvittana nucleopolyhedrovirus; Euproctis pseudoconspersa nucleopolyhedrovirus; Helicoverpa armigera nucleopolyhedrovirus; Helicoverpa armigera NPV NNg1; Helicoverpa armigera NPV strain Australia; Helicoverpa armigera nucleopolyhedrovirus G4; Helicoverpa armigera SNPV; Helicoverpa SNPV AC53; Helicoverpa zea single nucleopolyhedrovirus; Hemileuca species nucleopolyhedrovirus; Hemileuca sp. nucleopolyhedrovirus; Hyphantria cunea nucleopolyhedrovirus; Lambdina fiscellaria nucleopolyhedrovirus; Leucania separata nucleopolyhedrovirus; Lonomia obliqua nucleopolyhedrovirus; Lonomia obliqua multiple nucleopolyhedrovirus; Lymantria dispar multiple nucleopolyhedrovirus; Lymantria xylina nucleopolyhedrovirus; Mamestra brassicae multiple nucleopolyhedrovirus; Mamestra configurata nucleopolyhedrovirus A; Mamestra configurata nucleopolyhedrovirus B; Helicoverpa armigera multiple nucleopolyhedrovirus; Maruca vitrata nucleopolyhedrovirus; Mythimna unipuncta nucleopolyhedrovirus; Operophtera brumata nucleopolyhedrovirus; Orgyia leucostigma nucleopolyhedrovirus; Orgyia pseudotsugata multiple nucleopolyhedrovirus; Oxyplax ochracea nucleopolyhedrovirus; Perigonia lusca nucleopolyhedrovirus; Perigonia lusca single nucleopolyhedrovirus; Spodoptera exigua multiple nucleopolyhedrovirus; Spodoptera exigua nuclear polyhedrosis virus (strain US); Spodoptera frugiperda multiple nucleopolyhedrovirus; Spodoptera littoralis nucleopolyhedrovirus; Spodoptera litura nucleopolyhedrovirus; Sucra jujuba nucleopolyhedrovirus; Thysanoplusia orichalcea nucleopolyhedrovirus; Trichoplusia ni single nucleopolyhedrovirus; Wiseana signata nucleopolyhedrovirus; unclassified Alphabaculovirus; Abraxas grossulariata nucleopolyhedrovirus; Actias selene nucleopolyhedrovirus; Adoxophyes orana nucleopolyhedrovirus; Agraulis vanillae MNPV; Agrotis exclamationis nucleopolyhedrovirus; Agrotis ipsilon multicapsid nucleopolyhedrovirus; Amorbia cuneacapsa nucleopolyhedrovirus; Amorbia cuneana nucleopolyhedrovirus; Ampelophaga rubiginosa nucleopolyhedrovirus; Amsacta albistriga nucleopolyhedrovirus; Anagrapha falcifera multiple nucleopolyhedrovirus; Antheraea polyphemus nucleopolyhedrovirus; Anticarsia gemmatalis nucleopolyhedrovirus; Apocheima cinerarium nucleopolyhedrovirus; Aporia crataegi nucleopolyhedrovirus; Archips cerasivoranus nuclear polyhedrosis virus; Archips rosanus nucleopolyhedrovirus; Attacus ricini nuclear polyhedrosis virus; Autographa biloba nucleopolyhedrovirus; Autographa gamma nucleopolyhedrovirus; Autographa nigrisigna nucleopolyhedrovirus; Boarmia bistortata nucleopolyhedrovirus; Bombyx mandarina nuclear polyhedrosis virus; Busseola fusca nucleopolyhedrovirus; Catposilia pomona nucleopolyhedrovirus; Cerapteryx graminis nucleopolyhedrovirus; Choristoneura diversana nucleopolyhedrovirus; Choristoneura occidentalis nucleopolyhedrovirus; Chorizagrotis auxiliaris nucleopolyhedrovirus; Chrysodeixis includens NPV; Coloradia pandora alphabaculovirus; Coloradia pandora nucleopolyhedrovirus; Condylorrhiza vestigialis MNPV; Condylorrhiza vestigialis multiple nucleopolyhedrovirus; Cryptophlebia peltastica nucleopolyhedrovirus; Cyclophragma undans nucleopolyhedrovirus; Dasychira plagiata nucleopolyhedrovirus; Dendrolimus kikuchii nucleopolyhedrovirus; Diaphania pulverulentalis nucleopolyhedrovirus; Dione Juno MNPV tmk1/ARG/2003; Dione Juno nucleopolyhedrovirus; Dirphia peruvianus nucleopolyhedrovirus; Ectropis grisescens nucleopolyhedrovirus; Epinotia granitalis nucleopolyhedrovirus; Euproctis digramma nucleopolyhedrovirus; Gilpinia hercyniae nucleopolyhedrovirus; Heliconius erato nucleopolyhedrovirus; Helicoverpa assulta nucleopolyhedrovirus; Helicoverpa gelotopoeon single nucleopolyhedrovirus; Heliothis peltigera SNPV; Heliothis zea nuclear polyhedrosis virus; Hemerocampa vetusta nucleopolyhedrovirus; Hemileuca alphabaculovirus; Hyposidra infixaria NPV; Hyposidra talaca NPV; Iragoides fasciata nucleopolyhedrovirus; Junonia coenia nucleopolyhedrovirus; Leucoma salicis nucleopolyhedrovirus; Lymantria mathura mutiple nucleopolyhedrovirus; Lymantria monacha nucleopolyhedrovirus; Lymantria xylina nucleopolyhedrovirus 2; Malacosoma alphabaculovirus; Malacosoma americanum nucleopolyhedrovirus; Malacosoma californicum nucleopolyhedrovirus; Malacosoma californicum pluviale nucleopolyhedrovirus; Malacosoma disstria nucleopolyhedrovirus; Malacosoma neustria nucleopolyhedrovirus; Mamestra configurata nucleopolyhedrovirus; Neophasia alphabaculovirus; Nepytia phantasmaria nucleopolyhedrovirus; Nymphalis io nucleopolyhedrovirus; Oak looper alphabaculovirus; Ophiusa disjungens nucleopolyhedrovirus; Orgyia anartoides nucleopolyhedrovirus; Orgyia ericae nucleopolyhedrovirus; Orgyia pseudotsugata single capsid nuclopolyhedrovirus; Panolis flammea nucleopolyhedrovirus; Peridroma alphabaculovirus; Peridroma margaritosa nucleopolyhedrovirus; Perina nuda nucleopolyhedrovirus; Phryganidia californica nucleopolyhedrovirus; Plusia acuta nucleopolyhedrovirus; Plusia orichalcea nuclear polyhedrosis virus; Plutella maculipennis nucleopolyhedrovirus; Pseudaletia alphabaculovirus; Pseudoplusia includens nucleopolyhedrovirus; Pterolocera amplicornis nucleopolyhedrovirus; Rachiplusia nu nucleopolyhedrovirus; Rachiplusia nu single nucleopolyhedrovirus; Samia cynthia nucleopolyhedrovirus; Spilarctia obliqua nucleopolyhedrovirus; Spilosoma obliqua nucleopolyhedrosis virus; Spilosoma phasma nucleopolyhedrovirus; Spodoptera cosmioides nucleopolyhedrovirus; Spodoptera eridania nucleopolyhedrovirus; Spodoptera exempta nucleopolyhedrovirus; Spodoptera littoralis multicapsid nucleopolyhedrovirus; Spodoptera litura MNPV; Spodoptera litura nucleopolyhedrovirus II; Spodoptera terricola nucleopolyhedrovirus; Tineola bisselliella nucleopolyhedrovirus; Troides aeacus nucleopolyhedrovirus; Wiseana cervinata nucleopolyhedrovirus; Agraulis sp. nucleopolyhedrovirus; Malacosoma sp. alphabaculovirus; Malacosoma sp. nucleopolyhedrovirus; Neophasia sp. alphabaculovirus; or unidentified nuclear polyhedrosis viruses.

In some embodiments, an IA can be a Betabaculovirus virus selected from the following group: Adoxophyes orana granulovirus; Agrotis segetum granulovirus; Artogeia rapae granulovirus; Pieris brassicae granulovirus; Choristoneura fumiferana granulovirus; Choristoneura occidentalis granulovirus; Clostera anachoreta granulovirus; Clostera anastomosis granulovirus A; Clostera anastomosis granulovirus Henan; Clostera anastomosis granulovirus B; Cnaphalocrocis medinalis granulovirus; Cryptophlebia leucotreta granulovirus; Cydia pomonella granulovirus; Cydia pomonella granulosis virus (isolate Mexican); Diatraea saccharalis granulovirus; Epinotia aporema granulovirus; Erinnyis ello granulovirus; Harrisina brillians granulovirus; Helicoverpa armigera granulovirus; Lacanobia oleracea granulovirus; Mocis latipes granulovirus; Mythimna unipuncta granulovirus A; Pseudalatia unipuncta granulovirus; Mythimna unipuncta granulovirus B; Mythimna unipuncta granulovirus; Phthorimaea operculella granulovirus; Plodia interpunctella granulovirus; Plutella xylostella granulovirus; Spodoptera frugiperda granulovirus; Spodoptera litura granulovirus; Trichoplusia ni granulovirus; Trichoplusia ni granulovirus LBIV-12; Xestia c-nigrum granulovirus; Achaea janata granulovirus; Adoxophyes honmai granulovirus; Agrotis exclamationis granulovirus; Amelia pallorana granulovirus; Andraca bipunctata granulovirus; Autographa gamma granulovirus; Caloptilia theivora granulovirus; Choristoneura murinana granulovirus; Choristoneura viridis betabaculovirus; Clostera anastomosis granulovirus; Cnephasia longana granulovirus; Estigmene acrea granulovirus; Euxoa ochrogaster granulovirus; Heliothis armigera granulovirus; Hoplodrina ambigua granulovirus; Hyphantria cunea granulovirus; Natada nararia granulovirus; Nephelodes emmedonia granulovirus; Pandemis limitata granulovirus; Peridorma morpontora granulovirus; Pieris rapae granulovirus; Plathypena scabra granulovirus; Pseudaletia betabaculovirus; Scotogramma trifolii granulovirus; Spodoptera androgea granulovirus; Spodoptera littoralis granulovirus; Tecia solanivora granulovirus; or Mocis sp. granulovirus.

In some embodiments, an IA can be a Deltabaculovirus virus selected from the following group: Culex nigripalpus nucleopolyhedrovirus; or Culex nigripalpus NPV Florida/1997.

In some embodiments, an IA can be a Gammabaculovirus virus selected from the following group: Neodiprion lecontei nucleopolyhedrovirus; Neodiprion lecontei NPV (strain Canada); Neodiprion sertifer nucleopolyhedrovirus; unclassified Gammabaculovirus; or Neodiprion abietis NPV.

In some embodiments, an IA can be some heretofore unclassified Baculoviridae virus selected from the following group: Achaea faber nucleopolyhedrovirus; Aedes sollicitans nucleopolyhedrovirus; Aglais urticae nucleopolyhedrovirus; Agraulis vanillae nucleopolyhedrovirus; Anomis sabulifera nucleopolyhedrovirus; Antheraea yamamai nucleopolyhedrovirus; Anthophila fabriciana granulovirus; Aroa discalis nucleopolyhedrovirus; Baculovirus penaei; Cadra cautella nucleopolyhedrovirus; Chaliopsis junodi nucleopolyhedrovirus; Cotesia marginiventris baculovirus; Cynosarga ornata nucleopolyhedrovirus; Darna nararia granulovirus; Darna trima granulovirus; Erannis defoliaria nucleopolyhedrovirus; Euplexia lucipara granulovirus; Euproctis chrysorrhoea nucleopolyhedrovirus; Euproctis similis nucleopolyhedrovirus; Gonad-specific virus; Homona coffearia granulovirus; Hyblaea puera nucleopolyhedrovirus; Idaea seriata nucleopolyhedrovirus; Junonia coenia granulovirus; Lasiocampa quercus nucleopolyhedrovirus; Lemyra imparilis nucleopolyhedrovirus; Mahasena corbetti nucleopolyhedrovirus; Melanchra persicariae granulovirus; Operophtera bruceata nucleopolyhedrovirus; Orgyia antiqua nucleopolyhedrovirus; Orgyia mixta nucleopolyhedrovirus; Pachytrina philargyria nucleopolyhedrovirus; Pareuchaetes pseudoinsulata nucleopolyhedrovirus; Penaeus monodon nucleopolyhedrovirus; Phalera bucephala nucleopolyhedrovirus; Polygonia c-album nucleopolyhedrovirus; Samia ricini nucleopolyhedrovirus; Spilosoma lutea granulovirus; Spodoptera albula nucleopolyhedrovirus; Trabala vishnou nucleopolyhedrovirus; Uranotaenia sapphirina nucleopolyhedrovirus; Urbanus proteus nucleopolyhedrovirus; Utetheisa pulchella nucleopolyhedrovirus; Vanessa atalanta nucleopolyhedrovirus; Vanessa cardui nucleopolyhedrovirus; Wiseana cervinata granulovirus; or Baculoviridae sp.

In some embodiments, an IA can be a Baculoviridae virus

In some embodiments, an IA can be a Beta baculovirus.

In some embodiments, an IA can be a Adoxophyes orana granulovirus; a Agrotis segetum granulovirus; a Artogeia rapae granulovirus; a Pieris brassicae granulovirus; a Choristoneura fumiferana granulovirus; a Choristoneura occidentalis granulovirus; a Clostera anachoreta granulovirus; a Clostera anastomosis granulovirus A; a Clostera anastomosis granulovirus Henan; a Clostera anastomosis granulovirus B; a Cnaphalocrocis medinalis granulovirus; a Cryptophlebia leucotreta granulovirus; a Cydia pomonella granulovirus; a Cydia pomonella granulosis virus (isolate Mexican); a Diatraea saccharalis granulovirus; a Epinotia aporema granulovirus; a Erinnyis ello granulovirus; a Harrisina brillians granulovirus; a Helicoverpa armigera granulovirus; a Lacanobia oleracea granulovirus; a Mocis latipes granulovirus; a Mythimna unipuncta granulovirus A; a Pseudalatia unipuncta granulovirus; a Mythimna unipuncta granulovirus B; a Mythimna unipuncta granulovirus; a Phthorimaea operculella granulovirus; a Plodia interpunctella granulovirus; a Plutella xylostella granulovirus; a Spodoptera frugiperda granulovirus; a Spodoptera litura granulovirus; a Trichoplusia ni granulovirus; a Trichoplusia ni granulovirus LBIV-12; a Xestia c-nigrum granulovirus; a unclassified Betabaculovirus; a Achaea janata granulovirus; a Adoxophyes honmai granulovirus; a Agrotis exclamationis granulovirus; a Amelia pallorana granulovirus; a Andraca bipunctata granulovirus; a Autographa gamma granulovirus; a Caloptilia theivora granulovirus; a Choristoneura murinana granulovirus; a Choristoneura viridis betabaculovirus; a Clostera anastomosis granulovirus; a Cnephasia longana granulovirus; a Estigmene acrea granulovirus; a Euxoa ochrogaster granulovirus; a Heliothis armigera granulovirus; a Hoplodrina ambigua granulovirus; a Hyphantria cunea granulovirus; a Natada nararia granulovirus; a Nephelodes emmedonia granulovirus; a Pandemis limitata granulovirus; a Peridorma morpontora granulovirus; a Pieris rapae granulovirus; a Plathypena scabra granulovirus; a Pseudaletia betabaculovirus; a Scotogramma trifolii granulovirus; a Spodoptera androgea granulovirus; a Spodoptera littoralis granulovirus; a Tecia solanivora granulovirus; or a Mocis sp. Granulovirus.

In some embodiments, an IA can be a Cydia pomonella granulovirus.

In some embodiments, an IA can be a Cydia pomonella granulovirus isolate V22 virus.

An exemplary complete genome of a Cydia pomonella granulovirus has NCBI Accession No. NC_002816.1; see also, Lugue et al., The complete sequence of the Cydia pomonella granulovirus genome. J Gen Virol. 2001 October; 82(Pt 10):2531-2547; the disclosures of which are incorporated herein by reference in their entireties.

Exemplary insect viruses, insect virus sequences, and methods for making and using the like, are described in U.S. Pat. No. 5,560,909, entitled “Insecticidal compositions and process for preparation thereof”; U.S. Pat. No. 5,023,182, entitled “Novel virus composition to protect agricultural commodities from insects”; U.S. Pat. No. 6,130,074, entitled “Recombinant insect virus with reduced capacity for host-to-host transmission in the environment and methods to produce said virus”; U.S. Pat. No. 6,177,075, entitled “Insect viruses and their uses in protecting plants”; U.S. Pat. No. 7,271,002, entitled “Production of adeno-associated virus in insect cells”; U.S. Pat. No. 6,042,843, entitled “Baculovirus for the control of insect pests”; WIPO Publication No. WO1997008197A1, entitled “DNA sequence coding for a polypeptide which enhances virus infection of host insects”; and U.S. Pat. No. 5,858,353, entitled “Insect viruses, sequences, insecticidal compositions and methods”; the disclosures of which are incorporated herein by reference in their entireties.

IAs: Bacteria and Bacterial Toxins

In some embodiments, an IA can be a bacteria that possesses insecticidal activity when in contact with an insect.

In some embodiments, an IA can be a peptide or toxin isolated from a bacteria. In some embodiments, an IA can be a bacterial toxin.

Photorhabdus and/or the Toxins Therefrom

In some embodiments, an IA can be a bacterial toxin isolated from a bacteria belonging to the Xenorhabdus genus, or Photorhabdus genus.

In some embodiments, an IA can be a Photorhabdus toxin.

In some embodiments, an IA can be a Photorhabdus toxin selected from the group consisting of: Photorhabdus akhurstii toxin; Photorhabdus asymbiotica toxin; Photorhabdus asymbiotica subsp. asymbiotica toxin; Photorhabdus asymbiotica subsp. asymbiotica ATCC 43949 toxin; Photorhabdus australis toxin; Photorhabdus australis DSM 17609 toxin; Photorhabdus bodei toxin; Photorhabdus caribbeanensis toxin; Photorhabdus cinerea toxin; Photorhabdus hainanensis toxin; Photorhabdus heterorhabditis toxin; Photorhabdus kayaii toxin; Photorhabdus khanii toxin; Photorhabdus khanii NC19 toxin; Photorhabdus khanii subsp. guanajuatensis toxin; Photorhabdus kleinii toxin; Photorhabdus laumondii toxin; Photorhabdus laumondii subsp. clarkei toxin; Photorhabdus laumondii subsp. laumondii toxin; Photorhabdus laumondii subsp. laumondii TTO1 toxin; Photorhabdus luminescens toxin; Photorhabdus luminescens BA1 toxin; Photorhabdus luminescens NBAII H75HRPL105 toxin; Photorhabdus luminescens NBAII HiPL101 toxin; Photorhabdus luminescens subsp. luminescens toxin; Photorhabdus luminescens subsp. luminescens ATCC 29999 toxin; Photorhabdus luminescens subsp. mexicana toxin; Photorhabdus luminescens subsp. sonorensis toxin; Photorhabdus namnaonensis toxin; Photorhabdus noenieputensis toxin; Photorhabdus stackebrandtii toxin; Photorhabdus tasmaniensis toxin; Photorhabdus temperata toxin; Photorhabdus temperata J3 toxin; Photorhabdus temperata subsp. phorame toxin; Photorhabdus temperata subsp. temperata toxin; Photorhabdus temperata subsp. temperata M1021 toxin; Photorhabdus temperata subsp. temperata Meg1 toxin; Photorhabdus thracensis toxin; unclassified Photorhabdus toxin; Photorhabdus sp. toxin; Photorhabdus sp. 3014 toxin; Photorhabdus sp. 3240 toxin; Photorhabdus sp. Az29 toxin; Photorhabdus sp. BS21 toxin; Photorhabdus sp. CbKj163 toxin; Photorhabdus sp. CRCIA-P01 toxin; Photorhabdus sp. ENY toxin; Photorhabdus sp. FL2122 toxin; Photorhabdus sp. FL480 toxin; Photorhabdus sp. FsIw96 toxin; Photorhabdus sp. GDd233 toxin; Photorhabdus sp. H3086 toxin; Photorhabdus sp. H3107 toxin; Photorhabdus sp. H3240 toxin; Photorhabdus sp. HB301 toxin; Photorhabdus sp. HB78 toxin; Photorhabdus sp. HB89 toxin; Photorhabdus sp. HIT toxin; Photorhabdus sp. HO1 toxin; Photorhabdus sp. HUG-39 toxin; Photorhabdus sp. IT toxin; Photorhabdus sp. JUN toxin; Photorhabdus sp. KcTs129 toxin; Photorhabdus sp. KJ13.1 TH toxin; Photorhabdus sp. KJ14.3 TH toxin; Photorhabdus sp. KJ24.5 TH toxin; Photorhabdus sp. KJ29.1 TH toxin; Photorhabdus sp. KJ37.1 TH toxin; Photorhabdus sp. KJ7.1 TH toxin; Photorhabdus sp. KJ8.2 TH toxin; Photorhabdus sp. KJ9.1 TH toxin; Photorhabdus sp. KJ9.2 TH toxin; Photorhabdus sp. KK1.3 TH toxin; Photorhabdus sp. KK1.4 TH toxin; Photorhabdus sp. KMD74 toxin; Photorhabdus sp. KOH toxin; Photorhabdus sp. MID10 toxin; Photorhabdus sp. MOL toxin; Photorhabdus sp. MSW 058 toxin; Photorhabdus sp. MSW 079 toxin; Photorhabdus sp. NK2.1 TH toxin; Photorhabdus sp. NK2.5 TH toxin; Photorhabdus sp. NnMt2h toxin; Photorhabdus sp. NP1 toxin; Photorhabdus sp. OH10 toxin; Photorhabdus sp. OnIr40 toxin; Photorhabdus sp. OnKn2 toxin; Photorhabdus sp. PB10.1 TH toxin; Photorhabdus sp. PB16.3 TH toxin; Photorhabdus sp. PB17.1 TH toxin; Photorhabdus sp. PB17.3 TH toxin; Photorhabdus sp. PB2.5 TH toxin; Photorhabdus sp. PB22.4 TH toxin; Photorhabdus sp. PB22.5 TH toxin; Photorhabdus sp. PB32.1 TH toxin; Photorhabdus sp. PB33.1 TH toxin; Photorhabdus sp. PB33.4 TH toxin; Photorhabdus sp. PB37.4 TH toxin; Photorhabdus sp. PB39.2 TH toxin; Photorhabdus sp. PB4.5 TH toxin; Photorhabdus sp. PB41.4 TH toxin; Photorhabdus sp. PB45.5 TH toxin; Photorhabdus sp. PB47.1 TH toxin; Photorhabdus sp. PB47.3 TH toxin; Photorhabdus sp. PB5.1 TH toxin; Photorhabdus sp. PB5.4 TH toxin; Photorhabdus sp. PB50.4 TH toxin; Photorhabdus sp. PB51.4 TH toxin; Photorhabdus sp. PB52.2 TH toxin; Photorhabdus sp. PB54.4 TH toxin; Photorhabdus sp. PB58.2 TH toxin; Photorhabdus sp. PB58.4 TH toxin; Photorhabdus sp. PB58.5 TH toxin; Photorhabdus sp. PB59.2 TH toxin; Photorhabdus sp. PB6.5 TH toxin; Photorhabdus sp. PB67.2 TH toxin; Photorhabdus sp. PB67.4 TH toxin; Photorhabdus sp. PB68.1 TH toxin; Photorhabdus sp. PB7.5 TH toxin; Photorhabdus sp. PB76.1 TH toxin; Photorhabdus sp. PB76.4 TH toxin; Photorhabdus sp. PB76.5 TH toxin; Photorhabdus sp. PB78.2 TH toxin; Photorhabdus sp. PB80.3 TH toxin; Photorhabdus sp. PB80.4 TH toxin; Photorhabdus sp. Pjun toxin; Photorhabdus sp. RW14-46 toxin; Photorhabdus sp. S10-54 toxin; Photorhabdus sp. S12-55 toxin; Photorhabdus sp. S14-60 toxin; Photorhabdus sp. S15-56 toxin; Photorhabdus sp. S5P8-50 toxin; Photorhabdus sp. S7-51 toxin; Photorhabdus sp. S8-52 toxin; Photorhabdus sp. S9-53 toxin; Photorhabdus sp. SJ2 toxin; Photorhabdus sp. SN259 toxin; Photorhabdus sp. SP1.5 TH toxin; Photorhabdus sp. SP16.4 TH toxin; Photorhabdus sp. SP21.5 TH toxin; Photorhabdus sp. SP3.4 TH toxin; Photorhabdus sp. SP4.5 TH toxin; Photorhabdus sp. SP7.3 TH toxin; Photorhabdus sp. TyKb140 toxin; Photorhabdus sp. UK76 toxin; Photorhabdus sp. VMG toxin; Photorhabdus sp. WA21C toxin; Photorhabdus sp. WkSs43 toxin; Photorhabdus sp. Wx13 toxin; Photorhabdus sp. X₄ toxin; Photorhabdus sp. YNb90 toxin; and Photorhabdus sp. ZM toxin.

In some embodiments, an IA can be a Photorhabdus luminescens toxin.

In some embodiments, an IA can be a Photorhabdus luminescens toxin, wherein the Photorhabdus luminescens toxin comprises a Photorhabdus luminescens “toxin complex a” (Tca).

In some embodiments, an IA can be a Photorhabdus luminescens toxin, wherein the Photorhabdus luminescens toxin comprises a Photorhabdus luminescens “toxin complex c” (Tcc).

In some embodiments, an IA can be a Photorhabdus luminescens toxin, wherein the Photorhabdus luminescens toxin comprises a Photorhabdus luminescens “toxin complex d” (Tcd).

In some embodiments, an IA can be a Tca comprises a TcaA protein (SEQ ID NO: 616), a TcaB protein (SEQ ID NO: 617), a TcaC protein (SEQ ID NO: 618), and a TcaZ protein (SEQ ID NO: 619).

Exemplary Photorhabdus luminescens toxin peptides, nucleotides, sequences, and methods of making and using the same, are described in U.S. Pat. No. 7,491,698, entitled “Mixing and matching TC proteins for pest control”; U.S. Pat. No. 6,281,413, entitled “Insecticidal toxins from Photorhabdus luminescens and nucleic acid sequences coding therefor”; U.S. Pat. No. 6,630,619, entitled, “Toxin genes from the bacteria Xenorhabdus nematophilus and Photorhabdus luminescens”; U.S. Pat. No. 6,528,484, entitled “Insecticidal protein toxins from Photorhabdus”; U.S. Pat. No. 7,777,100, entitled “DNA sequences from tcd genomic region of Photorhabdus luminescens”; U.S. Pat. No. 7,161,062, entitled “DNA Sequences from Photorhabdus luminescens”; U.S. Patent Application Publication No. 20030207806, entitled “Insecticidal protein toxins from Photorhabdus”; U.S. Patent Application Publication No. 20070020625 A1, entitled “Sequence of the Photorhabdus luminescens strain tt01 genome and uses”; and U.S. Pat. No. 7,268,275, entitled “tcdB2 protein from Photorhabdus luminescens W-14”; the disclosures of which are incorporated herein by reference in their entireties.

Yersinia Organisms, and the Products Therefrom

In some embodiments, an IA can be one or more organisms belonging to the Yersinia genus.

In some embodiments, an IA can be one or more peptides isolated from an organism belonging to the Yersinia genus.

In some embodiments, an IA can be one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, an IA can be one or more peptides isolated from one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, an IA can be Yersinia entomophaga or Yersinia nurmii.

In some embodiments, an IA can be one or more peptides isolated from Yersinia entomophaga or Yersinia nurmii.

Briefly, Yersinia entomophaga is a gram-negative, rod-shaped, non-spore-forming bacterium isolated from diseased larvae of the New Zealand grass grub. Likewise, Yersinia nurmii is also a gram-negative, rod-shaped strain, albeit originating from broiler meat packaged under a modified atmosphere. See Hurst et al., The main virulence determinant of Yersinia entomophaga MH96 is a broad-host-range toxin complex active against insects. J Bacteriol. 2011 April; 193(8):1966-80; and Landsberg et al., 3D structure of the Yersinia entomophaga toxin complex and implications for insecticidal activity. Proc Natl Acad Sci USA. 2011 Dec. 20; 108(51):20544-9.

In some embodiments, an IA can be a Yersinia entomophaga bacteria, and/or a toxin therefrom.

In some embodiments, an IA can be one or more Yersinia nurmii bacteria, and/or a toxin therefrom.

In some embodiments, an IA can be one or more Yersinia entomophaga bacteria and/or a toxin therefrom, and one or more Yersinia nurmii bacteria and/or a toxin therefrom.

Exemplary methods of making and using Yersinia- and Yersinia-toxin-containing mixtures is disclosed in PCT Application No. WO2018175677A1, entitled “COMBINATIONS OF YERSINIA ENTOMOPHAGA AND PESTICIDES OR OTHER SUBSTANCES” (Assignee: Novozymes Bioag A/S), the disclosure of which is incorporated herein by reference in its entirety.

Bacillus thuringiensis Organisms, and the Products Therefrom

“Bt” are the initials for a bacterium called Bacillus thuringiensis. The Bt bacteria produces a family of peptides that are toxic to many insects. The Bt toxic peptides are well known for their ability to produce parasporal crystalline protein inclusions (usually referred to as crystals) that fall under two major classes of toxins; cytolysins (Cyt) and crystal Bt proteins (Cry). Since the cloning and sequencing of the first crystal proteins genes in the early-1980s, many others have been characterized and are now classified according to the nomenclature of Crickmore et al. (1998). Generally, Cyt proteins are toxic towards the insect orders Coleoptera (beetles) and Diptera (flies), and Cry proteins target Lepidopterans (moths and butterflies). Cry proteins bind to specific receptors on the membranes of mid-gut (epithelial) cells resulting in rupture of those cells. If a Cry protein cannot find a specific receptor on the epithelial cell to which it can bind, then it is not toxic. Bt strains can have different complements of Cyt and Cry proteins, thus defining their host ranges. The genes encoding many Cry proteins have been identified.

Currently there are four main pathotypes of insecticidal Bt parasporal peptides based on order specificity: Lepidoptera-specific (CryI, now Cry1), Coleoptera-specific (CryIII, now Cry3), Diptera-specific (CryIV, now Cry4, Cry 10, Cry11; and CytA, now Cyt1A), and CryII (Now Cry2), the only family known at that time to have dual (Lepidoptera and Diptera) specificity. Cross-order activity is now apparent in many cases.

The nomenclature assigns holotype sequences a unique name which incorporates ranks based on the degree of divergence, with the boundaries between the primary (Arabic numeral), secondary (uppercase letter), and tertiary (lower case letter) rank representing approximately 95%, 78% and 45% identities. A fourth rank (another Arabic number) is used to indicate independent isolations of holotype toxin genes with sequences that are identical or differ only slightly. Currently, the nomenclature distinguishes 174 holotype sequences that are grouping in 55 cry and 2 cyt families (Crickmore, N., Zeigler, D. R., Schnepf, E., Van Rie, J., Lereclus, D., Daum, J, Bravo, A., Dean, D. H., B. thuringiensis toxin nomenclature). Any of these crystal proteins and the genes that produce them may be used to produce a suitable Bt related toxin for this invention.

Also included in the descriptions of this invention are families of highly related crystal proteins produced by other bacteria: Cry16 and Cry17 from Clostridium bifermentans (Barloy et al., 1996, 1998), Cry 18 from Bacillus popilliae (Zhang et al., 1997), Cry43 from Paenibacillus lentimorbis (Yokoyama et al., 2004) and the binary Cry48/Cry49 produced by Bacillus sphaericus (Jones et al., 2008). Other crystalline or secreted pesticidal proteins, such as the S-layer proteins (Pena et al., 2006) that are included here are, genetically altered crystal proteins, except those that were modified through single amino acid substitutions (e.g., Lambert et al., 1996). Any of these genes may be used to produce a suitable Bt related toxin for this invention.

Naturally occurring allelic variants can be identified with the use of well-known molecular biology techniques, such as polymerase chain reaction (PCR) and hybridization techniques as outlined below. Variant nucleotide sequences also include synthetically derived nucleotide sequences that have been generated, for example, by using site-directed mutagenesis but which still encode the Bt protein proteins disclosed in the present disclosure as discussed below. Variant proteins encompassed by the present disclosure are biologically active, that is they continue to possess the desired biological activity of the native protein, i.e., retaining pesticidal activity. By “retains activity” is intended that the variant will have at least about 30%, at least about 50%, at least about 70%, or at least about 80% of the pesticidal activity of the native protein. Methods for measuring pesticidal activity are well known in the art. See, for example, Czapla and Lang (1990) J. Econ. Entomol. 83: 2480-2485; Andrews et al. (1988) Biochem. J. 252:199-206; Marrone et al. (1985) J. of Economic Entomology 78:290-293; and U.S. Pat. No. 5,743,477, all of which are herein incorporated by reference in their entirety, and all sequences identified by number specifically incorporated by reference.

Bt proteins and gene descriptions are described below in the following the following tables, which contain the Bt toxin and corresponding reference, each of which is incorporated by reference in its entirety.

TABLE 4
Bt Toxins and References.

| Toxin | Patents or Patent Publication Number |
|---|---|
| Cry1 | US2003046726, U.S. Pat. No. 6,833,449, |
| | CN1260397, US201026939, |
| | US2006174372, US2006174372, |
| | US642241, U.S. Pat. No. 6,229,004, |
| | US2004194165, U.S. Pat. No. 6,573,240, |
| | U.S. Pat. No. 5,424,409, U.S. Pat. No. 5,407,825, |
| | U.S. Pat. No. 5,135,867, U.S. Pat. No. 5,055,294, |
| Cry1 | WO2007107302, U.S. Pat. No. 6,855,873, |
| | WO2004020636, US2007061919, |
| | U.S. Pat. No. 6,048,839, US2007061919, |
| | AU784649B, US2007061919, U.S. Pat. No. 6,150,589, |
| | U.S. Pat. No. 5,679,343, U.S. Pat. No. 5,616,319, U.S. Pat. No. |
| | 5,322,687, |
| Cry1 | WO2007107302, US2006174372, |
| | US2005091714, US2004058860, |
| | US2008020968, U.S. Pat. No. 6,043,415, U.S. Pat. No. |
| | 5,942,664, |
| Cry1 | WO2007107302, US2007061919, |
| | U.S. Pat. No. 6,172,281, |
| Cry1 | WO03082910, MX9606262, U.S. Pat. No. 5,530,195, |
| | U.S. Pat. No. 5,407,825, U.S. Pat. No. 5,045,469, |
| Cry1 | US2006174372, |
| Cry1 | US2007061919, |
| Cry1 | US2007061919, |
| Cry1 | US2007061919, CN1401772, U.S. Pat. No. 6,063,605, |
| Cry1 | US2007061919, AU784649B, U.S. Pat. No. 5,723,758, |
| | U.S. Pat. No. 5,616,319, U.S. Pat. No. 5,356,623, U.S. Pat. No. |
| | 5,322,687 |
| Cry1 | U.S. Pat. No. 5,723,758 |
| Cry2 | CN1942582, WO9840490, |
| | US2007061919, UA75570, |
| | MXPA03006130, US2003167517, |
| | U.S. Pat. No. 6,107,278, U.S. Pat. No. 6,096,708, U.S. Pat. No. |
| | 5,073,632, U.S. Pat. No. 7,208,474, U.S. Pat. No. 7,244,880, |
| Cry3 | US2002152496, RU2278161, |
| | US2003054391, |
| Cry3 | U.S. Pat. No. 5,837,237, U.S. Pat. No. 5,723,756, U.S. Pat. No. |
| | 5,683,691, U.S. Pat. No. 5,104,974, U.S. Pat. No. 4,996,155, |
| Cry3 | U.S. Pat. No. 5,837,237, U.S. Pat. No. 5,723,756, |
| Cry5 | WO9840491, US2004018982, U.S. Pat. No. 6,166,195, |
| | US2001010932, U.S. Pat. No. 5,985,831, U.S. Pat. No. |
| | 5,824,792, US528153 |
| Cry5 | WO2007062064, US2001010932, |
| | U.S. Pat. No. 5,824,792, |
| Cry6 | WO2007062064, US2004018982, |
| | U.S. Pat. No. 5,973,231, U.S. Pat. No. 5,874,288, U.S. Pat. No. |
| | 5,236,843, US683106 |
| Cry6 | US2004018982, U.S. Pat. No. 6,166,195, |
| Cry7 | U.S. Pat. No. 6,048,839, U.S. Pat. No. 5,683,691, U.S. Pat. No. |
| | 5,378,625, US518709 |
| Cry7 | CN195215 |
| Cry8 | |
| Cry8 | |
| Cry8 | US200301796 |
| Cry8 | WO2006053473, US2007245430, |
| Cry8 | WO200605347 |
| Cry9 | US2007061919, |
| Cry9 | WO200506620 |
| Cry9 | US2007061919, U.S. Pat. No. 6,448,226, |
| | US2005097635, WO2005066202, |
| | U.S. Pat. No. 6,143,550, U.S. Pat. No. 6,028,246, U.S. Pat. No. |
| | 6,727,409, |
| Cry9 | US2005097635, WO2005066202, |
| Cry9 | U.S. Pat. No. 6,570,005, |
| Cry9 | AU784649B, US2007074308, |
| | US736180 |
| Cry11 | MXPA0200870 |
| Cry12 | US2004018982, U.S. Pat. No. 6,166,195, |
| | U.S. Pat. No. 6,077,937, U.S. Pat. No. 5,824,792, U.S. Pat. No. |
| | 5,753,492, |
| Cry13 | US2004018982, U.S. Pat. No. 6,166,195, |
| | U.S. Pat. No. 6,077,937, U.S. Pat. No. 5,824,792, U.S. Pat. No. |
| | 5,753,492, |
| Cry14 | JP2007006895, U.S. Pat. No. 5,831,011, |
| Cry21 | U.S. Pat. No. 5,831,011, U.S. Pat. No. 5,670,365, |
| Cry22 | US2006218666, US2001010932, |
| | MXPA01004361, U.S. Pat. No. 5,824,792, |
| Cry22 | US2003229919, |
| Cry23 | US2006051822, US2003144192, |
| | UA75317, U.S. Pat. No. 6,399,330, U.S. Pat. No. 6,326,351, |
| | U.S. Pat. No. 6,949,626, |
| Cry26 | US200315001 |
| Cry28 | US200315001 |
| Cry31 | CA2410153, |
| Cry34 | US200316752 |
| Cry35 | US2003167522, |
| Cry37 | US2006051822, US2003144192, |
| | UA75317, U.S. Pat. No. 6,399,330, U.S. Pat. No. 6,326,351, |
| | U.S. Pat. No. 6,949,626, |
| Cry43 | US200527164 |
| Cyt1 | WO2007027776, |
| Cyt1 | U.S. Pat. No. 6,150,165, |
| Cyt2 | US2007163000, EP1681351, |
| | U.S. Pat. No. 6,686,452, U.S. Pat. No. 6,537,756, |

TABLE 5
Hybrid Insecticidal Crystal Proteins and Patents.

| Patent No. | Holotype Toxin |
|---|---|
| US2008020967 | Cry29Aa |
| US2008040827 | Cry1Ca |
| US2007245430 | Cry8Aa |
| US2008016596 | Cry8Aa |
| US2008020968 | Cry1Cb |

TABLE 6
Patents Relating to Other Hybrid Insecticidal Crystal Proteins.

| Holotype Toxin | Patent No. |
|---|---|
| Cry23A, Cry37A | U.S. Pat. No. 7,214,788 |
| Cry1A | U.S. Pat. No. 7,019,197 |
| Cry1A, Cry1B | U.S. Pat. No. 6,320,100 |
| Cry1A, Cry1C | AU2001285900B |
| Cry23A, Cry37A | US2007208168 |
| Cry3A, Cry1I, Cry1B | WO0134811 |
| Cry3A, Cry3B, Cry3C | US2004033523 |
| Cry1A, Cry1C, Cry1E, Cry1G | U.S. Pat. No. 6,780,408 |
| Cry1A, Cry1F | US2008047034 |

Novel mixtures, formulations, and/or compositions comprising a CRIP and an IA can be used to control, kill and/or inhibit pests such as insects.

In some embodiments, an IA can be a Bacillus thuringiensis organism.

In some embodiments, an IA can be a Bacillus thuringiensis toxin.

In some embodiments, an IA can be a Bacillus thuringiensis subspecies. For example, in some embodiments, the Bacillus thuringiensis subspecies can be one of the following subspecies: aizawai; aizawai/pacificus; alesti; amagiensis; andalousiensis; argentinensis; asturiensis; azorensis; balearica; berliner; bolivia; brasilensis; cameroun; canadensis; chanpaisis; chinensis; colmeri; coreanensis; dakota; darmstadiensis; dendrolimus; entomocidus; entomocidus/subtoxicus; finitimus; fukuokaensis; galechiae; galleriae; graciosensis; guiyangiensis; higo; huazhongensis; iberica; indiana; israelensis; israelensis/tochigiensis; japonensis; jegathesan; jinghongiensis; kenyae; kim; kumamtoensis; kurstaki; kyushuensis; leesis; londrina; malayensis; medellin; mexicanensis; mogi; monterrey; morrisoni; muju; navarrensis; neoleonensis; nigeriensis; novosibirsk, ostriniae; oswaldocruzi; pahangi; pakistani; palmanyolensis; pingluonsis; pirenaica; poloniensis; pondicheriensis; pulsiensis; rongseni; roskildiensis; san diego; seoulensis; shandongiensis; silo; sinensis; sooncheon; sotto; sotto/dendrolimus; subtoxicus; sumiyoshiensis; sylvestriensis; tenebrionis; thailandensis; thompsoni; thuringiensis; tochigiensis; toguchini; tohokuensis; tolworthi; toumanoffi; vazensis; wratislaviensis; wuhanensis; xiaguangiensis; yosoo; yunnanensis; zhaodongensis; str. Al Hakam; or konkukian.

In some embodiments, an IA can be a Bacillus thuringiensis var. or varietas. For example, in some embodiments, an IA can be a Bacillus thuringiensis var. selected from the following group: Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kurstaki; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. tenebrionis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; Bacillus thuringiensis str. Al Hakam; Bacillus thuringiensis T01-328; Bacillus thuringiensis YBT-1518; or Bacillus thuringiensis var. konkukian.

In some embodiments, an IA can be a Bacillus thuringiensis serovar. For example, in some embodiments, an IA can be a Bacillus thuringiensis serovar selected from the following group: Bacillus thuringiensis AKS-7; Bacillus thuringiensis Bt18247; Bacillus thuringiensis Bt18679; Bacillus thuringiensis Bt407; Bacillus thuringiensis DAR 81934; Bacillus thuringiensis DB27; Bacillus thuringiensis F14-1; Bacillus thuringiensis FC1; Bacillus thuringiensis FC10; Bacillus thuringiensis FC2; Bacillus thuringiensis FC6; Bacillus thuringiensis FC7; Bacillus thuringiensis FCB; Bacillus thuringiensis FC9; Bacillus thuringiensis HD-771; Bacillus thuringiensis HD-789; Bacillus thuringiensis HD1002; Bacillus thuringiensis IBL 200; Bacillus thuringiensis IBL 4222; Bacillus thuringiensis IM-Mgvxx-63; Bacillus thuringiensis LDC 391; Bacillus thuringiensis LM1212; Bacillus thuringiensis MC28; Bacillus thuringiensis Sbt003; Bacillus thuringiensis serovar aizawai; Bacillus thuringiensis serovar aizawai/pacificus; Bacillus thuringiensis serovar alesti; Bacillus thuringiensis serovar amagiensis; Bacillus thuringiensis serovar andalousiensis; Bacillus thuringiensis serovar argentinensis; Bacillus thuringiensis serovar asturiensis; Bacillus thuringiensis serovar azorensis; Bacillus thuringiensis serovar balearica; Bacillus thuringiensis serovar berliner; Bacillus thuringiensis serovar bolivia; Bacillus thuringiensis serovar brasilensis; Bacillus thuringiensis serovar cameroun; Bacillus thuringiensis serovar canadensis; Bacillus thuringiensis serovar chanpaisis; Bacillus thuringiensis serovar chinensis; Bacillus thuringiensis serovar colmeri; Bacillus thuringiensis serovar coreanensis; Bacillus thuringiensis serovar dakota; Bacillus thuringiensis serovar darmstadiensis; Bacillus thuringiensis serovar dendrolimus; Bacillus thuringiensis serovar entomocidus; Bacillus thuringiensis serovar entomocidus/subtoxicus; Bacillus thuringiensis serovar finitimus; Bacillus thuringiensis serovar fukuokaensis; Bacillus thuringiensis serovar galechiae; Bacillus thuringiensis serovar galleriae; Bacillus thuringiensis serovar graciosensis; Bacillus thuringiensis serovar guiyangiensis; Bacillus thuringiensis serovar higo; Bacillus thuringiensis serovar huazhongensis; Bacillus thuringiensis serovar iberica; Bacillus thuringiensis serovar indiana; Bacillus thuringiensis serovar israelensis; Bacillus thuringiensis serovar israelensis/tochigiensis; Bacillus thuringiensis serovar japonensis; Bacillus thuringiensis serovar jegathesan; Bacillus thuringiensis serovar jinghongiensis; Bacillus thuringiensis serovar kenyae; Bacillus thuringiensis serovar kim; Bacillus thuringiensis serovar kumamtoensis; Bacillus thuringiensis serovar kunthalanags3; Bacillus thuringiensis serovar kunthalaRX24; Bacillus thuringiensis serovar kunthalaRX27; Bacillus thuringiensis serovar kunthalaRX28; Bacillus thuringiensis serovar kurstaki; Bacillus thuringiensis serovar kyushuensis; Bacillus thuringiensis serovar leesis; Bacillus thuringiensis serovar londrina; Bacillus thuringiensis serovar malayensis; Bacillus thuringiensis serovar medellin; Bacillus thuringiensis serovar mexicanensis; Bacillus thuringiensis serovar mogi; Bacillus thuringiensis serovar monterrey; Bacillus thuringiensis serovar morrisoni; Bacillus thuringiensis serovar muju; Bacillus thuringiensis serovar navarrensis; Bacillus thuringiensis serovar neoleonensis; Bacillus thuringiensis serovar nigeriensis; Bacillus thuringiensis serovar novosibirsk; Bacillus thuringiensis serovar ostriniae; Bacillus thuringiensis serovar oswaldocruzi; Bacillus thuringiensis serovar pahangi; Bacillus thuringiensis serovar pakistani; Bacillus thuringiensis serovar palmanyolensis; Bacillus thuringiensis serovar pingluonsis; Bacillus thuringiensis serovar pirenaica; Bacillus thuringiensis serovar poloniensis; Bacillus thuringiensis serovar pondicheriensis; Bacillus thuringiensis serovar pulsiensis; Bacillus thuringiensis serovar rongseni; Bacillus thuringiensis serovar roskildiensis; Bacillus thuringiensis serovar san diego; Bacillus thuringiensis serovar seoulensis; Bacillus thuringiensis serovar shandongiensis; Bacillus thuringiensis serovar silo; Bacillus thuringiensis serovar sinensis; Bacillus thuringiensis serovar sooncheon; Bacillus thuringiensis serovar sotto; Bacillus thuringiensis serovar sotto/dendrolimus; Bacillus thuringiensis serovar subtoxicus; Bacillus thuringiensis serovar sumiyoshiensis; Bacillus thuringiensis serovar sylvestriensis; Bacillus thuringiensis serovar tenebrionis; Bacillus thuringiensis serovar thailandensis; Bacillus thuringiensis serovar thompsoni; Bacillus thuringiensis serovar thuringiensis; Bacillus thuringiensis serovar tochigiensis; Bacillus thuringiensis serovar toguchini; Bacillus thuringiensis serovar tohokuensis; Bacillus thuringiensis serovar tolworthi; Bacillus thuringiensis serovar toumanoffi; Bacillus thuringiensis serovar vazensis; Bacillus thuringiensis serovar wratislaviensis; Bacillus thuringiensis serovar wuhanensis; Bacillus thuringiensis serovar xiaguangiensis; Bacillus thuringiensis serovar yosoo; Bacillus thuringiensis serovar yunnanensis; Bacillus thuringiensis serovar zhaodongensis; Bacillus thuringiensis str. Al Hakam; Bacillus thuringiensis T01-328; Bacillus thuringiensis YBT-1518; and Bacillus thuringiensis serovar konkukian.

In some preferred embodiments, an IA can be a one of the following organisms: Bacillus thuringiensis var. israelensis, Bacillus thuringiensis var. aizawai, Bacillus thuringiensis var. kurstaki, or Bacillus thuringiensis var. tenebrionensis.

In some embodiments, an IA can be a protein isolated from Bacillus thuringiensis. For example, in some embodiments, the IA can be a toxin isolated from Bacillus thuringiensis var. israelensis, Bacillus thuringiensis var. aizawai, Bacillus thuringiensis var. kurstaki, or Bacillus thuringiensis var. tenebrionensis.

In some embodiments, an IA can be a MTX2 toxin, e.g., a MTX2 toxin isolated from Lysinibacillus sphaericus.

In some embodiments, an IA can be a Bin-like toxin, e.g., a Bin-like toxin isolated from Lysinibacillus sphaericus.

In some embodiments, an IA can be a Bacillus thuringiensis var. israelensis (Bti) toxin.

In some embodiments, an IA can be a Bacillus thuringiensis ssp. israelensis Strain BMP 144 Bti toxin.

In some embodiments, an IA can be a Bacillus thuringiensis var. kurstaki (Btk) toxin.

In some embodiments, an IA can be a Bacillus thuringiensis ssp. kurstaki strain EVB-113-19 Btk toxin.

In some embodiments, an IA can be a Bacillus thuringiensis var. tenebrionis (Btt) toxin.

In some embodiments, an IA can be a Bacillus thuringiensis ssp. tenebrionis strain NB-176 Btt toxin.

In some embodiments, the IA isolated from a Bacillus thuringiensis can be contained in a commercially available product. For example, in some embodiments, the commercially available product comprising an IA can be AQUABAC XT® from Becker Microbial Products, Inc.; NOVODOR® FC from VALENT® U.S.A. LLC Agricultural Products; and/or BioProtec Plus™ from AEF Global Inc.

In some embodiments, an IA can be one or more Bacillus thuringiensis ssp. kurstaki strain EVB-113-19 cells.

In some embodiments, an IA can be one or more fermentation solids, spores, and/or insecticidal toxins isolated from Bacillus thuringiensis ssp. kurstaki strain EVB-113-19 cells.

In some embodiments, an IA can be one or more Bacillus thuringiensis ssp. tenebrionis strain NB-176 cells.

In some embodiments, an IA can be one or more fermentation solids, spores, and/or insecticidal toxins isolated from Bacillus thuringiensis ssp. tenebrionis strain NB-176 cells.

In some embodiments, an IA can be one or more Bacillus thuringiensis ssp. israelensis Strain BMP 144 cells.

In some embodiments, an IA can be one or more fermentation solids, spores, and/or insecticidal toxins isolated from Bacillus thuringiensis ssp. israelensis Strain BMP 144 cells.

In some embodiments, an IA can be AQUABAC XT®, consisting of the following ingredients: 6-10% (˜8%) Bacillus thuringiensis ssp. israelensis Strain BMP 144 solids, spores & insecticidal toxins, wherein said insecticidal toxins are δ-endotoxins, and equivalent to 1,200 International Toxic Units (ITU/mg) (4.84 Billion ITU/gallon or 1.2 Billion ITU/Liter); and ˜92% other/inactive ingredients.

In some embodiments, an IA can be NOVODOR® FC (or flowable concentrate), consisting of 10% Bacillus thuringiensis ssp. tenebrionis strain NB-176 fermentation solids and solubles, with a potency of 15,000 Leptinotarsa Units (LTU) per gram of product (equivalent to 16.3 Million LTU's per quart of product); and 90% other/inactive ingredients.

In some embodiments, an IA can be BioProtec Plus™, consisting of 14.49% Bacillus thuringiensis ssp. kurstaki strain EVB-113-19 fermentation solids, spores, and insecticidal toxins with a potency of 17,500 Cabbage Looper Units (CLU) per mg of product (equivalent to 76 billion CLU per gallon of product); and 85.51% other/inactive ingredients.

In some embodiments, an IA can be a Bt toxin, wherein said Bt toxin is a 6-endotoxin (e.g., a Crystal (Cry) toxin and/or a cytolytic (Cyt) toxin); a vegetative insecticidal protein (Vip); a secreted insecticidal protein (Sip); or a Bin-like toxin.

In some embodiments, an IA can be a Bt toxin having amino acid sequence as set forth in any one of SEQ ID NOs: 412-587.

In some embodiments, an IA can be a Cry protein having amino acid sequence as set forth in any one of SEQ ID NOs: 412-461.

In some embodiments, an IA can be a Cyt protein having amino acid sequence as set forth in any one of SEQ ID NOs: 462-481.

In some embodiments, an IA can be a Vip having amino acid sequence as set forth in any one of SEQ ID NOs: 482-587.

In some embodiments, an IA can be one or more of the following Cry proteins: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ja1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, and/or Cry78Aa1.

In some embodiments, an IA can be any of the Cry toxins as described herein, or presented in Table 7.

TABLE 7
Non-limiting examples of Cry toxins, their accession numbers
on NCBI, and strain. Here, if a cell is left blank, then the
accession number and/or strain is not applicable.

| Name | NCBI Accession No. | Strain/Other ID |
|---|---|---|
| Cry1Aa1 | AAA22353 | Bt kurstaki HD1 |
| Cry1Aa2 | AAA22552 | Bt sotto |
| Cry1Aa3 | BAA00257 | Bt aizawai IPL7 |
| Cry1Aa4 | CAA31886 | Bt entomocidus |
| Cry1Aa5 | BAA04468 | Bt Fu-2-7 |
| Cry1Aa6 | AAA86265 | Bt kurstaki NRD-12 |
| Cry1Aa7 | AAD46139 | Bt C12 |
| Cry1Aa8 | I26149 | |
| Cry1Aa9 | BAA77213 | Bt dendrolimus T84A1 |
| Cry1Aa10 | AAD55382 | Bt kurstaki HD-1-02 |
| Cry1Aa11 | CAA70856 | Bt kurstaki |
| Cry1Aa12 | AAP80146 | Bt Ly30 |
| Cry1Aa13 | AAM44305 | Bt sotto |
| Cry1Aa14 | AAP40639 | unpublished |
| Cry1Aa15 | AAY66993 | Bt INTA Mol-12 |
| Cry1Aa16 | HQ439776 | Bt Ps9-E2 |
| Cry1Aa17 | HQ439788 | Bt PS9-C12 |
| Cry1Aa18 | HQ439790 | Bt PS9-D12 |
| Cry1Aa19 | HQ685121 | Bt LS-R-21 |
| Cry1Aa20 | JF340156 | Bt SK-798 |
| Cry1Aa21 | JN651496 | Bt LTS-209 |
| Cry1Aa22 | KC158223 | Bt Lip |
| Cry1Aa23 | KJ125392 | Bt |
| Cry1Aa24 | AGH68331 | Btk NAIMCC-B-00167 |
| Cry1Aa25 | MK391629 | Bt MPUB5 |
| Cry1Ab1 | AAA22330 | Bt berliner 1715 |
| Cry1Ab2 | AAA22613 | Bt kurstaki |
| Cry1Ab3 | AAA22561 | Bt kurstaki HD1 |
| Cry1Ab4 | BAA00071 | Bt kurstaki HD1 |
| Cry1Ab5 | CAA28405 | Bt berliner 1715 |
| Cry1Ab6 | AAA22420 | Bt kurstaki NRD-12 |
| Cry1Ab7 | CAA31620 | Bt aizawai IC1 |
| Cry1Ab8 | AAA22551 | Bt aizawai IPL7 |
| Cry1Ab9 | CAA38701 | Bt aizawai HD133 |
| Cry1Ab10 | A29125 | Bt kurstaki HD1 |
| Cry1Ab11 | I12419 | Bt A20 |
| Cry1Ab12 | AAC64003 | Bt kurstaki S93 |
| Cry1Ab13 | AAN76494 | Bt c005 |
| Cry1Ab14 | AAG16877 | Native Chilean Bt |
| Cry1Ab15 | AAO13302 | Bt B-Hm-16 |
| Cry1Ab16 | AAK55546 | Bt AC-11 |
| Cry1Ab17 | AAT46415 | Bt WB9 |
| Cry1Ab18 | AAQ88259 | Bt |
| Cry1Ab19 | AAW31761 | Bt X-2 |
| Cry1Ab20 | ABB72460 | BtC008 |
| Cry1Ab21 | ABS18384 | Bt IS5056 |
| Cry1Ab22 | ABW87320 | BtS2491Ab |
| Cry1Ab23 | HQ439777 | Bt N32-2-2 |
| Cry1Ab24 | HQ439778 | Bt HD12 |
| Cry1Ab25 | HQ685122 | Bt LS-R-30 |
| Cry1Ab26 | HQ847729 | DOR BT-1 |
| Cry1Ab27 | JN135249 | |
| Cry1Ab28 | JN135250 | |
| Cry1Ab29 | JN135251 | |
| Cry1Ab30 | JN135252 | |
| Cry1Ab31 | JN135253 | |
| Cry1Ab32 | JN135254 | |
| Cry1Ab33 | AAS93798 | Bt kenyae K3 |
| Cry1Ab34 | KC156668 | ARP102 |
| Cry1Ab35 | KT692985 | Bt GS36 |
| Cry1Ab36 | KY440260 | Bt NEAU B-X5 |
| Cry1Ab-like | AAK14336 | Bt kunthala RX24 |
| Cry1Ab-like | AAK14337 | Bt kunthala RX28 |
| Cry1Ab-like | AAK14338 | Bt kunthala RX27 |
| Cry1Ab-like | ABG88858 | Bt ly4a3 |
| Cry1Ac1 | AAA22331 | Bt kurstaki HD73 |
| Cry1Ac2 | AAA22338 | Bt kenyae |
| Cry1Ac3 | CAA38098 | Bt BTS89A |
| Cry1Ac4 | AAA73077 | Bt kurstaki PS85A1 |
| Cry1Ac5 | AAA22339 | Bt kurstaki PS81GG |
| Cry1Ac6 | AAA86266 | Bt kurstaki NRD-12 |
| Cry1Ac7 | AAB46989 | Bt kurstaki HD73 |
| Cry1Ac8 | AAC44841 | Bt kurstaki HD73 |
| Cry1Ac9 | AAB49768 | Bt DSIR732 |
| Cry1Ac10 | CAA05505 | Bt kurstaki YBT-1520 |
| Cry1Ac11 | CAA10270 | |
| Cry1Ac12 | I12418 | Bt A20 |
| Cry1Ac13 | AAD38701 | Bt kurstaki HD1 |
| Cry1Ac14 | AAQ06607 | Bt Ly30 |
| Cry1Ac15 | AAN07788 | Bt from Taiwan |
| Cry1Ac16 | AAU87037 | Bt H3 |
| Cry1Ac17 | AAX18704 | Bt kenyae HD549 |
| Cry1Ac18 | AAY88347 | Bt SK-729 |
| Cry1Ac19 | ABD37053 | Bt C-33 |
| Cry1Ac20 | ABB89046 | |
| Cry1Ac21 | AAY66992 | INTA Mol-12 |
| Cry1Ac22 | ABZ01836 | Bt W015-1 |
| Cry1Ac23 | CAQ30431 | Bt |
| Cry1Ac24 | ABL01535 | Bt 146-158-01 |
| Cry1Ac25 | FJ513324 | Bt Tm37-6 |
| Cry1Ac26 | FJ617446 | Bt Tm41-4 |
| Cry1Ac27 | FJ617447 | Bt Tm44-1B |
| Cry1Ac28 | ACM90319 | Bt Q-12 |
| Cry1Ac29 | DQ438941 | INTA TA24-6 |
| Cry1Ac30 | GQ227507 | Bt S1478-1 |
| Cry1Ac31 | GU446674 | Bt S3299-1 |
| Cry1Ac32 | HM061081 | Bt ZQ-89 |
| Cry1Ac33 | GQ866913 | Bt SK-711 |
| Cry1Ac34 | HQ230364 | Bt SK-783 |
| Cry1Ac35 | JF340157 | Bt SK-784 |
| Cry1Ac36 | JN387137 | Bt SK-958 |
| Cry1Ac37 | JQ317685 | Bt SK-793 |
| Cry1Ac38 | ACC86135 | Bt LSZ9408 |
| Cry1Ac39 | ALT07695 | LBIT1200 |
| Cry1Ad1 | AAA22340 | Bt aizawai PS81I |
| Cry1Ad2 | CAA01880 | Bt PS81RR1 |
| CrylAe1 | AAA22410 | Bt alesti |
| Cry1Af1 | AAB82749 | Bt NT0423 |
| Cry1Ag1 | AAD46137 | |
| Cry1Ah1 | AAQ14326 | |
| Cry1Ah2 | ABB76664 | Bt alesti |
| Cry1Ah3 | HQ439779 | Bt S6 |
| Cry1Ai1 | AA039719 | |
| Cry1Ai2 | HQ439780 | Bt SC6H8 |
| Cry1Aj1 | KJ28846 | |
| Cry1A-like | AAK14339 | Bt kunthala nags3 |
| Cry1Ba1 | CAA29898 | Bt thuringiensis HD2 |
| Cry1Ba2 | CAA65003 | Bt entomocidus HD110 |
| Cry1Ba3 | AAK63251 | |
| Cry1Ba4 | AAK51084 | Bt entomocidus HD9 |
| Cry1Ba5 | ABO20894 | Bt sfw-12 |
| Cry1Ba6 | ABL60921 | Bt S601 |
| Cry1Ba7 | HQ439781 | Bt N17-37 |
| Cry1Ba8 | KJ868173 | Bt Na205-3 |
| Cry1Bb1 | AAA22344 | Bt EG5847 |
| Cry1Bb2 | HQ439782 | Bt WBT-2 |
| Cry1Bb3 | KJ619659 | Bt FH21 |
| Cry1Bc1 | CAA86568 | Bt morrisoni |
| Cry1Bd1 | AAD10292 | Bt wuhanensis HD525 |
| Cry1Bd2 | AAM93496 | Bt 834 |
| Cry1Bd3 | KX398132 | Bt K4 |
| Cry1Be1 | AAC32850 | Bt PS158C2 |
| Cry1Be2 | AAQ52387 | |
| Cry1Be3 | ACV96720 | Bt g9 |
| Cry1Be4 | HM070026 | |
| Cry1Be5 | KU761578 | Bt LBR2 |
| Cry1Bf1 | CAC50778 | |
| Cry1Bf2 | AAQ52380 | |
| Cry1Bg1 | AA039720 | |
| Cry1Bh1 | HQ589331 | Bt PS46L |
| Cry1Bi1 | KC156700 | ARP260 |
| Cry1Bj1 | KT952325 | Bt |
| Cry1Ca1 | CAA30396 | Bt entomocidus 60.5 |
| Cry1Ca2 | CAA31951 | Bt aizawai 7.29 |
| Cry1Ca3 | AAA22343 | Bt aizawai PS81I |
| Cry 1Ca4 | CAA01886 | Bt entomocidus HD110 |
| Cry1Ca5 | CAA65457 | Bt aizawai 7.29 |
| Cry1Ca6 [1] | AAF37224 | Bt AF-2 |
| Cry1Ca7 | AAG50438 | Bt J8 |
| Cry1Ca8 | AAM00264 | Bt c002 |
| Cry1Ca9 | AAL79362 | Bt G10-01A |
| Cry1Ca10 | AAN16462 | Bt E05-20a |
| Cry1Ca11 | AAX53094 | Bt C-33 |
| Cry1Ca12 | HM070027 | mo3-E7 |
| Cry1Ca13 | HQ412621 | Bt LB-R-78 |
| Cry1Ca14 | JN651493 | Bt LTS-38 |
| Cry1Ca15 | MK391630 | Bt MPU B5 |
| Cry1Cb1 | M97880 | Bt galleriae HD29 |
| Cry1Cb2 | AAG35409 | Bt c001 |
| Cry1Cb3 | ACD50894 | Bt 087 |
| Cry1Cb-like | AAX63901 | Bt TA476-1 |
| Cry1Da1 | CAA38099 | Bt aizawai HD68 |
| Cry1Da2 | I76415 | |
| Cry1Da3 | HQ439784 | Bt HD12 |
| Cry1Da4 | KJ619660 | Bt FH21 |
| Cry1Da5 | MG181949 | QL75-2 |
| Cry1Db1 | CAA80234 | Bt BTS00349A |
| Cry1Db2 | AAK48937 | Bt B-Pr-88 |
| Cry1Dc1 | ABK35074 | Bt JC291 |
| Cry1Dd1 | KJ28844 | |
| Cry1Ea1 | CAA37933 | Bt kenyae 4F1 |
| Cry1Ea2 | CAA39609 | Bt kenyae |
| Cry1Ea3 | AAA22345 | Bt kenyae PS81F |
| Cry1Ea4 | AAD04732 | Bt kenyae LBIT-147 |
| Cry1Ea5 | A15535 | |
| Cry1Ea6 | AAL50330 | Bt YBT-032 |
| Cry1Ea7 | AAW72936 | Bt JC190 |
| Cry1Ea8 | ABX11258 | Bt HZM2 |
| Cry1Ea9 | HQ439785 | Bt S6 |
| Cry1Ea10 | ADR00398 | Bt BR64 |
| Cry1Ea11 | JQ652456 | Bt |
| Cry1Ea12 | KF601559 | Bt strain V4 |
| Cry1Eb1 | AAA22346 | Bt aizawai PS81A2 |
| Cry1Fa1 | AAA22348 | Bt aizawai EG6346 |
| Cry1Fa2 | AAA22347 | Bt aizawai PS81I |
| Cry1Fa3 | HM070028 | Bt mo3-D8 |
| Cry1Fa4 | HM439638 | Bt mo3-D10 |
| Cry1Fb1 | CAA80235 | Bt BTS00349A |
| Cry1Fb2 | BAA25298 | Bt morrisoni INA67 |
| Cry1Fb3 | AAF21767 | Bt morrisoni |
| Cry1Fb4 | AAC10641 | |
| Cry1Fb5 | AAO13295 | Bt B-Pr-88 |
| Cry1Fb6 | ACD50892 | Bt 012 |
| Cry1Fb7 | ACD50893 | Bt 087 |
| Cry1Ga1 | CAA80233 | Bt BTS0349A |
| Cry1Ga2 | CAA70506 | Bt wuhanensis |
| Cry1Gb1 | AAD10291 | Bt wuhanensis HD525 |
| Cry1Gb2 | AAO13756 | Bt B-Pr-88 |
| Cry1Gc1 | AAQ52381 | |
| Cry1Ha1 | CAA80236 | Bt BTS02069AA |
| Cry1Hb1 | AAA79694 | Bt morrisoni BF190 |
| Cry1Hb2 | HQ439786 | Bt WBT-2 |
| Cry1Hc1 | KJ28845 | |
| Cry1H-like | AAF01213 | Bt JC291 |
| Cry1Ia1 | CAA44633 | Bt kurstaki |
| Cry1Ia2 | AAA22354 | Bt kurstaki |
| Cry1Ia3 | AAC36999 | Bt kurstaki HD1 |
| Cry1Ia4 | AAB00958 | Bt AB88 |
| Cry1Ia5 | CAA70124 | Bt 61 |
| Cry1Ia6 | AAC26910 | Bt kurstaki S101 |
| Cry1Ia7 | AAM73516 | Bt |
| Cry1Ia8 | AAK66742 | |
| Cry1Ia9 | AAQ08616 | Bt Ly30 |
| Cry1Ia10 | AAP86782 | Bt thuringiensis |
| Cry1Ia11 | CAC85964 | Bt kurstaki BNS3 |
| Cry1Ia12 | AAV53390 | Bt |
| Cry1Ia13 | ABF83202 | Bt |
| Cry1Ia14 | ACG63871 | Bt11 |
| Cry1Ia15 | FJ617445 | Bt E-1B |
| Cry1Ia16 | FJ617448 | Bt E-1A |
| Cry1Ia17 | GU989199 | Bt MX2 |
| Cry1Ia18 | ADK23801 | Bt MX9 |
| Cry1Ia19 | HQ439787 | Bt SC6H6 |
| Cry1Ia20 | JQ228426 | Bt wu1H-3 |
| Cry1Ia21 | JQ228424 | Bt you1D-9 |
| Cry1Ia22 | JQ228427 | Bt wu1E-3 |
| Cry1Ia23 | JQ228428 | Bt wu1E-4 |
| Cry1Ia24 | JQ228429 | Bt wu2B-6 |
| Cry1Ia25 | JQ228430 | Bt wu2G-11 |
| Cry1Ia26 | JQ228431 | Bt wu2G-12 |
| Cry1Ia27 | JQ228432 | Bt you2D-3 |
| Cry1Ia28 | JQ228433 | Bt you2E-3 |
| Cry1Ia29 | JQ228434 | Bt you2F-3 |
| Cry1Ia30 | JQ317686 | Bt 4J4 |
| Cry1Ia31 | JX944038 | Bt SC-7 |
| Cry1Ia32 | JX944039 | Bt SC-13 |
| Cry1Ia33 | JX944040 | Bt SC-51 |
| Cry1Ia34 | KJ868171 | Bt Na205-3 |
| Cry1Ia35 | AIF79803 | Bt V4 |
| Cry1Ia36 | KY212747 | Bt YC-10 |
| Cry1Ia37 | MG674828 | Bt SY80 |
| Cry1Ia38 | MG584186 | |
| Cry1Ia39 | MK393238 | Bt INTA H4-3 |
| Cry1Ia40 | MK391631 | Bt MPU B9 |
| Cry1Ib1 | AAA82114 | Bt entomocidus BP465 |
| Cry1Ib2 | ABW88019 | Bt PP61 |
| Cry1Ib3 | ACD75515 | Bt GS8 |
| Cry1Ib4 | HM051227 | Bt BF-4 |
| Cry1Ib5 | HM070028 | Bt mo3-D8 |
| Cry1Ib6 | ADK38579 | Bt LB52 |
| Cry1Ib7 | JN571740 | Bt SK-935 |
| Cry1Ib8 | JN675714 | |
| Cry1Ib9 | JN675715 | |
| Cry1Ib10 | JN675716 | |
| Cry1Ib11 | JQ228423 | Bt HD12 |
| CrylIc1 | AAC62933 | Bt C18 |
| Cry1Ic2 | AAE71691 | |
| Cry1Id1 | AAD44366 | |
| Cry1Id2 | JQ228422 | Bt HD12 |
| Cry1Id3 | KJ619661 | Bt FH21 |
| Cry1Ie1 | AAG43526 | Bt BTC007 |
| Cry1Ie2 | HM439636 | Bt T03B001 |
| Cry1Ie3 | KC156647 | ARP058 |
| Cry1Ie4 | KC156681 | ARP131 |
| Cry1Ie5 | KJ710646 | BN23-5 |
| Cry1If1 | AAQ52382 | |
| Cry1Ig1 | KC156701 | ARP166 |
| Cry1I-like | AAC31094 | |
| Cry1I-like | ABG88859 | Bt ly4a3 |
| Cry1Ja1 | AAA22341 | Bt EG5847 |
| Cry1Ja2 | HM070030 | WBT-1 |
| Cry1Ja3 | JQ228425 | Bt FH21 |
| Cry1Jb1 | AAA98959 | Bt EG5092 |
| Cry1Jc1 | AAC31092 | |
| Cry1Jc2 | AAQ52372 | |
| Cry1Jd1 | CAC50779 | Bt |
| Cry1Ka1 | AAB00376 | Bt morrisoni BF190 |
| Cry1Ka2 | HQ439783 | Bt WBT-2 |
| Cry1La1 | AAS60191 | Bt kurstaki K1 |
| Cry1La2 | HM070031 | Bt SC6H8 |
| Cry1La3 | KT692983 | Bt GS27 |
| Cry1Ma1 | FJ884067 | LBIT 1189 |
| Cry1Ma2 | KC156659 | ARP080 |
| Cry1Na1 | KC156648 | ARP009 |
| Cry1Na2 | AEH31422 | Bt T03B001 |
| Cry1Na3 | AKQ08661 | Bt BRC-ZYR2 |
| Cry1Nb1 | KC156678 | ARP146 |
| Cry1-like | AAC31091 | |
| Cry2Aa1 | AAA22335 | Bt kurstaki |
| Cry2Aa2 | AAA83516 | Bt kurstaki HD1 |
| Cry2Aa3 | D86064 | Bt sotto |
| Cry2Aa4 | AAC04867 | Bt kenyae HD549 |
| Cry2Aa5 | CAA10671 | Bt SL39 |
| Cry2Aa6 | CAA10672 | Bt YZ71 |
| Cry2Aa7 | CAA10670 | Bt CY29 |
| Cry2Aa8 | AAO13734 | Bt Dongbei 66 |
| Cry2Aa9 | AAO13750 | |
| Cry2Aa10 | AAQ04263 | |
| Cry2Aa11 | AAQ52384 | |
| Cry2Aa12 | ABI83671 | Bt Rpp39 |
| Cry2Aa13 | ABL01536 | Bt 146-158-01 |
| Cry2Aa14 | ACF04939 | Bt HD-550 |
| Cry2Aa15 | JN426947 | Bt SSy77 |
| Cry2Aa16 | KF667522 | Bt V4 |
| Cry2Aa17 | KF860848 | |
| Cry2Aa18 | ANF99565 | Bt SY49.1 |
| Cry2Aa19 | MG983752 | Bt-T32 |
| Cry2Aa20 | MG983753 | Bt-T405 |
| Cry2Aa21 | MG983754 | Bt-T414 |
| Cry2Aa22 | MH475904 | Bt-T527 |
| Cry2Aa23 | MH475905 | Bt-T532 |
| Cry2Aa23 | MH475906 | Bt-T536 |
| Cry2Aa25 | MH475907 | Bt-T543 |
| Cry2Ab1 | AAA22342 | Bt kurstaki HD1 |
| Cry2Ab2 | CAA39075 | Bt kurstaki HD1 |
| Cry2Ab3 | AAG36762 | Bt BTC002 |
| Cry2Ab4 | AAO13296 | Bt B-Pr-88 |
| Cry2Ab5 | AAQ04609 | Bt ly30 |
| Cry2Ab6 | AAP59457 | Bt WZ-7 |
| Cry2Ab7 | AAZ66347 | Bt 14-1 |
| Cry2Ab8 | ABC95996 | Bt WB2 |
| Cry2Ab9 | ABC74968 | Bt LLB6 |
| Cry2Ab10 | ABM21766 | Bt LyL |
| Cry2Ab11 | CAM84575 | Bt CMBL-BT1 |
| Cry2Ab12 | ABM21764 | Bt LyD |
| Cry2Ab13 | ACG76120 | Bt ywc5-4 |
| Cry2Ab14 | ACG76121 | Bt Bts |
| Cry2Ab15 | HM037126 | Bt BF-4 |
| Cry2Ab16 | GQ866914 | SK-793 |
| Cry2Ab17 | HQ439789 | Bt PS9-C12 |
| Cry2Ab18 | JN135255 | |
| Cry2Ab19 | JN135256 | |
| Cry2Ab20 | JN135257 | |
| Cry2Ab21 | JN135258 | |
| Cry2Ab22 | JN135259 | |
| Cry2Ab23 | JN135260 | |
| Cry2Ab24 | JN135261 | |
| Cry2Ab25 | JN415485 | Btk MnD |
| Cry2Ab26 | JN426946 | Bt SSy77 |
| Cry2Ab27 | JN415764 | |
| Cry2Ab28 | JN651494 | Bt LTS-7 |
| Cry2Ab29 | KF860847 | |
| Cry2Ab30 | EU623976 | Bt LSZ9408 |
| Cry2Ab31 | AHM93475 | Bt HTS-S-38 |
| Cry2Ab32 | KJ710647 | BN23-5 |
| Cry2Ab33 | KP053646 | Bt CYZ-4 |
| Cry2Ab34 | KX236449 | Bt BJH406 |
| Cry2Ab35 | KY212748 | Bt YC-10 |
| Cry2Ab36 | MK391632 | MPU B5 |
| Cry2Ac1 | CAA40536 | Bt shanghai S1 |
| Cry2Ac2 | AAG35410 | |
| Cry2Ac3 | AAQ52385 | |
| Cry2Ac4 | ABC95997 | Bt WB9 |
| Cry2Ac5 | ABC74969 | |
| Cry2Ac6 | ABC74793 | Bt wuhanensis |
| Cry2Ac7 | CAL18690 | Bt SBSBT-1 |
| Cry2Ac8 | CAM09325 | Bt CMBL-BT1 |
| Cry2Ac9 | CAM09326 | Bt CMBL-BT2 |
| Cry2Ac10 | ABN15104 | Bt QCL-1 |
| Cry2Ac11 | CAM83895 | Bt HD29 |
| Cry2Ac12 | CAM83896 | Bt CMBL-BT3 |
| Cry2Ad1 | AAF09583 | Bt BR30 |
| Cry2Ad2 | ABC86927 | Bt WB10 |
| Cry2Ad3 | CAK29504 | Bt 5_2AcT(1) |
| Cry2Ad4 | CAM32331 | Bt CMBL-BT2 |
| Cry2Ad5 | CAO78739 | Bt HD29 |
| Cry2Ae1 | AAQ52362 | |
| Cry2Af1 | ABO30519 | Bt C81 |
| Cry2Af2 | GQ866915 | SK-758 |
| Cry2Ag1 | ACH91610 | Bt JF19-2 |
| Cry2Ah1 | EU939453 | Bt SC6H8 |
| Cry2Ah2 | ACL80665 | Bt BRC-ZQL3 |
| Cry2Ah3 | GU073380 | HYW-8 |
| Cry2Ah4 | KC156702 | ARP193 |
| Cry2Ah5 | KT692984 | Bt GS3 |
| Cry2Ah6 | KX034204 | |
| Cry2Ai1 | FJ788388 | Bt |
| Cry2Aj1 | | |
| Cry2Ak1 | KC156660 | ARP067 |
| Cry2Al1 | KJ149819 | Bt SWK1 |
| Cry2Ba1 | KC156658 | ARP026 |
| Cry2Ba2 | KF014123 | HD395 |
| Cry3Aa1 | AAA22336 | Bt san diego |
| Cry3Aa2 | AAA22541 | Bt tenebrionis |
| Cry3Aa3 | CAA68482 | |
| Cry3Aa4 | AAA22542 | Bt tenebrionis |
| Cry3Aa5 | AAA50255 | Bt morrisoni EG2158 |
| Cry3Aa6 | AAC43266 | Bt tenebrionis |
| Cry3Aa7 | CAB41411 | Bt 22 |
| Cry3Aa8 | AAS79487 | Bt YM-03 |
| Cry3Aa9 | AAW05659 | Bt UTD-001 |
| Cry3Aa10 | AAU29411 | Bt 886 |
| Cry3Aa11 | AAW82872 | Bt tenebrionis Mm2 |
| Cry3Aa12 | ABY49136 | Bt tenebrionis |
| Cry3Ba1 | CAA34983 | Bt tolworthi 43F |
| Cry3Ba2 | CAA00645 | Bt PGSI208 |
| Cry3Ba3 | JQ397327 | Bt ML090 |
| Cry3Bb1 | AAA22334 | Bt EG4961 |
| Cry3Bb2 | AAA74198 | Bt EG5144 |
| Cry3Bb3 | I15475 | |
| Cry3Ca1 | CAA42469 | Bt kurstaki BtI109P |
| Cry4Aa1 | CAA68485 | Bt israelensis |
| Cry4Aa2 | BAA00179 | Bt israelensis HD522 |
| Cry4Aa3 | CAD30148 | Bt israelensis |
| Cry4Aa4 | AFB18317 | Bti BRC-LLP29 |
| Cry4A-like | AAY96321 | Bt LDC-9 |
| Cry4Ba1 | CAA30312 | Bt israelensis 4Q2-72 |
| Cry4Ba2 | CAA30114 | Bt israelensis |
| Cry4Ba3 | AAA22337 | Bt israelensis |
| Cry4Ba4 | BAA00178 | Bt israelensis HD522 |
| Cry4Ba5 | CAD30095 | Bt israelensis |
| Cry4Ba-like | ABC47686 | Bt LDC-9 |
| Cry4Ca1 | EU646202 | Bt Y41 |
| Cry4Ca2 | KM053252 | Bt SK700 |
| Cry4Cb1 | FJ403208 | Bt HS18-1 |
| Cry4Cb2 | FJ597622 | Bt Ywc2-8 |
| Cry4Cb3 | AHG25301 | Bt S2160-1 |
| Cry4Cc1 | FJ403207 | Bt MC28 |
| Cry5Aa1 | AAA67694 | Bt darmstadiensis PS17 |
| Cry5Ab1 | AAA67693 | Bt darmstadiensis PS17 |
| Cry5Ac1 | I34543 | |
| Cry5Ad1 | ABQ82087 | Bt L366 |
| Cry5Ba1 | AAA68598 | Bt PS86Q3 |
| Cry5Ba2 | ABW88931 | YBT 1518 |
| Cry5Ba3 | AFJ04417 | Bt zjfc85 |
| Cry5Ca1 | HM461869 | Sbt003 |
| Cry5Ca2 | ZP_04123426 | Bt T13001 |
| Cry5Da1 | HM461870 | Sbt003 |
| Cry5Da2 | ZP_04123980 | Bt T13001 |
| Cry5Ea1 | HM485580 | Sbt003 |
| Cry5Ea2 | ZP_04124038 | Bt T13001 |
| Cry6Aa1 | AAA22357 | Bt PS52A1 |
| Cry6Aa2 | AAM46849 | YBT 1518 |
| Cry6Aa3 | ABH03377 | Bt 96418 |
| Cry6Ba1 | AAA22358 | Bt PS69D1 |
| Cry7Aa1 | AAA22351 | Bt galleriae PGSI245 |
| Cry7Aa2 | MK840959 | Bt BM311.1 |
| Cry7Ab1 | AAA21120 | Bt dakota HD511 |
| Cry7Ab2 | AAA21121 | Bt kumamotoensis 867 |
| Cry7Ab3 | ABX24522 | Bt WZ-9 |
| Cry7Ab4 | EU380678 | Bt HQ122 |
| Cry7Ab5 | ABX79555 | Bt monterrey GM-33 |
| Cry7Ab6 | ACI44005 | Bt HQ122 |
| Cry7Ab7 | ADB89216 | Bt GW6 |
| Cry7Ab8 | GU145299 | |
| Cry7Ab9 | ADD92572 | Bt QG-121 |
| Cry7Ac1 | KJ789922 | Bt QZL20-1 |
| Cry7Ba1 | ABB70817 | Bt huazhongensis |
| Cry7Bb1 | KC156653 | ARP013 |
| Cry7Ca1 | ABR67863 | Bt BTH-13 |
| Cry7Cb1 | KC156698 | ARP269 |
| Cry7Da1 | ACQ99547 | Bt LH-2 |
| Cry7Da2 | HM572236 | |
| Cry7Da3 | KC156679 | ARP140 |
| Cry7Ea1 | HM035086 | Sbt009 |
| Cry7Ea2 | HM132124 | HD868(D8) |
| Cry7Ea3 | EEM19403 | BGSC 4Y1 |
| Cry7Fa1 | HM035088 | SBt009 |
| Cry7Fa2 | EEM19090 | BGSC 4Y1 |
| Cry7Fb1 | HM572235 | Bt |
| Cry7Fb2 | KC156682 | ARP162 |
| Cry7Fb3 | HM572235 | |
| Cry7Ga1 | HM572237 | Bt |
| Cry7Ga2 | KC156669 | ARP103 |
| Cry7Gb1 | KC156650 | ARP011 |
| Cry7Gc1 | KC156654 | ARP012 |
| Cry7Gd1 | KC156697 | ARP271 |
| Cry7Ha1 | KC156651 | ARP021 |
| Cry7Ia1 | KC156665 | ARP112 |
| Cry7Ja1 | KC156671 | ARP114 |
| Cry7Ka1 | KC156680 | ARP171 |
| Cry7Kb1 | BAM99306 | Bt dakota |
| Cry7La1 | BAM99307 | Bt dakota |
| Cry8Aa1 | AAA21117 | Bt kumamotoensis |
| Cry8Ab1 | EU044830 | Bt B-JJX |
| Cry8Ac1 | KC156662 | ARP068 |
| Cry8Ad1 | KC156684 | ARP215 |
| Cry8Ba1 | AAA21118 | Bt kumamotoensis |
| Cry8Bb1 | CAD57542 | |
| Cry8Bc1 | CAD57543 | |
| Cry8Ca1 | AAA21119 | Bt japonensis Buibui |
| Cry8Ca2 | AAR98783 | Bt HBF-1 |
| Cry8Ca3 | EU625349 | Bt FTL-23 |
| Cry8Ca4 | ADB54826 | Bt S185 |
| Cry8Ca5 | MK167020 | Bt BJH500 |
| Cry8Da1 | BAC07226 | Bt galleriae |
| Cry8Da2 | BD133574 | Bt |
| Cry8Da3 | BD133575 | Bt |
| Cry8Db1 | BAF93483 | Bt BBT2-5 |
| Cry8Ea1 | AAQ73470 | Bt 185 |
| Cry8Ea2 | EU047597 | Bt B-DLL |
| Cry8Ea3 | KC855216 | Bt GWL |
| Cry8Ea4 | AGM16383 | QZL144-1 |
| Cry8Ea5 | AGM16384 | QZL144-4 |
| Cry8Ea6 | KT692742 | ZK1 |
| Cry8Fa1 | AAT48690 | Bt 185 |
| Cry8Fa2 | HQ174208 | Bt DLL |
| Cry8Fa3 | AFH78109 | Bt L-27 |
| Cry8Fa4 | AGM16382 | QHW7-2 |
| Cry8Ga1 | AAT46073 | Bt HBF-18 |
| Cry8Ga2 | ABC42043 | Bt 145 |
| Cry8Ga3 | FJ198072 | Bt FCD114 |
| Cry8Ha1 | AAW81032 | Bt 185 |
| Cry8Hb1 | KP713881 | Bt |
| Cry8Ia1 | EU381044 | Bt su4 |
| Cry8Ia2 | GU073381 | Bt HW-11 |
| Cry8Ia3 | HM044664 | Sbt030 |
| Cry8Ia4 | KC156674 | ARP124 |
| Cry8Ib1 | GU325772 | Bt F4 |
| Cry8Ib2 | KC156677 | ARP135 |
| Cry8Ib3 | AHG25076 | Bt TS3 |
| Cry8Ja1 | EU625348 | Bt FPT-2 |
| Cry8Ka1 | FJ422558 | |
| Cry8Ka2 | ACN87262 | Bt kenyae |
| Cry8Ka3 | AGM16381 | QHW7-2 |
| Cry8Kb1 | HM123758 | ST8 |
| Cry8Kb2 | KC156675 | ARP158 |
| Cry8Kb3 | KJ123823 | INTA Fr7-4 |
| Cry8La1 | GU325771 | Bt F4 |
| Cry8Ma1 | | Sbt016 |
| Cry8Ma2 | EEM86551 | BGSC 4CC1 |
| Cry8Ma3 | HM210574 | NARC Bt17 (C6) |
| Cry8Na1 | HM640939 | BtQ52-7 |
| Cry8Pa1 | HQ388415 | Bt ST8 |
| Cry8Pa2 | HQ413324 | Bt QCM(T1) |
| Cry8Pa3 | KJ123823 | INTA Fr7-4 |
| Cry8Qa1 | HQ441166 | Bt ST8 |
| Cry8Qa2 | KC152468 | Bt INTA Fr7-4 |
| Cry8Ra1 | AFP87548 | Bt R36 |
| Cry8Sa1 | JQ740599 | Bt Strain 62 |
| Cry8Ta1 | KC156673 | ARP110 |
| Cry8-like | FJ770571 | Bt canadensis |
| Cry8-like | ABS53003 | Bt |
| Cry9Aa1 | CAA41122 | Bt galleriae |
| Cry9Aa2 | CAA41425 | Bt DSIR517 |
| Cry9Aa3 | GQ249293 | Bt SC5(D2) |
| Cry9Aa4 | GQ249294 | Bt T03C001 |
| Cry9Aa5 | JX174110 | BGSN1 |
| Cry9Aa like | AAQ52376 | |
| Cry9Ba1 | CAA52927 | Bt galleriae |
| Cry9Ba2 | GU299522 | Bt B-SC5 |
| Cry9Bb1 | AAV28716 | Bt japonensis |
| Cry9Ca1 | CAA85764 | Bt tolworthi |
| Cry9Ca2 | AAQ52375 | |
| Cry9Cb1 | MK005301 | |
| Cry9Da1 | BAA19948 | Bt japonensis N141 |
| Cry9Da2 | AAB97923 | Bt japonensis |
| Cry9Da3 | GQ249293 | Bt SC5 (D2) |
| Cry9Da4 | GQ249297 | Bt T03B001 |
| Cry9Db1 | AAX78439 | Bt kurstaki DP1019 |
| Cry9Dc1 | KC156683 | ARP168 |
| Cry9Ea1 | BAA34908 | Bt aizawai SSK-10 |
| Cry9Ea2 | AAO12908 | Bt B-Hm-16 |
| Cry9Ea3 | ABM21765 | Bt lyA |
| Cry9Ea4 | ACE88267 | Bt ywc5-4 |
| Cry9Ea5 | ACF04743 | Bts |
| Cry9Ea6 | ACG63872 | Bt 11 |
| Cry9Ea7 | FJ380927 | Bt 4 |
| Cry9Ea8 | GQ249292 | Bt SC5(E8) |
| Cry9Ea9 | JN651495 | Bt LTS-7 |
| Cry9Ea10 | KT692743 | ZK2 |
| Cry9Ea11 | MK391633 | Bt MPU B9 |
| Cry9Eb1 | CAC50780 | |
| Cry9Eb2 | GQ249298 | Bt T23001 |
| Cry9Eb3 | KC156646 | ARP057 |
| Cry9Ec1 | AAC63366 | Bt galleriae |
| Cry9Ed1 | AAX78440 | Bt kurstaki DP1019 |
| Cry9Ee1 | GQ249296 | Bt T03B001 |
| Cry9Ee2 | KC156664 | ARP095 |
| Cry9Fa1 | KC156692 | ARP212 |
| Cry9Ga1 | KC156699 | ARP188 |
| Cry9-like | AAC63366 | Bt galleriae |
| Cry10Aa1 | AAA22614 | Bt israelensis |
| Cry10Aa2 | E00614 | Bt israelensis ONR-60A |
| Cry10Aa3 | CAD30098 | Bt israelensis |
| Cry10Aa4 | AFB18318 | Bti BRC-LLP29 |
| Cry10A-like | DQ167578 | Bt LDC-9 |
| Cry11Aa1 | AAA22352 | Bt israelensis |
| Cry11Aa2 | AAA22611 | Bt israelensis |
| Cry11Aa3 | CAD30081 | Bt israelensis |
| Cry11Aa4 | AFB18319 | Bti BRC-LLP29 |
| Cry11Aa5 | MH253686 | |
| Cry11Aa-like | DQ166531 | Bt LDC-9 |
| Cry11Ba1 | CAA60504 | Bt jegathesan 367 |
| Cry11Bb1 | AAC97162 | Bt medellin |
| Cry11Bb2 | HM068615 | Bt K34 |
| Cry12Aa1 | AAA22355 | Bt PS33F2 |
| Cry13Aa1 | AAA22356 | Bt PS63B |
| Cry13Aa2 | CP015350 | Bt MYBT18246 |
| Cry14Aa1 | AAA21516 | Bt sotto PS80JJ1 |
| Cry14Ab1 | KC156652 | ARP001 |
| Cry15Aa1 | AAA22333 | Bt thompsoni |
| Cry16Aa1 | CAA63860 | Cb malaysia CH18 |
| Cry17Aa1 | CAA67841 | Cb malaysia CH18 |
| Cry18Aa1 | CAA67506 | Paenibacillus popilliae |
| Cry18Ba1 | AAF89667 | Paenibacillus popilliae |
| Cry18Ca1 | AAF89668 | Paenibacillus popilliae |
| Cry19Aa1 | CAA68875 | Bt jegathesan 367 |
| Cry19Ba1 | BAA32397 | Bt higo |
| Cry19Ca1 | AFM37572 | BGSC 4CE1 |
| Cry20Aa1 | AAB93476 | Bt fukuokaensis |
| Cry20Ba1 | ACS93601 | Bt higo LBIT-976 |
| Cry20Ba2 | KC156694 | ARP192 |
| Cry20-like | GQ144333 | Bt Y-5 |
| Cry21Aa1 | I32932 | |
| Cry21Aa2 | I66477 | |
| Cry21Aa3 | MF893204 | |
| Cry21Ba1 | BAC06484 | Bt roskildiensis |
| Cry21Ca1 | JF521577 | |
| Cry21Ca2 | KC156687 | ARP258 |
| Cry21Da1 | JF521578 | Sbt072 |
| Cry21Ea1 | KC865049 | |
| Cry21Fa1 | KF701307 | DB27 |
| Cry21Ga1 | KF771885 | DB27 |
| Cry21Ha1 | KF771886 | DB27 |
| Cry22Aa1 | I34547 | |
| Cry22Aa2 | CAD43579 | Bt |
| Cry22Aa3 | ACD93211 | Bt FZ-4 |
| Cry22Ab1 | AAK50456 | Bt EG4140 |
| Cry22Ab2 | CAD43577 | Bt |
| Cry22Ba1 | CAD43578 | Bt |
| Cry22Bb1 | KC156672 | ARP148 |
| Cry23Aa1 | AAF76375 | Bt |
| Cry24Aa1 | AAC61891 | Bt jegathesan |
| Cry24Ba1 | BAD32657 | Bt sotto |
| Cry24Ca1 | CAJ43600 | Bt FCC-41 |
| Cry24Da1 | KJ439561 | BLB32 |
| Cry25Aa1 | AAC61892 | Bt jegathesan |
| Cry26Aa1 | AAD25075 | Bt finitimus B-1166 |
| Cry27Aa1 | BAA82796 | Bt higo |
| Cry28Aa1 | AAD24189 | Bt finitimus B-1161 |
| Cry28Aa2 | AAG00235 | Bt finitimus |
| Cry29Aa1 | CAC80985 | Bt medellin |
| Cry29Ba1 | KC865046 | |
| Cry30Aa1 | CAC80986 | Bt medellin |
| Cry30Ba1 | BAD00052 | Bt entomocidus |
| Cry30Ca1 | BAD67157 | Bt sotto |
| Cry30Ca2 | ACU24781 | Bt jegathesan 367 |
| Cry30Da1 | EF095955 | Bt Y41 |
| Cry30Db1 | BAE80088 | Bt aizawai BUN1-14 |
| Cry30Ea1 | ACC95445 | Bt S2160-1 |
| Cry30Ea2 | FJ499389 | Bt Ywc2-8 |
| Cry30Ea3 | FJ527836 | Bt Hs18-1 |
| Cry30Ea4 | KJ740649 | BN15-6 |
| Cry30Fa1 | ACI22625 | Bt MC28 |
| Cry30Ga1 | ACG60020 | Bt HS18-1 |
| Cry30Ga2 | HQ638217 | Bt S2160-1 |
| Cry31Aa1 | BAB11757 | Bt 84-HS-1-11 |
| Cry31Aa2 | AAL87458 | Bt M15 |
| Cry31Aa3 | BAE79808 | Bt B0195 |
| Cry31Aa4 | BAF32571 | Bt 79-25 |
| Cry31Aa5 | BAF32572 | Bt 92-10 |
| Cry31Aa6 | BAI44026 | M019 |
| Cry31Ab1 | BAE79809 | Bt B0195 |
| Cry31Ab2 | BAF32570 | Bt 31-5 |
| Cry31Ac1 | BAF34368 | Bt 87-29 |
| Cry31Ac2 | AB731600 | Bt B0462 |
| Cry31Ad1 | BAI44022 | Bt MO19 |
| Cry31Ad2 | AGO57767 | Bt 64-1-94 |
| Cry32Aa1 | AAG36711 | Bt yunnanensis |
| Cry32Aa2 | GU063849 | Bt FBG-1 |
| Cry32Ab1 | GU063850 | Bt FZ-2 |
| Cry32Ba1 | BAB78601 | Bt |
| Cry32Ca1 | BAB78602 | Bt |
| Cry32Cb1 | KC156708 | ARP227 |
| Cry32Da1 | BAB78603 | Bt |
| Cry32Ea1 | GU324274 | Bt HYD-3 |
| Cry32Ea2 | KC156686 | ARP239 |
| Cry32Eb1 | KC156663 | ARP092 |
| Cry32Fa1 | KC156656 | ARP055 |
| Cry32Ga1 | KC156657 | ARP052 |
| Cry32Ha1 | KC156661 | ARP076 |
| Cry32Hb1 | KC156666 | ARP096 |
| Cry32Ia1 | KC156667 | ARP104 |
| Cry32Ja1 | KC156685 | ARP262 |
| Cry32Ka1 | KC156688 | ARP259 |
| Cry32La1 | KC156689 | ARP203 |
| Cry32Ma1 | KC156690 | ARP256 |
| Cry32Mb1 | KC156704 | ARP242 |
| Cry32Na1 | KC156691 | ARP179 |
| Cry32Oa1 | KC156703 | ARP218 |
| Cry32Pa1 | KC156705 | ARP277 |
| Cry32Qa1 | KC156706 | ARP174 |
| Cry32Ra1 | KC156707 | ARP229 |
| Cry32Sa1 | KC156709 | ARP185 |
| Cry32Ta1 | KC156710 | ARP220 |
| Cry32Ua1 | KC156655 | ARP050 |
| Cry32Va1 | | LM1212 |
| Cry32Wa1 | | LM1212 |
| Cry32Wa2 | AHN52957 | Bt B3 |
| Cry32Xa1 | KX094974 | |
| Cry32Ya1 | KX094973 | |
| Cry33Aa1 | AAL26871 | Bt dakota |
| Cry34Aa1 | AAG50341 | Bt PS80JJ1 |
| Cry34Aa2 | AAK64560 | Bt EG5899 |
| Cry34Aa3 | AAT29032 | Bt PS69Q |
| Cry34Aa4 | AAT29030 | Bt PS185GG |
| Cry34Ab1 | AAG41671 | Bt PS149B1 |
| Cry34Ac1 | AAG50118 | Bt PS167H2 |
| Cry34Ac2 | AAK64562 | Bt EG9444 |
| Cry34Ac3 | AAT29029 | Bt KR1369 |
| Cry34Ba1 | AAK64565 | Bt EG4851 |
| Cry34Ba2 | AAT29033 | Bt PS201L3 |
| Cry34Ba3 | AAT29031 | Bt PS201HH2 |
| Cry35Aa1 | AAG50342 | Bt PS80JJ1 |
| Cry35Aa2 | AAK64561 | Bt EG5899 |
| Cry35Aa3 | AAT29028 | Bt PS69Q |
| Cry35Aa4 | AAT29025 | Bt PS185GG |
| Cry35Ab1 | AAG41672 | Bt PS149B1 |
| Cry35Ab2 | AAK64563 | Bt EG9444 |
| Cry35Ab3 | AY536891 | Bt KR1369 |
| Cry35Ac1 | AAG50117 | Bt PS167H2 |
| Cry35Ba1 | AAK64566 | Bt EG4851 |
| Cry35Ba2 | AAT29027 | Bt PS201L3 |
| Cry35Ba3 | AAT29026 | Bt PS201HH2 |
| Cry36Aa1 | AAK64558 | Bt |
| Cry37Aa1 | AAF76376 | Bt |
| Cry38Aa1 | AAK64559 | Bt |
| Cry39Aa1 | BAB72016 | Bt aizawai |
| Cry40Aa1 | BAB72018 | Bt aizawai |
| Cry40Ba1 | BAC77648 | Bun1-14 |
| Cry40Ca1 | EU381045 | Bt Y41 |
| Cry40Da1 | ACF15199 | Bt S2096-2 |
| Cry41Aa1 | BAD35157 | Bt A1462 |
| Cry41Ab1 | BAD35163 | Bt A1462 |
| Cry41Ba1 | HM461871 | Sbt021 |
| Cry41Ba2 | ZP_04099652 | BGSC 4AW1 |
| Cry41Ca1 | | LM1212 |
| Cry42Aa1 | BAD35166 | Bt A1462 |
| Cry43Aa1 | BAD15301 | P. lentimorbus semadara |
| Cry43Aa2 | BAD95474 | P. popilliae popilliae |
| Cry43Ba1 | BAD15303 | P. lentimorbus semadara |
| Cry43Ca1 | KC156676 | ARP132 |
| Cry43Cb1 | KC156695 | ARP252 |
| Cry43Cc1 | KC156696 | ARP191 |
| Cry43-like | BAD15305 | P. lentimorbus semadara |
| Cry44Aa1 | BAD08532 | Bt entomocidus INA288 |
| Cry45Aa1 | BAD22577 | Bt 89-T-34-22 |
| Cry45Ba1 | | LM1212 |
| Cry46Aa1 | BAC79010 | Bt dakota |
| Cry46Aa2 | BAG68906 | Bt A1470 |
| Cry46Ab1 | BAD35170 | Bt |
| Cry47Aa1 | AAY24695 | Bt CAA890 |
| Cry48Aa1 | CAJ18351 | Bs IAB59 |
| Cry48Aa2 | CAJ86545 | Bs 47-6B |
| Cry48Aa3 | CAJ86546 | Bs NHA15b |
| Cry48Ab1 | CAJ86548 | Bs LP1G |
| Cry48Ab2 | CAJ86549 | Bs 2173 |
| Cry49Aa1 | CAH56541 | Bs IAB59 |
| Cry49Aa2 | CAJ86541 | Bs 47-6B |
| Cry49Aa3 | CAJ86543 | BsNHA15b |
| Cry49Aa4 | CAJ86544 | Bs 2173 |
| Cry49Ab1 | CAJ86542 | Bs LP1G |
| Cry50Aa1 | BAE86999 | Bt sotto |
| Cry50Ba1 | GU446675 | Bt S2160-1 |
| Cry50Ba2 | GU446676 | Bt S3161-3 |
| Cry51Aa1 | ABI14444 | Bt F14-1 |
| Cry51Aa2 | GU570697 | EG2934 |
| Cry52Aa1 | EF613489 | Bt Y41 |
| Cry52Ba1 | FJ361760 | Bt BM59-2 |
| Cry52Ca1 | KM053253 | Bt SK700 |
| Cry53Aa1 | EF633476 | Bt Y41 |
| Cry53Ab1 | FJ361759 | Bt MC28 |
| Cry54Aa1 | ACA52194 | Bt MC28 |
| Cry54Aa2 | GQ140349 | Bt FBG25 |
| Cry54Ab1 | JQ916908 | Bt MC28 |
| Cry54Ba1 | GU446677 | Bt S2160-1 |
| Cry54Ba2 | KJ740650 | BN15-6 |
| Cry55Aa1 | ABW88932 | YBT 1518 |
| Cry55Aa2 | AAE33526 | Bt Y41 |
| Cry55Aa3 | HG764207 | Bt T44 |
| Cry56Aa1 | ACU57499 | Bt Ywc2-8 |
| Cry56Aa2 | GQ483512 | Bt G7-1 |
| Cry56Aa3 | JX025567 | Bt HS18-1 |
| Cry56Aa4 | KJ740651 | BN7-5 |
| Cry57Aa1 | ACN87261 | Bt kim |
| Cry57Ab1 | KF638650 | Bt LTS290 |
| Cry58Aa1 | ACN87260 | Bt entomocidus |
| Cry59Ba1 | JN790647 | Bt Bm59-2 |
| Cry59Aa1 | ACR43758 | Bt kim LBIT-980 |
| Cry60Aa1 | ACU24782 | Bt jegathesan |
| Cry60Aa2 | EAO57254 | Bt israelensis |
| Cry60Aa3 | EEM99278 | Bt IBL 4222 |
| Cry60Ba1 | GU810818 | Bt malayensis |
| Cry60Ba2 | EAO57253 | Bt israelensis |
| Cry60Ba3 | EEM99279 | Bt IBL 4222 |
| Cry61Aa1 | HM035087 | Sbt009 |
| Cry61Aa2 | HM132125 | HD868 (E5) |
| Cry61Aa3 | EEM19308 | BGSC 4Y1 |
| Cry62Aa1 | HM054509 | ST7 |
| Cry63Aa1 | BAI44028 | MO19 |
| Cry64Aa1 | BAJ05397 | Bt tohokuensis |
| Cry64Ba1 | AGT29559 | BT 210-8-45 |
| Cry64Ca1 | AGT29560 | BT 210-8-45 |
| Cry65Aa1 | HM461868 | SBt 003 |
| Cry65Aa2 | ZP_04123838 | T13001 |
| Cry66Aa1 | AEB52311 | SBt 021 |
| Cry66Aa2 | ZP 04099945 | BGSC 4AW1 |
| Cry67Aa1 | HM485582 | SBt 009 |
| Cry67Aa2 | ZP_04148882 | BGSC 4Y1 |
| Cry68Aa1 | HQ113114 | Bt MC28 |
| Cry69Aa1 | HQ401006 | Bt MC28 |
| Cry69Aa2 | JQ821388 | Bt MC28 |
| Cry69Ab1 | JN209957 | Bt hs18-1 |
| Cry70Aa1 | JN646781 | Bt hs18-1 |
| Cry70Ba1 | ADO51070 | Bt MC28 |
| Cry70Bb1 | EEL67276 | Bc AH603 |
| Cry71Aa1 | JX025568 | Bt Hs18-1 |
| Cry72Aa1 | JX025569 | Bt Hs18-1 |
| Cry72Aa2 | KX094975 | |
| Cry73Aa1 | AEH76822 | Sbt Sbt029 |
| Cry74Aa | | LM1212 |
| Cry75Aa1 | ASY04853 | Bl EG5553 |
| Cry75Aa2 | ASY04852 | Bl EG5551 |
| Cry75Aa3 | ASY04851 | Bl EG5552 |
| Cry76Aa1 | MH810248 | |
| Cry77Aa1 | MH810249 | |
| Cry78Aa1 | KY780623 | Bt C9F1 |

In some embodiments, an IA can be one or more of the following Cyt proteins: Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and/or Cyt3Aa1.

In some embodiments, an IA can be any Cyt toxin as described herein, or presented in Table 8.

TABLE 8
Non-limiting examples of Cyt toxins, their accession numbers
on NCBI, and strain. Here, if a cell is left blank, then
the accession number and/or strain is not applicable.

| Name | NCBI Accession No. | Strain/Other ID |
|---|---|---|
| Cyt1Aa1 | X03182 | Bt israelensis |
| Cyt1Aa2 | X04338 | Bt israelensis |
| Cyt1Aa3 | Y00135 | Bt morrisoni PG14 |
| Cyt1Aa4 | M35968 | Bt morrisoni PG14 |
| Cyt1Aa5 | AL731825 | Bt israelensis |
| Cyt1Aa6 | ABC17640 | Bt LLP29 |
| Cyt1Aa7 | KF152888 | Bt BRC-HQY1 |
| Cyt1Aa8 | MF893205 | |
| Cyt1Aa-like | ABB01172 | Bt LDC-9 |
| Cyt1Ab1 | X98793 | Bt medellin |
| Cyt1Ba1 | U37196 | Bt neoleoensis |
| Cyt1Ca1 | AL731825 | Bt israelensis |
| Cyt1Da1 | HQ113115 | Bt MC28 |
| Cyt1Da2 | JN226105 | hs18-1 |
| Cyt2Aa1 | Z14147 | Bt kyushuensis |
| Cyt2Aa2 | AF472606 | Bt darmstadiensis73E10 |
| Cyt2Aa3 | EU835185 | Bt MC28 |
| Cyt2Aa4 | AEG19547 | Bt WFS-97 |
| Cyt2Bal | U52043 | Bt israelensis 4Q2 |
| Cyt2Ba2 | AF020789 | Bt israelensis PG14 |
| Cyt2Ba3 | AF022884 | Bt fuokukaensis |
| Cyt2Ba4 | AF022885 | Bt morrisoni HD12 |
| Cyt2Ba5 | AF022886 | Bt morrisoni HD518 |
| Cyt2Ba6 | AF034926 | Bt tenebrionis |
| Cyt2Ba7 | AF215645 | Bt T301 |
| Cyt2Ba8 | AF215646 | Bt T36 |
| Cyt2Ba9 | AL731825 | Bt israelensis |
| Cyt2Ba10 | ACX54358 | Bti HD 567 |
| Cyt2Bal1 | ACX54359 | Bti HD 522 |
| Cyt2Ba12 | ACX54360 | Bti INTA H41-1 |
| Cyt2Ba13 | FJ205865 | INTA 160-2 |
| Cyt2Bal4 | FJ205866 | Bti IPS82 |
| Cyt2Ba15 | JF283552 | Bt LLP29 |
| Cyt2Ba16 | MG181950 | QL32-1 |
| Cyt2Ba-like | ABE99695 | Bt LDC-9 |
| Cyt2Bb1 | U82519 | Bt jegathesan |
| Cyt2Bc1 | CAC80987 | Bt medellin |
| Cyt2B-like | DQ341380 | |
| Cyt2Ca1 | AAK50455 | Bt |
| Cyt3Aa1 | HM596591 | Bt TD516 |

In some embodiments, an IA can be a protein belonging to the Vip1, Vip2, Vip3, or Vip4 family. For example, in some embodiments, an IA can be one or more of the following Vip proteins: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and/or Vip4Aa1.

In some embodiments, an IA can be any Vip protein as described herein, or presented in Table 9.

TABLE 9
Non-limiting examples of Vip proteins and their accession
numbers on NCBI. Here, if a cell is left blank, then the
accession number is not applicable.

| Name | NCBI Accession No. |
|---|---|
| Vip1Aa1 | |
| Vip1Aa2 | AAR81088 |
| Vip1Aa3 | GU992203 |
| Vip1Ab1 | |
| Vip1Ac1 | HM439098 |
| Vip1Ad1 | AGC08395 |
| Vip1Ba1 | AAR40886 |
| Vip1Ba2 | CAI43278 |
| Vip1Bb1 | AAR40282 |
| Vip1Bb2 | HM485584 |
| Vip1Bb3 | KR065727 |
| Vip1Bc1 | HM485583 |
| Vip1Ca1 | AAO86514 |
| Vip1Ca2 | KR065725 |
| Vip1Da1 | CAI40767 |
| Vip2Aa1 | 1QS1A |
| Vip2Aa2 | AAR81096 |
| Vip2Aa3 | HM439097 |
| Vip2Ab1 | |
| Vip2Ac1 | AAO86513 |
| Vip2Ac2 | KR065726 |
| Vip2Ad1 | CAI40768 |
| Vip2Ae1 | EF442245 |
| Vip2Ae2 | ACH42758 |
| Vip2Ae3 | HM439099 |
| Vip2Af1 | ACH42759 |
| Vip2Af2 | EU909204 |
| Vip2Ag1 | AGC08396 |
| Vip2Ag2 | KC951878 |
| Vip2Ba1 | AAR40887 |
| Vip2Ba2 | CAI43279 |
| Vip2Bb1 | |
| Vip2Bb2 | HM485585 |
| Vip2Bb3 | KJ868170 |
| Vip2Bb4 | KR065728 |
| Vip3Aa1 | AAC37036 |
| Vip3Aa2 | AAC37037 |
| Vip3Aa3 | |
| Vip3Aa4 | AAR81079 |
| Vip3Aa5 | AAR81080 |
| Vip3Aa6 | AAR81081 |
| Vip3Aa7 | AAK95326 |
| Vip3Aa8 | AAK97481 |
| Vip3Aa9 | CAA76665 |
| Vip3Aa10 | AAN60738 |
| Vip3Aa11 | AAR36859 |
| Vip3Aa12 | AAM22456 |
| Vip3Aa13 | AAL69542 |
| Vip3Aa14 | AAQ12340 |
| Vip3Aa15 | AAP51131 |
| Vip3Aa16 | AAW65132 |
| Vip3Aa17 | |
| Vip3Aa18 | AAX49395 |
| Vip3Aa19.0 | DQ241674 |
| Vip3Aa19 | DQ539887 |
| Vip3Aa20 | DQ539888 |
| Vip3Aa21 | ABD84410 |
| Vip3Aa22 | AAY41427 |
| Vip3Aa23 | AAY41428 |
| Vip3Aa24 | BI 880913 |
| Vip3Aa25 | EF608501 |
| Vip3Aa26 | EU294496 |
| Vip3Aa27 | EU332167 |
| Vip3Aa28 | FJ494817 |
| Vip3Aa29 | FJ626674 |
| Vip3Aa30 | FJ626675 |
| Vip3Aa31 | FJ626676 |
| Vip3Aa32 | FJ626677 |
| Vip3Aa33 | GU073128 |
| Vip3Aa34 | GU073129 |
| Vip3Aa35 | GU733921 |
| Vip3Aa36 | GU951510 |
| Vip3Aa37 | HM132041 |
| Vip3Aa38 | HM117632 |
| Vip3Aa39 | HM117631 |
| Vip3Aa40 | HM132042 |
| Vip3Aa41 | HM132043 |
| Vip3Aa42 | HQ587048 |
| Vip3Aa43 | HQ594534 |
| Vip3Aa44 | HQ650163 |
| Vip3Aa45 | JF710269 |
| Vip3Aa46 | JQ228436 |
| Vip3Aa47 | JQ228435 |
| Vip3Aa48 | JQ731616 |
| Vip3Aa49 | JQ731617 |
| Vip3Aa50 | JQ946639 |
| Vip3Aa51 | KC156649 |
| Vip3Aa52 | KF826718 |
| Vip3Aa53 | KF826723 |
| Vip3Aa54 | AHK23264 |
| Vip3Aa55 | KJ868172 |
| Vip3Aa56 | LN624748 |
| Vip3Aa57 | AJD18609 |
| Vip3Aa58 | KR259139 |
| Vip3Aa59 | KR259140 |
| Vip3Aa60 | KR340473 |
| Vip3Aa61 | KU522245 |
| Vip3Aa62 | KT792883 |
| Vip3Aa63 | KY780302 |
| Vip3Aa64 | KY883694 |
| Vip3Aa65 | MH290720 |
| Vip3Aa66 | MK252100 |
| Vip3Ab1 | AAR40284 |
| Vip3Ab2 | AAY88247 |
| Vip3Ac1 | |
| Vip3Ad1 | |
| Vip3Ad2 | CAI43276 |
| Vip3Ad3 | KF826720 |
| Vip3Ad4 | KF826727 |
| Vip3Ad5 | KR263164 |
| Vip3Ad6 | KU761577 |
| Vip3Ae1 | CAI43277 |
| Vip3Af1 | CAI43275 |
| Vip3Af2 | |
| Vip3Af3 | HM117634 |
| Vip3Af4 | KM276664 |
| Vip3Ag1 | |
| Vip3Ag2 | FJ556803 |
| Vip3Ag3 | HM117633 |
| Vip3Ag4 | HQ414237 |
| Vip3Ag5 | HQ542193 |
| Vip3Ag6 | JQ397328 |
| Vip3Ag7 | KF826713 |
| Vip3Ag8 | KF826714 |
| Vip3Ag9 | KF826715 |
| Vip3Ag10 | KF826716 |
| Vip3Ag11 | KF826719 |
| Vip3Ag12 | KF826721 |
| Vip3Ag13 | KF826722 |
| Vip3Ag14 | KF826725 |
| Vip3Ag15 | KF826726 |
| Vip3Ah1 | DQ832323 |
| Vip3Ah2 | AQY42675 |
| Vip3Ai1 | KC156693 |
| Vip3Aj1 | KF826717 |
| Vip3Aj2 | KF826724 |
| Vip3Ba1 | AAV70653 |
| Vip3Ba2 | HM117635 |
| Vip3Bb1 | |
| Vip3Bb2 | ABO30520 |
| Vip3Bb3 | ADI48120 |
| Vip3Bc | MF543028 |
| Vip3Ca1 | ADZ46178 |
| Vip3Ca2 | AEE98106 |
| Vip3Ca3 | HQ876489 |
| Vip3Ca4 | JN836992 |
| Vip4Aa1 | HM044666 |

Crip and Ia Combinations

Any of the aforementioned CRIPs or IAs can be used to create a mixture and/or composition of the present invention, wherein said mixture and/or composition comprises at least one CRIP, and at least one other IA.

Described and incorporated by reference to the polypeptides identified herein are homologous variants of sequences mentioned, having homology to such sequences or referred to herein, including all homologous sequences having at least any of the following percent identities to any of the sequences disclosed here or to any sequence incorporated by reference: 50%, 55%, 60%, 65%, 70%, 75%, 80%, 85%, 90%, 95%, 96%, 97%, 98%, or 99% or greater identity, or 100% identity to any and all sequences identified in the sequences noted above, and to any other sequence identified herein, including each and every sequence in the sequence listing of this application. When the term homologous or homology is used herein with a number such as 50% or greater, then what is meant is percent identity or percent similarity between the two peptides. When homologous or homology is used without a numeric percent then it refers to two peptide sequences that are closely related in the evolutionary or developmental aspect in that they share common physical and functional aspects, like topical toxicity and similar size (i.e., the homolog being within 100% greater length or 50% shorter length of the peptide specifically mentioned herein or identified by reference herein as above).

In some embodiments a mixture can consist of any CRIP described herein, and any IA described herein.

In some embodiments, a mixture can comprise one or more CRIPs combined with one or more IAs; and wherein the mixture further comprises an excipient.

CRIP and IA Combinations

In some embodiments, any one or more of the CRIPs presented in Table A may be combined with any one or more of the IAs presented in Table B.

Table A and Table B below presents preferred CRIPs and IAs of the present invention, respectfully. Both tables provide a “Group No.” and a “Group Name”: these designations identify the category a given CRIP or IA belongs to. CRIP Group Nos are preceded by the Roman numeral “I” (e.g., I1, I2, I3, etc.). Insecticidal Agent (IA) Group Nos are preceded by the Roman numeral “II” (e.g., II2, II3, II3, etc.). A further level of specificity is provided with the “CRIP No.” and “IA No.”; these designations identify specific CRIPs or IAs. The CRIP Nos are preceded by an “A” (e.g., A1, A2, A3, etc.). IA Nos are preceded by a “B” (e.g., B1, B2, B3, etc.).

TABLE A
CRIPs of the present invention.

| | | CRIP No. | | |
|---|---|---|---|---|
| | | (Preceded | | SEQ |
| Group No. | Group Name | by “A”) | Name | ID NO. |
| I1 | U1-agatoxin- | 1 | WT-Ta1b | 1 |
| | Ta1b | | | |
| I2 | U1-agatoxin- | 2 | TVP-R9Q | 2 |
| | Ta1b Variant | 3 | TVP-R9QΔG | 3 |
| | Polypeptides | 4 | TVP-K18A | 4 |
| | (TVPs) | 5 | TVP-K18AΔG | 5 |
| | | 6 | TVP-R38A | 6 |
| | | 7 | TVP-R38AΔG | 7 |
| | | 8 | TVP-A8N | 8 |
| | | 9 | TVP-A8NΔG | 9 |
| | | 10 | TVP-A8S | 10 |
| | | 11 | TVP-A8SΔG | 11 |
| | | 12 | TVP-R9N | 12 |
| | | 13 | TVP-R9NΔG | 13 |
| | | 14 | TVP-T11P | 14 |
| | | 15 | TVP-T11PΔG | 15 |
| | | 16 | TVP-T43A | 49 |
| | | 17 | TVP-T43AΔG | 50 |
| | | 18 | TVP-R9Q/T43A | 51 |
| | | 19 | TVP-R9Q/T43A/ΔG | 52 |
| | | 20 | TVP-R9Q/T43A/ΔK-G | 53 |
| | | 21 | TVP-R9A | 621 |
| | | 22 | TVP-R9G | 622 |
| | | 23 | TVP-R9N | 623 |
| | | 24 | TVP-R9L | 624 |
| | | 25 | TVP-R9D | 625 |
| | | 26 | TVP-R9V | 626 |
| | | 27 | TVP-R9M | 627 |
| | | 28 | TVP-R9I | 628 |
| | | 29 | TVP-R9Q/T43A | 629 |
| | | 30 | TVP-R9Q | 630 |
| | | 31 | TVP-R9C | 631 |
| | | 32 | TVP-R9E | 632 |
| | | 33 | TVP-R9T | 633 |
| | | 34 | TVP-R9S | 634 |
| | | 35 | TVP-T43F | 635 |
| | | 36 | TVP-T43P | 636 |
| | | 37 | TVP-T43Y | 637 |
| | | 38 | TVP-T43K | 638 |
| | | 39 | TVP-T43W | 639 |
| | | 40 | TVP-T43H | 640 |
| | | 41 | TVP-T43A | 641 |
| | | 42 | TVP-T43G | 642 |
| | | 43 | TVP-T43N | 643 |
| | | 44 | TVP-T43L | 644 |
| | | 45 | TVP-T43D | 645 |
| | | 46 | TVP-T43V | 646 |
| | | 47 | TVP-T43M | 647 |
| | | 48 | TVP-T43I | 648 |
| | | 49 | TVP-T43Q | 649 |
| | | 50 | TVP-T43C | 650 |
| | | 51 | TVP-T43E | 651 |
| | | 52 | TVP-T43T | 652 |
| | | 53 | TVP-T43S | 653 |
| | | 54 | TVP-T43R | 654 |
| I3 | Scorpion | 55 | IpTx-a | 66 |
| | Toxins | 56 | AaIT1 | 88 |
| I4 | Sea Anemone | 57 | WT Av2 | 588 |
| | Toxins | 58 | WT Av3 | 44 |
| I5 | Av3 Variant | 59 | AVPa | 45 |
| | Polypeptides | 60 | AVPa-C1 | 46 |
| | (AVPs) | 61 | AVPb | 47 |
| I6 | Atracotoxin | 62 | U-ACTX-Hv1a | 60 |
| | (ACTX) | 63 | U+2-ACTX-Hv1a | 61 |
| | | 64 | ω-ACTX-Hv1a | 62 |
| | | 65 | ω+2-ACTX-Hv1a | 63 |
| | | 66 | K+2-ACTX-Hv1a | 64 |
| | | 67 | K-ACTX-Hv1a | 594 |
| I7 | Phoneutria | 68 | Γ-CNTX-Pn1a | 65 |
| | Toxins | | | |

TABLE B
Insecticidal Agents (IAs) of the present invention. Here,
the asterisk “*” indicates an IA that was shown to not
exert a greater than additive insecticidal effect
when combined with U+2-ACTX-Hv1a (SEQ ID NO: 61).

| | | IA No. | |
|---|---|---|---|
| Group | | (Preceded by | |
| No. | Group Name | “B”) | IA Name |
| II1 | RNAi | 1 | dsRNA (e.g., WupA dsRNA) |
| II2 | Stomach Poisons | 2 | Arsenicals |
| | | 3 | “Paris green” or copper |
| | | | acetoarsenite |
| | | 4 | Lead arsenate |
| | | 5 | Calcium arsenate |
| | | 6 | Fluorine compounds |
| | | 7 | Sodium fluoride |
| | | 8 | Cryolite* |
| | | 9 | Boron-containing compounds |
| | | 10 | Borates (e.g. |
| | | 11 | Borax |
| | | 12 | Boric acid |
| | | 13 | Disodium octaborate |
| | | 14 | Sodium borate |
| | | 15 | Sodium metaborate |
| | | 16 | Sodium tetraborate decahydrate |
| | | 17 | Boron oxide |
| | | 18 | Boron carbide |
| | | 19 | Boron nitride |
| | | 20 | Boron tribromide |
| | | 21 | Boron trichloride |
| | | 22 | Boron trifluoride |
| | | 23 | Anhydrous borax (Na₂B₄O₇) |
| | | 24 | Ammonium tetraborate |
| | | | ((NH₄)₂B₄O₇•4H₂O) |
| | | 25 | Ammonium pentaborate |
| | | | ((NH₄)₂B₁₀O₁₆•8H₂O) |
| | | 26 | Potassium pentaborate |
| | | | (K₂B₁₀O₁₆•8H₂O) |
| | | 27 | Potassium tetraborate |
| | | | (K₂B₄O₇•4H₂O) |
| | | 28 | Sodium metaborate |
| | | | (Na₂B₂O4•8H₂O) |
| | | 29 | Sodium metaborate |
| | | | (Na₂B₂O₄•4H₂O) |
| | | 30 | Disodium tetraborate decahydrate |
| | | | (Na₂B₄O₇•10H₂O) |
| | | 31 | Disodium tetraborate |
| | | | pentahydrate (Na₂B₄O₇•5H₂O) |
| | | 32 | Disodium octaborate tetrahydrate |
| | | | (Na₂B₈O₁₃•4H₂O) |
| II3 | Inhibitors of | 33 | Benzoylureas |
| | chitin | 34 | Bistrifluron |
| | biosynthesis | 35 | Chlorfluazuron |
| | type 0 | 36 | Diflubenzuron |
| | | 37 | Flucycloxuron |
| | | 38 | Flufenoxuron |
| | | 39 | Hexaflumuron |
| | | 40 | Lufenuron |
| | | 41 | Novaluron* |
| | | 42 | Noviflumuron |
| | | 43 | Teflubenzuron |
| | | 44 | Triflumuron |
| II4 | Inhibitors of | 45 | Buprofezin |
| | chitin | | |
| | biosynthesis, | | |
| | type 1 | | |
| II5 | Insect Viruses | 46 | Baculoviridae viruses |
| | | 47 | Alphabaculovirus |
| | | 48 | Betabaculoviruses |
| | | 49 | Deltabaculovirus |
| | | 50 | Gammabaculovirus |
| | | 51 | Granuloviruses (GVs) |
| | | 52 | Nucleopolyhedroviruses (NPVS) |
| | | 53 | Cydia pomonella GV |
| | | 54 | Cydia pomonella GV isolate V22 |
| | | 55 | Thaumatotibia leucotreta GV |
| | | 56 | Anticarsia gemmatalis MNPV |
| | | 57 | Helicoverpa armigera NPV |
| | | 58 | Parvoviridae viruses |
| | | 59 | Junonia coenia densovirus |
| | | | (JcDNV) |
| | | 60 | Ascoviridae family viruses |
| | | 61 | Densovirinae family viruses |
| | | 62 | Entomopoxvirinae family viruses |
| | | 63 | Iridoviridae family viruses |
| | | 64 | Nudiviridae family viruses |
| II6 | Compounds | 65 | Azadirachtin |
| | isolated from | 66 | Azadiradione |
| | Azadirachta | 67 | Azadiradionolide |
| | indica | 68 | Deacetylgedunin |
| | | 69 | Deacetylazadirachtinol |
| | | 70 | Desfuranoazadiradione |
| | | 71 | Epoxyazadiradione |
| | | 72 | Gedunin |
| | | 73 | Mahmoodin |
| | | 74 | Neemfruitin A |
| | | 75 | Neemfruitin B |
| | | 76 | Nimbolide |
| | | 77 | Nimbin |
| | | 78 | Nimolicinol |
| | | 79 | Ohchinin Acetate |
| | | 80 | Salannin |
| | | 81 | Salannol |
| | | 82 | Alpha-Nimolactone |
| | | 83 | Beta-Nimolactone |
| | | 84 | 2′,3′-Dihydrosalannin |
| | | 85 | 3-Deacetylsalannin |
| | | 86 | 6-Deacetylnimbin |
| | | 87 | 7-Acetyl-16,17-dehydro-16- |
| | | | hydroxyneotrichilenone |
| | | 88 | 7-Benzoylnimbocinol |
| | | 89 | 7-Deacetyl-7- |
| | | | benzoylepoxyazadiradione |
| | | 90 | 7-Deacetyl-7-benzoylgedunin |
| | | 91 | 7-Deacetyl-17-epinimolicinol |
| | | 92 | 15-Hydroxyazadiradione |
| | | 93 | 17-Epi-17-Hydroxyazadiradione |
| | | 94 | 17-Epiazadiradione |
| | | 95 | 20,21,22,23-Tetrahydro-23- |
| | | | oxoazadirone |
| | | 96 | 22,23-Dihydronimocinol |
| | | 97 | 28-Deoxonimbolide |
| II7 | Compounds | 98 | Benzoximate |
| | with unknown | 99 | Bromopropylate |
| | MOAs | 100 | Chinomethionat |
| | | 101 | Dicofol |
| | | 102 | Lime sulfur |
| | | 103 | Pyridalyl |
| | | 104 | Sulfur |
| II8 | Bacteria: | 105 | Brevibacillus brevis |
| | including the | 106 | Brevibacillus brevis toxins |
| | fermentation | 107 | TIC4670 Beta pore forming |
| | solids, spores, | | protein |
| | toxins, and/or | 108 | Alcaligenes faecalis |
| | products | 109 | Alcaligenes faecalis toxins |
| | therefrom | 110 | AfIP-1A/1B |
| | | 111 | Pseudomonas chlororaphis |
| | | 112 | Pseudomonas chlororaphis toxins |
| | | 113 | PIP-72Aa |
| | | 114 | Yersinia entomophaga |
| | | 115 | Yersinia entomophaga MH96 |
| | | 116 | Yersinia nurmii |
| | | 117 | Photorhabdus luminescens |
| | | 118 | Photorhabdus luminescens “toxin |
| | | | complex a” (Tca) |
| | | 119 | Photorhabdus luminescens “toxin |
| | | | complex c” (Tcc) |
| | | 120 | Photorhabdus luminescens “toxin |
| | | | complex d” (Tcd) |
| | | 121 | Photorhabdus luminescens Tca |
| | | | comprising TcaA protein (SEQ |
| | | | ID NO: 616), TcaB protein |
| | | | (SEQ ID NO: 617), TcaC |
| | | | protein (SEQ ID NO: 618), and |
| | | | TcaZ protein (SEQ ID NO: |
| | | | 619) |
| | | 122 | Burkholderia spp |
| | | 123 | Wolbachie pipientis |
| | | 124 | Bacillus thuringiensis |
| | | 125 | Bacillus thuringiensis toxins |
| | | 126 | Bacillus thuringiensis var. |
| | | | israelensis |
| | | 127 | Bacillus thuringiensis var. |
| | | | israelensis toxins |
| | | 128 | Bacillus thuringiensis var. |
| | | | aizawai |
| | | 129 | Bacillus thuringiensis var. |
| | | | aizawai toxins |
| | | 130 | Bacillus thuringiensis var. |
| | | | kurstaki |
| | | 131 | Bacillus thuringiensis var. |
| | | | kurstaki toxins |
| | | 132 | Bacillus thuringiensis var. |
| | | | tenebrionensis |
| | | 133 | Bacillus thuringiensis var. |
| | | | tenebrionensis toxins |
| | | 134 | Bacillus sphaericus |
| | | 135 | Bacillus thuringiensis toxins |
| | | 136 | Parasporal crystal toxins |
| | | 137 | δ-endotoxins |
| | | 138 | Cry toxins |
| | | 139 | Cyt toxins |
| | | 140 | Secreted protein |
| | | 141 | Vegetative insecticidal proteins |
| | | | (Vips) |
| | | 142 | Secreted insecticidal proteins |
| | | | (Sips) |
| | | 143 | Bin-like family proteins |
| | | 144 | ETX MTX2-family proteins |
| | | 145 | Bacillus thuringiensis ssp. |
| | | | kurstaki strain EVB-113-19 cells |
| | | 146 | Fermentation solids, spores, and/ |
| | | | or insecticidal toxins isolated |
| | | | from Bacillus thuringiensis ssp. |
| | | | kurstaki strain EVB-113-19 cells |
| | | 147 | Bacillus thuringiensis ssp. |
| | | | tenebrionis strain NB-176 cells |
| | | 148 | Fermentation solids, spores, and/ |
| | | | or insecticidal toxins isolated |
| | | | from Bacillus thuringiensis ssp. |
| | | | tenebrionis strain NB-176 cells |
| | | 149 | Bacillus thuringiensis ssp. |
| | | | israelensis Strain BMP 144 cells |
| | | 150 | Fermentation solids, spores, and/ |
| | | | or insecticidal toxins isolated |
| | | | from Bacillus thuringiensis ssp. |
| | | | israelensis Strain BMP 144 cells. |
| II9 | Fungi: including | 151 | Ascomycete fungi |
| | the fermentation | 152 | Cordycipitaceae fungi |
| | solids, spores, | 153 | Beauveria bassiana and/or the |
| | toxins, and/or | | toxins therefrom |
| | products | 154 | Beauvericin |
| | therefrom | 155 | Beauvericin having the chemical |
| | | | formula C₄₅H₅₇N₃O₉ |
| | | 156 | “Beauvericin A” toxin having the |
| | | | chemical formula C₄₆H₅₉N₃O₉ |
| | | 157 | “Beauvericin B” toxin having the |
| | | | chemical formula C₄₇H₆₁N₃O₉ |
| | | 158 | Beauveria bassiana strain ANT- |
| | | | 03 spore |
| | | 159 | Cordyceps bassiana, and/or the |
| | | | toxins therefrom |
| | | 160 | Metarhizium anisopliae (e.g., |
| | | | strain F52) and the products |
| | | | therefrom |
| | | 161 | Paecilomyces fumosoroseus (e.g., |
| | | | Apopka strain 97) and the |
| | | | products therefrom |
| II10 | Nematodes | 162 | Steinernema glaseri and/or the |
| | | | products therefrom |
| | | 163 | Heterorhabditis bacteriophora |
| | | | and/or the products therefrom |
| I11 | Botanical | 164 | Dysphania ambrosioides |
| | essences | 165 | Near ambrosioides extract |
| | | 166 | Fatty acid monoesters with |
| | | | glycerol |
| | | 167 | Propanediol Neem oil |
| | | 168 | Neem oil |
| II12 | Mechanical | 169 | Diatomaceous earth |
| | disruptors | 170 | Minerals |
| | | 171 | Synthetic/natural fibers |
| II13 | Fluorescent | 172 | Calcofluor White M2R |
| | brighteners | | |
| II14 | Silica | 173 | NanoXact Silica Nanospheres* |
| | nanospheres | | |
| II15 | Chitinases | 174 | Chitinase from Streptomyces |
| | | | griseus |
| II16 | Lectins | 175 | Galanthus nivalis agglutinin |
| | | | (GNA) |
| | | 176 | Sambucus nigra lectin (SNA) |
| | | 177 | Leukoagglutinating lectin from |
| | | | the seeds of Maackia amurensis |
| | | | (MAL) |
| | | 178 | Maackia amurensis-II (MAL-II) |
| | | 179 | Erythrina cristagalli lectin (ECL) |
| | | 180 | Ricinus communis agglutinin-I |
| | | | (RCA) |
| | | 181 | Peanut agglutinin (PNA) |
| | | 182 | Agglutinin isolectin 1 (WGA1) |
| | | 183 | Wheat germ agglutinin (WGA) |
| | | 184 | Griffonia simplicifolia-II (GSL-II) |
| | | 185 | Con A |
| | | 186 | Concanavalin-A (CNA) precursor |
| | | 187 | Lens culinaris agglutinin (LCA) |
| | | 188 | Mannose-binding lectin (MBL) |
| | | 189 | Jacalin-like lectin (Chain A) |
| | | 190 | Lectin alpha-1 chain |
| | | 191 | Lectin CaBo |
| | | 192 | BanLec |
| | | 193 | Galectins |
| | | 194 | Lectin ConGF |
| | | 195 | Mannose-specific lectin alpha |
| | | | chain |
| | | 196 | Beta-galactoside-specific lectin 1 |
| | | 197 | Galectin-3 |
| | | 198 | Phaseolus vulgaris |
| | | | Leucoagglutinin (PHA-L) |
| | | 199 | Phaseolus vulgaris |
| | | | Erythroagglutinin (PHA-E) |
| | | 200 | Datura stramonium Lectin (DSL) |
| | | 201 | Mannose/glucose-specific lectin |
| | | | Cramoll |
| | | 202 | Beta-galactoside-specific lectin 3 |
| | | 203 | Lactose-binding lectin-2 |
| | | 204 | Galectin-1 |
| | | 205 | Alpha-N-acetylgalactosamine- |
| | | | specific lectin |
| | | 206 | Favin |
| II17 | Membrane | 207 | MACPF isolated from fern |
| | Attack | 208 | GNIP1Aa isolated form |
| | Complex/ | | chromobacteria |
| | Perforin | | |
| | (MACPF) | | |
| | proteins | | |
| II18 | Plant virus coat | 209 | Pea enation mosaic virus |
| | protein-toxin | | (PEMV) fusion |
| | fusions | 210 | POC anti-aphids |
| II19 | Glycan binding | 211 | Chitinase glycan binding domain |
| | domain/toxin | | from Yersinia entomophaga |
| | fusion proteins | | MH96 fused to- |
| | | 212 | Glycan binding domain from |
| | | | GNA fused to- |
| | | 213 | Glycan binding domain from |
| | | | plant Luteovirus fused to- |
| | | 214 | Glycan binding domain from |
| | | | insect Parvoviridae fused to- |
| | | 215 | Glycan binding domain from |
| | | | insect Baculoviridae viruses |
| | | | fused to- |
| II20 | Acetyl- | 216 | Alanycarb |
| | cholinesterase | 217 | Aldicarb |
| | (AchE) | 218 | Bendiocarb |
| | inhibitors | 219 | Benfuracarb |
| | | 220 | Butocarboxim |
| | | 221 | Butoxycarboxim |
| | | 222 | Carbaryl |
| | | 223 | Carbofuran |
| | | 224 | Carbosulfan |
| | | 225 | Ethiofencarb |
| | | 226 | Fenobucarb |
| | | 227 | Formetanate |
| | | 228 | Furathiocarb |
| | | 229 | Isoprocarb |
| | | 230 | Methiocarb |
| | | 231 | Methomyl |
| | | 232 | Metolcarb |
| | | 233 | Oxamyl |
| | | 234 | Pirimicarb |
| | | 235 | Propoxur |
| | | 236 | Thiodicarb |
| | | 237 | Thiofanox |
| | | 238 | Triazamate |
| | | 239 | Trimethacarb |
| | | 240 | Xmc |
| | | 241 | Xylylcarb |
| | | 242 | Organophosphates |
| | | 243 | Acephate |
| | | 244 | Azamethiphos |
| | | 245 | Azinphos-ethyl |
| | | 246 | Azinphos-methyl |
| | | 247 | Cadusafos |
| | | 248 | Chlorethoxyfos |
| | | 249 | Chlorfenvinphos |
| | | 250 | Chlormephos |
| | | 251 | Chlorpyrifos |
| | | 252 | Chlorpyrifos-methyl |
| | | 253 | Coumaphos |
| | | 254 | Cyanophos |
| | | 255 | Demeton-s-methyl |
| | | 256 | Diazinon |
| | | 257 | Dichlorvos/ddvp |
| | | 258 | Dicrotophos |
| | | 259 | Dimethoate |
| | | 260 | Dimethylvinphos |
| | | 261 | Disulfoton |
| | | 262 | Epn |
| | | 263 | Ethion |
| | | 264 | Ethoprophos |
| | | 265 | Famphur |
| | | 266 | Fenamiphos |
| | | 267 | Fenitrothion |
| | | 268 | Fenthion |
| | | 269 | Fosthiazate |
| | | 270 | Heptenophos |
| | | 271 | Isofenphos |
| | | 272 | Isoxathion |
| | | 273 | Malathion |
| | | 274 | Mecarbam |
| | | 275 | Methamidophos |
| | | 276 | Methidathion |
| | | 277 | Mevinphos |
| | | 278 | Monocrotophos |
| | | 279 | Naled |
| | | 280 | Omethoate |
| | | 28 | Oxydemeton-methyl |
| | | 282 | Parathion |
| | | 283 | Parathion-methyl |
| | | 284 | Phenthoate |
| | | 285 | Phosalone |
| | | 286 | Phorate |
| | | 287 | Phosmet |
| | | 288 | Phosphamidon |
| | | 289 | Phoxim |
| | | 290 | Profenofos |
| | | 291 | Propetamphos |
| | | 292 | Prothiofos |
| | | 293 | Pyraclofos |
| | | 294 | Pyridaphenthion |
| | | 295 | Quinalphos |
| | | 296 | Sulfotep |
| | | 297 | Tebupirimfos |
| | | 298 | Temephos |
| | | 299 | Terbufos |
| | | 300 | Tetrachlorvinphos |
| | | 301 | Thiometon |
| | | 302 | Triazophos |
| | | 303 | Trichlorfon |
| | | 304 | Vamidothion |
| | | 305 | Pirimiphos-methyl |
| | | 306 | Imicyafos |
| | | 307 | Isopropyl o-(methoxyaminothio- |
| | | | phosphoryl) salicylate |
| II21 | GABA-gated | 308 | Cyclodiene organochlorines |
| | chloride channel | 309 | Chlordane |
| | blockers | 310 | Endosulfan |
| | | 311 | Phenylpyrazoles (fiproles) |
| | | 312 | Ethiprole |
| | | 313 | Fipronil |
| II22 | Sodium channel | 314 | Pyrethroids |
| | modulators | 315 | Pyrethrins |
| | | 316 | Acrinathrin |
| | | 317 | Allethrin |
| | | 318 | D-cis-trans allethrin |
| | | 319 | D-trans allethrin |
| | | 320 | Bifenthrin |
| | | 321 | Bioallethrin |
| | | 322 | Bioallethrin s-cyclopentenyl |
| | | 323 | Bioresmethrin |
| | | 324 | Cycloprothrin |
| | | 325 | Cyfluthrin |
| | | 326 | Beta-cyfluthrin |
| | | 327 | Cyhalothrin |
| | | 328 | Lambda-cyhalothrin |
| | | 329 | Gamma-cyhalothrin |
| | | 330 | Cypermethrin |
| | | 331 | Alpha-cypermethrin |
| | | 332 | Beta-cypermethrin |
| | | 333 | Theta-cypermethrin |
| | | 334 | Zeta-cypermethrin |
| | | 335 | Cyphenothrin [(1r)-trans-isomers] |
| | | 336 | Deltamethrin |
| | | 337 | Empenthrin [(ez)-(1r)-isomers] |
| | | 338 | Esfenvalerate |
| | | 339 | Etofenprox |
| | | 340 | Fenpropathrin |
| | | 34 | Fenvalerate |
| | | 342 | Flucythrinate |
| | | 343 | Flumethrin |
| | | 344 | Tau-fluvalinate |
| | | 345 | Kadathrin |
| | | 346 | Pyrethrins (pyrethrum) |
| | | 347 | Halfenprox |
| | | 348 | Phenothrin [(1r)-trans-isomer] |
| | | 349 | Prallethrin |
| | | 350 | Resmethrin |
| | | 351 | Silafluofen |
| | | 352 | Tefluthrin |
| | | 353 | Tetramethrin |
| | | 354 | Tetramethrin [(1r)-isomers] |
| | | 355 | Tralomethrin |
| | | 356 | Transfluthrin |
| | | 357 | And permethrin) |
| | | 358 | DDT |
| | | 359 | Methoxychlor |
| II23 | Nicotinic | 360 | Neonicotinoids |
| | acetylcholine | 361 | Acetamiprid |
| | receptor | 362 | Clothianidin |
| | (nAchR) | 363 | Dinotefuran |
| | Competitive | 364 | Imidacloprid |
| | Modulators | 365 | Nitenpyram |
| | | 366 | Thiacloprid |
| | | 367 | Thiamethoxam |
| | | 368 | Nicotine |
| | | 369 | Sulfoximines |
| | | 370 | Sulfoxaflor |
| | | 371 | Butenolides |
| | | 372 | Flupyradifurone |
| | | 373 | Mesoionics |
| | | 374 | Triflumezopyrim |
| II24 | Nicotinic | 375 | Spinosyns |
| | acetylcholine | 376 | Spinetoram |
| | receptor (nAchR) | 377 | Spinosad |
| | allosteric | | |
| | modulators-site I | | |
| II25 | Glutamate-gated | 378 | Avermectins |
| | chloride channel | 379 | Milbemycins |
| | (GluCl) allosteric | 380 | Abamectin |
| | modulators | 381 | Emamectin benzoate |
| | | 382 | Lepimectin |
| | | 383 | Milbemectin |
| II26 | Juvenile | 384 | Juvenile hormone analogues |
| | hormone | 385 | Hydroprene |
| | mimics | 386 | Kinoprene |
| | | 387 | And methoprene |
| | | 388 | Fenoxycarb |
| | | 389 | Pyriproxyfen |
| II27 | Miscellaneous | 390 | Alkyl halides |
| | non-specific | 391 | Methyl bromide |
| | (multi-site) | 392 | Alkyl halides |
| | inhibitors | 393 | Chloropicrin |
| | | 394 | Tartar emetic |
| | | 395 | Methyl isothiocyanate generators |
| | | 396 | Dazomet |
| | | 397 | Metam |
| II28 | Chordotonal | 398 | Pyridine azomethine derivatives |
| | organ | 399 | Pymetrozine |
| | TRPV channel | 400 | Pyrifluquinazon |
| | modulators | 401 | Pyropenes |
| | | 402 | Afidopyropen |
| II29 | Mite growth | 403 | Clofentezine |
| | inhibitors | 404 | Diflovidazin |
| | | 405 | Hexythiazox |
| | | 406 | Etoxazole |
| II30 | Inhibitors of | 407 | Diafenthiuron |
| | mitochondrial | 408 | Organotin miticides |
| | ATP synthase | 409 | Azocyclotin |
| | | 410 | Cyhexatin |
| | | 411 | And fenbutatin oxide |
| | | 412 | Propargite |
| | | 413 | Tetradifon |
| II31 | Uncouplers of | 414 | Pyrroles |
| | oxidative | 415 | Dinitrophenols |
| | phosphorylation | 416 | Sulfluramid |
| | via disruption | 417 | Chlorfenapyr |
| | of the proton | 418 | DNOC |
| | gradient | 419 | Sulfluramid |
| II32 | Nicotinic | 420 | Nereistoxin analogues |
| | acetylcholine | 421 | Bensultap |
| | receptor | 422 | Cartap hydrochloride |
| | (nAchR) channel | 423 | Thiocyclam |
| | blockers | 424 | Thiosultap-sodium |
| II34 | Moulting | 425 | Cyromazine |
| | disruptors | | |
| | (dipteran) | | |
| II35 | Ecdysone | 426 | Diacylhydrazines |
| | receptor | 427 | Chromafenozide |
| | agonists | 428 | Halofenozide |
| | | 429 | Methoxyfenozide |
| | | 430 | Tebufenozide |
| II36 | Octopamine | 431 | Amitraz |
| | receptor agonists | | |
| II37 | Mitochondrial | 432 | Hydramethylnon |
| | complex III | 433 | Acequinocyl |
| | electron | 434 | Fluacrypyrim |
| | transport | 435 | Bifenazate |
| | inhibitors | | |
| II38 | Mitochondrial | 436 | Meti acaricides |
| | complex I | 437 | Meti insecticides |
| | electron | 438 | Fenazaquin |
| | transport | 439 | Fenpyroximate |
| | inhibitors | 440 | Pyrimidifen |
| | | 441 | Pyridaben |
| | | 442 | Tebufenpyrad |
| | | 443 | Tolfenpyrad |
| | | 444 | Rotenone |
| II39 | Voltage- | 445 | Oxadiazines |
| | dependent | 446 | Indoxacarb |
| | sodium channel | 447 | Semicarbazones |
| | blockers | 448 | Metaflumizone |
| II40 | Inhibitors of | 449 | Tetronic derivatives |
| | acetyl co- | 450 | Tetramic acid derivatives |
| | enzyme A | 451 | Spirodiclofen |
| | carboxylase | 452 | Spiromesifen |
| | | 453 | Spiropidion |
| | | 454 | Spirotetramat |
| II41 | Mitochondrial | 455 | Phosphides |
| | complex IV | 456 | Aluminum phosphide |
| | electron | 457 | Calcium phosphide |
| | transport | 458 | Phosphine |
| | inhibitors | 459 | Zinc phosphide |
| | | 460 | Cyanides |
| | | 461 | Calcium cyanide |
| | | 462 | Potassium cyanide |
| | | 463 | Sodium cyanide |
| II42 | Mitochondrial | 464 | Beta-ketonitrile derivatives |
| | complex | 465 | Cyenopyrafen |
| | II electron | 466 | Cyflumetofen |
| | transport | 467 | Carboxanilides |
| | inhibitors | 468 | Pyflubumide |
| II43 | Ryanodine | 469 | Diamides |
| | receptor | 470 | Chlorantraniliprole |
| | modulators | 471 | Cyantraniliprole |
| | | 472 | Cyclaniliprole |
| | | 473 | Flubendiamide |
| | | 474 | Tetraniliprole |
| II44 | Chordotonal | 475 | Flonicamid |
| | organ | | |
| | modulators- | | |
| | undefined target | | |
| | site | | |
| II45 | GABA-gated | 476 | Meta-diamides |
| | chloride channel | 477 | Isoxazolines |
| | allosteric | 478 | Broflanilide |
| | modulators | 479 | Fluxametamide |

In some embodiments, a mixture of the present invention may comprise, consist essentially of, or consist of, one or more CRIPs selected from Table A, or combination thereof, and one or more Insecticidal Agents (IAs) selected from Table B, or combination thereof.

In some embodiments, a mixture of the present invention may comprise, consist essentially of, or consist of, one or more CRIPs selected from any one of CRIP Groups I1; I2; I3; I4; I5; I6; I7, or combination thereof; combined with any one or more IAs in IA Groups II1; II2; II3; II4; II5; II6; II7; II8; II9; II10; II11; II12; II13; II14; II15; II16; II17; II18; II19; II20; II21; II22; II23; II24; II25; II26; II27; II28; II29; II30; II31; II32; II33; 1134; II35; II36; II37; II38; II39; II40; II41; II42; II43; II44; II45, or combination thereof.

In some embodiments, a mixture of the present invention may comprise, consist essentially of, or consist of, a CRIP selected from: A1; A2; A3; A4; A5; A6; A7; A8; A9; A10; A11; A12; A13; A14; A15; A16; A17; A18; A19; A20; A21; A22; A23; A24; A25; A26; A27; A28; A29; A30; A31; A32; A33; A34; A35; A36; A37; A38; A39; A40; A41; A42; A43; A44; A45; A46; A47; A48; A49; A50; A51; A52; A53; A54; A55; A56; A57; A58; A59; A60; A61; A62; A63; A64; A65; A66; A67; A68; or a combination thereof; combined with an IA selected from: B1; B2; B3; B4; B5; B6; B7; B8; B9; B10; B11; B12; B13; B14; B15; B16; B17; B18; B19; B20; B21; B22; B23; B24; B25; B26; B27; B28; B29; B30; B31; B32; B33; B34; B35; B36; B37; B38; B39; B40; B41; B42; B43; B44; B45; B46; B47; B48; B49; B50; B51; B52; B53; B54; B55; B56; B57; B58; B59; B60; B61; B62; B63; B64; B65; B66; B67; B68; B69; B70; B71; B72; B73; B74; B75; B76; B77; B78; B79; B80; B81; B82; B83; B84; B85; B86; B87; B88; B89; B90; B91; B92; B93; B94; B95; B96; B97; B98; B99; B100; B101; B102; B103; B104; B105; B106; B107; B108; B109; B110; B111; B112; B113; B114; B115; B116; B117; B118; B119; B120; B121; B122; B123; B124; B125; B126; B127; B128; B129; B130; B131; B132; B133; B134; B135; B136; B137; B138; B139; B140; B141; B142; B143; B144; B145; B146; B147; B148; B149; B150; B151; B152; B153; B154; B155; B156; B157; B158; B159; B160; B161; B162; B163; B164; B165; B166; B167; B168; B169; B170; B171; B172; B173; B174; B175; B176; B177; B178; B179; B180; B181;

B182; B183; B184; B185; B186; B187; B188; B189; B190; B191; B192; B193; B194; B195; B196; B197; B198; B199; B200; B201; B202; B203; B204; B205; B206; B207; B208; B209; B210; B211; B212; B213; B214; B215; B216; B217; B218; B219; B220; B221; B222; B223; B224; B225; B226; B227; B228; B229; B230; B231; B232; B233; B234; B235; B236; B237; B238; B239; B240; B241; B242; B243; B244; B245; B246; B247; B248; B249; B250; B251; B252; B253; B254; B255; B256; B257; B258; B259; B260; B261; B262; B263; B264; B265; B266; B267; B268; B269; B270; B271; B272; B273; B274; B275; B276; B277; B278; B279; B280; B281; B282; B283; B284; B285; B286; B287; B288; B289; B290; B291; B292; B293; B294; B295; B296; B297; B298; B299; B300; B301; B302; B303; B304; B305; B306; B307; B308; B309; B310; B311; B312; B313; B314; B315; B316; B317; B318; B319; B320; B321; B322; B323; B324; B325; B326; B327; B328; B329; B330; B331; B332; B333; B334; B335; B336; B337; B338; B339; B340; B341; B342; B343; B344; B345; B346; B347; B348; B349; B350; B351; B352; B353; B354; B355; B356; B357; B358; B359; B360; B361; B362; B363; B364; B365; B366; B367; B368; B369; B370; B371; B372; B373; B374; B375; B376; B377; B378; B379; B380; B381; B382; B383; B384; B385; B386; B387; B388; B389; B390; B391; B392; B393; B394; B395; B396; B397; B398; B399; B400; B401; B402; B403; B404; B405; B406; B407; B408; B409; B410; B411; B412; B413; B414; B415; B416; B417; B418; B419; B420; B421; B422; B423; B424; B425; B426; B427; B428; B429; B430; B431; B432; B433; B434; B435; B436; B437; B438; B439; B440; B441; B442; B443; B444; B445; B446; B447; B448; B449; B450; B451; B452; B453; B454; B455; B456; B457; B458; B459; B460; B461; B462; B463; B464; B465; B466; B467; B468; B469; B470; B471; B472; B473; B474; B475; B476; B477; B478; B479; or a combination thereof.

In some embodiments, a mixture of the present invention may comprise, consist essentially of, or consist of, the CRIP A1 from Table A, combined with any one or more Insecticidal Agents (IAs) selected from the group consisting of B1-B479, in Table B.

In some embodiments, a mixture of the present invention may comprise, consist essentially of, or consist of, the CRIP A2 from Table A, combined with any one or more Insecticidal Agents (IAs) selected from the group consisting of B1-B479, in Table B.

In some embodiments, a mixture of the present invention may comprise, consist essentially of, or consist of, the CRIP A3 from Table A, combined with any one or more Insecticidal Agents (IAs) selected from the group consisting of B1-B479, in Table B.

In some embodiments, a mixture of the present invention may comprise, consist essentially of, or consist of, the CRIP A4 from Table A, combined with any one or more Insecticidal Agents (IAs) selected from the group consisting of B1-B479, in Table B.

In some embodiments, a mixture of the present invention may comprise, consist essentially of, or consist of, the CRIP A5 from Table A, combined with any one or more Insecticidal Agents (IAs) selected from the group consisting of B1-B479, in Table B.

In some embodiments, a mixture of the present invention may comprise, consist essentially of, or consist of, the CRIP A6 from Table A, combined with any one or more Insecticidal Agents (IAs) selected from the group consisting of B1-B479, in Table B.

In some embodiments, a mixture of the present invention may comprise, consist essentially of, or consist of, the CRIP A7 from Table A, combined with any one or more Insecticidal Agents (IAs) selected from the group consisting of B1-B479, in Table B.

In some embodiments, a mixture of the present invention may comprise, consist essentially of, or consist of, the CRIP A8 from Table A, combined with any one or more Insecticidal Agents (IAs) selected from the group consisting of B1-B479, in Table B.

In some embodiments, a mixture of the present invention may comprise, consist essentially of, or consist of, the CRIP A9 from Table A, combined with any one or more Insecticidal Agents (IAs) selected from the group consisting of B1-B479, in Table B.

In some embodiments, a mixture of the present invention may comprise, consist essentially of, or consist of, the CRIP A10 from Table A, combined with any one or more Insecticidal Agents (IAs) selected from the group consisting of B1-B479, in Table B.

In some embodiments, a mixture of the present invention may comprise, consist essentially of, or consist of, the CRIP A11 from Table A, combined with any one or more Insecticidal Agents (IAs) selected from the group consisting of B1-B479, in Table B.

In some embodiments, a mixture of the present invention may comprise, consist essentially of, or consist of, the CRIP A12 from Table A, combined with any one or more Insecticidal Agents (IAs) selected from the group consisting of B1-B479, in Table B.

In some embodiments, a mixture of the present invention may comprise, consist essentially of, or consist of, the CRIP A13 from Table A, combined with any one or more Insecticidal Agents (IAs) selected from the group consisting of B1-B479, in Table B.

In some embodiments, a mixture of the present invention may comprise, consist essentially of, or consist of, the CRIP A14 from Table A, combined with any one or more Insecticidal Agents (IAs) selected from the group consisting of B1-B479, in Table B.

In some embodiments, a mixture of the present invention may comprise, consist essentially of, or consist of, the CRIP A15 from Table A, combined with any one or more Insecticidal Agents (IAs) selected from the group consisting of B1-B479, in Table B.

In some embodiments, a mixture of the present invention may comprise, consist essentially of, or consist of, the CRIP A16 from Table A, combined with any one or more Insecticidal Agents (IAs) selected from the group consisting of B1-B479, in Table B.

In some embodiments, a mixture of the present invention may comprise, consist essentially of, or consist of, the CRIP A17 from Table A, combined with any one or more Insecticidal Agents (IAs) selected from the group consisting of B1-B479, in Table B.

In some embodiments, a mixture of the present invention may comprise, consist essentially of, or consist of, the CRIP A18 from Table A, combined with any one or more Insecticidal Agents (IAs) selected from the group consisting of B1-B479, in Table B.

In some embodiments, a mixture of the present invention may comprise, consist essentially of, or consist of, the CRIP A19 from Table A, combined with any one or more Insecticidal Agents (IAs) selected from the group consisting of B1-B479, in Table B.

In some embodiments, a mixture of the present invention may comprise, consist essentially of, or consist of, the CRIP A20 from Table A, combined with any one or more Insecticidal Agents (IAs) selected from the group consisting of B1-B479, in Table B.

In some embodiments, a mixture of the present invention may comprise, consist essentially of, or consist of, the CRIP A21 from Table A, combined with any one or more Insecticidal Agents (IAs) selected from the group consisting of B1-B479, in Table B.

In some embodiments, a mixture of the present invention may comprise, consist essentially of, or consist of, the CRIP A22 from Table A, combined with any one or more Insecticidal Agents (IAs) selected from the group consisting of B1-B479, in Table B.

In some embodiments, a mixture of the present invention may comprise, consist essentially of, or consist of, the CRIP A23 from Table A, combined with any one or more Insecticidal Agents (IAs) selected from the group consisting of B1-B479, in Table B.

In some embodiments, a mixture of the present invention may comprise, consist essentially of, or consist of, the CRIP A24 from Table A, combined with any one or more Insecticidal Agents (IAs) selected from the group consisting of B1-B479, in Table B.

In some embodiments, a mixture of the present invention may comprise, consist essentially of, or consist of, the CRIP A25 from Table A, combined with any one or more Insecticidal Agents (IAs) selected from the group consisting of B1-B479, in Table B.

In some embodiments, a mixture of the present invention may comprise, consist essentially of, or consist of, the CRIP A26 from Table A, combined with any one or more Insecticidal Agents (IAs) selected from the group consisting of B1-B479, in Table B.

In some embodiments, a mixture of the present invention may comprise, consist essentially of, or consist of, the CRIP A27 from Table A, combined with any one or more Insecticidal Agents (IAs) selected from the group consisting of B1-B479, in Table B.

In some embodiments, a mixture of the present invention may comprise, consist essentially of, or consist of, the CRIP A28 from Table A, combined with any one or more Insecticidal Agents (IAs) selected from the group consisting of B1-B479, in Table B.

In some embodiments, a mixture of the present invention may comprise, consist essentially of, or consist of, the CRIP A29 from Table A, combined with any one or more Insecticidal Agents (IAs) selected from the group consisting of B1-B479, in Table B.

In some embodiments, a mixture of the present invention may comprise, consist essentially of, or consist of, the CRIP A30 from Table A, combined with any one or more Insecticidal Agents (IAs) selected from the group consisting of B1-B479, in Table B.

In some embodiments, a mixture of the present invention may comprise, consist essentially of, or consist of, the CRIP A31 from Table A, combined with any one or more Insecticidal Agents (IAs) selected from the group consisting of B1-B479, in Table B.

In some embodiments, a mixture of the present invention may comprise, consist essentially of, or consist of, the CRIP A32 from Table A, combined with any one or more Insecticidal Agents (IAs) selected from the group consisting of B1-B479, in Table B.

In some embodiments, a mixture of the present invention may comprise, consist essentially of, or consist of, the CRIP A33 from Table A, combined with any one or more Insecticidal Agents (IAs) selected from the group consisting of B1-B479, in Table B.

In some embodiments, a mixture of the present invention may comprise, consist essentially of, or consist of, the CRIP A34 from Table A, combined with any one or more Insecticidal Agents (IAs) selected from the group consisting of B1-B479, in Table B.

In some embodiments, a mixture of the present invention may comprise, consist essentially of, or consist of, a CRIP from Table A selected from: A1; A2; A3; A4; A5; A6; A7; A8; A9; A10; A11; A12; A13; A14; A15; A16; A17; A18; A19; A20; A21; A22; A23; A24; A25; A26; A27; A28; A29; A30; A31; A32; A33; A34; A35; A36; A37; A38; A39; A40; A41; A42; A43; A44; A45; A46; A47; A48; A49; A50; A51; A52; A53; A54; A55; A56; A57; A58; A59; A60; A61; A62; A63; A64; A65; A66; A67; or A68; wherein said CRIP is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequences set forth in 1; 2; 3; 4; 5; 6; 7; 8; 9; 10; 11; 12; 13; 14; 15; 49; 50; 51; 52; 53; 621; 622; 623; 624; 625; 626; 627; 628; 629; 630; 631; 632; 633; 634; 635; 636; 637; 638; 639; 640; 641; 642; 643; 644; 645; 646; 647; 648; 649; 650; 651; 652; 653; 654; 66; 88; 588; 44; 45; 46; 47; 60; 61; 62; 63; 64; 594; or 65, respectively.

In some embodiments, a mixture of the present invention may comprise, consist essentially of, or consist of, a CRIP and an IA; wherein the CRIP peptide may comprise, consist essentially of, or consist of, an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to: a spider peptide having an amino acid sequence as set forth in any one of SEQ ID NOs: 192-370; an ACTX peptide (e.g., U-ACTX-Hv1a, U+2-ACTX-Hv1a, rU-ACTX-Hv1a, rU-ACTX-Hy1b, K-ACTX-Hy1a, κ+2-ACTX-Hv1a, ω-ACTX-Hv1a, and/or ω+2-ACTX-Hy1a) having an amino acid sequence as set forth in any one of SEQ ID NOs: 60-64, 192-370 and 594; an F-CNTX-Pn1a having an amino acid sequence as set forth in any one of SEQ ID NO: 65; a U1-agatoxin-Ta1b peptide having an amino acid sequence as set forth in SEQ ID NO: 1; a U1-agatoxin-Ta1b Variant Polypeptide (TVP) having an amino acid sequence as set forth in any one of SEQ ID NOs: 2-15, 49-53, 2-15, 49-53, 621-622, 624-628, 631-640, 642-651, or 653-654; a scorpion peptide having an amino acid sequence as set forth in any one of SEQ ID NOs: 66, 88-191; a sea anemone peptide having an amino acid sequence as set forth in any one of SEQ ID NOs: 371-411; an Av3 polypeptide from Anemonia viridis having an amino acid sequence as set forth in SEQ ID NO:44; an Av3 variant polypeptide (AVP) having an amino acid sequence as set forth in any one of SEQ ID NOs: 45-47; or a conotoxin; and wherein the IA is an IA listed in Table B, and wherein the IA is B1; B2; B3; B4; B5; B6; B7; B8; B9; B10; B11; B12; B13; B14; B15; B16; B17; B18; B19; B20; B21; B22; B23; B24; B25; B26; B27; B28; B29; B30; B31; B32; B33; B34; B35; B36; B37; B38; B39; B40; B41; B42; B43; B44; B45; B46; B47; B48; B49; B50; B51; B52; B53; B54; B55; B56; B57; B58; B59; B60; B61; B62; B63; B64; B65; B66; B67; B68; B69; B70; B71; B72; B73; B74; B75;

B76; B77; B78; B79; B80; B81; B82; B83; B84; B85; B86; B87; B88; B89; B90; B91; B92; B93; B94; B95; B96; B97; B98; B99; B100; B101; B102; B103; B104; B105; B106; B107; B108; B109; B110; B111; B112; B113; B114; B115; B116; B117; B118; B119; B120; B121; B122; B123; B124; B125; B126; B127; B128; B129; B130; B131; B132; B133; B134; B135; B136; B137; B138; B139; B140; B141; B142; B143; B144; B145; B146; B147; B148; B149; B150; B151; B152; B153; B154; B155; B156; B157; B158; B159; B160; B161; B162; B163; B164; B165; B166; B167; B168; B169; B170; B171; B172; B173; B174; B175; B176; B177; B178; B179; B180; B181; B182; B183; B184; B185; B186; B187; B188; B189; B190; B191; B192; B193; B194; B195; B196; B197; B198; B199; B200; B201; B202; B203; B204; B205; B206; B207; B208; B209; B210; B211; B212; B213; B214; B215; B216; B217; B218; B219; B220; B221; B222; B223; B224; B225; B226; B227; B228; B229; B230; B231; B232; B233; B234; B235; B236; B237; B238; B239; B240; B241; B242; B243; B244; B245; B246; B247; B248; B249; B250; B251; B252; B253; B254; B255; B256; B257; B258; B259; B260; B261; B262; B263; B264; B265; B266; B267; B268; B269; B270; B271; B272; B273; B274; B275; B276; B277; B278; B279; B280; B281; B282; B283; B284; B285; B286; B287; B288; B289; B290; B291; B292; B293; B294; B295; B296; B297; B298; B299; B300; B301; B302; B303; B304; B305; B306; B307; B308; B309; B310; B311; B312; B313; B314; B315; B316; B317; B318; B319; B320; B321; B322; B323; B324; B325; B326; B327; B328; B329; B330; B331; B332; B333; B334; B335; B336; B337; B338; B339; B340; B341; B342; B343; B344; B345; B346; B347; B348; B349; B350; B351; B352; B353; B354; B355; B356; B357; B358; B359; B360; B361; B362; B363; B364; B365; B366; B367; B368; B369; B370; B371; B372; B373; B374; B375; B376; B377; B378; B379; B380; B381; B382; B383; B384; B385; B386; B387; B388; B389; B390; B391; B392; B393; B394; B395; B396; B397; B398; B399; B400; B401; B402; B403; B404; B405; B406; B407; B408; B409; B410; B411; B412; B413; B414; B415; B416; B417; B418; B419; B420; B421; B422; B423; B424; B425; B426; B427; B428; B429; B430; B431; B432; B433; B434; B435; B436; B437; B438; B439; B440; B441; B442; B443; B444; B445; B446; B447; B448; B449; B450; B451; B452; B453; B454; B455; B456; B457; B458; B459; B460; B461; B462; B463; B464; B465; B466; B467; B468; B469; B470; B471; B472; B473; B474; B475; B476; B477; B478; B479; or a combination thereof.

In some embodiments, the ratio of CRIP to IA, on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of CRIP and IA in the mixture is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the mixture is comprised of excipients.

Any of the foregoing mixtures, compositions, or formulations comprising one or more CRIPs and one or more IAs as described herein, can further comprise, consist essentially of, or consist of, an excipient.

Any of the foregoing mixtures or compositions comprising one or more CRIPs and one or more IAs can be applied concomitantly and/or sequentially, and either in the same or separate compositions. The ratios of CRIP to IA will depend on the insect pest to be targeted, and the needs of the user.

Furthermore, any of the foregoing mixtures or compositions comprising one or more CRIPs and one or more IAs, can be can be applied to the crop area or plant to be treated, simultaneously or in succession, with other compounds. For example, in some embodiments, these other compounds can be fertilizers, weed killers, cryoprotectants, surfactants, detergents, pesticidal soaps, dormant oils, polymers, and/or time-release or biodegradable carrier formulations that permit long-term dosing of a target area following a single application of the formulation. The other compounds can also be selective herbicides, chemical insecticides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation. In some embodiments, suitable carriers and adjuvants can be solid or liquid, and correspond to the substances ordinarily employed in formulation technology, e.g. natural or regenerated mineral substances, solvents, dispersants, wetting agents, tackifiers, binders or fertilizers. Likewise, any of the foregoing mixtures, compositions, or formulations may be prepared into edible “baits” or fashioned into pest “traps” to permit feeding or ingestion by a target pest of the pesticidal formulation.

Compositions and Formulations

As used herein, the terms “composition” and “formulations” are used interchangeably.

% v/v; % w/w; and % w/v

As used herein, “v/v” or “% v/v” or “volume per volume” refers to the volume concentration of a solution (“v/v” stands for volume per volume). Here, v/v can be used when both components of a solution are liquids. For example, when 50 mL of ingredient X is diluted with 50 mL of water, there will be 50 mL of ingredient X in a total volume of 100 mL; therefore, this can be expressed as “ingredient X 50% v/v.” Percent volume per volume (% v/v) is calculated as follows: (volume of solute (mL)/volume of solution (100 mL)); e.g., % v/v=mL of solute/100 mL of solution.

As used herein, “w/w” or “% w/w” or “weight per weight” or “wt/wt” or “% wt/wt” refers to the weight concentration of a formulation or solution, i.e., percent weight in weight (“w/w” stands for weight per weight). Here, w/w expresses the number of grams (g) of a constituent in 100 g of solution or mixture. For example, a mixture consisting of 30 g of ingredient X, and 70 g of water would be expressed as “ingredient X 30% w/w.” Percent weight per weight (% w/w) is calculated as follows: (weight of solute (g)/weight of solution (g))×100; or (mass of solute (g)/mass of solution (g))×100.

As used herein, “w/v” or “% w/v” or “weight per volume” refers to the mass concentration of a solution, i.e., percent weight in volume (“w/v” stands for weight per volume). Here, w/v expresses the number of grams (g) of a constituent in 100 mL of solution. For example, if 1 g of ingredient X is used to make up a total volume of 100 mL, then a “1% w/v solution of ingredient X” has been made. Percent weight per volume (% w/v) is calculated as follows: (Mass of solute (g)/Volume of solution (mL))×100.

Compositions comprising, consisting essentially of, or consisting of a (1) CRIP, a CRIP-insecticidal protein, a pharmaceutically acceptable salt thereof, or a combination thereof; and (2) one or more Insecticidal Agents, for example, agrochemical compositions, can include, but are not limited to, aerosols and/or aerosolized products, e.g., sprays, fumigants, powders, dusts, and/or gases; seed dressings; oral preparations (e.g., insect food, etc.); transgenic organisms expressing and/or producing a TVP, a TVP-insecticidal protein, and/or a TVP ORF (either transiently and/or stably), e.g., a plant or an animal.

The composition may be formulated as a powder, dust, pellet, granule, spray, emulsion, colloid, solution, or such like, and may be prepared by such conventional means as desiccation, lyophilization, homogenization, extraction, filtration, centrifugation, sedimentation, or concentration of a culture of cells comprising the polypeptide. In all such compositions that contain at least one such pesticidal polypeptide, the polypeptide may be present in a concentration of from about 1% to about 99% by weight.

In some embodiments, the pesticide compositions described herein may be made by formulating either the CRIP, CRIP-insecticidal protein, or pharmaceutically acceptable salt thereof, with the desired agriculturally-acceptable carrier. The compositions may be formulated prior to administration in an appropriate means such as lyophilized, freeze-dried, desiccated, or in an aqueous carrier, medium or suitable diluent, such as saline and/or other buffer. In some embodiments, the formulated compositions may be in the form of a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art. In some embodiments, the formulations may be mixed with one or more solid or liquid adjuvants and prepared by various means, e.g., by homogeneously mixing, blending and/or grinding the pesticidal composition with suitable adjuvants using conventional formulation techniques. Suitable formulations and application methods are described in U.S. Pat. No. 6,468,523, the disclosure of which is incorporated by reference herein in its entirety.

In some embodiments, the composition comprises, consists essentially of, or consists of: a CRIP, or pharmaceutically acceptable salt thereof; an Insecticidal Agent; and an excipient.

In some embodiments, the composition comprises, consists essentially of, or consists of: a CRIP-insecticidal protein, or pharmaceutically acceptable salt thereof; an Insecticidal Agent; and an excipient.

In some embodiments, the composition comprises, consists essentially of, or consists of: (1) a CRIP, or pharmaceutically acceptable salt thereof; a CRIP-insecticidal protein, or pharmaceutically acceptable salt thereof; or a combination thereof; (2) one or more Insecticidal Agents; and (3) an excipient.

Pharmaceutically Acceptable Salts

As used herein, the term “pharmaceutically acceptable salt” and “agriculturally acceptable salt” are synonymous. In some embodiments, pharmaceutically acceptable salts, hydrates, solvates, crystal forms and individual isomers, enantiomers, tautomers, diastereomers and prodrugs of the CRIPs, CRIP-insecticidal proteins, and/or Insecticidal Agents described herein, and where applicable can be utilized.

In some embodiments, a pharmaceutically acceptable salt of the present invention possesses the desired pharmacological activity of the parent compound. Such salts include: acid addition salts, formed with inorganic acids; acid addition salts formed with organic acids; or salts formed when an acidic proton present in the parent compound is replaced by a metal ion, e.g., an alkali metal ion, aluminum ion; or coordinates with an organic base such as ethanolamine, and the like.

In some embodiments, pharmaceutically acceptable salts include conventional toxic or non-toxic salts. For example, in some embodiments, convention non-toxic salts include those such as fumarate, phosphate, citrate, chlorydrate, and the like. In some embodiments, the pharmaceutically acceptable salts of the present invention can be synthesized from a parent compound by conventional chemical methods. In some embodiments, such salts can be prepared by reacting the free acid or base forms of these compounds with a stoichiometric amount of the appropriate base or acid in water or in an organic solvent, or in a mixture of the two. In some embodiments, non-aqueous media like ether, ethyl acetate, ethanol, isopropanol, or acetonitrile are preferred. Lists of suitable salts are found in Remington's Pharmaceutical Sciences, 17th ed., Mack Publishing Company, Easton, Pa., 1985, p. 1418, the disclosure of which is incorporated herein by reference in its entirety.

In some embodiments, a pharmaceutically acceptable salt can be one of the following: hydrochloride; sodium; sulfate; acetate; phosphate or diphosphate; chloride; potassium; maleate; calcium; citrate; mesylate; nitrate; tartrate; aluminum; or gluconate.

In some embodiments, a list of pharmaceutically acceptable acids that can be used to form salts can be: glycolic acid; hippuric acid; hydrobromic acid; hydrochloric acid; isobutyric acid; lactic acid (DL); lactobionic acid; lauric acid; maleic acid; malic acid (−L); malonic acid; mandelic acid (DL); methanesulfonic acid; naphthalene-1,5-disulfonic acid; naphthalene-2-sulfonic acid; nicotinic acid; nitric acid; oleic acid; oxalic acid; palmitic acid; pamoic acid; phosphoric acid; proprionic acid; pyroglutamic acid (−L); salicylic acid; sebacic acid; stearic acid; succinic acid; sulfuric acid; tartaric acid (+L); thiocyanic acid; toluenesulfonic acid (p); undecylenic acid; a 1-hydroxy-2-naphthoic acid; 2,2-dichloroacetic acid; 2-hydroxyethanesulfonic acid; 2-oxoglutaric acid; 4-acetamidobenzoic acid; 4-aminosalicylic acid; acetic acid; adipic acid; ascorbic acid (L); aspartic acid (L); benzenesulfonic acid; benzoic acid; camphoric acid (+); camphor-10-sulfonic acid (+); capric acid (decanoic acid); caproic acid (hexanoic acid); caprylic acid (octanoic acid); carbonic acid; cinnamic acid; citric acid; cyclamic acid; dodecylsulfuric acid; ethane-1,2-disulfonic acid; ethanesulfonic acid; formic acid; fumaric acid; galactaric acid; gentisic acid; glucoheptonic acid (D); gluconic acid (D); glucuronic acid (D); glutamic acid; glutaric acid; or glycerophosphoric acid.

In some embodiments, pharmaceutically acceptable salt can be any organic or inorganic addition salt.

In some embodiments, the salt may use an inorganic acid and an organic acid as a free acid. The inorganic acid may be hydrochloric acid, bromic acid, nitric acid, sulfuric acid, perchloric acid, phosphoric acid, etc. The organic acid may be citric acid, acetic acid, lactic acid, maleic acid, fumaric acid, gluconic acid, methane sulfonic acid, gluconic acid, succinic acid, tartaric acid, galacturonic acid, embonic acid, glutamic acid, aspartic acid, oxalic acid, (D) or (L) malic acid, maleic acid, methane sulfonic acid, ethane sulfonic acid, 4-toluene sulfonic acid, salicylic acid, citric acid, benzoic acid, malonic acid, etc.

In some embodiments, the salts include alkali metal salts (sodium salts, potassium salts, etc.) and alkaline earth metal salts (calcium salts, magnesium salts, etc.). For example, the acid addition salt may include acetate, aspartate, benzoate, besylate, bicarbonate/carbonate, bisulfate/sulfate, borate, camsylate, citrate, edisilate, esylate, formate, fumarate, gluceptate, gluconate, glucuronate, hexafluorophosphate, hibenzate, hydrochloride/chloride, hydrobromide/bromide, hydroiodide/iodide, isethionate, lactate, malate, maleate, malonate, mesylate, methyl sulfate, naphthalate, 2-napsylate, nicotinate, nitrate, orotate, oxalate, palmitate, pamoate, phosphate/hydrogen phosphate/dihydrogen phosphate, saccharate, stearate, succinate, tartrate, tosylate, trifluoroacetate, aluminum, arginine, benzathine, calcium, choline, diethylamine, diolamine, glycine, lysine, magnesium, meglumine, olamine, potassium, sodium, tromethamine, zinc salt, etc., and among them, hydrochloride or trifluoroacetate may be used.

In yet other embodiments, the pharmaceutically acceptable salt can be a salt with an acid such as acetic acid, propionic acid, butyric acid, formic acid, trifluoroacetic acid, maleic acid, tartaric acid, citric acid, stearic acid, succinic acid, ethylsuccinic acid, lactobionic acid, gluconic acid, glucoheptonic acid, benzoic acid, methanesulfonic acid, ethanesulfonic acid, 2-hydroxyethanesulfonic acid, benzenesulfonic acid, p-toluenesulfonic acid, laurylsulfuric acid, malic acid, aspartic acid, glutaminic acid, adipic acid, cysteine, N-acetylcysteine, hydrochloric acid, hydrobromic acid, phosphoric acid, sulfuric acid, hydroiodic acid, nicotinic acid, oxalic acid, picric acid, thiocyanic acid, undecanoic acid, polyacrylate or carboxyvinyl polymer.

In some embodiments, the pharmaceutically acceptable salt can be prepared from either inorganic or organic bases. Salts derived from inorganic bases include, but are not limited to, the sodium, potassium, lithium, ammonium, calcium, magnesium, ferrous, zinc, copper, manganous, aluminum, ferric, manganic salts, and the like. Preferred inorganic salts are the ammonium, sodium, potassium, calcium, and magnesium salts. Salts derived from organic bases include, but are not limited to, salts of primary, secondary, and tertiary amines, substituted amines including naturally-occurring substituted amines, and cyclic amines, including isopropylamine, trimethylamine, diethylamine, triethylamine, tripropylamine, ethanolamine, 2-dimethylaminoethanol, tromethamine, lysine, arginine, histidine, caffeine, procaine, hydrabamine, choline, betaine, ethylenediamine, glucosamine, N-alkylglucamines, theobromine, purines, piperazine, piperidine, N-ethylpiperidine, and the like. Preferred organic bases are isopropylamine, diethylamine, ethanolamine, piperidine, tromethamine, and choline.

In some embodiments, pharmaceutically acceptable salt refers to those salts which are, within the scope of sound medical judgment, suitable for use in contact with the tissues of humans and lower animals without undue toxicity, irritation, allergic response and the like, and are commensurate with a reasonable benefit/risk ratio. Pharmaceutically acceptable salts are well known in the art. For example, S. M. Berge, et al. describe pharmaceutically acceptable salts in detail in J. Pharmaceutical Sciences, 66: 1-19 (1977), the disclosure of which is incorporated herein by reference in its entirety.

In some embodiments, the salts of the present invention can be prepared in situ during the final isolation and purification of the compounds of the invention, or separately by reacting the free base function with a suitable organic acid. Examples of pharmaceutically acceptable, nontoxic acid addition salts are salts of an amino group formed with inorganic acids such as hydrochloric acid, hydrobromic acid, phosphoric acid, sulfuric acid and perchloric acid or with organic acids such as acetic acid, oxalic acid, maleic acid, tartaric acid, citric acid, succinic acid or malonic acid or by using other methods used in the art such as ion exchange. Other pharmaceutically acceptable salts include adipate, alginate, ascorbate, aspartate, benzenesulfonate, benzoate, bisulfate, borate, butyrate, camphorate, camphorsulfonate, citrate, cyclopentanepropionate, digluconate, dodecylsulfate, ethanesulfonate, formate, fumarate, glucoheptonate, glycerophosphate, gluconate, hemisulfate, heptanoate, hexanoate, hydroiodide, 2-hydroxy-ethanesulfonate, lactobionate, lactate, laurate, lauryl sulfate, malate, maleate, malonate, methanesulfonate, 2-naphthalenesulfonate, nicotinate, nitrate, oleate, oxalate, palmitate, pamoate, pectinate, persulfate, 3-phenylpropionate, phosphate, picrate, pivalate, propionate, stearate, succinate, sulfate, tartrate, thiocyanate, p-toluenesulfonate, undecanoate, valerate salts, and the like. Representative alkali or alkaline earth metal salts include sodium, lithium, potassium, calcium, magnesium, and the like. Further pharmaceutically acceptable salts include, when appropriate, nontoxic ammonium, quaternary ammonium, and amine cations formed using counterions such as halide, hydroxide, carboxylate, sulfate, phosphate, nitrate, lower alkyl sulfonate and aryl sulfonate.

Exemplary descriptions of pharmaceutically acceptable salts is provided in P. H. Stahl and C. G. Wermuth, (editors), Handbook of Pharmaceutical Salts: Properties, Selection and Use, John Wiley & Sons, August 23, (2002), the disclosure of which is incorporated herein by reference in its entirety.

Sprayable Compositions

Examples of spray products of the present invention can include field sprayable formulations for agricultural usage and indoor sprays for use in interior spaces in a residential or commercial space. In some embodiments, residual sprays or space sprays comprising a combination of one or more of CRIPs: A1-A68, and one or more Insecticidal Agents: B1-B479, can be used to reduce or eliminate insect pests in an interior space.

Surface spraying indoors (SSI) is the technique of applying a variable volume sprayable volume of an insecticide onto indoor surfaces where vectors rest, such as on walls, windows, floors and ceilings. The primary goal of variable volume sprayable volume is to reduce the lifespan of the insect pest, (for example, a fly, a flea, a tick, or a mosquito vector) and thereby reduce or interrupt disease transmission. The secondary impact is to reduce the density of insect pests within the treatment area. SSI can be used as a method for the control of insect pest vector diseases, such as Lyme disease, Salmonella, Chikungunya virus, Zika virus, and malaria, and can also be used in the management of parasites carried by insect vectors, such as Leishmaniasis and Chagas disease. Many mosquito vectors that harbor Zika virus, Chikungunya virus, and malaria include endophilic mosquito vectors, resting inside houses after taking a blood meal. These mosquitoes are particularly susceptible to control through surface spraying indoors (SSI) with a sprayable composition comprising a combination of (1) one or more CRIPs set for the in Table A, i.e., A1-A68, (2) one or more Insecticidal Agents set forth in Table B, i.e., B1-B479, and (3) an excipient. As its name implies, SSI involves applying the composition onto the walls and other surfaces of a house with a residual insecticide.

In one embodiment, the composition comprising a combination of (1) one or more CRIPs set for the in Table A, i.e., A1-A68, (2) one or more Insecticidal Agents set forth in Table B, i.e., B1-B479, and (3) an excipient, will knock down insect pests that come in contact with these surfaces. SSI does not directly prevent people from being bitten by mosquitoes. Rather, it usually controls insect pests after they have blood fed, if they come to rest on the sprayed surface. SSI thus prevents transmission of infection to other persons. To be effective, SSI must be applied to a very high proportion of households in an area (usually greater than 40-80 percent). Therefore, sprays in accordance with the invention having good residual efficacy and acceptable odor are particularly suited as a component of integrated insect pest vector management or control solutions.

In contrast to SSI, which requires that the active CRIP, CRIP-insecticidal protein, or Insecticidal Agent be bound to surfaces of dwellings, such as walls or ceilings, as with a paint, for example, space spray products of the invention rely on the production of a large number of small insecticidal droplets intended to be distributed through a volume of air over a given period of time. When these droplets impact on a target insect pest, they deliver a knockdown effective dose of the CRIP, CRIP-insecticidal protein, or Insecticidal Agent effective to control the insect pest. The traditional methods for generating a space-spray include thermal fogging (whereby a dense cloud of a composition comprising a combination of (1) one or more CRIPs set for the in Table A, i.e., A1-A68, (2) one or more Insecticidal Agents set forth in Table B, i.e., B1-B479, and (3) an excipient, is produced giving the appearance of a thick fog) and Ultra Low Volume (ULV), whereby droplets are produced by a cold, mechanical aerosol-generating machine. Ready-to-use aerosols such as aerosol cans may also be used.

Because large areas can be treated at any one time, the foregoing method is a very effective way to rapidly reduce the population of flying insect pests in a specific area. And, because there is very limited residual activity from the application, it must be repeated at intervals of 5-7 days in order to be fully effective. This method can be particularly effective in epidemic situations where rapid reduction in insect pest numbers is required. As such, it can be used in urban dengue control campaigns.

Effective space-spraying is generally dependent upon the following specific principles. Target insects are usually flying through the spray cloud (or are sometimes impacted whilst resting on exposed surfaces). The efficiency of contact between the spray droplets and target insects is therefore crucial. This is achieved by ensuring that spray droplets remain airborne for the optimum period of time and that they contain the right dose of insecticide. These two issues are largely addressed through optimizing the droplet size. If droplets are too big they drop to the ground too quickly and don't penetrate vegetation or other obstacles encountered during application (limiting the effective area of application). If one of these big droplets impacts an individual insect then it is also “overkill,” because a high dose will be delivered per individual insect. If droplets are too small then they may either not deposit on a target insect (no impaction) due to aerodynamics or they can be carried upwards into the atmosphere by convection currents. The optimum size of droplets for space-spray application are droplets with a Volume Median Diameter (VIVID) of 10-25 microns.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Foams

The active compositions of the present invention comprising a combination of (1) one or more CRIPs set for the in Table A, i.e., A1-A68, (2) one or more Insecticidal Agents set forth in Table B, i.e., B1-B479, and (3) an excipient, may be made available in a spray product as an aerosol-based application, including aerosolized foam applications. Pressurized cans are the typical vehicle for the formation of aerosols. An aerosol propellant that is compatible with the CRIP, CRIP-insecticidal protein, or Insecticidal Agent used. Preferably, a liquefied-gas type propellant is used.

Suitable propellants include compressed air, carbon dioxide, butane and nitrogen. The concentration of the propellant in the active compound composition is from about 5 percent to about 40 percent by weight of the pyridine composition, preferably from about 15 percent to about 30 percent by weight of the composition comprising a combination of (1) one or more CRIPs set for the in Table A, i.e., A1-A68, (2) one or more Insecticidal Agents set forth in Table B, i.e., B1-B479, and (3) an excipient, and an excipient.

In one embodiment, formulations consisting of a TVP, a TVP-insecticidal protein, or a pharmaceutically acceptable salt thereof can also include one or more foaming agents. Foaming agents that can be used include sodium laureth sulfate, cocamide DEA, and cocamidopropyl betaine. Preferably, the sodium laureth sulfate, cocamide DEA and cocamidopropyl are used in combination. The concentration of the foaming agent(s) in the active compound composition is from about 10 percent to about 25 percent by weight, more preferably 15 percent to 20 percent by weight of the composition.

When such formulations are used in an aerosol application not containing foaming agents, the active compositions of the present invention can be used without the need for mixing directly prior to use. However, aerosol formulations containing the foaming agents do require mixing (i.e., shaking) immediately prior to use. In addition, if the formulations containing foaming agents are used for an extended time, they may require additional mixing at periodic intervals during use.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Burning Formulations

In some embodiments, a dwelling area may also be treated with an active CRIP, CRIP-insecticidal protein, or Insecticidal Agent composition by using a burning formulation, such as a candle, a smoke coil or a piece of incense containing the composition. For example, the composition may be formulated into household products such as “heated” air fresheners in which insecticidal compositions are released upon heating, e.g., electrically, or by burning. The active compound compositions of the present invention comprising a combination of (1) one or more CRIPs set for the in Table A, i.e., A1-A68, (2) one or more of Insecticidal Agents set forth in Table B, i.e., B1-B479, and (3) an excipient, may be made available in a spray product as an aerosol, a mosquito coil, and/or a vaporizer or fogger.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Fabric Treatments

In some embodiments, fabrics and garments may be made containing a pesticidal effective composition comprising a combination of (1) one or more CRIPs set for the in Table A, i.e., A1-A68, (2) one or more Insecticidal Agents set forth in Table B, i.e., B1-B479, and (3) an excipient. In some embodiments, the concentration of the CRIP, CRIP-insecticidal protein, or Insecticidal Agent in the polymeric material, fiber, yarn, weave, net, or substrate described herein, can be varied within a relatively wide concentration range from, for example, 0.05 to 15 percent by weight, preferably 0.2 to 10 percent by weight, more preferably 0.4 to 8 percent by weight, especially 0.5 to 5, such as 1 to 3, percent by weight.

Similarly, the concentration of the composition comprising a combination of (1) one or more CRIPs set for the in Table A, i.e., A1-A68, (2) one or more Insecticidal Agents set forth in Table B, i.e., B1-B479, and (3) an excipient, (whether for treating surfaces or for coating a fiber, yarn, net, weave) can be varied within a relatively wide concentration range from, for example 0.1 to 70 percent by weight, such as 0.5 to 50 percent by weight, preferably 1 to 40 percent by weight, more preferably 5 to 30 percent by weight, especially 10 to 20 percent by weight.

The concentration of the CRIP, CRIP-insecticidal protein, or Insecticidal Agent may be chosen according to the field of application such that the requirements concerning knockdown efficacy, durability and toxicity are met. Adapting the properties of the material can also be accomplished and so custom-tailored textile fabrics are obtainable in this way.

Accordingly, an effective amount of a CRIP or Insecticidal Agent can depend on the specific use pattern, the insect pest against which control is most desired and the environment in which the CRIP, CRIP-insecticidal protein, or Insecticidal Agent will be used. Therefore, an effective amount of a CRIP or Insecticidal Agent is sufficient that control of an insect pest is achieved.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Surface-Treatment Compositions

In some embodiments, the present disclosure provides compositions or formulations comprising a combination of (1) one or more CRIPs set for the in Table A, i.e., A1-A68, (2) one or more of Insecticidal Agents set forth in Table B, i.e., B1-B479, and (3) an excipient, for coating walls, floors and ceilings inside of buildings, and for coating a substrate or non-living material. The inventive compositions comprising a combination of (1) one or more CRIPs set for the in Table A, i.e., A1-A68, (2) one or more Insecticidal Agents set forth in Table B, i.e., B1-B479, and (3) an excipient, can be prepared using known techniques for the purpose in mind. Preparations of compositions comprising a combination of (1) one or more CRIPs set for the in Table A, i.e., A1-A68, (2) one or more of Insecticidal Agents set forth in Table B, i.e., B1-B479, and (3) an excipient, could be so formulated to also contain a binder to facilitate the binding of the compound to the surface or other substrate. Agents useful for binding are known in the art and tend to be polymeric in form. The type of binder suitable for a compositions to be applied to a wall surface having particular porosities and/or binding characteristics would be different compared to a fiber, yarn, weave or net—thus, a skilled person, based on known teachings, would select a suitable binder based on the desired surface and/or substrate.

Typical binders are poly vinyl alcohol, modified starch, poly vinyl acrylate, polyacrylic, polyvinyl acetate co polymer, polyurethane, and modified vegetable oils. Suitable binders can include latex dispersions derived from a wide variety of polymers and co-polymers and combinations thereof. Suitable latexes for use as binders in the inventive compositions comprise polymers and copolymers of styrene, alkyl styrenes, isoprene, butadiene, acrylonitrile lower alkyl acrylates, vinyl chloride, vinylidene chloride, vinyl esters of lower carboxylic acids and alpha, beta-ethylenically unsaturated carboxylic acids, including polymers containing three or more different monomer species copolymerized therein, as well as post-dispersed suspensions of silicones or polyurethanes. Also suitable may be a polytetrafluoroethylene (PTFE) polymer for binding the active ingredient to other surfaces.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Dispersants

In some exemplary embodiments, an insecticidal formulation according to the present disclosure may comprising a combination of (1) one or more CRIPs set for the in Table A, i.e., A1-A68, (2) one or more of Insecticidal Agents set forth in Table B, i.e., B1-B479, and (3) an excipient, e.g., diluent or carrier (e.g., such as water), a polymeric binder, and/or additional components such as a dispersing agent, a polymerizing agent, an emulsifying agent, a thickener, an alcohol, a fragrance, or any other inert excipients used in the preparation of sprayable insecticides known in the art.

In some embodiments, a composition comprising a combination of (1) one or more CRIPs set for the in Table A, i.e., A1-A68, (2) one or more Insecticidal Agents set forth in Table B, i.e., B1-B479, and (3) an excipient, can be prepared in a number of different forms or formulation types, such as suspensions or capsules suspensions. And a person skilled in the art can prepare the relevant composition based on the properties of the particular CRIP, CRIP-insecticidal protein, or Insecticidal Agent, its uses, and also its application type. For example, the CRIP, CRIP-insecticidal protein, or Insecticidal Agent used in the methods, embodiments, and other aspects of the present disclosure, may be encapsulated in a suspension or capsule suspension formulation. An encapsulated CRIP, CRIP-insecticidal protein, or Insecticidal Agent can provide improved wash-fastness, and also a longer period of activity. The formulation can be organic based or aqueous based, preferably aqueous based.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Microencapsulation

Microencapsulated CRIP, CRIP-insecticidal protein, or Insecticidal Agent suitable for use in the compositions and methods according to the present disclosure may be prepared with any suitable technique known in the art. For example, various processes for microencapsulating material have been previously developed. These processes can be divided into three categories: physical methods, phase separation, and interfacial reaction. In the physical methods category, microcapsule wall material and core particles are physically brought together and the wall material flows around the core particle to form the microcapsule. In the phase separation category, microcapsules are formed by emulsifying or dispersing the core material in an immiscible continuous phase in which the wall material is dissolved and caused to physically separate from the continuous phase, such as by coacervation, and deposit around the core particles. In the interfacial reaction category, microcapsules are formed by emulsifying or dispersing the core material in an immiscible continuous phase and then an interfacial polymerization reaction is caused to take place at the surface of the core particles. The concentration of the CRIP, CRIP-insecticidal protein, or Insecticidal Agent present in the microcapsules can vary from 0.1 to 60% by weight of the microcapsule.

In some embodiments, a sprayable composition may contain an amount of comprising a combination of one or more CRIPs set for the in Table A, i.e., A1-A68, ranging from about 0.005 wt % to about 99 wt %.

In some embodiments, a sprayable composition may contain an amount of comprising a combination of one or more Insecticidal Agents set forth in Table B, i.e., B1-B479, ranging from about 0.005 wt % to about 99 wt %.

Kits, formulations, dispersants, and the ingredients thereof.

The formulation used in the compositions (comprising a combination of (1) one or more CRIPs set for the in Table A, i.e., A1-A68, (2) one or more Insecticidal Agents set forth in Table B, i.e., B1-B479, and (3) an excipient), methods, embodiments and other aspects according to the present disclosure, may be formed by mixing all ingredients together with water, and optionally using suitable mixing and/or dispersing aggregates. In general, such a formulation is formed at a temperature of from 10 to 70° C., preferably 15 to 50° C., more preferably 20 to 40° C. Generally, a formulation comprising one or more of (A), (B), (C), and/or (D) is possible, wherein it is possible to use: a CRIP and Insecticidal Agent (as pesticide) (A); solid polymer (B); optional additional additives (D); and to disperse them in the aqueous component (C). If a binder is present in a composition of the present invention (comprising a combination of (1) one or more CRIPs set for the in Table A, i.e., A1-A68, (2) one or more Insecticidal Agents set forth in Table B, i.e., B1-B479, and (3) an excipient), it is preferred to use dispersions of the polymeric binder (B) in water as well as aqueous formulations of the CRIP, CRIP-insecticidal protein, or Insecticidal Agent (A) in water which have been separately prepared before. Such separate formulations may contain additional additives for stabilizing (A) and/or (B) in the respective formulations and are commercially available. In a second process step, such raw formulations and optionally additional water (component (C)) are added. Also, combinations of the abovementioned ingredients based on the foregoing scheme are likewise possible, e.g., using a pre-formed dispersion of (A) and/or (B) and mixing it with solid (A) and/or (B). A dispersion of the polymeric binder (B) may be a pre-manufactured dispersion already made by a chemicals manufacturer.

Moreover, it is also within the scope of the present invention to use “hand-made” dispersions, i.e., dispersions made in small-scale by an end-user. Such dispersions may be made by providing a mixture of about 20 percent of the binder (B) in water, heating the mixture to temperature of 90° C. to 100° C. and intensively stirring the mixture for several hours. It is possible to manufacture the formulation as a final product so that it can be readily used by the end-user for the process according to the present invention. And, it is of course similarly possible to manufacture a concentrate, which may be diluted by the end-user with additional water (C) to the desired concentration for use.

In an embodiment, a composition (comprising a combination of (1) one or more CRIPs set for the in Table A, i.e., A1-A68, (2) one or more Insecticidal Agents set forth in Table B, i.e., B1-B479, and (3) an excipient) suitable for SSI application or a coating formulation (comprising a combination of (1) one or more CRIPs set for the in Table A, i.e., A1-A68, (2) one or more Insecticidal Agents set forth in Table B, i.e., B1-B479, and (3) an excipient), contains the active ingredient and a carrier, such as water, and may also one or more co-formulants selected from a dispersant, a wetter, an anti-freeze, a thickener, a preservative, an emulsifier and a binder or sticker.

In some embodiments, an exemplary solid formulation of a CRIP or Insecticidal Agent, is generally milled to a desired particle size, such as the particle size distribution d(0.5) is generally from 3 to 20, preferably 5 to 15, especially 7 to 12, μm.

Furthermore, it may be possible to ship the formulation to the end-user as a kit comprising at least a first component comprising a combination of (1) one or more CRIPs set for the in Table A, i.e., A1-A68, (2) one or more of Insecticidal Agents set forth in Table B, i.e., B1-B479 (A); and a second component comprising at least one polymeric binder (B). Further additives (D) may be a third separate component of the kit, or may be already mixed with components (A) and/or (B). The end-user may prepare the formulation for use by just adding water (C) to the components of the kit and mixing. The components of the kit may also be formulations in water. Of course it is possible to combine an aqueous formulation of one of the components with a dry formulation of the other component(s). As an example, the kit can consist of one formulation of comprising a combination of (1) one or more CRIPs set for the in Table A, i.e., A1-A68, (2) one or more of Insecticidal Agents set forth in Table B, i.e., B1-B479, (A) and optionally water (C); and a second, separate formulation of at least one polymeric binder (B), water as component (C) and optionally components (D).

The concentrations of the components (A), (B), (C) and optionally (D) will be selected by the skilled artisan depending of the technique to be used for coating/treating. In general, the amount of a combination of (1) one or more CRIPs set for the in Table A, i.e., A1-A68, (2) one or more of Insecticidal Agents set forth in Table B, i.e., B1-B479, (A) may be up to 50, preferably 1 to 50, such as 10 to 40, especially 15 to 30, percent by weight, based on weight of the composition. The amount of polymeric binder (B) may be in the range of 0.01 to 30, preferably 0.5 to 15, more preferably 1 to 10, especially 1 to 5, percent by weight, based on weight of the composition. If present, in general the amount of additional components (D) is from 0.1 to 20, preferably 0.5 to 15, percent by weight, based on weight of the composition. If present, suitable amounts of pigments and/or dyestuffs and/or fragrances are in general 0.01 to 5, preferably 0.1 to 3, more preferably 0.2 to 2, percent by weight, based on weight of the composition. A typical formulation ready for use comprises 0.1 to 40, preferably 1 to 30, percent of components (A), (B), and optionally (D), the residual amount being water (C). A typical concentration of a concentrate to be diluted by the end-user may comprise 5 to 70, preferably 10 to 60, percent of components (A), (B), and optionally (D), the residual amount being water (C).

Any of the CRIPs set for the in Table A, i.e., A1-A68, or the Insecticidal Agents set forth in Table B, i.e., B1-B479, as described herein; and/or any of the methods regarding the same, can be used to create any of the foregoing sprayable compositions, formulations, and/or kits as described herein.

Tvp Compositions

Vitrification

Vitrification describes a process wherein the reaction kinetics of a peptide are slowed down via immobilization of the peptide in a rigid, amorphous glassy sugar matrix: this results in drastically slowing down degradation of the peptide. See Slade et al., Beyond water activity: recent advances based on an alternative approach to the assessment of food quality and safety, Crit. Rev. Food Sci. Nutr. 30 (1991) 115-360. The unfolding of peptides, and other mechanisms of degradation, are dependent on molecular mobility of a peptide; thus, vitrification slows down such degradation. See Change et al., Mechanism of protein stabilization by sugars during freeze-drying and storage: native structure preservation, specific interaction, and/or immobilization in a glassy matrix?, J Pharm. Sci. 94 (2005) 1427-1444; and G. O. Poinar and R. Hess, Ultrastructure of 40-million-year-old insect tissue, Science 80 (215) (1982) 1241-1242.

An exemplary description of vitrification, and considerations thereof in the stabilization of peptides, is provided in Mensink et al., How sugars protect proteins in the solid state and during drying (review): Mechanisms of stabilization in relation to stress conditions. Eur J Pharm Biopharm. 2017 May; 114:288-295; the disclosure of which is incorporated herein by reference in its entirety.

In some embodiments, a CRIP or a CRIP-insecticidal protein, e.g., a TVP of the present invention, can be vitrified. For example, in some embodiments, a TVP of the present invention can be stabilized using the process of vitrification.

In some embodiments, vitrification can occur via the use of sugar. In some embodiments, the sugar can be trehalose.

Trehalose

Trehalose is a disaccharide formed by a 1,1-glycosidic bond between two α-glucose units. In some embodiments, he molecular formula for trehalose is C₁₂H₂₂O₁₁; having a molecular weight of 342.3 g/mol.

Trehalose is found in nature as a disaccharide and also as a monomer in some polymers; however, some trehalose isomers exist that are not found in nature. See Elbein et al., New insights on trehalose: a multifunctional molecule. Glycobiology. 2003 April; 13(4):17R-27R.

Trehalose has been shown to stabilize proteins and cells against stresses such as heat, freezing, and desiccation. See K. Lippert and E. Galinski, Appl. Microbiol. Biotechnol., 1992, 37, 61-65; J. K. Kaushik and R. Bhat, J. Biol. Chem., 2003, 278, 26458-26465; R. P. Baptista, S. Pedersen, G. J. Cabrita, D. E. Otzen, J. M. Cabral and E. P. Melo, Biopolymers, 2008, 89, 538-547; Guo et al., Nat. Biotechnol., 2000, 18, 168-171; Hengherr et al., FEBS J., 2008, 275, 281-288; Crowe et al., Science, 1984, 223, 701-703; Beattie et al., Diabetes, 1997, 46, 519-523; P. Sundaramurthi and R. Suryanarayanan, J. Phys. Chem. Lett., 2009, 1, 510-514; Duong et al., Appl. Environ. Microbiol., 2006, 72, 1218-1225.

Indeed, some animals accumulate trehalose to significant levels in response to environmental stresses, thus emphasizing the ability of trehalose to stabilize biological molecules. See P. Westh and H. Ramlev, J. Exp. Zool., 1991, 258, 303-311; and K. A. C. Madin and J. H. Crowe, J. Exp. Zool., 1975, 193, 335-342. Furthermore, trehalose is generally regarded as safe, and is used in several pharmaceutical drugs as stabilizers. See N. K. Jain and I. Roy, Protein Sci., 2009, 18, 24-36; and S. Ohtake and Y. J. Wang, J. Pharm. Sci., 2011, 100, 2020-2053.

The use of trehalose is well known in the art. Trehalose is readily available from commercial sources. For example, D-(+)-Trehalose dihydrate (Product No. T9531); and Trehalose (Product Nos. PHR1344 and 1673715) are available from Sigma Aldrich (Sigma-Aldrich Corp. St. Louis, MO, USA).

Exemplary trehalose molecules are provided herein, having an Chemical Abstracts Service (CAS) Reg. No. 99-20-7 (anhydrous); and CAS Reg. No. 6138-23-4 (dihydrous). An exemplary trehalose compound of the present disclosure has a PubChem CID No. 7427.

Exemplary descriptions of the use of trehalose to stabilize peptides is provided in U.S. Pat. Nos. 6,165,981; 6,171,586; 6,991,790; 7,956,028; 10,273,333; and 10,588,957; the disclosures of which are incorporated herein by reference in their entireties.

Exemplary descriptions of the preparation and use of trehalose in compositions is provided in U.S. Pat. No. 7,678,764, the disclosure of which is incorporated herein by reference in its entirety.

Ranges and descriptions of TVP compositions and components thereof.

As used herein, “formulation” and “composition” are synonymous.

In some embodiments, a formulation comprising an Insecticidal Agent (IA) and a TVP, TVP-insecticidal protein, or a pharmaceutically acceptable salt thereof, can be a liquid concentrate, a wettable powder, or a granule formulation. In some embodiments, any of the TVPs, TVP-insecticidal proteins, or pharmaceutically acceptable salts thereof, as described herein, can be used in the any of the formulations described below, e.g., any of the foregoing TVPs, TVP-insecticidal proteins, or pharmaceutically acceptable salts thereof, can be used in the formulation of: a wettable powder or granule formulation; or a liquid concentrate formulation.

In some embodiments, a formulation comprises, consists essentially of, or consists of: (1) one or more IAs as described herein (e.g., those enumerated in Table B; (2) a TVP, a TVP-insecticidal protein, or a pharmaceutically acceptable salt thereof; and (3) one or more excipients; wherein the excipients comprise, consist essentially of, or consist of: trehalose; potassium phosphate dibasic (K₂HPO₄); potassium phosphate monobasic (KH₂PO₄); maltodextrin; and BIT.

In some embodiments, a formulation of the present invention comprises, a concentration of trehalose ranging from about 0.01%, 0.02%, 0.03%, 0.04%, 0.05%, 0.06%, 0.07%, 0.08%, 0.09%, 0.1%, 0.2%, 0.3%, 0.4%, 0.5%, 0.6%, 0.7%, 0.8%, 0.9%, 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88%, 89%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, or 99.9% by weight of the total formulation.

In some embodiments, a formulation of the present invention comprises, a concentration of trehalose ranging from about 0.1% to about 99.9%; from about 1% to about 99.9%; from about 2% to about 99.9%; from about 3% to about 99.9%; from about 4% to about 99.9%; from about 5% to about 99.9%; from about 6% to about 99.9%; from about 7% to about 99.9%; from about 8% to about 99.9%; from about 9% to about 99.9%; from about 10% to about 99.9%; from about 11% to about 99.9%; from about 12% to about 99.9%; from about 13% to about 99.9%; from about 14% to about 99.9%; from about 15% to about 99.9%; from about 16% to about 99.9%; from about 17% to about 99.9%; from about 18% to about 99.9%; from about 19% to about 99.9%; from about 20% to about 99.9%; from about 21% to about 99.9%; from about 22% to about 99.9%; from about 23% to about 99.9%; from about 24% to about 99.9%; from about 25% to about 99.9%; from about 26% to about 99.9%; from about 27% to about 99.9%; from about 28% to about 99.9%; from about 29% to about 99.9%; from about 30% to about 99.9%; from about 31% to about 99.9%; from about 32% to about 99.9%; from about 33% to about 99.9%; from about 34% to about 99.9%; from about 35% to about 99.9%; from about 36% to about 99.9%; from about 37% to about 99.9%; from about 38% to about 99.9%; from about 39% to about 99.9%; from about 40% to about 99.9%; from about 41% to about 99.9%; from about 42% to about 99.9%; from about 43% to about 99.9%; from about 44% to about 99.9%; from about 45% to about 99.9%; from about 46% to about 99.9%; from about 47% to about 99.9%; from about 48% to about 99.9%; from about 49% to about 99.9%; from about 50% to about 99.9%; from about 51% to about 99.9%; from about 52% to about 99.9%; from about 53% to about 99.9%; from about 54% to about 99.9%; from about 55% to about 99.9%; from about 56% to about 99.9%; from about 57% to about 99.9%; from about 58% to about 99.9%; from about 59% to about 99.9%; from about 60% to about 99.9%; from about 61% to about 99.9%; from about 62% to about 99.9%; from about 63% to about 99.9%; from about 64% to about 99.9%; from about 65% to about 99.9%; from about 66% to about 99.9%; from about 67% to about 99.9%; from about 68% to about 99.9%; from about 69% to about 99.9%; from about 70% to about 99.9%; from about 71% to about 99.9%; from about 72% to about 99.9%; from about 73% to about 99.9%; from about 74% to about 99.9%; from about 75% to about 99.9%; from about 76% to about 99.9%; from about 77% to about 99.9%; from about 78% to about 99.9%; from about 79% to about 99.9%; from about 80% to about 99.9%; from about 81% to about 99.9%; from about 82% to about 99.9%; from about 83% to about 99.9%; from about 84% to about 99.9%; from about 85% to about 99.9%; from about 86% to about 99.9%; from about 87% to about 99.9%; from about 88% to about 99.9%; from about 89% to about 99.9%; from about 90% to about 99.9%; from about 91% to about 99.9%; from about 92% to about 99.9%; from about 93% to about 99.9%; from about 94% to about 99.9%; from about 95% to about 99.9%; from about 96% to about 99.9%; from about 97% to about 99.9%; from about 98% to about 99.9%; or from about 99% to about 99.9%, wt/wt of the total formulation.

In some embodiments, a formulation of the present invention comprises a concentration of trehalose ranging from about 0.1% to about 99%; from about 0.1% to about 98%; from about 0.1% to about 97%; from about 0.1% to about 96%; from about 0.1% to about 95%; from about 0.1% to about 94%; from about 0.1% to about 93%; from about 0.1% to about 92%; from about 0.1% to about 91%; from about 0.1% to about 90%; from about 0.1% to about 89%; from about 0.1% to about 88%; from about 0.1% to about 87%; from about 0.1% to about 86%; from about 0.1% to about 85%; from about 0.1% to about 84%; from about 0.1% to about 83%; from about 0.1% to about 82%; from about 0.1% to about 81%; from about 0.1% to about 80%; from about 0.1% to about 79%; from about 0.1% to about 78%; from about 0.1% to about 77%; from about 0.1% to about 76%; from about 0.1% to about 75%; from about 0.1% to about 74%; from about 0.1% to about 73%; from about 0.1% to about 72%; from about 0.1% to about 71%; from about 0.1% to about 70%; from about 0.1% to about 69%; from about 0.1% to about 68%; from about 0.1% to about 67%; from about 0.1% to about 66%; from about 0.1% to about 65%; from about 0.1% to about 64%; from about 0.1% to about 63%; from about 0.1% to about 62%; from about 0.1% to about 61%; from about 0.1% to about 60%; from about 0.1% to about 59%; from about 0.1% to about 58%; from about 0.1% to about 57%; from about 0.1% to about 56%; from about 0.1% to about 55%; from about 0.1% to about 54%; from about 0.1% to about 53%; from about 0.1% to about 52%; from about 0.1% to about 51%; from about 0.1% to about 50%; from about 0.1% to about 49%; from about 0.1% to about 48%; from about 0.1% to about 47%; from about 0.1% to about 46%; from about 0.1% to about 45%; from about 0.1% to about 44%; from about 0.1% to about 43%; from about 0.1% to about 42%; from about 0.1% to about 41%; from about 0.1% to about 40%; from about 0.1% to about 39%; from about 0.1% to about 38%; from about 0.1% to about 37%; from about 0.1% to about 36%; from about 0.1% to about 35%; from about 0.1% to about 34%; from about 0.1% to about 33%; from about 0.1% to about 32%; from about 0.1% to about 31%; from about 0.1% to about 30%; from about 0.1% to about 29%; from about 0.1% to about 28%; from about 0.1% to about 27%; from about 0.1% to about 26%; from about 0.1% to about 25%; from about 0.1% to about 24%; from about 0.1% to about 23%; from about 0.1% to about 22%; from about 0.1% to about 21%; from about 0.1% to about 20%; from about 0.1% to about 19%; from about 0.1% to about 18%; from about 0.1% to about 17%; from about 0.1% to about 16%; from about 0.1% to about 15%; from about 0.1% to about 14%; from about 0.1% to about 13%; from about 0.1% to about 12%; from about 0.1% to about 11%; from about 0.1% to about 10%; from about 0.1% to about 9%; from about 0.1% to about 8%; from about 0.1% to about 7%; from about 0.1% to about 6%; from about 0.1% to about 5%; from about 0.1% to about 4%; from about 0.1% to about 3%; from about 0.1% to about 2%; from about 0.1% to about 1%; or from about 0.1% to about 0.5%, wt/wt of the total formulation.

In some embodiments, a formulation of the present invention comprises a concentration of potassium phosphate dibasic (K₂HPO₄) ranging from about 0.1% to about 40%; from about 0.5% to about 40%; from about 1% to about 40%; from about 2% to about 40%; from about 3% to about 40%; from about 4% to about 40%; from about 5% to about 40%; from about 6% to about 40%; from about 7% to about 40%; from about 8% to about 40%; from about 9% to about 40%; from about 10% to about 40%; from about 11% to about 40%; from about 12% to about 40%; from about 13% to about 40%; from about 14% to about 40%; from about 15% to about 40%; from about 16% to about 40%; from about 17% to about 40%; from about 18% to about 40%; from about 19% to about 40%; from about 20% to about 40%; from about 21% to about 40%; from about 22% to about 40%; from about 23% to about 40%; from about 24% to about 40%; from about 25% to about 40%; from about 26% to about 40%; from about 27% to about 40%; from about 28% to about 40%; from about 29% to about 40%; from about 30% to about 40%; from about 31% to about 40%; from about 32% to about 40%; from about 33% to about 40%; from about 34% to about 40%; from about 35% to about 40%; from about 36% to about 40%; from about 37% to about 40%; from about 38% to about 40%; or from about 39% to about 40%; wt/wt of the total formulation.

In some embodiments, a formulation of the present invention comprises a concentration of potassium phosphate dibasic (K₂HPO₄) ranging from about 0.1% to about 40%; from about 0.1% to about 39%; from about 0.1% to about 38%; from about 0.1% to about 37%; from about 0.1% to about 36%; from about 0.1% to about 35%; from about 0.1% to about 34%; from about 0.1% to about 33%; from about 0.1% to about 32%; from about 0.1% to about 31%; from about 0.1% to about 30%; from about 0.1% to about 29%; from about 0.1% to about 28%; from about 0.1% to about 27%; from about 0.1% to about 26%; from about 0.1% to about 25%; from about 0.1% to about 24%; from about 0.1% to about 23%; from about 0.1% to about 22%; from about 0.1% to about 21%; from about 0.1% to about 20%; from about 0.1% to about 19%; from about 0.1% to about 18%; from about 0.1% to about 17%; from about 0.1% to about 16%; from about 0.1% to about 15%; from about 0.1% to about 14%; from about 0.1% to about 13%; from about 0.1% to about 12%; from about 0.1% to about 11%; from about 0.1% to about 10%; from about 0.1% to about 9%; from about 0.1% to about 8%; from about 0.1% to about 7%; from about 0.1% to about 6%; from about 0.1% to about 5%; from about 0.1% to about 4%; from about 0.1% to about 3%; from about 0.1% to about 2%; from about 0.1% to about 1%; or from about 0.1% to about 0.5%, wt/wt of the total formulation.

In some embodiments, a formulation of the present invention comprises a concentration of potassium phosphate monobasic (KH₂PO₄) ranging from about 0.1% to about 20%; from about 0.5% to about 20%; from about 1% to about 20%; from about 2% to about 20%; from about 3% to about 20%; from about 4% to about 20%; from about 5% to about 20%; from about 6% to about 20%; from about 7% to about 20%; from about 8% to about 20%; from about 9% to about 20%; from about 10% to about 20%; from about 11% to about 20%; from about 12% to about 20%; from about 13% to about 20%; from about 14% to about 20%; from about 15% to about 20%; from about 16% to about 20%; from about 17% to about 20%; from about 18% to about 20%; or from about 19% to about 20%; wt/wt of the total formulation.

In some embodiments, a formulation of the present invention comprises a concentration of potassium phosphate monobasic (KH₂PO₄) ranging from about 0.1% to about 20%; from about 0.1% to about 19%; from about 0.1% to about 18%; from about 0.1% to about 17%; from about 0.1% to about 16%; from about 0.1% to about 15%; from about 0.1% to about 14%; from about 0.1% to about 13%; from about 0.1% to about 12%; from about 0.1% to about 11%; from about 0.1% to about 10%; from about 0.1% to about 9%; from about 0.1% to about 8%; from about 0.1% to about 7%; from about 0.1% to about 6%; from about 0.1% to about 5%; from about 0.1% to about 4%; from about 0.1% to about 3%; from about 0.1% to about 2%; from about 0.1% to about 1%; or from about 0.1% to about 0.5%, wt/wt of the total formulation.

In some embodiments, a formulation of the present invention comprises a concentration of maltodextrin ranging from about 0.1% to about 99.9%; from about 1% to about 99.9%; from about 2% to about 99.9%; from about 3% to about 99.9%; from about 4% to about 99.9%; from about 5% to about 99.9%; from about 6% to about 99.9%; from about 7% to about 99.9%; from about 8% to about 99.9%; from about 9% to about 99.9%; from about 10% to about 99.9%; from about 11% to about 99.9%; from about 12% to about 99.9%; from about 13% to about 99.9%; from about 14% to about 99.9%; from about 15% to about 99.9%; from about 16% to about 99.9%; from about 17% to about 99.9%; from about 18% to about 99.9%; from about 19% to about 99.9%; from about 20% to about 99.9%; from about 21% to about 99.9%; from about 22% to about 99.9%; from about 23% to about 99.9%; from about 24% to about 99.9%; from about 25% to about 99.9%; from about 26% to about 99.9%; from about 27% to about 99.9%; from about 28% to about 99.9%; from about 29% to about 99.9%; from about 30% to about 99.9%; from about 31% to about 99.9%; from about 32% to about 99.9%; from about 33% to about 99.9%; from about 34% to about 99.9%; from about 35% to about 99.9%; from about 36% to about 99.9%; from about 37% to about 99.9%; from about 38% to about 99.9%; from about 39% to about 99.9%; from about 40% to about 99.9%; from about 41% to about 99.9%; from about 42% to about 99.9%; from about 43% to about 99.9%; from about 44% to about 99.9%; from about 45% to about 99.9%; from about 46% to about 99.9%; from about 47% to about 99.9%; from about 48% to about 99.9%; from about 49% to about 99.9%; from about 50% to about 99.9%; from about 51% to about 99.9%; from about 52% to about 99.9%; from about 53% to about 99.9%; from about 54% to about 99.9%; from about 55% to about 99.9%; from about 56% to about 99.9%; from about 57% to about 99.9%; from about 58% to about 99.9%; from about 59% to about 99.9%; from about 60% to about 99.9%; from about 61% to about 99.9%; from about 62% to about 99.9%; from about 63% to about 99.9%; from about 64% to about 99.9%; from about 65% to about 99.9%; from about 66% to about 99.9%; from about 67% to about 99.9%; from about 68% to about 99.9%; from about 69% to about 99.9%; from about 70% to about 99.9%; from about 71% to about 99.9%; from about 72% to about 99.9%; from about 73% to about 99.9%; from about 74% to about 99.9%; from about 75% to about 99.9%; from about 76% to about 99.9%; from about 77% to about 99.9%; from about 78% to about 99.9%; from about 79% to about 99.9%; from about 80% to about 99.9%; from about 81% to about 99.9%; from about 82% to about 99.9%; from about 83% to about 99.9%; from about 84% to about 99.9%; from about 85% to about 99.9%; from about 86% to about 99.9%; from about 87% to about 99.9%; from about 88% to about 99.9%; from about 89% to about 99.9%; from about 90% to about 99.9%; from about 91% to about 99.9%; from about 92% to about 99.9%; from about 93% to about 99.9%; from about 94% to about 99.9%; from about 95% to about 99.9%; from about 96% to about 99.9%; from about 97% to about 99.9%; from about 98% to about 99.9%; or from about 99% to about 99.9%, wt/wt of the total formulation.

In some embodiments, a formulation of the present invention comprises a concentration of maltodextrin ranging from about 0.1% to about 99%; from about 0.1% to about 98%; from about 0.1% to about 97%; from about 0.1% to about 96%; from about 0.1% to about 95%; from about 0.1% to about 94%; from about 0.1% to about 93%; from about 0.1% to about 92%; from about 0.1% to about 91%; from about 0.1% to about 90%; from about 0.1% to about 89%; from about 0.1% to about 88%; from about 0.1% to about 87%; from about 0.1% to about 86%; from about 0.1% to about 85%; from about 0.1% to about 84%; from about 0.1% to about 83%; from about 0.1% to about 82%; from about 0.1% to about 81%; from about 0.1% to about 80%; from about 0.1% to about 79%; from about 0.1% to about 78%; from about 0.1% to about 77%; from about 0.1% to about 76%; from about 0.1% to about 75%; from about 0.1% to about 74%; from about 0.1% to about 73%; from about 0.1% to about 72%; from about 0.1% to about 71%; from about 0.1% to about 70%; from about 0.1% to about 69%; from about 0.1% to about 68%; from about 0.1% to about 67%; from about 0.1% to about 66%; from about 0.1% to about 65%; from about 0.1% to about 64%; from about 0.1% to about 63%; from about 0.1% to about 62%; from about 0.1% to about 61%; from about 0.1% to about 60%; from about 0.1% to about 59%; from about 0.1% to about 58%; from about 0.1% to about 57%; from about 0.1% to about 56%; from about 0.1% to about 55%; from about 0.1% to about 54%; from about 0.1% to about 53%; from about 0.1% to about 52%; from about 0.1% to about 51%; from about 0.1% to about 50%; from about 0.1% to about 49%; from about 0.1% to about 48%; from about 0.1% to about 47%; from about 0.1% to about 46%; from about 0.1% to about 45%; from about 0.1% to about 44%; from about 0.1% to about 43%; from about 0.1% to about 42%; from about 0.1% to about 41%; from about 0.1% to about 40%; from about 0.1% to about 39%; from about 0.1% to about 38%; from about 0.1% to about 37%; from about 0.1% to about 36%; from about 0.1% to about 35%; from about 0.1% to about 34%; from about 0.1% to about 33%; from about 0.1% to about 32%; from about 0.1% to about 31%; from about 0.1% to about 30%; from about 0.1% to about 29%; from about 0.1% to about 28%; from about 0.1% to about 27%; from about 0.1% to about 26%; from about 0.1% to about 25%; from about 0.1% to about 24%; from about 0.1% to about 23%; from about 0.1% to about 22%; from about 0.1% to about 21%; from about 0.1% to about 20%; from about 0.1% to about 19%; from about 0.1% to about 18%; from about 0.1% to about 17%; from about 0.1% to about 16%; from about 0.1% to about 15%; from about 0.1% to about 14%; from about 0.1% to about 13%; from about 0.1% to about 12%; from about 0.1% to about 11%; from about 0.1% to about 10%; from about 0.1% to about 9%; from about 0.1% to about 8%; from about 0.1% to about 7%; from about 0.1% to about 6%; from about 0.1% to about 5%; from about 0.1% to about 4%; from about 0.1% to about 3%; from about 0.1% to about 2%; from about 0.1% to about 1%; or from about 0.1% to about 0.5%, wt/wt of the total formulation.

In some embodiments, the maltodextrin can have a dextrose equivalent ranging from about 2% to about 20%; from about 3% to about 20%; from about 4% to about 20%; from about 5% to about 20%; from about 6% to about 20%; from about 7% to about 20%; from about 8% to about 20%; from about 9% to about 20%; from about 10% to about 20%; from about 11% to about 20%; from about 12% to about 20%; from about 13% to about 20%; from about 14% to about 20%; from about 15% to about 20%; from about 16% to about 20%; from about 17% to about 20%; from about 18% to about 20%; or from about 19% to about 20%; wt/wt of the total formulation.

In some embodiments, the maltodextrin can have a dextrose equivalent ranging from about 2% to about 20%; from about 2% to about 19%; from about 2% to about 18%; from about 2% to about 17%; from about 2% to about 16%; from about 2% to about 15%; from about 2% to about 14%; from about 2% to about 13%; from about 2% to about 12%; from about 2% to about 11%; from about 2% to about 10%; from about 2% to about 9%; from about 2% to about 8%; from about 2% to about 7%; from about 2% to about 6%; from about 2% to about 5%; from about 2% to about 4%; or from about 2% to about 3%; wt/wt of the total formulation.

In some embodiments, a formulation of the present invention comprises a concentration of benzisothiazolinone (BIT) ranging from about 0.01% to about 1%; from about 0.025% to about 1%; from about 0.05% to about 1%; from about 0.075% to about 1%; from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%; from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of benzisothiazolinone (BIT) ranging from about 0.01% to about 1%; from about 0.01% to about 0.975%; from about 0.01% to about 0.95%; from about 0.01% to about 0.925%; from about 0.01% to about 0.9%; from about 0.01% to about 0.875%; from about 0.01% to about 0.85%; from about 0.01% to about 0.825%; from about 0.01% to about 0.8%; from about 0.01% to about 0.775%; from about 0.01% to about 0.75%; from about 0.01% to about 0.725%; from about 0.01% to about 0.7%; from about 0.01% to about 0.675%; from about 0.01% to about 0.65%; from about 0.01% to about 0.625%; from about 0.01% to about 0.6%; from about 0.01% to about 0.575%; from about 0.01% to about 0.55%; from about 0.01% to about 0.525%; from about 0.01% to about 0.5%; from about 0.01% to about 0.475%; from about 0.01% to about 0.45%; from about 0.01% to about 0.425%; from about 0.01% to about 0.4%; from about 0.01% to about 0.375%; from about 0.01% to about 0.35%; from about 0.01% to about 0.325%; from about 0.01% to about 0.3%; from about 0.01% to about 0.275%; from about 0.01% to about 0.25%; from about 0.01% to about 0.225%; from about 0.01% to about 0.2%; from about 0.01% to about 0.175%; from about 0.01% to about 0.15%; from about 0.01% to about 0.125%; from about 0.01% to about 0.1%; from about 0.01% to about 0.075%; from about 0.01% to about 0.05%; or from about 0.01% to about 0.025%; wt/wt of the total formulation.

In some embodiments, the BIT can be 1,2-Benzisothiazolin-3-one. An exemplary 1,2-Benzisothiazolin-3-one is provided herein, having a CAS No. 2634-33-5. An exemplary description describing how to make 1,2-Benzisothiazolin-3-one is provided in WIPO Publication No. WO2014173716A1, the disclosure of which is incorporated herein by reference in its entirety. In addition, 1,2-Benzisothiazolin-3-one is readily available from commercial vendors, e.g., PROXEL® AQ Preservative; 9.25% aqueous solution of 1,2-benzisothiazolin-3-one; available from Lonza Group Ltd. Muenchensteinerstrasse 38, CH-4002 Basel, Switzerland.

In some embodiments, a formulation of the present invention comprises a concentration of lignosulfonate ranging from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%; from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of lignosulfonate from about 0.1% to about 1%; from about 0.1% to about 0.975%; from about 0.1% to about 0.95%; from about 0.1% to about 0.925%; from about 0.1% to about 0.9%; from about 0.1% to about 0.875%; from about 0.1% to about 0.85%; from about 0.1% to about 0.825%; from about 0.1% to about 0.8%; from about 0.1% to about 0.775%; from about 0.1% to about 0.75%; from about 0.1% to about 0.725%; from about 0.1% to about 0.7%; from about 0.1% to about 0.675%; from about 0.1% to about 0.65%; from about 0.1% to about 0.625%; from about 0.1% to about 0.6%; from about 0.1% to about 0.575%; from about 0.1% to about 0.55%; from about 0.1% to about 0.525%; from about 0.1% to about 0.5%; from about 0.1% to about 0.475%; from about 0.1% to about 0.45%; from about 0.1% to about 0.425%; from about 0.1% to about 0.4%; from about 0.1% to about 0.375%; from about 0.1% to about 0.35%; from about 0.1% to about 0.325%; from about 0.1% to about 0.3%; from about 0.1% to about 0.275%; from about 0.1% to about 0.25%; from about 0.1% to about 0.225%; from about 0.1% to about 0.2%; from about 0.1% to about 0.175%; from about 0.1% to about 0.15%; or from about 0.1% to about 0.125%; wt/wt of the total formulation.

In some embodiments, a formulation of the present invention comprises a concentration of gypsum ranging from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%;

from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of gypsum ranging from about 0.1% to about 1%; from about 0.1% to about 0.975%; from about 0.1% to about 0.95%; from about 0.1% to about 0.925%; from about 0.1% to about 0.9%; from about 0.1% to about 0.875%; from about 0.1% to about 0.85%; from about 0.1% to about 0.825%; from about 0.1% to about 0.8%; from about 0.1% to about 0.775%; from about 0.1% to about 0.75%; from about 0.1% to about 0.725%; from about 0.1% to about 0.7%; from about 0.1% to about 0.675%; from about 0.1% to about 0.65%; from about 0.1% to about 0.625%; from about 0.1% to about 0.6%; from about 0.1% to about 0.575%; from about 0.1% to about 0.55%; from about 0.1% to about 0.525%; from about 0.1% to about 0.5%; from about 0.1% to about 0.475%; from about 0.1% to about 0.45%; from about 0.1% to about 0.425%; from about 0.1% to about 0.4%; from about 0.1% to about 0.375%; from about 0.1% to about 0.35%; from about 0.1% to about 0.325%; from about 0.1% to about 0.3%; from about 0.1% to about 0.275%; from about 0.1% to about 0.25%; from about 0.1% to about 0.225%; from about 0.1% to about 0.2%; from about 0.1% to about 0.175%; from about 0.1% to about 0.15%; or from about 0.1% to about 0.125%; wt/wt of the total formulation.

In some embodiments, a formulation of the present invention comprises a concentration of sorbitol ranging from about 0.5% to about 8%; from about 0.75% to about 8%; from about 1% to about 8%; from about 1.25% to about 8%; from about 1.5% to about 8%; from about 1.75% to about 8%; from about 2% to about 8%; from about 2.25% to about 8%; from about 2.5% to about 8%; from about 2.75% to about 8%; from about 3% to about 8%; from about 3.25% to about 8%; from about 3.5% to about 8%; from about 3.75% to about 8%; from about 4% to about 8%; from about 4.25% to about 8%; from about 4.5% to about 8%; from about 4.75% to about 8%; from about 5% to about 8%; from about 5.25% to about 8%; from about 5.5% to about 8%; from about 5.75% to about 8%; from about 6% to about 8%; from about 6.25% to about 8%; from about 6.5% to about 8%; from about 6.75% to about 8%; from about 7% to about 8%; from about 7.25% to about 8%; from about 7.5% to about 8%; or from about 7.75% to about 8%; wt/wt of the total formulation.

In some embodiments, a formulation of the present invention comprises a concentration of sorbitol ranging from about 0.5% to about 8%; from about 0.5% to about 7.75%; from about 0.5% to about 7.5%; from about 0.5% to about 7.25%; from about 0.5% to about 7%; from about 0.5% to about 6.75%; from about 0.5% to about 6.5%; from about 0.5% to about 6.25%; from about 0.5% to about 6%; from about 0.5% to about 5.75%; from about 0.5% to about 5.5%; from about 0.5% to about 5.25%; from about 0.5% to about 5%; from about 0.5% to about 4.75%; from about 0.5% to about 4.5%; from about 0.5% to about 4.25%; from about 0.5% to about 4%; from about 0.5% to about 3.75%; from about 0.5% to about 3.5%; from about 0.5% to about 3.25%; from about 0.5% to about 3%; from about 0.5% to about 2.75%; from about 0.5% to about 2.5%; from about 0.5% to about 2.25%; from about 0.5% to about 2%; from about 0.5% to about 1.75%; from about 0.5% to about 1.5%; from about 0.5% to about 1.25%; from about 0.5% to about 1%; or from about 0.5% to about 0.75%; wt/wt of the total formulation.

In some embodiments, a formulation of the present invention comprises a concentration of sodium benzoate ranging from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%; from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of sodium benzoate ranging from about 0.1% to about 1%; from about 0.1% to about 0.975%; from about 0.1% to about 0.95%; from about 0.1% to about 0.925%; from about 0.1% to about 0.9%; from about 0.1% to about 0.875%; from about 0.1% to about 0.85%; from about 0.1% to about 0.825%; from about 0.1% to about 0.8%; from about 0.1% to about 0.775%; from about 0.1% to about 0.75%; from about 0.1% to about 0.725%; from about 0.1% to about 0.7%; from about 0.1% to about 0.675%; from about 0.1% to about 0.65%; from about 0.1% to about 0.625%; from about 0.1% to about 0.6%; from about 0.1% to about 0.575%; from about 0.1% to about 0.55%; from about 0.1% to about 0.525%; from about 0.1% to about 0.5%; from about 0.1% to about 0.475%; from about 0.1% to about 0.45%; from about 0.1% to about 0.425%; from about 0.1% to about 0.4%; from about 0.1% to about 0.375%; from about 0.1% to about 0.35%; from about 0.1% to about 0.325%; from about 0.1% to about 0.3%; from about 0.1% to about 0.275%; from about 0.1% to about 0.25%; from about 0.1% to about 0.225%; from about 0.1% to about 0.2%; from about 0.1% to about 0.175%; from about 0.1% to about 0.15%; or from about 0.1% to about 0.125%; wt/wt of the total formulation.

In some embodiments, a formulation of the present invention comprises a concentration of potassium sorbate ranging from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%; from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of potassium sorbate ranging from about 0.1% to about 1%; from about 0.1% to about 0.975%; from about 0.1% to about 0.95%; from about 0.1% to about 0.925%; from about 0.1% to about 0.9%; from about 0.1% to about 0.875%; from about 0.1% to about 0.85%; from about 0.1% to about 0.825%; from about 0.1% to about 0.8%; from about 0.1% to about 0.775%; from about 0.1% to about 0.75%; from about 0.1% to about 0.725%; from about 0.1% to about 0.7%; from about 0.1% to about 0.675%; from about 0.1% to about 0.65%; from about 0.1% to about 0.625%; from about 0.1% to about 0.6%; from about 0.1% to about 0.575%; from about 0.1% to about 0.55%; from about 0.1% to about 0.525%; from about 0.1% to about 0.5%; from about 0.1% to about 0.475%; from about 0.1% to about 0.45%; from about 0.1% to about 0.425%; from about 0.1% to about 0.4%; from about 0.1% to about 0.375%; from about 0.1% to about 0.35%; from about 0.1% to about 0.325%; from about 0.1% to about 0.3%; from about 0.1% to about 0.275%; from about 0.1% to about 0.25%; from about 0.1% to about 0.225%; from about 0.1% to about 0.2%; from about 0.1% to about 0.175%; from about 0.1% to about 0.15%; or from about 0.1% to about 0.125%; wt/wt of the total formulation.

In some embodiments, a formulation of the present invention comprises a concentration of EDTA ranging from about 0.1% to about 1%; from about 0.125% to about 1%; from about 0.15% to about 1%; from about 0.175% to about 1%; from about 0.2% to about 1%; from about 0.225% to about 1%; from about 0.25% to about 1%; from about 0.275% to about 1%; from about 0.3% to about 1%; from about 0.325% to about 1%; from about 0.35% to about 1%; from about 0.375% to about 1%; from about 0.4% to about 1%; from about 0.425% to about 1%; from about 0.45% to about 1%; from about 0.475% to about 1%; from about 0.5% to about 1%; from about 0.525% to about 1%; from about 0.55% to about 1%; from about 0.575% to about 1%; from about 0.6% to about 1%; from about 0.625% to about 1%; from about 0.65% to about 1%; from about 0.675% to about 1%; from about 0.7% to about 1%; from about 0.725% to about 1%; from about 0.75% to about 1%; from about 0.775% to about 1%; from about 0.8% to about 1%; from about 0.825% to about 1%; from about 0.85% to about 1%; from about 0.875% to about 1%; from about 0.9% to about 1%; from about 0.925% to about 1%; from about 0.95% to about 1%; or from about 0.975% to about 1%; wt/wt of the total formulation.

In some embodiments, a formulation of the present invention comprises a concentration of EDTA ranging from about 0.1% to about 1%; from about 0.1% to about 0.975%; from about 0.1% to about 0.95%; from about 0.1% to about 0.925%; from about 0.1% to about 0.9%; from about 0.1% to about 0.875%; from about 0.1% to about 0.85%; from about 0.1% to about 0.825%; from about 0.1% to about 0.8%; from about 0.1% to about 0.775%; from about 0.1% to about 0.75%; from about 0.1% to about 0.725%; from about 0.1% to about 0.7%; from about 0.1% to about 0.675%; from about 0.1% to about 0.65%; from about 0.1% to about 0.625%; from about 0.1% to about 0.6%; from about 0.1% to about 0.575%; from about 0.1% to about 0.55%; from about 0.1% to about 0.525%; from about 0.1% to about 0.5%; from about 0.1% to about 0.475%; from about 0.1% to about 0.45%; from about 0.1% to about 0.425%; from about 0.1% to about 0.4%; from about 0.1% to about 0.375%; from about 0.1% to about 0.35%; from about 0.1% to about 0.325%; from about 0.1% to about 0.3%; from about 0.1% to about 0.275%; from about 0.1% to about 0.25%; from about 0.1% to about 0.225%; from about 0.1% to about 0.2%; from about 0.1% to about 0.175%; from about 0.1% to about 0.15%; or from about 0.1% to about 0.125%; wt/wt of the total formulation.

In some embodiments a formulation of the present invention can be formulated at a pH ranging from about 5 to about 11; from about 5.5 to about 11; from about 6 to about 11; from about 6.5 to about 11; from about 7 to about 11; from about 7.5 to about 11; from about 8 to about 11; from about 8.5 to about 11; from about 9 to about 11; from about 9.5 to about 11; from about 10 to about 11; or from about 10.5 to about 11.

In some embodiments a formulation of the present invention can be formulated at a pH ranging from about 5 to about 11; from about 5 to about 10.5; from about 5 to about 10; from about 5 to about 9.5; from about 5 to about 9; from about 5 to about 8.5; from about 5 to about 8; from about 5 to about 7.5; from about 5 to about 7; from about 5 to about 6.5; from about 5 to about 6; or from about 5 to about 5.5.

In some embodiments the formulation can be formulated into a granule form (granular formulation). Methods of generating a granular formulation are well known in the art, and include: crystallization, precipitation, pan-coating, fluid bed coating, agglomeration (e.g., fluid bed agglomeration), rotary atomization, extrusion, prilling, spheronization, size reduction methods, drum granulation, and/or high shear granulation, and the like.

In some embodiments, the granular formulation can be generated via agglomeration, e.g., spray-drying agglomeration; rewet agglomeration; fluid bed agglomeration; and the like.

In some embodiments, the type of agglomeration can be fluid bed agglomeration. Exemplary methods of fluid bed agglomeration are provided in U.S. Pat. No. 7,582,147; the disclosure of which is incorporated herein by reference in its entirety.

In some embodiments, the granular formulation can be generated via fluid bed agglomeration.

In some embodiments, the granular formulation can be generated by spraying the active and inert ingredients onto a blank carrier in a fluid bed.

In some embodiments, the granular formulation can be generated by spraying the active and inert ingredients (excipients) onto a blank carrier and granulated in pan granulator.

In some embodiments, the granular formulation can be generated by mixing the active and inert powders (i.e., one or more excipients described herein) and water, and subsequently granulated by passing the ingredients through an extruder.

In some embodiments, the granular formulation can be generated by mixing the active and inert powders (i.e., one or more excipients described herein) with water, and granulated by roll compaction.

Illustrative Combinations, Compositions, and Products

The present disclosure contemplates combinations, compositions, and products, comprising one or more CRIPs and one or more Insecticidal Agents (IAs).

Any of the combinations, combinations, products, polypeptides and/or plants, utilizing a CRIP as described herein and an IA as described herein (e.g., a mixture of one or more of CRIPs: A1-A68, and one or more of IAs: B1-B479), can be used to control pests, their growth, and/or the damage caused by their actions, especially their damage to plants.

Compositions comprising a combination of one or more of CRIPs: A1-A68 and one or more of IAs: B1-B479 can include agrochemical compositions. For example, in some embodiments, agrochemical compositions can include, but is not limited to, aerosols and/or aerosolized products, e.g., sprays, fumigants, powders, dusts, and/or gases; seed dressings; oral preparations (e.g., insect food, etc.); transgenic organisms expressing and/or producing a CRIP and/or a CRIP ORF (either transiently and/or stably) and a peptide IA, e.g., a plant or an animal.

In some embodiments, combinations or compositions comprising one or more of CRIPs: A1-A68 and one or more of IAs: B1-B479 can be used concomitantly, or sequentially with other insecticides proteins, and/or pesticides as described herein.

In some embodiments, a composition or combination can comprise a combination of one or more of CRIPs: A1-A68 and one or more of IAs: B1-B479, and one or more peptides or polypeptides from another organism.

For example, in some embodiments, a combination or composition can comprise a combination of one or more of CRIPs: A1-A68 and one or more of IAs: B1-B479, and one or more peptides or polypeptides from a spider, a scorpion, a sea anemone, a cone shell, a snake, a lizard, or a jellyfish.

In some embodiments, the active ingredients of the present disclosure can be applied in the form of compositions and can be applied to the crop area or plant to be treated, simultaneously or in succession, with other compounds. These compounds can be fertilizers, weed killers, cryoprotectants, surfactants, detergents, pesticidal soaps, dormant oils, polymers, and/or time-release or biodegradable carrier formulations that permit long-term dosing of a target area following a single application of the formulation. They can also be selective herbicides, chemical insecticides, virucides, microbicides, amoebicides, pesticides, fungicides, bacteriocides, nematocides, molluscicides or mixtures of several of these preparations, if desired, together with further agriculturally acceptable carriers, surfactants or application-promoting adjuvants customarily employed in the art of formulation. Suitable carriers and adjuvants can be solid or liquid and correspond to the substances ordinarily employed in formulation technology, e.g. natural or regenerated mineral substances, solvents, dispersants, wetting agents, tackifiers, binders or fertilizers. Likewise, the formulations may be prepared into edible “baits” or fashioned into pest “traps” to permit feeding or ingestion by a target pest of the pesticidal formulation.

Methods of applying an active ingredient of the present disclosure or an agrochemical composition of the present disclosure that contains a combination of one or more of CRIPs: A1-A68 and one or more of IAs: B1-B479 produced by the methods described herein of the present disclosure include leaf application, seed coating and soil application. In some embodiments, the number of applications and the rate of application depend on the intensity of infestation by the corresponding pest.

The composition may be formulated as a powder, dust, pellet, granule, spray, emulsion, colloid, solution, or such like, and may be prepared by such conventional means as desiccation, lyophilization, homogenization, extraction, filtration, centrifugation, sedimentation, or concentration of a culture of cells comprising the polypeptide. In all such compositions that contain at least one such pesticidal polypeptide, the polypeptide may be present in a concentration of from about 1% to about 99% by weight.

In some embodiments, compositions containing a combination of one or more of CRIPs: A1-A68 and one or more of IAs: B1-B479 may be prophylactically applied to an environmental area to prevent infestation by a susceptible pest, for example, a lepidopteran and/or coleopteran pest, which may be killed or reduced in numbers in a given area by the methods of the invention. In some embodiments, the pest ingests, or comes into contact with, a pesticidally-effective amount of the polypeptide.

In some embodiments, the pesticide compositions described herein may be made by formulating either the bacterial, yeast, or other cell, crystal and/or spore suspension, or isolated protein component with the desired agriculturally-acceptable carrier. The compositions may be formulated prior to administration in an appropriate means such as lyophilized, freeze-dried, desiccated, or in an aqueous carrier, medium or suitable diluent, such as saline and/or other buffer. In some embodiments, the formulated compositions may be in the form of a dust or granular material, or a suspension in oil (vegetable or mineral), or water or oil/water emulsions, or as a wettable powder, or in combination with any other carrier material suitable for agricultural application. Suitable agricultural carriers can be solid or liquid and are well known in the art. In some embodiments, the formulations may be mixed with one or more solid or liquid adjuvants and prepared by various means, e.g., by homogeneously mixing, blending and/or grinding the pesticidal composition with suitable adjuvants using conventional formulation techniques. Suitable formulations and application methods are described in U.S. Pat. No. 6,468,523, herein incorporated by reference in its entirety.

In some embodiments, a composition comprising a combination of one or more of CRIPs: A1-A68 and one or more of IAs: B1-B479 may also comprise additional ingredients, for example, herbicides, chemical insecticides, virucides, microbicides, amoebicides, pesticides, fungicides, bacteriocides, nematocides, molluscicides, polypeptides, and/or one or more of the foregoing mixtures thereof.

In some embodiments, a combination of the present invention can be included in a formulation, for example, a formulation composed of a polar aprotic solvent, and or water, and or where the polar aprotic solvent is present in an amount of 1-99 wt %, the polar protic solvent is present in an amount of 1-99 wt %, and the water is present in an amount of 0-98 wt %. The polar aprotic solvent formulations are especially effective when they contain MSO. MSO is a methylated seed oil and surfactant blend that uses methyl esters of soya oil in amounts of between about 80 and 85 percent petroleum oil with 15 to 20 percent surfactant.

In some embodiments, a combination of the present invention comprises two types of components, wherein the first type of component is an Insecticidal Agent (IA), and the second type of components is a Cysteine Rich Insecticidal Peptide (CRIP), wherein neither the IA nor CRIP are part of a fusion protein; and wherein the combination results in a insecticidal effect; wherein the ratio of IA to CRIP is about 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000.

Combinations: Sea Anemone Toxins and Insecticidal Agents (IAs)

In some embodiments, a combination or composition comprises an Insecticidal Agent (IA) (e.g., one or more of IAs: B1-B479 in Table B), and one or more polypeptides derived from a sea anemone. For example, in some embodiments, the sea anemone polypeptides can be isolated from: Actinia equina; Anemonia erythraea; Anemonia sulcata; Anemonia viridis; Anthopleura elegantissima; Anthopleura fuscoviridis; Anthopleura xanthogrammica; Bunodosoma caissarum; Bunodosoma cangicum; Bunodosoma granulifera; Heteractis crispa; Parasicyonis actinostoloides; Radianthus paumotensis; or Stoichactis helianthus. In yet other embodiments, the sea anemone toxin can be Av2; an Av3; or a variant thereof.

In some embodiments, a combination or composition comprises an Insecticidal Agent (IA) (e.g., one or more of IAs: B1-B479 in Table B), and one or more of the following sea anemone toxins: Toxin AETX-1 (AETX I), Toxin APETx1, Toxin APETx2, Antihypertensive protein BDS-1 (Blood depressing substance I), Antihypertensive protein BDS-2 (Blood depressing substance II), Neurotoxin Bg-2 (Bg II), Neurotoxin Bg-3 (Bg III), Toxin APE 1-1, Toxin APE 1-2, Neurotoxin-1 (Toxin ATX-I), Neurotoxin-1 (Neurotoxin I), Neurotoxin 1 (Toxin RTX-I), Neurotoxin 1 (Toxin SHP-I), Toxin APE 2-1, Toxin APE 2-2, Neurotoxin-2 (Toxin ATX-II), (aka AV2)Neurotoxin-2 (Toxin AFT-II), Neurotoxin 2 (Toxin RTX-II), Neurotoxin 2 (Neurotoxin II), Neurotoxin 3 homolog (Neurotoxin III homolog), Neurotoxin 3 (Toxin RTX-III), Neurotoxin 3 (Neurotoxin-III), Neurotoxin 4 (Toxin RTX-IV), Neurotoxin-5 (Toxin ATX-V), Neurotoxin 5 (Toxin RTX-V), Anthopleurin-A (Toxin AP-A), Anthopleurin-B (Toxin AP-B), Anthopleurin-C (Toxin AP-C), Potassium channel toxin Aek, Potassium channel toxin Bgk, Major neurotoxin BcIII, Neurotoxin BcIV, Cangitoxin (CGTX), Potassium channel toxin ShK, Toxin PCR1 (PCR1-2), Toxin PCR2 (PCR2-5), Toxin PCR3 (PCR2-1), Toxin PCR4 (PCR2-10), Toxin PCR6 (PCR3-7), Cangitoxin-2 (Cangitoxin II), or Cangitoxin-3 (Cangitoxin III).

In some embodiments, a combination or composition comprises an Insecticidal Agent (IA) (e.g., one or more of IAs: B1-B479 in Table B), and one or more sea anemone polypeptides having an amino acid sequence as set forth in SEQ ID NOs: 371-411.

In some embodiments, a combination or composition comprises an Insecticidal Agent (IA) (e.g., one or more of IAs: B1-B479 in Table B), and one or more polypeptides derived from the sea anemone, Anemonia viridis, which possesses a variety of toxins that it uses to defend itself. One of the toxins derived from Anemonia viridis is the neurotoxin “Av3.” Av3 is a type III sea anemone toxin that inhibits the inactivation of voltage-gated sodium (Na t) channels at receptor site 3, resulting in contractile paralysis. The binding of an Av3 toxin to site 3 results in the inactivated state of the sodium channel to become destabilized, which in turn causes the channel to remain in the open position (see Blumenthal et al., Voltage-gated sodium channel toxins: poisons, probes, and future promise. Cell Biochem Biophys. 2003; 38(2):215-38). Av3 shows high selectivity for crustacean and insect sodium channels, and low selectivity for mammalian sodium channels (see Moran et al., Sea anemone toxins affecting voltage-gated sodium channels—molecular and evolutionary features, Toxicon. 2009 Dec. 15; 54(8): 1089-1101).

An exemplary Av3 polypeptide from Anemonia viridis is provided having the amino acid sequence of SEQ ID NO:44. The ratio of AVP to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of AVP and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, a combination or composition comprises a Insecticidal Agent (IA) (e.g., one or more of IAs: B1-B479 in Table B) and one or more polypeptides derived from the sea anemone Av3, for example, one or more of the Av3 variant polypeptide (AVP) can have the following amino acid variation from SEQ ID NO:44: an N-terminal amino acid substitution of R1K relative to SEQ ID NO:44, changing the polypeptide sequence from the wild-type “RSCCPCYWGGCPWGQNCYPEGCSGPKV” to “KSCCPCYWGGCPWGQNCYPEGCSGPKV” (SEQ ID NO:45); C-terminal amino acid can be deleted relative to SEQ ID NO:44, changing the polypeptide sequence from the wild-type “RSCCPCYWGGCPWGQNCYPEGCSGPKV” to “RSCCPCYWGGCPWGQNCYPEGCSGPK” (SEQ ID NO:46); and/or an N-terminal mutation and a C-terminal mutation, wherein the N-terminal amino acid can have a substitution of R1K relative to SEQ ID NO:44, and the C-terminal amino acid can be deleted relative to SEQ ID NO:44, changing the polypeptide sequence from the wild-type “RSCCPCYWGGCPWGQNCYPEGCSGPKV” to “KSCCPCYWGGCPWGQNCYPEGCSGPK” (SEQ ID NO:47).

The ratio of AVP to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of AVP and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, the method of controlling an insect comprises: applying AVP to an insect; and applying an Insecticidal Agent (IA) (e.g., one or more of IAs: B1-B479 in Table B) to said insect. The foregoing application can be applied concomitantly and/or sequentially, and either in the same or separate compositions. In some embodiments, AVP and the Insecticidal Agent (IA) (e.g., one or more of IAs: B1-B479 in Table B) may be applied to insecticidal-resistant insects (e.g., Bt-resistant insects). The ratio of AVP to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of AVP and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, an illustrative Av3 peptide or variant thereof is described in the Applicant's PCT application (Application No. PCT/US19/51093) filed Sep. 13, 2019, entitled “Av3 Mutant Insecticidal Polypeptides and Methods for Producing and Using Same,” the disclosure of which, and the disclosure of Av3 peptides or variants thereof, are described and are incorporated by reference herein in its entirety.

In some embodiments, a combination or composition comprises an Insecticidal Agent (IA) (e.g., one or more of IAs: B1-B479 in Table B), and one or more sea anemone peptides having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 44-47, and 371-411.

Combinations: Spider Toxins and Insecticidal Agents (IAs)

In some embodiments, a combination or composition comprises an Insecticidal Agent (IA) (e.g., one or more of IAs: B1-B479 in Table B) and one or more polypeptides derived, isolated, and/or originating from a spider.

In some embodiments, the spider toxin can be isolated from one of the following species: Phoneutria nigriventer; Allagelena opulenta; Cupiennius salei; Plectreurys tristis; Coremiocnemis vanda; Haplopelma huwenum; Agelena orientalis; Allagelena opulenta; Segestria florentina; Apomastus schlingeri; Phoneutria keyserlingi; Macrothele gigas; Macrothele raveni; Missulena bradleyi; Pireneitega luctuosa; Phoneutria reidyi; Illawara wisharti; Eucratoscelus constrictus; Agelenopsis aperta; Hololena curta; Oxyopes lineatus; Brachypelma albiceps; or Brachypelma smithi.

In some embodiments, the spider toxin can be isolated from Hadronyche versuta (also known as the Blue Mountain funnel web spider), Hadronyche venenata, Atrax robustus, Atrax formidabilis, or Atrax infensus.

In some embodiments, an Insecticidal Agent (IA) (e.g., one or more of IAs: B1-B479 in Table B) can be combined with one or more of the following one of the following spider toxins: U13-ctenitoxin-Pn1a, U13-ctenitoxin-Pn1b,U13-ctenitoxin-Pn1c, U1-agatoxin-Aop1a, U1-ctenitoxin-Cs1a, U1-nemetoxin-Csp1a, U1-nemetoxin-Csp1b, U1-nemetoxin-Csp1c, U1-plectoxin-Pt1a, U1-plectoxin-Pt1b, U1-plectoxin-Pt1c, U1-plectoxin-Pt1d, U1-plectoxin-Pt1f, U1-theraphotoxin-Cv1a, U1-theraphotoxin-Hh1a_1, U1-theraphotoxin-Hh1a_2, U1-theraphotoxin-Hh1a_3, U1-theraphotoxin-Hh1b, U1-theraphotoxin-Hh1c_1, U1-theraphotoxin-Hh1c_2, U1-theraphotoxin-Hh1d, U1-theraphotoxin-Hh1e, U1-theraphotoxin-Hh1f_1, U1-theraphotoxin-Hh1f_2, U1-theraphotoxin-Hh1f_3, U1-theraphotoxin-Hh1f_4, U1-theraphotoxin-Hh1g, U2-agatoxin-Ao1a, U2-agatoxin-Aop1a, U2-ctenitoxin-Cs1a, U2-ctenitoxin-Pn1a, U2-cyrtautoxin-As1a, U2-segestritoxin-Sf1a, U2-segestritoxin-Sf1b, U2-segestritoxin-Sf1c, U2-segestritoxin-Sf1d, U2-segestritoxin-Sf1e, U2-segestritoxin-Sf1f, U2-segestritoxin-Sf1g, U2-segestritoxin-Sf1h, U2-theraphotoxin-Hh1a, U3-cyrtautoxin-As1a, U3-plectoxin-Pt1a, U5-ctenitoxin-Pn1a, U7-ctenitoxin-Pk1a, β-hexatoxin-Mg1a, β-hexatoxin-Mr1a, Γ-ctenitoxin-Pn1a, δ-actinopoditoxin-Mb1a, δ-Amaurobitoxin-Pl1a, δ-Amaurobitoxin-Pl1b, δ-Amaurobitoxin-Pl1c, δ-Amaurobitoxin-Pl1d, δ-ctenitoxin-Asp2e, δ-ctenitoxin-Pn1a_1, δ-ctenitoxin-Pn1a_2, δ-ctenitoxin-Pn1b, δ-ctenitoxin-Pn2a, δ-ctenitoxin-Pn2b, δ-ctenitoxin-Pn2cδ-ctenitoxin-Pr2d, δ-hexatoxin-Aria, δ-hexatoxin-Hv1a, δ-hexatoxin-Hv1b, δ-hexatoxin-Iw1a, δ-hexatoxin-Mg1a, δ-hexatoxin-Mg1b, κ-hexatoxin-Hf1a, κ-hexatoxin-Hv1a, κ-hexatoxin-Hv1b, hexatoxin-Hv1c_1, κ-hexatoxin-Hv1c_2, κ-hexatoxin-Hv1c_3, κ-hexatoxin-Hv1c_4, κ-hexatoxin-Hv1d, κ-hexatoxin-Hv1e, κ-theraphotoxin-Ec2a, κ-theraphotoxin-Ec2b, μ-agatoxin-Aa1a, μ-agatoxin-Aa1b, μ-agatoxin-Aa1c, μ-agatoxin-Aa1d, μ-agatoxin-Aa1e, μ-agatoxin-Aa1f, μ-agatoxin-Hc1a, μ-agatoxin-Hc1b, μ-agatoxin-Hc1c, μ-hexatoxin-Mg1a, μ-hexatoxin-Mg1b, μ-hexatoxin-Mg1c, μ-hexatoxin-Mg2a, μ-theraphotoxin-Hh1a, ω-actinopoditoxin-Mb1a, ω-agatoxin-Aa4a, ω-agatoxin-Aa4b, ω-agatoxin-Aa4c, ω-hexatoxin-Ar1a_1, ω-hexatoxin-Aria 3, ω-hexatoxin-Ar1b_1, ω-hexatoxin-Ar1d_1, ω-hexatoxin-Ar1d_4, ω-hexatoxin-Ar1e_1 ω-hexatoxin-Ar1f, ω-hexatoxin-Ar1g_1, ω-hexatoxin-Ar1h, ω-hexatoxin-Ar2a, ω-hexatoxin-Ar2b, ω-hexatoxin-Ar2c, ω-hexatoxin-Ar2d, ω-hexatoxin-Ar2e_1, ω-hexatoxin-Ar2e_2, ω-atracotoxin-Asp2a, ω-hexatoxin-Asp2b, ω-hexatoxin-Hf1a, ω-hexatoxin-Hi1a_1, ω-hexatoxin-Hi1a_2, ω-hexatoxin-Hi1a_3, ω-hexatoxin-Hilb 1, ω-hexatoxin-Hi1b_10, ω-hexatoxin-Hi1b_2, ω-hexatoxin-Hi1b_5, ω-hexatoxin-Hi1b_8, ω-hexatoxin-Hi1c_1, ω-hexatoxin-Hi1c_2, ω-hexatoxin-Hv1a, ω-hexatoxin-Hv1b, ω-hexatoxin-Hv1c, ω-hexatoxin-Hv1d, ω-hexatoxin-Hv1e, ω-hexatoxin-Hv1f, ω-hexatoxin-Hv1g_1, ω-hexatoxin-Hv1g_5ω-hexatoxin-Hv1g_6ω-hexatoxin-Hv2a, ω-hexatoxin-Hv2b_1, ω-hexatoxin-Hv2b_2, ω-hexatoxin-Hv2b_3, ω-hexatoxin-Hv2b_4, ω-hexatoxin-Hv2b_5, ω-hexatoxin-Hv2b_6, ω-hexatoxin-Hv2b_7, ω-hexatoxin-Hv2c, ω-hexatoxin-Hv2d_1, ω-hexatoxin-Hv2d_2, ω-hexatoxin-Hv2d_3, ω-hexatoxin-Hv2e, ω-hexatoxin-Hv2f, ω-hexatoxin-Hv2g, ω-hexatoxin-Hv2h_1, ω-hexatoxin-Hv2h_2, ω-hexatoxin-Hv2i, ω-hexatoxin-Hv2j_1, ω-hexatoxin-Hv2j_2, ω-hexatoxin-Hv2k, ω-hexatoxin-Hv2l, ω-hexatoxin-Hv2m_1, ω-hexatoxin-Hv2m_2, ω-hexatoxin-Hv2m_3, ω-hexatoxin-Hv2n, ω-hexatoxin-Hv2o, ω-hexatoxin-Hvn1a, ω-hexatoxin-Hvn1b_1, ω-hexatoxin-Hvn1b_2, ω-hexatoxin-Hvn1b_3, ω-hexatoxin-Hvn1b_4, ω-hexatoxin-Hvn1b_6, ω-hexatoxin-Iw2a, ω-oxotoxin-Ol1b, ω-plectoxin-Pt1a, ω-theraphotoxin-Asp1a, ω-theraphotoxin-Asp1f, ω-theraphotoxin-Asp1g, ω-theraphotoxin-Ba1a, ω-theraphotoxin-Ba1b, ω-theraphotoxin-Bs1a, ω-theraphotoxin-Bs2a, or ω-theraphotoxin-Hh2a.

In some embodiments, an Insecticidal Agent (IA) (e.g., one or more of IAs: B1-B479 in Table B) can be combined with one or more spider toxins having an amino acid as set forth in SEQ ID NOs: 192-278, and 281-370.

In some embodiments, an Insecticidal Agent (IA) (e.g., one or more of IAs: B1-B479 in Table B) can be combined with one or more ACTX peptides.

In some embodiments, an Insecticidal Agent (IA) (e.g., one or more of IAs: B1-B479 in Table B) can be combined with one or more of the following ACTX peptides: U-ACTX-Hv1a, U+2-ACTX-Hv1a, rU-ACTX-Hv1a, rU-ACTX-Hv1b, rκ-ACTX-Hv1c, co-ACTX-Hv1a, and/or ω-ACTX-Hv1a+2.

Exemplary ACTX peptides include: U-ACTX-Hv1a, having the amino acid sequence “QYCVPVDQPCSLNTQPCCDDATCTQERNENGHTVYYCRA” (SEQ ID NO: 60); U+2-ACTX-Hv1a, having the amino acid sequence “GSQYCVPVDQPCSLNTQPCCDDATCTQERNENGHTVYYCRA” (SEQ ID NO: 61); Omega-ACTX-Hv1a, having the amino acid sequence “SPTCIPSGQPCPYNENCCSQSCTFKENENGNTVKRCD” (SEQ ID NO: 62); Omega-hexatoxin-Ar1d, having the amino acid sequence “GSSPTCIPSGQPCPYNENCCSQSCTFKENENGNTVKRCD” (SEQ ID NO: 63); and Kappa-hexatoxin-Hv1c, having the amino acid sequence “GSAICTGADRPCAACCPCCPGTSCKAESNGVSYCRKDEP” (SEQ ID NO: 64).

In some embodiments, an Insecticidal Agent (IA) (e.g., one or more of IAs: B1-B7, B9-B40, and B42-B479 in Table B) can be combined with one or more of the aforementioned exemplary ACTX peptides.

In some embodiments, a combination or composition comprises an Insecticidal Agent (IA) (e.g., one or more of IAs: B1-B479 in Table B), and one or more U-ACTX peptides, Omega-ACTX peptides, and/or Kappa-ACTX peptides. The ratio of ACTX peptides to Insecticidal Agent (IA) (e.g., one or more of IAs: B1-B7, B9-B40, and B42-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of ACTX and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, the method of controlling an insect comprises: applying an ACTX peptide to an insect; and applying an Insecticidal Agent (IA) (e.g., one or more of IAs: B1-B479 in Table B) to said insect. The foregoing application can be applied concomitantly and/or sequentially, and either in the same or separate compositions. In some embodiments, ACTX peptide and the Insecticidal Agent (IA) (e.g., one or more of IAs: B1-B479 in Table B) may be applied to insecticidal-resistant insects (e.g., Bt-resistant insects). The ratio of ACTX peptide to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of ACTX peptide and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, a combination or composition comprises an Insecticidal Agent (IA) (e.g., one or more of IAs: B1-B479 in Table B) and one or more spider toxins having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 192-278 and 281-370.

In some embodiments, a combination or composition comprises an Insecticidal Agent (IA) (e.g., one or more of IAs: B1-B7, B9-B40, and B42-B479 in Table B) and one or more ACTX peptides having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 60-64, and 594.

Γ-CNTX-Pn1a and Insecticidal Agents (IAs)

In some preferred embodiments, an Insecticidal Agent (IA) (e.g., one or more of IAs: B1-B479 in Table B) can be combined with one or more Γ-CNTX-Pn1a or γ-CNTX-Pn1a toxins. The Γ-CNTX-Pn1a peptide is an insecticidal neurotoxin derived from the Brazilian armed spider, Phoneutria nigriventer. Γ-CNTX-Pn1a targets the N-methyl-D-aspartate (NMDA)-subtype of ionotropic glutamate receptor (GRIN), and sodium channels. An exemplary Γ-CNTX-Pn1a peptide has an amino acid sequence of

(SEQ ID NO: 65)
MKVAIVFLSLLVLAFASESIEENREEFPVEESARCADINGACKSDCDCC
GDSVTCDCYWSDSCKCRESNFKIGMAIRKKFC.

In some embodiments, the method of controlling an insect comprises: applying Γ-CNTX-Pn1a to an insect; and applying an IA to said insect. The foregoing application can be applied concomitantly and/or sequentially, and either in the same or separate compositions. In some embodiments, Γ-CNTX-Pn1a and Insecticidal Agent (IA) (e.g., one or more of IAs: B1-B479 in Table B) may be applied to (Γ-CNTX-Pn1a)-resistant insects. In some embodiments, Γ-CNTX-Pn1a and Insecticidal Agent (IA) (e.g., one or more of IAs: B1-B479 in Table B) may be applied to (Bt toxin)-resistant insects. The ratio of F-CNTX-Pn1a to IA, on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of Γ-CNTX-Pn1a and TVP in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, the combination or composition comprises both a F-CNTX-Pn1a and an Insecticidal Agent (IA) (e.g., one or more of IAs: B1-B479 in Table B). The combination or composition can be in the ratio of Γ-CNTX-Pn1a to Insecticidal Agent (IA) (e.g., one or more of IAs: B1-B479 in Table B), on a dry weight basis, from about any or all of the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. In some embodiments, the composition can have a ratio of Γ-CNTX-Pn1a to Insecticidal Agent (IA) (e.g., one or more of IAs: B1-B479 in Table B), on a on a dry weight basis, selected from about the following ratios: 0:50, 45:55, 40:60, 35:65, 30:70, 25:75, 20:80, 15:85, 10:90, 5:95, 1:99, 0.5:99.5, 0.1:99.9 and 0.01:99.99 or any combination of any two of these values.

In some embodiments, a combination or composition comprises an Insecticidal Agent (IA) (e.g., one or more of IAs: B1-B479 in Table B) and one or more F-CNTX-Pn1a peptides having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 65.

Wild-Type U1-Agatoxins, TVPs, and Insecticidal Agents (IAs)

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP has one amino acid substitution at X₁, X₂, X₃, X₄, or X₅.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP has one amino acid substitution at X₁, X₂, X₃, X₄, or X₅; and wherein X₇ is Glycine.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP has one amino acid substitution at X₁, X₂, X₃, X₄, or X₅; and wherein X₇ is absent.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP has one amino acid substitution at X₁, X₂, X₃, X₄, or X₅; and wherein X₆ and X₇ are absent.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP comprises an amino sequence as set forth in any one of SEQ ID NOs 2-15 or 49-53.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP is encoded by a polynucleotide sequence as set forth in any one of SEQ ID NOs 17-30 or 54-58, or a complementary nucleotide sequence thereof.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP further comprises a homopolymer or heteropolymer of two or more TVPs, wherein the amino acid sequence of each TVP is the same or different.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP is a fused protein comprising two or more TVPs separated by a cleavable or non-cleavable linker, and wherein the amino acid sequence of each TVP may be the same or different.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein the TVP is a fused protein comprising two or more TVPs separated by a cleavable or non-cleavable linker, and wherein the amino acid sequence of each TVP may be the same or different, and wherein the linker is cleavable inside the gut or hemolymph of an insect.

In some embodiments, a combination or composition comprises an Insecticidal Agent (IA) (e.g., one or more of IAs: B1-B479 in Table B) and one or more TVPs comprising an amino acid sequence that is at least 90%, or at least 95%, or at least 96%, or at least 97%, or at least 98%, or at least 99%, or 100% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein if Z₁ is T then the TVP is glycosylated.

In some embodiments, a combination or composition comprises an Insecticidal Agent (IA) (e.g., one or more of IAs: B1-B479 in Table B) and one or more TVPs having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 2-15, 49-53, 2-15, 49-53, 621-622, 624-628, 631-640, 642-651, or 653-654.

In some embodiments, a combination or composition comprises an Insecticidal Agent (IA) (e.g., one or more of IAs: B1-B479 in Table B) and one or more Wild-Type U1-agatoxin-Ta1b peptides having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NO: 1.

Combinations: Scorpion Toxins and Insecticidal Agents (IAs)

In some embodiments, an Insecticidal Agent (IA) (e.g., one or more of IAs: B1-B479 in Table B) can be combined with one or more toxins isolated from a scorpion.

In some embodiments, a combination or composition comprises an Insecticidal Agent (IA) (e.g., one or more of IAs: B1-B479 in Table B) and one or more scorpion toxins selected from the following toxins: Imperatoxin-A (IpTxa), Potassium channel toxin alpha-KTx 10.2 (Cobatoxin-2), Potassium channel toxin alpha-KTx 11.1 (Parabutoxin-1), Potassium channel toxin alpha-KTx 11.2 (Parabutoxin-2), Potassium channel toxin alpha-KTx 11.3 (Parabutoxin-10), Potassium channel toxin alpha-KTx 12.1 (Butantoxin), Potassium channel toxin alpha-KTx 12.2 (Butantoxin), Potassium channel toxin alpha-KTx 12.3 (Butantoxin-like peptide), Potassium channel toxin alpha-KTx 15.1 (Peptide Aa1), Potassium channel toxin alpha-KTx 15.3 (Toxin AmmTX3), Potassium channel toxin alpha-KTx 15.6 (Discrepin), Potassium channel toxin alpha-KTx 16.1 (Tamulotoxin), Potassium channel toxin alpha-KTx 19.1 (Neurotoxin BmBKTx1), Potassium channel toxin alpha-KTx 1.3 (Iberiotoxin), Potassium channel toxin alpha-KTx 1.4 (Limbatotoxin), Potassium channel toxin alpha-KTx 1.7 (Lqh 15-1), Potassium channel toxin alpha-KTx 1.9 (Hongotoxin-2), Potassium channel toxin alpha-KTx 1.10 (Parabutoxin-3), Potassium channel toxin alpha-KTx 1.11 (Slotoxin), Potassium channel toxin alpha-KTx 1.13 (Charybdotoxin c), Potassium channel toxin alpha-KTx 2.1 (Noxiustoxin), Potassium channel toxin alpha-KTx 2.2 (Margatoxin), Potassium channel toxin alpha-KTx 2.3 (CllTx1), Potassium channel toxin alpha-KTx 2.4 (Noxiustoxin-2), Potassium channel toxin alpha-KTx 2.5 (Hongotoxin-1), Potassium channel toxin alpha-KTx 2.6 (Hongotoxin-3), Potassium channel toxin alpha-KTx 2.7 (CllTx2), Potassium channel toxin alpha-KTx 2.8 (Toxin Ce1), Potassium channel toxin alpha-KTx 2.9 (Toxin Ce2), Potassium channel toxin alpha-KTx 2.10 (Toxin Ce3), Potassium channel toxin alpha-KTx 2.11 (Toxin Ce4), Potassium channel toxin alpha-KTx 2.12 (Toxin Ce5), Potassium channel toxin alpha-KTx 3.1 (Kaliotoxin-1), Potassium channel toxin alpha-KTx 3.2 (Agitoxin-2), Potassium channel toxin alpha-KTx 3.3 (Agitoxin-3), Potassium channel toxin alpha-KTx 3.4 (Agitoxin-1), Potassium channel toxin alpha-KTx 3.7 (OsK-1), Potassium channel toxin alpha-KTx 3.8 (Charybdotoxin-like peptide Bs 6), Potassium channel toxin alpha-KTx 3.9 (Kaliotoxin-3), Potassium channel toxin alpha-KTx 4.1 (Tityustoxin K-alpha), Potassium channel toxin alpha-KTx 4.3 (Toxin TdK1), Potassium channel toxin alpha-KTx 4.4 (Toxin Tc30), Potassium channel toxin alpha-KTx 5.1 (Leiurotoxin-1), Potassium channel toxin alpha-KTx 5.2 (Leiurotoxin I-like toxin P05), Potassium channel toxin alpha-KTx 5.4 (Tamapin), Potassium channel toxin alpha-KTx 5.5 (Tamapin-2), Potassium channel toxin alpha-KTx 6.1 (Potassium channel-blocking toxin 1), Potassium channel toxin alpha-KTx 6.2 (Maurotoxin), Potassium channel toxin alpha-KTx 6.3 (Neurotoxin HsTX1), Potassium channel toxin alpha-KTx 6.12 (Anuroctoxin), Potassium channel toxin alpha-KTx 6.13 (Spinoxin), Potassium channel toxin alpha-KTx 6.14 (HgeTx1), Potassium channel toxin alpha-KTx 7.2 (Toxin PiTX-K-beta), Potassium channel toxin gamma-KTx 1.2 (Ergtoxin-like protein 1), Potassium channel toxin gamma-KTx 1.3 (Ergtoxin-like protein 1), Potassium channel toxin gamma-KTx 1.4 (Ergtoxin-like protein 1), Potassium channel toxin gamma-KTx 1.5 (Ergtoxin-like protein 1), Potassium channel toxin gamma-KTx 1.6 (Ergtoxin-like protein 1), Potassium channel toxin gamma-KTx 4.2 (Ergtoxin-like protein 5), Insectotoxin-I1. Small toxin (Peptide I), Insectotoxin-I3 (BeI3), Insectotoxin-I4 (BeI4), Insectotoxin-I5A, Neurotoxin 8 (Neurotoxin VIII), Probable toxin Lqh 8/6, Neurotoxin 9 (Neurotoxin IX), Maurocalcin (MCa), Chlorotoxin-like peptide Bs14 (Bs14), Chlorotoxin (CTX), Neurotoxin P2, Insectotoxin-I5 (BeI5), Potassium channel toxin alpha-KTx 6.15 (Hemitoxin), Toxin GaTx1, AahIT1, Phaiodotoxin, BaIT2, BotIT1, BotIT2, BmK M1, BmK-M2, BmK-M4, BmK-M7, BmK IT-AP, Bom3, Bom4, BjaIT, Bj-xtrIT, BjIT2, LqhaIT, Lqhb1, LqhIT2, LqhdprIT3a, Lgh-xtrIT, Lqh3, Lqh6, Lqh7, LqqIT1, LqqIT2, Lqq3, OD1, Ts1, Tz1, or combinations thereof.

In some embodiments, a combination or composition comprises an Insecticidal Agent (IA) (e.g., one or more of IAs: B1-B479 in Table B) and one or more scorpion toxins, wherein the scorpion toxin has an amino acid sequence as set forth in SEQ ID NOs: 88-191.

In some embodiments, a combination or composition comprises an Insecticidal Agent (IA) (e.g., one or more of IAs: B1-B479 in Table B) and one or more scorpion toxins, wherein the toxin can be an imperatoxin. Imperatoxins are peptide toxins derived from the venom of the African scorpion (Pandinus imperator).

In some embodiments, a combination or composition comprises an Insecticidal Agent (IA) (e.g., one or more of IAs: B1-B479 in Table B) and one or more imperatoxins.

In some embodiments, a combination or composition comprises an Insecticidal Agent (IA) (e.g., one or more of IAs: B1-B479 in Table B) and one or more imperatoxins, wherein the imperatoxin is Imperatoxin A (IpTx-a), or a variant thereof. In some embodiments, the IpTx-a has an amino acid sequence of

(SEQ ID NO: 66)
GDCLPHLKRCKADNDCCGKKCKRRGTNAEKRCR.

In some embodiments, the method of controlling an insect comprises: applying IpTx-a to an insect; and applying an Insecticidal Agent (IA) (e.g., one or more of IAs: B1-B479 in Table B) to said insect. The foregoing application can be applied concomitantly and/or sequentially, and either in the same or separate compositions. In some embodiments, IpTx-a and Insecticidal Agent (IA) (e.g., one or more of IAs: B1-B479 in Table B) may be applied to (IpTx-a)-resistant insects. In some embodiments, IpTx-a and

Insecticidal Agent (IA) (e.g., one or more of IAs: B1-B479 in Table B) may be applied to (Bt toxin)-resistant insects. The ratio of IpTx-a to IA, on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of IpTx-a and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, the combination or composition comprises both an IpTx-a and an Insecticidal Agent (IA) (e.g., one or more of IAs: B1-B479 in Table B). The combination or composition can be in the ratio of IpTx-a to Insecticidal Agent (IA) (e.g., one or more of IAs: B1-B479 in Table B), on a dry weight basis, from about any or all of the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. In some embodiments, the combination or composition can have a ratio of IpTx-a to Insecticidal Agent (IA) (e.g., one or more of IAs: B1-B479 in Table B), on a on a dry weight basis, selected from about the following ratios: 0:50, 45:55, 40:60, 35:65, 30:70, 25:75, 20:80, 15:85, 10:90, 5:95, 1:99, 0.5:99.5, 0.1:99.9 and 0.01:99.99 or any combination of any two of these values.

In some embodiments, an Insecticidal Agent (IA) (e.g., one or more of IAs: B1-B479 in Table B) can be combined with one or more AaIT1 toxins. The protein toxin, AalT1, is a sodium channel site 4 toxin from North African desert scorpion (Androctonus australis). An exemplary AaIT1 toxin is a peptide having the amino acid sequence according to SEQ ID NO: 88 (NCBI accession No. P01497.2). AaIT1 is a site 4 toxin, which forces the insect sodium channel to open by lowering the activation reaction energy barrier.

In some embodiments, the method of controlling an insect comprises: applying AaIT1 to an insect; and applying an Insecticidal Agent (IA) (e.g., one or more of IAs: B1-B479 in Table B) to said insect. The foregoing application can be applied concomitantly and/or sequentially, and either in the same or separate compositions. In some embodiments, AaIT1 and the Insecticidal Agent (IA) (e.g., one or more of IAs: B1-B479 in Table B) may be applied to (AaIT1)-resistant insects. In some embodiments, AaIT1 and the Insecticidal Agent (IA) (e.g., one or more of IAs: B1-B479 in Table B) may be applied to (Bt toxin)-resistant insects. The ratio of AaIT1 to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of AaIT1 and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, a combination or composition comprises an Insecticidal Agent (IA) (e.g., one or more of IAs: B1-B479 in Table B) and one or more scorpion peptides or scorpion toxins having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in SEQ ID NOs: 66, 88-191.

Combinations: Conotoxins and Insecticidal Agents (IAs)

Conotoxins are toxins isolated from cone shells; these toxins act by interfering with neuronal communication. Examples of conotoxins include the α-, ω-, μ-, δ-, and κ-conotoxins. Briefly, the α-conotoxins (and αA- & φ-conotoxins) target nicotinic ligand gated channels; ω-conotoxins target voltage-gated calcium channels; μ-conotoxins target the voltage-gated sodium channels; δ-conotoxins target the voltage-gated sodium channel; and κ-conotoxins target the voltage-gated potassium channel.

In some embodiments, an Insecticidal Agent (IA) (e.g., one or more of IAs: B1-B479 in Table B), can be combined with one or more peptides isolated from organisms belonging to the Conus genus.

In some embodiments, an Insecticidal Agent (IA) (e.g., one or more of IAs: B1-B479 in Table B) can be combined with one or more peptides isolated from organisms belonging to the Conus genus, wherein the peptide isolated is a conotoxin.

In some embodiments, an Insecticidal Agent (IA) (e.g., one or more of IAs: B1-B479 in Table B) can be combined with one or more peptides isolated from Conus amadis; Conus catus; Conus ermineus; Conus geographus; Conus gloriamaris; Conus kinoshitai; Conus magus; Conus marmoreus; Conus purpurascens; Conus stercusmuscarum; Conus striatus; Conus textile; or Conus tulipa.

In some embodiments, an Insecticidal Agent (IA) (e.g., one or more of IAs: B1-B479 in Table B) can be combined with one or more α-conotoxin, αA-conotoxin, φ-conotoxins, ω-conotoxin, μ-conotoxin, δ-conotoxin, or κ-conotoxin.

In some embodiments, the method of controlling an insect comprises: applying a conotoxin to an insect; and applying an Insecticidal Agent (IA) (e.g., one or more of IAs: B1-B479 in Table B) to said insect. The foregoing application can be applied concomitantly and/or sequentially, and either in the same or separate compositions. In some embodiments, conotoxin and Insecticidal Agent (IA) (e.g., one or more of IAs: B1-B479 in Table B) may be applied to (conotoxin)-resistant insects. In some embodiments, conotoxin and Insecticidal Agent (IA) (e.g., one or more of IAs: B1-B479 in Table B) may be applied to (Bt toxin)-resistant insects. The ratio of conotoxin to Insecticidal Agent (IA) (e.g., one or more of IAs: B1-B479 in Table B), on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of conotoxin and Insecticidal Agent (IA) (e.g., one or more of IAs: B1-B479 in Table B) in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, the combination or composition comprises both a conotoxin and an Insecticidal Agent (IA) (e.g., one or more of IAs: B1-B479 in Table B). The combination or composition can be in the ratio of conotoxin to Insecticidal Agent (IA) (e.g., one or more of IAs: B1-B479 in Table B), on a dry weight basis, from about any or all of the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. In some embodiments, the combination or composition can have a ratio of conotoxin to Insecticidal Agent (IA) (e.g., one or more of IAs: B1-B479 in Table B), on a on a dry weight basis, selected from about the following ratios: 0:50, 45:55, 40:60, 35:65, 30:70, 25:75, 20:80, 15:85, 10:90, 5:95, 1:99, 0.5:99.5, 0.1:99.9 and 0.01:99.99 or any combination of any two of these values.

Combinations: Fungi/Fungal Toxins and CRIPs

In some embodiments, a combination or composition of the present invention comprises one or more CRIPs (e.g. one or more of CRIPs: A1-A68 in Table A) and one or more Insecticidal Agents (IAs), wherein the IA is

In some embodiments, a combination or composition of the present invention comprises one or more CRIPs (e.g. one or more of CRIPs: A1-A68 in Table A) and one or more Insecticidal Agents (IAs), wherein the IA is

In some embodiments, a combination or composition of the present invention comprises one or more CRIPs (e.g. one or more of CRIPs: A1-A68 in Table A) and one or more Insecticidal Agents (IAs), wherein the IA is an entomopathogenic fungi.

In some embodiments, a combination or composition of the present invention comprises one or more CRIPs (e.g. one or more of CRIPs: A1-A68 in Table A) and one or more Insecticidal Agents (IAs), wherein the IA is a peptide, protein, or toxin produced from an entomopathogenic fungi.

In some embodiments, a combination or composition of the present invention comprises one or more CRIPs (e.g. one or more of CRIPs: A1-A68 in Table A) and one or more Insecticidal Agents (IAs), wherein the IA is an Ascomycete fungal toxin.

In some embodiments, a combination or composition of the present invention comprises one or more CRIPs (e.g. one or more of CRIPs: A1-A68 in Table A) and one or more Insecticidal Agents (IAs), wherein the IA is a Cordycipitaceae family fungal toxin.

In some embodiments, a combination or composition of the present invention comprises one or more CRIPs (e.g. one or more of CRIPs: A1-A68 in Table A) and one or more Insecticidal Agents (IAs), wherein the IA is a Akanthomyces toxin; a Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, a combination or composition of the present invention comprises one or more CRIPs (e.g. one or more of CRIPs: A1-A68 in Table A) and one or more Insecticidal Agents (IAs), wherein the IA is a fungi organism or toxin therefrom, selected from the following genera: Beauveria; Metarhizium; Paecilomyces; Lecanicillium; Nomuraea; Isaria; Hirsutella; Sorosporella; Aspergillus; Cordiceps; Entomophthora; Zoophthora; Pandora; Entomophaga; Conidiobolus and Basidiobolus.

In some embodiments, a combination or composition of the present invention comprises one or more CRIPs (e.g. one or more of CRIPs: A1-A68 in Table A) and one or more Insecticidal Agents (IAs), wherein the IA is a Beauveria toxin.

In some embodiments, a combination or composition of the present invention comprises one or more CRIPs (e.g. one or more of CRIPs: A1-A68 in Table A) and one or more Insecticidal Agents (IAs), wherein the IA is one of the following toxins: a Beauveria alba toxin; a Beauveria amorpha toxin; a Beauveria arenaria toxin; a Beauveria asiatica toxin; a Beauveria australis toxin; a Beauveria bassiana toxin; a Cordyceps bassiana toxin; a Beauveria brongniartii toxin; a Beauveria brumptii toxin; a Beauveria caledonica toxin; a Beauveria chiromensis toxin; a Beauveria coccorum toxin; a Beauveria cretacea toxin; a Beauveria cylindrospora toxin; a Beauveria delacroixii toxin; a Beauveria densa toxin; a Beauveria dependens toxin; a Beauveria doryphorae toxin; a Beauveria effusa toxin; a Beauveria epigaea toxin; a Beauveria felina toxin; a Beauveria geodes toxin; a Beauveria globulifera toxin; a Beauveria heimii toxin; a Beauveria hoplocheli toxin; a Beauveria kipukae toxin; a Beauveria laxa toxin; a Beauveria malawiensis toxin; a Beauveria medogensis toxin; a Beauveria melolonthae toxin; a Beauveria nubicola toxin; a Beauveria oryzae toxin; a Beauveria paradoxa toxin; a Beauveria paranensis toxin; a Beauveria parasitica toxin; a Beauveria petelotii toxin; a Beauveria pseudobassiana toxin; a Beauveria rileyi toxin; a Beauveria rubra toxin; a Beauveria shiotae toxin; a Beauveria sobolifera toxin; a Beauveria spicata toxin; a Beauveria stephanoderis toxin; a Beauveria sulfurescens toxin; a Beauveria sungii toxin; a Beauveria tenella toxin; a Beauveria tundrensis toxin; a Beauveria velata toxin; a Beauveria varroae toxin; a Beauveria vermiconia toxin; a Beauveria vexans toxin; a Beauveria viannai toxin; or a Beauveria virella toxin.

In some embodiments, a combination or composition of the present invention comprises one or more CRIPs (e.g. one or more of CRIPs: A1-A68 in Table A) and one or more Insecticidal Agents (IAs), wherein the IA is a Beauveria bassiana toxin

In some embodiments, a combination or composition of the present invention comprises one or more CRIPs (e.g. one or more of CRIPs: A1-A68 in Table A) and one or more Insecticidal Agents (IAs), wherein the IA is a beauvericin.

In some embodiments, a combination or composition of the present invention comprises one or more CRIPs (e.g. one or more of CRIPs: A1-A68 in Table A) and one or more Insecticidal Agents (IAs), wherein the IA is a beauvericin having the chemical formula C₄₅H₅₇N₃ 09.

In some embodiments, a combination or composition of the present invention comprises one or more CRIPs (e.g. one or more of CRIPs: A1-A68 in Table A) and one or more Insecticidal Agents (IAs), wherein the IA is a “Beauvericin A” toxin having the chemical formula C₄₆H₅₉N₃O₉.

In some embodiments, a combination or composition of the present invention comprises one or more CRIPs (e.g. one or more of CRIPs: A1-A68 in Table A) and one or more Insecticidal Agents (IAs), wherein the IA is a “Beauvericin B” toxin having the chemical formula C₄₇H₆₁N₃O₉.

In some embodiments, a combination or composition of the present invention comprises one or more CRIPs (e.g. one or more of CRIPs: A1-A68 in Table A) and one or more Insecticidal Agents (IAs), wherein the IA is a Beauveria bassiana strain ANT-03 spore.

In some embodiments, a combination or composition of the present invention comprises one or more CRIPs (e.g. one or more of CRIPs: A1-A68 in Table A) and one or more Insecticidal Agents (IAs), wherein the IA is an Ascomycete fungal toxin.

In some embodiments, a combination or composition of the present invention comprises one or more Insecticidal Agents (IAs), and one or more CRIPs (e.g. one or more of CRIPs: A1-A68 in Table A), wherein the IA is a Cordycipitaceae family fungal toxin.

In some embodiments, a combination or composition of the present invention comprises one or more Insecticidal Agents (IAs), and one or more CRIPs (e.g. one or more of CRIPs: A1-A68 in Table A), wherein the IA is an Akanthomyces toxin; a Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, a combination or composition of the present invention comprises one or more Insecticidal Agents (IAs), and one or more CRIPs (e.g. one or more of CRIPs: A1-A68 in Table A), wherein the IA is a Beauveria toxin.

Combinations: Lectins and CRIPs

In some embodiments, a combination of the present invention can comprise one or more IAs, and one or more CRIPs, wherein the IA is not fused nor operably linked to the CRIP, and wherein the IA is Galanthus nivalis agglutinin (GNA).

In some embodiments, a combination or composition of the present invention comprises one or more Insecticidal Agents (IAs), and one or more CRIPs (e.g. one or more of CRIPs: A1-A68 in Table A), wherein the IA is a lectin.

In some embodiments, a combination or composition of the present invention comprises one or more Insecticidal Agents (IAs), and one or more CRIPs (e.g. one or more of CRIPs: A1-A68 in Table A), wherein the IA is a lectin, wherein said lectin is not fused nor operably linked to the CRIP.

In some embodiments, a combination or composition of the present invention comprises one or more Insecticidal Agents (IAs), and one or more CRIPs (e.g. one or more of CRIPs: A1-A68 in Table A), wherein the IA is can be one of the following lectins: Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia simphcifolia-II (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); and/or Datura stramonium Lectin (DSL).

In some embodiments, a combination or composition of the present invention comprises one or more Insecticidal Agents (IAs), and one or more CRIPs (e.g. one or more of CRIPs: A1-A68 in Table A), wherein the IA is a lectin having an amino acid sequence selected from SEQ ID NOs: 35, 595-615, or a variant thereof.

In some embodiments, a combination or composition of the present invention comprises one or more Insecticidal Agents (IAs), and one or more CRIPs (e.g. one or more of CRIPs: A1-A68 in Table A), wherein the IA is one of the following lectins: Galanthus nivalis agglutinin (GNA) (SEQ ID NO: 35); Sambucus nigra (European elder) lectin (SNA) (SEQ ID NO: 596); Leukoagglutinating lectin from the seeds of Maackia amurensis (MAL) (SEQ ID NO: 597); Erythrina cristagalli lectin (ECL) (SEQ ID NO: 598); Ricinus communis agglutinin-I (RCA) (SEQ ID NO: 599); Peanut agglutinin (PNA) (SEQ ID NO: 600); Agglutinin isolectin 1 (WGA1) (SEQ ID NO: 601); Concanavalin-A (CNA) precursor (SEQ ID NO: 602); Jacalin-like lectin (Chain A) (SEQ ID NO: 603); Lectin alpha-1 chain (SEQ ID NO: 604); Lectin CaBo (SEQ ID NO: 605); Lectin ConGF (SEQ ID NO: 606); Mannose-specific lectin alpha chain (SEQ ID NO: 607); Beta-galactoside-specific lectin 1 (SEQ ID NO: 608); Galectin-3 (SEQ ID NO: 609); Mannose/glucose-specific lectin Cramoll (SEQ ID NO: 610); Beta-galactoside-specific lectin 3 (SEQ ID NO: 611); Lactose-binding lectin-2 (SEQ ID NO: 612); Galectin-1 (SEQ ID NO: 613); Alpha-N-acetylgalactosamine-specific lectin (SEQ ID NO: 614); Favin (SEQ ID NO: 615); or a combination thereof.

In some embodiments, a combination or composition of the present invention comprises one or more Insecticidal Agents (IAs), and one or more CRIPs (e.g. one or more of CRIPs: A1-A68 in Table A), wherein the IA may comprise an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to an amino acid sequence as set forth in any one of SEQ ID NOs: 35, 595-615.

Combinations: Chitinases and CRIPs

In some embodiments, a combination or composition of the present invention comprises one or more Insecticidal Agents (IAs), and one or more CRIPs (e.g. one or more of CRIPs: A1-A68 in Table A), wherein the IA is a chitinase.

In some embodiments, a combination or composition of the present invention comprises one or more Insecticidal Agents (IAs), and one or more CRIPs (e.g. one or more of CRIPs: A1-A68 in Table A), wherein the IA is a chitinase from Trichoderma viride.

In some embodiments, a combination or composition of the present invention comprises one or more Insecticidal Agents (IAs), and one or more CRIPs (e.g. one or more of CRIPs: A1-A68 in Table A), wherein the IA is a chitinase having an amino acid sequence as set forth in SEQ ID NO: 620.

In some embodiments, a combination or composition of the present invention comprises one or more Insecticidal Agents (IAs), and one or more CRIPs (e.g. one or more of CRIPs: A1-A68 in Table A), wherein the IA may be a chitinase comprising an amino acid sequence having at least 50%, at least 55%, at least 60%, at least 65%, at least 70%, at least 75%, at least 80%, at least 81%, at least 82%, at least 83%, at least 84%, at least 85%, at least 86%, at least 87%, at least 88%, at least 89%, at least 90%, at least 91%, at least 92%, at least 93%, at least 94%, at least 95%, at least 96%, at least 97%, at least 98%, at least 99%, at least 99.5%, at least 99.6%, at least 99.7%, at least 99.8%, at least 99.9%, or 100% amino acid sequence identity to an amino acid sequence as set forth in any one of SEQ ID NO: 620.

Combinations: Azadirachta indica Compounds and CRIPs

In some embodiments, a combination or composition of the present invention comprises one or more Insecticidal Agents (IAs), and one or more CRIPs (e.g. one or more of CRIPs: A1-A68 in Table A), wherein the IA is an Azadirachta indica compound.

In some embodiments, a combination or composition of the present invention comprises one or more Insecticidal Agents (IAs), and one or more CRIPs (e.g. one or more of CRIPs: A1-A68 in Table A), wherein the IA is an Azadirachtin; an Azadiradione; an Azadiradionolide; a Deacetylgedunin; a Deacetylazadirachtinol; a Desfuranoazadiradione; a Epoxyazadiradione; a Gedunin; a Mahmoodin; a Neemfruitin A; a Neemfruitin B; a Nimbolide; a Nimbin; a Nimolicinol; an Ohchinin Acetate; a Salannin; a Salannol; an alpha-Nimolactone; a beta-Nimolactone; a 2′,3′-Dihydrosalannin; a 3-Deacetylsalannin; a 6-Deacetylnimbin; a 7-Acetyl-16,17-dehydro-16-hydroxyneotrichilenone; a 7-Benzoylnimbocinol; a 7-Deacetyl-7-benzoylepoxyazadiradione; a 7-Deacetyl-7-benzoylgedunin; a 7-Deacetyl-17-epinimolicinol; a 15-Hydroxyazadiradione; a 17-Epi-17-Hydroxyazadiradione; a 17-Epiazadiradione; a 20,21,22,23-Tetrahydro-23-oxoazadirone; a 22,23-Dihydronimocinol; or a 28-Deoxonimbolide.

In some embodiments, a combination or composition of the present invention comprises one or more Insecticidal Agents (IAs), and one or more CRIPs (e.g. one or more of CRIPs: A1-A68 in Table A), wherein the IA is Azadirachtin.

In some embodiments, a combination or composition of the present invention comprises one or more Insecticidal Agents (IAs), and one or more CRIPs (e.g. one or more of CRIPs: A1-A68 in Table A), wherein the IA is an Azadirachtin having a chemical formula: C₃₅H₄₄O₁₆.

Combinations: Boron Compounds and CRIPs

In some embodiments, a combination or composition of the present invention comprises one or more Insecticidal Agents (IAs), and one or more CRIPs (e.g. one or more of CRIPs: A1-A68 in Table A), wherein the IA is a boron compound.

In some embodiments, a combination or composition of the present invention comprises one or more Insecticidal Agents (IAs), and one or more CRIPs (e.g. one or more of CRIPs: A1-A68 in Table A), wherein the IA is a boric acid, diboron tetrahydroxide, a borate, a boron oxide, a borane, or a combination thereof.

In some embodiments, a combination or composition of the present invention comprises one or more Insecticidal Agents (IAs), and one or more CRIPs (e.g. one or more of CRIPs: A1-A68 in Table A), wherein the IA is a borane and/or a borate ester that produces oxides of boron in aqueous media.

In some embodiments, a combination or composition of the present invention comprises one or more Insecticidal Agents (IAs), and one or more CRIPs (e.g. one or more of CRIPs: A1-A68 in Table A), wherein the IA is boric acid, a borate (e.g., basic sodium borate (borax)), or a combination of boric acid and a borate.

In some embodiments, a combination or composition of the present invention comprises one or more Insecticidal Agents (IAs), and one or more CRIPs (e.g. one or more of CRIPs: A1-A68 in Table A), wherein the IA is a borate.

In some embodiments, a combination or composition of the present invention comprises one or more Insecticidal Agents (IAs), and one or more CRIPs (e.g. one or more of CRIPs: A1-A68 in Table A), wherein the IA is one of the following: perborates, metaborates, tetraborates, octaborates, borate esters, metallic borates (e.g., sodium borate, zinc borate and potassium borate), di sodium tetraborate decahydrate, disodium octaborate tetrahydrate, sodium metaborate, sodium perborate monohydrate, disodium octaborate, sodium tetraborate pentahydrate, sodium tetraborate, copper metaborate, zinc borate, barium metaborate, or any combination thereof.

In some embodiments, a combination or composition of the present invention comprises one or more Insecticidal Agents (IAs), and one or more CRIPs (e.g. one or more of CRIPs: A1-A68 in Table A), wherein the IA is borax (e.g., sodium borate decahydrate-10 mol Na₂B₄O₇·10H₂O or sodium borate pentahydrate-5 mol Na₂B₄O₇·5H₂O).

In some embodiments, a combination or composition of the present invention comprises one or more Insecticidal Agents (IAs), and one or more CRIPs (e.g. one or more of CRIPs: A1-A68 in Table A), wherein the IA is a boron compound that may be utilized in effective amounts as substitutes for borax (or may be utilized in effective amounts in combination with borax or one another).

In some embodiments, a combination or composition of the present invention comprises one or more Insecticidal Agents (IAs), and one or more CRIPs (e.g. one or more of CRIPs: A1-A68 in Table A), wherein the IA is anhydrous borax (Na₂B₄O₇); ammonium tetraborate ((NH₄)₂B₄O₇·4H₂O); ammonium pentaborate ((NH₄)₂B₁₀O₁₆·8H₂O); potassium pentaborate (K2B₁₀O₁₆·8H₂O); potassium tetraborate (K2B₄O₇·4H₂O); sodium metaborate ((8 mol) Na₂B₂O₄·8H₂O); sodium metaborate ((4 mol) Na₂B₂O₄·4H₂O); disodium tetraborate decahydrate (Na₂B₄O₇·10H₂O); disodium tetraborate pentahydrate (Na₂B₄O₇·5H₂O); disodium octaborate tetrahydrate (Na₂B₈O₁₃·4H₂O); or combinations thereof.

In some embodiments, a combination or composition of the present invention comprises one or more Insecticidal Agents (IAs), and one or more CRIPs (e.g. one or more of CRIPs: A1-A68 in Table A), wherein the IA is a boron compound that is selected from the group consisting of: borax, boric acid, disodium octaborate, sodium borate, sodium metaborate, sodium tetraborate decahydrate, boron oxide, boron carbide, boron nitride, boron tribromide, boron trichloride, and boron trifluoride.

In some embodiments, a combination or composition of the present invention comprises one or more Insecticidal Agents (IAs), and one or more CRIPs (e.g. one or more of CRIPs: A1-A68 in Table A), wherein the IA is boric acid.

In some embodiments, a combination or composition of the present invention comprises one or more Insecticidal Agents (IAs), and one or more CRIPs (e.g. one or more of CRIPs: A1-A68 in Table A), wherein the IA is boric acid having a chemical formula of H₃BO₃.

Combinations: Viruses and CRIPs

In some embodiments, a combination or composition of the present invention comprises one or more Insecticidal Agents (IAs), and one or more CRIPs (e.g. one or more of CRIPs: A1-A68 in Table A), wherein the IA is an Ascoviridae family virus.

In some embodiments, a combination or composition of the present invention comprises one or more Insecticidal Agents (IAs), and one or more CRIPs (e.g. one or more of CRIPs: A1-A68 in Table A), wherein the IA is an ascovirus such as Heliothis virescens ascovirus 3a; Heliothis virescens ascovirus 3; Heliothis virescens ascovirus 3b; Heliothis virescens ascovirus 3c; Heliothis virescens ascovirus 3d; Heliothis virescens ascovirus 3e; Heliothis virescens ascovirus 3f; Heliothis virescens ascovirus 3g; Heliothis virescens ascovirus 3h; Heliothis virescens ascovirus 3j; Spodoptera frugiperda ascovirus 1a; Trichoplusia ni ascovirus 2a; Heliothis virescens ascovirus 3i; Spodoptera ascovirus; Spodoptera exigua ascovirus 5a; Spodoptera frugiperda ascovirus 1c; Spodoptera frugiperda ascovirus I d; Trichoplusia ni ascovirus 2b; Trichoplusia ni ascovirus 2c; Trichoplusia ni ascovirus 2d; or Trichoplusia ni ascovirus 6b.

In some embodiments, an IA can be a virus from the Ascoviridae family. For example, in some embodiments, an IA can be a toursvirus such as Diadromus pulchellus toursvirus; Diadromus pulchellus ascovirus 4a; or Dasineura jujubifolia toursvirus 2a.

In some embodiments, a combination or composition of the present invention comprises one or more Insecticidal Agents (IAs), and one or more CRIPs (e.g. one or more of CRIPs: A1-A68 in Table A), wherein the IA is a virus from the Densovirinae family.

In some embodiments, a combination or composition of the present invention comprises one or more Insecticidal Agents (IAs), and one or more CRIPs (e.g. one or more of CRIPs: A1-A68 in Table A), wherein the IA is an Ambidensovirus.

In some embodiments, a combination or composition of the present invention comprises one or more Insecticidal Agents (IAs), and one or more CRIPs (e.g. one or more of CRIPs: A1-A68 in Table A), wherein the IA is an Ambidensovirus selected from the following group: Asteroid ambidensovirus 1; Sea star-associated densovirus; Blattodean ambidensovirus 1; Periplaneta fuliginosa densovirus; Periplaneta fuliginosa densovirus Guo/2000; Blattodean ambidensovirus 2; Blattella germanica densovirus 1; Decapod ambidensovirus 1; Cherax quadricarinatus densovirus; Dipteran ambidensovirus 1; Culex pipiens densovirus; Hemipteran ambidensovirus 1; Planococcus citri densovirus; Hemipteran ambidensovirus 2; Dysaphis plantaginea densovirus; Hemipteran ambidensovirus 3; Myzus persicae densovirus; Myzus persicae nicotianae densovirus; Hymenopteran ambidensovirus 1; Solenopsis invicta densovirus; Lepidopteran ambidensovirus 1; Galleria mellonella densovirus; Junonia coenia densovirus; Junonia coenia densovirus pBRJ/1990; Mythimna loreyi densovirus; Pseudoplusia includens densovirus; Orthopteran ambidensovirus 1; Acheta domestica densovirus; unclassified Ambidensovirus; Tetranychus urticae-associated ambidensovirus; unclassified Densovirus; Ambidensovirus CaaDV1; Ambidensovirus CaaDV2; Atrato Denso-like virus; Atrato Denso-like virus 1; Densovirus SC1065; Densovirus SC1118; Densovirus SC116; Densovirus SC2121; Densovirus SC2209; Densovirus SC2228; Densovirus SC2886; Densovirus SC3749; Densovirus SC3908; Densovirus SC4092; Densovirus SC444; Densovirus SC525; Diaphorina citri densovirus; Diatraea saccharalis densovirus; Lupine feces-associated densovirus; and Lupine feces-associated densovirus 2.

In some embodiments, a combination or composition of the present invention comprises one or more Insecticidal Agents (IAs), and one or more CRIPs (e.g. one or more of CRIPs: A1-A68 in Table A), wherein the IA is a virus from the Entomopoxvirinae family.

In some embodiments, a combination or composition of the present invention comprises one or more Insecticidal Agents (IAs), and one or more CRIPs (e.g. one or more of CRIPs: A1-A68 in Table A), wherein the IA is an Alphaentomopoxvirus; Betaentomopoxvirus; Diachasmimorpha entomopoxvirus; Melanoplus sanguinipes entomopoxvirus; or some heretofore unclassified Entomopoxvirinae.

In some embodiments, a combination or composition of the present invention comprises one or more Insecticidal Agents (IAs), and one or more CRIPs (e.g. one or more of CRIPs: A1-A68 in Table A), wherein the IA is an Entomopoxvirinae family virus selected from the following group: Anomala cuprea entomopoxvirus; Adoxophyes honmai entomopoxvirus; Adoxophyes honmai entomopoxvirus ‘L’; Amsacta moorei entomopoxvirus; Choristoneura biennis entomopoxvirus; Choristoneura fumiferana entomopoxvirus; Choristoneura rosaceana entomopoxvirus; Choristoneura rosaceana entomopoxvirus ‘L’; Heliothis armigera entomopoxvirus; Mythimna separata entomopoxvirus; Mythimna separata entomopoxvirus ‘L’; unclassified Betaentomopoxvirus; Diachasmimorpha longicaudata entomopoxvirus; Melanoplus sanguinipes entomopoxvirus ‘0’; Anacridium aegyptium entomopoxvirus; Calliptamus italicus entomopoxvirus; Chironomus decorus entomopoxvirus; Gomphocerus sibiricus entomopoxvirus; Homona coffearia entomopoxvirus; Linepithema humile entomopoxvirus 1; Oedaleus asiaticus entomopoxvirus; and Pseudaletia separata entomopoxvirus.

In some embodiments, a combination or composition of the present invention comprises one or more Insecticidal Agents (IAs), and one or more CRIPs (e.g. one or more of CRIPs: A1-A68 in Table A), wherein the IA is an Iridoviridae family virus, e.g., an Iridovirus.

In some embodiments, a combination or composition of the present invention comprises one or more Insecticidal Agents (IAs), and one or more CRIPs (e.g. one or more of CRIPs: A1-A68 in Table A), wherein the IA is an Iridoviridae family virus selected from the following group: Tipula iridescent virus; Invertebrate iridescent virus 31; Armadillidium vulgare iridescent virus; Popillia japonica iridescent virus; Porcellio scaber iridescent virus; Invertebrate iridescent virus 6; Gryllus bimaculatus iridovirus; unclassified Iridovirus; Acetes erythraeus iridovirus; Anticarsia gemmatalis iridescent virus; Armadillidium decorum iridescent virus; Barramundi perch iridovirus; Bluegill sunfish iridovirus; Common ponyfish iridovirus; Crimson snapper iridovirus; Decapterus macrosoma iridovirus; Gazza minuta iridovirus; Invertebrate iridescent virus 16; Costelytra zealandica iridescent virus; Invertebrate iridescent virus 2; Sericesthis iridescent virus; Invertebrate iridescent virus 23; Heteronychus arator iridescent virus; Invertebrate iridescent virus 24; Apis cerana iridescent virus; Invertebrate iridescent virus 29; Tenebrio molitor iridescent virus; Iridovirus barramundi/Quang Ninh/VNM/2008; Iridovirus IV31; Japanese sea bass iridovirus; Lagocephalus sceleratus iridovirus; Lates calcarifer iridovirus; Leiognathus splendens iridovirus; Marble goby iridovirus; Orbiculate batfish iridovirus; Parapristipoma trilineatum iridovirus; Perch iridovirus 603-2/China; Polydactylus sextarius iridovirus; Porcellio siculoccidentalis iridescent virus; Pyrrhalta luteola iridescent virus; Rana temporaria United Kingdom iridovirus 1; Rana temporaria United Kingdom iridovirus 2; Silver sea bream iridovirus; Snakehead iridovirus; Stone flounder iridovirus 603-3/China; Stone flounder iridovirus 724/China; Sturgeon iridovirus; Synodus indicus iridovirus; and Trichoniscus panormidensis iridescent virus.

In some embodiments, a combination or composition of the present invention comprises one or more Insecticidal Agents (IAs), and one or more CRIPs (e.g. one or more of CRIPs: A1-A68 in Table A), wherein the IA is an Nudiviridae family virus, e.g., an Alphanudivirus, a Betanudivirus, or some heretofore unclassified Nudiviridae family virus.

In some embodiments, a combination or composition of the present invention comprises one or more Insecticidal Agents (IAs), and one or more CRIPs (e.g. one or more of CRIPs: A1-A68 in Table A), wherein the IA is an Nudiviridae family virus selected from the following group: Gryllus bimaculatus nudivirus; Oryctes rhinoceros nudivirus; Heliothis zea nudivirus; Helicoverpa zea nudivirus 2; Allomyrina virus; Drosophila innubila nudivirus; Drosophila nudivirus RLU-2011; Esparto virus; Homarus gammarus nudivirus; Kallithea virus; Macrobrachium nudivirus CN-SL2011; Mauternbach virus; Nilaparvata lugens endogenous nudivirus; Penaeus monodon nudivirus; Tipula oleracea nudivirus; and Tomelloso virus.

In some embodiments, a combination or composition of the present invention comprises one or more Insecticidal Agents (IAs), and one or more CRIPs (e.g. one or more of CRIPs: A1-A68 in Table A), wherein the IA is an Iflaviridae family virus selected from the following group: Antheraea pernyi iflavirus; Brevicoryne brassicae virus; Brevicoryne brassicae virus—UK; Deformed wing virus; Kakugo virus; VDV-1/DWV recombinant; Dinocampus coccinellae paralysis virus; Ectropis obliqua virus; Ectropis obliqua picorna-like virus; Infectious flacherie virus; Infectious flacherie virus isolate silkworm; Ixodes holocyclus iflavirus; Lygus lineolaris virus 1; Lymantria dispar iflavirus 1; Nilaparvata lugens honeydew virus 1; Perina nuda virus; Sacbrood virus; Sacbrood virus CSBV-LN/China/2009; Slow bee paralysis virus; Spodoptera exigua iflavirus 1; Spodoptera exigua iflavirus 2; Varroa destructor virus 1; unclassified Iflavirus; ACT flea iflavirus; Aedes vexans iflavirus; Armigeres iflavirus; Bat iflavirus; Bee iflavirus 1; Blackberry iflavirus A; Blackberry iflavirus B; Bombyx mori iflavirus; Breves iflavirus; Diamondback moth iflavirus; Formica exsecta virus 2; Haemaphysalis flava iflavirus; Heliconius erato iflavirus; Helicoverpa armigera iflavirus; Midge iflavirus 9000; Miniopterus fuliginosus iflavirus; Moku virus; Nasonia vitripennis virus; Pirizal iflavirus; Psammotettix alienus iflavirus 1; Rondonia iflavirus 1; Rondonia iflavirus 2; Scaphoideus titanus iflavirus 1; Scaphoideus titanus iflavirus 2; VDV-1/DWV recombinant 4; Vespa velutina Moku virus; or Xysticus cristatus iflavirus.

In some embodiments, a combination or composition of the present invention comprises one or more Insecticidal Agents (IAs), and one or more CRIPs (e.g. one or more of CRIPs: A1-A68 in Table A), wherein the IA is a virus from the Baculoviridae family.

In some embodiments, a combination or composition of the present invention comprises one or more Insecticidal Agents (IAs), and one or more CRIPs (e.g. one or more of CRIPs: A1-A68 in Table A), wherein the IA is an Alphabaculovirus, Betabaculovirus, Deltabaculovirus, Gammabaculovirus, or heretofore unclassified Baculoviridae virus.

In some embodiments, a combination or composition of the present invention comprises one or more Insecticidal Agents (IAs), and one or more CRIPs (e.g. one or more of CRIPs: A1-A68 in Table A), wherein the IA is a Alphabaculovirus virus selected from the following group: Adoxophyes honmai nucleopolyhedrovirus; Agrotis ipsilon multiple nucleopolyhedrovirus; Agrotis segetum nucleopolyhedrovirus A; Agrotis segetum nucleopolyhedrovirus B; Antheraea pernyi nucleopolyhedrovirus; Antheraea proylei nucleopolyhedrovirus; Philosamia cynthia ricini nucleopolyhedrovirus virus; Anticarsia gemmatalis multiple nucleopolyhedrovirus; Autographa californica multiple nucleopolyhedrovirus; Anagrapha falcifera MNPV; Autographa californica nucleopolyhedrovirus; Galleria mellonella MNPV; Plutella xylostella multiple nucleopolyhedrovirus; Rachiplusia nu MNPV; Rachiplusia ou MNPV; Bombyx mori nucleopolyhedrovirus; Bombyx mandarina nucleopolyhedrovirus; Bombyx mandarina nucleopolyhedrovirus S2; Bombyx mori nuclear polyhedrosis virus K1; Buzura suppressaria nucleopolyhedrovirus; Catopsilia pomona nucleopolyhedrovirus; Choristoneura fumiferana DEF multiple nucleopolyhedrovirus; Choristoneura fumiferana multiple nucleopolyhedrovirus; Choristoneura occidentalis alphabaculovirus; Choristoneura murinana nucleopolyhedrovirus; Choristoneura rosaceana nucleopolyhedrovirus; Chrysodeixis chalcites nucleopolyhedrovirus; Chrysodeixis chalcites SNPV TF1-A; Chrysodeixis includens nucleopolyhedrovirus; Pseudoplusia includens SNPV IE; Clanis bilineata nucleopolyhedrovirus; Dasychira pudibunda nucleopolyhedrovirus; Ectropis obliqua nucleopolyhedrovirus; Epiphyas postvittana nucleopolyhedrovirus; Euproctis pseudoconspersa nucleopolyhedrovirus; Helicoverpa armigera nucleopolyhedrovirus; Helicoverpa armigera NPV NNg1; Helicoverpa armigera NPV strain Australia; Helicoverpa armigera nucleopolyhedrovirus G4; Helicoverpa armigera SNPV; Helicoverpa SNPV AC53; Helicoverpa zea single nucleopolyhedrovirus; Hemileuca species nucleopolyhedrovirus;

Hemileuca sp. nucleopolyhedrovirus; Hyphantria cunea nucleopolyhedrovirus; Lambdina fiscellaria nucleopolyhedrovirus; Leucania separata nucleopolyhedrovirus; Lonomia obliqua nucleopolyhedrovirus; Lonomia obliqua multiple nucleopolyhedrovirus; Lymantria dispar multiple nucleopolyhedrovirus; Lymantria xylina nucleopolyhedrovirus; Mamestra brassicae multiple nucleopolyhedrovirus; Mamestra configurata nucleopolyhedrovirus A; Mamestra configurata nucleopolyhedrovirus B; Helicoverpa armigera multiple nucleopolyhedrovirus; Maruca vitrata nucleopolyhedrovirus; Mythimna unipuncta nucleopolyhedrovirus; Operophtera brumata nucleopolyhedrovirus; Orgyia leucostigma nucleopolyhedrovirus; Orgyia pseudotsugata multiple nucleopolyhedrovirus; Oxyplax ochracea nucleopolyhedrovirus; Perigonia lusca nucleopolyhedrovirus; Perigonia lusca single nucleopolyhedrovirus; Spodoptera exigua multiple nucleopolyhedrovirus; Spodoptera exigua nuclear polyhedrosis virus (strain US); Spodoptera frugiperda multiple nucleopolyhedrovirus; Spodoptera littoralis nucleopolyhedrovirus; Spodoptera litura nucleopolyhedrovirus; Sucra jujuba nucleopolyhedrovirus; Thysanoplusia orichalcea nucleopolyhedrovirus; Trichoplusia ni single nucleopolyhedrovirus; Wiseana signata nucleopolyhedrovirus; unclassified Alphabaculovirus; Abraxas grossulariata nucleopolyhedrovirus; Actias selene nucleopolyhedrovirus; Adoxophyes orana nucleopolyhedrovirus; Agraulis vanillae MNPV; Agrotis exclamationis nucleopolyhedrovirus; Agrotis ipsilon multicapsid nucleopolyhedrovirus; Amorbia cuneacapsa nucleopolyhedrovirus; Amorbia cuneana nucleopolyhedrovirus; Ampelophaga rubiginosa nucleopolyhedrovirus; Amsacta albistriga nucleopolyhedrovirus; Anagrapha falcifera multiple nucleopolyhedrovirus; Antheraea polyphemus nucleopolyhedrovirus; Anticarsia gemmatalis nucleopolyhedrovirus; Apocheima cinerarium nucleopolyhedrovirus; Aporia crataegi nucleopolyhedrovirus; Archips cerasivoranus nuclear polyhedrosis virus; Archips rosanus nucleopolyhedrovirus; Attacus ricini nuclear polyhedrosis virus; Autographa biloba nucleopolyhedrovirus; Autographa gamma nucleopolyhedrovirus; Autographa nigrisigna nucleopolyhedrovirus; Boarmia bistortata nucleopolyhedrovirus; Bombyx mandarina nuclear polyhedrosis virus; Busseola fusca nucleopolyhedrovirus; Catposilia pomona nucleopolyhedrovirus; Cerapteryx graminis nucleopolyhedrovirus; Choristoneura diversana nucleopolyhedrovirus; Choristoneura occidentalis nucleopolyhedrovirus; Chorizagrotis auxiliaris nucleopolyhedrovirus; Chrysodeixis includens NPV; Coloradia pandora alphabaculovirus; Coloradia pandora nucleopolyhedrovirus; Condylorrhiza vestigialis MNPV; Condylorrhiza vestigialis multiple nucleopolyhedrovirus; Cryptophlebia peltastica nucleopolyhedrovirus; Cyclophragma undans nucleopolyhedrovirus; Dasychira plagiata nucleopolyhedrovirus; Dendrolimus kikuchii nucleopolyhedrovirus; Diaphania pulverulentalis nucleopolyhedrovirus; Dione Juno MNPV tmk1/ARG/2003; Dione Juno nucleopolyhedrovirus; Dirphia peruvianus nucleopolyhedrovirus; Ectropis grisescens nucleopolyhedrovirus; Epinotia granitalis nucleopolyhedrovirus; Euproctis digramma nucleopolyhedrovirus; Gilpinia hercyniae nucleopolyhedrovirus; Heliconius erato nucleopolyhedrovirus; Helicoverpa assulta nucleopolyhedrovirus; Helicoverpa gelotopoeon single nucleopolyhedrovirus; Heliothis peltigera SNPV; Heliothis zea nuclear polyhedrosis virus; Hemerocampa vetusta nucleopolyhedrovirus; Hemileuca alphabaculovirus; Hyposidra infixaria NPV; Hyposidra talaca NPV; Iragoides fasciata nucleopolyhedrovirus; Junonia coenia nucleopolyhedrovirus; Leucoma salicis nucleopolyhedrovirus; Lymantria mathura mutiple nucleopolyhedrovirus; Lymantria monacha nucleopolyhedrovirus; Lymantria xylina nucleopolyhedrovirus 2; Malacosoma alphabaculovirus; Malacosoma americanum nucleopolyhedrovirus; Malacosoma californicum nucleopolyhedrovirus; Malacosoma californicum pluviale nucleopolyhedrovirus; Malacosoma disstria nucleopolyhedrovirus; Malacosoma neustria nucleopolyhedrovirus; Mamestra configurata nucleopolyhedrovirus; Neophasia alphabaculovirus; Nepytia phantasmaria nucleopolyhedrovirus; Nymphalis io nucleopolyhedrovirus; Oak looper alphabaculovirus; Ophiusa disjungens nucleopolyhedrovirus; Orgyia anartoides nucleopolyhedrovirus; Orgyia ericae nucleopolyhedrovirus; Orgyia pseudotsugata single capsid nuclopolyhedrovirus; Panolis flammea nucleopolyhedrovirus; Peridroma alphabaculovirus; Peridroma margaritosa nucleopolyhedrovirus; Perina nuda nucleopolyhedrovirus; Phryganidia californica nucleopolyhedrovirus; Plusia acuta nucleopolyhedrovirus; Plusia orichalcea nuclear polyhedrosis virus; Plutella maculipennis nucleopolyhedrovirus; Pseudaletia alphabaculovirus; Pseudoplusia includens nucleopolyhedrovirus; Pterolocera amplicornis nucleopolyhedrovirus; Rachiplusia nu nucleopolyhedrovirus; Rachiplusia nu single nucleopolyhedrovirus; Samia cynthia nucleopolyhedrovirus; Spilarctia obliqua nucleopolyhedrovirus; Spilosoma obliqua nucleopolyhedrosis virus; Spilosoma phasma nucleopolyhedrovirus; Spodoptera cosmioides nucleopolyhedrovirus; Spodoptera eridania nucleopolyhedrovirus; Spodoptera exempta nucleopolyhedrovirus; Spodoptera littoralis multicapsid nucleopolyhedrovirus; Spodoptera litura MNPV; Spodoptera litura nucleopolyhedrovirus II; Spodoptera terricola nucleopolyhedrovirus; Tineola bisselliella nucleopolyhedrovirus; Troides aeacus nucleopolyhedrovirus; Wiseana cervinata nucleopolyhedrovirus; Agraulis sp. nucleopolyhedrovirus; Malacosoma sp. alphabaculovirus;

Malacosoma sp. nucleopolyhedrovirus; Neophasia sp. alphabaculovirus; and unidentified nuclear polyhedrosis viruses.

In some embodiments, a combination or composition of the present invention comprises one or more Insecticidal Agents (IAs), and one or more CRIPs (e.g. one or more of CRIPs: A1-A68 in Table A), wherein the IA is a Betabaculovirus virus selected from the following group: Adoxophyes orana granulovirus; Agrotis segetum granulovirus; Artogeia rapae granulovirus; Pieris brassicae granulovirus; Choristoneura fumiferana granulovirus; Choristoneura occidentalis granulovirus; Clostera anachoreta granulovirus; Clostera anastomosis granulovirus A; Clostera anastomosis granulovirus Henan; Clostera anastomosis granulovirus B; Cnaphalocrocis medinalis granulovirus; Cryptophlebia leucotreta granulovirus; Cydia pomonella granulovirus; Cydia pomonella granulosis virus (isolate Mexican); Diatraea saccharalis granulovirus; Epinotia aporema granulovirus; Erinnyis ello granulovirus; Harrisina brillians granulovirus; Helicoverpa armigera granulovirus; Lacanobia oleracea granulovirus; Mocis latipes granulovirus; Mythimna unipuncta granulovirus A; Pseudalatia unipuncta granulovirus; Mythimna unipuncta granulovirus B; Mythimna unipuncta granulovirus; Phthorimaea operculella granulovirus; Plodia interpunctella granulovirus; Plutella xylostella granulovirus; Spodoptera frugiperda granulovirus; Spodoptera litura granulovirus; Trichoplusia ni granulovirus; Trichoplusia ni granulovirus LBIV-12; Xestia c-nigrum granulovirus; Achaea janata granulovirus; Adoxophyes honmai granulovirus; Agrotis exclamationis granulovirus; Amelia pallorana granulovirus; Andraca bipunctata granulovirus; Autographa gamma granulovirus; Caloptilia theivora granulovirus; Choristoneura murinana granulovirus; Choristoneura viridis betabaculovirus; Clostera anastomosis granulovirus; Cnephasia longana granulovirus; Estigmene acrea granulovirus; Euxoa ochrogaster granulovirus; Heliothis armigera granulovirus; Hoplodrina ambigua granulovirus; Hyphantria cunea granulovirus; Natada nararia granulovirus; Nephelodes emmedonia granulovirus; Pandemis limitata granulovirus; Peridorma morpontora granulovirus; Pieris rapae granulovirus; Plathypena scabra granulovirus; Pseudaletia betabaculovirus; Scotogramma trifolii granulovirus; Spodoptera androgea granulovirus; Spodoptera littoralis granulovirus; Tecia solanivora granulovirus; and Mocis sp. granulovirus.

In some embodiments, a combination or composition of the present invention comprises one or more Insecticidal Agents (IAs), and one or more CRIPs (e.g. one or more of CRIPs: A1-A68 in Table A), wherein the IA is a Deltabaculovirus virus selected from the following group: Culex nigripalpus nucleopolyhedrovirus; and Culex nigripalpus NPV Florida/1997.

In some embodiments, a combination or composition of the present invention comprises one or more Insecticidal Agents (IAs), and one or more CRIPs (e.g. one or more of CRIPs: A1-A68 in Table A), wherein the IA is a Gammabaculovirus virus selected from the following group: Neodiprion lecontei nucleopolyhedrovirus; Neodiprion lecontei NPV (strain Canada); Neodiprion sertifer nucleopolyhedrovirus; unclassified Gammabaculovirus; and Neodiprion abietis NPV.

In some embodiments, a combination or composition of the present invention comprises one or more Insecticidal Agents (IAs), and one or more CRIPs (e.g. one or more of CRIPs: A1-A68 in Table A), wherein the IA is a heretofore unclassified Baculoviridae virus selected from the following group: Achaea faber nucleopolyhedrovirus; Aedes sollicitans nucleopolyhedrovirus; Aglais urticae nucleopolyhedrovirus; Agraulis vanillae nucleopolyhedrovirus; Anomis sabulifera nucleopolyhedrovirus; Antheraea yamamai nucleopolyhedrovirus; Anthophila fabriciana granulovirus; Aroa discalis nucleopolyhedrovirus; Baculovirus penaei; Cadra cautella nucleopolyhedrovirus; Chaliopsis junodi nucleopolyhedrovirus; Cotesia marginiventris baculovirus; Cynosarga ornata nucleopolyhedrovirus; Darna nararia granulovirus; Darna trima granulovirus; Erannis defoliaria nucleopolyhedrovirus; Euplexia lucipara granulovirus; Euproctis chrysorrhoea nucleopolyhedrovirus; Euproctis similis nucleopolyhedrovirus; Gonad-specific virus; Homona coffearia granulovirus; Hyblaea puera nucleopolyhedrovirus; Idaea seriata nucleopolyhedrovirus; Junonia coenia granulovirus; Lasiocampa quercus nucleopolyhedrovirus; Lemyra imparilis nucleopolyhedrovirus; Mahasena corbetti nucleopolyhedrovirus; Melanchra persicariae granulovirus; Operophtera bruceata nucleopolyhedrovirus; Orgyia antiqua nucleopolyhedrovirus; Orgyia mixta nucleopolyhedrovirus; Pachytrina philargyria nucleopolyhedrovirus; Pareuchaetes pseudoinsulata nucleopolyhedrovirus; Penaeus monodon nucleopolyhedrovirus; Phalera bucephala nucleopolyhedrovirus; Polygonia c-album nucleopolyhedrovirus; Samia ricini nucleopolyhedrovirus; Spilosoma lutea granulovirus; Spodoptera albula nucleopolyhedrovirus; Trabala vishnou nucleopolyhedrovirus; Uranotaenia sapphirina nucleopolyhedrovirus; Urbanus proteus nucleopolyhedrovirus; Utetheisa pulchella nucleopolyhedrovirus; Vanessa atalanta nucleopolyhedrovirus; Vanessa cardui nucleopolyhedrovirus; and Wiseana cervinata granulovirus.

In some embodiments, a combination or composition of the present invention comprises one or more Insecticidal Agents (IAs), and one or more CRIPs (e.g. one or more of CRIPs: A1-A68 in Table A), wherein the IA is a Adoxophyes orana granulovirus; a Agrotis segetum granulovirus; a Artogeia rapae granulovirus; a Pieris brassicae granulovirus; a Choristoneura fumiferana granulovirus; a Choristoneura occidentalis granulovirus; a Clostera anachoreta granulovirus; a Clostera anastomosis granulovirus A; a Clostera anastomosis granulovirus Henan; a Clostera anastomosis granulovirus B; a Cnaphalocrocis medinalis granulovirus; a Cryptophlebia leucotreta granulovirus; a Cydia pomonella granulovirus; a Cydia pomonella granulosis virus (isolate Mexican); a Diatraea saccharalis granulovirus; a Epinotia aporema granulovirus; a Erinnyis ello granulovirus; a Harrisina brillians granulovirus; a Helicoverpa armigera granulovirus; a Lacanobia oleracea granulovirus; a Mocis latipes granulovirus; a Mythimna unipuncta granulovirus A; a Pseudalatia unipuncta granulovirus; a Mythimna unipuncta granulovirus B; a Mythimna unipuncta granulovirus; a Phthorimaea operculella granulovirus; a Plodia interpunctella granulovirus; a Plutella xylostella granulovirus; a Spodoptera frugiperda granulovirus; a Spodoptera litura granulovirus; a Trichoplusia ni granulovirus; a Trichoplusia ni granulovirus LBIV-12; a Xestia c-nigrum granulovirus; a unclassified Betabaculovirus; a Achaea janata granulovirus; a Adoxophyes honmai granulovirus; a Agrotis exclamationis granulovirus; a Amelia pallorana granulovirus; a Andraca bipunctata granulovirus; a Autographa gamma granulovirus; a Caloptilia theivora granulovirus; a Choristoneura murinana granulovirus; a Choristoneura viridis betabaculovirus; a Clostera anastomosis granulovirus; a Cnephasia longana granulovirus; a Estigmene acrea granulovirus; a Euxoa ochrogaster granulovirus; a Heliothis armigera granulovirus; a Hoplodrina ambigua granulovirus; a Hyphantria cunea granulovirus; a Natada nararia granulovirus; a Nephelodes emmedonia granulovirus; a Pandemis limitata granulovirus; a Peridorma morpontora granulovirus; a Pieris rapae granulovirus; a Plathypena scabra granulovirus; a Pseudaletia betabaculovirus; a Scotogramma trifolii granulovirus; a Spodoptera androgea granulovirus; a Spodoptera littoralis granulovirus; a Tecia solanivora granulovirus; or a Mocis sp. Granulovirus.

In some embodiments, a combination or composition of the present invention comprises one or more Insecticidal Agents (IAs), and one or more CRIPs (e.g. one or more of CRIPs: A1-A68 in Table A), wherein the IA is a Cydia pomonella granulovirus.

In some embodiments, a combination or composition of the present invention comprises one or more Insecticidal Agents (IAs), and one or more CRIPs (e.g. one or more of CRIPs: A1-A68 in Table A), wherein the IA is a Cydia pomonella granulovirus isolate V22 virus.

Combinations: Bacteria/Bacterial Toxins and CRIPs

In some embodiments, a combination or composition of the present invention comprises one or more Insecticidal Agents (IAs), and one or more CRIPs (e.g. one or more of CRIPs: A1-A68 in Table A), wherein the IA is a bacteria.

In some embodiments, a combination or composition of the present invention comprises one or more Insecticidal Agents (IAs), and one or more CRIPs (e.g. one or more of CRIPs: A1-A68 in Table A), wherein the IA is a peptide or toxin isolated from a bacteria.

In some embodiments, a combination or composition of the present invention comprises one or more Insecticidal Agents (IAs), and one or more CRIPs (e.g. one or more of CRIPs: A1-A68 in Table A), wherein the IA is a bacterial toxin.

Photorhabdus and/or the Toxins Therefrom

In some embodiments, a combination or composition of the present invention comprises one or more Insecticidal Agents (IAs), and one or more CRIPs (e.g. one or more of CRIPs: A1-A68 in Table A), wherein the IA is a bacterial toxin isolated from a bacteria belonging to the Xenorhabdus genus, or Photorhabdus genus.

In some embodiments, a combination or composition of the present invention comprises one or more Insecticidal Agents (IAs), and one or more CRIPs (e.g. one or more of CRIPs: A1-A68 in Table A), wherein the IA is a Photorhabdus toxin.

In some embodiments, a combination or composition of the present invention comprises one or more Insecticidal Agents (IAs), and one or more CRIPs (e.g. one or more of CRIPs: A1-A68 in Table A), wherein the IA is a Photorhabdus toxin selected from the group consisting of: Photorhabdus akhurstii toxin; Photorhabdus asymbiotica toxin; Photorhabdus asymbiotica subsp. asymbiotica toxin; Photorhabdus asymbiotica subsp. asymbiotica ATCC 43949 toxin; Photorhabdus australis toxin; Photorhabdus australis DSM 17609 toxin; Photorhabdus bodei toxin; Photorhabdus caribbeanensis toxin; Photorhabdus cinerea toxin; Photorhabdus hainanensis toxin; Photorhabdus heterorhabditis toxin; Photorhabdus kayaii toxin; Photorhabdus khanii toxin; Photorhabdus khanii NC19 toxin; Photorhabdus khanii subsp. guanajuatensis toxin; Photorhabdus kleinii toxin; Photorhabdus laumondii toxin; Photorhabdus laumondii subsp. clarkei toxin; Photorhabdus laumondii subsp. laumondii toxin; Photorhabdus laumondii subsp. laumondii TTO1 toxin; Photorhabdus luminescens toxin; Photorhabdus luminescens BA1 toxin; Photorhabdus luminescens NBAII H75HRPL105 toxin; Photorhabdus luminescens NBAII HiPL101 toxin; Photorhabdus luminescens subsp. luminescens toxin; Photorhabdus luminescens subsp. luminescens ATCC 29999 toxin; Photorhabdus luminescens subsp. mexicana toxin; Photorhabdus luminescens subsp. sonorensis toxin; Photorhabdus namnaonensis toxin; Photorhabdus noenieputensis toxin; Photorhabdus stackebrandtii toxin; Photorhabdus tasmaniensis toxin; Photorhabdus temperata toxin; Photorhabdus temperata J3 toxin; Photorhabdus temperata subsp. phorame toxin; Photorhabdus temperata subsp. temperata toxin; Photorhabdus temperata subsp. temperata M1021 toxin; Photorhabdus temperata subsp. temperata Meg1 toxin; Photorhabdus thracensis toxin; unclassified Photorhabdus toxin; Photorhabdus sp. toxin; Photorhabdus sp. 3014 toxin; Photorhabdus sp. 3240 toxin; Photorhabdus sp. Az29 toxin; Photorhabdus sp. B S21 toxin; Photorhabdus sp. CbKj163 toxin; Photorhabdus sp. CRCIA-P01 toxin; Photorhabdus sp. ENY toxin; Photorhabdus sp. FL2122 toxin; Photorhabdus sp. FL480 toxin; Photorhabdus sp. FsIw96 toxin; Photorhabdus sp. GDd233 toxin; Photorhabdus sp. H3086 toxin; Photorhabdus sp. H3107 toxin; Photorhabdus sp. H3240 toxin; Photorhabdus sp. HB301 toxin; Photorhabdus sp. HB78 toxin; Photorhabdus sp. HB89 toxin; Photorhabdus sp. HIT toxin; Photorhabdus sp. HO1 toxin; Photorhabdus sp. HUG-39 toxin; Photorhabdus sp. IT toxin; Photorhabdus sp. JUN toxin; Photorhabdus sp. KcTs129 toxin; Photorhabdus sp. KJ13.1 TH toxin; Photorhabdus sp. KJ14.3 TH toxin; Photorhabdus sp. KJ24.5 TH toxin; Photorhabdus sp. KJ29.1 TH toxin; Photorhabdus sp. KJ37.1 TH toxin; Photorhabdus sp. KJ7.1 TH toxin; Photorhabdus sp. KJ8.2 TH toxin; Photorhabdus sp. KJ9.1 TH toxin; Photorhabdus sp. KJ9.2 TH toxin; Photorhabdus sp. KK1.3 TH toxin; Photorhabdus sp. KK1.4 TH toxin; Photorhabdus sp. KMD74 toxin; Photorhabdus sp. KOH toxin; Photorhabdus sp. MID10 toxin; Photorhabdus sp. MOL toxin; Photorhabdus sp. MSW 058 toxin; Photorhabdus sp. MSW 079 toxin; Photorhabdus sp. NK2.1 TH toxin; Photorhabdus sp. NK2.5 TH toxin; Photorhabdus sp. NnMt2h toxin; Photorhabdus sp. NP1 toxin; Photorhabdus sp. OH10 toxin; Photorhabdus sp. OnIr40 toxin; Photorhabdus sp. OnKn2 toxin; Photorhabdus sp. PB10.1 TH toxin; Photorhabdus sp. PB16.3 TH toxin; Photorhabdus sp. PB17.1 TH toxin; Photorhabdus sp. PB17.3 TH toxin; Photorhabdus sp. PB2.5 TH toxin; Photorhabdus sp. PB22.4 TH toxin; Photorhabdus sp. PB22.5 TH toxin; Photorhabdus sp. PB32.1 TH toxin; Photorhabdus sp. PB33.1 TH toxin; Photorhabdus sp. PB33.4 TH toxin; Photorhabdus sp. PB37.4 TH toxin; Photorhabdus sp. PB39.2 TH toxin; Photorhabdus sp. PB4.5 TH toxin; Photorhabdus sp. PB41.4 TH toxin; Photorhabdus sp. PB45.5 TH toxin; Photorhabdus sp. PB47.1 TH toxin; Photorhabdus sp. PB47.3 TH toxin; Photorhabdus sp. PB5.1 TH toxin; Photorhabdus sp. PB5.4 TH toxin; Photorhabdus sp. PB50.4 TH toxin; Photorhabdus sp. PB51.4 TH toxin; Photorhabdus sp. PB52.2 TH toxin; Photorhabdus sp. PB54.4 TH toxin; Photorhabdus sp. PB58.2 TH toxin; Photorhabdus sp. PB58.4 TH toxin; Photorhabdus sp. PB58.5 TH toxin; Photorhabdus sp. PB59.2 TH toxin; Photorhabdus sp. PB6.5 TH toxin; Photorhabdus sp. PB67.2 TH toxin;

Photorhabdus sp. PB67.4 TH toxin; Photorhabdus sp. PB68.1 TH toxin; Photorhabdus sp. PB7.5 TH toxin; Photorhabdus sp. PB76.1 TH toxin; Photorhabdus sp. PB76.4 TH toxin; Photorhabdus sp. PB76.5 TH toxin; Photorhabdus sp. PB78.2 TH toxin; Photorhabdus sp. PB80.3 TH toxin; Photorhabdus sp. PB80.4 TH toxin; Photorhabdus sp. Pjun toxin; Photorhabdus sp. RW14-46 toxin; Photorhabdus sp. S10-54 toxin; Photorhabdus sp. S12-55 toxin; Photorhabdus sp. S14-60 toxin; Photorhabdus sp. S15-56 toxin; Photorhabdus sp. S5P8-50 toxin; Photorhabdus sp. S7-51 toxin; Photorhabdus sp. S8-52 toxin; Photorhabdus sp. S9-53 toxin; Photorhabdus sp. 5.12 toxin; Photorhabdus sp. SN259 toxin; Photorhabdus sp. SP1.5 TH toxin; Photorhabdus sp. SP16.4 TH toxin; Photorhabdus sp. SP21.5 TH toxin; Photorhabdus sp. SP3.4 TH toxin; Photorhabdus sp. SP4.5 TH toxin; Photorhabdus sp. SP7.3 TH toxin; Photorhabdus sp. TyKb140 toxin; Photorhabdus sp. UK76 toxin; Photorhabdus sp. VMG toxin; Photorhabdus sp. WA21C toxin; Photorhabdus sp. WkSs43 toxin; Photorhabdus sp. Wx13 toxin; Photorhabdus sp. X₄ toxin; Photorhabdus sp. YNb90 toxin; and Photorhabdus sp. ZM toxin.

In some embodiments, a combination or composition of the present invention comprises one or more Insecticidal Agents (IAs), and one or more CRIPs (e.g. one or more of CRIPs: A1-A68 in Table A), wherein the IA is a Photorhabdus luminescens toxin.

In some embodiments, a combination or composition of the present invention comprises one or more Insecticidal Agents (IAs), and one or more CRIPs (e.g. one or more of CRIPs: A1-A68 in Table A), wherein the IA is a Photorhabdus luminescens toxin, wherein the Photorhabdus luminescens toxin comprises a Photorhabdus luminescens “toxin complex a” (Tca).

In some embodiments, a combination or composition of the present invention comprises one or more Insecticidal Agents (IAs), and one or more CRIPs (e.g. one or more of CRIPs: A1-A68 in Table A), wherein the IA is a Photorhabdus luminescens toxin, wherein the Photorhabdus luminescens toxin comprises a Photorhabdus luminescens “toxin complex c” (Tcc).

In some embodiments, a combination or composition of the present invention comprises one or more Insecticidal Agents (IAs), and one or more CRIPs (e.g. one or more of CRIPs: A1-A68 in Table A), wherein the IA is a Photorhabdus luminescens toxin, wherein the Photorhabdus luminescens toxin comprises a Photorhabdus luminescens “toxin complex d” (Tcd).

In some embodiments, a combination or composition of the present invention comprises one or more Insecticidal Agents (IAs), and one or more CRIPs (e.g. one or more of CRIPs: A1-A68 in Table A), wherein the IA is a Tca comprising a TcaA protein (SEQ ID NO: 616), a TcaB protein (SEQ ID NO: 617), a TcaC protein (SEQ ID NO: 618), and a TcaZ protein (SEQ ID NO: 619).

In some embodiments, a combination or composition of the present invention comprises one or more Insecticidal Agents (IAs), and one or more CRIPs (e.g. one or more of CRIPs: A1-A68 in Table A), wherein the IA is a Photorhabdus luminescens “toxin complex a” (Tca) having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in a SEQ ID NO: 616-619.

Yersinia Organisms, and the Products Therefrom

In some embodiments, a combination or composition of the present invention comprises one or more Insecticidal Agents (IAs), and one or more CRIPs (e.g. one or more of CRIPs: A1-A68 in Table A), wherein the IA is one or more organisms belonging to the Yersinia genus.

In some embodiments, a combination or composition of the present invention comprises one or more Insecticidal Agents (IAs), and one or more CRIPs (e.g. one or more of CRIPs: A1-A68 in Table A), wherein the IA is one or more peptides isolated from an organism belonging to the Yersinia genus.

In some embodiments, a combination or composition of the present invention comprises one or more Insecticidal Agents (IAs), and one or more CRIPs (e.g. one or more of CRIPs: A1-A68 in Table A), wherein the IA is one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, a combination or composition of the present invention comprises one or more Insecticidal Agents (IAs), and one or more CRIPs (e.g. one or more of CRIPs: A1-A68 in Table A), wherein the IA is one or more peptides isolated from one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, a combination or composition of the present invention comprises one or more Insecticidal Agents (IAs), and one or more CRIPs (e.g. one or more of CRIPs: A1-A68 in Table A), wherein the IA is a Yersinia entomophaga or Yersinia nurmii.

In some embodiments, a combination or composition of the present invention comprises one or more Insecticidal Agents (IAs), and one or more CRIPs (e.g. one or more of CRIPs: A1-A68 in Table A), wherein the IA is one or more peptides isolated from Yersinia entomophaga or Yersinia nurmii.

In some embodiments, a combination or composition of the present invention comprises one or more Insecticidal Agents (IAs), and one or more CRIPs (e.g. one or more of CRIPs: A1-A68 in Table A), wherein the IA is a “Yen-TC” toxin complex (TC).

In some embodiments, a combination or composition of the present invention comprises one or more Insecticidal Agents (IAs), and one or more CRIPs (e.g. one or more of CRIPs: A1-A68 in Table A), wherein the IA is one or more TC proteins.

In some embodiments, a combination or composition of the present invention comprises one or more Insecticidal Agents (IAs), and one or more CRIPs (e.g. one or more of CRIPs: A1-A68 in Table A), wherein the IA is TcA, TcB, and TcC.

In some embodiments, a combination or composition of the present invention comprises one or more Insecticidal Agents (IAs), and one or more CRIPs (e.g. one or more of CRIPs: A1-A68 in Table A), wherein the IA is a Yersinia entomophaga bacteria, and/or a toxin therefrom.

In some embodiments, a combination or composition of the present invention comprises one or more Insecticidal Agents (IAs), and one or more CRIPs (e.g. one or more of CRIPs: A1-A68 in Table A), wherein the IA is one or more Yersinia nurmii bacteria, and/or a toxin therefrom.

In some embodiments, a combination or composition of the present invention comprises one or more Insecticidal Agents (IAs), and one or more CRIPs (e.g. one or more of CRIPs: A1-A68 in Table A), wherein the IA is one or more Yersinia entomophaga bacteria and/or a toxin therefrom, and one or more Yersinia nurmii bacteria and/or a toxin therefrom.

Combinations: Bt Toxins, CRIPs, and combinations thereof.

In some embodiments, a combination or composition can comprise any one or more CRIPs in Table A, combined with one or more IAs contained in IA Group No. 8; e.g., IA Nos. B124-B150.

In some embodiments, a combination or composition can comprise: (1) one or more of CRIPs: A1-A68; and (2) one or more Bt peptides and/or toxins.

In some embodiments, a combination or composition can comprise: (1) one or more of CRIPs: A1-A68; and (2) one or more Bt peptides; wherein the combination or composition further comprises an additional agent (e.g., one or more pesticides and/or insecticides as described herein).

In some embodiments, a combination or composition can comprise: (1) one or more of CRIPs: A1-A68; and (2) one or more Bt peptides; wherein the combination or composition further comprises an excipient.

In some embodiments, the method of controlling an insect comprises: applying a Bacillus thuringiensis (Bt) protein to the locus of an insect; and then applying one or more of CRIPs: A1-A68 to the locus of said insect, wherein said Bt and/or CRIP is applied either concomitantly or sequentially.

In some embodiments, a combination and/or composition can comprise one or more of CRIPs: A1-A68, and one or more Bt toxins, e.g., a Cry protein, a Cyt protein, or a Vip protein, as described herein and/or enumerated in the tables herein and/or in the sequence listing.

In some embodiments, one or more of CRIPs: A1-A68 can be combined with a protein isolated from Bacillus thuringiensis. For example, in some embodiments, one or more of CRIPs: A1-A68 can be combined with an δ-endotoxin (e.g., Crystal (Cry) toxins and/or cytolytic (Cyt) toxins); vegetative insecticidal proteins (Vips); secreted insecticidal protein (Sips); or Bin-like toxins.

In some embodiments, the present invention provides for a combination comprising one or more of CRIPs: A1-A68 and a Bacillus thuringiensis (Bt) toxin; wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, the present invention provides for a combination comprising one or more of CRIPs: A1-A68 and a Bacillus thuringiensis (Bt) toxin; wherein the Bt toxin is a parasporal crystal toxin, and wherein the parasporal crystal toxin is a 6-endotoxin.

In some embodiments, the present invention provides for a combination comprising one or more of CRIPs: A1-A68 and a Bacillus thuringiensis (Bt) toxin; wherein the Bt toxin is an δ-endotoxin that is a Three-domain (3D) Cry family protein, binary Bin-like family toxin, ETX_MTX2-like family toxin, Toxin-10 family toxin, Aerolysin family toxin or cytolysin.

In some embodiments, the present invention provides for a combination comprising one or more of CRIPs: A1-A68 and a Bacillus thuringiensis (Bt) toxin; wherein the Bt toxin is an δ-endotoxin that is a Three-domain (3D) Cry toxin, mosquitocidal Cry toxin (Mtx), binary-like (Bin) toxin, or Cyt toxin.

In some embodiments, the present invention provides for a combination comprising one or more of CRIPs: A1-A68 and a Bacillus thuringiensis (Bt) toxin; wherein the Bt toxin is an δ-endotoxin that is a Three-domain (3D) Cry toxin or a Cyt toxin.

In some embodiments, a combination or composition comprises one or more of CRIPs: A1-A68, that is combined with one or more of the following Cry proteins: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry11-like, Cry11-like, Cry1Ja1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, and/or Cry78Aa1.

In some embodiments, a combination or composition comprises one or more of CRIPs: A1-A68, that is combined with one or more Bt toxins, wherein said Bt toxin is a Cry toxin, a Cyt toxin, or a Vip toxin (e.g., any of the Cry, Cyt, or Vips as described herein).

In some embodiments, one or more of CRIPs: A1-A68 can be combined with one or more Cry proteins having an amino acid sequence as set forth in SEQ ID NOs: 412-461.

In some embodiments, a combination or composition comprises one or more of CRIPs: A1-A68 that is combined with one or more of the following Cyt proteins: Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and/or Cyt3Aa1.

In some embodiments, a combination or composition comprises one or more of CRIPs: A1-A68, which is combined with one or more Cyt proteins having an amino acid sequence as set forth in SEQ ID NOs: 462-481.

In some embodiments, the present invention provides for a combination comprising one or more of CRIPs: A1-A68 and a Bacillus thuringiensis (Bt) toxin; wherein the Bt toxin is a secreted protein that is a vegetative insecticidal proteins (Vip), a secreted insecticidal protein (Sip), a Bin-like family protein, or an ETX_MTX2-family protein.

In some embodiments, the present invention provides for a combination comprising one or more of CRIPs: A1-A68 and a Bacillus thuringiensis (Bt) toxin; wherein the Bt toxin is a secreted protein that is a Vip.

In some embodiments, the present invention provides for a combination comprising one or more of CRIPs: A1-A68 and a Bacillus thuringiensis (Bt) toxin; wherein the Bt toxin is a Vip that is a Vip 1 family protein, Vip 2 family protein, Vip 3 family protein, or Vip 4 family protein.

In some embodiments, one or more of CRIPs: A1-A68 can be combined with one or more of the following Vip proteins: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and/or Vip4Aa1.

In some embodiments, one or more of CRIPs: A1-A68 can be combined with one or more Vip proteins having an amino acid sequence as set forth in SEQ ID NOs: 482-587.

Any of the foregoing combinations or compositions comprising one or more of CRIPs: A1-A68 and one or more Bt peptides, can be applied concomitantly and/or sequentially, and either in the same or separate compositions. The ratios of CRIP to Bt peptide will depend on the insect pest to be targeted, and the need of the user.

In some embodiments, the Bt protein and the CRIP may be applied to (Bt protein)-resistant insects. The ratio of Bt to CRIP, on a dry weight basis, can be selected from at least about the following ratios: 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000, or any combination of any two of these values. The total concentration of Bt and CRIP in the composition is selected from the following percent concentrations: 0, 1, 5, 10, 15, 20, 25, 30, 35, 40, 45, 50, 55, 60, 65, 70, 75, 80, 85, 90, 95, 99 or 100%, or any range between any two of these values, and the remaining percentage of the composition is comprised of excipients.

In some embodiments, one or more CRIPs can be included in a formulation, for example, a formulation composed of a polar aprotic solvent, and or water, and or where the polar aprotic solvent is present in an amount of 1-99 wt %, the polar protic solvent is present in an amount of 1-99 wt %, and the water is present in an amount of 0-98 wt %. In some embodiments, the formulations include a CRIP, and another IA, for example, a Bt protein. In some embodiments, the Bt protein is contained within a commercially available product (e.g., DiPel®). The polar aprotic solvent formulations are especially effective when they contain MSO. MSO is a methylated seed oil and surfactant blend that uses methyl esters of soya oil in amounts of between about 80 and 85 percent petroleum oil with 15 to 20 percent surfactant.

In some embodiments, a combination or composition can comprise a Bacillus thuringiensis (Bt) protein and a CRIP, wherein the Bt peptide can be a MTX2 toxin, e.g., a MTX2 toxin isolated from Lysinibacillus sphaericus.

In some embodiments, a combination or composition can comprise a Bacillus thuringiensis (Bt) protein and a CRIP, wherein the Bt peptide can be a Bin-like toxin, e.g., a Bin-like toxin isolated from Lysinibacillus sphaericus.

In some embodiments, a combination or composition can comprise a Bacillus thuringiensis (Bt) protein and a CRIP, wherein the Bt peptide can be isolated from a Bacillus thuringiensis subspecies. For example, in some embodiments, the Bacillus thuringiensis subspecies can be one of the following subspecies: aizawai; aizawai/pacificus; alesti; amagiensis; andalousiensis; argentinensis; asturiensis; azorensis; balearica; berliner; bolivia; brasilensis; cameroun; canadensis; chanpaisis; chinensis; colmeri; coreanensis; dakota; darmstadiensis; dendrolimus; entomocidus; entomocidus/subtoxicus; finitimus; fukuokaensis; galechiae; galleriae; graciosensis; guiyangiensis; higo; huazhongensis; iberica; indiana; israelensis; israelensis/tochigiensis; japonensis; jegathesan; jinghongiensis; kenyae; kim; kumamtoensis; kurstaki; kyushuensis; leesis; londrina; malayensis; medellin; mexicanensis; mogi; monterrey; morrisoni; muju; navarrensis; neoleonensis; nigeriensis; novosibirsk, ostriniae; oswaldocruzi; pahangi; pakistani; palmanyolensis; pingluonsis; pirenaica; poloniensis; pondicheriensis; pulsiensis; rongseni; roskildiensis; san diego; seoulensis; shandongiensis; silo; sinensis; sooncheon; sotto; sotto/dendrolimus; subtoxicus; sumiyoshiensis; sylvestriensis; tenebrionis; thailandensis; thompsoni; thuringiensis; tochigiensis; toguchini; tohokuensis; tolworthi; toumanoffi; vazensis; wratislaviensis; wuhanensis; xiaguangiensis; yosoo; yunnanensis; zhaodongensis; str. Al Hakam; or konkukian.

In some embodiments, a combination or composition can comprise a Bacillus thuringiensis (Bt) protein and a CRIP, wherein the Bt peptide is isolated from a Bacillus thuringiensis var. selected from the following group: Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kurstaki; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. tenebrionis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; Bacillus thuringiensis str. Al Hakam; Bacillus thuringiensis T01-328; Bacillus thuringiensis YBT-1518; or Bacillus thuringiensis var. konkukian.

In some embodiments, a combination or composition can comprise a Bacillus thuringiensis (Bt) protein and a CRIP, wherein the Bt peptide is isolated from a Bacillus thuringiensis serovar. For example, in some embodiments, a the Bt peptide can be a Bacillus thuringiensis serovar selected from the following group: Bacillus thuringiensis AKS-7; Bacillus thuringiensis Bt18247; Bacillus thuringiensis Bt18679; Bacillus thuringiensis Bt407; Bacillus thuringiensis DAR 81934; Bacillus thuringiensis DB27; Bacillus thuringiensis F14-1; Bacillus thuringiensis FC1; Bacillus thuringiensis FC10; Bacillus thuringiensis FC2; Bacillus thuringiensis FC6; Bacillus thuringiensis FC7; Bacillus thuringiensis FCB; Bacillus thuringiensis FC9; Bacillus thuringiensis HD-771; Bacillus thuringiensis HD-789; Bacillus thuringiensis HD1002; Bacillus thuringiensis IBL 200; Bacillus thuringiensis IBL 4222; Bacillus thuringiensis JM-Mgvxx-63; Bacillus thuringiensis LDC 391; Bacillus thuringiensis LM1212; Bacillus thuringiensis MC28; Bacillus thuringiensis Sbt003; Bacillus thuringiensis serovar aizawai; Bacillus thuringiensis serovar aizawai/pacificus; Bacillus thuringiensis serovar alesti; Bacillus thuringiensis serovar amagiensis; Bacillus thuringiensis serovar andalousiensis; Bacillus thuringiensis serovar argentinensis; Bacillus thuringiensis serovar asturiensis; Bacillus thuringiensis serovar azorensis; Bacillus thuringiensis serovar balearica; Bacillus thuringiensis serovar berliner; Bacillus thuringiensis serovar bolivia; Bacillus thuringiensis serovar brasilensis; Bacillus thuringiensis serovar cameroun; Bacillus thuringiensis serovar canadensis; Bacillus thuringiensis serovar chanpaisis; Bacillus thuringiensis serovar chinensis; Bacillus thuringiensis serovar colmeri; Bacillus thuringiensis serovar coreanensis; Bacillus thuringiensis serovar dakota; Bacillus thuringiensis serovar darmstadiensis; Bacillus thuringiensis serovar dendrolimus; Bacillus thuringiensis serovar entomocidus; Bacillus thuringiensis serovar entomocidus/subtoxicus; Bacillus thuringiensis serovar finitimus; Bacillus thuringiensis serovar fukuokaensis; Bacillus thuringiensis serovar galechiae; Bacillus thuringiensis serovar galleriae; Bacillus thuringiensis serovar graciosensis; Bacillus thuringiensis serovar guiyangiensis; Bacillus thuringiensis serovar higo; Bacillus thuringiensis serovar huazhongensis; Bacillus thuringiensis serovar iberica; Bacillus thuringiensis serovar indiana; Bacillus thuringiensis serovar israelensis; Bacillus thuringiensis serovar israelensis/tochigiensis; Bacillus thuringiensis serovar japonensis; Bacillus thuringiensis serovar jegathesan; Bacillus thuringiensis serovar jinghongiensis; Bacillus thuringiensis serovar kenyae; Bacillus thuringiensis serovar kim; Bacillus thuringiensis serovar kumamtoensis; Bacillus thuringiensis serovar kunthalanags3; Bacillus thuringiensis serovar kunthalaRX24; Bacillus thuringiensis serovar kunthalaRX27; Bacillus thuringiensis serovar kunthalaRX28; Bacillus thuringiensis serovar kurstaki; Bacillus thuringiensis serovar kyushuensis; Bacillus thuringiensis serovar leesis; Bacillus thuringiensis serovar londrina; Bacillus thuringiensis serovar malayensis; Bacillus thuringiensis serovar medellin; Bacillus thuringiensis serovar mexicanensis; Bacillus thuringiensis serovar mogi; Bacillus thuringiensis serovar monterrey; Bacillus thuringiensis serovar morrisoni; Bacillus thuringiensis serovar muju; Bacillus thuringiensis serovar navarrensis; Bacillus thuringiensis serovar neoleonensis; Bacillus thuringiensis serovar nigeriensis; Bacillus thuringiensis serovar novosibirsk, Bacillus thuringiensis serovar ostriniae; Bacillus thuringiensis serovar oswaldocruzi; Bacillus thuringiensis serovar pahangi; Bacillus thuringiensis serovar pakistani; Bacillus thuringiensis serovar palmanyolensis; Bacillus thuringiensis serovar pingluonsis; Bacillus thuringiensis serovar pirenaica; Bacillus thuringiensis serovar poloniensis; Bacillus thuringiensis serovar pondicheriensis; Bacillus thuringiensis serovar pulsiensis; Bacillus thuringiensis serovar rongseni; Bacillus thuringiensis serovar roskildiensis; Bacillus thuringiensis serovar san diego; Bacillus thuringiensis serovar seoulensis; Bacillus thuringiensis serovar shandongiensis; Bacillus thuringiensis serovar silo; Bacillus thuringiensis serovar sinensis; Bacillus thuringiensis serovar sooncheon; Bacillus thuringiensis serovar sotto; Bacillus thuringiensis serovar sotto/dendrolimus; Bacillus thuringiensis serovar subtoxicus; Bacillus thuringiensis serovar sumiyoshiensis; Bacillus thuringiensis serovar sylvestriensis; Bacillus thuringiensis serovar tenebrionis; Bacillus thuringiensis serovar thailandensis; Bacillus thuringiensis serovar thompsoni; Bacillus thuringiensis serovar thuringiensis; Bacillus thuringiensis serovar tochigiensis; Bacillus thuringiensis serovar toguchini; Bacillus thuringiensis serovar tohokuensis; Bacillus thuringiensis serovar tolworthi; Bacillus thuringiensis serovar toumanoffi; Bacillus thuringiensis serovar vazensis; Bacillus thuringiensis serovar wratislaviensis; Bacillus thuringiensis serovar wuhanensis; Bacillus thuringiensis serovar xiaguangiensis; Bacillus thuringiensis serovar yosoo; Bacillus thuringiensis serovar yunnanensis; Bacillus thuringiensis serovar zhaodongensis; Bacillus thuringiensis str. Al Hakam; Bacillus thuringiensis T01-328; Bacillus thuringiensis YBT-1518; and Bacillus thuringiensis serovar konkukian.

In some embodiments, a combination or composition can comprise a Bacillus thuringiensis (Bt) protein and a CRIP, wherein the Bt peptide is isolated from: Bacillus thuringiensis var. israelensis, Bacillus thuringiensis var. aizawai, Bacillus thuringiensis var. kurstaki, or Bacillus thuringiensis var. tenebrionensis.

In some embodiments, the present invention provides for a combination comprising one or more of CRIPs: A1-A68 and a Bacillus thuringiensis (Bt) toxin; wherein the combination results in an insecticidal effect; and wherein the Bt toxin is a Bacillus thuringiensis var. israelensis (Bti) toxin.

In some embodiments, the present invention provides for a combination comprising one or more of CRIPs: A1-A68 and a Bacillus thuringiensis (Bt) toxin; wherein the combination results in an insecticidal effect; and wherein the Bti toxin is a Bacillus thuringiensis ssp. israelensis Strain BMP 144 Bti toxin.

In some embodiments, the present invention provides for a combination comprising one or more of CRIPs: A1-A68 and a Bacillus thuringiensis (Bt) toxin; wherein the combination results in an insecticidal effect; and wherein the Bt toxin is a Bacillus thuringiensis var. kurstaki (Btk) toxin.

In some embodiments, the present invention provides for a combination comprising one or more of CRIPs: A1-A68 and a Bacillus thuringiensis (Bt) toxin; wherein the combination results in an insecticidal effect; and wherein the Btk toxin is Bacillus thuringiensis ssp. kurstaki strain EVB-113-19 Btk toxin.

In some embodiments, the present invention provides for a combination comprising one or more of CRIPs: A1-A68 and a Bacillus thuringiensis (Bt) toxin; wherein the combination results in an insecticidal effect; and wherein the Bt toxin is a Bacillus thuringiensis var. tenebrionis (Btt) toxin.

In some embodiments, the present invention provides for a combination comprising one or more of CRIPs: A1-A68 and a Bacillus thuringiensis (Bt) toxin; wherein the combination results in an insecticidal effect; and wherein the Btt toxin is a Bacillus thuringiensis ssp. tenebrionis strain NB-176 Btt toxin.

In some embodiments, the present invention provides for a combination comprising one or more of CRIPs: A1-A68 and a Bacillus thuringiensis (Bt) toxin; wherein the combination results in an insecticidal effect; and wherein the ratio of CRIP to Bt toxin is about 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000.

In some embodiments, the present invention provides for a combination comprising one or more of CRIPs: A1-A68 and a Bacillus thuringiensis (Bt) toxin; wherein the combination results in an insecticidal effect; and wherein the ratio of Bt toxin to CRIP is from about 1:1 to about 1:200.

In some embodiments, the present invention provides for a combination comprising one or more of CRIPs: A1-A68 and a Bacillus thuringiensis (Bt) toxin; wherein the combination results in an insecticidal effect; and wherein the ratio of Bt toxin to CRIP is about 1:115.

In some embodiments, the present invention provides for a combination comprising at least one CRIP and at least one IA, wherein the CRIP is a TVP, and the IA is a Bacillus thuringiensis (Bt) toxin; wherein the combination results in an insecticidal effect; and wherein the TVP comprises an amino acid sequence that is at least 90% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, or N; X₃ is T or P; X₄ is K or A; X₅ is R or A; Z₁ is T or A; X₆ is K or absent; and X₇ is G or absent; and wherein if Z₁ is T, then the TVP is glycosylated.

In some embodiments any of the combinations of a CRIP as described herein, and a Bt toxin as described herein, can further comprise an excipient.

Any of the foregoing combinations or compositions comprising one or more of CRIPs: A1-A68, and a Bt toxin, can be applied concomitantly and/or sequentially, and either in the same or separate compositions. The ratios of a CRIP to an IA, i.e., one or more chemical substances, molecules, nucleotides, polynucleotides, peptides, polypeptides, proteins, toxins, toxicants, poisons, insecticides, pesticides, organic compounds, inorganic compounds, prokaryote organisms, or eukaryote organisms, and the agents produced by said prokaryote or eukaryote organisms, will depend on the insect pest to be targeted, and the need of the user.

Furthermore, any of the foregoing combinations or compositions comprising a CRIP and a Bt toxin, can be can be applied to the crop area or plant to be treated, simultaneously or in succession, with other compounds. For example, in some embodiments, these compounds can be fertilizers, weed killers, cryoprotectants, surfactants, detergents, pesticidal soaps, dormant oils, polymers, and/or time-release or biodegradable carrier formulations that permit long-term dosing of a target area following a single application of the formulation. The other compounds can also be selective herbicides, chemical insecticides, virucides, microbicides, amoebicides, pesticides, fungicides, bacteriocides, nematocides, molluscicides or combinations of several of these preparations, if desired, together with further agriculturally acceptable carriers, surfactants or application-promoting adjuvants customarily employed in the art of formulation. In some embodiments, suitable carriers and adjuvants can be solid or liquid, and correspond to the substances ordinarily employed in formulation technology, e.g. natural or regenerated mineral substances, solvents, dispersants, wetting agents, tackifiers, binders or fertilizers. Likewise, any of the foregoing combinations, compositions, or formulations may be prepared into edible “baits” or fashioned into pest “traps” to permit feeding or ingestion by a target pest of the pesticidal formulation.

Methods of Using the Present Invention

Methods for Protecting Plants, Plant Parts, and Seeds

In some embodiments, the present disclosure comprises a method for controlling an invertebrate pest in agronomic and/or nonagronomic applications, comprising contacting the invertebrate pest or its environment, a solid surface, including a plant surface or part thereof, with a biologically effective amount of a combination of one or more CRIPs (e.g., one or more of CRIPs: A1-A68 in Table A) and one or more IAs (e.g., one or more of IAs: B1-B479 in Table B).

In some embodiments, the present disclosure comprises a method for controlling an invertebrate pest in agronomic and/or nonagronomic applications, comprising contacting the invertebrate pest or its environment, a solid surface, including a plant surface or part thereof, with a biologically effective amount of a composition or a combination of one or more CRIPs (e.g., one or more of CRIPs: A1-A68 in Table A) and one or more IAs (e.g., one or more of IAs: B1-B479 in Table B). Examples of suitable compositions comprising one or more CRIPs (e.g., one or more of CRIPs: A1-A68 in Table A) and one or more IAs (e.g., one or more of IAs: B1-B479 in Table B) include a liquid solution, an emulsion, a powder, a granule, a nanoparticle, a microparticle, or a combination of the above formulated into a composition wherein either one or more CRIPs (e.g., one or more of CRIPs: A1-A68 in Table A) is present on, or in the same composition as the one or more IAs (e.g., one or more of IAs: B1-B479 in Table B) (e.g., a part of a granular composition, or on granules separate.

In some embodiments, to achieve contact with a compound, combination, or composition of the invention to protect a field crop from invertebrate pests, the compound or composition is typically applied to the seed of the crop before planting, to the foliage (e.g., leaves, stems, flowers, fruits) of crop plants, or to the soil or other growth medium before or after the crop is planted.

One embodiment of a method of contact is by spraying. Alternatively, a granular composition comprising a one or more CRIPs (e.g., one or more of CRIPs: A1-A68 in Table A) and one or more IAs (e.g., one or more of IAs: B1-B479 in Table B) of the invention can be applied to the plant foliage or the soil. Compounds of this invention can also be effectively delivered through plant uptake by contacting the plant with a composition comprising a compound of this invention applied as a soil drench of a liquid formulation, a granular formulation to the soil, a nursery box treatment or a dip of transplants. Of note is a composition of the present disclosure in the form of a soil drench liquid formulation. Also of note is a method for controlling an invertebrate pest comprising contacting the invertebrate pest or its environment with a biologically effective amount of a one or more CRIPs (e.g., one or more of CRIPs: A1-A68 in Table A) and one or more IAs (e.g., one or more of IAs: B1-B479 in Table B), or with a composition comprising a biologically effective amount of a one or more CRIPs (e.g., one or more of CRIPs: A1-A68 in Table A) and one or more IAs (e.g., one or more of IAs: B1-B479 in Table B). Of further note, in some illustrative embodiments, the illustrative method includes wherein the environment is soil and the composition is applied to the soil as a soil drench formulation. Of further note is that a one or more CRIPs (e.g., one or more of CRIPs: A1-A68 in Table A) and one or more IAs (e.g., one or more of IAs: B1-B479 in Table B), is also effective by localized application to the locus of infestation. Other methods of contact include application of a compound or a composition of the invention by direct and residual sprays, aerial sprays, gels, seed coatings, microencapsulations, systemic uptake, baits, ear tags, boluses, foggers, fumigants, aerosols, dusts and many others. One embodiment of a method of contact is a dimensionally stable fertilizer granule, stick or tablet comprising a compound or composition of the invention. The compounds of this invention can also be impregnated into materials for fabricating invertebrate control devices (e.g., insect netting, application onto clothing, application into candle formulations and the like).

In some embodiments, a combination comprising one or more CRIPs (e.g., one or more of CRIPs: A1-A68 in Table A) and one or more IAs (e.g., one or more of IAs: B1-B479 in Table B) is also useful in seed treatments for protecting seeds from invertebrate pests. In the context of the present disclosure and claims, treating a seed means contacting the seed with a biologically effective amount of a combination comprising one or more CRIPs (e.g., one or more of CRIPs: A1-A68 in Table A) and one or more IAs (e.g., one or more of IAs: B1-B479 in Table B), which is typically formulated as a composition of the invention. This seed treatment protects the seed from invertebrate soil pests and generally can also protect roots and other plant parts in contact with the soil of the seedling developing from the germinating seed. The seed treatment may also provide protection of foliage by translocation of the combination comprising one or more CRIPs (e.g., one or more of CRIPs: A1-A68 in Table A) and one or more IAs (e.g., one or more of IAs: B1-B479 in Table B) within the developing plant. Seed treatments can be applied to all types of seeds, including those from which plants genetically transformed to express specialized traits will germinate. In addition, a combination comprising one or more CRIPs (e.g., one or more of CRIPs: A1-A68 in Table A) and one or more IAs (e.g., one or more of IAs: B1-B479 in Table B) can be transformed into a plant or part thereof, for example a plant cell, or plant seed, that is already transformed with proteins toxic to invertebrate pests, such as Bacillus thuringiensis toxins or protein crystals or those expressing herbicide resistance such as glyphosate acetyltransferase, which provides resistance to glyphosate. Representative examples include those expressing proteins toxic to invertebrate pests, such as Bacillus thuringiensis toxins and/or protein crystals, or those expressing herbicide resistance such as glyphosate acetyltransferase, which provides resistance to glyphosate.

One method of seed treatment is by spraying or dusting the seed with a combination comprising one or more CRIPs (e.g., one or more of CRIPs: A1-A68 in Table A) and one or more IAs (e.g., one or more of IAs: B1-B479 in Table B) (i.e. as a formulated composition or a combination) before sowing the seeds. Compositions formulated for seed treatment generally comprise a film former or adhesive agent. Therefore, typically, a seed coating composition of the present disclosure comprises a biologically effective amount of a combination comprising one or more CRIPs (e.g., one or more of CRIPs: A1-A68 in Table A) and one or more IAs (e.g., one or more of IAs: B1-B479 in Table B), and a film former or adhesive agent. Seed can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Monograph No. 57, and references listed therein, the disclosures of which are incorporated herein by reference in their entireties.

The treated seed typically comprises a combination comprising one or more CRIPs (e.g., one or more of CRIPs: A1-A68 in Table A) and one or more IAs (e.g., one or more of IAs: B1-B479 in Table B) in an amount ranging from about 0.01 g to 1 kg per 100 kg of seed (i.e. from about 0.00001 to 1% by weight of the seed before treatment). A flowable suspension formulated for seed treatment typically comprises from about 0.5 to about 70% of the active ingredient, from about 0.5 to about 30% of a film-forming adhesive, from about 0.5 to about 20% of a dispersing agent, from 0 to about 5% of a thickener, from 0 to about 5% of a pigment and/or dye, from 0 to about 2% of an antifoaming agent, from 0 to about 1% of a preservative, and from 0 to about 75% of a volatile liquid diluent.

Methods of Using Combinations and Compositions

In some embodiments, the present invention provides a method of using a combination comprising one or more CRIPs (e.g., one or more of CRIPs: A1-A68 in Table A) and one or more IAs (e.g., one or more of IAs: B1-B479 in Table B) wherein the combination results in an insecticidal effect; to control insects, said method comprising, providing a combination comprising one or more CRIPs (e.g., one or more of CRIPs: A1-A68 in Table A) and one or more IAs (e.g., one or more of IAs: B1-B479 in Table B); and then applying said combination to the locus of an insect.

In some embodiments, the present invention provides a method of using a combination comprising one or more CRIPs (e.g., one or more of CRIPs: A1-A68 in Table A) and one or more IAs (e.g., one or more of IAs: B1-B479 in Table B); and wherein the combination results in an insecticidal effect; to control insects, wherein the insects are selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of using a combination comprising one or more CRIPs (e.g., one or more of CRIPs: A1-A68 in Table A) and one or more IAs (e.g., one or more of IAs: B1-B479 in Table B); and wherein the combination results in an insecticidal effect; to control Bacillus thuringiensis-toxin-resistant insects comprising, providing a combination comprising one or more CRIPs (e.g., one or more of CRIPs: A1-A68 in Table A) and one or more IAs (e.g., one or more of IAs: B1-B479 in Table B); and then applying said combination to the locus of an insect.

In some embodiments, the present invention provides a method of using a combination comprising one or more CRIPs (e.g., one or more of CRIPs: A1-A68 in Table A) and one or more IAs (e.g., one or more of IAs: B1-B479 in Table B) wherein the combination results in an insecticidal effect; to control Bacillus thuringiensis-toxin-resistant insects, wherein the Bacillus thuringiensis-toxin-resistant insects are selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of combating, controlling, or inhibiting a pest comprising, applying a pesticidally effective amount of a combination comprising one or more CRIPs (e.g., one or more of CRIPs: A1-A68 in Table A) and one or more IAs (e.g., one or more of IAs: B1-B479 in Table B) wherein the combination results in an insecticidal effect; to the locus of the pest, or to a plant or animal susceptible to an attack by the pest; wherein the combination of each insecticidal peptide results in an insecticidal effect.

In some embodiments, the present invention provides a method of combating, controlling, or inhibiting a pest comprising, applying a pesticidally effective amount of a combination comprising one or more CRIPs (e.g., one or more of CRIPs: A1-A68 in Table A) and one or more IAs (e.g., one or more of IAs: B1-B479 in Table B) to the locus of the pest, or to a plant or animal susceptible to an attack by the pest; wherein the combination of each insecticidal peptide results in an insecticidal effect; wherein the pest is selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of combating, controlling, or inhibiting a pest comprising, applying a pesticidally effective amount of a combination comprising one or more CRIPs (e.g., one or more of CRIPs: A1-A68 in Table A) and one or more IAs (e.g., one or more of IAs: B1-B479 in Table B) to the locus of the pest, or to a plant or animal susceptible to an attack by the pest; wherein the combination of each insecticidal peptide results in an insecticidal effect; wherein the pest is selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

Combinations: Exemplary Combination of Bt Toxins and WT-Ta1b

In some embodiments, a combination or composition comprises, consists essentially of, or consists of: a U1-agatoxin-Ta1b peptide having an amino acid sequence according to the amino acid sequence set forth in SEQ ID NO: 1, and a bacterial toxin, wherein the bacterial toxin is a Bacillus thuringiensis (Bt) toxin.

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, a combination or composition comprises, consists essentially of, or consists of: a U1-agatoxin-Ta1b peptide having an amino acid sequence according to the amino acid sequence set forth in SEQ ID NO: 1, and a parasporal crystal toxin, wherein the parasporal crystal toxin is a δ-endotoxin.

In some embodiments, a combination or composition comprises, consists essentially of, or consists of: a U1-agatoxin-Ta1b peptide having an amino acid sequence according to the amino acid sequence set forth in SEQ ID NO: 1, and a δ-endotoxin, wherein the δ-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, a combination or composition comprises, consists essentially of, or consists of: a U1-agatoxin-Ta1b peptide having an amino acid sequence according to the amino acid sequence set forth in SEQ ID NO: 1, and a δ-endotoxin, wherein the δ-endotoxin is a Three-domain (3D) Cry toxin, a mosquitocidal Cry toxin (Mtx), a binary-like (Bin) toxin, or a Cyt toxin.

In some embodiments, a combination or composition comprises, consists essentially of, or consists of: a U1-agatoxin-Ta1b peptide having an amino acid sequence according to the amino acid sequence set forth in SEQ ID NO: 1, and a δ-endotoxin, wherein the δ-endotoxin is a Three-domain (3D) Cry toxin or a Cyt toxin.

In some embodiments, a combination or composition comprises, consists essentially of, or consists of: a U+2-ACTX-Hv1a toxin having an amino acid sequence according to the amino acid sequence set forth in SEQ ID NO: 61, and a δ-endotoxin, wherein the δ-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Aa1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ia1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32 Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, a combination or composition comprises, consists essentially of, or consists of: a U1-agatoxin-Ta1b peptide having an amino acid sequence according to the amino acid sequence set forth in SEQ ID NO: 1, and a Cry toxin, or a Cyt toxin, wherein the Cry toxin or Cyt toxin has an amino acid sequence according to SEQ ID NOs: 412-481.

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is a secreted protein.

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is a secreted protein, wherein the secreted protein is a vegetative insecticidal protein (Vip), a secreted insecticidal protein (Sip), a Bin-like family protein, or an ETX_MTX2-family protein.

In some embodiments, a combination or composition comprises, consists essentially of, or consists of: a U1-agatoxin-Ta1b peptide having an amino acid sequence according to the amino acid sequence set forth in SEQ ID NO: 1, and a Bt toxin, wherein the Bt toxin is a secreted protein, and wherein the secreted protein is a Vip.

In some embodiments, a combination or composition comprises, consists essentially of, or consists of: a U1-agatoxin-Ta1b peptide having an amino acid sequence according to the amino acid sequence set forth in SEQ ID NO: 1, and a Vip, wherein the Vip is a Vip 1 family protein, a Vip 2 family protein, a Vip 3 family protein, or a Vip 4 family protein.

In some embodiments, a combination or composition comprises, consists essentially of, or consists of: a U1-agatoxin-Ta1b peptide having an amino acid sequence according to the amino acid sequence set forth in SEQ ID NO: 1, and a Vip, wherein the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, a combination or composition comprises, consists essentially of, or consists of: a U1-agatoxin-Ta1b peptide having an amino acid sequence according to the amino acid sequence set forth in SEQ ID NO: 1, and a Vip, wherein the Vip protein has an amino acid sequence according to the amino acid sequence set forth in SEQ ID NOs: 482-587.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp. tenebrionis strain NB-176; or a Bacillus thuringiensis ssp. israelensis strain BMP 144; and a U1-agatoxin-Ta1b peptide having an amino acid sequence according to the amino acid sequence set forth in SEQ ID NO: 1.

In some embodiments, a combination or composition comprises, consists essentially of, or consists of: one or more fermentation solids, spores, or toxins isolated from a Bacillus thuringiensis ssp. kurstaki strain EVB-113-19, and a U1-agatoxin-Ta1b peptide having an amino acid sequence according to the amino acid sequence set forth in SEQ ID NO: 1.

In some embodiments, a combination or composition comprises, consists essentially of, or consists of: a U1-agatoxin-Ta1b peptide having an amino acid sequence according to the amino acid sequence set forth in SEQ ID NO: 1, and one or more fermentation solids, spores, or toxins isolated from a Bacillus thuringiensis ssp. kurstaki strain EVB-113-19, wherein the combination or composition comprises a concentration of U1-agatoxin-Ta1b peptide having an amino acid sequence according to the amino acid sequence set forth in SEQ ID NO: 1 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U1-agatoxin-Ta1b peptide having an amino acid sequence according to the amino acid sequence set forth in SEQ ID NO: 1, and one or more fermentation solids, spores, or toxins isolated from a Bacillus thuringiensis ssp. kurstaki strain EVB-113-19, wherein the combination or composition comprises a concentration of one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Bt Toxins and TVPs

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a bacterial toxin, wherein the bacterial toxin is a Bacillus thuringiensis (Bt) toxin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a parasporal crystal toxin, wherein the parasporal crystal toxin is a δ-endotoxin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a δ-endotoxin, wherein the δ-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a δ-endotoxin, wherein the δ-endotoxin is a Three-domain (3D) Cry toxin, a mosquitocidal Cry toxin (Mtx), a binary-like (Bin) toxin, or a Cyt toxin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a δ-endotoxin, wherein the δ-endotoxin is a Three-domain (3D) Cry toxin or a Cyt toxin.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a δ-endotoxin, wherein the δ-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ja1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Cry toxin, or a Cyt toxin, wherein the Cry toxin or Cyt toxin has an amino acid sequence according to SEQ ID NOs: 412-481.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is a secreted protein.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is a secreted protein, wherein the secreted protein is a vegetative insecticidal protein (Vip), a secreted insecticidal protein (Sip), a Bin-like family protein, or an ETX_MTX2-family protein.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Bt toxin, wherein the Bt toxin is a secreted protein, and wherein the secreted protein is a Vip.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Vip, wherein the Vip is a Vip 1 family protein, a Vip 2 family protein, a Vip 3 family protein, or a Vip 4 family protein.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Vip, wherein the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and a Vip, wherein the Vip protein has an amino acid sequence according to the amino acid sequence set forth in SEQ ID NOs: 482-587.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp. tenebrionis strain NB-176; or a Bacillus thuringiensis ssp. israelensis strain BMP 144; and a U1-agatoxin-Ta1b Variant Polypeptide (TVP) having an amino acid sequence according to the amino acid sequence set forth in SEQ ID NO: 2.

In some embodiments, a combination or composition comprises, consists essentially of, or consists of: one or more fermentation solids, spores, or toxins isolated from a Bacillus thuringiensis ssp. kurstaki strain EVB-113-19, and a U1-agatoxin-Ta1b Variant Polypeptide (TVP) having an amino acid sequence according to the amino acid sequence set forth in SEQ ID NO: 2.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp.

tenebrionis strain NB-176; or a Bacillus thuringiensis ssp. israelensis strain BMP 144; and a U1-agatoxin-Ta1b Variant Polypeptide (TVP) having an amino acid sequence according to the amino acid sequence set forth in SEQ ID NO: 51.

In some embodiments, a combination or composition comprises, consists essentially of, or consists of: one or more fermentation solids, spores, or toxins isolated from a Bacillus thuringiensis ssp. kurstaki strain EVB-113-19, and a U1-agatoxin-Ta1b Variant Polypeptide (TVP) having an amino acid sequence according to the amino acid sequence set forth in SEQ ID NO: 51.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and one or more fermentation solids, spores, or toxins isolated from a Bacillus thuringiensis ssp. kurstaki strain EVB-113-19, wherein the combination or composition comprises a concentration of U1-agatoxin-Ta1b Variant Polypeptide (TVP) having an amino acid sequence according to the amino acid sequence set forth in SEQ ID NO: 2 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 51, and one or more fermentation solids, spores, or toxins isolated from a Bacillus thuringiensis ssp. kurstaki strain EVB-113-19, wherein the combination or composition comprises a concentration of U1-agatoxin-Ta1b Variant Polypeptide (TVP) having an amino acid sequence according to the amino acid sequence set forth in SEQ ID NO: 51 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 2, and one or more fermentation solids, spores, or toxins isolated from a Bacillus thuringiensis ssp. kurstaki strain EVB-113-19, wherein the combination or composition comprises a concentration of one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U1-agatoxin-Ta1b Variant Polypeptide (TVP) having an amino acid sequence according to the amino acid sequence set forth in SEQ ID NO: 51, and one or more fermentation solids, spores, or toxins isolated from a Bacillus thuringiensis ssp. kurstaki strain EVB-113-19, wherein the combination or composition comprises a concentration of one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Bt Toxins and AVPs

In some embodiments, a combination or composition comprises, consists essentially of, or consists of: an Av3-Variant Polypeptide (AVP) having an amino acid sequence according to the amino acid sequence set forth in SEQ ID NO: 67, and a bacterial toxin, wherein the bacterial toxin is a Bacillus thuringiensis (Bt) toxin.

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX2 7; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, a combination or composition comprises, consists essentially of, or consists of: an Av3-Variant Polypeptide (AVP) having an amino acid sequence according to the amino acid sequence set forth in SEQ ID NO: 67, and a parasporal crystal toxin, wherein the parasporal crystal toxin is a δ-endotoxin.

In some embodiments, a combination or composition comprises, consists essentially of, or consists of: an Av3-Variant Polypeptide (AVP) having an amino acid sequence according to the amino acid sequence set forth in SEQ ID NO: 67, and a 6-endotoxin, wherein the δ-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, a combination or composition comprises, consists essentially of, or consists of: an Av3-Variant Polypeptide (AVP) having an amino acid sequence according to the amino acid sequence set forth in SEQ ID NO: 67, and a 6-endotoxin, wherein the δ-endotoxin is a Three-domain (3D) Cry toxin, a mosquitocidal Cry toxin (Mtx), a binary-like (Bin) toxin, or a Cyt toxin.

In some embodiments, a combination or composition comprises, consists essentially of, or consists of: an Av3-Variant Polypeptide (AVP) having an amino acid sequence according to the amino acid sequence set forth in SEQ ID NO: 67, and a 6-endotoxin, wherein the δ-endotoxin is a Three-domain (3D) Cry toxin or a Cyt toxin.

In some embodiments, a combination or composition comprises, consists essentially of, or consists of: an Av3-Variant Polypeptide (AVP) having an amino acid sequence according to the amino acid sequence set forth in SEQ ID NO: 67, and a 6-endotoxin, wherein the δ-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ja1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, a combination or composition comprises, consists essentially of, or consists of: an Av3-Variant Polypeptide (AVP) having an amino acid sequence according to the amino acid sequence set forth in SEQ ID NO: 67, and a Cry toxin, or a Cyt toxin, wherein the Cry toxin or Cyt toxin has an amino acid sequence according to SEQ ID NOs: 412-481.

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is a secreted protein.

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is a secreted protein, wherein the secreted protein is a vegetative insecticidal protein (Vip), a secreted insecticidal protein (Sip), a Bin-like family protein, or an ETX_MTX2-family protein.

In some embodiments, a combination or composition comprises, consists essentially of, or consists of: an Av3-Variant Polypeptide (AVP) having an amino acid sequence according to the amino acid sequence set forth in SEQ ID NO: 67, and a Bt toxin, wherein the Bt toxin is a secreted protein, and wherein the secreted protein is a Vip.

In some embodiments, a combination or composition comprises, consists essentially of, or consists of: an Av3-Variant Polypeptide (AVP) having an amino acid sequence according to the amino acid sequence set forth in SEQ ID NO: 67, and a Vip, wherein the Vip is a Vip 1 family protein, a Vip 2 family protein, a Vip 3 family protein, or a Vip 4 family protein.

In some embodiments, a combination or composition comprises, consists essentially of, or consists of: an Av3-Variant Polypeptide (AVP) having an amino acid sequence according to the amino acid sequence set forth in SEQ ID NO: 67, and a Vip, wherein the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, a combination or composition comprises, consists essentially of, or consists of: an Av3-Variant Polypeptide (AVP) having an amino acid sequence according to the amino acid sequence set forth in SEQ ID NO: 67, and a Vip, wherein the Vip protein has an amino acid sequence according to the amino acid sequence set forth in SEQ ID NOs: 482-587.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp. tenebrionis strain NB-176; or a Bacillus thuringiensis ssp. israelensis strain BMP 144; and an Av3-Variant Polypeptide (AVP) having an amino acid sequence according to the amino acid sequence set forth in SEQ ID NO: 67.

In some embodiments, a combination or composition comprises, consists essentially of, or consists of: one or more fermentation solids, spores, or toxins isolated from a Bacillus thuringiensis ssp. kurstaki strain EVB-113-19, and an Av3-Variant Polypeptide (AVP) having an amino acid sequence according to the amino acid sequence set forth in SEQ ID NO: 67.

In some embodiments, a combination or composition comprises, consists essentially of, or consists of: an Av3-Variant Polypeptide (AVP) having an amino acid sequence according to the amino acid sequence set forth in SEQ ID NO: 67, and one or more fermentation solids, spores, or toxins isolated from a Bacillus thuringiensis ssp. kurstaki strain EVB-113-19, wherein the combination or composition comprises a concentration of one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: an Av3-Variant Polypeptide (AVP) having an amino acid sequence according to the amino acid sequence set forth in SEQ ID NO: 67, and one or more fermentation solids, spores, or toxins isolated from a Bacillus thuringiensis ssp. kurstaki strain EVB-113-19, wherein the combination or composition comprises a concentration of an Av3-Variant Polypeptide (AVP) having an amino acid sequence according to the amino acid sequence set forth in SEQ ID NO: 67 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Bt Toxins and Γ-CNTX-Pn1a

In some embodiments, a combination or composition comprises, consists essentially of, or consists of: a Γ-CNTX-Pn1a toxin having an amino acid sequence according to the amino acid sequence set forth in SEQ ID NO: 65, and a bacterial toxin, wherein the bacterial toxin is a Bacillus thuringiensis (Bt) toxin.

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, a combination or composition comprises, consists essentially of, or consists of: a Γ-CNTX-Pn1a toxin having an amino acid sequence according to the amino acid sequence set forth in SEQ ID NO: 65, and a parasporal crystal toxin, wherein the parasporal crystal toxin is a δ-endotoxin.

In some embodiments, a combination or composition comprises, consists essentially of, or consists of: a Γ-CNTX-Pn1a toxin having an amino acid sequence according to the amino acid sequence set forth in SEQ ID NO: 65, and a δ-endotoxin, wherein the 6-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, a combination or composition comprises, consists essentially of, or consists of: a Γ-CNTX-Pn1a toxin having an amino acid sequence according to the amino acid sequence set forth in SEQ ID NO: 65, and a δ-endotoxin, wherein the 6-endotoxin is a Three-domain (3D) Cry toxin, a mosquitocidal Cry toxin (Mtx), a binary-like (Bin) toxin, or a Cyt toxin.

In some embodiments, a combination or composition comprises, consists essentially of, or consists of: a Γ-CNTX-Pn1a toxin having an amino acid sequence according to the amino acid sequence set forth in SEQ ID NO: 65, and a δ-endotoxin, wherein the 6-endotoxin is a Three-domain (3D) Cry toxin or a Cyt toxin.

In some embodiments, a combination or composition comprises, consists essentially of, or consists of: a Γ-CNTX-Pn1a toxin having an amino acid sequence according to the amino acid sequence set forth in SEQ ID NO: 65, and a δ-endotoxin, wherein the 6-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ab10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ia1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32 Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, a combination or composition comprises, consists essentially of, or consists of: a Γ-CNTX-Pn1a toxin having an amino acid sequence according to the amino acid sequence set forth in SEQ ID NO: 65, and a Cry toxin, or a Cyt toxin, wherein the Cry toxin or Cyt toxin has an amino acid sequence according to SEQ ID NOs: 412-481.

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is a secreted protein.

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is a secreted protein, wherein the secreted protein is a vegetative insecticidal protein (Vip), a secreted insecticidal protein (Sip), a Bin-like family protein, or an ETX_MTX2-family protein.

In some embodiments, a combination or composition comprises, consists essentially of, or consists of: a Γ-CNTX-Pn1a toxin having an amino acid sequence according to the amino acid sequence set forth in SEQ ID NO: 65, and a Bt toxin, wherein the Bt toxin is a secreted protein, and wherein the secreted protein is a Vip.

In some embodiments, a combination or composition comprises, consists essentially of, or consists of: a Γ-CNTX-Pn1a toxin having an amino acid sequence according to the amino acid sequence set forth in SEQ ID NO: 65, and a Vip, wherein the Vip is a Vip 1 family protein, a Vip 2 family protein, a Vip 3 family protein, or a Vip 4 family protein.

In some embodiments, a combination or composition comprises, consists essentially of, or consists of: a Γ-CNTX-Pn1a toxin having an amino acid sequence according to the amino acid sequence set forth in SEQ ID NO: 65, and a Vip, wherein the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, a combination or composition comprises, consists essentially of, or consists of: a Γ-CNTX-Pn1a toxin having an amino acid sequence according to the amino acid sequence set forth in SEQ ID NO: 65, and a Vip, wherein the Vip protein has an amino acid sequence according to the amino acid sequence set forth in SEQ ID NOs: 482-587.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp. tenebrionis strain NB-176; or a Bacillus thuringiensis ssp. israelensis strain BMP 144; and a Γ-CNTX-Pn1a toxin having an amino acid sequence according to the amino acid sequence set forth in SEQ ID NO: 65.

In some embodiments, a combination or composition comprises, consists essentially of, or consists of: one or more fermentation solids, spores, or toxins isolated from a Bacillus thuringiensis ssp. kurstaki strain EVB-113-19, and a Γ-CNTX-Pn1a toxin having an amino acid sequence according to the amino acid sequence set forth in SEQ ID NO: 65.

In some embodiments, a combination or composition comprises, consists essentially of, or consists of: a Γ-CNTX-Pn1a toxin having an amino acid sequence according to the amino acid sequence set forth in SEQ ID NO: 65, and one or more fermentation solids, spores, or toxins isolated from a Bacillus thuringiensis ssp. kurstaki strain EVB-113-19, wherein the combination or composition comprises a concentration of the Γ-CNTX-Pn1a toxin having an amino acid sequence according to the amino acid sequence set forth in SEQ ID NO: 65 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a Γ-CNTX-Pn1a toxin having an amino acid sequence according to the amino acid sequence set forth in SEQ ID NO: 65, and one or more fermentation solids, spores, or toxins isolated from a Bacillus thuringiensis ssp. kurstaki strain EVB-113-19, wherein the combination or composition comprises a concentration of the one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Fungal Toxins and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a fungal toxin.

In some embodiments, a combination or composition comprises, consists essentially of, or consists of: a U+2-ACTX-Hv1a toxin having an amino acid sequence according to the amino acid sequence set forth in SEQ ID NO: 61, and a fungal toxin, wherein the fungal toxin is an Ascomycete fungal toxin.

In some embodiments, a combination or composition comprises, consists essentially of, or consists of: a U+2-ACTX-Hv1a toxin having an amino acid sequence according to the amino acid sequence set forth in SEQ ID NO: 61, and a fungal toxin, wherein the fungal toxin is a Akanthomyces toxin; a Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, a combination or composition comprises, consists essentially of, or consists of: a U+2-ACTX-Hv1a toxin having an amino acid sequence according to the amino acid sequence set forth in SEQ ID NO: 61, and a fungi organism or toxin therefrom, wherein the fungi organism or toxin therefrom is selected from the following genera: Beauveria; Metarhizium; Paecilomyces; Lecanicillium; Nomuraea; Isaria; Hirsutella; Sorosporella; Aspergillus; Cordiceps; Entomophthora; Zoophthora; Pandora; Entomophaga; Conidiobolus and Basidiobolus.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria toxin.

In some embodiments, a combination or composition comprises, consists essentially of, or consists of: a U+2-ACTX-Hv1a toxin having an amino acid sequence according to the amino acid sequence set forth in SEQ ID NO: 61, and one of the following toxins: a Beauveria alba toxin; a Beauveria amorpha toxin; a Beauveria arenaria toxin; a Beauveria asiatica toxin; a Beauveria australis toxin; a Beauveria bassiana toxin; a Cordyceps bassiana toxin; a Beauveria brongniartii toxin; a Beauveria brumptii toxin; a Beauveria caledonica toxin; a Beauveria chiromensis toxin; a Beauveria coccorum toxin; a Beauveria cretacea toxin; a Beauveria cylindrospora toxin; a Beauveria delacroixii toxin; a Beauveria densa toxin; a Beauveria dependens toxin; a Beauveria doryphorae toxin; a Beauveria effusa toxin; a Beauveria epigaea toxin; a Beauveria felina toxin; a Beauveria geodes toxin; a Beauveria globulifera toxin; a Beauveria heimii toxin; a Beauveria hoplocheli toxin; a Beauveria kipukae toxin; a Beauveria laxa toxin; a Beauveria malawiensis toxin; a Beauveria medogensis toxin; a Beauveria melolonthae toxin; a Beauveria nubicola toxin; a Beauveria oryzae toxin; a Beauveria paradoxa toxin; a Beauveria paranensis toxin; a Beauveria parasitica toxin; a Beauveria petelotii toxin; a Beauveria pseudobassiana toxin; a Beauveria rileyi toxin; a Beauveria rubra toxin; a Beauveria shiotae toxin; a Beauveria sobolifera toxin; a Beauveria spicata toxin; a Beauveria stephanoderis toxin; a Beauveria sulfurescens toxin; a Beauveria sungii toxin; a Beauveria tenella toxin; a Beauveria tundrensis toxin; a Beauveria velata toxin; a Beauveria varroae toxin; a Beauveria vermiconia toxin; a Beauveria vexans toxin; a Beauveria viannai toxin; or a Beauveria virella toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana toxin, wherein the Beauveria bassiana toxin is beauvericin.

In some embodiments, a combination or composition comprises, consists essentially of, or consists of: a U+2-ACTX-Hv1a toxin having an amino acid sequence according to the amino acid sequence set forth in SEQ ID NO: 61, and beauvericin, wherein the beauvericin has the chemical formula C₄₅H₅₇N₃O₉.

In some embodiments, a combination or composition comprises, consists essentially of, or consists of: a U+2-ACTX-Hv1a toxin having an amino acid sequence according to the amino acid sequence set forth in SEQ ID NO: 61, and beauvericin, wherein the beauvericin is a “Beauvericin A” toxin having the chemical formula C₄₆H₅₉N₃O₉.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria toxin, wherein the beauvericin toxin is a beauvericin toxin having the chemical formula C₄₅H₅₇N₃O₉; a beauvericin A toxin having the chemical formula C₄₆H₅₉N₃O₉; or a beauvericin B toxin having the chemical formula C₄₇H₆₁N₃O₉.

In some embodiments, a combination or composition comprises, consists essentially of, or consists of: a U+2-ACTX-Hv1a toxin having an amino acid sequence according to the amino acid sequence set forth in SEQ ID NO: 61, and beauvericin, wherein the beauvericin is a “Beauvericin B” toxin having the chemical formula C₄₇H₆₁N₃O₉.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana organism.

In some embodiments, a combination or composition comprises, consists essentially of, or consists of: a U+2-ACTX-Hv1a toxin having an amino acid sequence according to the amino acid sequence set forth in SEQ ID NO: 61, and a spore isolated from a Beauveria bassiana organism.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana organism, wherein the Beauveria bassiana organism is a Beauveria bassiana strain ANT-03.

In some embodiments, a combination or composition comprises, consists essentially of, or consists of: a U+2-ACTX-Hv1a toxin having an amino acid sequence according to the amino acid sequence set forth in SEQ ID NO: 61, and a spore isolated from a Beauveria bassiana organism, wherein the Beauveria bassiana spore is a Beauveria bassiana strain ANT-03 spore.

In some embodiments, a combination or composition comprises, consists essentially of, or consists of: a U+2-ACTX-Hv1a toxin having an amino acid sequence according to the amino acid sequence set forth in SEQ ID NO: 61, and a an Ascomycete fungal toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Cordycipitaceae family fungal toxin.

In some embodiments, a combination or composition comprises, consists essentially of, or consists of: a U+2-ACTX-Hv1a toxin having an amino acid sequence according to the amino acid sequence set forth in SEQ ID NO: 61, and a an Akanthomyces toxin; an Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, a combination or composition comprises, consists essentially of, or consists of: a Beauveria bassiana strain ANT-03 spore, and a U+2-ACTX-Hv1a toxin having an amino acid sequence according to the amino acid sequence set forth in SEQ ID NO: 61.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana strain ANT-03 spore, wherein the combination or composition comprises a concentration of the Beauveria bassiana strain ANT-03 spore ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a Beauveria bassiana strain ANT-03 spore, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Bt Toxins and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a bacterial toxin, wherein the bacterial toxin is a Bacillus thuringiensis (Bt) toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is a parasporal crystal toxin, a secreted protein, a β-exotoxin, a 41.9-kDa insecticidal toxin, a sphaericolysin, an alveolysin, or an enhancin-like protein.

In some embodiments, a combination or composition comprises, consists essentially of, or consists of: a U+2-ACTX-Hv1a toxin having an amino acid sequence according to the amino acid sequence set forth in SEQ ID NO: 61, and a parasporal crystal toxin, wherein the parasporal crystal toxin is a δ-endotoxin.

In some embodiments, a combination or composition comprises, consists essentially of, or consists of: a U+2-ACTX-Hv1a toxin having an amino acid sequence according to the amino acid sequence set forth in SEQ ID NO: 61, and a δ-endotoxin, wherein the δ-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, a combination or composition comprises, consists essentially of, or consists of: a U+2-ACTX-Hv1a toxin having an amino acid sequence according to the amino acid sequence set forth in SEQ ID NO: 61, and a δ-endotoxin, wherein the δ-endotoxin is a Three-domain (3D) Cry toxin, a mosquitocidal Cry toxin (Mtx), a binary-like (Bin) toxin, or a Cyt toxin.

In some embodiments, a combination or composition comprises, consists essentially of, or consists of: a U+2-ACTX-Hv1a toxin having an amino acid sequence according to the amino acid sequence set forth in SEQ ID NO: 61, and a δ-endotoxin, wherein the δ-endotoxin is a Three-domain (3D) Cry toxin or a Cyt toxin.

In some embodiments, a combination or composition comprises, consists essentially of, or consists of: a U+2-ACTX-Hv1a toxin having an amino acid sequence according to the amino acid sequence set forth in SEQ ID NO: 61, and a δ-endotoxin, wherein the δ-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Aa1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ia1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32 Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, a combination or composition comprises, consists essentially of, or consists of: a U+2-ACTX-Hv1a toxin having an amino acid sequence according to the amino acid sequence set forth in SEQ ID NO: 61, and a Cry toxin, or a Cyt toxin, wherein the Cry toxin or Cyt toxin has an amino acid sequence according to SEQ ID NOs: 412-481.

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is a secreted protein.

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is a secreted protein, wherein the secreted protein is a vegetative insecticidal protein (Vip), a secreted insecticidal protein (Sip), a Bin-like family protein, or an ETX_MTX2-family protein.

In some embodiments, a combination or composition comprises, consists essentially of, or consists of: a U+2-ACTX-Hv1a toxin having an amino acid sequence according to the amino acid sequence set forth in SEQ ID NO: 61, and a Bt toxin, wherein the Bt toxin is a secreted protein, and wherein the secreted protein is a Vip.

In some embodiments, a combination or composition comprises, consists essentially of, or consists of: a U+2-ACTX-Hv1a toxin having an amino acid sequence according to the amino acid sequence set forth in SEQ ID NO: 61, and a Vip, wherein the Vip is a Vip 1 family protein, a Vip 2 family protein, a Vip 3 family protein, or a Vip 4 family protein.

In some embodiments, a combination or composition comprises, consists essentially of, or consists of: a U+2-ACTX-Hv1a toxin having an amino acid sequence according to the amino acid sequence set forth in SEQ ID NO: 61, and a Vip, wherein the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, a combination or composition comprises, consists essentially of, or consists of: a U+2-ACTX-Hv1a toxin having an amino acid sequence according to the amino acid sequence set forth in SEQ ID NO: 61, and a Vip, wherein the Vip protein has an amino acid sequence according to the amino acid sequence set forth in SEQ ID NOs: 482-587.

In some embodiments, a combination or composition comprises, consists essentially of, or consists of: one or more fermentation solids, spores, or toxins isolated from a Bacillus thuringiensis ssp. kurstaki strain EVB-113-19; a Bacillus thuringiensis ssp. tenebrionis strain NB-176; or a Bacillus thuringiensis ssp. israelensis strain BMP 144; and a U+2-ACTX-Hv1a toxin having an amino acid sequence according to the amino acid sequence set forth in SEQ ID NO: 61.

In some embodiments, a combination or composition comprises, consists essentially of, or consists of: one or more fermentation solids, spores, or toxins isolated from a Bacillus thuringiensis ssp. tenebrionis strain NB-176, and a U+2-ACTX-Hv1a toxin having an amino acid sequence according to the amino acid sequence set forth in SEQ ID NO: 61.

In some embodiments, a combination or composition comprises, consists essentially of, or consists of: one or more fermentation solids, spores, or toxins isolated from a Bacillus thuringiensis ssp. kurstaki strain EVB-113-19, and a U+2-ACTX-Hv1a toxin having an amino acid sequence according to the amino acid sequence set forth in SEQ ID NO: 61.

In some embodiments, a combination or composition comprises, consists essentially of, or consists of: one or more fermentation solids, spores, or toxins isolated from a Bacillus thuringiensis ssp. israelensis strain BMP 144, and a U+2-ACTX-Hv1a toxin having an amino acid sequence according to the amino acid sequence set forth in SEQ ID NO: 61.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. israelensis strain BMP 144, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. israelensis strain BMP 144, wherein the combination or composition comprises a concentration of the one or more fermentation solids, spores, or toxins isolated from a Bacillus thuringiensis ssp. israelensis strain BMP 144 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. kurstaki strain EVB-113-19, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. kurstaki strain EVB-113-19, wherein the combination or composition comprises a concentration of the one or more fermentation solids, spores, or toxins isolated from a Bacillus thuringiensis ssp. kurstaki strain EVB-113-19 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. tenebrionis strain NB-176, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and one or more fermentation solids, spores, or toxins isolated from a Bacillus thuringiensis ssp. tenebrionis strain NB-176, wherein the combination or composition comprises a concentration of the one or more fermentation solids, spores, or toxins isolated from a Bacillus thuringiensis ssp. tenebrionis strain NB-176 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: exemplary combinations of other bacteria toxins and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a bacterial toxin.

In some embodiments, a combination or composition comprises, consists essentially of, or consists of: a U+2-ACTX-Hv1a toxin having an amino acid sequence according to the amino acid sequence set forth in SEQ ID NO: 61, and a bacterial toxin, wherein the bacterial toxin is isolated from a bacteria belonging to the Xenorhabdus genus, or Photorhabdus genus.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus toxin, wherein the Photorhabdus toxin is selected from the group consisting of: Photorhabdus akhurstii toxin; a Photorhabdus asymbiotica toxin; a Photorhabdus asymbiotica subsp. asymbiotica toxin; a Photorhabdus asymbiotica subsp. asymbiotica ATCC 43949 toxin; a Photorhabdus australis toxin; a Photorhabdus australis DSM 17609 toxin; a Photorhabdus bodei toxin; a Photorhabdus caribbeanensis toxin; a Photorhabdus cinerea toxin; a Photorhabdus hainanensis toxin; a Photorhabdus heterorhabditis toxin; a Photorhabdus kayaii toxin; a Photorhabdus khanii toxin; a Photorhabdus khanii NC19 toxin; a Photorhabdus khanii subsp. guanajuatensis toxin; a Photorhabdus kleinii toxin; a Photorhabdus laumondii toxin; a Photorhabdus laumondii subsp. clarkei toxin; a Photorhabdus laumondii subsp. laumondii toxin; a Photorhabdus laumondii subsp. laumondii TTO1 toxin; a Photorhabdus luminescens toxin; a Photorhabdus luminescens BA1 toxin; a Photorhabdus luminescens NBAII H75HRPL105 toxin; a Photorhabdus luminescens NBAII HiPL101 toxin; a Photorhabdus luminescens subsp. luminescens toxin; a Photorhabdus luminescens subsp. luminescens ATCC 29999 toxin; a Photorhabdus luminescens subsp. mexicana toxin; a Photorhabdus luminescens subsp. sonorensis toxin; a Photorhabdus namnaonensis toxin; a Photorhabdus noenieputensis toxin; a Photorhabdus stackebrandtii toxin; a Photorhabdus tasmaniensis toxin; a Photorhabdus temperata toxin; a Photorhabdus temperata J3 toxin; a Photorhabdus temperata subsp. phorame toxin; a Photorhabdus temperata subsp. temperata toxin; a Photorhabdus temperata subsp. temperata M1021 toxin; a Photorhabdus temperata subsp. temperata Meg1 toxin; a Photorhabdus thracensis toxin; a unclassified Photorhabdus toxin; a Photorhabdus sp. toxin; a Photorhabdus sp. 3014 toxin; a Photorhabdus sp. 3240 toxin; a Photorhabdus sp. Az29 toxin; a Photorhabdus sp. BS21 toxin; a Photorhabdus sp. CbKj163 toxin; a Photorhabdus sp. CRCIA-P01 toxin; a Photorhabdus sp. ENY toxin; a Photorhabdus sp. FL2122 toxin; a Photorhabdus sp. FL480 toxin; a Photorhabdus sp. FsIw96 toxin; a Photorhabdus sp. GDd233 toxin; a Photorhabdus sp. H3086 toxin; a Photorhabdus sp. H3107 toxin; a Photorhabdus sp. H3240 toxin; a Photorhabdus sp. HB301 toxin; a Photorhabdus sp. HB78 toxin; a Photorhabdus sp. HB89 toxin; a Photorhabdus sp. HIT toxin; a Photorhabdus sp. HO1 toxin; a Photorhabdus sp. HUG-39 toxin; a Photorhabdus sp. IT toxin; a Photorhabdus sp. JUN toxin; a Photorhabdus sp. KcTs129 toxin; a Photorhabdus sp. KJ13.1 TH toxin; a Photorhabdus sp. KJ14.3 TH toxin; a Photorhabdus sp. KJ24.5 TH toxin; a Photorhabdus sp. KJ29.1 TH toxin; a Photorhabdus sp. KJ37.1 TH toxin; a Photorhabdus sp. KJ7.1 TH toxin; a Photorhabdus sp. KJ8.2 TH toxin; a Photorhabdus sp. KJ9.1 TH toxin; a Photorhabdus sp. KJ9.2 TH toxin; a Photorhabdus sp. KK1.3 TH toxin; a Photorhabdus sp. KK1.4 TH toxin; a Photorhabdus sp. KMD74 toxin; a Photorhabdus sp. KOH toxin; a Photorhabdus sp. MID10 toxin; a Photorhabdus sp. MOL toxin; a Photorhabdus sp. MSW 058 toxin; a Photorhabdus sp. MSW 079 toxin; a Photorhabdus sp. NK2.1 TH toxin; a Photorhabdus sp. NK2.5 TH toxin; a Photorhabdus sp. NnMt2h toxin; a Photorhabdus sp. NP1 toxin; a Photorhabdus sp. OH10 toxin; a Photorhabdus sp. OnIr40 toxin; a Photorhabdus sp. OnKn2 toxin; a Photorhabdus sp. PB10.1 TH toxin; a Photorhabdus sp. PB16.3 TH toxin; a Photorhabdus sp. PB17.1 TH toxin; a Photorhabdus sp. PB17.3 TH toxin; a Photorhabdus sp. PB2.5 TH toxin; a Photorhabdus sp. PB22.4 TH toxin; a Photorhabdus sp. PB22.5 TH toxin; a Photorhabdus sp. PB32.1 TH toxin; a Photorhabdus sp. PB33.1 TH toxin; a Photorhabdus sp. PB33.4 TH toxin; a Photorhabdus sp. PB37.4 TH toxin; a Photorhabdus sp. PB39.2 TH toxin; a Photorhabdus sp. PB4.5 TH toxin; a Photorhabdus sp. PB41.4 TH toxin; a Photorhabdus sp. PB45.5 TH toxin; a Photorhabdus sp. PB47.1 TH toxin; a Photorhabdus sp. PB47.3 TH toxin; a Photorhabdus sp. PB5.1 TH toxin; a Photorhabdus sp. PB5.4 TH toxin; a Photorhabdus sp. PB50.4 TH toxin; a Photorhabdus sp. PB51.4 TH toxin; a Photorhabdus sp. PB52.2 TH toxin; a Photorhabdus sp. PB54.4 TH toxin; a Photorhabdus sp. PB58.2 TH toxin; a Photorhabdus sp. PB58.4 TH toxin; a Photorhabdus sp. PB58.5 TH toxin; a Photorhabdus sp. PB59.2 TH toxin; a Photorhabdus sp. PB6.5 TH toxin; a Photorhabdus sp. PB67.2 TH toxin; a Photorhabdus sp. PB67.4 TH toxin; a Photorhabdus sp. PB68.1 TH toxin; a Photorhabdus sp. PB7.5 TH toxin; a Photorhabdus sp. PB76.1 TH toxin; a Photorhabdus sp. PB76.4 TH toxin; a Photorhabdus sp. PB76.5 TH toxin; a Photorhabdus sp. PB78.2 TH toxin; a Photorhabdus sp. PB80.3 TH toxin; a Photorhabdus sp. PB80.4 TH toxin; a Photorhabdus sp. Pjun toxin; a Photorhabdus sp. RW14-46 toxin; a Photorhabdus sp. S10-54 toxin; a Photorhabdus sp. S12-55 toxin; a Photorhabdus sp. S14-60 toxin; a Photorhabdus sp. S15-56 toxin; a Photorhabdus sp. S5P8-50 toxin; a Photorhabdus sp. S7-51 toxin; a Photorhabdus sp. S8-52 toxin; a Photorhabdus sp. S9-53 toxin; a Photorhabdus sp. SJ2 toxin; a Photorhabdus sp. SN259 toxin; a Photorhabdus sp. SP1.5 TH toxin; a Photorhabdus sp. SP16.4 TH toxin; a Photorhabdus sp. SP21.5 TH toxin; a Photorhabdus sp. SP3.4 TH toxin; a Photorhabdus sp. SP4.5 TH toxin; a Photorhabdus sp. SP7.3 TH toxin; a Photorhabdus sp. TyKb140 toxin; a Photorhabdus sp. UK76 toxin; a Photorhabdus sp. VMG toxin; a Photorhabdus sp. WA21C toxin; a Photorhabdus sp. WkSs43 toxin; a Photorhabdus sp. Wx13 toxin; a Photorhabdus sp. X₄ toxin; a Photorhabdus sp. YNb90 toxin; and Photorhabdus sp. ZM toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin, wherein the Photorhabdus luminescens toxin comprises a Photorhabdus luminescens “toxin complex a” (Tca).

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin, wherein the Photorhabdus luminescens toxin comprises a Photorhabdus luminescens “toxin complex c” (Tcc).

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin, wherein the Photorhabdus luminescens toxin comprises a Photorhabdus luminescens “toxin complex d” (Tcd).

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin comprising a TcaA protein (SEQ ID NO: 616), a TcaB protein (SEQ ID NO: 617), a TcaC protein (SEQ ID NO: 618), and a TcaZ protein (SEQ ID NO: 619), or an extract thereof.

In some embodiments, a combination or composition comprises, consists essentially of, or consists of: a U+2-ACTX-Hv1a toxin having an amino acid sequence according to the amino acid sequence set forth in SEQ ID NO: 61, and one or more organisms belonging to the Yersinia genus.

In some embodiments, a combination or composition comprises, consists essentially of, or consists of: a U+2-ACTX-Hv1a toxin having an amino acid sequence according to the amino acid sequence set forth in SEQ ID NO: 61, and one or more peptides isolated from an organism belonging to a Yersinia genus.

In some embodiments, a combination or composition comprises, consists essentially of, or consists of: a U+2-ACTX-Hv1a toxin having an amino acid sequence according to the amino acid sequence set forth in SEQ ID NO: 61, and one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, a combination or composition comprises, consists essentially of, or consists of: a U+2-ACTX-Hv1a toxin having an amino acid sequence according to the amino acid sequence set forth in SEQ ID NO: 61, and one or more peptides isolated from one or more of the following species: Yersinia aldovaeyb, Yersinia aleksiciae, Yersinia bercovieri, Yersinia canariae, Yersinia enterocolitica, Yersinia enterocolitica subsp. enterocolitica, Yersinia enterocolitica subsp. palearctica, Yersinia entomophaga, Yersinia frederiksenii, Yersinia hibernica, Yersinia intermedia, Yersinia kristensenii, Yersinia kristensenii subsp. kristensenii, Yersinia kristensenii subsp. rochesterensis, Yersinia massiliensis, Yersinia mollaretii, Yersinia nurmii, Yersinia pekkanenii, Yersinia pestis, Yersinia pestis subsp. pestis, Yersinia pestis subsp. medievalis, Yersinia pestis subsp. orientalis, Yersinia pseudotuberculosis, Yersinia pseudotuberculosis subsp. pestis, Yersinia pseudotuberculosis subsp. pseudotuberculosis, Yersinia rohdei, Yersinia ruckeri, Yersinia similis, or Yersinia wautersii.

In some embodiments, a combination or composition comprises, consists essentially of, or consists of: a U+2-ACTX-Hv1a toxin having an amino acid sequence according to the amino acid sequence set forth in SEQ ID NO: 61, and a Yersinia entomophaga or a Yersinia nurmii.

In some embodiments, a combination or composition comprises, consists essentially of, or consists of: a U+2-ACTX-Hv1a toxin having an amino acid sequence according to the amino acid sequence set forth in SEQ ID NO: 61, and one or more peptides isolated from Yersinia entomophaga or Yersinia nurmii.

In some embodiments, a combination or composition comprises, consists essentially of, or consists of: a U+2-ACTX-Hv1a toxin having an amino acid sequence according to the amino acid sequence set forth in SEQ ID NO: 61, and a Yersinia entomophaga bacteria, and/or a toxin therefrom.

In some embodiments, a combination or composition comprises, consists essentially of, or consists of: a U+2-ACTX-Hv1a toxin having an amino acid sequence according to the amino acid sequence set forth in SEQ ID NO: 61, and one or more Yersinia nurmii bacteria, and/or a toxin therefrom.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin complex comprising a TcaA protein (SEQ ID NO: 616), a TcaB protein (SEQ ID NO: 617), a TcaC protein (SEQ ID NO: 618), and a TcaZ protein (SEQ ID NO: 619), or an extract thereof, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a Photorhabdus luminescens toxin complex comprising a TcaA protein (SEQ ID NO: 616), a TcaB protein (SEQ ID NO: 617), a TcaC protein (SEQ ID NO: 618), and a TcaZ protein (SEQ ID NO: 619), or an extract thereof, wherein the combination or composition comprises a concentration of the Photorhabdus luminescens toxin complex ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of GNA and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a lectin.

In some embodiments, a combination or composition comprises, consists essentially of, or consists of: a U+2-ACTX-Hv1a toxin having an amino acid sequence according to the amino acid sequence set forth in SEQ ID NO: 61, and a lectin, wherein the lectin is one or more of the following: Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia simplicifolia-II (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); and/or Datura stramonium Lectin (DSL).

In some embodiments, a combination or composition comprises, consists essentially of, or consists of: a U+2-ACTX-Hv1a toxin having an amino acid sequence according to the amino acid sequence set forth in SEQ ID NO: 61, and a lectin, wherein the lectin is Galanthus nivalis agglutinin (GNA).

In some embodiments, a combination or composition comprises, consists essentially of, or consists of: a U+2-ACTX-Hv1a toxin having an amino acid sequence according to the amino acid sequence set forth in SEQ ID NO: 61, and a lectin, wherein the lectin has an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence set forth in any one of SEQ ID NOs: 35, 595-615.

In some embodiments, a combination or composition comprises, consists essentially of, or consists of: a U+2-ACTX-Hv1a toxin having an amino acid sequence according to the amino acid sequence set forth in SEQ ID NO: 61, and a lectin, wherein the lectin has an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence:

(SEQ ID NO: 35)
″MAKASLLILATIFLGVITPSCLSENILYSGETLPTGGFLSSGSFVFIM
QEDCNLVLYNVDKPIWATNTGGLSSDCSLSMQNDGNLVVFTPSNKPIWA
SNTDGQNGNYVCILQKDRNVVIYGTNRWATGTYTGAVGIPESPPSEKYP
SAGKIKLVTAK”.

In some embodiments, a combination or composition comprises, consists essentially of, or consists of: a U+2-ACTX-Hv1a toxin having an amino acid sequence according to the amino acid sequence set forth in SEQ ID NO: 61, and a lectin, wherein the lectin has an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequence:

(SEQ ID NO: 595)
“MAKASLLILAAIFLGVITPSCLSDNILYSGETLSTGEFLNYGSFVFIM
QEDCNLVLYDVDKPIWATNTGGLSRSCFLSMQTDGNLVVYNPSNKPIWA
SNTGGQNGNYVCILQKDRNVVIYGTDRWATGTHTGLVGIPASPPSEKYP
TAGKIKLVTAK”.

In some embodiments, a combination or composition comprises, consists essentially of, or consists of: a U+2-ACTX-Hv1a toxin having an amino acid sequence according to the amino acid sequence set forth in SEQ ID NO: 61, and a GNA having an amino acid sequence according to the amino acid sequence set forth in SEQ ID NO: 35, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a GNA having an amino acid sequence according to the amino acid sequence set forth in SEQ ID NO: 595, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a GNA having an amino acid sequence according to the amino acid sequence set forth in SEQ ID NO: 35, wherein the combination or composition comprises a concentration of the a GNA having an amino acid sequence according to the amino acid sequence set forth in SEQ ID NO: 35 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a GNA having an amino acid sequence according to the amino acid sequence set forth in SEQ ID NO: 595, wherein the combination or composition comprises a concentration of the a GNA having an amino acid sequence according to the amino acid sequence set forth in SEQ ID NO: 595 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Azadirachtin and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a compound isolated from an Azadirachta indica (also known as neem, nimtree or Indian lilac).

In some embodiments, a combination or composition comprises, consists essentially of, or consists of: a U+2-ACTX-Hv1a toxin having an amino acid sequence according to the amino acid sequence set forth in SEQ ID NO: 61, and an Azadirachta indica compound.

In some embodiments, a combination or composition comprises, consists essentially of, or consists of: a U+2-ACTX-Hv1a toxin having an amino acid sequence according to the amino acid sequence set forth in SEQ ID NO: 61, and one or more of the following: an Azadirachtin; an Azadiradione; an Azadiradionolide; a Deacetylgedunin; a Deacetylazadirachtinol; a Desfuranoazadiradione; a Epoxyazadiradione; a Gedunin; a Mahmoodin; a Neemfruitin A; a Neemfruitin B; a Nimbolide; a Nimbin; a Nimolicinol; an Ohchinin Acetate; a Salannin; a Salannol; an alpha-Nimolactone; a beta-Nimolactone; a 2′,3′-Dihydrosalannin; a 3-Deacetylsalannin; a 6-Deacetylnimbin; a 7-Acetyl-16,17-dehydro-16-hydroxyneotrichilenone; a 7-Benzoylnimbocinol; a 7-Deacetyl-7-benzoylepoxyazadiradione; a 7-Deacetyl-7-benzoylgedunin; a 7-Deacetyl-17-epinimolicinol; a 15-Hydroxyazadiradione; a 17-Epi-17-Hydroxyazadiradione; a 17-Epiazadiradione; a 20,21,22,23-Tetrahydro-23-oxoazadirone; a 22,23-Dihydronimocinol; or a 28-Deoxonimbolide.

In some embodiments, a combination or composition comprises, consists essentially of, or consists of: a U+2-ACTX-Hv1a toxin having an amino acid sequence according to the amino acid sequence set forth in SEQ ID NO: 61, and Azadirachtin.

In some embodiments, a combination or composition comprises, consists essentially of, or consists of: a U+2-ACTX-Hv1a toxin having an amino acid sequence according to the amino acid sequence set forth in SEQ ID NO: 61, and Azadirachtin, wherein the Azadirachtin has a chemical formula: C₃₅H₄₄O₁₆.

In some embodiments, a combination or composition comprises, consists essentially of, or consists of: a U+2-ACTX-Hv1a toxin having an amino acid sequence according to the amino acid sequence set forth in SEQ ID NO: 61, and an Azadirachtin, wherein the Azadirachtin has a chemical formula: C₃₅H₄₄O₁₆, wherein the combination or composition comprises a concentration of the Azadirachtin, wherein the Azadirachtin has a chemical formula: C₃₅H₄₄O₁₆ ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and an Azadirachtin, wherein the Azadirachtin has a chemical formula: C₃₅H₄₄O₁₆, wherein the combination or composition comprises a concentration of the U+2-ACTX-Hy1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Boric Acid and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a boron compound.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a boric acid, diboron tetrahydroxide, a borate, a boron oxide, a borane, or any combination of any of the foregoing.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a borane and/or a borate ester that produces oxides of boron in aqueous media.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a boric acid, a borate (e.g., basic sodium borate (borax)), or a mixture of boric acid and a borate.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a borate.

In some embodiments, a combination or composition comprises, consists essentially of, or consists of: a U+2-ACTX-Hv1a toxin having an amino acid sequence according to the amino acid sequence set forth in SEQ ID NO: 61, and a borate, wherein the borate is selected from: perborates, metaborates, tetraborates, octaborates, borate esters, and any combination thereof.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a borate, wherein the borate is selected from: metallic borates (e.g., sodium borate, zinc borate and potassium borate), such as disodium tetraborate decahydrate, disodium octaborate tetrahydrate, sodium metaborate, sodium perborate monohydrate, disodium octaborate, sodium tetraborate pentahydrate, sodium tetraborate, copper metaborate, zinc borate, barium metaborate, and any combination thereof.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a borax (e.g., sodium borate decahydrate-10 mol Na₂B₄O₇·10H₂O or sodium borate pentahydrate-5 mol Na₂B₄O₇·5H₂O).

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is a boron compound that may be utilized in effective amounts as substitutes for borax (or may be utilized in effective amounts in combination with borax or one another).

In some embodiments, a combination or composition comprises, consists essentially of, or consists of: a U+2-ACTX-Hv1a toxin having an amino acid sequence according to the amino acid sequence set forth in SEQ ID NO: 61, and a borax.

In some embodiments, a combination or composition comprises, consists essentially of, or consists of: a U+2-ACTX-Hv1a toxin having an amino acid sequence according to the amino acid sequence set forth in SEQ ID NO: 61, and a borax, wherein the borax is selected from: anhydrous borax (Na₂B₄O₇); ammonium tetraborate ((NH₄)₂B₄O₇·4H₂O); ammonium pentaborate ((NH₄)₂B₁₀O₁₆·8H₂O); potassium pentaborate (K2B₁₀O₁₆·8H₂O); potassium tetraborate (K2B₄O₇·4H₂O); sodium metaborate ((8 mol) Na₂B₂O₄·8H₂O); sodium metaborate ((4 mol) Na₂B₂O₄·4H₂O); disodium tetraborate decahydrate (Na₂B₄O₇·10H₂O); disodium tetraborate pentahydrate (Na₂B₄O₇·5H₂O); disodium octaborate tetrahydrate (Na₂B₈O₁₃·4H₂O); or combinations thereof.

In some embodiments, a combination or composition comprises, consists essentially of, or consists of: a U+2-ACTX-Hv1a toxin having an amino acid sequence according to the amino acid sequence set forth in SEQ ID NO: 61, and a boron compound, wherein the boron compound is selected from the group consisting of: borax, boric acid, disodium octaborate, sodium borate, sodium metaborate, sodium tetraborate decahydrate, boron oxide, boron carbide, boron nitride, boron tribromide, boron trichloride, and boron trifluoride.

In some embodiments, a combination or composition comprises, consists essentially of, or consists of: a U+2-ACTX-Hv1a toxin having an amino acid sequence according to the amino acid sequence set forth in SEQ ID NO: 61, and boric acid.

In some embodiments, a combination or composition comprises, consists essentially of, or consists of: a U+2-ACTX-Hv1a toxin having an amino acid sequence according to the amino acid sequence set forth in SEQ ID NO: 61, and boric acid, wherein the boric acid having a chemical formula of H₃BO₃.

In some embodiments, a combination or composition comprises, consists essentially of, or consists of: a U+2-ACTX-Hv1a toxin having an amino acid sequence according to the amino acid sequence set forth in SEQ ID NO: 61, and a boric acid having a chemical formula of H₃BO₃, wherein the combination or composition comprises a concentration of the U+2-ACTX-Hv1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a boric acid having a chemical formula of H₃BO₃, wherein the combination or composition comprises a concentration of the boric acid having a chemical formula of H₃BO₃ ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Combinations: Exemplary Combinations of Viruses and U+2-ACTX-Hv1a

In some embodiments, a combination or composition comprises, consists essentially of, or consists of: a U+2-ACTX-Hv1a toxin having an amino acid sequence according to the amino acid sequence set forth in SEQ ID NO: 61, and a virus that possesses an insecticidal activity when in contact with an insect species.

In some embodiments, a combination or composition comprises, consists essentially of, or consists of: a U+2-ACTX-Hv1a toxin having an amino acid sequence according to the amino acid sequence set forth in SEQ ID NO: 61, and a DNA virus or an RNA virus.

In some embodiments, a combination or composition comprises, consists essentially of, or consists of: a U+2-ACTX-Hv1a toxin having an amino acid sequence according to the amino acid sequence set forth in SEQ ID NO: 61, and an ascovirus; baculovirus; densovirus; entomopoxvirus; hytrosavirus; iridovirus; nudivirus; polydnavirus; dicistrovirus; iflavirus; nodavirus; tetravirus; or cypovirus.

In some embodiments, a combination or composition comprises, consists essentially of, or consists of: a U+2-ACTX-Hv1a toxin having an amino acid sequence according to the amino acid sequence set forth in SEQ ID NO: 61, and a virus from the Ascoviridae family.

In some embodiments, a combination or composition comprises, consists essentially of, or consists of: a U+2-ACTX-Hv1a toxin having an amino acid sequence according to the amino acid sequence set forth in SEQ ID NO: 61, and an ascovirus such as Heliothis virescens ascovirus 3a; Heliothis virescens ascovirus 3; Heliothis virescens ascovirus 3b; Heliothis virescens ascovirus 3c; Heliothis virescens ascovirus 3d; Heliothis virescens ascovirus 3e; Heliothis virescens ascovirus 3f; Heliothis virescens ascovirus 3g; Heliothis virescens ascovirus 3h; Heliothis virescens ascovirus 3j; Spodoptera frugiperda ascovirus 1a; Trichoplusia ni ascovirus 2a; Heliothis virescens ascovirus 3i; Spodoptera ascovirus; Spodoptera exigua ascovirus 5a; Spodoptera frugiperda ascovirus 1c; Spodoptera frugiperda ascovirus 1d; Trichoplusia ni ascovirus 2b; Trichoplusia ni ascovirus 2c; Trichoplusia ni ascovirus 2d; or Trichoplusia ni ascovirus 6b.

In some embodiments, a combination or composition comprises, consists essentially of, or consists of: a U+2-ACTX-Hv1a toxin having an amino acid sequence according to the amino acid sequence set forth in SEQ ID NO: 61, and a virus from the Ascoviridae family.

In some embodiments, a combination or composition comprises, consists essentially of, or consists of: a U+2-ACTX-Hv1a toxin having an amino acid sequence according to the amino acid sequence set forth in SEQ ID NO: 61, and a toursvirus such as Diadromus pulchellus toursvirus; Diadromus pulchellus ascovirus 4a; or Dasineura jujubifolia toursvirus 2a.

In some embodiments, a combination or composition comprises, consists essentially of, or consists of: a U+2-ACTX-Hv1a toxin having an amino acid sequence according to the amino acid sequence set forth in SEQ ID NO: 61, and a virus from the Densovirinae family.

In some embodiments, a combination or composition comprises, consists essentially of, or consists of: a U+2-ACTX-Hv1a toxin having an amino acid sequence according to the amino acid sequence set forth in SEQ ID NO: 61, and an Ambidensovirus.

In some embodiments, a combination or composition comprises, consists essentially of, or consists of: a U+2-ACTX-Hv1a toxin having an amino acid sequence according to the amino acid sequence set forth in SEQ ID NO: 61, and an Ambidensovirus selected from the following group: Asteroid ambidensovirus 1; Sea star-associated densovirus; Blattodean ambidensovirus 1; Periplaneta fuliginosa densovirus; Periplaneta fuliginosa densovirus Guo/2000; Blattodean ambidensovirus 2; Blattella germanica densovirus 1; Decapod ambidensovirus 1; Cherax quadricarinatus densovirus; Dipteran ambidensovirus 1; Culex pipiens densovirus; Hemipteran ambidensovirus 1; Planococcus citri densovirus; Hemipteran ambidensovirus 2; Dysaphis plantaginea densovirus; Hemipteran ambidensovirus 3; Myzus persicae densovirus; Myzus persicae nicotianae densovirus; Hymenopteran ambidensovirus 1; Solenopsis invicta densovirus; Lepidopteran ambidensovirus 1; Galleria mellonella densovirus; Junonia coenia densovirus; Junonia coenia densovirus pBRJ/1990; Mythimna loreyi densovirus; Pseudoplusia includens densovirus; Orthopteran ambidensovirus 1; Acheta domestica densovirus; unclassified Ambidensovirus; Tetranychus urticae-associated ambidensovirus; unclassified Densovirus; Ambidensovirus CaaDV1; Ambidensovirus CaaDV2; Atrato Denso-like virus; Atrato Denso-like virus 1; Densovirus SC1065; Densovirus SC1118; Densovirus SC116; Densovirus SC2121; Densovirus SC2209; Densovirus SC2228; Densovirus SC2886; Densovirus SC3749;

Densovirus SC3908; Densovirus SC4092; Densovirus SC444; Densovirus SC525; Diaphorina citri densovirus; Diatraea saccharalis densovirus; Lupine feces-associated densovirus; Lupine feces-associated densovirus 2; or Ambidensovirus sp.

In some embodiments, a combination or composition comprises, consists essentially of, or consists of: a U+2-ACTX-Hv1a toxin having an amino acid sequence according to the amino acid sequence set forth in SEQ ID NO: 61, and a virus from the Entomopoxvirinae family.

In some embodiments, a combination or composition comprises, consists essentially of, or consists of: a U+2-ACTX-Hv1a toxin having an amino acid sequence according to the amino acid sequence set forth in SEQ ID NO: 61, and an Alphaentomopoxvirus; Betaentomopoxvirus; Diachasmimorpha entomopoxvirus; Melanoplus sanguinipes entomopoxvirus; or some heretofore unclassified Entomopoxvirinae.

In some embodiments, a combination or composition comprises, consists essentially of, or consists of: a U+2-ACTX-Hv1a toxin having an amino acid sequence according to the amino acid sequence set forth in SEQ ID NO: 61, and an Entomopoxvirinae family virus selected from the following group: Anomala cuprea entomopoxvirus; Adoxophyes honmai entomopoxvirus; Adoxophyes honmai entomopoxvirus ‘L’; Amsacta moorei entomopoxvirus; Choristoneura biennis entomopoxvirus; Choristoneura fumiferana entomopoxvirus; Choristoneura rosaceana entomopoxvirus; Choristoneura rosaceana entomopoxvirus ‘L’; Heliothis armigera entomopoxvirus; Mythimna separata entomopoxvirus; Mythimna separata entomopoxvirus ‘L’; unclassified Betaentomopoxvirus; Diachasmimorpha longicaudata entomopoxvirus; Melanoplus sanguinipes entomopoxvirus ‘O’; Anacridium aegyptium entomopoxvirus; Calliptamus italicus entomopoxvirus; Chironomus decorus entomopoxvirus; Gomphocerus sibiricus entomopoxvirus; Homona coffearia entomopoxvirus; Linepithema humile entomopoxvirus 1; Oedaleus asiaticus entomopoxvirus; or Pseudaletia separata entomopoxvirus.

In some embodiments, a combination or composition comprises, consists essentially of, or consists of: a U+2-ACTX-Hv1a toxin having an amino acid sequence according to the amino acid sequence set forth in SEQ ID NO: 61, and an Iridoviridae family virus, e.g., an Iridovirus.

In some embodiments, a combination or composition comprises, consists essentially of, or consists of: a U+2-ACTX-Hv1a toxin having an amino acid sequence according to the amino acid sequence set forth in SEQ ID NO: 61, and an Iridoviridae family virus selected from the following group: Tipula iridescent virus; Invertebrate iridescent virus 31; Armadillidium vulgare iridescent virus; Popillia japonica iridescent virus; Porcellio scaber iridescent virus; Invertebrate iridescent virus 6; Gryllus bimaculatus iridovirus; unclassified Iridovirus; Acetes erythraeus iridovirus; Anticarsia gemmatalis iridescent virus; Armadillidium decorum iridescent virus; Barramundi perch iridovirus; Bluegill sunfish iridovirus; Common ponyfish iridovirus; Crimson snapper iridovirus; Decapterus macrosoma iridovirus; Gazza minuta iridovirus; Invertebrate iridescent virus 16; Costelytra zealandica iridescent virus; Invertebrate iridescent virus 2; Sericesthis iridescent virus; Invertebrate iridescent virus 23; Heteronychus arator iridescent virus; Invertebrate iridescent virus 24; Apis cerana iridescent virus; Invertebrate iridescent virus 29; Tenebrio molitor iridescent virus; Iridovirus barramundi/Quang Ninh/VNM/2008; Iridovirus IV31; Japanese sea bass iridovirus; Lagocephalus sceleratus iridovirus; Lates calcarifer iridovirus; Leiognathus splendens iridovirus; Marble goby iridovirus; Orbiculate batfish iridovirus; Parapristipoma trilineatum iridovirus; Perch iridovirus 603-2/China; Polydactylus sextarius iridovirus; Porcellio siculoccidentalis iridescent virus; Pyrrhalta luteola iridescent virus; Rana temporaria United Kingdom iridovirus 1; Rana temporaria United Kingdom iridovirus 2; Silver sea bream iridovirus; Snakehead iridovirus; Stone flounder iridovirus 603-3/China; Stone flounder iridovirus 724/China; Sturgeon iridovirus; Synodus indicus iridovirus; or Trichoniscus panormidensis iridescent virus.

In some embodiments, a combination or composition comprises, consists essentially of, or consists of: a U+2-ACTX-Hv1a toxin having an amino acid sequence according to the amino acid sequence set forth in SEQ ID NO: 61, and an Nudiviridae family virus, e.g., an Alphanudivirus, a Betanudivirus, or some heretofore unclassified Nudiviridae family virus

In some embodiments, a combination or composition comprises, consists essentially of, or consists of: a U+2-ACTX-Hv1a toxin having an amino acid sequence according to the amino acid sequence set forth in SEQ ID NO: 61, and an Nudiviridae family virus selected from the following group: Gryllus bimaculatus nudivirus; Oryctes rhinoceros nudivirus; Heliothis zea nudivirus; Helicoverpa zea nudivirus 2; Allomyrina virus; Drosophila innubila nudivirus; Drosophila nudivirus RLU-2011; Esparto virus; Homarus gammarus nudivirus; Kallithea virus; Macrobrachium nudivirus CN-SL2011; Mauternbach virus; Nilaparvata lugens endogenous nudivirus; Penaeus monodon nudivirus; Tipula oleracea nudivirus; or Tomelloso virus.

In some embodiments, a combination or composition comprises, consists essentially of, or consists of: a U+2-ACTX-Hv1a toxin having an amino acid sequence according to the amino acid sequence set forth in SEQ ID NO: 61, and an Iflaviridae family virus selected from the following group: Antheraea pernyi iflavirus; Brevicoryne brassicae virus; Brevicoryne brassicae virus—UK; Deformed wing virus; Kakugo virus; VDV-1/DWV recombinant; Dinocampus coccinellae paralysis virus; Ectropis obliqua virus; Ectropis obliqua picorna-like virus; Infectious flacherie virus; Infectious flacherie virus isolate silkworm; Ixodes holocyclus iflavirus; Lygus lineolaris virus 1; Lymantria dispar iflavirus 1; Nilaparvata lugens honeydew virus 1; Perina nuda virus; Sacbrood virus; Sacbrood virus CSBV-LN/China/2009; Slow bee paralysis virus; Spodoptera exigua iflavirus 1; Spodoptera exigua iflavirus 2; Varroa destructor virus 1; unclassified Iflavirus; ACT flea iflavirus; Aedes vexans iflavirus; Armigeres iflavirus; Bat iflavirus; Bee iflavirus 1; Blackberry iflavirus A; Blackberry iflavirus B; Bombyx mori iflavirus; Breves iflavirus; Diamondback moth iflavirus; Formica exsecta virus 2; Haemaphysalis flava iflavirus; Heliconius erato iflavirus; Helicoverpa armigera iflavirus; Midge iflavirus 9000; Miniopterus fuliginosus iflavirus; Moku virus; Nasonia vitripennis virus; Pirizal iflavirus; Psammotettix alienus iflavirus 1; Rondonia iflavirus 1; Rondonia iflavirus 2; Scaphoideus titanus iflavirus 1; Scaphoideus titanus iflavirus 2; VDV-1/DWV recombinant 4; Vespa velutina Moku virus; or Xysticus cristatus iflavirus.

In some embodiments, a combination or composition comprises, consists essentially of, or consists of: a U+2-ACTX-Hv1a toxin having an amino acid sequence according to the amino acid sequence set forth in SEQ ID NO: 61, and a virus from the Baculoviridae family.

In some embodiments, a combination or composition comprises, consists essentially of, or consists of: a U+2-ACTX-Hv1a toxin having an amino acid sequence according to the amino acid sequence set forth in SEQ ID NO: 61, and an Alphabaculovirus, Betabaculovirus, Deltabaculovirus, Gammabaculovirus, or heretofore unclassified Baculoviridae virus.

In some embodiments, a combination or composition comprises, consists essentially of, or consists of: a U+2-ACTX-Hv1a toxin having an amino acid sequence according to the amino acid sequence set forth in SEQ ID NO: 61, and an Alphabaculovirus virus selected from the following group: Adoxophyes honmai nucleopolyhedrovirus; Agrotis ipsilon multiple nucleopolyhedrovirus; Agrotis segetum nucleopolyhedrovirus A; Agrotis segetum nucleopolyhedrovirus B; Antheraea pernyi nucleopolyhedrovirus; Antheraea proylei nucleopolyhedrovirus; Philosamia cynthia ricini nucleopolyhedrovirus virus; Anticarsia gemmatalis multiple nucleopolyhedrovirus; Autographa californica multiple nucleopolyhedrovirus; Anagrapha falcifera MNPV; Autographa californica nucleopolyhedrovirus; Galleria mellonella MNPV; Plutella xylostella multiple nucleopolyhedrovirus; Rachiplusia nu MNPV; Rachiplusia ou MNPV; Bombyx mori nucleopolyhedrovirus; Bombyx mandarina nucleopolyhedrovirus; Bombyx mandarina nucleopolyhedrovirus S2; Bombyx mori nuclear polyhedrosis virus K1; Buzura suppressaria nucleopolyhedrovirus; Catopsilia pomona nucleopolyhedrovirus; Choristoneura fumiferana DEF multiple nucleopolyhedrovirus; Choristoneura fumiferana multiple nucleopolyhedrovirus; Choristoneura occidentalis alphabaculovirus; Choristoneura murinana nucleopolyhedrovirus; Choristoneura rosaceana nucleopolyhedrovirus; Chrysodeixis chalcites nucleopolyhedrovirus; Chrysodeixis chalcites SNPV TF1-A; Chrysodeixis includens nucleopolyhedrovirus; Pseudoplusia includens SNPV IE; Clanis bilineata nucleopolyhedrovirus; Dasychira pudibunda nucleopolyhedrovirus; Ectropis obliqua nucleopolyhedrovirus; Epiphyas postvittana nucleopolyhedrovirus; Euproctis pseudoconspersa nucleopolyhedrovirus; Helicoverpa armigera nucleopolyhedrovirus; Helicoverpa armigera NPV NNg1; Helicoverpa armigera NPV strain Australia; Helicoverpa armigera nucleopolyhedrovirus G4; Helicoverpa armigera SNPV; Helicoverpa SNPV AC53; Helicoverpa zea single nucleopolyhedrovirus; Hemileuca species nucleopolyhedrovirus; Hemileuca sp. nucleopolyhedrovirus; Hyphantria cunea nucleopolyhedrovirus; Lambdina fiscellaria nucleopolyhedrovirus; Leucania separata nucleopolyhedrovirus; Lonomia obliqua nucleopolyhedrovirus; Lonomia obliqua multiple nucleopolyhedrovirus; Lymantria dispar multiple nucleopolyhedrovirus; Lymantria xylina nucleopolyhedrovirus; Mamestra brassicae multiple nucleopolyhedrovirus; Mamestra configurata nucleopolyhedrovirus A; Mamestra configurata nucleopolyhedrovirus B; Helicoverpa armigera multiple nucleopolyhedrovirus; Maruca vitrata nucleopolyhedrovirus; Mythimna unipuncta nucleopolyhedrovirus; Operophtera brumata nucleopolyhedrovirus; Orgyia leucostigma nucleopolyhedrovirus; Orgyia pseudotsugata multiple nucleopolyhedrovirus; Oxyplax ochracea nucleopolyhedrovirus; Perigonia lusca nucleopolyhedrovirus; Perigonia lusca single nucleopolyhedrovirus; Spodoptera exigua multiple nucleopolyhedrovirus; Spodoptera exigua nuclear polyhedrosis virus (strain US); Spodoptera frugiperda multiple nucleopolyhedrovirus; Spodoptera littoralis nucleopolyhedrovirus; Spodoptera litura nucleopolyhedrovirus; Sucra jujuba nucleopolyhedrovirus; Thysanoplusia orichalcea nucleopolyhedrovirus; Trichoplusia ni single nucleopolyhedrovirus; Wiseana signata nucleopolyhedrovirus; unclassified Alphabaculovirus; Abraxas grossulariata nucleopolyhedrovirus; Actias selene nucleopolyhedrovirus; Adoxophyes orana nucleopolyhedrovirus; Agraulis vanillae MNPV; Agrotis exclamationis nucleopolyhedrovirus; Agrotis ipsilon multicapsid nucleopolyhedrovirus; Amorbia cuneacapsa nucleopolyhedrovirus; Amorbia cuneana nucleopolyhedrovirus; Ampelophaga rubiginosa nucleopolyhedrovirus; Amsacta albistriga nucleopolyhedrovirus; Anagrapha falcifera multiple nucleopolyhedrovirus; Antheraea polyphemus nucleopolyhedrovirus; Anticarsia gemmatalis nucleopolyhedrovirus; Apocheima cinerarium nucleopolyhedrovirus; Aporia crataegi nucleopolyhedrovirus; Archips cerasivoranus nuclear polyhedrosis virus; Archips rosanus nucleopolyhedrovirus; Attacus ricini nuclear polyhedrosis virus; Autographa biloba nucleopolyhedrovirus; Autographa gamma nucleopolyhedrovirus; Autographa nigrisigna nucleopolyhedrovirus; Boarmia bistortata nucleopolyhedrovirus; Bombyx mandarina nuclear polyhedrosis virus; Busseola fusca nucleopolyhedrovirus; Catposilia pomona nucleopolyhedrovirus; Cerapteryx graminis nucleopolyhedrovirus; Choristoneura diversana nucleopolyhedrovirus; Choristoneura occidentalis nucleopolyhedrovirus; Chorizagrotis auxiliaris nucleopolyhedrovirus; Chrysodeixis includens NPV; Coloradia pandora alphabaculovirus; Coloradia pandora nucleopolyhedrovirus; Condylorrhiza vestigialis MNPV; Condylorrhiza vestigialis multiple nucleopolyhedrovirus; Cryptophlebia peltastica nucleopolyhedrovirus; Cyclophragma undans nucleopolyhedrovirus; Dasychira plagiata nucleopolyhedrovirus; Dendrolimus kikuchii nucleopolyhedrovirus; Diaphania pulverulentalis nucleopolyhedrovirus; Dione Juno MNPV tmk1/ARG/2003; Dione Juno nucleopolyhedrovirus; Dirphia peruvianus nucleopolyhedrovirus; Ectropis grisescens nucleopolyhedrovirus; Epinotia granitalis nucleopolyhedrovirus; Euproctis digramma nucleopolyhedrovirus; Gilpinia hercyniae nucleopolyhedrovirus; Heliconius erato nucleopolyhedrovirus; Helicoverpa assulta nucleopolyhedrovirus; Helicoverpa gelotopoeon single nucleopolyhedrovirus; Heliothis peltigera SNPV; Heliothis zea nuclear polyhedrosis virus; Hemerocampa vetusta nucleopolyhedrovirus; Hemileuca alphabaculovirus; Hyposidra infixaria NPV; Hyposidra talaca NPV; Iragoides fasciata nucleopolyhedrovirus; Junonia coenia nucleopolyhedrovirus; Leucoma salicis nucleopolyhedrovirus; Lymantria mathura mutiple nucleopolyhedrovirus; Lymantria monacha nucleopolyhedrovirus; Lymantria xylina nucleopolyhedrovirus 2; Malacosoma alphabaculovirus; Malacosoma americanum nucleopolyhedrovirus; Malacosoma californicum nucleopolyhedrovirus; Malacosoma californicum pluviale nucleopolyhedrovirus; Malacosoma disstria nucleopolyhedrovirus; Malacosoma neustria nucleopolyhedrovirus; Mamestra configurata nucleopolyhedrovirus; Neophasia alphabaculovirus; Nepytia phantasmaria nucleopolyhedrovirus; Nymphalis io nucleopolyhedrovirus; Oak looper alphabaculovirus; Ophiusa disjungens nucleopolyhedrovirus; Orgyia anartoides nucleopolyhedrovirus; Orgyia ericae nucleopolyhedrovirus; Orgyia pseudotsugata single capsid nuclopolyhedrovirus; Panolis flammea nucleopolyhedrovirus; Peridroma alphabaculovirus; Peridroma margaritosa nucleopolyhedrovirus; Perina nuda nucleopolyhedrovirus; Phryganidia californica nucleopolyhedrovirus; Plusia acuta nucleopolyhedrovirus; Plusia orichalcea nuclear polyhedrosis virus; Plutella maculipennis nucleopolyhedrovirus; Pseudaletia alphabaculovirus; Pseudoplusia includens nucleopolyhedrovirus; Pterolocera amplicornis nucleopolyhedrovirus; Rachiplusia nu nucleopolyhedrovirus; Rachiplusia nu single nucleopolyhedrovirus; Samia cynthia nucleopolyhedrovirus; Spilarctia obliqua nucleopolyhedrovirus; Spilosoma obliqua nucleopolyhedrosis virus; Spilosoma phasma nucleopolyhedrovirus; Spodoptera cosmioides nucleopolyhedrovirus; Spodoptera eridania nucleopolyhedrovirus; Spodoptera exempta nucleopolyhedrovirus; Spodoptera littoralis multicapsid nucleopolyhedrovirus; Spodoptera litura MNPV; Spodoptera litura nucleopolyhedrovirus II; Spodoptera terricola nucleopolyhedrovirus; Tineola bisselliella nucleopolyhedrovirus; Troides aeacus nucleopolyhedrovirus; Wiseana cervinata nucleopolyhedrovirus; Agraulis sp. nucleopolyhedrovirus; Malacosoma sp. alphabaculovirus; Malacosoma sp. nucleopolyhedrovirus; Neophasia sp. alphabaculovirus; or unidentified nuclear polyhedrosis viruses.

In some embodiments, a combination or composition comprises, consists essentially of, or consists of: a U+2-ACTX-Hv1a toxin having an amino acid sequence according to the amino acid sequence set forth in SEQ ID NO: 61, and a Betabaculovirus virus selected from the following group: Adoxophyes orana granulovirus; Agrotis segetum granulovirus; Artogeia rapae granulovirus; Pieris brassicae granulovirus; Choristoneura fumiferana granulovirus; Choristoneura occidentalis granulovirus; Clostera anachoreta granulovirus; Clostera anastomosis granulovirus A; Clostera anastomosis granulovirus Henan; Clostera anastomosis granulovirus B; Cnaphalocrocis medinalis granulovirus; Cryptophlebia leucotreta granulovirus; Cydia pomonella granulovirus; Cydia pomonella granulosis virus (isolate Mexican); Diatraea saccharalis granulovirus; Epinotia aporema granulovirus; Erinnyis ello granulovirus; Harrisina brillians granulovirus; Helicoverpa armigera granulovirus; Lacanobia oleracea granulovirus; Mocis latipes granulovirus; Mythimna unipuncta granulovirus A; Pseudalatia unipuncta granulovirus; Mythimna unipuncta granulovirus B; Mythimna unipuncta granulovirus; Phthorimaea operculella granulovirus; Plodia interpunctella granulovirus; Plutella xylostella granulovirus; Spodoptera frugiperda granulovirus; Spodoptera litura granulovirus; Trichoplusia ni granulovirus;

Trichoplusia ni granulovirus LBIV-12; Xestia c-nigrum granulovirus; Achaea Janata granulovirus; Adoxophyes honmai granulovirus; Agrotis exclamationis granulovirus; Amelia pallorana granulovirus; Andraca bipunctata granulovirus; Autographa gamma granulovirus; Caloptilia theivora granulovirus; Choristoneura murinana granulovirus; Choristoneura viridis betabaculovirus; Clostera anastomosis granulovirus; Cnephasia longana granulovirus; Estigmene acrea granulovirus; Euxoa ochrogaster granulovirus; Heliothis armigera granulovirus; Hoplodrina ambigua granulovirus; Hyphantria cunea granulovirus; Natada nararia granulovirus; Nephelodes emmedonia granulovirus; Pandemis limitata granulovirus; Peridorma morpontora granulovirus; Pieris rapae granulovirus; Plathypena scabra granulovirus; Pseudaletia betabaculovirus; Scotogramma trifolii granulovirus; Spodoptera androgea granulovirus; Spodoptera littoralis granulovirus; Tecia solanivora granulovirus; or Mocis sp. granulovirus.

In some embodiments, a combination or composition comprises, consists essentially of, or consists of: a U+2-ACTX-Hv1a toxin having an amino acid sequence according to the amino acid sequence set forth in SEQ ID NO: 61, and a Deltabaculovirus virus selected from the following group: Culex nigripalpus nucleopolyhedrovirus; or Culex nigripalpus NPV Florida/1997.

In some embodiments, a combination or composition comprises, consists essentially of, or consists of: a U+2-ACTX-Hv1a toxin having an amino acid sequence according to the amino acid sequence set forth in SEQ ID NO: 61, and a Gammabaculovirus virus selected from the following group: Neodiprion lecontei nucleopolyhedrovirus; Neodiprion lecontei NPV (strain Canada); Neodiprion sertifer nucleopolyhedrovirus; unclassified Gammabaculovirus; or Neodiprion abietis NPV.

In some embodiments, a combination or composition comprises, consists essentially of, or consists of: a U+2-ACTX-Hv1a toxin having an amino acid sequence according to the amino acid sequence set forth in SEQ ID NO: 61, and a heretofore unclassified Baculoviridae virus selected from the following group: Achaea faber nucleopolyhedrovirus; Aedes sollicitans nucleopolyhedrovirus; Aglais urticae nucleopolyhedrovirus; Agraulis vanillae nucleopolyhedrovirus; Anomis sabulifera nucleopolyhedrovirus; Antheraea yamamai nucleopolyhedrovirus; Anthophila fabriciana granulovirus; Aroa discalis nucleopolyhedrovirus; Baculovirus penaei; Cadra cautella nucleopolyhedrovirus; Chaliopsis junodi nucleopolyhedrovirus; Cotesia marginiventris baculovirus; Cynosarga ornata nucleopolyhedrovirus; Darna nararia granulovirus; Darna trima granulovirus; Erannis defoliaria nucleopolyhedrovirus; Euplexia lucipara granulovirus;

Euproctis chrysorrhoea nucleopolyhedrovirus; Euproctis similis nucleopolyhedrovirus; Gonad-specific virus; Homona coffearia granulovirus; Hyblaea puera nucleopolyhedrovirus; Idaea seriata nucleopolyhedrovirus; Junonia coenia granulovirus; Lasiocampa quercus nucleopolyhedrovirus; Lemyra imparilis nucleopolyhedrovirus; Mahasena corbetti nucleopolyhedrovirus; Melanchra persicariae granulovirus; Operophtera bruceata nucleopolyhedrovirus; Orgyia antiqua nucleopolyhedrovirus; Orgyia mixta nucleopolyhedrovirus; Pachytrina philargyria nucleopolyhedrovirus; Pareuchaetes pseudoinsulata nucleopolyhedrovirus; Penaeus monodon nucleopolyhedrovirus; Phalera bucephala nucleopolyhedrovirus; Polygonia c-album nucleopolyhedrovirus; Samia ricini nucleopolyhedrovirus; Spilosoma lutea granulovirus; Spodoptera albula nucleopolyhedrovirus; Trabala vishnou nucleopolyhedrovirus; Uranotaenia sapphirina nucleopolyhedrovirus; Urbanus proteus nucleopolyhedrovirus; Utetheisa pulchella nucleopolyhedrovirus; Vanessa atalanta nucleopolyhedrovirus; Vanessa cardui nucleopolyhedrovirus; Wiseana cervinata granulovirus; or Baculoviridae sp.

In some embodiments, a combination or composition comprises, consists essentially of, or consists of: a U+2-ACTX-Hv1a toxin having an amino acid sequence according to the amino acid sequence set forth in SEQ ID NO: 61, and a Baculoviridae virus

In some embodiments, a combination or composition comprises, consists essentially of, or consists of: a U+2-ACTX-Hv1a toxin having an amino acid sequence according to the amino acid sequence set forth in SEQ ID NO: 61, and a Betabaculovirus.

In some embodiments, a combination or composition comprises, consists essentially of, or consists of: a U+2-ACTX-Hv1a toxin having an amino acid sequence according to the amino acid sequence set forth in SEQ ID NO: 61, and a Adoxophyes orana granulovirus; a Agrotis segetum granulovirus; a Artogeia rapae granulovirus; a Pieris brassicae granulovirus; a Choristoneura fumiferana granulovirus; a Choristoneura occidentalis granulovirus; a Clostera anachoreta granulovirus; a Clostera anastomosis granulovirus A; a Clostera anastomosis granulovirus Henan; a Clostera anastomosis granulovirus B; a Cnaphalocrocis medinalis granulovirus; a Cryptophlebia leucotreta granulovirus; a Cydia pomonella granulovirus; a Cydia pomonella granulosis virus (isolate Mexican); a Diatraea saccharalis granulovirus; a Epinotia aporema granulovirus; a Erinnyis ello granulovirus; a Harrisina brillians granulovirus; a Helicoverpa armigera granulovirus; a Lacanobia oleracea granulovirus; a Mocis latipes granulovirus; a Mythimna unipuncta granulovirus A; a Pseudalatia unipuncta granulovirus; a Mythimna unipuncta granulovirus B; a Mythimna unipuncta granulovirus; a Phthorimaea operculella granulovirus; a Plodia interpunctella granulovirus; a Plutella xylostella granulovirus; a Spodoptera frugiperda granulovirus; a Spodoptera litura granulovirus; a Trichoplusia ni granulovirus; a Trichoplusia ni granulovirus LBIV-12; a Xestia c-nigrum granulovirus; a unclassified Betabaculovirus; a Achaea janata granulovirus; a Adoxophyes honmai granulovirus; a Agrotis exclamationis granulovirus; a Amelia pallorana granulovirus; a Andraca bipunctata granulovirus; a Autographa gamma granulovirus; a Caloptilia theivora granulovirus; a Choristoneura murinana granulovirus; a Choristoneura viridis betabaculovirus; a Clostera anastomosis granulovirus; a Cnephasia longana granulovirus; a Estigmene acrea granulovirus; a Euxoa ochrogaster granulovirus; a Heliothis armigera granulovirus; a Hoplodrina ambigua granulovirus; a Hyphantria cunea granulovirus; a Natada nararia granulovirus; a Nephelodes emmedonia granulovirus; a Pandemis limitata granulovirus; a Peridorma morpontora granulovirus; a Pieris rapae granulovirus; a Plathypena scabra granulovirus; a Pseudaletia betabaculovirus; a Scotogramma trifolii granulovirus; a Spodoptera androgea granulovirus; a Spodoptera littoralis granulovirus; a Tecia solanivora granulovirus; or a Mocis sp. Granulovirus.

In some embodiments, a combination or composition comprises, consists essentially of, or consists of: a U+2-ACTX-Hv1a toxin having an amino acid sequence according to the amino acid sequence set forth in SEQ ID NO: 61, and a Cydia pomonella granulovirus.

In some embodiments, a combination or composition comprises, consists essentially of, or consists of: a U+2-ACTX-Hv1a toxin having an amino acid sequence according to the amino acid sequence set forth in SEQ ID NO: 61, and a Cydia pomonella granulovirus isolate V22 virus.

In some embodiments, a combination or composition comprises, consists essentially of, or consists of: a U+2-ACTX-Hv1a toxin having an amino acid sequence according to the amino acid sequence set forth in SEQ ID NO: 61, and a Cydia pomonella granulovirus isolate V22 virus, wherein the combination or composition comprises a concentration of the Cydia pomonella granulovirus isolate V22 virus ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

In some embodiments, a combination or composition comprises, consists essentially of, or consists of: a U+2-ACTX-Hv1a toxin having an amino acid sequence according to the amino acid sequence set forth in SEQ ID NO: 61, and a Cydia pomonella granulovirus isolate V22 virus, wherein the combination or composition comprises a concentration of the U+2-ACTX-Hy1a toxin having an amino acid sequence according to the amino acid sequence set forth in SEQ ID NO: 61 ranging from about 0.0001% w/w, 0.0005% w/w, 0.001% w/w, 0.005% w/w, 0.01% w/w, 0.02% w/w, 0.03% w/w, 0.04% w/w, 0.05% w/w, 0.06% w/w, 0.07% w/w, 0.08% w/w, 0.09% w/w, 0.1% w/w, 0.2% w/w, 0.3% w/w, 0.4% w/w, 0.5% w/w, 0.6% w/w, 0.7% w/w, 0.8% w/w, 0.9% w/w, 1% w/w, 2% w/w, 3% w/w, 4% w/w, 5% w/w, 6% w/w, 7% w/w, 8% w/w, 9% w/w, 10% w/w, 11% w/w, 12% w/w, 13% w/w, 14% w/w, 15% w/w, 16% w/w, 17% w/w, 18% w/w, 19% w/w, 20% w/w, 21% w/w, 22% w/w, 23% w/w, 24% w/w, 25% w/w, 26% w/w, 27% w/w, 28% w/w, 29% w/w, 30% w/w, 31% w/w, 32% w/w, 33% w/w, 34% w/w, 35% w/w, 36% w/w, 37% w/w, 38% w/w, 39% w/w, 40% w/w, 41% w/w, 42% w/w, 43% w/w, 44% w/w, 45% w/w, 46% w/w, 47% w/w, 48% w/w, 49% w/w, 50% w/w, 51% w/w, 52% w/w, 53% w/w, 54% w/w, 55% w/w, 56% w/w, 57% w/w, 58% w/w, 59% w/w, 60% w/w, 61% w/w, 62% w/w, 63% w/w, 64% w/w, 65% w/w, 66% w/w, 67% w/w, 68% w/w, 69% w/w, 70% w/w, 71% w/w, 72% w/w, 73% w/w, 74% w/w, 75% w/w, 76% w/w, 77% w/w, 78% w/w, 79% w/w, 80% w/w, 81% w/w, 82% w/w, 83% w/w, 84% w/w, 85% w/w, 86% w/w, 87% w/w, 88% w/w, 89% w/w, 90% w/w, 91% w/w, 92% w/w, 93% w/w, 94% w/w, 95% w/w, 96% w/w, 97% w/w, 98% w/w, 99% w/w, 99.1% w/w, 99.2% w/w, 99.3% w/w, 99.4% w/w, 99.5% w/w, 99.6% w/w, 99.7% w/w, 99.8% w/w, or about 99.9% w/w of the total composition.

Methods of Using the Present Invention

Methods for Protecting Plants, Plant Parts, and Seeds

In some embodiments, the present disclosure provides a method for controlling an invertebrate pest in agronomic and/or nonagronomic applications, comprising contacting the invertebrate pest or its environment, a solid surface, including a plant surface or part thereof, with a pesticidally effective amount of a combination of (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein.

In some embodiments, the present disclosure provides a method for controlling an invertebrate pest in agronomic and/or nonagronomic applications, comprising contacting the invertebrate pest or its environment, a solid surface, including a plant surface or part thereof, with a pesticidally effective amount of a composition comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients. For example, in some embodiments, the composition can comprise: (1) one or more CRIPs set for the in Table A, i.e., A1-A68, (2) one or more Insecticidal Agents set forth in Table B, i.e., B1-B479, and (3) an excipient.

Examples of suitable compositions comprising: (1) one or more CRIPs, or pharmaceutically acceptable salt thereof; one or more CRIP-insecticidal proteins, or pharmaceutically acceptable salt thereof; or a combination thereof; (2) one or more Insecticidal Agents (IA), as described herein; and (3) one or more excipients, include said compositions formulated win inactive ingredients to be delivered in the form of: a liquid solution, an emulsion, a powder, a granule, a nanoparticle, a microparticle, or a combination thereof.

In some embodiments, to achieve contact with a compound, mixture, or composition of the invention to protect a field crop from invertebrate pests, the compound or composition is typically applied to the seed of the crop before planting, to the foliage (e.g., leaves, stems, flowers, fruits) of crop plants, or to the soil or other growth medium before or after the crop is planted.

One embodiment of a method of contact is by spraying. Alternatively, a granular composition comprising: (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients, can be applied to the plant foliage or the soil. Compounds of this invention can also be effectively delivered through plant uptake by contacting the plant with a composition comprising a compound of this invention applied as a soil drench of a liquid formulation, a granular formulation to the soil, a nursery box treatment or a dip of transplants. Of note is a composition of the present disclosure in the form of a soil drench liquid formulation. Also of note is a method for controlling an invertebrate pest comprising contacting the invertebrate pest or its environment with a biologically effective amount of a combination of the present invention. Of further note, in some illustrative embodiments, the illustrative method contemplates a soil environment, wherein the composition is applied to the soil as a soil drench formulation. Of further note is that a combination of a CRIP and IA of the present invention is also effective by localized application to the locus of infestation. Other methods of contact include application of a compound or a composition of the invention by direct and residual sprays, aerial sprays, gels, seed coatings, microencapsulations, systemic uptake, baits, ear tags, boluses, foggers, fumigants, aerosols, dusts and many others. One embodiment of a method of contact is a dimensionally stable fertilizer granule, stick or tablet comprising a compound or composition of the invention. The compounds of this invention can also be impregnated into materials for fabricating invertebrate control devices (e.g., insect netting, application onto clothing, application into candle formulations and the like).

In some embodiments, a combination comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and optionally (3) one or more excipients, is also useful in seed treatments for protecting seeds from invertebrate pests. In the context of the present disclosure and claims, treating a seed means contacting the seed with a pesticidally effective amount of a combination of (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein, which is typically formulated as a composition of the invention. This seed treatment protects the seed from invertebrate soil pests and generally can also protect roots and other plant parts in contact with the soil of the seedling developing from the germinating seed. The seed treatment may also provide protection of foliage by translocation of the (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein, within the developing plant. Seed treatments can be applied to all types of seeds, including those from which plants genetically transformed to express specialized traits will germinate. In addition, in some embodiments, a CRIP can be transformed into a plant or part thereof, for example a plant cell, or plant seed, that is already transformed, e.g., those expressing herbicide resistance such as glyphosate acetyltransferase, which provides resistance to glyphosate.

One method of seed treatment is by spraying or dusting the seed with a combination comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients, before sowing the seeds. Compositions formulated for seed treatment generally consist of the combination of the present invention, and a film former or adhesive agent. Therefore, typically, a seed coating composition of the present disclosure consists of a pesticidally effective amount of: (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein, and a film former or adhesive agent. Seed can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Monograph No. 57, and references listed therein, the disclosures of which are incorporated herein by reference in their entireties.

The treated seed typically comprises a combination of (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein, in an amount ranging from about 0.01 g to 1 kg per 100 kg of seed (i.e. from about 0.00001 to 1% by weight of the seed before treatment). A flowable suspension formulated for seed treatment typically comprises from about 0.5 to about 70% of the active ingredient, from about 0.5 to about 30% of a film-forming adhesive, from about 0.5 to about 20% of a dispersing agent, from 0 to about 5% of a thickener, from 0 to about 5% of a pigment and/or dye, from 0 to about 2% of an antifoaming agent, from 0 to about 1% of a preservative, and from 0 to about 75% of a volatile liquid diluent.

Methods of Using Formulations and Compositions

In some embodiments, the present invention provides a method of using a combination comprising: (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients; wherein said method comprises, preparing the composition and then applying said composition to the locus of an insect.

In some embodiments, the present invention provides a method of using a composition to control insects, said composition comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients; wherein the insects are selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curia/is); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subs/gnaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of protecting a plant from insects comprising, providing a plant which expresses one or more CRIPs, or polynucleotides encoding the same; and one or more peptide-IAs.

In some embodiments, the present invention provides a method of protecting a plant from insects comprising, providing a plant which expresses one or more CRIPs, or polynucleotides encoding the same; and application of one or more non-peptide-IAs to said plant.

In some embodiments, the present invention provides a method of combating, controlling, or inhibiting a pest comprising, applying a pesticidally effective amount of a composition comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients; wherein the composition is applied to the locus of the pest, or to a plant or animal susceptible to an attack by the pest.

Any of the compositions described herein can be used in the method of combating, controlling, or inhibiting a pest comprising, applying a pesticidally effective amount of a composition comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients.

For example, in some embodiments, the present invention provides a method of combating, controlling, or inhibiting a pest comprising, applying a pesticidally effective amount of a composition comprising: (1) one or more CRIPs, or pharmaceutically acceptable salt thereof; CRIP-insecticidal proteins, or pharmaceutically acceptable salt thereof; or combination thereof; and (2) one or more Insecticidal Agents (IA), as described herein; wherein the CRIP is selected from Table A, i.e., A1; A2; A3; A4; A5; A6; A7; A8; A9; A10; A11; A12; A13; A14; A15; A16; A17; A18; A19; A20; A21; A22; A23; A24; A25; A26; A27; A28; A29; A30; A31; A32; A33; A34; A35; A36; A37; A38; A39; A40; A41; A42; A43; A44; A45; A46; A47; A48; A49; A50; A51; A52; A53; A54; A55; A56; A57; A58; A59; A60; A61; A62; A63; A64; A65; A66; A67; or A68; wherein said CRIP is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to an amino acid sequences set forth in 1; 2; 3; 4; 5; 6; 7; 8; 9; 10; 11; 12; 13; 14; 15; 49; 50; 51;

52; 53; 621; 622; 623; 624; 625; 626; 627; 628; 629; 630; 631; 632; 633; 634; 635; 636; 637; 638; 639; 640; 641; 642; 643; 644; 645; 646; 647; 648; 649; 650; 651; 652; 653; 654; 66; 88; 588; 44; 45; 46; 47; 60; 61; 62; 63; 64; 594; or 65, respectively.

In some embodiments, the present invention provides a method of combating, controlling, or inhibiting a pest comprising, applying a pesticidally effective amount of a composition comprising: (1) one or more CRIPs, or pharmaceutically acceptable salt thereof; CRIP-insecticidal proteins, or pharmaceutically acceptable salt thereof; or combination thereof; and (2) one or more Insecticidal Agents (IA), as described herein; wherein the CRIP peptide may comprise, consist essentially of, or consist of, a peptide having an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to: a spider peptide having an amino acid sequence as set forth in any one of SEQ ID NOs: 192-370; an ACTX peptide (e.g., U-ACTX-Hv1a, U+2-ACTX-Hv1a, rU-ACTX-Hv1a, rU-ACTX-Hv1b, κ-ACTX-Hv1a, κ+2-ACTX-Hv1a, ω-ACTX-Hv1a, and/or ω+2-ACTX-Hv1a) having an amino acid sequence as set forth in any one of SEQ ID NOs: 60-64, 192-370 and 594; an Γ-CNTX-Pn1a having an amino acid sequence as set forth in any one of SEQ ID NO: 65; a U1-agatoxin-Ta1b peptide having an amino acid sequence as set forth in SEQ ID NO: 1; a U1-agatoxin-Ta1b Variant Polypeptide (TVP) having an amino acid sequence as set forth in any one of SEQ ID NOs: 2-15, 49-53, 2-15, 49-53, 621-622, 624-628, 631-640, 642-651, or 653-654; a scorpion peptide having an amino acid sequence as set forth in any one of SEQ ID NOs: 66, 88-191; a sea anemone peptide having an amino acid sequence as set forth in any one of SEQ ID NOs: 371-411; an Av3 polypeptide from Anemonia viridis having an amino acid sequence as set forth in SEQ ID NO:44; an Av3 variant polypeptide (AVP) having an amino acid sequence as set forth in any one of SEQ ID NOs: 45-47; or a conotoxin; and wherein the IA is an IA listed in Table B, and wherein the IA is B1; B2; B3; B4; B5; B6; B7; B8; B9; B10; B11; B12; B13; B14; B15; B16; B17; B18; B19; B20; B21; B22; B23; B24; B25; B26; B27; B28; B29; B30; B31; B32; B33; B34; B35; B36; B37; B38; B39; B40; B41; B42; B43; B44; B45; B46; B47; B48; B49; B50; B51; B52; B53; B54; B55; B56; B57; B58; B59; B60; B61; B62; B63; B64; B65; B66; B67; B68; B69; B70; B71; B72; B73; B74; B75; B76; B77; B78; B79; B80; B81; B82; B83; B84; B85; B86; B87; B88; B89; B90; B91; B92; B93; B94; B95; B96; B97; B98; B99; B100; B101; B102; B103; B104; B105; B106; B107; B108; B109; B110; B111; B112; B113; B114; B115; B116; B117; B118; B119; B120; B121; B122; B123; B124; B125; B126; B127; B128; B129; B130; B131; B132; B133; B134; B135; B136; B137; B138; B139; B140; B141; B142; B143; B144; B145; B146; B147; B148; B149; B150; B151; B152; B153; B154; B155; B156; B157; B158; B159; B160; B161; B162; B163; B164; B165; B166; B167; B168; B169; B170; B171; B172; B173; B174; B175; B176; B177; B178; B179; B180; B181; B182; B183; B184; B185; B186; B187; B188; B189; B190; B191; B192; B193; B194; B195; B196; B197; B198; B199; B200; B201; B202; B203; B204; B205; B206; B207; B208; B209; B210; B211; B212; B213; B214; B215; B216; B217; B218; B219; B220; B221; B222; B223; B224; B225; B226; B227; B228; B229; B230; B231; B232; B233; B234; B235; B236; B237; B238; B239; B240; B241; B242; B243; B244; B245; B246; B247; B248; B249; B250; B251; B252; B253; B254; B255; B256; B257; B258; B259; B260; B261; B262; B263; B264; B265; B266; B267; B268; B269; B270; B271; B272; B273; B274; B275; B276; B277; B278; B279; B280; B281; B282; B283; B284; B285; B286; B287; B288; B289; B290; B291; B292; B293; B294; B295; B296; B297; B298; B299; B300; B301; B302; B303; B304; B305; B306; B307; B308; B309; B310; B311; B312; B313; B314; B315; B316; B317; B318; B319; B320; B321; B322; B323; B324; B325; B326; B327; B328; B329; B330; B331; B332; B333; B334; B335; B336; B337; B338; B339; B340; B341; B342; B343; B344; B345; B346; B347; B348; B349; B350; B351; B352; B353; B354; B355; B356; B357; B358; B359; B360; B361; B362; B363; B364; B365; B366; B367; B368; B369; B370; B371; B372; B373; B374; B375; B376; B377; B378; B379; B380; B381; B382; B383; B384; B385; B386; B387; B388; B389; B390; B391; B392; B393; B394; B395; B396; B397; B398; B399; B400; B401; B402; B403; B404; B405; B406; B407; B408; B409; B410; B411; B412; B413; B414; B415; B416; B417; B418; B419; B420; B421; B422; B423; B424; B425; B426; B427; B428; B429; B430; B431; B432; B433; B434; B435; B436; B437; B438; B439; B440; B441; B442; B443; B444; B445; B446; B447; B448; B449; B450; B451; B452; B453; B454; B455; B456; B457; B458; B459; B460; B461; B462; B463; B464; B465; B466; B467; B468; B469; B470; B471; B472; B473; B474; B475; B476; B477; B478; B479; or a combination thereof.

Method of Using TVP Compositions (Formula I)

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients, wherein the one or more excipients is selected from the group consisting of: trehalose; maltodextrin; potassium phosphate dibasic anhydrous (K₂HPO₄); potassium phosphate monobasic (KH₂PO₄); BIT; and fermentation solids.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein ranges from about 2% to about 16% wt/wt; and wherein trehalose ranges from about 5% to about 40% wt/wt; BIT ranges from about 0.01% to about 0.1% wt/wt; maltodextrin ranges from about 10% to about 50% wt/wt; potassium phosphate dibasic anhydrous (K₂HPO₄) ranges from about 1% to about 5% wt/wt; and potassium phosphate monobasic (KH₂PO₄) ranges from about 0.10% to about 1% wt/wt; and fermentation solids range from about 15% to about 40% wt/wt; of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein ranges from about 7% to about 9% wt/wt; and wherein trehalose ranges from about 20% to about 30% wt/wt; BIT ranges from about 0.025% to about 0.075% wt/wt; maltodextrin ranges from about 30% to about 40% wt/wt; potassium phosphate dibasic anhydrous (K₂HPO₄) ranges from about 2% to about 3% wt/wt; potassium phosphate monobasic (KH₂PO₄) ranges from about 0.2% to about 0.6%; and fermentation solids range from about 20% to about 30%, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein is about 8.5% wt/wt; and wherein trehalose is about 25% wt/wt; BIT is about 0.05% wt/wt; maltodextrin is about 36.3% wt/wt; potassium phosphate dibasic anhydrous (K₂HPO₄) is about 2.6% wt/wt; potassium phosphate monobasic (KH₂PO₄) is about 0.4% wt/wt; and fermentation solids are about 26.85% wt/wt, of the total weight of the composition.

In some embodiments, the present invention provides a method of combating, controlling, or inhibiting a pest comprising, applying a pesticidally effective amount of a composition consisting essentially of (1) a combination of an Insecticidal Agent (IA) and a CRIP; wherein the IA is an IA set forth in Table B, i.e., any one or more of B1-B479; and wherein the CRIP is a TVP or TVP-insecticidal protein; and wherein the composition consists essentially of the following: an amount of a TVP or a TVP-insecticidal protein that is 8.5% wt/wt; an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising a combination of an Insecticidal Agent (IA) and a CRIP; wherein the IA is an IA set forth in Table B, i.e., any one or more of B1-B479; and wherein the CRIP is a TVP or a TVP-insecticidal protein; and wherein the composition has the following amounts: an amount of a TVP or a TVP-insecticidal protein that is 8.5% wt/wt; an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein comprises an amino acid sequence that is at least 90% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; or a pharmaceutically acceptable salt thereof wherein the composition consists of an amount of TVP that is 8.5% wt/wt of the total weight of the composition; and wherein the plurality of excipients consists of the following: an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP has one amino acid substitution at X₁, X₂, X₃, X₄, or X₅, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP has one amino acid substitution at X₁, X₂, X₃, X₄, or X₅; and wherein X₇ is Glycine, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the TVP has one amino acid substitution at X₁, X₂, X₃, X₄, or X₅; and wherein X₇ is absent, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the TVP has one amino acid substitution at X₁, X₂, X₃, X₄, or X₅; and wherein X₆ and X₇ are absent, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP comprises an amino sequence as set forth in any one of SEQ ID NOs: 2-15, 49-53, 2-15, 49-53, 621-622, 624-628, 631-640, 642-651, or 653-654.

In some embodiments, the present invention provides a method of combating, controlling, or inhibiting a pest comprising, applying a pesticidally effective amount of a composition consisting of (1) a TVP, a TVP-insecticidal protein, or a combination thereof; and (2) a plurality of excipients; wherein the TVP or TVP-insecticidal protein; wherein the TVP is encoded by a polynucleotide sequence as set forth in any one of SEQ ID NOs: 17-30, 54-58, or 655-688, or a complementary nucleotide sequence thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the TVP further comprises a homopolymer or heteropolymer of two or more TVPs, wherein the amino acid sequence of each TVP is the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the TVP is a fused protein comprising two or more TVPs separated by a cleavable or non-cleavable linker, and wherein the amino acid sequence of each TVP may be the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the linker is a cleavable linker.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the cleavable linker is cleavable inside the gut or hemolymph of an insect.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein comprises an amino acid sequence that is at least 90% identical to the amino acid sequence according to Formula (I): E-P-D-E-I-C-R-X₁-X₂-M-X₃-N-K-E-F-T-Y-X₄-S-N-V-C-N-N-C-G-D-Q-V-A-A-C-E-A-E-C-F-X₅-N-D-V-Y-Z₁-A-C-H-E-A-Q-X₆-X₇, wherein the polypeptide comprises at least one amino acid substitution relative to the wild-type sequence of U1-agatoxin-Ta1b as set forth in SEQ ID NO:1, and wherein X₁ is A, S, or N; X₂ is R, Q, N, A, G, N, L, D, V, M, I, C, E, T, or S; X₃ is T or P; X₄ is K or A; X₅ is R or A; Z₁ is T, S, A, F, P, Y, K, W, H, A, G, N, L, V, M, I, Q, C, E, or R; X₆ is K or absent; and X₇ is G or absent; or a pharmaceutically acceptable salt thereof; wherein the composition consists of an amount of TVP that is 8.5% wt/wt of the total weight of the composition; and wherein the plurality of excipients consists of the following: an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition; wherein if Z₁ is T or S, then the TVP is glycosylated.

Any of the foregoing TVPs, TVP-insecticidal proteins, or pharmaceutically acceptable salts thereof, can be used in the any of the formulations described herein and below, e.g., any of the foregoing TVPs, TVP-insecticidal proteins, or pharmaceutically acceptable salts thereof, can be used in the formulation of: a wettable powder or granule formulation; or a liquid concentrate formulation.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP or a TVP-insecticidal protein; and (2) an excipient; to the locus of a pest, wherein the pest is selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curcuhonoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

Method of Using TVP Compositions (Formula II)

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP or a TVP-insecticidal protein; and (2) an excipient; wherein the TVP is selected from one or any combination of the TVPs described herein, e.g., an insecticidal U₁-agatoxin-Ta1b variant polypeptide (TVP), said TVP comprising an amino acid sequence that is at least 90% identical to the amino acid sequence according to Formula (II): E-P-D-E-I-C-R-A-X₁-M-T-N-K-E-F-T-Y-K-S-N-V-C-N-N-C-G-D-O-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; and wherein the composition is applied to the locus of the pest, or to a plant or animal susceptible to an attack by the pest.

Any of the compositions described herein can be used in the method of method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP or a TVP-insecticidal protein; and (2) an excipient.

For example, in some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, and one or more excipients; wherein the TVP comprises an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof; and wherein the one or more excipients is selected from the group consisting of: trehalose; maltodextrin; maltose; potassium phosphate dibasic (K₂HPO₄); potassium phosphate monobasic (KH₂PO₄); lignosulfonate; gypsum; sorbitol; sodium benzoate; potassium sorbate; EDTA; benzisothiazolinone (BIT); and fermentation solids.

In some embodiments, the present invention provides a method of combating, controlling, or inhibiting a pest comprising, applying a pesticidally effective amount of a composition comprising a TVP, wherein Z₁ is T and the TVP is glycosylated, or a pharmaceutically acceptable salt thereof.

In some embodiments, the present invention provides a method of combating, controlling, or inhibiting a pest comprising, applying a pesticidally effective amount of a composition consisting of a TVP, wherein X₁ is Q; and Z₁ is A, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, wherein the TVP comprises an amino sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to any of the amino acid sequences set forth in any one of SEQ ID NOs: 2, 49, or 51.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, wherein the TVP is encoded by a polynucleotide sequence as set forth in any one of SEQ ID NOs: 17, 54, or 56, or a complementary nucleotide sequence thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is f a TVP, wherein the TVP further comprises a homopolymer or heteropolymer of two or more TVPs, wherein the amino acid sequence of each TVP is the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, wherein the TVP is a fused protein comprising two or more TVPs separated by a cleavable linker or non-cleavable linker, and wherein the amino acid sequence of each TVP may be the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP having a linker, wherein the linker is a cleavable linker.

In some embodiments, a composition of the present invention comprises a TVP having a cleavable linker, wherein the cleavable linker is cleavable inside the gut or hemolymph of an insect.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP having a linker.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, and one or more excipients; wherein the TVP comprises an amino acid sequence that is at least 50% identical, at least 55% identical, at least 60% identical, at least 65% identical, at least 70% identical, at least 75% identical, at least 80% identical, at least 81% identical, at least 82% identical, at least 83% identical, at least 84% identical, at least 85% identical, at least 86% identical, at least 87% identical, at least 88% identical, at least 89% identical, at least 90% identical, at least 91% identical, at least 92% identical, at least 93% identical, at least 94% identical, at least 95% identical, at least 96% identical, at least 97% identical, at least 98% identical, at least 99% identical, at least 99.5% identical, at least 99.6% identical, at least 99.7% identical, at least 99.8% identical, at least 99.9% identical, or 100% identical to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof; and wherein the one or more excipients is selected from the group consisting of: trehalose; maltodextrin; maltose; potassium phosphate dibasic (K₂HPO₄); potassium phosphate monobasic (KH₂PO₄); lignosulfonate; gypsum; sorbitol; sodium benzoate; potassium sorbate; EDTA; benzisothiazolinone (BIT); and fermentation solids, wherein if Z₁ is T or S, then the TVP is glycosylated.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients, wherein the one or more excipients is selected from the group consisting of: trehalose; maltodextrin; potassium phosphate dibasic anhydrous (K₂HPO₄); potassium phosphate monobasic (KH₂PO₄); BIT; and fermentation solids.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein ranges from about 2% to about 16% wt/wt; and wherein trehalose ranges from about 5% to about 40% wt/wt; BIT ranges from about 0.01% to about 0.1% wt/wt; maltodextrin ranges from about 10% to about 50% wt/wt; potassium phosphate dibasic anhydrous (K₂HPO₄) ranges from about 1% to about 5% wt/wt; and potassium phosphate monobasic (KH₂PO₄) ranges from about 0.10% to about 1% wt/wt; and fermentation solids range from about 15% to about 40% wt/wt; of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein ranges from about 7% to about 9% wt/wt; and wherein trehalose ranges from about 20% to about 30% wt/wt; BIT ranges from about 0.025% to about 0.075% wt/wt; maltodextrin ranges from about 30% to about 40% wt/wt; potassium phosphate dibasic anhydrous (K₂HPO₄) ranges from about 2% to about 3% wt/wt; potassium phosphate monobasic (KH₂PO₄) ranges from about 0.2% to about 0.6%; and fermentation solids range from about 20% to about 30%, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) one or more excipients; wherein the TVP or TVP-insecticidal protein is about 8.5% wt/wt; and wherein trehalose is about 25% wt/wt; BIT is about 0.05% wt/wt; maltodextrin is about 36.3% wt/wt; potassium phosphate dibasic anhydrous (K₂HPO₄) is about 2.6% wt/wt; potassium phosphate monobasic (KH₂PO₄) is about 0.4% wt/wt; and fermentation solids are about 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP; and wherein the composition comprises the following amounts: an amount of a TVP or a TVP-insecticidal protein that is 8.5% wt/wt; an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP; and wherein the composition comprises the following amounts: an amount of a TVP or a TVP-insecticidal protein that is 8.5% wt/wt; an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein comprises an amino acid sequence that is at least 90% identical to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof; wherein the composition consists of an amount of TVP that is 8.5% wt/wt of the total weight of the composition; and wherein the plurality of excipients consists of the following: an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein Z₁ is T and the TVP is glycosylated, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein X₁ is Q; and Z₁ is A, or a pharmaceutically acceptable salt thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP comprises an amino sequence as set forth in any one of SEQ ID NOs: 2, 49, or 51.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP is encoded by a polynucleotide sequence as set forth in any one of SEQ ID NOs: 17, 54, or 56, or a complementary nucleotide sequence thereof.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the TVP further comprises a homopolymer or heteropolymer of two or more TVPs, wherein the amino acid sequence of each TVP is the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein; wherein the TVP is a fused protein comprising two or more TVPs separated by a cleavable or non-cleavable linker, and wherein the amino acid sequence of each TVP may be the same or different.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the linker is a cleavable linker.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof and (2) a plurality of excipients; wherein the TVP or TVP-insecticidal protein; wherein the cleavable linker is cleavable inside the gut or hemolymph of an insect.

In some embodiments, the present invention provides a method of combating, controlling, or inhibiting a pest comprising, applying a pesticidally effective amount of a composition comprising (1) a combination of an Insecticidal Agent (IA) and a CRIP; wherein the IA is an IA set forth in Table B, i.e., any one or more of B1-B479; and wherein the CRIP is a TVP, a TVP-insecticidal protein, or a combination thereof; and (2) a plurality of excipients; wherein the TVP or TVP-insecticidal protein comprises an amino acid sequence that is at least 90% identical to the amino acid sequence according to Formula (II): E-P-D-E-I-C-R-A-X₁-M-T-N-K-E-F-T-Y-K-S-N-V-C-N-N-C-G-D-Q-V-A-A-C-E-A-E-C-F-R-N-D-V-Y-Z₁-A-C-H-E-A-Q-K-G; wherein the polypeptide comprises at least one amino acid substitution relative to the wild-type sequence of U1-agatoxin-Ta1b as set forth in SEQ ID NO:1, and wherein X₁ is R or Q; and Z₁ is T or A; or a pharmaceutically acceptable salt thereof; wherein the composition consists of an amount of TVP that is 8.5% wt/wt of the total weight of the composition; and wherein the plurality of excipients consists of the following: an amount of trehalose that is 25% wt/wt; an amount of BIT that is 0.05% wt/wt; an amount of maltodextrin that is 36.3% wt/wt; an amount of potassium phosphate dibasic anhydrous (K₂HPO₄) that is 2.6% wt/wt; an amount of potassium phosphate monobasic (KH₂PO₄) that is 0.4% wt/wt; and an amount of fermentation solids that is 26.85% wt/wt, of the total weight of the composition; wherein if Z₁ is T or S, then the TVP is glycosylated.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP comprising an amino acid sequence that is at least 90% identical to the amino acid sequence set forth in any one of SEQ ID NOs: 2, 49, or 51; or a pharmaceutically acceptable salt thereof, to the locus of the pest.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP comprising an amino acid sequence set forth in any one of SEQ ID NOs: 2, 49, or 51; or a pharmaceutically acceptable salt thereof, to the locus of the pest.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP consisting of an amino acid sequence set forth in any one of SEQ ID NOs: 2, 49, or 51; or a pharmaceutically acceptable salt thereof, to the locus of the pest.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP comprising an amino acid sequence that is at least 90% identical to the amino acid sequence set forth in SEQ ID NO 51, or a pharmaceutically acceptable salt thereof, to the locus of the pest.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP comprising an amino acid sequence set forth in SEQ ID NO: 51, or a pharmaceutically acceptable salt thereof, to the locus of the pest.

In some embodiments, the present invention provides a method of combating, controlling, or inhibiting a pest comprising, applying a pesticidally effective amount of a combination comprising a combination of an Insecticidal Agent (IA) and a CRIP; wherein the IA is an IA set forth in Table B, i.e., any one or more of B1-B479; and wherein the CRIP is an insecticidal U₁-agatoxin-Ta1b variant polypeptide (TVP), said TVP consisting of an amino acid sequence set forth in SEQ ID NO: 51, or a pharmaceutically acceptable salt thereof, to the locus of the pest.

Any of the foregoing combinations comprising (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein, can be used in the any of the compositions described herein and the methods of using the same, i.e., to combat, control, or inhibit a pest and/or to apply to the locus of a pest, wherein the pest is selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curia/is); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elute/la); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

Crops and Pests

Specific crop pests and insects that may be controlled by these methods include the following: Dictyoptera (cockroaches); Isoptera (termites); Orthoptera (locusts, grasshoppers and crickets); Diptera (house flies, mosquito, tsetse fly, crane-flies and fruit flies); Hymenoptera (ants, wasps, bees, saw-flies, ichneumon flies and gall-wasps); Anoplura (biting and sucking lice); Siphonaptera (fleas); and Hemiptera (bugs and aphids), as well as arachnids such as Acari (ticks and mites), and the parasites that each of these organisms harbor.

“Pest” includes, but is not limited to: insects, fungi, bacteria, nematodes, mites, ticks, and the like.

Insect pests include, but are not limited to, insects selected from the orders Coleoptera, Diptera, Hymenoptera, Lepidoptera, Mallophaga, Homoptera, Hemiptera, Orthroptera, Thysanoptera, Dermaptera, Isoptera, Anoplura, Siphonaptera, Trichoptera, and the like. More particularly, insect pests include Coleoptera, Lepidoptera, and Diptera.

Insects of suitable agricultural, household and/or medical/veterinary importance for treatment with the insecticidal polypeptides include, but are not limited to, members of the following classes and orders:

The order Coleoptera includes the suborders Adephaga and Polyphaga. Suborder Adephaga includes the superfamilies Caraboidea and Gyrinoidea. Suborder Polyphaga includes the superfamilies Hydrophiloidea, Staphylinoidea, Cantharoidea, Cleroidea, Elateroidea, Dascilloidea, Dryopoidea, Byrrhoidea, Cucujoidea, Meloidea, Mordelloidea, Tenebrionoidea, Bostrichoidea, Scarabaeoidea, Cerambycoidea, Chrysomeloidea, and Curculionoidea. Superfamily Caraboidea includes the families Cicindelidae, Carabidae, and Dytiscidae. Superfamily Gyrinoidea includes the family Gyrinidae. Superfamily Hydrophiloidea includes the family Hydrophilidae. Superfamily Staphylinoidea includes the families Silphidae and Staphylinidae. Superfamily Cantharoidea includes the families Cantharidae and Lampyridae. Superfamily Cleroidea includes the families Cleridae and Dermestidae. Superfamily Elateroidea includes the families Elateridae and Buprestidae. Superfamily Cucujoidea includes the family Coccinellidae. Superfamily Meloidea includes the family Meloidae. Superfamily Tenebrionoidea includes the family Tenebrionidae. Superfamily Scarabaeoidea includes the families Passalidae and Scarabaeidae. Superfamily Cerambycoidea includes the family Cerambycidae. Superfamily Chrysomeloidea includes the family Chrysomelidae. Superfamily Curculionoidea includes the families Curculionidae and Scolytidae.

Examples of Coleoptera include, but are not limited to: the American bean weevil Acanthoscelides obtectus, the leaf beetle Agelastica alni, click beetles (Agriotes lineatus, Agriotes obscurus, Agriotes bicolor), the grain beetle Ahasverus advena, the summer schafer Amphimallon solstitialis, the furniture beetle Anobium punctatum, Anthonomus spp. (weevils), the Pygmy mangold beetle Atomaria linearis, carpet beetles (Anthrenus spp., Attagenus spp.), the cowpea weevil Callosobruchus maculates, the fried fruit beetle Carpophilus hemipterus, the cabbage seedpod weevil Ceutorhynchus assimilis, the rape winter stem weevil Ceutorhynchus picitarsis, the wireworms Conoderus vespertinus and Conoderus falli, the banana weevil Cosmopolites sordidus, the New Zealand grass grub Costelytra zealandica, the June beetle Cotinis nitida, the sunflower stem weevil Cylindrocopturus adspersus, the larder beetle Dermestes lardarius, the corn rootworms Diabrotica virgifera, Diabrotica virgifera virgifera, and Diabrotica barberi, the Mexican bean beetle Epilachna varivestis, the old house borer Hylotropes bajulus, the lucerne weevil Hypera postica, the shiny spider beetle Gibbium psylloides, the cigarette beetle Lasioderma serricorne, the Colorado potato beetle Leptinotarsa decemlineata, Lyctus beetles (Lyctus spp.), the pollen beetle Meligethes aeneus, the common cockshafer Melolontha melolontha, the American spider beetle Mezium americanum, the golden spider beetle Niptus hololeucus, the grain beetles Oryzaephilus surinamensis and Otyzaephilus mercator, the black vine weevil Otiorhynchus sulcatus, the mustard beetle Phaedon cochleariae, the crucifer flea beetle Phyllotreta cruciferae, the striped flea beetle Phyllotreta striolata, the cabbage steam flea beetle Psylliodes chrysocephala, Ptinus spp. (spider beetles), the lesser grain borer Rhizopertha dominica, the pea and been weevil Sitona lineatus, the rice and granary beetles Sitophilus oryzae and Sitophilus granaries, the red sunflower seed weevil Smicronyx fitivus, the drugstore beetle Stegobium paniceum, the yellow mealworm beetle Tenebrio molitor, the flour beetles Tribolium castaneum and Tribolium confusum, warehouse and cabinet beetles (Trogoderma spp.), and the sunflower beetle Zygogramma exclamationis.

Examples of Dermaptera (earwigs) include, but are not limited to: the European earwig, Forficula auricularia, and the striped earwig, Labidura riparia.

Examples of Dictvontera include, but are not limited to: the oriental cockroach, Blatta orientalis, the German cockroach, Blatella germanica, the Madeira cockroach, Leucophaea maderae, the American cockroach, Periplaneta americana, and the smokybrown cockroach Periplaneta fuliginosa.

Examples of Diplonoda include, but are not limited to: the spotted snake millipede Blaniulus guttulatus, the flat-back millipede Brachydesmus superus, and the greenhouse millipede Oxidus gracilis.

The order Diptera includes the Suborders Nematocera, Brachycera, and Cyclorrhapha. Suborder Nematocera includes the families Tipulidae, Psychodidae, Culicidae, Ceratopogonidae, Chironomidae, Simuliidae, Bibionidae, and Cecidomyiidae. Suborder Brachycera includes the families Stratiomyidae, Tabanidae, Therevidae, Asilidae, Mydidae, Bombyliidae, and Dolichopodidae. Suborder Cyclorrhapha includes the Divisions Aschiza and Aschiza. Division Aschiza includes the families Phoridae, Syrphidae, and Conopidae. Division Aschiza includes the Sections Acalyptratae and Calyptratae. Section Acalyptratae includes the families Otitidae, Tephritidae, Agromyzidae, and Drosophilidae. Section Calyptratae includes the families Hippoboscidae, Oestridae, Tachinidae, Anthomyiidae, Muscidae, Calliphoridae, and Sarcophagidae.

Examples of Diptera include, but are not limited to: the house fly (Musca domestica), the African tumbu fly (Cordylobia anthropophaga), biting midges (Culicoides spp.), bee louse (Braula spp.), the beet fly Pegomyia betae, blackflies (Cnephia spp., Eusimulium spp., Simulium spp.), bot flies (Cuterebra spp., Gastrophilus spp., Oestrus spp.), craneflies (Tipula spp.), eye gnats (Hippelates spp.), filth-breeding flies (Calliphora spp., Fannia spp., Hermetia spp., Lucilia spp., Musca spp., Muscina spp., Phaenicia spp., Phormia spp.), flesh flies (Sarcophaga spp., Wohlfahrtia spp.); the flit fly Oscinella frit, fruifflies (Dacus spp., Drosophila spp.), head and canon flies (Hydrotea spp.), the hessian fly Mayetiola destructor, horn and buffalo flies (Haematobia spp.), horse and deer flies (Chrysops spp., Haematopota spp., Tabanus spp.), louse flies (Lipoptena spp., Lynchia spp., and Pseudolynchia spp.), medflies (Ceratitus spp.), mosquitoes (Aedes spp., Anopheles spp., Culex spp., Psorophora spp.), sandflies (Phlebotomus spp., Lutzomyia spp.), screw-worm flies (Chtysomya bezziana and Cochliomyia hominivorw), sheep keds (Melophagus spp.); stable flies (Stomoxys spp.), tsetse flies (Glossina spp.), and warble flies (Hypoderma spp.).

Examples of Isontera (termites) include, but are not limited to: species from the familes Hodotennitidae, Kalotermitidae, Mastotermitidae, Rhinotennitidae, Serritermitidae, Termitidae, and Termopsidae.

Examples of Heteroptera include, but are not limited to: the bed bug Cimex lectularius, the cotton stainer Dysdercus intermedius, the Sunn pest Eurygaster integriceps, the tarnished plant bug Lygus lineolaris, the green stink bug Nezara antennata, the southern green stink bug Nezara viridula, and the triatomid bugs Panstrogylus megistus, Rhodnius ecuadoriensis, Rhodnius pallescans, Rhodnius prolixus, Rhodnius robustus, Triatoma dimidiata, Triatoma infestans, and Triatoma sordida.

Examples of Homoptera include, but are not limited to: the California red scale Aonidiella aurantii, the black bean aphid Aphis fabae, the cotton or melon aphid Aphis gossypii, the green apple aphid Aphis pomi, the citrus spiny whitefly Aleurocanthus spiniferus, the oleander scale Aspidiotus hederae, the sweet potato whitefly Bemesia tabaci, the cabbage aphid Brevicoryne brassicae, the pear psylla Cacopsylla pyricola, the currant aphid Cryptomyzus ribis, the grape phylloxera Daktulosphaira vitifoliae, the citrus psylla Diaphorina citri, the potato leafhopper Empoasca fabae, the bean leafhopper Empoasca solana, the vine leafhopper Empoasca vitis, the woolly aphid Eriosoma lanigerum, the European fruit scale Eulecanium corni, the mealy plum aphid Hyalopterus arundinis, the small brown planthopper Laodelphax striatellus, the potato aphid Macrosiphum euphorbiae, the green peach aphid Myzus persicae, the green rice leafhopper Nephotettix cinticeps, the brown planthopper Nilaparvata lugens, gall-forming aphids (Pemphigus spp.), the hop aphid Phorodon humuli, the bird-cherry aphid Rhopalosiphum padi, the black scale Saissetia oleae, the greenbug Schizaphis graminum, the grain aphid Sitobion avenae, and the greenhouse whitefly Trialeurodes vaporariorum.

Examples of Isopoda include, but are not limited to: the common pillbug Armadillidium vulgare and the common woodlouse Oniscus asellus.

The order Lepidoptera includes the families Papilionidae, Pieridae, Lycaenidae, Nymphalidae, Danaidae, Satyridae, Hesperiidae, Sphingidae, Saturniidae, Geometridae, Arctiidae, Noctuidae, Lymantriidae, Sesiidae, and Tineidae.

Examples of Lepidoptera include, but are not limited to: Adoxophyes orana (summer fruit tortrix moth), Agrotis ipsolon (black cutworm), Archips podana (fruit tree tortrix moth), Bucculatrix pyrivorella (pear leafminer), Bucculatrix thurberiella (cotton leaf perforator), Bupalus piniarius (pine looper), Carpocapsa pomonella (codling moth), Chilo suppressalis (striped rice borer), Choristoneura fumiferana (eastern spruce budworm), Cochylis hospes (banded sunflower moth), Diatraea grandiosella (southwestern corn borer), Earls insulana (Egyptian bollworm), Euphestia kuehniella (Mediterranean flour moth), Eupoecilia ambiguella (European grape berry moth), Euproctis chrysorrhoea (brown-tail moth), Euproctis subflava (oriental tussock moth), Galleria mellonella (greater wax moth), Helicoverpa armigera (cotton bollworm), Helicoverpa zea (cotton bollworm), Heliothis virescens (tobacco budworm), Hofmannophila pseudopretella (brown house moth), Homeosoma electellum (sunflower moth), Homona magnanima (oriental tea tree tortrix moth), Lithocolletis blancardella (spotted tentiform leafminer), Lymantria dispar (gypsy moth), Malacosoma neustria (tent caterpillar), Mamestra brassicae (cabbage armyworm), Mamestra configurata (Bertha armyworm), the hornworms Manduca sexta and Manuduca quinquemaculata, Operophtera brumata (winter moth), Ostrinia nubilalis (European corn borer), Panolis flammea (pine beauty moth), Pectinophora gossypiella (pink bollworm), Phyllocnistis citrella (citrus leafminer), Pieris brassicae (cabbage white butterfly), Plutella xylostella (diamondback moth), Rachiplusia ni (soybean looper), Spilosoma virginica (yellow bear moth), Spodoptera exigua (beet armyworm), Spodoptera frugiperda (fall armyworm), Spodoptera littoralis (cotton leafworin), Spodoptera litura (common cutworm), Spodoptera praefica (yellowstriped armyworm), Sylepta derogata (cotton leaf roller), Tineola bisselliella (webbing clothes moth), Tineola pellionella (case-making clothes moth), Tortrix viridana (European oak leafroller), Trichoplusia ni (cabbage looper), and Yponomeuta padella (small ermine moth).

Examples of Orthoptera include, but are not limited to: the common cricket Acheta domesticus, tree locusts (Anacridium spp.), the migratory locust Locusta migratoria, the two striped grasshopper Melanoplus bivittatus, the differential grasshopper Melanoplus dfferentialis, the redlegged grasshopper Melanoplus femurrubrum, the migratory grasshopper Melanoplus sanguinipes, the northern mole cricket Neocurtilla hexadectyla, the red locust Nomadacris septemfasciata, the shortwinged mole cricket Scapteriscus abbreviatus, the southern mole cricket Scapteriscus borellii, the tawny mole cricket Scapteriscus vicinus, and the desert locust Schistocerca gregaria.

Examples of Phthiraptera include, but are not limited to: the cattle biting louse Bovicola bovis, biting lice (Damalinia spp.), the cat louse Felicola subrostrata, the shortnosed cattle louse Haematopinus eloysternus, the tail-switch louse Haematopinus quadriperiussus, the hog louse Haematopinus suis, the face louse Linognathus ovillus, the foot louse Linognathus pedalis, the dog sucking louse Linognathus setosus, the long-nosed cattle louse Linognathus vituli, the chicken body louse Menacanthus stramineus, the poultry shaft louse Menopon gallinae, the human body louse Pediculus humanus, the pubic louse Phthirus pubis, the little blue cattle louse Solenopotes capillatus, and the dog biting louse Trichodectes canis.

Examples of Psocoptera include, but are not limited to: the booklice Liposcelis bostrychophila, Liposcelis decolor, Liposcelis entomophila, and Trogium pulsatorium. Examples of Siphonaptera include, but are not limited to: the bird flea Ceratophyllus gallinae, the dog flea Ctenocephalides canis, the cat flea Ctenocephalides fells, the human flea Pulex irritans, and the oriental rat flea Xenopsylla cheopis.

Examples of Symphyla include, but are not limited to: the garden symphylan Scutigerella immaculate.

Examples of Thysanura include, but are not limited to: the gray silverfish Ctenolepisma longicaudata, the four-lined silverfish Ctenolepisma quadriseriata, the common silverfish Lepisma saccharina, and the firebrat Thennobia domestica;

Examples of Thysanoptera include, but are not limited to: the tobacco thrips Frankliniella fusca, the flower thrips Frankliniella intonsa, the western flower thrips Frankliniella occidentalis, the cotton bud thrips Frankliniella schultzei, the banded greenhouse thrips Hercinothrips femoralis, the soybean thrips Neohydatothrips variabilis, Kelly's citrus thrips Pezothrips kellyanus, the avocado thrips Scirtothrips perseae, the melon thrips Thrips palmi, and the onion thrips Thrips tabaci.

Examples of Nematodes include, but are not limited to: parasitic nematodes such as root-knot, cyst, and lesion nematodes, including Heterodera spp., Meloidogyne spp., and Globodera spp.; particularly members of the cyst nematodes, including, but not limited to: Heterodera glycines (soybean cyst nematode); Heterodera schachtii (beet cyst nematode); Heterodera avenae (cereal cyst nematode); and Globodera rostochiensis and Globodera pailida (potato cyst nematodes). Lesion nematodes include, but are not limited to: Pratylenchus spp.

Other insect species susceptible to a combination comprising one or more CRIPs (e.g., one or more of CRIPs: A1-A34 in Table A) and one or more IAs (e.g., one or more of IAs: B1-B479 in Table B) of the present disclosure include: athropod pests that cause public and animal health concerns, for example, mosquitos for example, mosquitoes from the genera Aedes, Anopheles and Culex, from ticks, flea, and flies etc.

In one embodiment, the combination comprising one or more CRIPs (e.g., one or more of CRIPs: A1-A34 in Table A) and one or more IAs (e.g., one or more of IAs: B1-B479 in Table B) can be employed to treat ectoparasites. Ectoparasites include, but are not limited to: fleas, ticks, mange, mites, mosquitoes, nuisance and biting flies, lice, and combinations comprising one or more of the foregoing ectoparasites. The term “fleas” includes the usual or accidental species of parasitic flea of the order Siphonaptera, and in particular the species Ctenocephalides, in particular C. fells and C. cams, rat fleas (Xenopsylla cheopis) and human fleas (Pulex irritans).

Insect pests of the invention for the major crops include, but are not limited to: Maize: Ostrinia nubilalis, European corn borer; Agrotis ipsilon, black cutworm; Helicoverpa zea, corn earworm; Spodoptera frugiperda, fall armyworm; Diatraea grandiosella, southwestern corn borer; Elasmopalpus lignosellus, lesser cornstalk borer; Diatraea saccharalis, surgarcane borer; Diabrotica virgifera, western corn rootworm; Diabrotica longicornis barberi, northern corn rootworm; Diabrotica undecimpunctata howardi, southern corn rootworm; Melanotus spp., wireworms; Cyclocephala borealis, northern masked chafer (white grub); Cyclocephala immaculata, southern masked chafer (white grub); Popillia japonica, Japanese beetle; Chaetocnema pulicaria, corn flea beetle; Sphenophorus maidis, maize billbug; Rhopalosiphum maidis, corn leaf aphid; Anuraphis maidiradicis, corn root aphid; Blissus leucopterus leucopterus, chinch bug; Melanoplus femurrubrum, redlegged grasshopper; Melanoplus sanguinipes, migratory grasshopper; Hylemya platura, seedcorn maggot; Agromyza parvicornis, corn blot leafminer; Anaphothrips obscrurus, grass thrips; Solenopsis milesta, thief ant; Tetranychus urticae, twospotted spider mite; Sorghum: Chilo partellus, sorghum borer; Spodoptera frugiperda, fall armyworm; Helicoverpa zea, corn earworm; Elasmopalpus lignosellus, lesser cornstalk borer; Feltia subterranea, granulate cutworm; Phyllophaga crinita, white grub; Eleodes, Conoderus, and Aeolus spp., wireworms; Oulema melanopus, cereal leaf beetle; Chaetocnema pulicaria, corn flea beetle; Sphenophorus maidis, maize billbug; Rhopalosiphum maidis, corn leaf aphid; Sipha flava, yellow sugarcane aphid; Blissus leucopterus leucopterus, chinch bug; Contarinia sorghicola, sorghum midge; Tetranychus cinnabarinus, carmine spider mite; Tetranychus urticae, twospotted spider mite; Wheat: Pseudaletia unipunctata, army worm; Spodoptera frugiperda, fall armyworm; Elasmopalpus lignosellus, lesser cornstalk borer; Agrotis orthogonia, western cutworm; Elasmopalpus lignosellus, lesser cornstalk borer; Oulema melanopus, cereal leaf beetle; Hypera punctata, clover leaf weevil; Diabrotica undecimpunctata howardi, southern corn rootworm; Russian wheat aphid; Schizaphis graminum, greenbug; Macrosiphum avenae, English grain aphid; Melanoplus femurrubrum, redlegged grasshopper; Melanoplus differentialis, differential grasshopper; Melanoplus sanguinipes, migratory grasshopper; Mayetiola destructor, Hessian fly; Sitodiplosis mosellana, wheat midge; Meromyza americana, wheat stem maggot; Hylemya coarctata, wheat bulb fly; Frankliniella fusca, tobacco thrips; Cephus cinctus, wheat stem sawfly; Aceria tulipae, wheat curl mite; Sunflower: Suleima helianthana, sunflower bud moth; Homoeosoma electellum, sunflower moth; Zygogramma exclamationis, sunflower beetle; Bothyrus gibbosus, carrot beetle; Neolasioptera murtfeldtiana, sunflower seed midge; Cotton: Heliothis virescens, cotton budworm; Helicoverpa zea, cotton bollworm; Spodoptera exigua, beet armyworm; Pectinophora gossypiella, pink bollworm; Anthonomus grandis, boll weevil; Aphis gossypii, cotton aphid; Pseudatomoscelis seriatus, cotton fleahopper; Trialeurodes abutilonea, banded winged whitefly; Lygus lineolaris, tarnished plant bug; Melanoplus femurrubrum, redlegged grasshopper; Melanoplus differentialis, differential grasshopper; Thrips tabaci, onion thrips; Franklinkiella fusca, tobacco thrips; Tetranychus cinnabarinus, carmine spider mite; Tetranychus urticae, twospotted spider mite; Rice: Diatraea saccharalis, sugarcane borer; Spodoptera frugiperda, fall armyworm; Helicoverpa zea, corn earworm; Colaspis brunnea, grape colaspis; Lissorhoptrus oryzophilus, rice water weevil; Sitophilus oryzae, rice weevil; Nephotettix nigropictus, rice leafhopper; Blissus leucopterus, chinch bug; Acrosternum hilare, green stink bug; Soybean: Pseudoplusia includens, soybean looper; Anticarsia gemmatalis, velvet bean caterpillar; Plathypena scabra, green clover worm; Ostrinia nubilalis, European corn borer; Agrotis ipsilon, black cutworm; Spodoptera exigua, beet armyworm; Heliothis virescens, cotton budworm; Helicoverpa zea, cotton bollworm; Epilachna varivestis, Mexican bean beetle; Myzus persicae, green peach aphid; Empoasca fabae, potato leafhopper; Acrosternum hilare, green stink bug; Melanoplus femurrubrum, redlegged grasshopper; Melanoplus differentialis, differential grasshopper; Hylemya platura, seedcorn maggot; Sericothrips variabilis, soybean thrips; Thrips tabaci, onion thrips; Tetranychus turkestani, strawberry spider mite; Tetranychus urticae, twospotted spider mite; Barley: Ostrinia nubilalis, European corn borer; Agrotis ipsilon, black cutworm; Schizaphis graminum, greenbug; Blissus leucopterus leucopterus, chinch bug; Acrosternum hilare, green stink bug; Euschistus servus, brown stink bug; Delia platura, seedcorn maggot; Mayetiola destructor, Hessian fly; Petrobia latens, brown wheat mite; Oil Seed Rape: Brevicoryne brassicae, cabbage aphid; Phyllotreta cruciferae, Flea beetle; Mamestra configurata, Bertha armyworm; Plutella xylostella, Diamond-back moth; Delia ssp., Root maggots.

In some embodiments, a combination comprising one or more CRIPs (e.g., one or more of CRIPs: A1-A34 in Table A) and one or more IAs (e.g., one or more of IAs: B1-B479 in Table B) can be employed to treat any one or more of the foregoing insects.

The insects that are susceptible to the combinations and compositions of this invention include but are not limited to the following: Cyt toxins affected familes such as: Blattaria, Coleoptera, Collembola, Diptera, Echinostomida, Hemiptera, Hymenoptera, Isoptera, Lepidoptera, Neuroptera, Orthoptera, Rhabditida, Siphonoptera, and Thysanoptera. Genus Species are indicated as follows: Actebia fennica, Agrotis ipsilon, A. segetum, Anticarsia gemmatalis, Argyrotaenia citrana, Artogeia rapae, Bombyx mori, Busseola fusca, Cacyreus marshall, Chilo suppressalis, Christoneura fumiferana, C. occidentalis, C. pinus pinus, C. rosacena, Cnaphalocrocis medinalis, Conopomorpha cramerella, Ctenopsuestis obliquana, Cydia pomonella, Danaus plexippus, Diatraea saccharallis, D. grandiosella, Earias vittella, Elasmolpalpus lignoselius, Eldana saccharina, Ephestia kuehniella, Epinotia aporema, Epiphyas postvittana, Galleria mellonella, Genus Species, Helicoverpa zea, H. punctigera, H. armigera, Heliothis virescens, Hyphantria cunea, Lambdina fiscellaria, Leguminivora glycinivorella, Lobesia botrana, Lymantria dispar, Malacosoma disstria, Mamestra brassicae, M. configurata, Manduca sexta, Marasmia patnalis, Maruca vitrata, Orgyia leucostigma, Ostrinia nubilalis, O. furnacalis, Pandemis pyrusana, Pectinophora gossypiella, Perileucoptera coffeella, Phthorimaea opercullela, Pianotortrix octo, Piatynota stultana, Pieris brassicae, Plodia interpunctala, Plutella xylostella, Pseudoplusia includens, Rachiplusia nu, Sciropophaga incertulas, Sesamia calamistis, Spilosoma virginica, Spodoptera exigua, S. frugiperda, S. littoralis, S. exempta, S. litura, Tecia solanivora, Thaumetopoea pityocampa, Trichoplusia ni, Wiseana cervinata, Wiseana copularis, Wiseana jocosa, Blattaria blattella, Collembola xenylla, C. folsomia, Echinostomida fasciola, Hemiptera oncopeltrus, He. bemisia, He. macrosiphum, He. rhopalosiphum, He. myzus, Hymenoptera diprion, Hy. apis, Hy. Macrocentrus, Hy. Meteorus, Hy. Nasonia, Hy. Solenopsis, Isopoda porcellio, Isoptera reticulitermes, Orthoptera Achta, Prostigmata tetranychus, Rhabitida acrobeloides, R. caenorhabditis, R. distolabrellus, R. panagrellus, R. pristionchus, R. pratylenchus, R. ancylostoma, R. nippostrongylus, R. panagrellus, R. haemonchus, R. meloidogyne, and Siphonaptera ctenocephalides.

The present disclosure provides methods for plant transformation, which may be used for transformation of any plant species, including, but not limited to, monocots and dicots. Crops for which a transgenic approach would be an especially useful approach include, but are not limited to: alfalfa, cotton, tomato, maize, wheat, corn, sweet corn, lucerne, soybean, sorghum, field pea, linseed, safflower, rapeseed, oil seed rape, rice, soybean, barley, sunflower, trees (including coniferous and deciduous), flowers (including those grown commercially and in greenhouses), field lupins, switchgrass, sugarcane, potatoes, tomatoes, tobacco, crucifers, peppers, sugarbeet, barley, and oilseed rape, Brassica sp., rye, millet, peanuts, sweet potato, cassaya, coffee, coconut, pineapple, citrus trees, cocoa, tea, banana, avocado, fig, guava, mango, olive, papaya, cashew, macadamia, almond, oats, vegetables, ornamentals, and conifers.

Insecticide-Resistant Pests

Resistance to insecticides occurs when there is a heritable change in the sensitivity of a pest population to insecticides; this change in sensitivity can be observed in the failure of an insecticide to achieve the desired result and/or expected degree of control when used as intended. Cross-resistance describes a pest's resistance to one insecticide that in turn confers resistance to another different insecticide—even in cases where said pest has not been confronted with the other insecticide. Information about insecticide resistance can be found on the Insecticide Resistance Action Committee (IRAC) website (https://www.irac-online.org/). Reports of insecticide resistance in insects and other pests, and the insecticides appertaining thereunto, can be found at the Arthropod Pesticide Resistance Database (APRD) (https://www.pesticideresistance.org/).

In some embodiments, an insect and/or pest may be resistant or at least partially resistant to one or more insecticides. For example, in some embodiments, an insect and/or pest may be resistant or at least partially resistant to one or more of the following insecticides: Acetylcholinesterase (AchE) inhibitors (e.g., carbamates such as alanycarb, aldicarb, bendiocarb, benfuracarb, butocarboxim, butoxycarboxim, carbaryl, carbofuran, carbosulfan, ethiofencarb, fenobucarb, formetanate, furathiocarb, isoprocarb, methiocarb, methomyl, metolcarb, oxamyl, pirimicarb, propoxur, thiodicarb, thiofanox, triazamate, trimethacarb, xmc, and xylylcarb; and organophosphates such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-s-methyl, diazinon, dichlorvos/ddvp, dicrotophos, dimethoate, dimethylvinphos, disulfoton, epn, ethion, ethoprophos, famphur, fenamiphos, fenitrothion, fenthion, fosthiazate, heptenophos, isofenphos, isoxathion, malathion, mecarbam, methamidophos, methidathion, mevinphos, monocrotophos, naled, omethoate, oxydemeton-methyl, parathion, parathion-methyl, phenthoate, phosalone, phorate, phosmet, phosphamidon, phoxim, profenofos, propetamphos, prothiofos, pyraclofos, pyridaphenthion, quinalphos, sulfotep, tebupirimfos, temephos, terbufos, tetrachlorvinphos, thiometon, triazophos, trichlorfon, vamidothion, pirimiphos-methyl, imicyafos, and isopropyl o-(methoxyaminothio-phosphoryl) salicylate); Gaba-gated chloride channel blockers (e.g., cyclodiene organochlorines such as chlordane, and endosulfan; and phenylpyrazoles (fiproles) such as ethiprole, and fipronil); Sodium channel modulators (e.g., pyrethroids and pyrethrins such as acrinathrin, allethrin, d-cis-trans allethrin, d-trans allethrin, bifenthrin, bioallethrin, bioallethrin s-cyclopentenyl, bioresmethrin, cycloprothrin, cyfluthrin, beta-cyfluthrin, cyhalothrin, lambda-cyhalothrin, gamma-cyhalothrin, cypermethrin, alpha-cypermethrin, beta-cypermethrin, theta-cypermethrin, zeta-cypermethrin, cyphenothrin [(1r)-trans-isomers], deltamethrin, empenthrin [(ez)-(1r)-isomers], esfenvalerate, etofenprox, fenpropathrin, fenvalerate, flucythrinate, flumethrin, tau-fluvalinate, kadathrin, pyrethrins (pyrethrum), halfenprox, phenothrin [(1r)-trans-isomer], prallethrin, resmethrin, silafluofen, tefluthrin, tetramethrin, tetramethrin [(1r)-isomers], tralomethrin, transfluthrin, permethrin; ddt and methoxychlor); Nicotinic acetylcholine receptor (nAchR) competitive modulators (e.g., neonicotinoids such as acetamiprid, clothianidin, dinotefuran, imidacloprid, nitenpyram, thiacloprid, thiamethoxam; nicotine; sulfoximines such as sulfoxaflor; butenolides such as flupyradifurone; and mesoionics such as triflumezopyrim); Nicotinic acetylcholine receptor (nAchR) allosteric modulators—site I (e.g., spinosyns such as spinetoram and spinosad); Glutamate-gated chloride channel (GluCl) allosteric modulators (e.g., avermectins and milbemycins such as abamectin, emamectin benzoate, lepimectin, and milbemectin); Juvenile hormone mimics (e.g., juvenile hormone analogues such as hydroprene, kinoprene, and methoprene; fenoxycarb; and pyriproxyfen); Miscellaneous non-specific (multi-site) inhibitors (e.g., alkyl halides such as methyl bromide and other alkyl halides; chloropicrin; fluorides such as cryolite and sulfuryl fluoride; borates such as borax, boric acid, disodium octaborate, sodium borate, and sodium metaborate; tartar emetic; and methyl isothiocyanate generators such as dazomet and metam); Chordotonal organ TRPV channel modulators (e.g., pyridine azomethine derivatives such as pymetrozine, pyrifluquinazon; and pyropenes such as afidopyropen); Mite growth inhibitors (e.g., clofentezine and diflovidazin, hexythiazox such as clofentezine, diflovidazin, and hexythiazox; and etoxazole); Inhibitors of mitochondrial ATP synthase (e.g., diafenthiuron; organotin miticides such as azocyclotin, cyhexatin, and fenbutatin oxide; propargite; and tetradifon); Uncouplers of oxidative phosphorylation via disruption of the proton gradient (e.g., pyrroles, dinitrophenols, and sulfluramid, e.g., chlorfenapyr, dnoc, and sulfluramid); Nicotinic acetylcholine receptor (nAchR) channel blockers (e.g., nereistoxin analogues such as bensultap, cartap hydrochloride, thiocyclam, thiosultap-sodium); Ecdysone receptor agonists (e.g., diacylhydrazines such as chromafenozide, halofenozide, methoxyfenozide, and tebufenozide); Octopamine receptor agonists (e.g., amitraz); Mitochondrial complex III electron transport inhibitors (e.g., hydramethylnon; acequinocyl; fluacrypyrim; and bifenazate); Mitochondrial complex I electron transport inhibitors (e.g., meti acaricides and insecticides such as fenazaquin, fenpyroximate, pyrimidifen, pyridaben, tebufenpyrad, and tolfenpyrad; and rotenone); Voltage-dependent sodium channel blockers (e.g., oxadiazines such as indoxacarb; and semicarbazones such as metaflumizone); Inhibitors of acetyl co-enzyme A carboxylase (e.g., tetronic and tetramic acid derivatives such as spirodiclofen, spiromesifen, spiropidion, and spirotetramat); Mitochondrial complex IV electron transport inhibitors (e.g., phosphides such as aluminum phosphide, calcium phosphide, phosphine, and zinc phosphide; and cyanides such as calcium cyanide, potassium cyanide, and sodium cyanide); Mitochondrial complex II electron transport inhibitors (e.g., beta-ketonitrile derivatives such as cyenopyrafen and cyflumetofen; and carboxanilides such as pyflubumide); Ryanodine receptor modulators (e.g., diamides such as chlorantraniliprole, cyantraniliprole, cyclaniliprole, flubendiamide, and tetraniliprole); Chordotonal organ modulators—undefined target site (e.g., flonicamid); and/or GABA-gated chloride channel allosteric modulators (e.g., meta-diamides and isoxazolines such as broflanilide, fluxametamide).

In some embodiments, an insect and/or pest may be resistant or at least partially resistant to any one or more of the insecticides described herein.

In some embodiments, the compositions, combinations, and/or methods of the present invention can be applied to the locus of an insect and/or pest that is resistant or at least partially resistant to one or more insecticides, said insect and/or pest selected from the group consisting of the following commonly known insects and/or pests: yellow fever mosquito; Corn stalk borer; Asiatic rice borer; house mosquito; southern house mosquito; western corn rootworm; sugarcane borer; cotton bollworm; corn earworm; tobacco budworm; Colorado potato beetle; Asian corn borer; European corn borer; pink bollworm; Indian meal moth; diamond-back moth; soybean looper; beet army worm, lesser army worm; fall armyworm; Egyptian cotton leafworm, army worm; or cabbage looper.

In some embodiments, the compositions, combinations, and/or methods of the present invention can be applied to the locus of an insect and/or pest that is resistant or at least partially resistant to one or more insecticides, wherein said insect and/or pest selected is a blackfly or nuisance fly (e.g., Psychoda spp. And Chironomus spp.).

In some embodiments, an insect and/or pest may be resistant or at least partially resistant to one or more insecticides can be a lepidopteran, e.g., a diamondback moth.

In some embodiments, the compositions, combinations, and/or methods of the present invention can be applied to the locus of an insect and/or pest that is resistant or at least partially resistant to one or more insecticides, said insect and/or pest selected from the group consisting of: Loopers; Omnivorous Leafroller; Hornworms; Imported Cabbageworm; Diamondback Moth; Green Cloverworm; Webworm; Saltmarsh Caterpillar; Armyworms; Cutworms; Cross-Striped Cabbageworm; Podworms; Velvetbean Caterpillar; Soybean Looper; Tomato Fruitworm; Variegated Cutworm; Melonworms; Rindworm complex; Fruittree Leafroller; Citrus Cutworm; Heliothis; Orangedog; Citrus Cutworm; Redhumped Caterpillar; Tent Caterpillars; Fall Webworm; Walnut Caterpillar; Cankerworms; Gypsy Moth; Variegated Leafroller; Redbanded Leafroller; Tufted Apple Budmoth; Oriental Fruit Moth; Filbert Leafroller; Obliquebanded Leafroller; Codling Moth; Twig Borer; Grapeleaf Skeletonizer; Grape Leafroller; Achema Sphinx Moth (Hornworm); Orange Tortrix; Tobacco Budworm; Grape Berry Moth; Spanworm; Alfalfa Caterpillar; Cotton Bollworm; Head Moth; Amorbia Moth; Omnivorous Looper; Ello Moth (Hornworm); Io Moth; Oleander Moth; Azalea Caterpillar; Hornworm; Leafrollers; Banana Skipper; Batrachedra comosae (Hodges); Thecla Moth; Artichoke Plume Moth; Thistle Butterfly; Bagworm; Spring & Fall Cankerworm; Elm Spanworm; California Oakworm; Pine Butterfly; Spruce Budworms; Saddle Prominent Caterpillar; Douglas Fir Tussock Moth; Western Tussock Moth; Blackheaded Budworm; Mimosa Webworm; Jack Pine Budworm; Saddleback Caterpillar; Greenstriped Mapleworm; or Hemlock Looper.

In some embodiments, an insect and/or pest may be resistant or at least partially resistant to one or more insecticides can be a Colorado Potato Beetle or an Elm Leaf Beetle.

In some embodiments, the compositions, combinations, and/or methods of the present invention can be applied to the locus of an insect and/or pest that is resistant or at least partially resistant to one or more insecticides, said insect and/or pest selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; or Xanthogaleruca luteola.

In some embodiments, the compositions, combinations, and/or methods of the present invention can be applied to the locus of an insect and/or pest that is resistant or at least partially resistant to one or more insecticides, wherein said insect and/or pest is an adult beetle selected from the group consisting of: Asiatic garden beetle (Maladera castanea); Gold spotted oak borer (Agrilus coxalis auroguttatus); Green June beetle (Cotinis nitida); Japanese beetle (Popillia japonica); May or June beetle (Phyllophaga sp.); Oriental beetle (Anomala orientalis); and Soap berry-borer (Agrilus prionurus).

In some embodiments, the compositions, combinations, and/or methods of the present invention can be applied to the locus of an insect and/or pest that is resistant or at least partially resistant to one or more insecticides, wherein said insect and/or pest is a larvae (annual white grub) selected from the group consisting of: Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); and Billbug (Curculionoidea).

Bt-Toxin-Resistant Pests

In some embodiments, an insect and/or pest may be resistant or at least partially resistant to one or more insecticides, for example, one or more Bt toxins. An exemplary description of Bt toxins is disclosed in Adang et al., (2014) Diversity of Bacillus thuringiensis crystal toxins and mechanism of action. In: Dhadialla, Tarlochan and Gill, Sarjeet (eds.) Insect Midgut and Insecticidal Proteins. Advances in Insect Physiology, 47. Academic Press, pp. 39-87; and PCT Application No. WO2009076475, the disclosures of which are incorporated herein by reference in their entirety.

In some embodiments, an insect and/or pest may be resistant or at least partially resistant to one or more Bt toxins as described herein.

In some embodiments, an insect and/or pest may be resistant or at least partially resistant to a Bt toxin. For example, in some embodiments, an insect and/or pest may be resistant or at least partially resistant to a Bacillus thuringiensis toxin; Bacillus thuringiensis Cry11Aa protein; Bacillus thuringiensis Cry11Ba protein; Bacillus thuringiensis Cry1Ac protein; Bacillus thuringiensis Cry1A.105 protein; Bacillus thuringiensis Cry1Aa protein; Bacillus thuringiensis Cry1Ab protein; Bacillus thuringiensis Cry1Da protein; Bacillus thuringiensis Cry1F protein; Bacillus thuringiensis Cry2A protein; Bacillus thuringiensis Cry2Ab protein; Bacillus thuringiensis Cry2Ab2 protein; Bacillus thuringiensis Cry2Ae protein; Bacillus thuringiensis Cry4Aa protein; Bacillus thuringiensis Cry4B protein; Bacillus thuringiensis Cry1Aa protein; Bacillus thuringiensis crystal CryIC protein; Bacillus thuringiensis CryIJa protein; Bacillus thuringiensis HD73 spore/crystal protein; Bacillus thuringiensis var. kurstaki HD-1 protein; Bacillus thuringiensis var. tenebrionenis protein; Bacillus thuringiensis var. aizawai protein; Bacillus thuringiensis var. aizawai ATTC SD-1372 protein; Bacillus thuringiensis var. israelensis protein; Bacillus thuringiensis var. kurstaki protein; Bacillus thuringiensis var. kurstaki (Dipel) protein; Bacillus thuringiensis var. kurstaki (Javelin) protein; Bacillus thuringiensis Vip3A protein; Cry1A.105 protein; Cry1 Ah protein; Cry1Ba protein; Cry1C protein; Cry1Ca protein; Cry1Ie protein; Cry2Aa protein; Cry3Bb1 protein; Cry4Ba protein; or Cry11B protein

In some embodiments, an insect and/or pest that may be resistant or at least partially resistant to a Bt toxin can be selected from the following orders: Culicidae diptera; Chrysomelidae coleoptera; Pyralidae lepidoptera; Gelechiidae lepidoptera; Pyralidae lepidoptera; Plutellidae lepidoptera; or Noctuidae lepidoptera.

In some embodiments, an insect and/or pest that may be resistant or at least partially resistant to a Bt toxin can be selected from the following species: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, a combination comprising one or more CRIPs (e.g., one or more of CRIPs: A1-A34 in Table A) and one or more IAs (e.g., one or more of IAs: B1-B479 in Table B) can be used to treat any of the foregoing insecticide-resistant insects or Bt-resistant insects.

Exemplary Combinations and Methods

In some embodiments, the present invention provides a combination comprising a Cysteine Rich Insecticidal Peptide (CRIP) and an Insecticidal Agent (IA).

In some embodiments, the present invention provides a combination comprising a Cysteine Rich Insecticidal Peptide (CRIP) and an Insecticidal Agent (IA), wherein the IA is a bacterial toxin; a fungal toxin; a lectin; an Azadirachta indica compound; a boron compound; a virus; or a combination thereof.

In some embodiments, the bacterial toxin is a Bacillus thuringiensis (Bt) toxin or a Photorhabdus toxin.

In some embodiments, the Bt toxin is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. bolivia; Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; and Bacillus thuringiensis var. konkukian toxin.

In some embodiments, the Bt toxin is one or more fermentation solids, spores, or toxins isolated from the group consisting of: Bacillus thuringiensis var. kurstaki (Btk); Bacillus thuringiensis var. tenebrionis (Btt); and Bacillus thuringiensis var. israelensis (Bti).

In some embodiments, the Bt toxin is a parasporal crystal toxin, a secreted protein, a β-exotoxin, a 41.9-kDa insecticidal toxin, a sphaericolysin, an alveolysin, or an enhancin-like protein.

In some embodiments, the parasporal crystal toxin is a δ-endotoxin.

In some embodiments, the δ-endotoxin is a Three-domain (3D) Cry family protein, a binary Bin-like family toxin, an ETX_MTX2-like family toxin, a Toxin-10 family toxin, an Aerolysin family toxin, or a cytolysin.

In some embodiments, the δ-endotoxin is a Three-domain (3D) Cry toxin, a mosquitocidal Cry toxin (Mtx), a binary-like (Bin) toxin, or a Cyt toxin.

In some embodiments, the δ-endotoxin is a Three-domain (3D) Cry toxin or a Cyt toxin.

In some embodiments, the δ-endotoxin is selected from the group consisting of: Cry1Aa1, Cry1Aa2, Cry1Aa3, Cry1Aa4, Cry1Aa5, Cry1Aa6, Cry1Aa7, Cry1Aa8, Cry1Aa9, Cry1Aa10, Cry1Aa11, Cry1Aa12, Cry1Aa13, Cry1Aa14, Cry1Aa15, Cry1Aa16, Cry1Aa17, Cry1Aa18, Cry1Aa19, Cry1Aa20, Cry1Aa21, Cry1Aa22, Cry1Aa23, Cry1Aa24, Cry1Aa25, Cry1Ab1, Cry1Ab2, Cry1Ab3, Cry1Ab4, Cry1Ab5, Cry1Ab6, Cry1Ab7, Cry1Ab8, Cry1Ab9, Cry1Ab10, Cry1Ab11, Cry1Ab12, Cry1Ab13, Cry1Ab14, Cry1Ab15, Cry1Ab16, Cry1Ab17, Cry1Ab18, Cry1Ab19, Cry1Ab20, Cry1Ab21, Cry1Ab22, Cry1Ab23, Cry1Ab24, Cry1Ab25, Cry1Ab26, Cry1Ab27, Cry1Ab28, Cry1Ab29, Cry1Ab30, Cry1Ab31, Cry1Ab32, Cry1Ab33, Cry1Ab34, Cry1Ab35, Cry1Ab36, Cry1Ab-like, Cry1Ab-like, Cry1Ab-like, Cry1Ab-like, Cry1Ac1, Cry1Ac2, Cry1Ac3, Cry1Ac4, Cry1Ac5, Cry1Ac6, Cry1Ac7, Cry1Ac8, Cry1Ac9, Cry1Ac10, Cry1Ac11, Cry1Ac12, Cry1Ac13, Cry1Ac14, Cry1Ac15, Cry1Ac16, Cry1Ac17, Cry1Ac18, Cry1Ac19, Cry1Ac20, Cry1Ac21, Cry1Ac22, Cry1Ac23, Cry1Ac24, Cry1Ac25, Cry1Ac26, Cry1Ac27, Cry1Ac28, Cry1Ac29, Cry1Ac30, Cry1Ac31, Cry1Ac32, Cry1Ac33, Cry1Ac34, Cry1Ac35, Cry1Ac36, Cry1Ac37, Cry1Ac38, Cry1Ac39, Cry1Ad1, Cry1Ad2, Cry1Ae1, Cry1Af1, Cry1Ag1, Cry1Ah1, Cry1Ah2, Cry1Ah3, Cry1Ai1, Cry1Ai2, Cry1Aj1, Cry1A-like, Cry1Ba1, Cry1Ba2, Cry1Ba3, Cry1Ba4, Cry1Ba5, Cry1Ba6, Cry1Ba7, Cry1Ba8, Cry1Bb1, Cry1Bb2, Cry1Bb3, Cry1Bc1, Cry1Bd1, Cry1Bd2, Cry1Bd3, Cry1Be1, Cry1Be2, Cry1Be3, Cry1Be4, Cry1Be5, Cry1Bf1, Cry1Bf2, Cry1Bg1, Cry1Bh1, Cry1Bi1, Cry1Bj1, Cry1Ca1, Cry1Ca2, Cry1Ca3, Cry1Ca4, Cry1Ca5, Cry1Ca6, Cry1Ca7, Cry1Ca8, Cry1Ca9, Cry1Ca10, Cry1Ca11, Cry1Ca12, Cry1Ca13, Cry1Ca14, Cry1Ca15, Cry1Cb1, Cry1Cb2, Cry1Cb3, Cry1Cb-like, Cry1Da1, Cry1Da2, Cry1Da3, Cry1Da4, Cry1Da5, Cry1db1, Cry1db2, Cry1Dc1, Cry1Dd1, Cry1Ea1, Cry1Ea2, Cry1Ea3, Cry1Ea4, Cry1Ea5, Cry1Ea6, Cry1Ea7, Cry1Ea8, Cry1Ea9, Cry1Ea10, Cry1Ea11, Cry1Ea12, Cry1Eb1, Cry1Fa1, Cry1Fa2, Cry1Fa3, Cry1Fa4, Cry1Fb1, Cry1Fb2, Cry1Fb3, Cry1Fb4, Cry1Fb5, Cry1Fb6, Cry1Fb7, Cry1Ga1, Cry1Ga2, Cry1Gb1, Cry1Gb2, Cry1Gc1, Cry1Ha1, Cry1Hb1, Cry1Hb2, Cry1Hc1, Cry1H-like, Cry1Ia1, Cry1Ia2, Cry1Ia3, Cry1Ia4, Cry1Ia5, Cry1Ia6, Cry1Ia7, Cry1Ia8, Cry1Ia9, Cry1Ia10, Cry1Ia11, Cry1Ia12, Cry1Ia13, Cry1Ia14, Cry1Ia15, Cry1Ia16, Cry1Ia17, Cry1Ia18, Cry1Ia19, Cry1Ia20, Cry1Ia21, Cry1Ia22, Cry1Ia23, Cry1Ia24, Cry1Ia25, Cry1Ia26, Cry1Ia27, Cry1Ia28, Cry1Ia29, Cry1Ia30, Cry1Ia31, Cry1Ia32, Cry1Ia33, Cry1Ia34, Cry1Ia35, Cry1Ia36, Cry1Ia37, Cry1Ia38, Cry1Ia39, Cry1Ia40, Cry1Ib1, Cry1Ib2, Cry1Ib3, Cry1Ib4, Cry1Ib5, Cry1Ib6, Cry1Ib7, Cry1Ib8, Cry1Ib9, Cry1Ib10, Cry1Ib11, Cry1Ic1, Cry1Ic2, Cry1Id1, Cry1Id2, Cry1Id3, Cry1Ie1, Cry1Ie2, Cry1Ie3, Cry1Ie4, Cry1Ie5, Cry1If1, Cry1Ig1, Cry1I-like, Cry1I-like, Cry1Ja1, Cry1Ja2, Cry1Ja3, Cry1Jb1, Cry1Jc1, Cry1Jc2, Cry1Jd1, Cry1Ka1, Cry1Ka2, Cry1La1, Cry1La2, Cry1La3, Cry1Ma1, Cry1Ma2, Cry1Na1, Cry1Na2, Cry1Na3, Cry1Nb1, Cry1-like, Cry2Aa1, Cry2Aa2, Cry2Aa3, Cry2Aa4, Cry2Aa5, Cry2Aa6, Cry2Aa7, Cry2Aa8, Cry2Aa9, Cry2Aa10, Cry2Aa11, Cry2Aa12, Cry2Aa13, Cry2Aa14, Cry2Aa15, Cry2Aa16, Cry2Aa17, Cry2Aa18, Cry2Aa19, Cry2Aa20, Cry2Aa21, Cry2Aa22, Cry2Aa23, Cry2Aa23, Cry2Aa25, Cry2Ab1, Cry2Ab2, Cry2Ab3, Cry2Ab4, Cry2Ab5, Cry2Ab6, Cry2Ab7, Cry2Ab8, Cry2Ab9, Cry2Ab10, Cry2Ab11, Cry2Ab12, Cry2Ab13, Cry2Ab14, Cry2Ab15, Cry2Ab16, Cry2Ab17, Cry2Ab18, Cry2Ab19, Cry2Ab20, Cry2Ab21, Cry2Ab22, Cry2Ab23, Cry2Ab24, Cry2Ab25, Cry2Ab26, Cry2Ab27, Cry2Ab28, Cry2Ab29, Cry2Ab30, Cry2Ab31, Cry2Ab32, Cry2Ab33, Cry2Ab34, Cry2Ab35, Cry2Ab36, Cry2Ac1, Cry2Ac2, Cry2Ac3, Cry2Ac4, Cry2Ac5, Cry2Ac6, Cry2Ac7, Cry2Ac8, Cry2Ac9, Cry2Ac10, Cry2Ac11, Cry2Ac12, Cry2Ad1, Cry2Ad2, Cry2Ad3, Cry2Ad4, Cry2Ad5, Cry2Ae1, Cry2Af1, Cry2Af2, Cry2Ag1, Cry2Ah1, Cry2Ah2, Cry2Ah3, Cry2Ah4, Cry2Ah5, Cry2Ah6, Cry2Ai1, Cry2Aj1, Cry2Ak1, Cry2A11, Cry2Ba1, Cry2Ba2, Cry3Aa1, Cry3Aa2, Cry3Aa3, Cry3Aa4, Cry3Aa5, Cry3Aa6, Cry3Aa7, Cry3Aa8, Cry3Aa9, Cry3Aa10, Cry3Aa11, Cry3Aa12, Cry3Ba1, Cry3Ba2, Cry3Ba3, Cry3Bb1, Cry3Bb2, Cry3Bb3, Cry3Ca1, Cry4Aa1, Cry4Aa2, Cry4Aa3, Cry4Aa4, Cry4A-like, Cry4Ba1, Cry4Ba2, Cry4Ba3, Cry4Ba4, Cry4Ba5, Cry4Ba-like, Cry4Ca1, Cry4Ca2, Cry4Cb1, Cry4Cb2, Cry4Cb3, Cry4Cc1, Cry5Aa1, Cry5Ab1, Cry5Ac1, Cry5Ad1, Cry5Ba1, Cry5Ba2, Cry5Ba3, Cry5Ca1, Cry5Ca2, Cry5Da1, Cry5Da2, Cry5Ea1, Cry5Ea2, Cry6Aa1, Cry6Aa2, Cry6Aa3, Cry6Ba1, Cry7Aa1, Cry7Aa2, Cry7Ab1, Cry7Ab2, Cry7Ab3, Cry7Ab4, Cry7Ab5, Cry7Ab6, Cry7Ab7, Cry7Ab8, Cry7Ab9, Cry7Ac1, Cry7Ba1, Cry7Bb1, Cry7Ca1, Cry7Cb1, Cry7Da1, Cry7Da2, Cry7Da3, Cry7Ea1, Cry7Ea2, Cry7Ea3, Cry7Fa1, Cry7Fa2, Cry7Fb1, Cry7Fb2, Cry7Fb3, Cry7Ga1, Cry7Ga2, Cry7Gb1, Cry7Gc1, Cry7Gd1, Cry7Ha1, Cry7Ia1, Cry7Ja1, Cry7Ka1, Cry7Kb1, Cry7La1, Cry8Aa1, Cry8Ab1, Cry8Ac1, Cry8Ad1, Cry8Ba1, Cry8Bb1, Cry8Bc1, Cry8Ca1, Cry8Ca2, Cry8Ca3, Cry8Ca4, Cry8Ca5, Cry8Da1, Cry8Da2, Cry8Da3, Cry8db1, Cry8Ea1, Cry8Ea2, Cry8Ea3, Cry8Ea4, Cry8Ea5, Cry8Ea6, Cry8Fa1, Cry8Fa2, Cry8Fa3, Cry8Fa4, Cry8Ga1, Cry8Ga2, Cry8Ga3, Cry8Ha1, Cry8Hb1, Cry8Ia1, Cry8Ia2, Cry8Ia3, Cry8Ia4, Cry8Ib1, Cry8Ib2, Cry8Ib3, Cry8Ja1, Cry8Ka1, Cry8Ka2, Cry8Ka3, Cry8Kb1, Cry8Kb2, Cry8Kb3, Cry8La1, Cry8Ma1, Cry8Ma2, Cry8Ma3, Cry8Na1, Cry8Pa1, Cry8Pa2, Cry8Pa3, Cry8Qa1, Cry8Qa2, Cry8Ra1, Cry8Sa1, Cry8Ta1, Cry8-like, Cry8-like, Cry9Aa1, Cry9Aa2, Cry9Aa3, Cry9Aa4, Cry9Aa5, Cry9Aa, like, Cry9Ba1, Cry9Ba2, Cry9Bb1, Cry9Ca1, Cry9Ca2, Cry9Cb1, Cry9Da1, Cry9Da2, Cry9Da3, Cry9Da4, Cry9db1, Cry9Dc1, Cry9Ea1, Cry9Ea2, Cry9Ea3, Cry9Ea4, Cry9Ea5, Cry9Ea6, Cry9Ea7, Cry9Ea8, Cry9Ea9, Cry9Ea10, Cry9Ea11, Cry9Eb1, Cry9Eb2, Cry9Eb3, Cry9Ec1, Cry9Ed1, Cry9Ee1, Cry9Ee2, Cry9Fa1, Cry9Ga1, Cry9-like, Cry10Aa1, Cry10Aa2, Cry10Aa3, Cry10Aa4, Cry10A-like, Cry11Aa1, Cry11Aa2, Cry11Aa3, Cry11Aa4, Cry11Aa5, Cry11Aa-like, Cry11Ba1, Cry11Bb1, Cry11Bb2, Cry12Aa1, Cry13Aa1, Cry13Aa2, Cry14Aa1, Cry14Ab1, Cry15Aa1, Cry16Aa1, Cry17Aa1, Cry18Aa1, Cry18Ba1, Cry18Ca1, Cry19Aa1, Cry19Ba1, Cry19Ca1, Cry20Aa1, Cry20Ba1, Cry20Ba2, Cry20-like, Cry21Aa1, Cry21Aa2, Cry21Aa3, Cry21Ba1, Cry21Ca1, Cry21Ca2, Cry21Da1, Cry21Ea1, Cry21Fa1, Cry21Ga1, Cry21Ha1, Cry22Aa1, Cry22Aa2, Cry22Aa3, Cry22Ab1, Cry22Ab2, Cry22Ba1, Cry22Bb1, Cry23Aa1, Cry24Aa1, Cry24Ba1, Cry24Ca1, Cry24Da1, Cry25Aa1, Cry26Aa1, Cry27Aa1, Cry28Aa1, Cry28Aa2, Cry29Aa1, Cry29Ba1, Cry30Aa1, Cry30Ba1, Cry30Ca1, Cry30Ca2, Cry30Da1, Cry30db1, Cry30Ea1, Cry30Ea2, Cry30Ea3, Cry30Ea4, Cry30Fa1, Cry30Ga1, Cry30Ga2, Cry31Aa1, Cry31Aa2, Cry31Aa3, Cry31Aa4, Cry31Aa5, Cry31Aa6, Cry31Ab1, Cry31Ab2, Cry31Ac1, Cry31Ac2, Cry31Ad1, Cry31Ad2, Cry32Aa1, Cry32Aa2, Cry32Ab1, Cry32Ba1, Cry32Ca1, Cry32Cb1, Cry32Da1, Cry32Ea1, Cry32Ea2, Cry32Eb1, Cry32Fa1, Cry32Ga1, Cry32Ha1, Cry32Hb1, Cry32Ia1, Cry32Ja1, Cry32Ka1, Cry32La1, Cry32Ma1, Cry32Mb1, Cry32Na1, Cry32Oa1, Cry32Pa1, Cry32Qa1, Cry32Ra1, Cry32Sa1, Cry32Ta1, Cry32Ua1, Cry32Va1, Cry32Wa1, Cry32Wa2, Cry32Xa1, Cry32Ya1, Cry33Aa1, Cry34Aa1, Cry34Aa2, Cry34Aa3, Cry34Aa4, Cry34Ab1, Cry34Ac1, Cry34Ac2, Cry34Ac3, Cry34Ba1, Cry34Ba2, Cry34Ba3, Cry35Aa1, Cry35Aa2, Cry35Aa3, Cry35Aa4, Cry35Ab1, Cry35Ab2, Cry35Ab3, Cry35Ac1, Cry35Ba1, Cry35Ba2, Cry35Ba3, Cry36Aa1, Cry37Aa1, Cry38Aa1, Cry39Aa1, Cry40Aa1, Cry40Ba1, Cry40Ca1, Cry40Da1, Cry41Aa1, Cry41Ab1, Cry41Ba1, Cry41Ba2, Cry41Ca1, Cry42Aa1, Cry43Aa1, Cry43Aa2, Cry43Ba1, Cry43Ca1, Cry43Cb1, Cry43Cc1, Cry43-like, Cry44Aa1, Cry45Aa1, Cry45Ba1, Cry46Aa1, Cry46Aa2, Cry46Ab1, Cry47Aa1, Cry48Aa1, Cry48Aa2, Cry48Aa3, Cry48Ab1, Cry48Ab2, Cry49Aa1, Cry49Aa2, Cry49Aa3, Cry49Aa4, Cry49Ab1, Cry50Aa1, Cry50Ba1, Cry50Ba2, Cry51Aa1, Cry51Aa2, Cry52Aa1, Cry52Ba1, Cry52Ca1, Cry53Aa1, Cry53Ab1, Cry54Aa1, Cry54Aa2, Cry54Ab1, Cry54Ba1, Cry54Ba2, Cry55Aa1, Cry55Aa2, Cry55Aa3, Cry56Aa1, Cry56Aa2, Cry56Aa3, Cry56Aa4, Cry57Aa1, Cry57Ab1, Cry58Aa1, Cry59Ba1, Cry59Aa1, Cry60Aa1, Cry60Aa2, Cry60Aa3, Cry60Ba1, Cry60Ba2, Cry60Ba3, Cry61Aa1, Cry61Aa2, Cry61Aa3, Cry62Aa1, Cry63Aa1, Cry64Aa1, Cry64Ba1, Cry64Ca1, Cry65Aa1, Cry65Aa2, Cry66Aa1, Cry66Aa2, Cry67Aa1, Cry67Aa2, Cry68Aa1, Cry69Aa1, Cry69Aa2, Cry69Ab1, Cry70Aa1, Cry70Ba1, Cry70Bb1, Cry71Aa1, Cry72Aa1, Cry72Aa2, Cry73Aa1, Cry74Aa, Cry75Aa1, Cry75Aa2, Cry75Aa3, Cry76Aa1, Cry77Aa1, or Cry78Aa1, Cyt1Aa1, Cyt1Aa2, Cyt1Aa3, Cyt1Aa4, Cyt1Aa5, Cyt1Aa6, Cyt1Aa7, Cyt1Aa8, Cyt1Aa-like, Cyt1Ab1, Cyt1Ba1, Cyt1Ca1, Cyt1Da1, Cyt1Da2, Cyt2Aa1, Cyt2Aa2, Cyt2Aa3, Cyt2Aa4, Cyt2Ba1, Cyt2Ba2, Cyt2Ba3, Cyt2Ba4, Cyt2Ba5, Cyt2Ba6, Cyt2Ba7, Cyt2Ba8, Cyt2Ba9, Cyt2Ba10, Cyt2Ba11, Cyt2Ba12, Cyt2Ba13, Cyt2Ba14, Cyt2Ba15, Cyt2Ba16, Cyt2Ba-like, Cyt2Bb1, Cyt2Bc1, Cyt2B-like, Cyt2Ca1, and Cyt3Aa1.

In some embodiments, the Cry toxin or Cyt toxin has an amino acid sequence according to SEQ ID NOs: 412-481.

In some embodiments, the Bt toxin is a secreted protein.

In some embodiments, the secreted protein is a vegetative insecticidal protein (Vip), a secreted insecticidal protein (Sip), a Bin-like family protein, or an ETX_MTX2-family protein.

In some embodiments, the secreted protein is a Vip.

In some embodiments, the Vip is a Vip 1 family protein, a Vip 2 family protein, a Vip 3 family protein, or a Vip 4 family protein.

In some embodiments, the Vip is selected from the group consisting of: Vip1Aa1, Vip1Aa2, Vip1Aa3, Vip1Ab1, Vip1Ac1, Vip1Ad1, Vip1Ba1, Vip1Ba2, Vip1Bb1, Vip1Bb2, Vip1Bb3, Vip1Bc1, Vip1Ca1, Vip1Ca2, Vip1Da1, Vip2Aa1, Vip2Aa2, Vip2Aa3, Vip2Ab1, Vip2Ac1, Vip2Ac2, Vip2Ad1, Vip2Ae1, Vip2Ae2, Vip2Ae3, Vip2Af1, Vip2Af2, Vip2Ag1, Vip2Ag2, Vip2Ba1, Vip2Ba2, Vip2Bb1, Vip2Bb2, Vip2Bb3, Vip2Bb4, Vip3Aa1, Vip3Aa2, Vip3Aa3, Vip3Aa4, Vip3Aa5, Vip3Aa6, Vip3Aa7, Vip3Aa8, Vip3Aa9, Vip3Aa10, Vip3Aa11, Vip3Aa12, Vip3Aa13, Vip3Aa14, Vip3Aa15, Vip3Aa16, Vip3Aa17, Vip3Aa18, Vip3Aa19.0, Vip3Aa19, Vip3Aa20, Vip3Aa21, Vip3Aa22, Vip3Aa23, Vip3Aa24, Vip3Aa25, Vip3Aa26, Vip3Aa27, Vip3Aa28, Vip3Aa29, Vip3Aa30, Vip3Aa31, Vip3Aa32, Vip3Aa33, Vip3Aa34, Vip3Aa35, Vip3Aa36, Vip3Aa37, Vip3Aa38, Vip3Aa39, Vip3Aa40, Vip3Aa41, Vip3Aa42, Vip3Aa43, Vip3Aa44, Vip3Aa45, Vip3Aa46, Vip3Aa47, Vip3Aa48, Vip3Aa49, Vip3Aa50, Vip3Aa51, Vip3Aa52, Vip3Aa53, Vip3Aa54, Vip3Aa55, Vip3Aa56, Vip3Aa57, Vip3Aa58, Vip3Aa59, Vip3Aa60, Vip3Aa61, Vip3Aa62, Vip3Aa63, Vip3Aa64, Vip3Aa65, Vip3Aa66, Vip3Ab1, Vip3Ab2, Vip3Ac1, Vip3Ad1, Vip3Ad2, Vip3Ad3, Vip3Ad4, Vip3Ad5, Vip3Ad6, Vip3Ae1, Vip3Af1, Vip3Af2, Vip3Af3, Vip3Af4, Vip3Ag1, Vip3Ag2, Vip3Ag3, Vip3Ag4, Vip3Ag5, Vip3Ag6, Vip3Ag7, Vip3Ag8, Vip3Ag9, Vip3Ag10, Vip3Ag11, Vip3Ag12, Vip3Ag13, Vip3Ag14, Vip3Ag15, Vip3Ah1, Vip3Ah2, Vip3Ai1, Vip3Aj1, Vip3Aj2, Vip3Ba1, Vip3Ba2, Vip3Bb1, Vip3Bb2, Vip3Bb3, Vip3Bc, Vip3Ca1, Vip3Ca2, Vip3Ca3, Vip3Ca4, and Vip4Aa1.

In some embodiments, the Vip protein has an amino acid sequence according to the amino acid sequence set forth in SEQ ID NOs: 482-587.

In some embodiments, the bacterial toxin is a Photorhabdus toxin.

In some embodiments, the Photorhabdus toxin is selected from the group consisting of: a Photorhabdus akhurstii toxin; a Photorhabdus asymbiotica toxin; a Photorhabdus asymbiotica subsp. asymbiotica toxin; a Photorhabdus asymbiotica subsp. asymbiotica ATCC 43949 toxin; a Photorhabdus australis toxin; a Photorhabdus australis DSM 17609 toxin; a Photorhabdus bodei toxin; a Photorhabdus caribbeanensis toxin; a Photorhabdus cinerea toxin; a Photorhabdus hainanensis toxin; a Photorhabdus heterorhabditis toxin; a Photorhabdus kayaii toxin; a Photorhabdus khanii toxin; a Photorhabdus khanii NC19 toxin; a Photorhabdus khanii subsp. guanajuatensis toxin; a Photorhabdus kleinii toxin; a Photorhabdus laumondii toxin; a Photorhabdus laumondii subsp. clarkei toxin; a Photorhabdus laumondii subsp. laumondii toxin; a Photorhabdus laumondii subsp. laumondii TTO1 toxin; a Photorhabdus luminescens toxin; a Photorhabdus luminescens BA1 toxin; a Photorhabdus luminescens NBAII H75HRPL105 toxin; a Photorhabdus luminescens NBAII HiPL101 toxin; a Photorhabdus luminescens subsp. luminescens toxin; a Photorhabdus luminescens subsp. luminescens ATCC 29999 toxin; a Photorhabdus luminescens subsp. mexicana toxin; a Photorhabdus luminescens subsp. sonorensis toxin; a Photorhabdus namnaonensis toxin; a Photorhabdus noenieputensis toxin; a Photorhabdus stackebrandtii toxin; a Photorhabdus tasmaniensis toxin; a Photorhabdus temperata toxin; a Photorhabdus temperata J3 toxin; a Photorhabdus temperata subsp. phorame toxin; a Photorhabdus temperata subsp. temperata toxin; a Photorhabdus temperata subsp. temperata M1021 toxin; a Photorhabdus temperata subsp. temperata Meg1 toxin; a Photorhabdus thracensis toxin; a unclassified Photorhabdus toxin; a Photorhabdus sp. toxin; a Photorhabdus sp. 3014 toxin; a Photorhabdus sp. 3240 toxin; a Photorhabdus sp. Az29 toxin; a Photorhabdus sp. BS21 toxin; a Photorhabdus sp. CbKj163 toxin; a Photorhabdus sp. CRCIA-P01 toxin; a Photorhabdus sp. ENY toxin; a Photorhabdus sp. FL2122 toxin; a Photorhabdus sp. FL480 toxin; a Photorhabdus sp. FsIw96 toxin; a Photorhabdus sp. GDd233 toxin; a Photorhabdus sp. H3086 toxin; a Photorhabdus sp. H3107 toxin; a Photorhabdus sp. H3240 toxin; a Photorhabdus sp. HB301 toxin; a Photorhabdus sp. HB78 toxin; a Photorhabdus sp. HB89 toxin; a Photorhabdus sp. HIT toxin; a Photorhabdus sp. HO1 toxin; a Photorhabdus sp. HUG-39 toxin; a Photorhabdus sp. IT toxin; a Photorhabdus sp. JUN toxin; a Photorhabdus sp. KcTs129 toxin; a Photorhabdus sp. KJ13.1 TH toxin; a Photorhabdus sp. KJ14.3 TH toxin; a Photorhabdus sp. KJ24.5 TH toxin; a Photorhabdus sp. KJ29.1 TH toxin; a Photorhabdus sp. KJ37.1 TH toxin; a Photorhabdus sp. KJ7.1 TH toxin; a Photorhabdus sp. KJ8.2 TH toxin; a Photorhabdus sp.

KJ9.1 TH toxin; a Photorhabdus sp. KJ9.2 TH toxin; a Photorhabdus sp. KK1.3 TH toxin; a Photorhabdus sp. KK1.4 TH toxin; a Photorhabdus sp. KMD74 toxin; a Photorhabdus sp. KOH toxin; a Photorhabdus sp. MID10 toxin; a Photorhabdus sp. MOL toxin; a Photorhabdus sp. MSW 058 toxin; a Photorhabdus sp. MSW 079 toxin; a Photorhabdus sp. NK2.1 TH toxin; a Photorhabdus sp. NK2.5 TH toxin; a Photorhabdus sp. NnMt2h toxin; a Photorhabdus sp. NP1 toxin; a Photorhabdus sp. OH10 toxin; a Photorhabdus sp. OnIr40 toxin; a Photorhabdus sp. OnKn2 toxin; a Photorhabdus sp. PB10.1 TH toxin; a Photorhabdus sp. PB16.3 TH toxin; a Photorhabdus sp. PB17.1 TH toxin; a Photorhabdus sp. PB17.3 TH toxin; a Photorhabdus sp. PB2.5 TH toxin; a Photorhabdus sp. PB22.4 TH toxin; a Photorhabdus sp. PB22.5 TH toxin; a Photorhabdus sp. PB32.1 TH toxin; a Photorhabdus sp. PB33.1 TH toxin; a Photorhabdus sp. PB33.4 TH toxin; a Photorhabdus sp. PB37.4 TH toxin; a Photorhabdus sp. PB39.2 TH toxin; a Photorhabdus sp. PB4.5 TH toxin; a Photorhabdus sp. PB41.4 TH toxin; a Photorhabdus sp. PB45.5 TH toxin; a Photorhabdus sp. PB47.1 TH toxin; a Photorhabdus sp. PB47.3 TH toxin; a Photorhabdus sp. PB5.1 TH toxin; a Photorhabdus sp. PB5.4 TH toxin; a Photorhabdus sp. PB50.4 TH toxin; a Photorhabdus sp. PB51.4 TH toxin; a Photorhabdus sp. PB52.2 TH toxin; a Photorhabdus sp. PB54.4 TH toxin; a Photorhabdus sp. PB58.2 TH toxin; a Photorhabdus sp. PB58.4 TH toxin; a Photorhabdus sp. PB58.5 TH toxin; a Photorhabdus sp. PB59.2 TH toxin; a Photorhabdus sp. PB6.5 TH toxin; a Photorhabdus sp. PB67.2 TH toxin; a Photorhabdus sp. PB67.4 TH toxin; a Photorhabdus sp. PB68.1 TH toxin; a Photorhabdus sp. PB7.5 TH toxin; a Photorhabdus sp. PB76.1 TH toxin; a Photorhabdus sp. PB76.4 TH toxin; a Photorhabdus sp. PB76.5 TH toxin; a Photorhabdus sp. PB78.2 TH toxin; a Photorhabdus sp. PB80.3 TH toxin; a Photorhabdus sp. PB80.4 TH toxin; a Photorhabdus sp. Pjun toxin; a Photorhabdus sp. RW14-46 toxin; a Photorhabdus sp. S10-54 toxin; a Photorhabdus sp. S12-55 toxin; a Photorhabdus sp. S14-60 toxin; a Photorhabdus sp. S15-56 toxin; a Photorhabdus sp. S5P8-50 toxin; a Photorhabdus sp. S7-51 toxin; a Photorhabdus sp. S8-52 toxin; a Photorhabdus sp. S9-53 toxin; a Photorhabdus sp. SJ2 toxin; a Photorhabdus sp. SN259 toxin; a Photorhabdus sp. SP1.5 TH toxin; a Photorhabdus sp. SP16.4 TH toxin; a Photorhabdus sp. SP21.5 TH toxin; a Photorhabdus sp. SP3.4 TH toxin; a Photorhabdus sp. SP4.5 TH toxin; a Photorhabdus sp. SP7.3 TH toxin; a Photorhabdus sp. TyKb140 toxin; a Photorhabdus sp. UK76 toxin; a Photorhabdus sp. VMG toxin; a Photorhabdus sp. WA21C toxin; a Photorhabdus sp. WkSs43 toxin; a Photorhabdus sp. Wx13 toxin; a Photorhabdus sp. X₄ toxin; a Photorhabdus sp. YNb90 toxin; a and a Photorhabdus sp. ZM toxin.

In some embodiments, the Photorhabdus toxin is a Photorhabdus luminescens toxin.

In some embodiments, the fungal toxin is an Ascomycete fungal toxin.

In some embodiments, the Ascomycete fungal toxin is a Cordycipitaceae family fungal toxin.

In some embodiments, the Cordycipitaceae fungal toxin is a Akanthomyces toxin; a Ascopolyporus toxin; a Beauveria toxin; a Beejasamuha toxin; a Cordyceps toxin; a Coremiopsis toxin; a Engyodontium toxin; a Gibellula toxin; a Hyperdermium toxin; a Insecticola toxin; a Isaria toxin; a Lecanicillium toxin; a Microhilum toxin; a Phytocordyceps toxin; a Pseudogibellula toxin; a Rotiferophthora toxin; a Simplicillium toxin; or a Torrubiella toxin.

In some embodiments, the Cordycipitaceae fungal toxin is a Beauveria toxin.

In some embodiments, the Beauveria toxin is a Beauveria alba toxin; a Beauveria amorpha toxin; a Beauveria arenaria toxin; a Beauveria asiatica toxin; a Beauveria australis toxin; a Beauveria bassiana toxin; a Cordyceps bassiana toxin; a Beauveria brongniartii toxin; a Beauveria brumptii toxin; a Beauveria caledonica toxin; a Beauveria chiromensis toxin; a Beauveria coccorum toxin; a Beauveria cretacea toxin; a Beauveria cylindrospora toxin; a Beauveria delacroixii toxin; a Beauveria densa toxin; a Beauveria dependens toxin; a Beauveria doryphorae toxin; a Beauveria effusa toxin; a Beauveria epigaea toxin; a Beauveria felina toxin; a Beauveria geodes toxin; a Beauveria globulifera toxin; a Beauveria heimii toxin; a Beauveria hoplocheli toxin; a Beauveria kipukae toxin; a Beauveria taxa toxin; a Beauveria malawiensis toxin; a Beauveria medogensis toxin; a Beauveria melolonthae toxin; a Beauveria nubicola toxin; a Beauveria oryzae toxin; a Beauveria paradoxa toxin; a Beauveria paranensis toxin; a Beauveria parasitica toxin; a Beauveria petelotii toxin; a Beauveria pseudobassiana toxin; a Beauveria rileyi toxin; a Beauveria rubra toxin; a Beauveria shiotae toxin; a Beauveria sobolifera toxin; a Beauveria spicata toxin; a Beauveria stephanoderis toxin; a Beauveria sulfurescens toxin; a Beauveria sungii toxin; a Beauveria tenella toxin; a Beauveria tundrensis toxin; a Beauveria velata toxin; a Beauveria varroae toxin; a Beauveria vermiconia toxin; a Beauveria vexans toxin; a Beauveria viannai toxin; or a Beauveria virella toxin.

In some embodiments, the lectin is selected from the group consisting of: Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia simplicifolia-II (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); and Datura stramonium Lectin (DSL).

In some embodiments, the lectin is GNA.

In some embodiments, the Azadirachta indica compound is an Azadirachtin; an Azadiradione; an Azadiradionolide; a Deacetylgedunin; a Deacetylazadirachtinol; a Desfuranoazadiradione; a Epoxyazadiradione; a Gedunin; a Mahmoodin; a Neemfruitin A; a Neemfruitin B; a Nimbolide; a Nimbin; a Nimolicinol; an Ohchinin Acetate; a Salannin; a Salannol; an alpha-Nimolactone; a beta-Nimolactone; a 2′,3′-Dihydrosalannin; a 3-Deacetylsalannin; a 6-Deacetylnimbin; a 7-Acetyl-16,17-dehydro-16-hydroxyneotrichilenone; a 7-Benzoylnimbocinol; a 7-Deacetyl-7-benzoylepoxyazadiradione; a 7-Deacetyl-7-benzoylgedunin; a 7-Deacetyl-17-epinimolicinol; a 15-Hydroxyazadiradione; a 17-Epi-17-Hydroxyazadiradione; a 17-Epiazadiradione; a 20,21,22,23-Tetrahydro-23-oxoazadirone; a 22,23-Dihydronimocinol; or a 28-Deoxonimbolide.

In some embodiments, the boron compound is selected from the group consisting of: borax, boric acid, disodium octaborate, sodium borate, sodium metaborate, sodium tetraborate decahydrate, boron oxide, boron carbide, boron nitride, boron tribromide, boron trichloride, and boron trifluoride.

In some embodiments, the virus is a Baculoviridae virus.

In some embodiments, the Baculoviridae virus is a Betabaculovirus.

In some embodiments, the Betabaculovirus is a Adoxophyes orana granulovirus; a Agrotis segetum granulovirus; a Artogeia rapae granulovirus; a Pieris brassicae granulovirus; a Choristoneura fumiferana granulovirus; a Choristoneura occidentalis granulovirus; a Clostera anachoreta granulovirus; a Clostera anastomosis granulovirus A; a Clostera anastomosis granulovirus Henan; a Clostera anastomosis granulovirus B; a Cnaphalocrocis medinalis granulovirus; a Cryptophlebia leucotreta granulovirus; a Cydia pomonella granulovirus; a Cydia pomonella granulosis virus (isolate Mexican); a Diatraea saccharalis granulovirus; a Epinotia aporema granulovirus; a Erinnyis ello granulovirus; a Harrisina brillians granulovirus; a Helicoverpa armigera granulovirus; a Lacanobia oleracea granulovirus; a Mods latipes granulovirus; a Mythimna unipuncta granulovirus A; a Pseudalatia unipuncta granulovirus; a Mythimna unipuncta granulovirus B; a Mythimna unipuncta granulovirus; a Phthorimaea operculella granulovirus; a Plodia interpunctella granulovirus; a Plutella xylostella granulovirus; a Spodoptera frugiperda granulovirus; a Spodoptera litura granulovirus; a Trichoplusia ni granulovirus; a Trichoplusia ni granulovirus LBIV-12; a Xestia c-nigrum granulovirus; a unclassified Betabaculovirus; a Achaea janata granulovirus; a Adoxophyes honmai granulovirus; a Agrotis exclamationis granulovirus; a Amelia pallorana granulovirus; a Andraca bipunctata granulovirus; a Autographa gamma granulovirus; a Caloptilia theivora granulovirus; a Choristoneura murinana granulovirus; a Choristoneura viridis betabaculovirus; a Clostera anastomosis granulovirus; a Cnephasia longana granulovirus; a Estigmene acrea granulovirus; a Euxoa ochrogaster granulovirus; a Heliothis armigera granulovirus; a Hoplodrina ambigua granulovirus; a Hyphantria cunea granulovirus; a Natada nararia granulovirus; a Nephelodes emmedonia granulovirus; a Pandemis limitata granulovirus; a Peridorma morpontora granulovirus; a Pieris rapae granulovirus; a Plathypena scabra granulovirus; a Pseudaletia betabaculovirus; a Scotogramma trifolii granulovirus; a Spodoptera androgea granulovirus; a Spodoptera littoralis granulovirus; a Tecia solanivora granulovirus; or a Mocis sp. Granulovirus.

In some embodiments, the IA selected from the group consisting of: a Photorhabdus luminescens toxin; a Beauveria bassiana toxin; a Galanthus nivalis agglutinin (GNA); an Azadirachtin compound; a boric acid; and a Cydia pomonella granulovirus (CpGV).

In some embodiments, the Photorhabdus luminescens toxin comprises a Photorhabdus luminescens toxin complex (Tca).

In some embodiments, the Tca comprises a TcaA protein (SEQ ID NO: 616), a TcaB protein (SEQ ID NO: 617), a TcaC protein (SEQ ID NO: 618), and a TcaZ protein (SEQ ID NO: 619).

In some embodiments, the Beauveria bassiana toxin is a beauvericin toxin.

In some embodiments, the beauvericin toxin is a beauvericin toxin having the chemical formula C₄₅H₅₇N₃O₉; a beauvericin A toxin having the chemical formula C₄₆H₅₉N₃O₉; or a beauvericin B toxin having the chemical formula C₄₇H₆₁N₃O₉.

In some embodiments, the Beauveria bassiana toxin is a beauvericin toxin isolated from a Beauveria bassiana strain ANT-03 spore.

In some embodiments, the GNA has an amino acid sequence as set forth in SEQ ID NO: 35.

In some embodiments, the CpGV is a Cydia pomonella granulovirus isolate V22 virus.

In some embodiments, the IA is one or more fermentation solids, spores, or toxins isolated from a Bacillus thuringiensis var. israelensis (Bti).

In some embodiments, the IA is one or more fermentation solids, spores, or toxins isolated from a Bacillus thuringiensis ssp. israelensis strain BMP 144.

In some embodiments, the IA is one or more fermentation solids, spores, or toxins isolated from a Bacillus thuringiensis var. kurstaki (Btk).

In some embodiments, the IA is one or more fermentation solids, spores, or toxins isolated from a Bacillus thuringiensis ssp. kurstaki strain EVB-113-19.

In some embodiments, the IA is one or more fermentation solids, spores, or toxins isolated from a Bacillus thuringiensis var. tenebrionis (Btt).

In some embodiments, the Btt toxin is one or more fermentation solids, spores, or toxins isolated from a Bacillus thuringiensis ssp. tenebrionis strain NB-176.

In some embodiments, the CRIP is a U1-agatoxin-Ta1b peptide; a U1-agatoxin-Ta1b Variant Polypeptide (TVP); a sea anemone toxin; an Av3 Variant Polypeptide (AVP); a Phoneutria toxin; or an Atracotoxin (ACTX).

In some embodiments, the U1-agatoxin-Ta1b peptide has an amino acid sequence that is at least 90% identical to the amino acid sequence set forth in SEQ ID NO: 1.

In some embodiments, the U1-agatoxin-Ta1b peptide has an amino acid sequence according to the amino acid sequence set forth in SEQ ID NO: 1.

In some embodiments, the TVP has an amino acid sequence that is at least 90% identical to an amino acid sequence set forth in any one of SEQ ID NOs: 2-15, 49-53, 2-15, 49-53, 621-622, 624-628, 631-640, 642-651, or 653-654.

In some embodiments, the TVP has an amino acid sequence according to the amino acid sequence set forth in any one of SEQ ID NOs: 2-15, 49-53, 2-15, 49-53, 621-622, 624-628, 631-640, 642-651, or 653-654.

In some embodiments, the sea anemone toxin is an Av2 toxin, or an Av3 toxin.

In some embodiments, the Av2 toxin has an amino acid sequence that is at least 90% identical to an amino acid sequence set forth in SEQ ID NO: 588.

In some embodiments, the Av2 toxin has an amino acid sequence according to the amino acid sequence set forth in SEQ ID NO: 588.

In some embodiments, the Av3 toxin has an amino acid sequence that is at least 90% identical to an amino acid sequence set forth in SEQ ID NO: 44.

In some embodiments, the Av3 toxin has an amino acid sequence according to the amino acid sequence set forth in SEQ ID NO: 44.

In some embodiments, the AVP is an AVPa peptide, an AVPa-C1 peptide, or an AVPb peptide.

In some embodiments, the AVPa toxin has an amino acid sequence that is at least 90% identical to an amino acid sequence set forth in SEQ ID NO: 45.

In some embodiments, AVPa toxin has an amino acid sequence according to the amino acid sequence set forth in SEQ ID NO: 45.

In some embodiments, the AVPa-C1 toxin has an amino acid sequence that is at least 90% identical to an amino acid sequence set forth in SEQ ID NO: 46.

In some embodiments, the AVPa-C1 toxin has an amino acid sequence according to the amino acid sequence set forth in SEQ ID NO: 46.

In some embodiments, the AVPb toxin has an amino acid sequence that is at least 90% identical to an amino acid sequence set forth in SEQ ID NO: 47.

In some embodiments, the AVPb toxin has an amino acid sequence according to the amino acid sequence set forth in SEQ ID NO: 47.

In some embodiments, the CRIP is a ctenitoxin (CNTX).

In some embodiments, the CNTX is Γ-CNTX-Pn1a.

In some embodiments, the Γ-CNTX-Pn1a has an amino acid sequence that is at least 90% identical to an amino acid sequence set forth in SEQ ID NO: 65.

In some embodiments, the Γ-CNTX-Pn1a has an amino acid sequence according the amino acid sequence set forth in SEQ ID NO: 65.

In some embodiments, the CRIP is an ACTX.

In some embodiments, the ACTX is a U-ACTX peptide, Omega-ACTX peptides, or Kappa-ACTX peptide.

In some embodiments, the ACTX is a U-ACTX-Hv1a, a U+2-ACTX-Hv1a, a rU-ACTX-Hv1a, a rU-ACTX-Hv1b, a K-ACTX-Hv1a, a κ+2-ACTX-Hv1a, a ω-ACTX-Hv1a, or a ω+2-ACTX-Hv1a.

In some embodiments, the ACTX has an amino acid sequence that is at least 90% identical to an amino acid sequence set forth in any one of SEQ ID NOs: 60-64 and 594

In some embodiments, the ACTX has an amino acid sequence according an amino acid sequence set forth in any one of SEQ ID NOs: 60-64 and 594.

In some embodiments, the ACTX has an amino acid sequence that is at least 90% identical to an amino acid sequence set forth in SEQ ID NO: 61.

In some embodiments, the ACTX has an amino acid sequence according the amino acid sequence set forth in SEQ ID NO: 61.

In some embodiments, the CRIP is selected from the group consisting of: a U1-agatoxin-Ta1b peptide having an amino acid sequence according to the amino acid sequence set forth in SEQ ID NO: 1; a TVP having an amino acid sequence according to the amino acid sequence set forth in any one of SEQ ID NOs: 2-15, 49-53, 2-15, 49-53, 621-622, 624-628, 631-640, 642-651, or 653-654; an Av3-Variant Polypeptide (AVP) having an amino acid sequence set forth in SEQ ID NO: 47; a Γ-CNTX-Pn1a having an amino acid sequence set forth in SEQ ID NO: 65; or a U+2-ACTX-Hula having an amino acid sequence set forth in SEQ ID NO: 61.

In some embodiments, the ratio of IA to CRIP is about 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000.

In some embodiments, the IA is one or more fermentation solids, spores, or toxins isolated from a Bacillus thuringiensis var. israelensis (Bti); and the CRIP is an ACTX; and wherein the ratio of the one or more fermentation solids, spores, and toxins isolated from a Bacillus thuringiensis var. israelensis (Bti) to the ACTX is from about 1:1 to about 1:5000.

In some embodiments, the ratio of the one or more fermentation solids, spores, or toxins isolated from a Bacillus thuringiensis var. israelensis (Bti) to the ACTX is about 1:4000.

In some embodiments, the IA is one or more fermentation solids, spores, or toxins isolated from a Bacillus thuringiensis var. kurstaki (Btk); and the CRIP is an ACTX; and wherein the ratio of the one or more fermentation solids, spores, or toxins isolated from a Bacillus thuringiensis var. kurstaki (Btk) to the ACTX is from about 1:1 to about 1:10.

In some embodiments, the ratio of the one or more fermentation solids, spores, or toxins isolated from a Bacillus thuringiensis var. kurstaki (Btk) to ACTX is about 1:9.2

In some embodiments, the IA is one or more fermentation solids, spores, or toxins isolated from a Bacillus thuringiensis var. kurstaki (Btk); and the CRIP is an AVP; and wherein the ratio of the one or more fermentation solids, spores, or toxins isolated from a Bacillus thuringiensis var. kurstaki (Btk) to AVP is from about 1:1 to about 1:1.5.

In some embodiments, the ratio of the one or more fermentation solids, spores, or toxins isolated from a Bacillus thuringiensis var. kurstaki (Btk) to AVP is about 1:1.375.

In some embodiments, the IA is one or more fermentation solids, spores, or toxins isolated from a Bacillus thuringiensis var. tenebrionis (Btt); and the CRIP is an ACTX; and wherein the ratio of the one or more fermentation solids, spores, or toxins isolated from the Bacillus thuringiensis var. tenebrionis (Btt) to the ACTX is from about 1:1 to about 1:10.

In some embodiments, the ratio of the one or more fermentation solids, spores, or toxins isolated from the Bacillus thuringiensis var. tenebrionis (Btt) to the ACTX is about 1:8.75.

In some embodiments, the present invention provides a composition comprising the combination comprising: (1) one or more CRIPs, or pharmaceutically acceptable salts thereof; one or more CRIP-insecticidal proteins, or pharmaceutically acceptable salts thereof; or a combination thereof; and (2) one or more Insecticidal Agents (IA), as described herein; and further comprising an excipient.

In some embodiments, the present invention provides a combination comprising one or more fermentation solids, spores, or toxins isolated from a Bacillus thuringiensis ssp. kurstaki strain EVB-113-19, and a U1-agatoxin-Ta1b peptide having an amino acid sequence according to the amino acid sequence set forth in SEQ ID NO: 1.

In some embodiments, the present invention provides a combination comprising one or more fermentation solids, spores, or toxins isolated from a Bacillus thuringiensis ssp. kurstaki strain EVB-113-19, and a U1-agatoxin-Ta1b Variant Polypeptide (TVP) having an amino acid sequence according to the amino acid sequence set forth in SEQ ID NO: 2.

In some embodiments, the present invention provides a combination comprising one or more fermentation solids, spores, or toxins isolated from a Bacillus thuringiensis ssp. kurstaki strain EVB-113-19, and an Av3-Variant Polypeptide (AVP) having an amino acid sequence according to the amino acid sequence set forth in SEQ ID NO: 67.

In some embodiments, the present invention provides a combination comprising one or more fermentation solids, spores, or toxins isolated from a Bacillus thuringiensis ssp. kurstaki strain EVB-113-19, and a Γ-CNTX-Pn1a toxin having an amino acid sequence according to the amino acid sequence set forth in SEQ ID NO: 65.

In some embodiments, the present invention provides a combination comprising a Beauveria bassiana strain ANT-03 spore, and a U+2-ACTX-Hv1a toxin having an amino acid sequence according to the amino acid sequence set forth in SEQ ID NO: 61.

In some embodiments, the present invention provides a combination comprising one or more fermentation solids, spores, or toxins isolated from a Bacillus thuringiensis ssp. tenebrionis strain NB-176, and a U+2-ACTX-Hv1a toxin having an amino acid sequence according to the amino acid sequence set forth in SEQ ID NO: 61.

In some embodiments, the present invention provides a combination comprising one or more fermentation solids, spores, or toxins isolated from a Bacillus thuringiensis ssp. kurstaki strain EVB-113-19, and a U+2-ACTX-Hv1a toxin having an amino acid sequence according to the amino acid sequence set forth in SEQ ID NO: 61.

In some embodiments, the present invention provides a combination comprising one or more fermentation solids, spores, or toxins isolated from a Bacillus thuringiensis ssp. israelensis Strain BMP 144, and a U+2-ACTX-Hv1a toxin having an amino acid sequence according to the amino acid sequence set forth in SEQ ID NO: 61.

In some embodiments, the present invention provides a combination comprising a Photorhabdus luminescens toxin, and an ACTX; wherein the Photorhabdus luminescens toxin is a Photorhabdus luminescens toxin complex (Tca) comprising a TcaA (SEQ ID NO: 616), a TcaB (SEQ ID NO: 617), a TcaC (SEQ ID NO: 618), and a TcaZ (SEQ ID NO: 619); and wherein the ACTX peptide is a U+2-ACTX-Hv1a toxin (SEQ ID NO: 61).

In some embodiments, the present invention provides a combination comprising a Galanthus nivalis agglutinin (GNA), and an ACTX; wherein the GNA has an amino acid sequence as set forth in SEQ ID NO: 35; and wherein the ACTX peptide is a U+2-ACTX-Hv1a toxin having an amino acid sequence according to the amino acid sequence set forth in SEQ ID NO: 61.

In some embodiments, the present invention provides a combination comprising an Azadirachtin, and an ACTX; wherein the Azadirachtin is an Azadirachtin having a chemical formula: C₃₅H₄₄O₁₆; and wherein the ACTX is a U+2-ACTX-Hv1a toxin having an amino acid sequence according to the amino acid sequence set forth in SEQ ID NO: 61.

In some embodiments, the present invention provides a combination comprising a boric acid compound, and an ACTX; wherein the boric acid compound has a chemical formula of H₃BO₃; and wherein the ACTX peptide is a U+2-ACTX-Hv1a toxin having an amino acid sequence according to the amino acid sequence set forth in SEQ ID NO: 61.

In some embodiments, the present invention provides a combination comprising a Cydia pomonella granulovirus (CpGV), and an ACTX; wherein the CpGV is a Cydia pomonella granulovirus isolate V22 virus; and wherein the ACTX peptide is a U+2-ACTX-Hv1a toxin having an amino acid sequence according to the amino acid sequence set forth in SEQ ID NO: 61.

In some embodiments, the present invention provides a method of using the combination comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and (3) one or more excipients; to control insects, said method comprising, providing a combination of at least one CRIP and at least one IA, applying the combination to the locus of an insect.

In some embodiments, the insects are selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of using the combination comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and optionally (3) one or more excipients; to control Bacillus thuringiensis-toxin-resistant insects comprising, providing a combination of at least one CRIP and at least on IA; and then applying said combination to the locus of an insect.

In some embodiments, the Bacillus thuringiensis-toxin-resistant insects are selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the present invention provides a method of combating, controlling, or inhibiting a pest comprising, applying a pesticidally effective amount of the combination comprising (1) one or more CRIPs, or pharmaceutically acceptable salts thereof; one or more CRIP-insecticidal proteins, or pharmaceutically acceptable salts thereof; or a combination thereof; (2) one or more Insecticidal Agents (IA), as described herein; and optionally (3) one or more excipients; to the locus of the pest, or to a plant or animal susceptible to an attack by the pest.

In some embodiments, the pest is selected from the group consisting of: Achema Sphinx Moth (Hornworm) (Eumorpha achemon); Alfalfa Caterpillar (Colias eurytheme); Almond Moth (Caudra cautella); Amorbia Moth (Amorbia humerosana); Armyworm (Spodoptera spp., e.g. exigua, frugiperda, littoralis, Pseudaletia unipuncta); Artichoke Plume Moth (Platyptilia carduidactyla); Azalea Caterpillar (Datana major); Bagworm (Thyridopteryx); ephemeraeformis); Banana Moth (Hypercompe scribonia); Banana Skipper (Erionota thrax); Blackheaded Budworm (Acleris gloverana); California Oakworm (Phryganidia californica); Spring Cankerworm (Paleacrita merriccata); Cherry Fruitworm (Grapholita packardi); China Mark Moth (Nymphula stagnata); Citrus Cutworm (Xylomyges curialis); Codling Moth (Cydia pomonella); Cranberry Fruitworm (Acrobasis vaccinii); Cross-striped Cabbageworm (Evergestis rimosalis); Cutworm (Noctuid species, Agrotis ipsilon); Douglas Fir Tussock Moth (Orgyia pseudotsugata); Ello Moth (Hornworm) (Erinnyis ello); Elm Spanworm (Ennomos subsignaria); European Grapevine Moth (Lobesia botrana); European Skipper (Thymelicus lineola (Essex Skipper); Fall Webworm (Melissopus latiferreanus; Filbert Leafroller (Archips rosanus; Fruittree Leafroller (Archips argyrospilia; Grape Berry Moth (Paralobesia viteana; Grape Leafroller (Platynota stultana; Grapeleaf Skeletonizer (Harrisina americana (ground only); Green Cloverworm (Plathypena scabra; Greenstriped Mapleworm (Dryocampa rubicunda; Gummosos-Batrachedra; Comosae (Hodges); Gypsy Moth (Lymantria dispar); Hemlock Looper (Lambdina fiscellaria); Hornworm (Manduca spp.); Imported Cabbageworm (Pieris rapae); Io Moth (Automeris io); Jack Pine Budworm (Choristoneura pinus); Light Brown Apple Moth (Epiphyas postvittana); Melonworm (Diaphania hyalinata); Mimosa Webworm (Homadaula anisocentra); Obliquebanded Leafroller (Choristoneura rosaceana); Oleander Moth (Syntomeida epilais); Omnivorous Leafroller (Playnota stultana); Omnivorous Looper (Sabulodes aegrotata); Orangedog (Papilio cresphontes); Orange Tortrix (Argyrotaenia citrana); Oriental Fruit Moth (Grapholita molesta); Peach Twig Borer (Anarsia lineatella); Pine Butterfly (Neophasia menapia); Podworm (Heliocoverpa zea); Redbanded Leafroller (Argyrotaenia velutinana); Redhumped Caterpillar (Schizura concinna); Rindworm Complex (Various Leps.); Saddleback Caterpillar (Sibine stimulea); Saddle Prominent Caterpillar Heterocampa guttivitta); Saltmarsh Caterpillar (Estigmene acrea); Sod Webworm (Crambus spp.); Spanworm (Ennomos subsignaria); Fall Cankerworm (Alsophila pometaria); Spruce Budworm (Choristoneura fumiferana); Tent Caterpillar (Various Lasiocampidae); Thecla-Thecla Basilides (Geyr) Thecla basilides); Tobacco Hornworm (Manduca sexta); Tobacco Moth (Ephestia elutella); Tufted Apple Budmoth (Platynota idaeusalis); Twig Borer (Anarsia lineatella); Variegated Cutworm (Peridroma saucia); Variegated Leafroller (Platynota flavedana); Velvetbean Caterpillar (Anticarsia gemmatalis); Walnut Caterpillar (Datana integerrima); Webworm (Hyphantria cunea); Western Tussock Moth (Orgyia vetusta); Southern Cornstalk Borer (Diatraea crambidoides); Corn Earworm; Sweet potato weevil; Pepper weevil; Citrus root weevil; Strawberry root weevil; Pecan weevil; Filbert weevil; Ricewater weevil; Alfalfa weevil; Clover weevil; Tea shot-hole borer; Root weevil; Sugarcane beetle; Coffee berry borer; Annual blue grass weevil (Listronotus maculicollis); Asiatic garden beetle (Maladera castanea); European chafer (Rhizotroqus majalis); Green June beetle (Cotinis nitida); Japanese beetle (Popillia japonica); May or June beetle (Phyllophaga sp.); Northern masked chafer (Cyclocephala borealis); Oriental beetle (Anomala orientalis); Southern masked chafer (Cyclocephala lurida); Billbug (Curculionoidea); Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

In some embodiments, the pest is selected from the group consisting of: Aedes aegypti; Busseola fusca; Chilo suppressalis; Culex pipiens; Culex quinquefasciatus; Diabrotica virgifera; Diatraea saccharalis; Helicoverpa armigera; Helicoverpa zea;

Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.

### EXAMPLES

The Examples in this specification are not intended to, and should not be used to, limit the invention; they are provided only to illustrate the invention.

### Example 1: Bti Toxins and U+2-ACTX-Hv1a

Combinations of Bacillus thuringiensis var. israelensis (Bti) toxins and U+2-ACTX-Hv1a were evaluated for their insecticidal activity in a liquid solution assay against third instar Aedes aegypti (mosquito) larvae. Briefly, treatments of either: (1) combinations of U+2-ACTX-Hv1a with Bti toxin; (2) Bti toxin alone; (3) U+2-ACTX-Hv1a alone; or (4) water (as an untreated control), were applied to the mosquito larvae, and mortality was then assessed.

Treatments

Treatments were compositions consisting of the following components:
(1) Bti toxins (0.2511 g/mL or 0.25 ppm). To evaluate the effect of Bti toxins, AQUABAC XT® from Becker Microbial Products, Inc. was used. AQUABAC XT® consists of the following ingredients: 6-10% (˜8%) Bacillus thuringiensis ssp. israelensis Strain BMP 144 solids, spores & insecticidal toxins, wherein said insecticidal toxins are δ-endotoxins, and equivalent to 1,200 International Toxic Units (ITU/mg) (4.84 Billion ITU/gallon or 1.2 Billion ITU/Liter); and ˜92% other/inactive ingredients. AQUABAC XT® is commercially available from Becker Microbial Products, Inc., 11146 N.W. 69th Place, Parkland, FL 33076, U.S.A.; website: https://beckermicrobialproductsinc.com/; product code: 27376; EPA Reg. No. 62637-1.
(2) U+2-ACTX-Hv1a (1 mg/mL). U+2-ACTX-Hv1a (also referred to as “Spear”) having an amino acid sequence of “GSQYCVPVDQPCSLNTQPCCDDATCTQERNENGHTVYYCRA” (SEQ ID NO: 61) was obtained according to the methods described herein.
(3) Bti toxins+U+2-ACTX-Hv1a. Bti toxins and U+2-ACTX-Hv1a were prepared as described above, and combined. The final combination composition consisted of the following components: 0.1% w/v of U+2-ACTX-Hv1a; and 0.000025% v/v Bti toxins, of the total volume of the composition, with the remainder water
(4) Control (water).

Generating U+2-ACTX-Hv1a

Briefly, to obtain U+2-ACTX-Hv1a, a recombinant K. lactis expression system was used: the expression vector, pKLAC1, and the K. lactis strain, YCT306, both available from New England Biolabs® (Ipswich, MA, USA). A codon-optimized transgene operable to encode U+2-ACTX-Hv1a, and under control of a LAC4 promoter, was cloned into pKLAC1, and, and transformed into YCT306. The resulting transformants produced pre-propeptides comprising an α-mating factor signal peptide, a Kex2 cleavage site, and mature U+2-ACTX-Hv1a. The α-Mating factor signal peptide guides the pre-propeptides to go through the endogenous secretion pathway, and subsequently the mature U+2-ACTX-Hv1a are released into the growth media. Reverse-phase HPLC was used to purify U+2-ACTX-Hv1a from the growth media via monolithic C18 columns using water with 0.1% Trifloroacetic acid, and acetonitrile as the mobile phase. An elution protocol using 20-40% acetonitrile was used for U+2-ACTX-Hv1a purification, in which U+2-ACTX-Hv1a was eluted between a range of 34-36% acetonitrile. The resulting U+2-ACTX-Hv1a peptides were then formulated into wettable granules (WG) by blending and agglomerating the U+2-ACTX-Hv1a peptides together with surfactants and using water as an agglomerating agent. Methods for producing WGs are well known in the art.

Liquid Solution Assay

Each treatment was tested nine times (N=9). Here, the amount of Bti toxin used 0.25 μg/mL or 0.25 ppm. The amount of U+2-ACTX-Hv1a used in this example was 1 mg/mL.

To test the foregoing treatments, an arena was established that consisted of a 59 mL cup containing 30 mL of water. In each cup, third instar mosquito larvae (N=10) were added. No food was provided. Next, a given treatment solution was added to cup, and the cup was sealed with a lid. The cups were then placed on a tray under fluorescent grow lights. Three replicates were provided for each treatment.

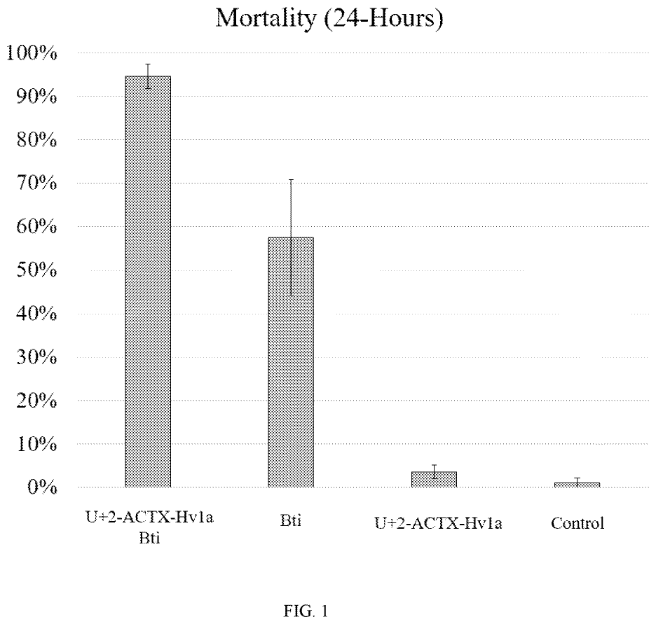

After 24 hours, the combination of U+2-ACTX-Hv1a with Bti toxin resulted in a surprising, synergistic effect corresponding to 95% mortality. Alternatively, Bti toxin alone only resulted in 57% mortality, and U+2-ACTX-Hv1a alone only resulted in 4% mortality. Accordingly, the combination of U+2-ACTX-Hv1a with Bti toxin resulted in a surprising synergistic effect that was greater than the expected additive effect of combining U+2-ACTX-Hv1a with Bti toxins. FIG. 1.

### Example 2: Btk Toxin and Γ-CNTX-Pn1a

Combinations of Bacillus thuringiensis var. kurstaki (Btk) toxins and F-CNTX-Pn1a were evaluated for their insecticidal activity in a foliar spray bioassay against Spodoptera exigua (beet armyworm). Briefly, treatments of either: (1) Γ-CNTX-Pn1a alone; (2) Btk toxin alone; (3) a combination of Γ-CNTX-Pn1a and Btk toxin; or (4) a control (0.125% Vintre, a surfactant), were sprayed on leaves, and mortality was then assessed.

Treatments

Treatments were compositions consisting of the following components:
(1) Btk toxins (0.0107% v/v). To evaluate Btk toxin, BioProtec Plus™ from AEF Global Inc. was used. BioProtec Plus™ consists of 14.49% Bacillus thuringiensis ssp. kurstaki strain EVB-113-19 fermentation solids, spores, and insecticidal toxins with a potency of 17,500 Cabbage Looper Units (CLU) per mg of product (equivalent to 76 billion CLU per gallon of product); and 85.51% other/inactive ingredients. BioProtec Plus™ consisting of 14.49% Bacillus thuringiensis ssp. kurstaki strain EVB-113-19 fermentation solids, spores, and insecticidal toxins, is commercially available from AEF Global Inc., 925 des calfats, US-QC, Levis, G6Y9E8, Canada; website: http://www.aefglobal.com/en/; CAS number: 68038-71-1; lot number: 31G18.
(2) Γ-CNTX-Pn1a (0.034% w/v, 0.152% w/v and 0.675% w/v). Γ-CNTX-Pn1a having an amino acid sequence of “GSCADINGACKSDCDCCGDSVTCDCYWSDSCKCRESNFKIGMAIRKKFC” (SEQ ID NO: 65) was obtained using ion exchange chromatography, and according to the methods described below.
(3) Btk toxins+Γ-CNTX-Pn1a. Btk toxins and Γ-CNTX-Pn1a were prepared as described above, and combined. The final combination compositions tested were as follows:
Low dose Γ-CNTX-Pn1a: 0.034% w/v Γ-CNTX-Pn1a; 0.125% v/v Vintre; 0.0107% v/v Btk toxins, of the total volume of the composition, with the remainder water.
Intermediate dose Γ-CNTX-Pn1a: 0.152% w/v Γ-CNTX-Pn1a; 0.125% v/v Vintre; 0.0107% v/v Btk toxins, of the total volume of the composition, with the remainder water.
High dose Γ-CNTX-Pn1a: 0.675% w/v Γ-CNTX-Pn1a; 0.125% v/v Vintre; 0.0107% v/v Btk toxins, of the total volume of the composition, with the remainder water.
(4) Control (0.125% Vintre®). Vintre® (used here and in the above treatments) is a surfactant that consists of 8.92% alcohol ethoxylate, and 91.08% constituents ineffective as spray adjuvants (ORO AGRI, Inc, 990 Trophy Club Dr., Trophy Club, TX 76262 USA). Vintre is commercially available from several vendors, and is a product that is well known to those having ordinary skill in the art.

Generating Γ-CNTX-Pn1a

A DNA construct of Γ-CNTX-Pn1a having an amino acid sequence of “GSCADINGACKSDCDCCGDSVTCDCYWSDSCKCRESNFKIGMAIRKKFC” (SEQ ID NO: 65) was codon optimized and synthesized as a fusion with Kluyveromyces lactis alpha mating factor pre/pro sequence (αMF) and ligated into the NotI and HindIII restriction sites of pKlac1 (New England Biolabs). The vector was digested with SacII to linearize and remove the bacterial Ori and selection marker, then electroporated into electrocompetent Kluyveromyces lactis cells. Multiple gene copy transformants were selected on selection plates containing acetamide as the sole nitrogen source. Clones expressing Γ-CNTX-Pn1a were assessed by HPLC on a Chromolith C18 column (4.6×100 mm) and eluted at a flow rate of 2 mL min-1 and gradient of 15-33% acetonitrile over 8 min.

Γ-CNTX-Pn1a was purified by cation exchange chromatography using Sephadex C-25 resin. Supernatant was bound to resin and eluted with increasing concentrations of sodium chloride. Elutions were dialyzed, lyophilized, and resuspended in water.

Foliar Spray Bioassay

The effect of combining Bacillus thuringiensis var. kurstaki (Btk) toxin with Γ-CNTX-Pn1a was tested against the Lepidopteran species, the beet armyworm (Spodoptera exigua). Mortality of the beet armyworm was assessed when confronting the insect with either (1) Γ-CNTX-Pn1a alone; (2) Btk toxin alone; (3) a combination of Γ-CNTX-Pn1a and Btk toxin; or (4) a control (0.125% Vintre, a surfactant).

To test the effect of the combinations, romaine lettuce was cut into 30 mm diameter disks, and then sterilized using a 140 ppm bleach solution; the disks were then triple rinsed. The romaine lettuce disks were then pinned to a Styrofoam board and sprayed with a given treatment; the disks were flipped, sprayed again, allowed to dry, and placed in the arena.

The arena was 32-well rearing tray containing 5 mL of 1% agar. One romaine lettuce disk was placed in each well, with a single second instar beet armyworm per leaf disk. The trays were then placed in a 28° C. Incubator. Each treatment was tested on 12 disks, with three replicates (N=36).

First, a sublethal dose (i.e., a dose resulting in approximately 20% of the population being killed, or ˜LD₂₀) of Btk toxin was determined, to allow the observation of Γ-CNTX-Pn1a when combined with Btk toxin.

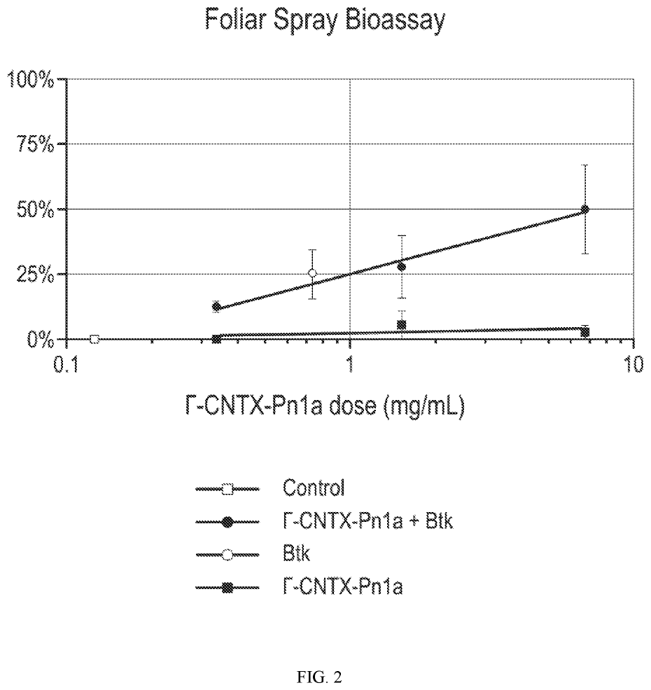

Here, the sublethal does of Btk toxin was 736 ppm (0.736 mg/mL), which resulted in the death of 25% of the population. FIG. 2. Once the sublethal dose of Btk toxin was identified, the dose of Γ-CNTX-Pn1a was increased until the LD₅₀ amount was reached for the Γ-CNTX-Pn1a+Btk toxin combination. Accordingly, the final combination compositions were as follows: (1) Low dose Γ-CNTX-Pn1a: 0.034% w/v Γ-CNTX-Pn1a; 0.125% v/v Vintre; 0.0107% v/v Btk toxins, of the total volume of the composition, with the remainder water; (2) Intermediate dose Γ-CNTX-Pn1a: 0.152% w/v Γ-CNTX-Pn1a; 0.125% v/v Vintre; 0.0107% v/v Btk toxins, of the total volume of the composition, with the remainder water; and (3) High dose Γ-CNTX-Pn1a: 0.675% w/v Γ-CNTX-Pn1a; 0.125% v/v Vintre; 0.0107% v/v Btk toxins, of the total volume of the composition, with the remainder water.

As shown in FIG. 2, the use of 1.6 mg/mL of Γ-CNTX-Pn1a resulted in 6% mortality; however, when combined with 0.736 mg/mL of Btk toxin, the mortality jumped to 28%. Likewise, 6.75 mg/mL of Γ-CNTX-Pn1a caused a mortality rate of 3%; but, when combined with 0.736 mg/mL of Btk toxin, the mortality rate was 50%. This example demonstrates that a combination of Btk toxin and Γ-CNTX-Pn1a results in an unexpected effect.

### Example 3: Btk Toxin and AVPs

Combinations of Bacillus thuringiensis ssp. kurstaki (Btk) toxins and Av3-variant polypeptide (AVPs) were evaluated for their insecticidal activity in a foliar spray bioassay against Spodoptera exigua (beet armyworm). Briefly, treatments of either: (1) AVP alone; (2) Btk toxin alone; (3) a combination of both AVP and Btk toxin; or (4) a control (0.125% Vintre, a surfactant), were sprayed on leaves, and mortality was then assessed.

Treatments

Treatments were compositions consisting of the following components:
(1) Btk toxins (800 ppm or 0.8 mg/mL). To evaluate Btk toxin, BioProtec Plus™ from AEF Global Inc. was used. BioProtec Plus™ consists of 14.49% Bacillus thuringiensis ssp. kurstaki strain EVB-113-19 fermentation solids, spores, and insecticidal toxins with a potency of 17,500 Cabbage Looper Units (CLU) per mg of product (equivalent to 76 billion CLU per gallon of product); and 85.51% other/inactive ingredients. BioProtec Plus™ consisting of 14.49% Bacillus thuringiensis ssp. kurstaki strain EVB-113-19 fermentation solids, spores, and insecticidal toxins, is commercially available from AEF Global Inc., 925 des calfats, US-QC, Levis, G6Y9E8, Canada; website: http://www.aefglobal.com/en/; CAS number: 68038-71-1; lot number: 31G18.
(2) AVP (1, 3, and 9 mg/mL). The Av3-variant polypeptide (AVP) evaluated has an amino acid sequence of “KSCCPCYWGGCPWGQNCYPEGCSGPK” (SEQ ID NO: 47) (AVPb). Methods of generating the AVP are provided in detail below.
(3) Btk toxins+AVP. Btk toxins and AVP were prepared in amounts as described above, and combined. The final combination compositions tested were as follows:
Low dose AVP: 0.1% w/v AVP; 0.125% v/v Vintre; 0.0116% v/v Btk toxins, of the total volume of the composition, with the remainder water.
Intermediate dose AVP: 0.3% w/v AVP; 0.125% v/v Vintre; 0.0116% v/v Btk toxins, of the total volume of the composition, with the remainder water.
High dose AVP: 0.9% w/v AVP; 0.125% v/v Vintre; 0.0116% v/v Btk toxins, of the total volume of the composition, with the remainder water.
(4) Control (0.125% Vintre®). Vintre® is a surfactant that consists of 8.92% alcohol ethoxylate, and 91.08% constituents ineffective as spray adjuvants (ORO AGRI, Inc, 990 Trophy Club Dr., Trophy Club, TX 76262 USA). Vintre is commercially available from several vendors, and is a product that is well known to those having ordinary skill in the art.

Generating AVP

The Av3-variant polypeptide (AVP) evaluated was obtained as follows: briefly, a WT-Av3 peptide, having an amino acid sequence “RSCCPCYWGGCPWGQNCYPEGCSGPKV” (SEQ ID NO: 44), was used as a template, and mutated to produce a peptide having an R1K substitution, and a C-terminus deletion. The resulting mutant peptide is an AVPb peptide having the amino acid sequence

(SEQ ID NO: 47)
“KSCCPCYWGGCPWGQNCYPEGCSGPK”.

AVPb was obtained by first generating an AVP peptide expression vector was generated based on the pKLAC1 yeast expression vector (available from NEW ENGLAND BIOLABS®): AVPs were expressed as a secretion peptide with acetamidase gene expression as the selection marker. The expression vector of pLB102 was linearized by the digestion with the restriction enzyme SacII; the linear pLB102 plasmid was then transformed into K. lactis cell by electroporation; 96 of resulting positive transformation colonies were cultured. Seed culture of the production strain for inoculation of the 2 L fermentation was preceded for 24 hours in the seed medium containing 3% solulys 095K+3% glucose and 50 μg/mL Kanamycin. Then 30 mL seed culture was used to inoculate 2 L fermentation tank with 1 L batch medium containing 1 L basal salt media (BMS (g/L): Solulys 095K 40, suppressor 3519 0.1 mL, 85% phosphoric acid 13 mL, CaSO₄ 0.5, K₂SO₄ 9.1, MgSO₄·7H₂O 7.5, KOH 2.1, (NH₄)₂SO₄ 5, Dextrose 10) with 1.2% Pichia Trace metals (PTM (g/L): CuSO₄·5H₂O 6, NaI 0.08, MgSO₄·H₂O 3, NaMoO₄·2H₂O 0.2, H₃BO₃ 0.02, CoCl₂·6H₂O 0.5, ZnCl₂ 20, FeSO₄·6H₂O 65, H₂SO₄ 5 mL) and 2 mL 5% suppressor 7153. Batch phase of fermentation continued for 6 hours with controlled temperature at 27° C., pH 4.80 and dissolved oxygen at 15%. After 6 hour batch fermentation, temperature was dropped to 23.5° C. and feeding of sugar alcohol started and continued for 120 hours with temperature control at 23.5 C° for the rest of fermentation process. Feed media was fed at a gradually increased rates: 3.4 mL/hr. for 24 hours, 4.4 mL/hr. for 30 hours, 7.2 mL/hr. for 24 hours, 8.8 mL/hr. for 12 hours and 11 mL/hr. until feed medium was totally consumed. Reverse-phase HPLC was used to purify AVP from the fermentation beer (i.e., spent medium) via monolithic C18 columns using water with 0.1% Trifloroacetic acid, and acetonitrile as the mobile phase. An elution protocol using 20-40% acetonitrile was used for AVP purification, in which AVP was eluted between a range of 34-36% acetonitrile.

An exemplary method of obtaining AVPs is disclosed in PCT Application No. PCT/US2019/051093, the disclosure of which is incorporated herein by reference in its entirety.

Foliar Spray Bioassay

The effect of combining Btk toxin with Av3b-Variant Polypeptides (AVPs) was tested against the Lepidopteran species, the beet armyworm (Spodoptera exigua). Mortality of the beet armyworm was assessed when confronting the insect with either (1) AVP alone; (2) Btk toxin alone; (3) a combination of both AVP and Btk toxin; or (4) a control (0.125% Vintre, a surfactant).

To test the effect of the combinations, romaine lettuce was cut into 30 mm diameter disks, and then sterilized using a 140 ppm bleach solution; the disks were then triple rinsed. The romaine lettuce disks were then pinned to a Styrofoam board and sprayed with a given treatment; the disks were flipped, sprayed again, allowed to dry, and placed in the arena.

The arena was 32-well rearing tray containing 5 mL of 1% agar. One romaine lettuce disk was placed in each well, with a single, second instar beet armyworm per leaf disk. The trays were then placed in a 28° C. Incubator. Each treatment was tested on 12 disks, with three replicates (N=36).

First, a sublethal dose (i.e., a dose resulting in approximately 20% of the population being killed, or ˜LD₂₀) of Btk toxin was determined, to allow the observation of insecticidal peptides when combined with Btk toxin, and subsequently allow the observation of synergy between the two products.

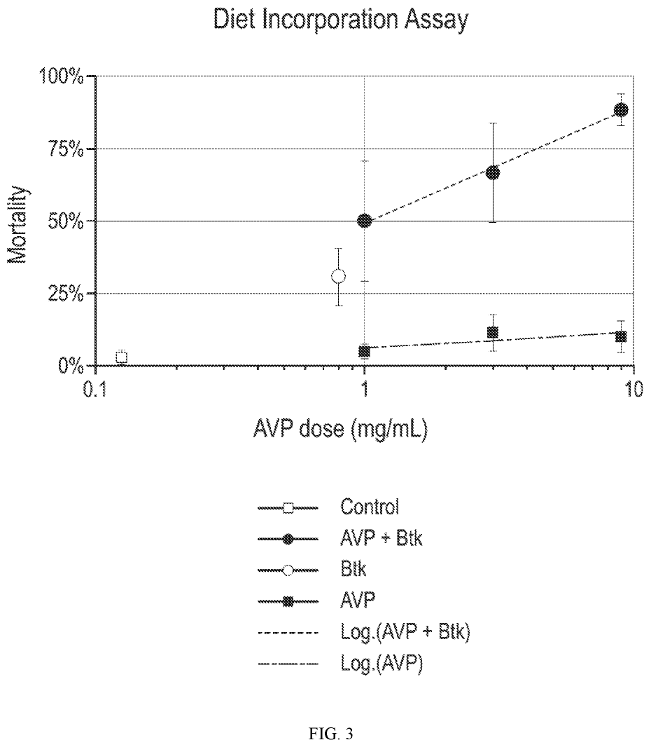

Here, the sublethal does of Btk toxin was 800 ppm (0.8 mg/mL), which resulted in the death of 31% of the population. FIG. 3. Once the sublethal dose of Btk toxin was identified for these experiments, the dose of AVP was increased until the LD₅₀ amount was reached for the AVP+Btk toxin combination. Accordingly, the final combination compositions were as follows: (1) Low dose AVP: 0.1% w/v AVP; 0.125% v/v Vintre; 0.0116% v/v Btk toxins, of the total volume of the composition, with the remainder water; (2) Intermediate dose AVP: 0.3% w/v AVP; 0.125% v/v Vintre; 0.0116% v/v Btk toxins, of the total volume of the composition, with the remainder water; and (3) High dose AVP: 0.9% w/v AVP; 0.125% v/v Vintre; 0.0116% v/v Btk toxins, of the total volume of the composition, with the remainder water.

As shown in FIG. 3, the use of 1.1 mg/mL of AVP resulted in 5% mortality; however, when combined with 0.8 mg/mL of Btk toxin, the mortality rate increased to 50%. Similarly, when using AVP alone at a dose of 3 mg/mL, the mortality rate was 11%; however, when combined with 0.8 mg/mL of Btk toxin, the mortality rate increased to 67%. Finally, using a dose of 9 mg/mL of AVP alone resulted in a 10% mortality rate, but, when combined with Btk toxin, the mortality rate was 88%. This example demonstrates that a combination of Btk toxin and AVP results in an unexpected, synergistic effect, wherein the combination results in more than the expected additive effect.

### Example 4: Btk Toxins, Ta1b, and TVPs

The effect of combinations of (1) Btk toxin with wild-type Ta1b; or (2) Btk toxin with Ta1b-Variant Polypeptides (TVPs); were each tested against the Lepidopteran species, corn earworm (Helicoverpa zea), in an injection assay, and in a foliar bioassay.

WT-Ta1b and TVP-R9Q

The CRIPs evaluated here were WT-Ta1b, and the Ta1b-variant polypeptide, TVP-R9Q. WT-Ta1b has an amino acid sequence as follows:

“EPDEICRARMTNKEFTYKSNVCNNCGDQVAACEAECFRNDVYTACHEAQKG” (SEQ ID NO: 1); TVP-R9Q has amino acid sequence as follows:

(SEQ ID NO: 2)
“EPDEICRAQMTNKEFTYKSNVCNNCGDQVAACEAECFRNDVYTACHEA
QKG”.

To obtain the TVP-R9Q peptide, a wild-type Ta1b peptide having the amino acid sequence:

“EPDEICRARMTNKEFTYKSNVCNNCGDQVAACEAECFRNDVYTACHEAQKG” (SEQ ID NO: 1) was used as a template and mutated residue position number 9, resulting in an R9Q substitution; accordingly, TVP-R9Q has an R9Q amino acid substitution relative to wild type (SEQ ID NO: 1).

To produce WT-Ta1b and TVP-R9Q, DNA constructs comprising a nucleotide sequence operable to encode WT-Ta1b or TVP-R9Q were codon optimized and synthesized as a fusion with Kluyveromyces lactis alpha mating factor pre/pro sequence (αMF) and ligated into the NotI and HindIII restriction sites of pKlac1 (NEW ENGLAND BIOLABS®). The vector was digested with SacII to linearize and remove the bacterial Ori and selection marker, then electroporated into electrocompetent Kluyveromyces lactis cells. Multiple gene copy transformants were selected on selection plates containing acetamide as the sole nitrogen source. Clones expressing WT-Ta1b or TVP-R9Q were assessed by HPLC on a Chromolith C18 column (4.6×100 mm) and eluted at a flow rate of 2 mL min-1 and gradient of 15-33% acetonitrile over 8 min.

### Example 5: Stability Assay of WT-Ta1b and TVP-R9Q

TVP-R9Q is resistant lepidopteran gut proteases. Briefly, degradation of TVP-R9Q and WT-Ta1b was performed as follows: early fifth instar Helicoverpa zea larvae were dissected to remove the intact digestive tract from other tissues and hemolymph. To obtain the Helicoverpa gut extract (HGE), a small incision was made to the intestinal lining such that gut contents could be collected in a tube. Multiple dissections were pooled and kept on ice for immediate use, or stored at −80° C. for future use.

Wild-type Ta1b (SEQ ID NO: 1) was used as a template, and mutated at amino acid substitution at position 9, (i.e., R9; SEQ ID NO: 1) to produce a substitution of the arginine at position 9 (i.e., R9) of the wild-type amino acid sequence (SEQ ID NO: 1), with the amino acid Q (TVP-R9Q). WT-Ta1b and TVP-R9Q were confronted with Helicoverpa gut extract (HGE) to simulate digestion in the lepidopteran gut environment. Here, WT-Ta1b and TVP-R9Q were incubated with 20 μL HGE; 205 μL 30 mM Tris-HCl pH 8.8 (to maintain the alkaline pH of the Helicoverpa gut environment); and 25 μL of 15.7 mg/mL of WT-Ta1b or TVP-R9Q.

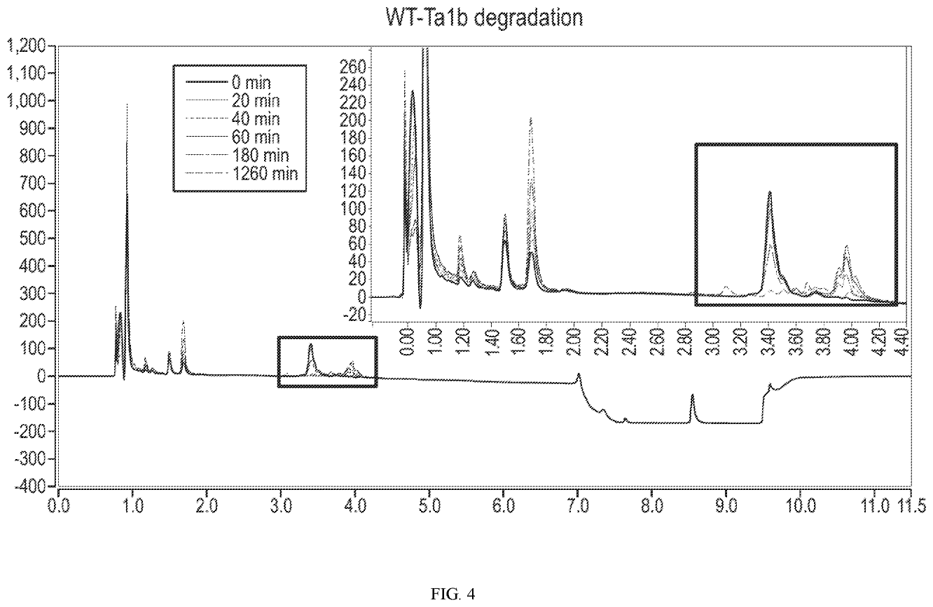

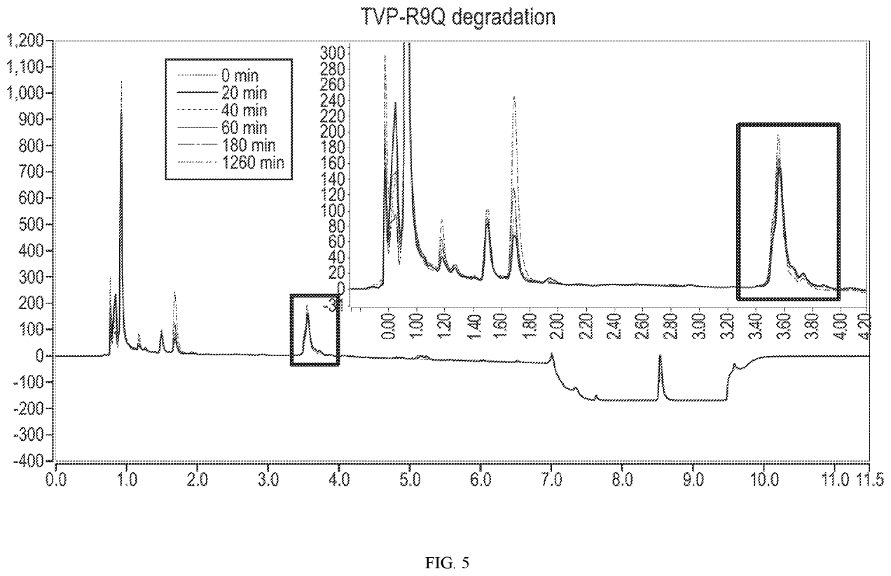

Samples of the digested Ta1b or TVP was collected at time points of 0, 20, 40, 60, 180, and 1260 minutes. To quench the digestion process, 82 μL of Tris-HCl pH 8.8, and 3 μL 25% HCl, was added to the samples, and the samples of the digested TVPs were immediately analyzed using reverse-phase HPLC to quantify the TVP peak area. As shown in FIGS. 4-5, the TVP-R9Q is stable in HGE compared to WT-Ta1b.

### Example 6: Foliar Assay of Ta1b, TVP-R9Q, and Btk Toxins

To test the effect of combinations of Btk toxins and WT-Ta1b or TVP-R9Q, romaine lettuce was cut into 30 mm diameter disks, and then sterilized using a 140 ppm bleach solution; the disks were then triple rinsed. The romaine lettuce disks were then pinned to a Styrofoam board and sprayed with a given treatment; the disks were flipped, sprayed again, allowed to dry, and placed in the arena.

The arena was 32-well rearing tray containing 5 mL of 1% agar. One romaine lettuce disk was placed in each well, with a single second instar beet armyworm per leaf disc. The trays were then placed in a 28° C. Incubator. Each treatment was tested on 12 discs, with four experimental replicates (N=48).

Treatments

Treatments were spray solution compositions consisting of the following components:
(1) WT-Ta1b, at a stock concentration: 14.51 mg/mL, was diluted to doses of 0, 1, 3, and 9 mg/mL, and combined with 0.25% v/v LoadUp surfactant, for a final formulation of either 0.0% w/v, 0.1% w/v, 0.3% w/v, or 0.9% w/v of WT-Ta1b; 0.25% v/v of LoadUp, and the remainder water.
(2) TVP-R9Q, at a stock concentration: 25.46 mg/mL, was diluted to doses of 0, 1, 3, and 9 mg/mL, and combined with 0.25% v/v LoadUp surfactant, for a final formulation of either 0.0% w/v, 0.1% w/v, 0.3% w/v, or 0.9% w/v of TVP-R9Q; 0.25% v/v of LoadUp, of the total volume of the composition, with the remainder water.
(3) 0.25% LoadUp surfactant (control). The “LoadUp” used here and in all the enumerated treatments above and below, is a surfactant consisting of the following: 56.1.0% alkyl phenol ethoxylate, propylene glycol, alkyl amine ethoxylate, and sulfuric acid; and 43.9% other constituents ineffective as spray adjuvants. LoadUp is available from J. R. Simplot Company (P.O. Box 70013, Boise, ID 83707 USA).
(4) Btk toxins (15 ppm Btk toxins, or 15 μL/mL, or 0.015 mL/mL). In this treatment, the formulation consisted of 0.0015% v/v Btk toxins, of the total volume of the composition, with the remainder water.

To evaluate Btk toxins, the commercial product Leprotec® was used. Leprotec® consists of 14.49% Bacillus thuringiensis ssp. kurstaki (Btk) strain EVB-113-19 fermentation solids, spores, and insecticidal toxins, with a potency of 17,500 Cabbage Looper Units (CLU) per mg of product (equivalent to 76 billion CLU per gallon of product); and 85.51% other/inactive ingredients. Leprotec® is available from AEF Global Inc., 925 des calfats, US-QC, Levis, G6Y9E8, Canada; website: http://www.aefglobal.com/en/; CAS number: 68038-71-1; lot number: 23J19M.).

In order to select the amount of Leprotec® to use in these experiments (i.e., 15 ppm), a sublethal dose (i.e., a dose resulting in approximately 20% of the population being killed, or ˜LD₂₀) of Leprotec® was established for multiple species. This initial test revealed the sublethal doses (˜LD₂₀) of Leprotec® for the following species: cabbage loopers=2.5 ppm; fall armyworm=383 ppm; beet armyworm=87 ppm; and corn earworm=15 ppm.

The initial work to establish the sublethal dose of Leprotec® was performed in order to allow an observation of combined effect of Leprotec® with Ta1b or TVP-R9Q, and subsequently allow the determination of whether a greater than additive effect is shown in combinations thereof.
(5) WT-Ta1b+Btk toxins. Here, WT-Ta1b and Btk toxins were combined. A stock concentration of WT-Ta1b (14.51 mg/mL), was diluted to doses of 0, 1, 3, and 9 mg/mL, and combined with 0.25% v/v LoadUp surfactant, and 15 ppm Btk toxins (Leprotec®; see above). This resulted in a final composition of either 0.0% w/v, 0.1% w/v, 0.3% w/v, or 0.9% w/v of WT-Ta1b; 0.25% v/v of LoadUp; 0.0015% v/v Btk toxins, of the total volume of the composition, with the remainder water.
(6) TVP-R9Q+Btk toxins. Here, TVP-R9Q and Btk toxins were combined. A stock concentration of TVP-R9Q (25.46 mg/mL), was diluted to doses of 0, 1, 3, and 9 mg/mL, and combined with 0.25% v/v LoadUp surfactant, and 15 ppm Btk toxins (Leprotec®; see above). This resulted in a final composition of either 0.0% w/v, 0.1% w/v, 0.3% w/v, or 0.9% w/v of WT-Ta1b; 0.25% v/v of LoadUp; 0.0015% v/v Btk toxins, of the total volume of the composition, with the remainder water.

The foregoing treatments were then sprayed on the leaf disks.

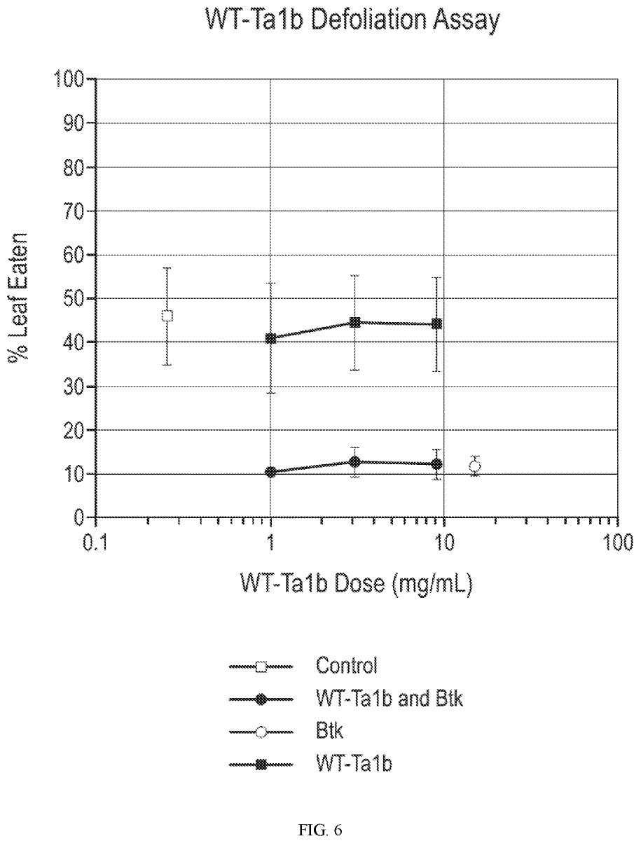

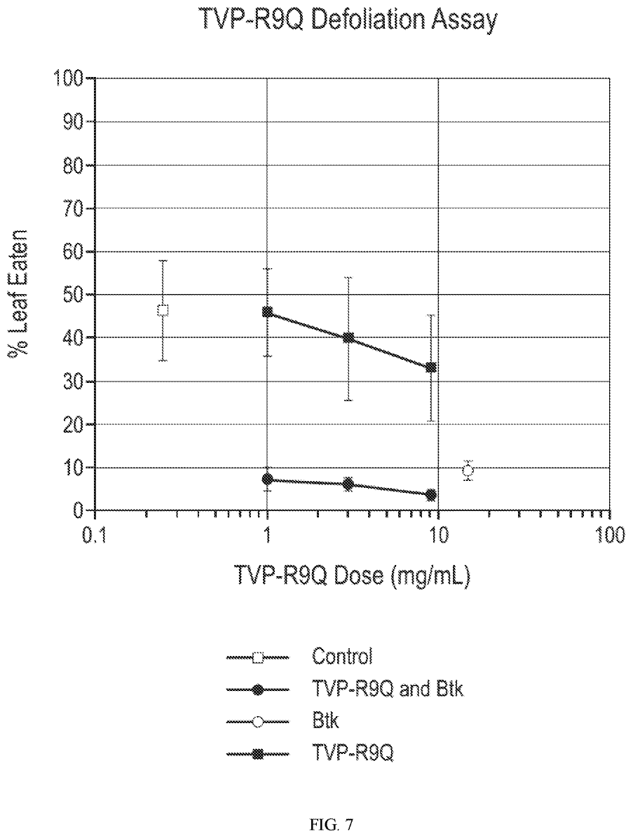

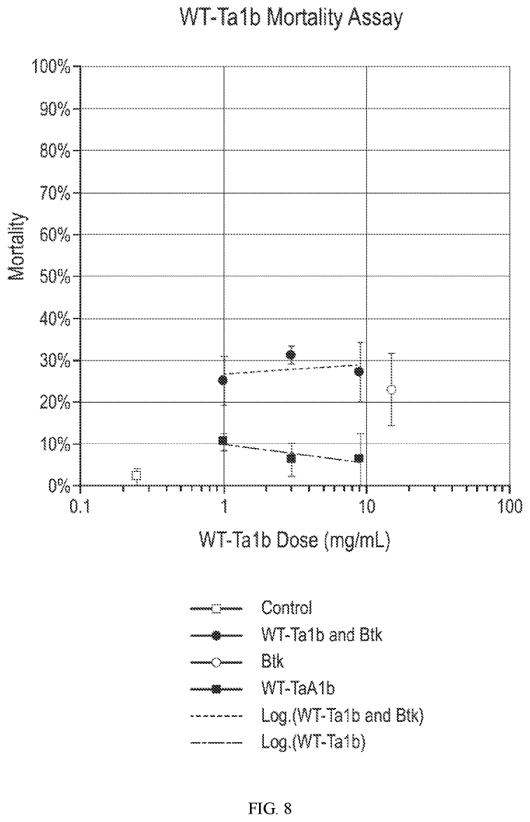

The results of foliar bioassay are shown in FIGS. 6-9. Here, when TVP-R9Q was combined with Btk toxin, it resulted in decreased defoliation and increased mortality; and, these effects on defoliation and mortality were better than TVP-R9Q alone, Ta1b alone, or Ta1b in combination with Btk toxins.

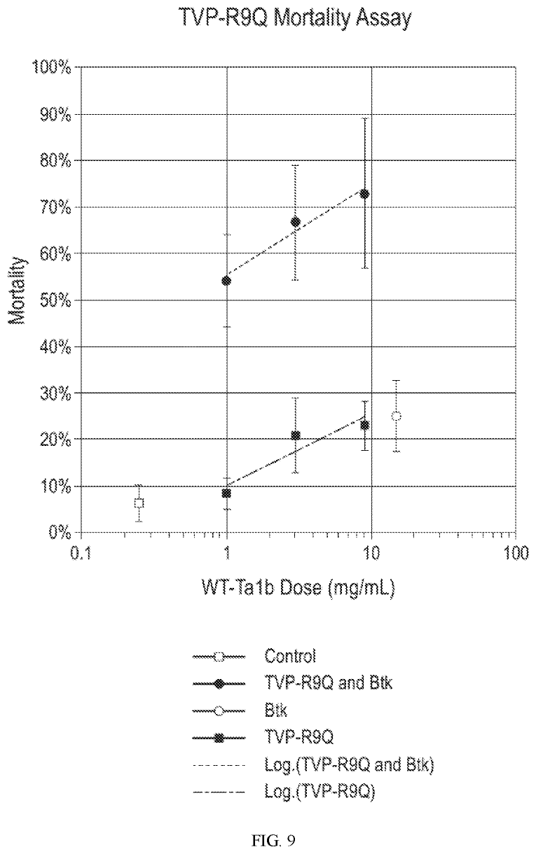

As shown in FIG. 9, the LD 50 for TVP-R9Q combined with a sublethal dose of Leprotec, in neonate corn earworm, was 2 ppt (Std. error=0.9). FIG. 9. Accordingly, the TVP-R9Q mutation causes a major increase in insecticidal activity relative to WT-Ta1b when ingested.

### Example 7: Diet Incorporation Assay: Btt Toxin and U+2-ACTX-Hv1a

Combinations of Bacillus thuringiensis var. tenebrionis (Btt) toxins and U+2-ACTX-Hv1a were evaluated for their insecticidal activity in a diet incorporation assay against Alphitobius diaperinus (darkling beetle). Briefly, treatments of either: (1) U+2-ACTX-Hv1a alone; (2) Btt toxin alone; (3) a combination of both U+2-ACTX-Hv1a and Btt toxin; or (4) an untreated control (water).

The Darkling Beetle, Alphitobius diaperinus (of the order Coleoptera: family Tenebrionidae), also known as the lesser mealworm in its larval stages, is a serious pest in poultry houses. The larvae of the beetle eat chicken food, manure, and carcasses on the floor. Additionally, larvae are a vector disease when eaten by the chickens. And, the larvae burrow into Styrofoam insulation, reducing thermal efficiency of buildings.

The effect of the dietary incorporation of a combination of Bacillus thuringiensis var. tenebrionis toxins (Btt toxin) with U+2-ACTX-Hv1a was tested against the Coleopteran species, the Darkling Beetle (Alphitobius diaperinus). Mortality of the Darkling beetle was assessed after the incorporation of one of the following treatments into the insect's diet: (1) U+2-ACTX-Hv1a alone; (2) Btt toxin alone; (3) a combination of both U+2-ACTX-Hv1a and Btt toxin; or (4) an untreated control (water). Treatments are described below.

Treatments

Treatments were compositions consisting of the following components:
(1) Btt toxins. To evaluate Btt toxin, NOVODOR® FC from VALENT® U.S.A. LLC Agricultural Products was used. NOVODOR® FC (or flowable concentrate) consists of 10% Bacillus thuringiensis ssp. tenebrionis strain NB-176 fermentation solids and solubles, with a potency of 15,000 Leptinotarsa Units (LTU) per gram of product (equivalent to 16.3 Million LTU's per quart of product); and 90% other/inactive ingredients. NOVODOR® FC consisting of Bacillus thuringiensis ssp. tenebrionis strain NB-176 fermentation solids and solubles, is commercially available from VALENT® U.S.A. LLC Agricultural Products, 1333 N California Blvd, Suite 600, US-CA, Walnut Creek, 94596-8025, U.S.A., website: https://www.valent.com/; product code number: 96017; list number: 60220; lot number: 235-222-3L-00.
(2) U+2-ACTX-Hv1a (1 mg/mL). U+2-ACTX-Hv1a (also referred to as “Spear”) having an amino acid sequence of “GSQYCVPVDQPCSLNTQPCCDDATCTQERNENGHTVYYCRA” (SEQ ID NO: 61) was obtained according to the methods described in Example 1, albeit in a liquid formulation.
(3) Btt toxins+U+2-ACTX-Hv1a. Bti toxins and U+2-ACTX-Hv1a were prepared as described above, and combined. The final combination compositions were as follows:
Low dose U+2-ACTX-Hv1a: 0.1% w/v U+2-ACTX-Hv1a; and 0.0040% v/v Btt toxins, of the total volume of the composition, with the remainder being artificial southern corn rootworm diet (Frontier Agricultural Services #F9800B).
Intermediate dose U+2-ACTX-Hv1a: 0.3% w/v U+2-ACTX-Hv1a; and 0.0040% v/v Btt toxins, of the total volume of the composition, with the remainder being artificial southern corn rootworm diet (Frontier Agricultural Services #F9800B).
High dose U+2-ACTX-Hv1a: 0.8% w/v U+2-ACTX-Hv1a; and 0.0040% v/v Btt toxins, of the total volume of the composition, with the remainder being artificial southern corn rootworm diet (Frontier Agricultural Services #F9800B).
(4) Control. Water

Diet Incorporation Assay

To test the effect of the combinations, an arena was created comprising a 128 well bioassay tray, into which two (N=2), first-instar lesser mealworms were added (i.e., 2 mealworms per well). The mealworms were then provided a meal consisting of Southern Corn Rootworm (SCR) diet (Frontier Scientific, Newark, DE 19713, product No. F9800B) mixed with one of the treatments. The meal consisted of 1 mL of agar-based SCR diet, mixed with one of the treatments. Stock meal mixtures were made by combining 15 mL of SCR diet held at 65° C. with 10 mL of 2.5× treatment solution. The wells were then secured with vented lid, and the tray was placed in incubator with the following environmental conditions: 32° C.; 50-70% relative humidity; and no lights. Four replicates for each treatment condition were completed (N=4).

Next, a sublethal dose (i.e., a dose resulting in approximately 20% of the population being killed, or ˜LD₂₀) of Btt toxin was determined, to allow the observation of insecticidal peptides when combined with Btt toxin, and subsequently allow the observation of synergy between the two products.

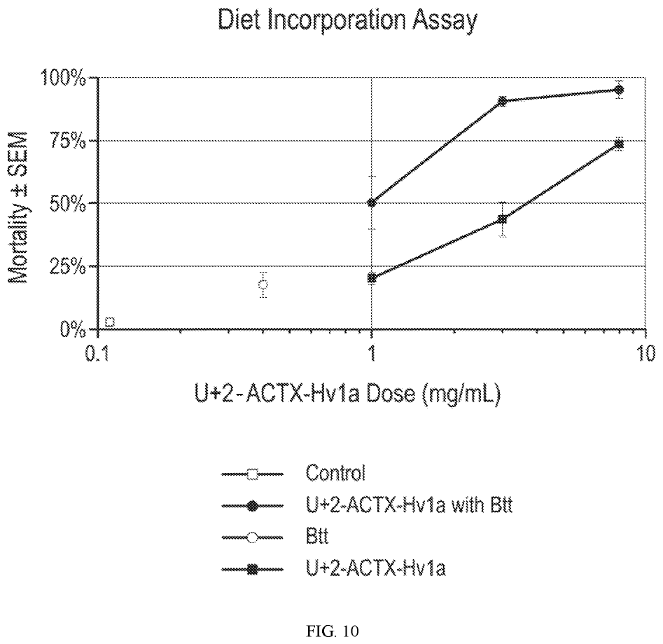

Here, the sublethal does of Btt toxin was 400 ppm (0.4 mg/mL), which resulted in the death of 18% of the population. FIG. 10. Once the sublethal dose of Btt toxin was identified for these experiments, the dose of U+2-ACTX-Hv1a was increased until the LD₅₀ amount was reached for the U+2-ACTX-Hv1a+Btt toxin combination. Accordingly, the final combination compositions were as follows: (1) Low dose U+2-ACTX-Hv1a: 0.1% w/v U+2-ACTX-Hv1a; and 0.0040% v/v Btt toxins, of the total volume of the composition, with the remainder being artificial southern corn rootworm diet (Frontier Agricultural Services #F9800B); (2) Intermediate dose U+2-ACTX-Hv1a: 0.3% w/v U+2-ACTX-Hv1a; and 0.0040% v/v Btt toxins, of the total volume of the composition, with the remainder being artificial southern corn rootworm diet (Frontier Agricultural Services #F9800B); and (3) High dose U+2-ACTX-Hv1a: 0.8% w/v U+2-ACTX-Hv1a; and 0.0040% v/v Btt toxins, of the total volume of the composition, with the remainder being artificial southern corn rootworm diet (Frontier Agricultural Services #F9800B).

As shown in FIG. 10, the use of 1 mg/mL of U+2-ACTX-Hv1a alone resulted in 20% mortality; however, when combined with 0.4 mg/mL of Btt toxin, the mortality rate increased to 50%. Likewise, when using U+2-ACTX-Hv1a alone at a dose of 3 mg/mL, the mortality rate was 44%; however, when combined with 0.4 mg/mL of Btt toxin, the mortality rate increased to 91%. Finally, using a dose of 8 mg/mL of U+2-ACTX-Hv1a alone resulted in a 74% mortality rate. However, when 8.0 mg/mL of U+2-ACTX-Hv1a was combined with 0.4 mg/mL of Btt toxin, the mortality rate increased to 95%. This example demonstrates that a combination of Btt toxin and U+2-ACTX-Hv1a results in an unexpected, synergistic effect, wherein the combination results in more than the expected additive effect.

### Example 8: Spray Assay: Btt Toxin and U+2-ACTX-Hv1a

A spray assay was performed in order to determine the effect of using a spray containing Btt toxin with U+2-ACTX-Hv1a on Colorado potato beetle (Leptinotarsa decemlineata) mortality.

Approximately 16 first-instar Colorado potato beetles were placed on filter paper (Whatman #3, 90 mm diameter), contained in an inverted petri dish (25×100 mm). Next a mini-spray bottle (Qosmedix) was used to spray the Colorado potato beetles with 2 mL of treatment solution containing the following: water; 10 ppT (0.01 mg/mL of U+2-ACTX-Hv1a; and 20 ppT (0.02 mg/mL) of Btt toxin. The petri dish was then sealed with parafilm, and stored in the incubator (28° C.; 50% relative humidity; lights on) for 4 hours. Beetles were sprayed with (1) U+2-ACTX-Hv1a alone; (2) Btt toxin alone; (3) a combination of both U+2-ACTX-Hv1a and Btt toxin; or (4) an untreated control (water). Treatments were the same as those described in Example 8, albeit formulated into a spray form.

Following the spray treatment, individual beetles were transferred to the wells of a rearing tray, where they were provided 1 mL per well of an artificial Colorado potato beetle diet (Frontier Scientific, Newark, DE 19713, product No. F9380B) with formaldehyde. Mortality rates were measured every 24 hours for the next 4 days.

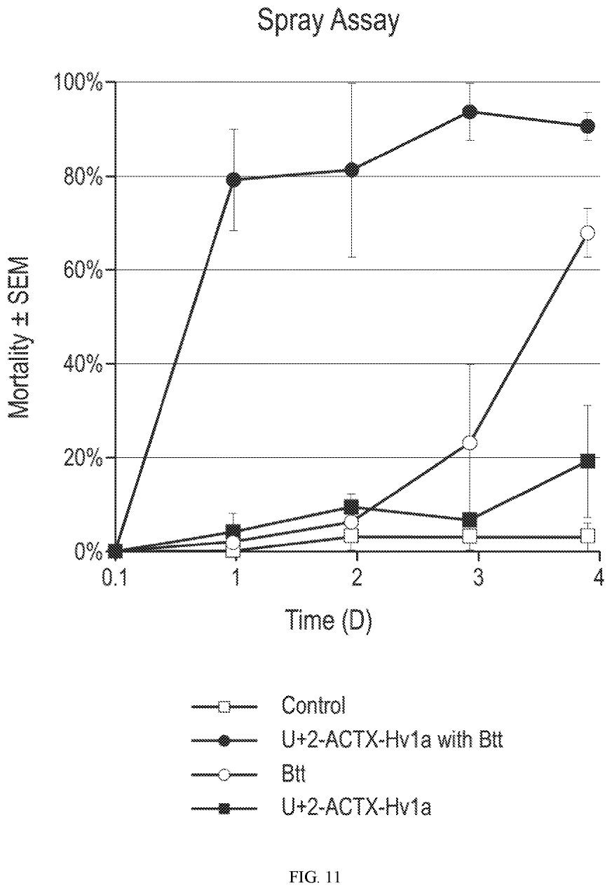

As shown in FIG. 11, after 24 hours (1 day) beetles treated with U+2-ACTX-Hv1a alone had a 4% mortality rate. Beetles treated with Btt toxin alone possessed a 2% mortality rate. In stark contrast to the mortality rates of either U+2-ACTX-Hv1a or Btt toxin alone, combining U+2-ACTX-Hv1a with Btt toxin resulted in a 79% mortality rate after 24 hours. This pattern of synergy continued at subsequent time points. At 48 hours (2 days), beetles treated with U+2-ACTX-Hv1a alone possessed a 9% mortality rate. Beetles treated with Btt toxin alone possessed a 6% mortality rate. By combining U+2-ACTX-Hv1a with Btt toxin, the mortality rate increased to 81% at 48 hours. At 72 hours (3 days), beetles treated with U+2-ACTX-Hv1a alone possessed a 7% mortality rate. Beetles treated with Btt toxin alone possessed a 23% mortality rate. By combining U+2-ACTX-Hv1a with Btt toxin, the mortality rate increased to 94% at 72 hours. Finally, at 96 hours (4 days), beetles treated with U+2-ACTX-Hv1a alone possessed a 19% mortality rate. Beetles treated with Btt toxin alone possessed a 68% mortality rate. By combining U+2-ACTX-Hv1a with Btt toxin, the mortality rate increased to 91% at 96 hours.

### Example 9: Photorhabdus luminescens Toxin Complex an U+2-ACTX-Hv1a

Photorhabdus luminescens is highly virulent insect pathogen vectored by the nematode Heterorhabditis bacteriophora. The bacterium produces and secretes large protein complexes known as toxin complexes. The protein complex is referred to as “Toxin complex a” or “Tca.” Tca is composed of four different proteins: TcaA, TcaB, TcaC, and TcaZ. Here, combinations of Photorhabdus luminescens toxins and U+2-ACTX-Hv1a were assessed for the their insecticidal activity.

Treatments
(1) Photorhabdus luminescens toxins (4.75% v/v). Toxin complex a (Tca) was obtained by sourcing P. luminescens from American Type Culture Collection (ATCC), 10801 University Blvd. Manassas, VA 20110, USA. P. luminescens cells (Product number 2999; Strain: Hb [DSM 3368, HB1, NCIB 12670]; Contributors: (Thomas and Poinar), Boemare et. al.) were cultured according to the manufacturer's recommendations. Toxin complex was purified by spinning down the cells, and concentrating the culture broth over a 30 molecular-weight cut-off (mwco) filter. The Tca complex extract used here was composed of four different proteins: TcaA (SEQ ID NO: 616), TcaB (SEQ ID NO: 617), TcaC (SEQ ID NO: 618), and TcaZ (SEQ ID NO: 619).
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) Photorhabdus luminescens toxins+U+2-ACTX-Hv1a. Photorhabdus luminescens toxins and U+2-ACTX-Hv1a were prepared/obtained as described in the treatments above, and combined. The final combination composition was as follows: 1% w/v U+2-ACTX-Hv1a; and 4.75% v/v Photorhabdus luminescens toxin complex extract, of the total volume of the composition, with the remainder being water.
(4) Control. Water.

Diet Incorporation Assay

Diet incorporation bioassays were performed on Corn earworms (Helicoverpa zea). The bioassay was performed in 128-well trays. Each well was filled with 200 μL of agar-based general lepidopteran diet infused with a given treatment (N=16, wells per treatment). One neonate corn earworm (Helicoverpa zea) was placed in each well and their survival was evaluated over four days. The foregoing treatments were applied as follows:
(a) Water;
(b) Toxin complex alone (4.75% v/v);
(c) 10 mg/mL U+2-ACTX-Hv1a (1% w/v); and
(d) Toxin complex (4.75% w/v) with 10 mg/mL U+2-ACTX-Hv1a (1% w/v).

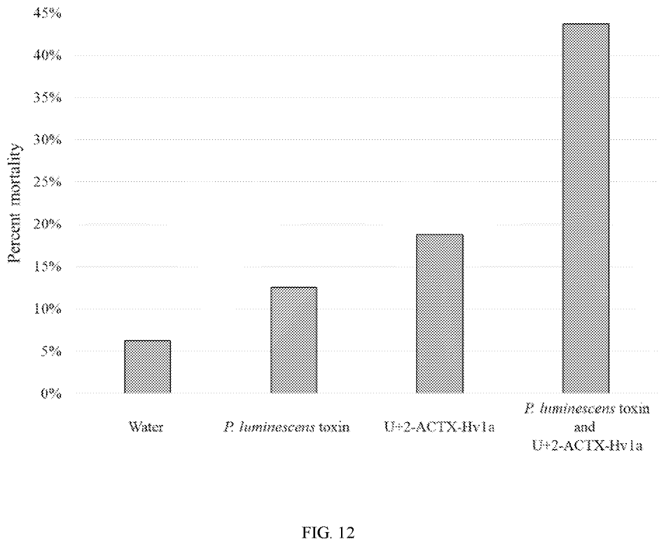

As shown in FIG. 12, after 4 days, corn earworm larvae treated with Tca alone had a mortality of 13%. Corn earworms treated with U+2-ACTX-Hv1a alone had a mortality of 19%. In stark contrast to the mortality rates of either Tca or U+2-ACTX-Hv1a alone, combining U+2-ACTX-Hv1a with Tca toxin resulted in a 44% mortality rate after 4 days.

The results here provides evidence of synergy between the Photorhabdus luminescens toxin complex and U+2-ACTX-Hv1a against Corn Earworm; i.e., the example here demonstrates that a combination of Tca and U+2-ACTX-Hv1a results in an unexpected, synergistic effect, wherein the combination results in more than the expected additive effect.

### Example 10: Snowdrop Lectin (GNA) and ACTX

Snowdrop lectin or Galanthus nivalis (GNA) is a mannose binding protein. Here, Corn earworm (CEW) (Helicoverpa zea) neonates were confronted with solutions of GNA and/or U+2-ACTX-Hv1a to assess mortality after feeding.

Treatments (1) Snowdrop lectin (GNA).

GNA having an amino acid sequence:

“MAKASLLILATIFLGVITPSCLSENILYSGETLPTGGFLSSGSFVFIIVIQEDCNLVLYNV DKPIWATNTGGLSSDCSLSMQNDGNLVVFTPSNKPIWASNTDGQNGNYVCILQKDR NVVIYGTNRWATGTYTGAVGIPESPPSEKYPSAGKIKLVTAK” and as set forth in SEQ ID NO: 35, was obtained from Vector Laboratories (3390 South Service Rd, Burlington, ON L7N 3J5, Canada), Catalog no. L-1240. Lot no. ZD1016. U+2-ACTX-Hv1a was obtained as described herein.
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) GNA+U+2-ACTX-Hv1a. GNA and U+2 were prepared/obtained as described in the treatments above, and combined. The final combination composition was as follows: 0.5% w/v U+2-ACTX-Hv1a; and 0.25% w/v GNA, of the total volume of the composition, with the remainder being water.
(4) Control. Water.

Diet Incorporation Assay

A diet incorporation assay was performed as follows: first droplet bioassay arenas were constructed by creating 32 well assay trays containing parafilm on top of agar. Next, 3 μL droplets (3×) were placed on parafilm with 5 CEW neonates. Droplets were replenished daily. This was replicated 4 times per treatment.

The foregoing treatments were applied as follows:
(a) 2.5 mg/mL GNA (0.25% w/v); 5 mg/mL U+2-ACTX-Hv1a (0.5% w/v);
(b) 0 mg/mL GNA (0% w/v); 5 mg/mL U+2-ACTX-Hv1a (0.5% w/v);
(c) 2.5 mg/mL GNA (0.25% w/v); 0 mg/mL U+2-ACTX-Hv1a (0% w/v); and
(d) 0 mg/mL GNA (0% w/v); with 0 mg/mL U+2-ACTX-Hv1a (0% w/v) (control).

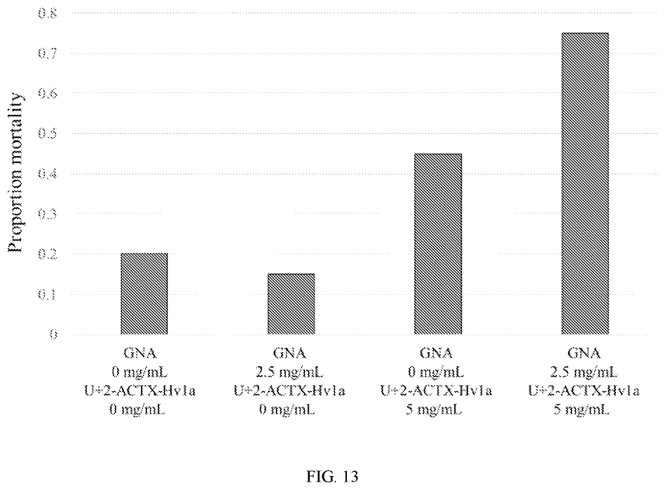

Larvae mortality was assessed daily for 3 days. The mortality rate on day three of the bioassay is presented in FIG. 13.

As shown in FIG. 13, the control had a baseline mortality rate of 20%. U+2-ACTX-Hv1a alone, at a dose 5 mg/mL, resulted in 45% mortality. GNA alone had a mortality rate of 15%. When the baseline mortality rate is subtracted, the mortality rate of U+2-ACTX-Hv1a alone changes to −25%, whereas the mortality rate of GNA falls to around zero. However, the combination of U+2-ACTX-Hv1a (5 mg/mL) and GNA (2.5 mg/mL) together had a synergistic effect, resulting in 75% mortality; and, when normalized to account for the baseline mortality rate, the mortality rate for the combination of U+2-ACTX-Hv1a (5 mg/mL) and GNA (2.5 mg/mL) comes to −55%—or roughly double the amount of U+2-ACTX-Hv1a alone.

### Example 11: Chitinase and U+2-ACTX-Hv1a

To evaluate the chitinases, Fall Armyworms (Spodoptera frugiperda) were confronted with doses of U+2-ACTX-Hv1a and/or chitinase to test their effects alone and in combination.

Treatments
(1) Chitinase. To evaluate chitinases, a chitinase from Trichoderma viride was used. A chitinase having an amino acid sequence as set forth in SEQ ID NO: 620 was obtained from Sigma Aldrich (3050 Spruce Street, St Louis, MO 63103 U.S.A) (Product No. C8241-25UN; Lot no. 128M4015V).
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) Chitinase+U+2-ACTX-Hv1a. Chitinase and U+2-ACTX-Hv1a were prepared/obtained as described in the treatments above, and combined. The final combination composition was as follows: 0.5% w/v U+2-ACTX-Hv1a; 0.01% w/v chitinase, of the total volume of the composition, with the remainder being water.
(4) Control. Water.

Diet Incorporation Assay

Three droplets (3 μL each) containing the following ingredient concentrations were presented to five neonate Fall armyworm (Spodoptera frugiperda) larvae in trays of 32-well trays:
(a) Chitinase 0 μL/L (0% w/v); U+2-ACTX-Hv1a 0 mg/mL (0% w/v); Sucrose (10% w/v);
(b) Chitinase 100 μL/L (0.01% w/v); U+2-ACTX-Hv1a 0 mg/mL (0% w/v); Sucrose (10% w/v);
(c) Chitinase 0 μL/L (0% w/v); U+2-ACTX-Hv1a 5 mg/mL (0.5% w/v); Sucrose (10% w/v); and
(d) Chitinase 100 μL/L (0.01% w/v); U+2-ACTX-Hv1a 5 mg/mL (0.5% w/v); Sucrose (10% w/v).

Mortality was then assessed after three days.

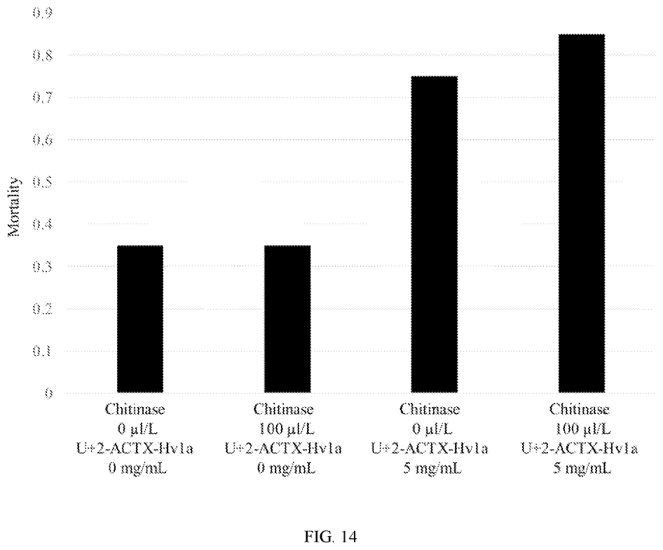

As shown in FIG. 14, the untreated control had a mortality of 35%. This may have been a result of the use of fragile neonates, and/or reflective of the typical stresses and/or food or nutrient deprivation common in diet incorporation studies using insects. Here, chitinase alone had no effect relative to the control treatment (i.e., mortality rate of 35%). Accordingly, the effect of chitinase alone could not be said to have caused an increase in mortality over the control. On the other hand, U+2-ACTX-Hv1a exhibited a 75% mortality rate on the insects. And, a greater than additive effect on mortality was observed (i.e., 85%) in the combination treatment of chitinase and U+2-ACTX-Hv1a.

Therefore, the example here demonstrates that a combination of chitinase and U+2-ACTX-Hv1a results in an unexpected, synergistic effect, wherein the combination results in more than the expected additive effect.

### Example 12: Insect Growth Regulators (Azadirachtin) and U+2-ACTX-Hv1a

Insect growth regulators (IGRs) act by interfering with larval insects' ability to molt to the next instar. The mechanism of action (MoA) of IGRs is interference and/or inhibition of chitin synthases.

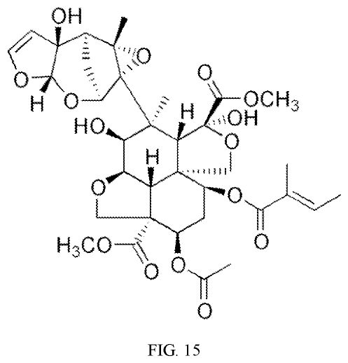

To test the foregoing hypothesis, Corn earworm (CEW) (Helicoverpa zea) neonates were confronted with Azadirachtin, and combinations of Azadirachtin and U+2-ACTX-Hv1a. Azadirachtin is a formulated insecticide derived from Neem oil extract, which has insecticidal activity. Azadirachtin has a chemical formula: C₃₅H₄₄O₁₆, and a chemical structure as shown in FIG. 15.

Treatments
(1) Azadirachtin. Here, Azadirachtin was obtained from the commercially available product, NEEMIX® 4.5, which comprises the active ingredient, Azadirachtin. NEEMIX® 4.5 (Item code: 168600; Lot number: 72371909; CAS number: 11141-17-6), was obtained from Certis USA L.L.C. (9145 Guilford Road Suite 175 Columbia, MD 21046).
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) Azadirachtin+U+2-ACTX-Hv1a. Azadirachtin and U+2-ACTX-Hv1a were prepared/obtained as described in the treatments above, and combined. The final combination composition was as follows: 1% w/v U+2-ACTX-Hv1a; 0.008% w/v Azadirachtin, of the total volume of the composition, with the remainder being water.
(4) Control. Water.

Diet Incorporation Assay

The foregoing treatments were applied as follows:
(a) 0 μL/L Azadirachtin (0% v/v); 0 mg/mL U+2-ACTX-Hv1a (0% w/v) (control);
(b) 80 μL/L Azadirachtin (0.008% v/v); 0 mg/mL U+2-ACTX-Hv1a (0% w/v);
(c) 0 μL/L Azadirachtin (0% v/v); 10 mg/mL U+2-ACTX-Hv1a (1% w/v); and
(c) 80 μL/L Azadirachtin (0.008% v/v); 10 mg/mL of U+2-ACTX-Hv1a (1% w/v).

Bioassay arenas consisted of 128-well trays. Each well was filled with 200 μL of agar-based general lepidopteran diet infused with the above treatments; 16 wells per treatment were evaluated (N=16). One neonate corn earworm (Helicoverpa zea) was placed in each well and their survival was evaluated after four days.

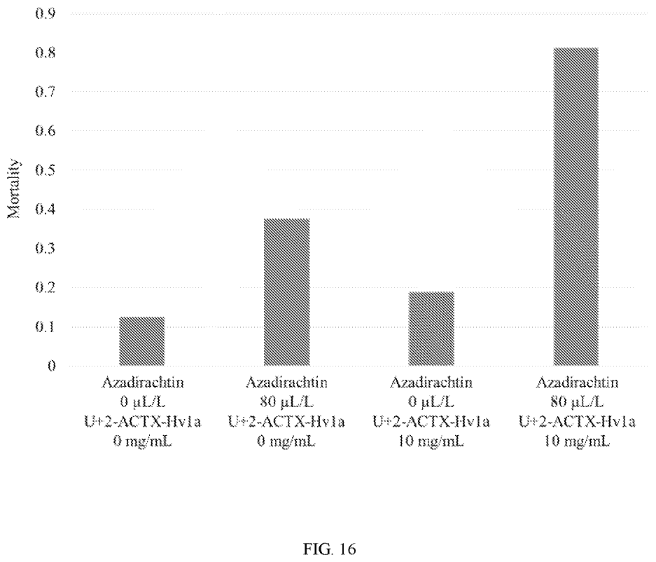

As shown in FIG. 16, the use of Azadirachtin alone resulted in 37.5% mortality. U+2-ACTX-Hv1a alone resulted in 18.75% mortality. However, the combination of U+2-ACTX-Hv1a and Azadirachtin resulted in 81.25% mortality. Thus, higher corn earworm mortality was observed with all treatments of U+2-ACTX-Hv1a and Azadirachtin, as opposed to Azadirachtin alone.

Therefore, this example demonstrates that a combination of Azadirachtin and U+2-ACTX-Hv1a results in an unexpected, synergistic effect, wherein the combination results in more than the expected additive effect.

### Example 13: Miscellaneous Non-Specific Inhibitors (Boric Acid) and U+2-ACTX-Hv1a

Miscellaneous non-specific (multi-site) inhibitors include borates such as borax, boric acid, disodium octaborate, sodium borate, and sodium metaborate. To evaluate the effect of miscellaneous non-specific inhibitors, boric acid and/or U+2-ACTX-Hv1a were evaluated on Lesser mealworm (Alphilobius diaperinus) neonates.

Treatments
(1) Boric acid. Boric acid (chemical formula: H₃BO₃) was obtained from ThermoFisher Scientific via the distributor VWR International, Inc. (Goshen Parkway 1310, P.O. Box 2656 West Chester, PA 19380-0906 www.vwr.com) (Code: 315181000; CAS 10043-35-3; EC: 233-139-2; Lot: A0254726).
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) Boric acid+U+2-ACTX-Hv1a. Boric acid and U+2-ACTX-Hv1a were obtained as described above and combined. The final combination composition consisted of the following: 0.1% w/v U+2-ACTX-Hv1a; and 0.25% w/v boric acid, of the total volume of the composition, with the remainder being water.
(4) Control. Water.

Diet Incorporation Assay

Treatment solutions and concentrations were applied as follows:
(a) 0 mg/mL U+2-ACTX-Hv1a (0% w/v); 0 mg/mL boric acid (0% w/v) (control);
(b) 0 mg/mL U+2-ACTX-Hv1a (0% w/v); 2.5 mg/mL boric acid (0.25% w/v);
(c) 1 mg/mL U+2-ACTX-Hv1a (0.1% w/v); 0 mg/mL boric acid (0% w/v); and
(d) 1 mg/mL U+2-ACTX-Hv1a (0.1% w/v); 2.5 mg/mL boric acid (0.25% w/v).

Bioassay arenas were performed in 128-well trays. Each well was filled with 1 mL of agar-based southern corn rootworm diet infused with one of the above treatments. Sixteen wells per treatment was filled (N=16). One neonate lesser mealworm (Alphitobius diaperinus) was then placed in each well, and their survival was evaluated over four days.

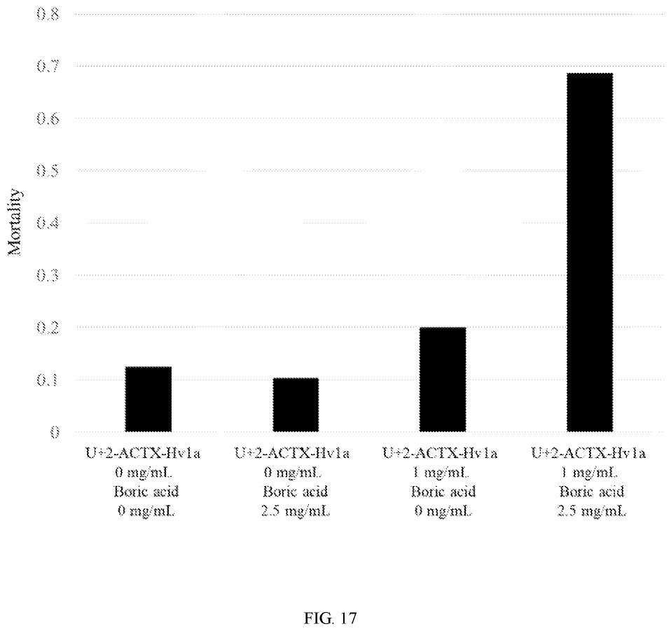

As shown in FIG. 17, boric acid alone resulted in a mortality rate of 10.3%, whereas U+2-ACTX-Hv1a alone resulted in a mortality rate of 20%. In stark contrast, however, to the mortality rates of either boric acid or U+2-ACTX-Hv1a alone, the combination of boric acid and U+2-ACTX-Hv1a resulted in a mortality rate of 68.75%.

Therefore, this example demonstrates that a combination of boric acid and U+2-ACTX-Hv1a results in an unexpected, synergistic effect, wherein the combination results in more than the expected additive effect.

### Example 14: Entomopathogenic Fungi and U+2-ACTX-Hv1a

Beauveria bassiana is an entomopathogenic fungus that infects a broad range of insects. The insecticidal activity of Beauveria bassiana likely comes from compounds it secretes, which in turn degrades the insect cuticle. One of the insecticidal compounds secreted by B. bassiana is beauvericin. There are three species of beauvericin with purported insecticidal activity: (1) beauvericin (C₄₅H₅₇N₃O₉); (2) beauvericin A (C₄₆H₅₉N₃O₉); and (3) beauvericin B (C₄₇H₆₁N₃O₉).

Without being bound to any particular theory, it is hypothesized that, if ingested, the compounds produced by B. bassiana in combination with the CRIPs of the present invention and described herein, may result in the increased bioavailability and/or the insecticidal effect of CRIPs, beauvericin, and/or combinations thereof. To evaluate the foregoing hypothesis, Codling Moths (Cydia pomonella) were confronted with doses of U+2-ACTX-Hv1a and/or beauvericin to test their effects alone and in combination.

Treatments
(1) Beauveria bassiana toxins. To test Beauveria bassiana, and the toxins, spores, and/or proteins therefrom, BIOCERES® WP was used. BIOCERES® WP is a formulated product comprising 20% Beauveria bassiana strain ANT-03 spores; and 80% other/inactive ingredients. BIOCERES® WP (Lot number: 19206-LDBC-719-03; CAS: 63428-82-0) is commercially available from Anatis Bioprotection Inc., 278, rang Saint-André St-Jacques-le-Mineur, Québec J0J 1Z0, Canada.
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) Beauveria bassiana toxins+U+2-ACTX-Hv1a. Beauveria bassiana toxins and U+2-ACTX-Hv1a were obtained as described above and combined. The final combination composition consisted of the following: 0.2% w/v U+2-ACTX-Hv1a; and 0.12% w/v Beauveria bassiana toxins, of the total volume of the composition, with the remainder being water.
(4) Control. Water.

Diet Incorporation Assay

The foregoing treatments were applied as follows:
(a) 0 mg/mL Beauveria bassiana toxins (0% w/v); 0 mg/mL of U+2-ACTX-Hv1a (0% w/v) (control);
(b) 1.2 mg/mL Beauveria bassiana toxins (0.12% w/v); 0 mg/mL of U+2-ACTX-Hv1a (0% w/v);
(c) 0 mg/mL Beauveria bassiana toxins; 2 mg/mL of U+2-ACTX-Hv1a (0.2% w/v); and
(d) 1.2 mg/mL Beauveria bassiana toxins (0.12% w/v); 2 mg/mL of U+2-ACTX-Hv1a (0.2% w/v).

Bioassay arenas were performed in 128-well trays. Each well was filled with 200 μL of agar-based general lepidopteran diet infused with one of the above treatments. Sixteen wells per treatment was filled (N=16 well per treatment). One neonate codling moth (Cydia pomonella) was then placed in each well, and survival was evaluated over seven days.

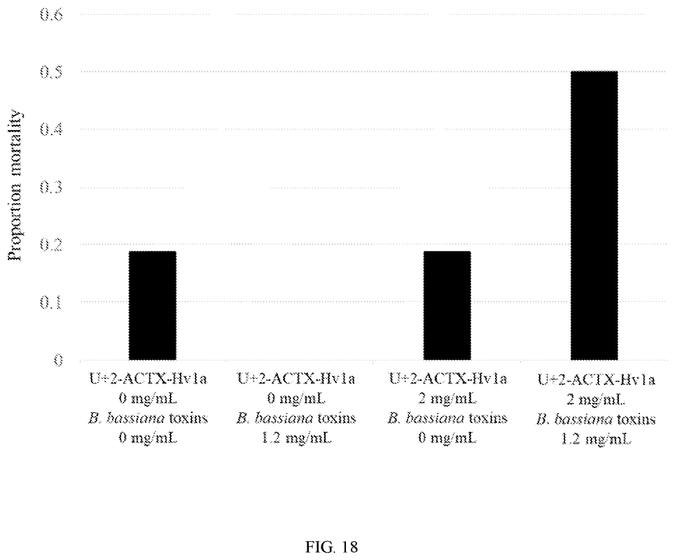

As shown in FIG. 18, the treatment with 0 mg/mL of BIOCERES® WP with 0 mg/mL of U+2-ACTX-Hv1a (control) resulted in 18.75% mortality. The treatment consisting of 1.2 mg/mL of BIOCERES® WP with 0 mg/mL of U+2-ACTX-Hv1a resulted in no mortality. The treatment with 0 mg/mL of BIOCERES® WP with 2 mg/mL of U+2-ACTX-Hv1a had the same mortality as the control (18.75%). Surprisingly, the treatment combining 1.2 mg/mL of BIOCERES® WP with 2 mg/mL of U+2-ACTX-Hv1a resulted in a 50% mortality rate.

Therefore, this example demonstrates that a combination of BIOCERES® WP and U+2-ACTX-Hv1a results in an unexpected, synergistic effect, wherein the combination results in more than the expected additive effect.

### Example 15: Baculovirus and U+2-ACTX-Hv1a

Baculoviridae are a family of viruses specific to arthropods. Within the Baculoviridae are a genus known as Betabaculovirus comprising 26 species, including Cydia pomonella granulovirus. Cydia pomonella granulovirus (CpGV) is a virus of, inter alia, Cydia pomonella (commonly known as the Codling moth). Codling moth larvae must ingest virus occlusion bodies (OB) of the Cydia pomonella granulovirus to become infected. Occlusion bodies are protein lattices or matrices that surround and protect infectious nucleic acid particles.
(1) Cydia pomonella granulovirus (CpGV). To test Cydia pomonella granulovirus, MADEX® HP was used. MADEX® HP is manufactured by Andermatt Biocontrol AG (Stahlermatten 6, CH-6146 Grossdietwil, Switzerland;
https://www.andermattbiocontrol.com/index.html); and distributed in the USA by Certis USA LLC (9145 Guilford Road, Suite 175 Columbia, MD 21046) (https://www.certisusa.com/). MADEX® HP (EPA Reg. No. 69553-1; EPA Est. No. 70051-CA-001; Lot No. 31240799) consists of the following ingredients: 0.06% Cydia pomonella granulovirus isolate V22; and 99.94% other/inactive ingredients.
(2) U+2-ACTX-Hv1a. U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA).
(3) CpGV+U+2-ACTX-Hv1a. CpGV and U+2-ACTX-Hv1a were obtained as described above and combined. The final combination composition consisted of the following: 0.2% w/v U+2-ACTX-Hv1a; and 0.0.00585% w/v CpGV, of the total volume of the composition, with the remainder being water.
(4) Control. Water.

Diet Incorporation Assay

The foregoing treatments were applied as follows:
(a) 0 μL/L of CpGV (0% w/v); 0 mg/mL of U+2-ACTX-Hv1a (0% w/v) (control);
(b) 58.5 μL/L of CpGV (0.00585% w/v); 0 mg/mL of U+2-ACTX-Hv1a (0% w/v);
(c) 0 μL/L of CpGV (0% w/v); 2 mg/mL of U+2-ACTX-Hv1a (0.2% w/v); and
(d) 58.5 μL/L of CpGV (0.00585% w/v); 2 mg/mL of U+2-ACTX-Hv1a (0.2% w/v).

Bioassay arenas were performed in 128-well trays. Each well was filled with 200 μL of agar-based general lepidopteran diet infused with the above treatments. Sixteen wells per treatment were then filled (N=16, per treatment). One neonate Codling moth (Cydia pomonella) was then placed in each well and their survival was evaluated over two days.

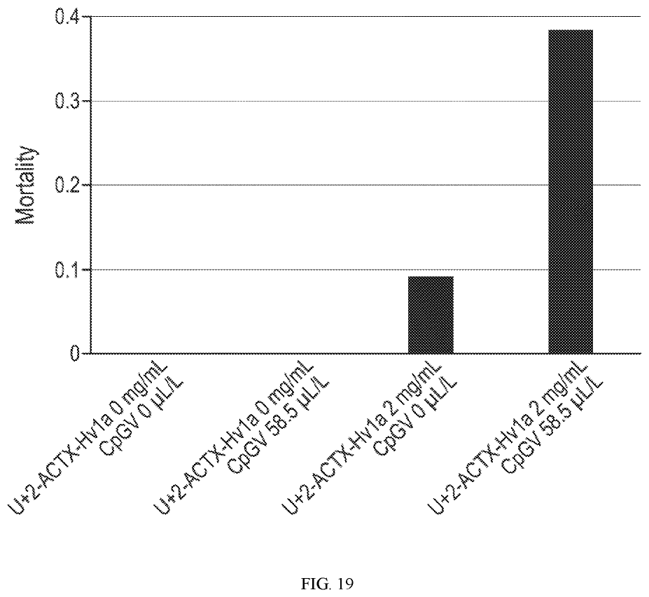

As shown in FIG. 19, both the treatments of 0 μL/L of MADEX® HP with 0 mg/mL of U+2-ACTX-Hv1a (control), and 58.5 μL/L of MADEX® HP with 0 mg/mL of U+2-ACTX-Hv1a, resulted in zero mortality. Using 2 mg/mL of U+2-ACTX-Hv1a alone resulted in 9% mortality. And, the combination of 58.5 μL/L of MADEX® HP with 2 mg/mL of U+2-ACTX-Hv1a resulted in 38.5% mortality.

Therefore, this example demonstrates that a combination of MADEX® HP and U+2-ACTX-Hv1a results in an unexpected, synergistic effect, wherein the combination results in more than the expected additive effect.

### Example 16: Unexpected Effects

The foregoing examples (i.e., Examples 1-15) were shown to demonstrate unexpected effects that were greater than the additive effects of any one of the IAs or CRIPs alone. Indeed, evidencing the unexpected, greater than additive effects of Examples 1-15 are the results of the tests shown below, which did not show greater than additive effects. Here, combinations of U+2-ACTX-Hv1a and Novaluron, nanoparticles, and cryolite, did not result in greater than additive effects

Insect Growth Regulator (IGR): Novaluron

Insect growth regulators (IGRs) act by interfering with larval insects' ability to molt to the next instar. Generally, the mechanism of action for IGRs is interference and/or inhibition of chitin synthases, which may allow bioavailability of insecticidal peptides in the insect gut. Novaluron or (±)-1-[3-chloro-4-(1,1,2-trifluoro-2-trifluoro-methoxyethoxy)phenyl]-3-(2,6-difluorobenzoyl)urea (CAS No 116714-46-6), is an IGR. Here we tested combinations of Novaluron with U+2-ACTX-Hv1a to determine its insecticidal effects.

Novaluron was obtained in the form of Pedestal®, which consists of 10% Novaluron, and 90% other ingredients (OHP, Inc. P.O. Box 746 Bluffton, South Carolina, 29910 USA). Here, U+2-ACTX-Hv1a having an amino acid sequence of “GSQYCVPVDQPCSLNTQPCCDDATCTQERNENGHTVYYCRA” (SEQ ID NO: 61) was obtained from SPEAR®-T Liquid Concentrate (Lot No. 14143019 Vestaron®, 4717 Campus Drive, Kalamazoo, MI 49008 USA). Pedestal is a formulated insecticide which is an inhibitor of chitin biosynthesis which affects CHS1. Novaluron is part of the IRAC 15 group.

Here, treatments evaluating the following concentrations of Novaluron were tested (with and without U+2-ACTX-Hv1a):
(a) 80 μL/L of Novaluron (0.008% w/v);
(b) 8 μL/L of Novaluron (0.0008% w/v);
(c) 0.8 μL/L of Novaluron (0.00008% w/v); and
(d) 0 μL/L of Novaluron (0% w/v).

The bioassay arena was as follows: 128-well trays were arranged, wherein each well was filled with 200 μL of agar-based general lepidopteran diet infused with the above treatments. Here, 16 wells per treatment was filled. One neonate corn earworm (Helicoverpa zea) was placed in each well and their survival was evaluated over four days.

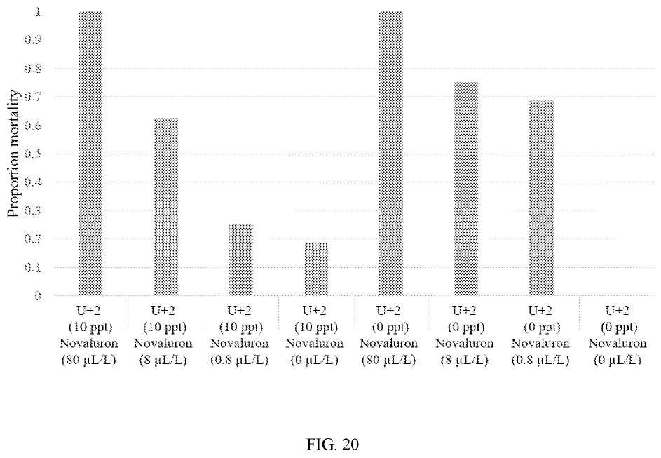

FIG. 20 depicts a graphs showing the mortality results after 3-days. As shown here, there was no evidence of a greater than additive effect when combining Novaluron with U+2-ACTX-Hv1a in a corn earworm (Helicoverpa zea) diet incorporation assay.

Nanoparticles

Nanoparticles induce tight junction relaxation and enable the oral delivery of insulin in mice. When integrins are bound by nanoparticles, they can stimulate signaling pathways that activates MLCK enzyme. Here, Nanoparticle solutions, with and without 5 ppt U+2-ACTX-Hv1a (0.5 mg/mL) (0.5% w/v) were evaluated. Here, nanoparticles were obtained in the form of NanoXact Silica Nanospheres (nanoCompsix, 4878 Ronson Ct Ste J, San Diego, CA 92111)

The nanoparticle concentrations were as follows:
(a) 50 nm silica aminated (2700 ppm);
(b) 50 silica (2575 ppm);
(c) 20 nm silica (1177 ppm); and
(d) 10 nm silica (12500 ppm).

Droplet bioassay arenas were performed in 128-well trays that contained agar, wax paper, 3 μL nanoparticle solution, and 1 neonate H. zea (corn earworm). Here 16 wells (larvae) were evaluated per treatment, and were evaluated every day, for 3 days for proportional mortality.

“Proportion mortality” or “proportional mortality” refers to the proportion of individual insects killed over the course of an experiment. Proportion mortality can be calculated according to Formula (IV), as follows:

$$Proportion mortality = \frac{Number of dead individuals}{Number of total individuals} \qquad Formula ( IV )$$

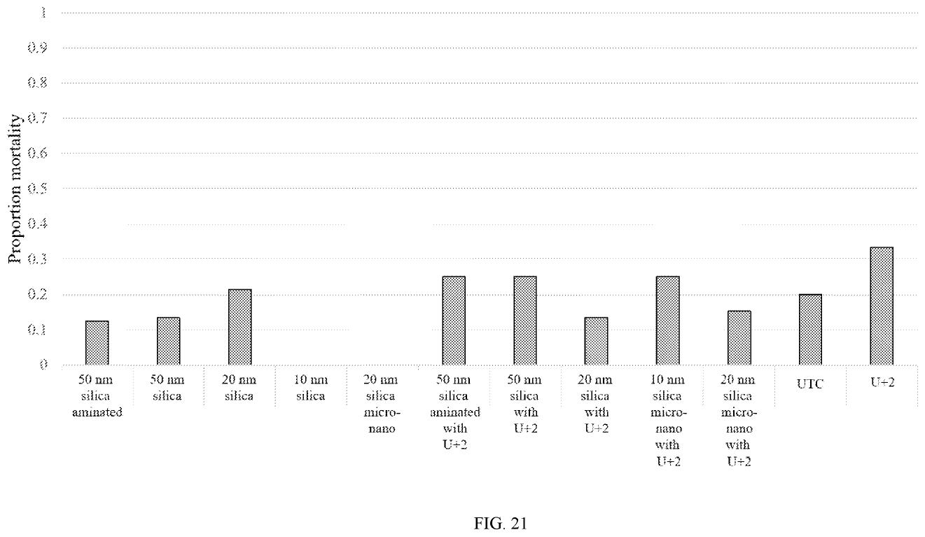

Mortality results after 3 days are shown in FIG. 21. As shown, there is no evidence of a greater than additive effect when combining nanoparticles with U+2-ACTX-Hv1a.

Stomach Poison

The stomach poison cryolite was evaluated in combination with U+2-ACTX-Hv1a._Cryolite (Na₃AlF₆, sodium hexafluoroaluminate) is IRAC group 8C: “miscellaneous non-specific (multi-site) inhibitors. Cryolite dissolves in insect gut and fluoride ions likely cause toxicity, however, it has low toxicity to non-targets, such as vertebrates (including mammals).

Cryolite treatment concentrations were evaluated with and without 10 ppt Spear (1 mg/mL or 1% w/v the total composition), and were as follows:
(a) 10000 ppm;
(b) 2000 ppm;
(c) 400 ppm; and
(d) 0 ppm.

Cryolite was obtained in the form of Prokil®, a commercially available form of cryolite consisting of 96% cryolite (sodium aluminofluoride) and 4% other ingredients (Gowan®, 370 South Main Street, Yuma, Arizona 85364 USA).

Bioassay arenas was as follows: 128-well trays were arranged, and each well was filled with 200 μL of agar-based general lepidopteran diet infused with the above treatments. Here, 16 wells per treatment were filled. One neonate corn earworm (Helicoverpa zea) was placed in each well and their survival was evaluated over four days.

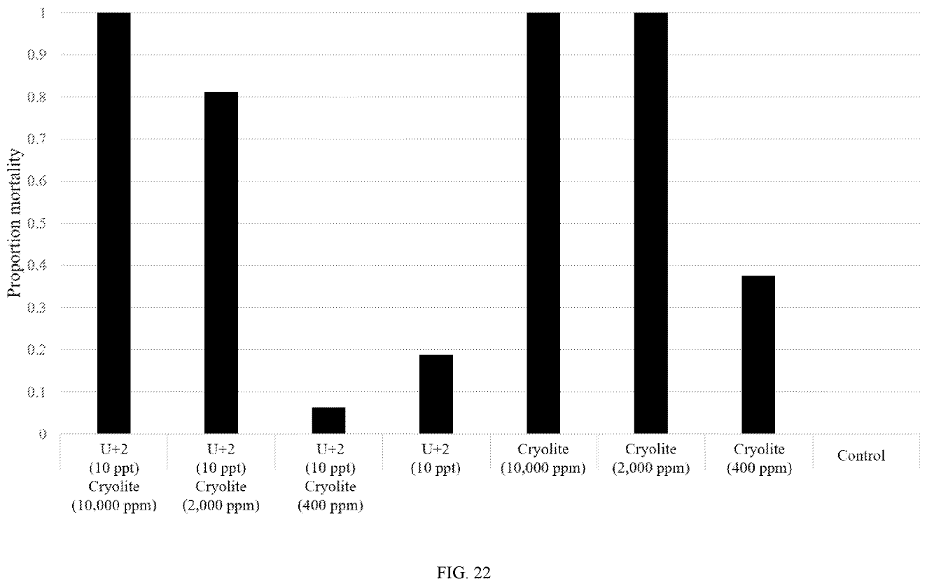

As shown in FIG. 22, there is no evidence of a greater than additive effect when combining cryolite with U+2-ACTX-Hv1a.

1-106. (canceled)

107. A combination comprising a Cysteine Rich Insecticidal Peptide (CRIP) and an Insecticidal Agent (IA).

108. The combination of claim 107, wherein the IA is: a virus; a fungal toxin, a bacterial toxin; a lectin; an Azadirachta indica compound; a boron compound; or a combination thereof.

109. The combination of claim 108, wherein the virus is a granulovirus; the fungal toxin is a Beauveria toxin; and the bacterial toxin is a Bacillus thuringiensis (Bt) toxin protein or a Photorhabdus toxin.

110. The combination of claim 109, wherein the granulovirus is selected from: Adoxophyes orana granulovirus; Agrotis segetum granulovirus; Artogeia rapae granulovirus; Pieris brassicae granulovirus; Choristoneura fumiferana granulovirus; Choristoneura occidentalis granulovirus; Clostera anachoreta granulovirus; Clostera anastomosis granulovirus A; Clostera anastomosis granulovirus Henan; Clostera anastomosis granulovirus B; Cnaphalocrocis medinalis granulovirus; Cryptophlebia leucotreta granulovirus; Cydia pomonella granulovirus (CpGV); Diatraea saccharalis granulovirus; Epinotia aporema granulovirus; Erinnyis ello granulovirus; Harrisina brillians granulovirus; Helicoverpa armigera granulovirus; Lacanobia oleracea granulovirus; Mocis latipes granulovirus; Mythimna unipuncta granulovirus A; Pseudalatia unipuncta granulovirus; Mythimna unipuncta granulovirus B; Mythimna unipuncta granulovirus; Phthorimaea operculella granulovirus; Plodia interpunctella granulovirus; Plutella xylostella granulovirus; Spodoptera frugiperda granulovirus; Spodoptera litura granulovirus; Trichoplusia ni granulovirus; Trichoplusia ni granulovirus LBIV-12; Xestia c-nigrum granulovirus; unclassified Betabaculovirus; Achaea janata granulovirus; Adoxophyes honmai granulovirus; Agrotis exclamationis granulovirus; Amelia pallorana granulovirus; Andraca bipunctata granulovirus; Autographa gamma granulovirus; Caloptilia theivora granulovirus; Choristoneura murinana granulovirus; Choristoneura viridis betabaculovirus; Clostera anastomosis granulovirus; Cnephasia longana granulovirus; Estigmene acrea granulovirus; Euxoa ochrogaster granulovirus; Heliothis armigera granulovirus; Hoplodrina ambigua granulovirus; Hyphantria cunea granulovirus; Natada nararia granulovirus; Nephelodes emmedonia granulovirus; Pandemis limitata granulovirus; Peridorma morpontora granulovirus; Pieris rapae granulovirus; Plathypena scabra granulovirus; Pseudaletia betabaculovirus; Scotogramma trifolii granulovirus; Spodoptera androgea granulovirus; Spodoptera littoralis granulovirus; Tecia solanivora granulovirus; or a Mocis sp. granulovirus.

111. The combination of claim 109, wherein the Bt toxin protein is one or more fermentation solids, spores, or toxins isolated from the group consisting of: Bacillus thuringiensis var. kurstaki (Btk); Bacillus thuringiensis var. tenebrionis (Btt); Bacillus thuringiensis var. israelensis (Bti); Bacillus thuringiensis var. aizawai; Bacillus thuringiensis var. aizawai/pacificus; Bacillus thuringiensis var. alesti; Bacillus thuringiensis var. amagiensis; Bacillus thuringiensis var. andalousiensis; Bacillus thuringiensis var. argentinensis; Bacillus thuringiensis var. asturiensis; Bacillus thuringiensis var. azorensis; Bacillus thuringiensis var. balearica; Bacillus thuringiensis var. berliner; Bacillus thuringiensis var. Bolivia, Bacillus thuringiensis var. brasilensis; Bacillus thuringiensis var. cameroun; Bacillus thuringiensis var. canadensis; Bacillus thuringiensis var. chanpaisis; Bacillus thuringiensis var. chinensis; Bacillus thuringiensis var. colmeri; Bacillus thuringiensis var. coreanensis; Bacillus thuringiensis var. dakota; Bacillus thuringiensis var. darmstadiensis; Bacillus thuringiensis var. dendrolimus; Bacillus thuringiensis var. entomocidus; Bacillus thuringiensis var. entomocidus/subtoxicus; Bacillus thuringiensis var. finitimus; Bacillus thuringiensis var. fukuokaensis; Bacillus thuringiensis var. galechiae; Bacillus thuringiensis var. galleriae; Bacillus thuringiensis var. graciosensis; Bacillus thuringiensis var. guiyangiensis; Bacillus thuringiensis var. higo; Bacillus thuringiensis var. huazhongensis; Bacillus thuringiensis var. iberica; Bacillus thuringiensis var. Indiana; Bacillus thuringiensis var. israelensis/tochigiensis; Bacillus thuringiensis var. japonensis; Bacillus thuringiensis var. jegathesan; Bacillus thuringiensis var. jinghongiensis; Bacillus thuringiensis var. kenyae; Bacillus thuringiensis var. kim; Bacillus thuringiensis var. kumamtoensis; Bacillus thuringiensis var. kunthalanags3; Bacillus thuringiensis var. kunthalaRX24; Bacillus thuringiensis var. kunthalaRX27; Bacillus thuringiensis var. kunthalaRX28; Bacillus thuringiensis var. kyushuensis; Bacillus thuringiensis var. leesis; Bacillus thuringiensis var. londrina; Bacillus thuringiensis var. malayensis; Bacillus thuringiensis var. medellin; Bacillus thuringiensis var. mexicanensis; Bacillus thuringiensis var. mogi; Bacillus thuringiensis var. monterrey; Bacillus thuringiensis var. morrisoni; Bacillus thuringiensis var. muju; Bacillus thuringiensis var. navarrensis; Bacillus thuringiensis var. neoleonensis; Bacillus thuringiensis var. nigeriensis; Bacillus thuringiensis var. novosibirsk; Bacillus thuringiensis var. ostriniae; Bacillus thuringiensis var. oswaldocruzi; Bacillus thuringiensis var. pahangi; Bacillus thuringiensis var. pakistani; Bacillus thuringiensis var. palmanyolensis; Bacillus thuringiensis var. pingluonsis; Bacillus thuringiensis var. pirenaica; Bacillus thuringiensis var. poloniensis; Bacillus thuringiensis var. pondicheriensis; Bacillus thuringiensis var. pulsiensis; Bacillus thuringiensis var. rongseni; Bacillus thuringiensis var. roskildiensis; Bacillus thuringiensis var. san diego; Bacillus thuringiensis var. seoulensis; Bacillus thuringiensis var. shandongiensis; Bacillus thuringiensis var. silo; Bacillus thuringiensis var. sinensis; Bacillus thuringiensis var. sooncheon; Bacillus thuringiensis var. sotto; Bacillus thuringiensis var. sotto/dendrolimus; Bacillus thuringiensis var. subtoxicus; Bacillus thuringiensis var. sumiyoshiensis; Bacillus thuringiensis var. sylvestriensis; Bacillus thuringiensis var. thailandensis; Bacillus thuringiensis var. thompsoni; Bacillus thuringiensis var. thuringiensis; Bacillus thuringiensis var. tochigiensis; Bacillus thuringiensis var. toguchini; Bacillus thuringiensis var. tohokuensis; Bacillus thuringiensis var. tolworthi; Bacillus thuringiensis var. toumanoffi; Bacillus thuringiensis var. vazensis; Bacillus thuringiensis var. wratislaviensis; Bacillus thuringiensis var. wuhanensis; Bacillus thuringiensis var. xiaguangiensis; Bacillus thuringiensis var. yosoo; Bacillus thuringiensis var. yunnanensis; Bacillus thuringiensis var. zhaodongensis; or Bacillus thuringiensis var. konkukian toxin.

112. The combination of claim 109, wherein the Photorhabdus toxin is selected from: a Photorhabdus akhurstii toxin; a Photorhabdus asymbiotica toxin; a Photorhabdus asymbiotica subsp. asymbiotica toxin; a Photorhabdus asymbiotica subsp. asymbiotica ATCC 43949 toxin; a Photorhabdus australis toxin; a Photorhabdus australis DSM 17609 toxin; a Photorhabdus bodei toxin; a Photorhabdus caribbeanensis toxin; a Photorhabdus cinerea toxin; a Photorhabdus hainanensis toxin; a Photorhabdus heterorhabditis toxin; a Photorhabdus kayaii toxin; a Photorhabdus khanii toxin; a Photorhabdus khanii NC19 toxin; a Photorhabdus khanii subsp. guanajuatensis toxin; a Photorhabdus kleinii toxin; a Photorhabdus laumondii toxin; a Photorhabdus laumondii subsp. clarkei toxin; a Photorhabdus laumondii subsp. laumondii toxin; a Photorhabdus laumondii subsp. laumondii TTO1 toxin; a Photorhabdus luminescens toxin; a Photorhabdus luminescens BA1 toxin; a Photorhabdus luminescens NBAII H75HRPL105 toxin; a Photorhabdus luminescens NBAII HiPL101 toxin; a Photorhabdus luminescens subsp. luminescens toxin; a Photorhabdus luminescens subsp. luminescens ATCC 29999 toxin; a Photorhabdus luminescens subsp. mexicana toxin; a Photorhabdus luminescens subsp. sonorensis toxin; a Photorhabdus namnaonensis toxin; a Photorhabdus noenieputensis toxin; a Photorhabdus stackebrandtii toxin; a Photorhabdus tasmaniensis toxin; a Photorhabdus temperata toxin; a Photorhabdus temperata J3 toxin; a Photorhabdus temperata subsp. phorame toxin; a Photorhabdus temperata subsp. temperata toxin; a Photorhabdus temperata subsp. temperata M1021 toxin; a Photorhabdus temperata subsp. temperata Meg1 toxin; a Photorhabdus thracensis toxin; a unclassified Photorhabdus toxin; a Photorhabdus sp. toxin; a Photorhabdus sp. 3014 toxin; a Photorhabdus sp. 3240 toxin; a Photorhabdus sp. Az29 toxin; a Photorhabdus sp. BS21 toxin; a Photorhabdus sp. CbKj163 toxin; a Photorhabdus sp. CRCIA-P01 toxin; a Photorhabdus sp. ENY toxin; a Photorhabdus sp. FL2122 toxin; a Photorhabdus sp. FL480 toxin; a Photorhabdus sp. FsIw96 toxin; a Photorhabdus sp. GDd233 toxin; a Photorhabdus sp. H3086 toxin; a Photorhabdus sp. H3107 toxin; a Photorhabdus sp. H3240 toxin; a Photorhabdus sp. HB301 toxin; a Photorhabdus sp. HB78 toxin; a Photorhabdus sp. HB89 toxin; a Photorhabdus sp. HIT toxin; a Photorhabdus sp. HO1 toxin; a Photorhabdus sp. HUG-39 toxin; a Photorhabdus sp. IT toxin; a Photorhabdus sp. JUN toxin; a Photorhabdus sp. KcTs129 toxin; a Photorhabdus sp. KJ13.1 TH toxin; a Photorhabdus sp. KJ14.3 TH toxin; a Photorhabdus sp. KJ24.5 TH toxin; a Photorhabdus sp. KJ29.1 TH toxin; a Photorhabdus sp. KJ37.1 TH toxin; a Photorhabdus sp. KJ7.1 TH toxin; a Photorhabdus sp. KJ8.2 TH toxin; a Photorhabdus sp. KJ9.1 TH toxin; a Photorhabdus sp. KJ9.2 TH toxin; a Photorhabdus sp. KK1.3 TH toxin; a Photorhabdus sp. KK1.4 TH toxin; a Photorhabdus sp. KMD74 toxin; a Photorhabdus sp. KOH toxin; a Photorhabdus sp. MID10 toxin; a Photorhabdus sp. MOL toxin; a Photorhabdus sp. MSW 058 toxin; a Photorhabdus sp. MSW 079 toxin; a Photorhabdus sp. NK2.1 TH toxin; a Photorhabdus sp. NK2.5 TH toxin; a Photorhabdus sp. NnMt2h toxin; a Photorhabdus sp. NP1 toxin; a Photorhabdus sp. OH10 toxin; a Photorhabdus sp. OnIr40 toxin; a Photorhabdus sp. OnKn2 toxin; a Photorhabdus sp. PB10.1 TH toxin; a Photorhabdus sp. PB16.3 TH toxin; a Photorhabdus sp. PB17.1 TH toxin; a Photorhabdus sp. PB17.3 TH toxin; a Photorhabdus sp. PB2.5 TH toxin; a Photorhabdus sp. PB22.4 TH toxin; a Photorhabdus sp. PB22.5 TH toxin; a Photorhabdus sp. PB32.1 TH toxin; a Photorhabdus sp. PB33.1 TH toxin; a Photorhabdus sp. PB33.4 TH toxin; a Photorhabdus sp. PB37.4 TH toxin; a Photorhabdus sp. PB39.2 TH toxin; a Photorhabdus sp. PB4.5 TH toxin; a Photorhabdus sp. PB41.4 TH toxin; a Photorhabdus sp. PB45.5 TH toxin; a Photorhabdus sp. PB47.1 TH toxin; a Photorhabdus sp. PB47.3 TH toxin; a Photorhabdus sp. PB5.1 TH toxin; a Photorhabdus sp. PB5.4 TH toxin; a Photorhabdus sp. PB50.4 TH toxin; a Photorhabdus sp. PB51.4 TH toxin; a Photorhabdus sp. PB52.2 TH toxin; a Photorhabdus sp. PB54.4 TH toxin; a Photorhabdus sp. PB58.2 TH toxin; a Photorhabdus sp. PB58.4 TH toxin; a Photorhabdus sp. PB58.5 TH toxin; a Photorhabdus sp. PB59.2 TH toxin; a Photorhabdus sp. PB6.5 TH toxin; a Photorhabdus sp. PB67.2 TH toxin; a Photorhabdus sp. PB67.4 TH toxin; a Photorhabdus sp. PB68.1 TH toxin; a Photorhabdus sp. PB7.5 TH toxin; a Photorhabdus sp. PB76.1 TH toxin; a Photorhabdus sp. PB76.4 TH toxin; a Photorhabdus sp. PB76.5 TH toxin; a Photorhabdus sp. PB78.2 TH toxin; a Photorhabdus sp. PB80.3 TH toxin; a Photorhabdus sp. PB80.4 TH toxin; a Photorhabdus sp. Pjun toxin; a Photorhabdus sp. RW14-46 toxin; a Photorhabdus sp. S10-54 toxin; a Photorhabdus sp. S12-55 toxin; a Photorhabdus sp. S14-60 toxin; a Photorhabdus sp. S15-56 toxin; a Photorhabdus sp. S5P8-50 toxin; a Photorhabdus sp. S7-51 toxin; a Photorhabdus sp. S8-52 toxin; a Photorhabdus sp. S9-53 toxin; a Photorhabdus sp. SJ2 toxin; a Photorhabdus sp. SN259 toxin; a Photorhabdus sp. SP1.5 TH toxin; a Photorhabdus sp. SP16.4 TH toxin; a Photorhabdus sp. SP21.5 TH toxin; a Photorhabdus sp. SP3.4 TH toxin; a Photorhabdus sp. SP4.5 TH toxin; a Photorhabdus sp. SP7.3 TH toxin; a Photorhabdus sp. TyKb140 toxin; a Photorhabdus sp. UK76 toxin; a Photorhabdus sp. VMG toxin; a Photorhabdus sp. WA21C toxin; a Photorhabdus sp. WkSs43 toxin; a Photorhabdus sp. Wx13 toxin; a Photorhabdus sp. X₄ toxin; a Photorhabdus sp. YNb90 toxin; a Photorhabdus sp. ZM toxin; or one or more proteins from a Photorhabdus luminescens toxin complex (Tca).

113. The combination of claim 109, wherein the Beauveria toxin is selected from: a Beauveria alba toxin; a Beauveria amorpha toxin; a Beauveria arenaria toxin; a Beauveria asiatica toxin; a Beauveria australis toxin; a Beauveria bassiana toxin; a Cordyceps bassiana toxin; a Beauveria brongniartii toxin; a Beauveria brumptii toxin; a Beauveria caledonica toxin; a Beauveria chiromensis toxin; a Beauveria coccorum toxin; a Beauveria cretacea toxin; a Beauveria cylindrospora toxin; a Beauveria delacroixii toxin; a Beauveria densa toxin; a Beauveria dependens toxin; a Beauveria doryphorae toxin; a Beauveria effusa toxin; a Beauveria epigaea toxin; a Beauveria felina toxin; a Beauveria geodes toxin; a Beauveria globulifera toxin; a Beauveria heimii toxin; a Beauveria hoplocheli toxin; a Beauveria kipukae toxin; a Beauveria laxa toxin; a Beauveria malawiensis toxin; a Beauveria medogensis toxin; a Beauveria melolonthae toxin; a Beauveria nubicola toxin; a Beauveria oryzae toxin; a Beauveria paradoxa toxin; a Beauveria paranensis toxin; a Beauveria parasitica toxin; a Beauveria petelotii toxin; a Beauveria pseudobassiana toxin; a Beauveria rileyi toxin; a Beauveria rubra toxin; a Beauveria shiotae toxin; a Beauveria sobolifera toxin; a Beauveria spicata toxin; a Beauveria stephanoderis toxin; a Beauveria sulfurescens toxin; a Beauveria sungii toxin; a Beauveria tenella toxin; a Beauveria tundrensis toxin; a Beauveria velata toxin; a Beauveria varroae toxin; a Beauveria vermiconia toxin; a Beauveria vexans toxin; a Beauveria viannai toxin; or a Beauveria virella toxin.

114. The combination of claim 108, wherein the lectin is selected from: Galanthus nivalis agglutinin (GNA); Sambucus nigra lectin (SNA); Maackia amurensis-II (MAL-II); Erythrina cristagalli lectin (ECL); Ricinus communis agglutinin-I (RCA); peanut agglutinin (PNA); wheat germ agglutinin (WGA); Griffonia simplicifolia-II (GSL-II); Con A; Lens culinaris agglutinin (LCA); Mannose-binding lectin (MBL); BanLec; galectins; Phaseolus vulgaris Leucoagglutinin (PHA-L); Phaseolus vulgaris Erythroagglutinin (PHA-E); or Datura stramonium Lectin (DSL).

115. The combination of claim 108, wherein the Azadirachta indica compound is selected from: Azadiradione; Azadiradionolide; Deacetylgedunin; Deacetylazadirachtinol; Desfuranoazadiradione; Epoxyazadiradione; Gedunin; Mahmoodin; Neemfruitin A; Neemfruitin B; Nimbolide; Nimbin; Nimolicinol; an Ohchinin Acetate; Salannin; Salannol; an alpha-Nimolactone; beta-Nimolactone; 2′,3′-Dihydrosalannin; 3-Deacetylsalannin; 6-Deacetylnimbin; 7-Acetyl-16,17-dehydro-16-hydroxyneotrichilenone; 7-Benzoylnimbocinol; 7-Deacetyl-7-benzoylepoxyazadiradione; 7-Deacetyl-7-benzoylgedunin; 7-Deacetyl-17-epinimolicinol; 15-Hydroxyazadiradione; 17-Epi-17-Hydroxyazadiradione; 17-Epiazadiradione; 20,21,22,23-Tetrahydro-23-oxoazadirone; 22,23-Dihydronimocinol; or 28-Deoxonimbolide.

116. The combination of claim 108, wherein the boron compound is selected from: borax; boric acid; disodium octaborate; sodium borate; sodium metaborate; sodium tetraborate decahydrate; boron oxide; boron carbide; boron nitride; boron tribromide; boron trichloride; or boron trifluoride.

117. The combination of claim 107, wherein the IA is: a Cydia pomonella granulovirus (CpGV); a Bt toxin protein comprising one or more fermentation solids, spores, or toxins isolated from a Bacillus thuringiensis var. kurstaki (Btk), a Bacillus thuringiensis var. tenebrionis (Btt), or a Bacillus thuringiensis var. israelensis (Bti); a Photorhabdus luminescens toxin complex (Tca); a Beauveria bassiana toxin; a Galanthus nivalis agglutinin (GNA); an Azadirachta indica compound; or a boron compound.

118. The combination of claim 117, wherein the Cydia pomonella granulovirus (CpGV) is a Cydia pomonella granulovirus isolate V22 virus; the Bt toxin protein is one or more fermentation solids, spores, or toxins isolated from a Bacillus thuringiensis ssp. kurstaki (Btk) strain EVB-113-19; a Bacillus thuringiensis ssp. tenebrionis (Btt) train NB-176, a Bacillus thuringiensis ssp. israelensis (Bti) strain BMP 144, or a Bt toxin protein as set forth in any one of SEQ ID NOs: 412-587; wherein the Tca comprises a TcaA protein (SEQ ID NO: 616), a TcaB protein (SEQ ID NO: 617), a TcaC protein (SEQ ID NO: 618), and a TcaZ protein (SEQ ID NO: 619); wherein the Beauveria bassiana toxin is a beauvericin toxin having the chemical formula C₄₅H₅₇N₃O₉, a beauvericin A toxin having the chemical formula C₄₆H₅₉N₃O₉, a beauvericin B toxin having the chemical formula C₄₇H₆₁N₃O₉, or a beauvericin toxin isolated from a Beauveria bassiana strain ANT-03 spore; wherein the Galanthus nivalis agglutinin (GNA) has an amino acid sequence as set forth in SEQ ID NO: 35; wherein the Azadirachta indica compound is Azadirachtin; or wherein the boron compound is boric acid.

119. The combination of claim 107, wherein the CRIP is a U1-agatoxin-Ta1b peptide; a U1-agatoxin-Ta1b Variant Polypeptide (TVP); a sea anemone toxin; an Av3 Variant Polypeptide (AVP); a Phoneutria toxin; or an Atracotoxin (ACTX).

120. The combination of claim 119, wherein the CRIP has an amino acid sequence that is at least 90% identical to an amino acid sequence as set forth in any one of SEQ ID NOs: 1, 2-15, 44, 45-47, 49-53, 60-64, 65, 588, 594, 621-622, 624-628, 631-640, 642-651, or 653-654.

121. The combination of claim 119, wherein the CRIP is a U1-agatoxin-Ta1b peptide having an amino acid sequence as set forth in SEQ ID NO: 1; a U1-agatoxin-Ta1b Variant Polypeptide (TVP) having an amino acid as set forth in any one of SEQ ID NOs: 2-15, 49-53, 2-15, 49-53, 621-622, 624-628, 631-640, 642-651, or 653-654; an Av3-Variant Polypeptide (AVP) having an amino acid as set forth in SEQ ID NO: 47; a Γ-CNTX-Pn1a having an amino acid sequence as set forth in SEQ ID NO: 65; or an ACTX having an amino acid sequence as set forth in any one of SEQ ID NOs: 60-64, or 594.

122. The combination of claim 121, wherein the CRIP is a U1-agatoxin-Ta1b peptide having an amino acid sequence as set forth in SEQ ID NO: 1; a U1-agatoxin-Ta1b Variant Polypeptide (TVP) having an amino acid as set forth in SEQ ID NO: 2-; an Av3-Variant Polypeptide (AVP) having an amino acid as set forth in SEQ ID NO: 47; a Γ-CNTX-Pn1a having an amino acid sequence as set forth in SEQ ID NO: 65; or an ACTX having an amino acid sequence as set forth in SEQ ID NO: 61.

123. The combination of claim 121, wherein the IA comprises a granulovirus selected from the group consisting of: Adoxophyes orana granulovirus; Agrotis segetum granulovirus; Artogeia rapae granulovirus; Pieris brassicae granulovirus; Choristoneura fumiferana granulovirus; Choristoneura occidentalis granulovirus; Clostera anachoreta granulovirus; Clostera anastomosis granulovirus A; Clostera anastomosis granulovirus Henan; Clostera anastomosis granulovirus B; Cnaphalocrocis medinalis granulovirus; Cryptophlebia leucotreta granulovirus; Cydia pomonella granulovirus (CpGV); Diatraea saccharalis granulovirus; Epinotia aporema granulovirus; Erinnyis ello granulovirus; Harrisina brillians granulovirus; Helicoverpa armigera granulovirus; Lacanobia oleracea granulovirus; Mocis latipes granulovirus; Mythimna unipuncta granulovirus A; Pseudalatia unipuncta granulovirus; Mythimna unipuncta granulovirus B; Mythimna unipuncta granulovirus; Phthorimaea operculella granulovirus; Plodia interpunctella granulovirus; Plutella xylostella granulovirus; Spodoptera frugiperda granulovirus; Spodoptera litura granulovirus; Trichoplusia ni granulovirus; Trichoplusia ni granulovirus LBIV-12; Xestia c-nigrum granulovirus; unclassified Betabaculovirus; Achaea janata granulovirus; Adoxophyes honmai granulovirus; Agrotis exclamationis granulovirus; Amelia pallorana granulovirus; Andraca bipunctata granulovirus; Autographa gamma granulovirus; Caloptilia theivora granulovirus; Choristoneura murinana granulovirus; Choristoneura viridis betabaculovirus; Clostera anastomosis granulovirus; Cnephasia longana granulovirus; Estigmene acrea granulovirus; Euxoa ochrogaster granulovirus; Heliothis armigera granulovirus; Hoplodrina ambigua granulovirus; Hyphantria cunea granulovirus; Natada nararia granulovirus; Nephelodes emmedonia granulovirus; Pandemis limitata granulovirus; Peridorma morpontora granulovirus; Pieris rapae granulovirus; Plathypena scabra granulovirus; Pseudaletia betabaculovirus; Scotogramma trifolii granulovirus; Spodoptera androgea granulovirus; Spodoptera littoralis granulovirus; Tecia solanivora granulovirus; a Cydia pomonella granulovirus (CpGV) isolate V22 virus; and a Mocis sp. Granulovirus.

124. The combination of claim 122, wherein the IA comprises one or more fermentation solids, spores, or toxins isolated from a Bacillus thuringiensis ssp. kurstaki strain EVB-113-19; and the CRIP comprises a U1-agatoxin-Ta1b Variant Polypeptide (TVP) having an amino acid sequence as set forth in SEQ ID NO: 2.

125. The combination of claim 107, wherein the IA comprises one or more fermentation solids, spores, or toxins isolated from a Bacillus thuringiensis ssp. kurstaki strain EVB-113-19, and the CRIP comprises an Av3-Variant Polypeptide (AVP) having an amino acid sequence as set forth in SEQ ID NO: 47.

126. The combination of claim 107, wherein the IA comprises one or more fermentation solids, spores, or toxins isolated from a Bacillus thuringiensis ssp. kurstaki strain EVB-113-19, and wherein the CRIP comprises a Γ-CNTX-Pn1a toxin having an amino acid sequence according to the amino acid sequence set forth in SEQ ID NO: 65.

127. The combination of claim 107, wherein the IA comprises a Beauveria bassiana strain ANT-03 spore, and wherein the CRIP comprises a U+2-ACTX-Hv1a toxin having an amino acid sequence as set forth in SEQ ID NO: 61.

128. The combination of claim 107, wherein the IA comprises one or more fermentation solids, spores, or toxins isolated from a Bacillus thuringiensis ssp. tenebrionis strain NB-176, and wherein the CRIP comprises a U+2-ACTX-Hv1a toxin having an amino acid sequence according to the amino acid sequence set forth in SEQ ID NO: 61.

129. The combination of claim 107, wherein the IA comprises one or more fermentation solids, spores, or toxins isolated from a Bacillus thuringiensis ssp. kurstaki strain EVB-113-19, and wherein the CRIP comprises a U+2-ACTX-Hv1a toxin having an amino acid sequence as set forth in SEQ ID NO: 61.

130. The combination of claim 107, wherein the IA comprises one or more fermentation solids, spores, or toxins isolated from a Bacillus thuringiensis ssp. israelensis Strain BMP 144, and wherein the CRIP comprises a U+2-ACTX-Hv1a toxin having an amino acid sequence according to the amino acid sequence set forth in SEQ ID NO: 61.

131. The combination of claim 107, wherein the IA comprises a Photorhabdus luminescens toxin complex (Tca) comprising a TcaA (SEQ ID NO: 616), a TcaB (SEQ ID NO: 617), a TcaC (SEQ ID NO: 618), and a TcaZ (SEQ ID NO: 619); and wherein the CRIP comprises a U+2-ACTX-Hv1a toxin having an amino acid sequence as set forth in SEQ ID NO: 61.

132. The combination of claim 107, wherein the IA comprises a Galanthus nivalis agglutinin (GNA) having an amino acid sequence as set forth in SEQ ID NO: 35; and wherein the CRIP comprises U+2-ACTX-Hv1a toxin having an amino acid sequence as set forth in SEQ ID NO: 61.

133. The combination of claim 107, wherein the IA comprises an Azadirachtin having a chemical formula: C₃₅H₄₄O₁₆; and wherein the CRIP comprises a U+2-ACTX-Hv1a toxin having an amino acid sequence as set forth in SEQ ID NO: 61.

134. The combination of claim 107, wherein the IA comprises a boric acid compound having a chemical formula of H₃BO₃; and wherein the CRIP comprises a U+2-ACTX-Hv1a toxin having an amino acid sequence as set forth in SEQ ID NO: 61.

135. The combination of claim 107, wherein the IA comprises a Cydia pomonella granulovirus (CpGV) isolate V22 virus; and wherein the CRIP is a U+2-ACTX-Hv1a toxin having an amino acid sequence as set forth in SEQ ID NO: 61.

136. The combination of claim 107, wherein each of the IA, and the CRIP, in the combination is formulated in separate compositions, wherein each separate composition further comprises at least one excipient.

137. The combination of claim 136, wherein the separate compositions are formulated as powders, dusts, pellets, granules, sprays, emulsions, colloids, solutions, or combinations thereof.

138. The combination of claim 136, wherein the separate compositions are formulated using the same excipients or different excipients.

139. The method of claim 136, wherein the separate compositions are applied separately, sequentially, simultaneously, concurrently, or chronologically staggered.

140. The combination of claim 107, wherein the IA is in admixture with the CRIP, and formulated in a single composition, wherein the single composition further comprises at least one excipient.

141. The combination of claim 140, wherein the single composition is formulated as a powder, a dust, a pellet, a granule, a spray, an emulsion, a colloid, a solution, or combinations thereof.

142. The combination of claim 107, wherein if the combination comprises a protein or peptide Insecticidal Agent (IA), then the IA is integrally expressed in a plant, or plant seed; and wherein the Cysteine Rich Insecticidal Peptide (CRIP) is formulated as a composition comprising at least one excipient, and the CRIP is applied onto a surface of the plant or plant seed containing the IA.

143. The combination of claim 107, wherein the combination comprises the Cysteine Rich Insecticidal Peptide (CRIP) integrally expressed in a plant or plant seed; and wherein the Insecticidal Agent (IA) is formulated as a composition comprising at least one excipient and the IA is applied onto a surface of the plant or plant seed containing the CRIP.

144. The combination of claim 107, wherein if the Insecticidal Agent (IA) is a protein, then both the IA and Cysteine Rich Insecticidal Peptide (CRIP) are integrally expressed in a plant.

145. The combination of claim 107, wherein the ratio of IA to CRIP in the combination ranges from about 10,000:1 to 1:10,000.

146. The combination of claim 145, wherein the ratio of IA to CRIP in the combination is about 10,000:1, 5,000:1, 1,000:1, 500:1, 250:1, 200:1, 100:1, 99:1, 95:5, 90:10, 85:15, 80:20, 75:25, 70:30, 65:35, 60:40, 55:45, 1:1, 45:55, 40:60, 35:65, 30:70, 25:75, 20:80, 15:85, 10:90, 5:95, 1:99, 1:100, 1:200, 1:250, 1:500, 1:1,000, 1:5,000, or 1:10,000.

147. A method of combating, controlling, or inhibiting a pest, the method comprising
(1) providing: a pesticidally effective amount of a combination comprising a Cysteine Rich Insecticidal Peptide (CRIP) and an Insecticidal Agent (IA); wherein the IA is selected from a virus; a fungal toxin, a bacterial toxin; a lectin; an Azadirachta indica compound; a boron compound; or a combination thereof; and the CRIP is selected from a U1-agatoxin-Ta1b peptide; a U1-agatoxin-Ta1b Variant Polypeptide (TVP); a sea anemone toxin; an Av3 Variant Polypeptide (AVP); a Phoneutria toxin; or an Atracotoxin (ACTX); and
(2) applying the combination to: the pest, a locus of the pest, a food supply of the pest, a habitat of the pest, or a breeding ground of the pest; a plant, a seed, a plant part, a locus of a plant, or an environment of a plant that is susceptible to an attack by the pest; an animal, a locus of an animal, or an environment of an animal susceptible to an attack by the pest; or a combination thereof.

148. The method of claim 147, wherein the pest is selected from the group consisting of: Eumorpha achemon; Colias eurytheme; Caudra cautella; Amorbia humerosana; Pseudaletia unipuncta; Platyptilia carduidactyla; Datana major; Thyridopteryx ephemeraeformis; Hypercompe scribonia; Erionota thrax; Acleris gloverana; Phryganidia californica; Paleacrita merriccata; Grapholita packardi; Nymphula stagnates, Xylomyges curialis; Cydia pomonella; Acrobasis vaccinii; Evergestis rimosalis; Noctuid species; Agrotis ipsilon; Orgyia pseudotsugata; Erinnyis ello; Ennomos subsignaria; Lobesia botrana; Thymelicus lineola; Melissopus latiferreanus; Archips rosanus; Archips argyrospilia; Paralobesia viteana; Platynota stultana; Harrisina americans; Plathypena scabra; Dryocampa rubicunda; Batrachedra comosae; Lymantria dispar; Lambdina fiscellaria; Manduca quinquemaculata; Manduca sexta; Pieris rapae; Automeris io; Choristoneura pinus; Epiphyas postvittana; Diaphania hyalinata; Homadaula anisocentra; Choristoneura rosaceana; Syntomeida epilais; Playnota stultana; Sabulodes aegrotata; Papilio cresphontes; Argyrotaenia citrana; Grapholita molests, Anarsia lineatella; Neophasia menapia; Argyrotaenia velutinana; Schizura concinna; Sibine stimulea; Heterocampa guttivitta; Estigmene acres, Crambus sp.; Ennomos subsignaria; Alsophila pometaria; Choristoneura fumiferana; Lasiocampidae sp.; Thecla basilides; Ephestia elutella; Platynota idaeusalis; Anarsia lineatella; Peridroma saucia; Platynota flavedana; Anticarsia gemmatalis; Datana integerrima; Hyphantria cunea; Orgyia vetusta; Southern Diatraea crambidoides; Cylas formicarius; Anthonomus eugenii; Diaprepes abbreviatus; Otiorhynchus ovatus; Curculio caryae; Curculio occidentis; Lissorhoptrus oryzophilus; Hypera postica; Hypera zoilus; Euwallacea fornicatus; Euetheola humilis; Hypothenemus hampei; Listronotus maculicollis; Maladera castanea; Rhizotroqus majalis; Cotinis nitida; Popillia japonica; Phyllophaga sp.; Cyclocephala borealis; Anomala orientalis; Cyclocephala lurida; Sphenophorus parvulus; Sphenophorus apicalis; Sphenophorus cariosus; Sphenophorus inaequalis; Sphenophorus minimus; Aedes aegypti; Busseola fusca; Chilo suppressalis; Culex pipiens; Culex quinquefasciatus; Diabrotica virgifera; Diatraea saccharalis; Helicoverpa armigera; Helicoverpa zea; Heliothis virescens; Leptinotarsa decemlineata; Ostrinia furnacalis; Ostrinia nubilalis; Pectinophora gossypiella; Plodia interpunctella; Plutella xylostella; Pseudoplusia includens; Spodoptera exigua; Spodoptera frugiperda; Spodoptera littoralis; Trichoplusia ni; and Xanthogaleruca luteola.
